(19) United States
(12) Patent Application Publication
(10) Pub. No.: US 2026/0149597 A1
(43) Pub. Date: May 28, 2026

(54) Computationally Efficient Transfer Processing, Auditing, and Search Apparatuses, Mechanisms, Mediums, Processes and Systems

(71) Applicant: FMR LLC, Boston, MA (US)

(72) Inventors: Xinxin Sheng, Cary, NC (US); Thomas Stephen McGuire, Galway (IE); Amanda Chiu, San Francisco, CA (US); Jonathan Hromi, Watertown, MA (US); Raghav Chawla, Cambridge, MA (US)

(21) Appl. No.: 19/412,411

(22) Filed: Dec. 8, 2025

Related U.S. Application Data
(63) Continuation-in-part of application No. 15/844,387, filed on Dec. 15, 2017.
(63) Continuation-in-part of application No. 16/125,608, filed on Sep. 7, 2018.
Application No. 16/125,608 is a continuation-in-part of application No. 15/898,220, filed on Feb. 15, 2018, now Pat. No. 12,452,075.
Application No. 15/898,220 is a continuation-in-part of application No. 15/210,813, filed on Jul. 14, 2016, now abandoned.
Application No. 15/898,220 is a continuation-in-part of application No. 15/210,817, filed on Jul. 14, 2016.
Application No. 15/898,220 is a continuation-in-part of application No. 15/210,807, filed on Jul. 14, 2016.
Application No. 15/898,220 is a continuation-in-part of application No. 15/210,795, filed on Jul. 14, 2016, now abandoned.
Application No. 15/898,220 is a continuation-in-part of application No. 15/210,821, filed on Jul. 14, 2016, now abandoned.
Application No. 15/898,220 is a continuation-in-part of application No. 14/799,282, filed on Jul. 14, 2015, now abandoned.
Application No. 14/799,282 is a continuation-in-part of application No. 14/799,242, filed on Jul. 14, 2015, now abandoned.
Application No. 14/799,242 is a continuation-in-part of application No. 14/799,229, filed on Jul. 14, 2015, now abandoned.
Application No. 14/799,229 is a continuation-in-part of application No. 14/963,165, filed on Dec. 8, 2015, now Pat. No. 10,504,179.
Application No. 14/963,165 is a continuation-in-part of application No. 15/019,926, filed on Feb. 9, 2016, now abandoned.
Application No. 15/019,926 is a continuation-in-part of application No. 15/209,701, filed on Jul. 13, 2016, now abandoned.
Application No. 15/209,701 is a continuation-in-part of application No. 15/209,709, filed on Jul. 13, 2016.
Application No. 15/209,709 is a continuation-in-part of application No. 15/209,714, filed on Jul. 13, 2016, now Pat. No. 10,339,523.
Application No. 15/209,714 is a continuation-in-part of application No. 15/210,781, filed on Jul. 14, 2016, now abandoned.
Application No. 15/210,781 is a continuation-in-part of application No. 15/486,243, filed on Apr. 12, 2017, now Pat. No. 11,488,147.
Application No. 15/486,243 is a continuation-in-part of application No. 15/844,375, filed on Dec. 15, 2017, now Pat. No. 11,636,471.
Application No. 15/844,375 is a continuation-in-part of application No. 15/844,404, filed on Dec. 15, 2017, now Pat. No. 11,436,598.
Application No. 15/844,404 is a continuation-in-part of application No. 15/844,387, filed on Dec. 15, 2017.
(60) Provisional application No. 62/273,447, filed on Dec. 31, 2015.
(60) Provisional application No. 62/273,449, filed on Dec. 31, 2015.
(60) Provisional application No. 62/273,450, filed on Dec. 31, 2015.
(60) Provisional application No. 62/273,452, filed on Dec. 31, 2015.
(60) Provisional application No. 62/273,453, filed on Dec. 31, 2015.
(60) Provisional application No. 62/273,447, filed on Dec. 31, 2015.
(60) Provisional application No. 62/273,449, filed on Dec. 31, 2015.
(60) Provisional application No. 62/273,450, filed on Dec. 31, 2015.
(60) Provisional application No. 62/273,452, filed on Dec. 31, 2015.
(60) Provisional application No. 62/273,453, filed on Dec. 31, 2015.
(60) Provisional application No. 62/273,447, filed on Dec. 31, 2015.
(60) Provisional application No. 62/273,449, filed on Dec. 31, 2015.
(60) Provisional application No. 62/273,450, filed on Dec. 31, 2015.
(60) Provisional application No. 62/273,452, filed on Dec. 31, 2015.
(60) Provisional application No. 62/273,453, filed on Dec. 31, 2015.
(60) Provisional application No. 62/273,447, filed on Dec. 31, 2015.
(60) Provisional application No. 62/273,449, filed on Dec. 31, 2015.
(60) Provisional application No. 62/273,450, filed on Dec. 31, 2015.
(60) Provisional application No. 62/273,452, filed on Dec. 31, 2015.
(60) Provisional application No. 62/273,453, filed on Dec. 31, 2015.
(60) Provisional application No. 62/273,447, filed on Dec. 31, 2015.
(60) Provisional application No. 62/273,449, filed on Dec. 31, 2015.
(60) Provisional application No. 62/273,450, filed on Dec. 31, 2015.
(60) Provisional application No. 62/273,452, filed on Dec. 31, 2015.
(60) Provisional application No. 62/273,453, filed on Dec. 31, 2015.

(51) Int. Cl. H04L 9/32; G06F 7/58; H04L 9/00

(52) U.S. Cl. CPC H04L 9/3239; G06F 7/586; H04L 9/50; H04L 2209/56

(57) ABSTRACT

The Computationally Efficient Transfer Processing, Auditing, and Search Apparatuses, Mechanisms, Mediums, Processes and Systems (“SOCOACT”) transforms transfer of assets (TOA) initiation request, brokerage order request, blockchain transaction request, agency action request, borrow transaction request, contract deployment request, transaction signing request, key backup request, key recovery request datastructure/inputs via SOCOACT components into TOA confirm., brokerage order confirm., transaction confirm., agency action notif., borrow transaction init notification, borrow transaction sync notification, contract deployment response, transaction signing resp., key backup resp., key recovery resp. datastructure/outputs. A plurality of transaction record datastructures is received. Transaction amount availability is verified. The transaction record datastructure is cryptographically recorded in a blockchain. Received source address and destination address are hashed. A list representation of the matrix datastructure is generated, where each entry in the list comprises a tuple having the source wallet address, the destination wallet address, the transaction amount and the timestamp.

This application for letters patent disclosure document describes inventive aspects that include various novel innovations (hereinafter “disclosure”) and contains material that is subject to any of: copyright, mask work, and/or other intellectual property protection. The respective owners of such intellectual property have no objection to the facsimile reproduction of the disclosure by anyone as it appears in published Patent Office file/records, but otherwise reserve all rights.

### PRIORITY CLAIM

Applicant hereby claims benefit to priority under 35 USC § 120 as a continuation-in-part of: U.S. patent application Ser. No. 15/844,387, filed Dec. 15, 2017, entitled “Social Data Tracking Datastructures, Apparatuses, Methods and Systems,” (attorney docket no. Fidelity0501US).

Applicant hereby claims benefit to priority under 35 USC § 120 as a continuation-in-part of: U.S. patent application Ser. No. 16/125,608, filed Sep. 7, 2018, entitled “Collateral Management With Blockchain and Smart Contracts Apparatuses, Methods and Systems”, (attorney docket no Fidelity0565CP1); which in turn:
claims benefit to priority under 35 USC § 120 as a continuation-in-part of: U.S. patent application Ser. No. 15/898,220, filed Feb. 15, 2018, entitled “Asynchronous Crypto Asset Transfer and Social Aggregating, Fractionally Efficient Transfer Guidance, Conditional Triggered Transaction, Datastructures, Apparatuses, Methods and Systems”, (attorney docket no. FIDELITY0510CP1); which in turn:
   claims benefit to priority under 35 USC § 120 as a continuation-in-part of: U.S. patent application Ser. No. 15/210,813, filed Jul. 14, 2016, entitled “Crypto Key Recovery and Social Aggregating, Fractionally Efficient Transfer Guidance, Conditional Triggered Transaction, Datastructures, Apparatuses, Methods and Systems,” (attorney docket no. Fidelity367US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,817, filed Jul. 14, 2016, entitled “Crypto Voting and Social Aggregating, Fractionally Efficient Transfer Guidance, Conditional Triggered Transaction, Datastructures, Apparatuses, Methods and Systems,” (attorney docket no. Fidelity390US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,807, filed Jul. 14, 2016, entitled “Smart Rules and Social Aggregating, Fractionally Efficient Transfer Guidance, Conditional Triggered Transaction, Datastructures, Apparatuses, Methods and Systems,” (attorney docket no. Fidelity391US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,795, filed Jul. 14, 2016, entitled “Social Aggregating, Fractionally Efficient Transfer Guidance, Conditional Triggered Transaction, Datastructures, Apparatuses, Methods and Systems,” (attorney docket no. Fidelity392US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,821, filed Jul. 14, 2016, entitled “Crypto Captcha and Social Aggregating, Fractionally Efficient Transfer Guidance, Conditional Triggered Transaction, Datastructures, Apparatuses, Methods and Systems,” (attorney docket no. Fidelity393US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 14/799,282, filed Jul. 14, 2015, entitled “Point-to-Point Transaction Guidance Apparatuses, Methods and Systems,” (attorney docket no. Fidelity336US1);
   claims benefit to priority under 35 USC § 120 as a continuation-in-part of: U.S. patent application Ser. No. 14/799,242, filed Jul. 14, 2015, entitled “Point-to-Point Transaction Guidance Apparatuses, Methods and Systems,” (attorney docket no. Fidelity336US2);
   claims benefit to priority under 35 USC § 120 as a continuation-in-part of: U.S. patent application Ser. No. 14/799,229, filed Jul. 14, 2015, entitled “Point-to-Point Transaction Guidance Apparatuses, Methods and Systems,” (attorney docket no. Fidelity336US3);
   claims benefit to priority under 35 USC § 120 as a continuation-in-part of: U.S. patent application Ser. No. 14/963,165, filed Dec. 8, 2015, entitled “Social Aggregated Fractional Equity Transaction Partitioned Acquisition Apparatuses, Methods and Systems,” (attorney docket no. Fidelity339US);
   claims benefit to priority under 35 USC § 120 as a continuation-in-part of: U.S. patent application Ser. No. 15/019,926, filed Feb. 9, 2016, entitled “Computationally Efficient Transfer Processing and Auditing Apparatuses, Methods and Systems,” (attorney docket no. Fidelity340US);
   claims benefit to priority under 35 USC § 120 as a continuation-in-part of: U.S. patent application Ser. No. 15/209,701, filed Jul. 13, 2016, entitled “Point-to-Point Transaction Guidance Apparatuses, Methods and Systems,” (attorney docket no. Fidelity0336CP1);
   claims benefit to priority under 35 USC § 120 as a continuation-in-part of: U.S. patent application Ser. No. 15/209,709, filed Jul. 13, 2016, entitled “Point-to-Point Transaction Guidance Apparatuses, Methods and Systems,” (attorney docket no. Fidelity0336CP2);
   claims benefit to priority under 35 USC § 120 as a continuation-in-part of: U.S. patent application Ser. No. 15/209,714, filed Jul. 13, 2016, entitled “Point-to-Point Transaction Guidance Apparatuses, Methods and Systems,” (attorney docket no. Fidelity0336CP3);
   claims benefit to priority under 35 USC § 120 as a continuation-in-part of: Patent Cooperation Treaty application serial no. PCT/US16/42169, filed Jul. 13, 2016, entitled “Computationally Efficient Transfer Processing, Auditing, and Search Apparatuses, Methods and Systems,” (attorney docket no. Fidelity0340PC);
   claims benefit to priority under 35 USC § 120 as a continuation-in-part of: U.S. patent application Ser. No. 15/210,781, filed Jul. 14, 2016, entitled “Computationally Efficient Transfer Processing, Auditing, and Search Apparatuses, Methods and Systems,” (attorney docket no. Fidelity0340CP1);
   claims benefit to priority under 35 USC § 120 as a continuation-in-part of: U.S. patent application Ser. No. 15/486,243, filed Apr. 12, 2017, entitled “Computationally Efficient Transfer Processing, Auditing, and Search Apparatuses, Methods and Systems,” (attorney docket no. Fidelity0340CP2A);
   claims benefit to priority under 35 USC § 120 as a continuation-in-part of: U.S. patent application Ser. No. 15/844,375, filed Dec. 15, 2017, entitled “Social Data Tracking Datastructures, Apparatuses, Methods and Systems,” (attorney docket no. Fidelity0477US);
   claims benefit to priority under 35 USC § 120 as a continuation-in-part of: U.S. patent application Ser. No. 15/844,404, filed Dec. 15, 2017, entitled “Social Data Tracking Datastructures, Apparatuses, Methods and Systems,” (attorney docket no. Fidelity0478US);
   claims benefit to priority under 35 USC § 120 as a continuation-in-part of: U.S. patent application Ser. No. 15/844,387, filed Dec. 15, 2017, entitled “Social Data Tracking Datastructures, Apparatuses, Methods and Systems,” (attorney docket no. Fidelity0501US).

Applicant hereby claims benefit to priority under 35 USC § 120 as a continuation-in-part of: U.S. patent application Ser. No. 18/118,741, filed Mar. 7, 2023, entitled “Unified Multi-sig Blockchain Transaction Signing Platform Apparatuses, Processes and Systems”, (attorney docket no. Fidelity0853CP6); and which in turn:
claims benefit to priority under 35 USC § 120 as a continuation-in-part of: U.S. patent application Ser. No. 17/719,344, filed Apr. 12, 2022, entitled “Address Verification, Seed Splitting and Firmware Extension for Secure Cryptocurrency Key Backup, Restore, and Transaction Signing Platform Apparatuses, Methods and Systems”, (attorney docket no. Fidelity0807CP3); and which in turn claims benefit to priority under 35 USC § 120 as a continuation-in-part of: U.S. patent application Ser. No. 16/421,442, filed May 23, 2019, entitled “Seed Splitting and Firmware Extension for Secure Cryptocurrency Key Backup, Restore, and Transaction Signing Platform Apparatuses, Methods and Systems”, (attorney docket no. Fidelity0642CP2); and which in turn claims benefit to priority under 35 USC § 120 as a continuation-in-part of: U.S. patent application Ser. No. 15/984,280, filed May 18, 2018, entitled “Seed Splitting and Firmware Extension for Secure Cryptocurrency Key Backup, Restore, and Transaction Signing Platform Apparatuses, Methods and Systems”, (attorney docket no. Fidelity0506CP1); and which in turn:
   claims benefit to priority under 35 USC § 119 as a non-provisional conversion of: U.S. provisional patent application Ser. No. 62/509,011, filed May 19, 2017, entitled “Secure Firmware Transaction Signing Platform Apparatuses, Methods and Systems”, (attorney docket no. Fidelity0506PV);
   claims benefit to priority under 35 USC § 120 as a continuation-in-part of: U.S. patent application Ser. No. 15/898,224, filed Feb. 15, 2018, entitled “Firmware Extension for Secure Cryptocurrency Key Backup, Restore, and Transaction Signing Platform Apparatuses, Methods and Systems”, (attorney docket no. FIDELITY0512CP1); and which in turn:
   claims benefit to priority under 35 USC § 120 as a continuation-in-part of: U.S. patent application Ser. No. 15/456,461 filed Mar. 10, 2017, entitled “Secure Firmware Transaction Signing Platform Apparatuses, Methods and Systems,” (attorney docket no. FIDELITY0473US1A);
   claims benefit to priority under 35 USC § 120 as a continuation-in-part of: U.S. patent application Ser. No. 15/210,813, filed Jul. 14, 2016, entitled “Crypto Key Recovery and Social Aggregating, Fractionally Efficient Transfer Guidance, Conditional Triggered Transaction, Datastructures, Apparatuses, Methods and Systems,” (attorney docket no. Fidelity367US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,817, filed Jul. 14, 2016, entitled “Crypto Voting and Social Aggregating, Fractionally Efficient Transfer Guidance, Conditional Triggered Transaction, Datastructures, Apparatuses, Methods and Systems,” (attorney docket no. Fidelity390US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,807, filed Jul. 14, 2016, entitled “Smart Rules and Social Aggregating, Fractionally Efficient Transfer Guidance, Conditional Triggered Transaction, Datastructures, Apparatuses, Methods and Systems,” (attorney docket no. Fidelity391US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,795, filed Jul. 14, 2016, entitled “Social Aggregating, Fractionally Efficient Transfer Guidance, Conditional Triggered Transaction, Datastructures, Apparatuses, Methods and Systems,” (attorney docket no. Fidelity392US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,821, filed Jul. 14, 2016, entitled “Crypto Captcha and Social Aggregating, Fractionally Efficient Transfer Guidance, Conditional Triggered Transaction, Datastructures, Apparatuses, Methods and Systems,” (attorney docket no. Fidelity393US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 14/799,282, filed Jul. 14, 2015, entitled “Point-to-Point Transaction Guidance Apparatuses, Methods and Systems,” (attorney docket no. Fidelity336US1);
   claims benefit to priority under 35 USC § 120 as a continuation-in-part of: U.S. patent application Ser. No. 14/799,242, filed Jul. 14, 2015, entitled “Point-to-Point Transaction Guidance Apparatuses, Methods and Systems,” (attorney docket no. Fidelity336US2);
   claims benefit to priority under 35 USC § 120 as a continuation-in-part of: U.S. patent application Ser. No. 14/799,229, filed Jul. 14, 2015, entitled “Point-to-Point Transaction Guidance Apparatuses, Methods and Systems,” (attorney docket no. Fidelity336US3);
   claims benefit to priority under 35 USC § 120 as a continuation-in-part of: U.S. patent application Ser. No. 14/963,165, filed Dec. 8, 2015, entitled “Social Aggregated Fractional Equity Transaction Partitioned Acquisition Apparatuses, Methods and Systems,” (attorney docket no. Fidelity339US);
   claims benefit to priority under 35 USC § 120 as a continuation-in-part of: U.S. patent application Ser. No. 15/019,926, filed Feb. 9, 2016, entitled “Computationally Efficient Transfer Processing and Auditing Apparatuses, Methods and Systems,” (attorney docket no. Fidelity340US);
   claims benefit to priority under 35 USC § 120 as a continuation-in-part of: U.S. patent application Ser. No. 15/209,701, filed Jul. 13, 2016, entitled “Point-to-Point Transaction Guidance Apparatuses, Methods and Systems,” (attorney docket no. Fidelity0336CP1);
   claims benefit to priority under 35 USC § 120 as a continuation-in-part of: U.S. patent application Ser. No. 15/209,709, filed Jul. 13, 2016, entitled “Point-to-Point Transaction Guidance Apparatuses, Methods and Systems,” (attorney docket no. Fidelity0336CP2);
   claims benefit to priority under 35 USC § 120 as a continuation-in-part of: U.S. patent application Ser. No. 15/209,714, filed Jul. 13, 2016, entitled “Point-to-Point Transaction Guidance Apparatuses, Methods and Systems,” (attorney docket no. Fidelity0336CP3);
   claims benefit to priority under 35 USC § 120 as a continuation-in-part of: Patent Cooperation Treaty application serial no. PCT/US16/42169, filed Jul. 13, 2016, entitled “Computationally Efficient Transfer Processing, Auditing, and Search Apparatuses, Methods and Systems,” (attorney docket no. Fidelity0340PC);
   claims benefit to priority under 35 USC § 120 as a continuation-in-part of: U.S. patent application Ser. No. 15/210,781, filed Jul. 14, 2016, entitled “Computationally Efficient Transfer Processing, Auditing, and Search Apparatuses, Methods and Systems,” (attorney docket no. Fidelity0340CP1);
   claims benefit to priority under 35 USC § 120 as a continuation-in-part of: U.S. patent application Ser. No. 15/486,243, filed Apr. 12, 2017, entitled “Computationally Efficient Transfer Processing, Auditing, and Search Apparatuses, Methods and Systems,” (attorney docket no. Fidelity0340CP2A).
claims benefit to priority under 35 USC § 120 as a continuation-in-part of: U.S. patent application Ser. No. 17/719,353, filed Apr. 12, 2022, entitled “Address Verification, Seed Splitting and Firmware Extension for Secure Cryptocurrency Key Backup, Restore, and Transaction Signing Platform Apparatuses, Methods and Systems”, (attorney docket no. Fidelity0807CP4); and which in turn claims benefit to priority under 35 USC § 120 as a continuation-in-part of: U.S. patent application Ser. No. 16/421,442, filed May 23, 2019, entitled “Seed Splitting and Firmware Extension for Secure Cryptocurrency Key Backup, Restore, and Transaction Signing Platform Apparatuses, Methods and Systems”, (attorney docket no. Fidelity0642CP2); and which in turn claims benefit to priority under 35 USC § 120 as a continuation-in-part of: U.S. patent application Ser. No. 15/984,280, filed May 18, 2018, entitled “Seed Splitting and Firmware Extension for Secure Cryptocurrency Key Backup, Restore, and Transaction Signing Platform Apparatuses, Methods and Systems”, (attorney docket no. Fidelity0506CP1); and which in turn:
   claims benefit to priority under 35 USC § 119 as a non-provisional conversion of: U.S. provisional patent application Ser. No. 62/509,011, filed May 19, 2017, entitled “Secure Firmware Transaction Signing Platform Apparatuses, Methods and Systems”, (attorney docket no. Fidelity0506PV);
   claims benefit to priority under 35 USC § 120 as a continuation-in-part of: U.S. patent application Ser. No. 15/898,224, filed Feb. 15, 2018, entitled “Firmware Extension for Secure Cryptocurrency Key Backup, Restore, and Transaction Signing and Systems”, (attorney docket no. Platform Apparatuses, Methods FIDELITY0512CP1); and which in turn:
   claims benefit to priority under 35 USC § 120 as a continuation-in-part of: U.S. patent application Ser. No. 15/456,461 filed Mar. 10, 2017, entitled “Secure Firmware Transaction Signing Platform Apparatuses, Methods and Systems,” (attorney docket no. FIDELITY0473US1A);
   claims benefit to priority under 35 USC § 120 as a continuation-in-part of: U.S. patent application Ser. No. 15/210,813, filed Jul. 14, 2016, entitled “Crypto Key Recovery and Social Aggregating, Fractionally Efficient Transfer Guidance, Conditional Triggered Transaction, Datastructures, Apparatuses, Methods and Systems,” (attorney docket no. Fidelity367US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,817, filed Jul. 14, 2016, entitled “Crypto Voting and Social Aggregating, Fractionally Efficient Transfer Guidance, Conditional Triggered Transaction, Datastructures, Apparatuses, Methods and Systems,” (attorney docket no. Fidelity390US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,807, filed Jul. 14, 2016, entitled “Smart Rules and Social Aggregating, Fractionally Efficient Transfer Guidance, Conditional Triggered Transaction, Datastructures, Apparatuses, Methods and Systems,” (attorney docket no. Fidelity391US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,795, filed Jul. 14, 2016, entitled “Social Aggregating, Fractionally Efficient Transfer Guidance, Conditional Triggered Transaction, Datastructures, Apparatuses, Methods and Systems,” (attorney docket no. Fidelity392US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 15/210,821, filed Jul. 14, 2016, entitled “Crypto Captcha and Social Aggregating, Fractionally Efficient Transfer Guidance, Conditional Triggered Transaction, Datastructures, Apparatuses, Methods and Systems,” (attorney docket no. Fidelity393US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
   claims benefit to priority under 35 USC § 120 as a continuation-in-part of: U.S. patent application Ser. No. 14/799,282, filed Jul. 14, 2015, entitled “Point-to-Point Transaction Guidance Apparatuses, Methods and Systems,” (attorney docket no. Fidelity336US1);
   claims benefit to priority under 35 USC § 120 as a continuation-in-part of: U.S. patent application Ser. No. 14/799,242, filed Jul. 14, 2015, entitled “Point-to-Point Transaction Guidance Apparatuses, Methods and Systems,” (attorney docket no. Fidelity336US2);
   claims benefit to priority under 35 USC § 120 as a continuation-in-part of: U.S. patent application Ser. No. 14/799,229, filed Jul. 14, 2015, entitled “Point-to-Point Transaction Guidance Apparatuses, Methods and Systems,” (attorney docket no. Fidelity336US3);
   claims benefit to priority under 35 USC § 120 as a continuation-in-part of: U.S. patent application Ser. No. 14/963,165, filed Dec. 8, 2015, entitled “Social Aggregated Fractional Equity Transaction Partitioned Acquisition Apparatuses, Methods and Systems,” (attorney docket no. Fidelity339US);
   claims benefit to priority under 35 USC § 120 as a continuation-in-part of: U.S. patent application Ser. No. 15/019,926, filed Feb. 9, 2016, entitled “Computationally Efficient Transfer Processing and Auditing Apparatuses, Methods and Systems,” (attorney docket no. Fidelity340US);
   claims benefit to priority under 35 USC § 120 as a continuation-in-part of: U.S. patent application Ser. No. 15/209,701, filed Jul. 13, 2016, entitled “Point-to-Point Transaction Guidance Apparatuses, Methods and Systems,” (attorney docket no. Fidelity0336CP1);
   claims benefit to priority under 35 USC § 120 as a continuation-in-part of: U.S. patent application Ser. No. 15/209,709, filed Jul. 13, 2016, entitled “Point-to-Point Transaction Guidance Apparatuses, Methods and Systems,” (attorney docket no. Fidelity0336CP2);
   claims benefit to priority under 35 USC § 120 as a continuation-in-part of: U.S. patent application Ser. No. 15/209,714, filed Jul. 13, 2016, entitled “Point-to-Point Transaction Guidance Apparatuses, Methods and Systems,” (attorney docket no. Fidelity0336CP3);
   claims benefit to priority under 35 USC § 120 as a continuation-in-part of: Patent Cooperation Treaty application serial no. PCT/US16/42169, filed Jul. 13, 2016, entitled “Computationally Efficient Transfer Processing, Auditing, and Search Apparatuses, Methods and Systems,” (attorney docket no. Fidelity0340PC);
   claims benefit to priority under 35 USC § 120 as a continuation-in-part of: U.S. patent application Ser. No. 15/210,781, filed Jul. 14, 2016, entitled “Computationally Efficient Transfer Processing, Auditing, and Search Apparatuses, Methods and Systems,” (attorney docket no. Fidelity0340CP1);
   claims benefit to priority under 35 USC § 120 as a continuation-in-part of: U.S. patent application Ser. No. 15/486,243, filed Apr. 12, 2017, entitled “Computationally Efficient Transfer Processing, Auditing, and Search Apparatuses, Methods and Systems,” (attorney docket no. Fidelity0340CP2A).

Applicant hereby claims benefit to priority under 35 USC § 120 as a continuation-in-part of: U.S. application Ser. No. 17/972,559 filed on Oct. 24, 2022, titled “Computationally Efficient Transfer Processing, Auditing, and Search Apparatuses, Methods and Systems” (attorney docket no. Fidelity0340CP3), which in turn:
claims benefit to priority under 35 USC § 120 as a continuation of U.S. application Ser. No. 15/486,243 filed on Apr. 12, 2017, titled “Computationally Efficient Transfer Processing, Auditing, and Search Apparatuses, methods and Systems” (attorney docket no. Fidelity0340CP2A) which in turn claims benefit to priority under 35 USC § 120 as a continuation of U.S. application Ser. No. 15/210,781 titled “Computationally Efficient Transfer Processing, Auditing, and Search Apparatuses, methods and Systems” (attorney docket no Fidelity0340CP1) filed on Jul. 14, 2016, which in turn claims benefit to priority under 35 USC § 120 as a continuation-in-part of: U.S. patent application Ser. No. 14/799,282, filed Jul. 14, 2015, entitled “Point-to-Point Transaction Guidance Apparatuses, Methods and Systems,” (attorney docket no. Fidelity0336US1); U.S. patent application Ser. No. 14/799,242, filed Jul. 14, 2015, entitled “Point-to-Point Transaction Guidance Apparatuses, Methods and Systems,” (attorney docket no. Fidelity336US2); U.S. patent application Ser. No. 14/799,229, filed Jul. 14, 2015, entitled “Point-to-Point Transaction Guidance Apparatuses, Methods and Systems,” (attorney docket no. Fidelity0336US3); U.S. patent application Ser. No. 14/963,165, filed Dec. 8, 2015, entitled “Social Aggregated Fractional Equity Transaction Partitioned Acquisition Apparatuses, Methods and Systems,” (attorney docket no. Fidelity0339US); U.S. patent application Ser. No. 15/019,926, filed Feb. 9, 2016, entitled “Computationally Efficient Transfer Processing and Auditing Apparatuses, Methods and Systems,” (attorney docket no. Fidelity0340US); U.S. patent application Ser. No. 15/209,701, filed Jul. 13, 2016, entitled “Point-to-Point Transaction Guidance Apparatuses, Methods and Systems,” (attorney docket no. Fidelity0336CP1); U.S. patent application Ser. No. 15/209,709, filed Jul. 13, 2016, entitled “Point-to-Point Transaction Guidance Apparatuses, Methods and Systems,” (attorney docket no. Fidelity0336CP2); and U.S. patent application Ser. No. 15/209,714, filed Jul. 13, 2016, entitled “Point-to-Point Transaction Guidance Apparatuses, Methods and Systems,” (attorney docket no. Fidelity0336CP3).

Applicant hereby claims benefit to priority under 35 USC § 120 as a continuation-in-part of U.S. patent application Ser. No. 19/172,599, filed Apr. 7, 2025, entitled “Social Aggregating, Fractionally Efficient Transfer Guidance, Conditional Triggered Transaction, Datastructures, Apparatuses, Methods and Systems” (attorney docket no. Fidelity0642CP3US1), which in turn:
claims benefit to priority under 35 USC § 120 as a continuation of U.S. patent application Ser. No. 17/238,172, filed Apr. 22, 2021, entitled “Social Aggregating, Fractionally Efficient Transfer Guidance, Conditional Triggered Transaction, Datastructures, Apparatuses, Methods and Systems” (attorney docket no. Fidelity0642CP3), which in turn: claims benefit to priority under 35 USC § 120 as a continuation-in-part of the following cases:
   U.S. patent application Ser. No. 16/125,608, filed Sep. 7, 2018, entitled “Collateral Management With Blockchain and Smart Contracts Apparatuses, Methods and Systems”, (attorney docket no Fidelity0565CP1); which in turn:
      claims benefit to priority under 35 USC § 120 as a continuation-in-part of: U.S. patent application Ser. No. 15/898,220, filed Feb. 15, 2018, entitled “Asynchronous Crypto Asset Transfer and Social Aggregating, Fractionally Efficient Transfer Guidance, Conditional Triggered Transaction, Datastructures, Apparatuses, Methods and Systems”, (attorney docket no. FIDELITY0510CP1); which in turn:
         claims benefit to priority under 35 USC § 120 as a continuation-in-part of: U.S. patent application Ser. No. 15/844,375, filed Dec. 15, 2017, entitled “Social Data Tracking Datastructures, Apparatuses, Methods and Systems,” (attorney docket no. Fidelity0477US);
         claims benefit to priority under 35 USC § 120 as a continuation-in-part of: U.S. patent application Ser. No. 15/844,404, filed Dec. 15, 2017, entitled “Social Data Tracking Datastructures, Apparatuses, Methods and Systems,” (attorney docket no. Fidelity0478US);
         claims benefit to priority under 35 USC § 120 as a continuation-in-part of: U.S. patent application Ser. No. 15/844,387, filed Dec. 15, 2017, entitled “Social Data Tracking Datastructures, Apparatuses, Methods and Systems,” (attorney docket no. Fidelity0501US).
         claims benefit priority under 35 USC § 120 as a continuation-in-part of: U.S. patent application Ser. No. 15/210,813, filed Jul. 14, 2016, entitled “Crypto Key Recovery and Social Aggregating, Fractionally Efficient Transfer Guidance, Conditional Triggered Transaction, Datastructures, Apparatuses, Methods and Systems,” (attorney docket no. Fidelity367US);
         claims benefit to priority under 35 USC § 120 as a continuation-in-part of: U.S. patent application Ser. No. 15/210,817, filed Jul. 14, 2016, entitled “Crypto Voting and Social Aggregating, Fractionally Efficient Transfer Guidance, Conditional Triggered Transaction, Datastructures, Apparatuses, Methods and Systems,” (attorney docket no. Fidelity390US);
         claims benefit to priority under 35 USC § 120 as a continuation-in-part of: U.S. patent application Ser. No. 15/210,807, filed Jul. 14, 2016, entitled “Smart Rules and Social Aggregating, Fractionally Efficient Transfer Guidance, Conditional Triggered Transaction, Datastructures, Apparatuses, Methods and Systems,” (attorney docket no. Fidelity391US);
         claims benefit to priority under 35 USC § 120 as a continuation-in-part of: U.S. patent application Ser. No. 15/210,795, filed Jul. 14, 2016, entitled “Social Aggregating, Fractionally Efficient Transfer Guidance, Conditional Triggered Transaction, Datastructures, Apparatuses, Methods and Systems,” (attorney docket no. Fidelity392US);
         claims benefit to priority under 35 USC § 120 as a continuation-in-part of: U.S. patent application Ser. No. 15/210,821, filed Jul. 14, 2016, entitled “Crypto Captcha and Social Aggregating, Fractionally Efficient Transfer Guidance, Conditional Triggered Transaction, Datastructures, Apparatuses, Methods and Systems,” (attorney docket no. Fidelity393US);
         Applicant hereby claims benefit to priority under 35 USC § 120 as a continuation-in-part of: U.S. patent application Ser. No. 15/486,243, filed Apr. 12, 2017, entitled “Computationally Efficient Transfer Processing, Auditing, and Search Apparatuses, Methods and Systems,” (attorney docket no. Fidelity0340CP2A); which in turn:
         claims benefit to priority under 35 USC § 120 as a continuation-in-part of: Patent Cooperation Treaty application serial no. PCT/US16/42169, filed Jul. 13, 2016, entitled “Computationally Efficient Transfer Processing, Auditing, and Search Apparatuses, Methods and Systems,” (attorney docket no. Fidelity0340PC);
         claims benefit to priority under 35 USC § 120 as a continuation-in-part of: U.S. patent application Ser. No. 15/210,781, filed Jul. 14, 2016, entitled “Computationally Efficient Transfer Processing, Auditing, and Search Apparatuses, Methods and Systems,” (attorney docket no. Fidelity0340CP1); which in turn:
         claims benefit to priority under 35 USC § 120 as a continuation-in-part of: U.S. patent application Ser. No. 15/019,926, filed Feb. 9, 2016, entitled “Computationally Efficient Transfer Processing and Auditing Apparatuses, Methods and Systems,” (attorney docket no. Fidelity340US);
         claims benefit to priority under 35 USC § 120 as a continuation-in-part of: U.S. patent application Ser. No. 15/209,701, filed Jul. 13, 2016, entitled “Point-to-Point Transaction Guidance Apparatuses, Methods and Systems,” (attorney docket no. Fidelity0336CP1);
         claims benefit to priority under 35 USC § 120 as a continuation-in-part of: U.S. patent application Ser. No. 15/209,714, filed Jul. 13, 2016, entitled “Point-to-Point Transaction Guidance Apparatuses, Methods and Systems,” (attorney docket no. Fidelity0336CP3);
         claims benefit to priority under 35 USC § 120 as a continuation-in-part of: U.S. patent application Ser. No. 15/209,709, filed Jul. 13, 2016, entitled “Point-to-Point Transaction Guidance Apparatuses, Methods and Systems,” (attorney docket no. Fidelity0336CP2); which in turn:
         claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV);
         claims benefit to priority under 35 USC § 119 as a non-provisional conversion of: U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV);
         claims benefit to priority under 35 USC § 119 as a non-provisional conversion of: U.S. provisional patent application Ser. No. 62/273,450, filed Dec. 31, 2015, entitled “Social Aggregating, Fractionally Efficient Transfer Guidance, Conditional Triggered Transaction, Datastructures, Systems,” Apparatuses, Methods and (attorney docket no. Fidelity391PV);
         claims benefit to priority under 35 USC § 119 as a non-provisional conversion of: U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV);
         claims benefit to priority under 35 USC § 119 as a non-provisional conversion of: U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
         claims benefit to priority under 35 USC § 120 as a continuation-in-part of: U.S. patent application Ser. No. 14/963,165, filed Dec. 8, 2015, entitled “Social Aggregated Fractional Equity Transaction Partitioned Acquisition Apparatuses, Methods and Systems,” (attorney docket no. Fidelity339US);
         claims benefit to priority under 35 USC § 120 as a continuation-in-part of: U.S. patent application Ser. No. 14/799,282, filed Jul. 14, 2015, entitled “Point-to-Point Transaction Guidance Apparatuses, Methods and Systems,” (attorney docket no. Fideli-ty336US1);
         claims benefit to priority under 35 USC § 120 as a continuation-in-part of: U.S. patent application Ser. No. 14/799,242, filed Jul. 14, 2015, entitled “Point-to-Point Transaction Guidance Apparatuses, Methods and Systems,” (attorney docket no. Fideli-ty336US2);
         claims benefit to priority under 35 USC § 120 as a continuation-in-part of: U.S. patent application Ser. No. 14/799,229, filed Jul. 14, 2015, entitled “Point-to-Point Transaction Guidance Apparatuses, Methods and Systems,” (attorney docket no. Fideli-ty336US3);
   U.S. patent application Ser. No. 16/421,442, filed May 23, 2019, entitled “Seed Splitting and Firmware Extension for Secure Cryptocurrency Key Backup, Restore, and Transaction Signing Platform Apparatuses, Methods and Systems”, (attorney docket no Fidelity0642CP2); which in turn:
      claims priority under 35 USC 120 as a continuation-in-part of U.S. patent application Ser. No. 15/984,280, filed May 18, 2018, entitled “Seed Splitting and Firmware Extension for Secure Cryptocurrency Key Backup, Restore, and Transaction Signing Platform Apparatuses, Methods and Systems”, (attorney docket no Fidelity0506CP1); which in turn:
         claims benefit to priority under 35 USC § 119 as a non-provisional conversion of: U.S. provisional patent application Ser. No. 62/509,011, filed May 19, 2017, entitled “Secure Firmware Transaction Signing Platform Apparatuses, Methods and Systems”, (attorney docket no. Fidelity0506PV);
         claims benefit to priority under 35 USC § 120 as a continuation-in-part of: U.S. patent application Ser. No. 15/898,224, filed Feb. 15, 2018, entitled “Firmware Extension for Secure Cryptocurrency Key Backup, Restore, and Transaction Signing Platform Apparatuses, Methods and Systems”, (attorney docket no. FIDELITY0512CP1), which in turn:
         claims benefit to priority under 35 USC § 120 as a continuation-in-part of: U.S. patent application Ser. No. 15/456,461 filed Mar. 10, 2017, entitled “Secure Firmware Transaction Signing Platform Apparatuses, Methods and Systems,” (attorney docket no. FIDELITY0473US1A).

Applicant hereby claims benefit to priority under 35 USC § 120 as a continuation-in-part of: U.S. patent application Ser. No. 15/898,220, filed Feb. 15, 2018, entitled “Asynchronous Crypto Asset Transfer and Social Aggregating, Fractionally Efficient Transfer Guidance, Conditional Triggered Transaction, Datastructures, Apparatuses, Methods and Systems”, (attorney docket no. FIDELITY0510CP1); and which in turn:
claims benefit to priority under 35 USC § 120 as a continuation-in-part of: U.S. patent application Ser. No. 15/210,813, filed Jul. 14, 2016, entitled “Crypto Key Recovery and Social Aggregating, Fractionally Efficient Transfer Guidance, Conditional Triggered Transaction, Datastructures, Apparatuses, Methods and Systems,” (attorney docket no. Fidelity367US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
claims benefit to priority under 35 USC § 120 as a continuation-in-part of: U.S. patent application Ser. No. 15/210,817, filed Jul. 14, 2016, entitled “Crypto Voting and Social Aggregating, Fractionally Efficient Transfer Guidance, Conditional Triggered Transaction, Datastructures, Apparatuses, Methods and Systems,” (attorney docket no. Fidelity390US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
claims benefit to priority under 35 USC § 120 as a continuation-in-part of: U.S. patent application Ser. No. 15/210,807, filed Jul. 14, 2016, entitled “Smart Rules and Social Aggregating, Fractionally Efficient Transfer Guidance, Conditional Triggered Transaction, Datastructures, Apparatuses, Methods and Systems,” (attorney docket no. Fidelity391US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
claims benefit to priority under 35 USC § 120 as a continuation-in-part of: U.S. patent application Ser. No. 15/210,795, filed Jul. 14, 2016, entitled “Social Aggregating, Fractionally Efficient Transfer Guidance, Conditional Triggered Transaction, Datastructures, Apparatuses, Methods and Systems,” (attorney docket no. Fidelity392US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
claims benefit to priority under 35 USC § 120 as a continuation-in-part of: U.S. patent application Ser. No. 15/210,821, filed Jul. 14, 2016, entitled “Crypto Captcha and Social Aggregating, Fractionally Efficient Transfer Guidance, Conditional Triggered Transaction, Datastructures, Apparatuses, Methods and Systems,” (attorney docket no. Fidelity393US); and which in turn claims benefit to priority under 35 USC § 119 as a non-provisional conversion of: U.S. provisional patent application Ser. No. 62/273,447, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity367PV), U.S. provisional patent application Ser. No. 62/273,449, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity390PV), U.S. provisional patent application Ser. No. 62/273,450, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity391PV), U.S. provisional patent application Ser. No. 62/273,452, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity392PV), U.S. provisional patent application Ser. No. 62/273,453, filed Dec. 31, 2015, entitled “Social Aggregating, Fractionally Efficient Transfer Guidance, Conditional Triggered Transaction, Datastructures, Apparatuses, Methods and Systems,” (attorney docket no. Fidelity393PV);
claims benefit to priority under 35 USC § 120 as a continuation-in-part of: U.S. patent application Ser. No. 14/799,282, filed Jul. 14, 2015, entitled “Point-to-Point Transaction Guidance Apparatuses, Methods and Systems,” (attorney docket no. Fidelity336US1);
claims benefit to priority under 35 USC § 120 as a continuation-in-part of: U.S. patent application Ser. No. 14/799,242, filed Jul. 14, 2015, entitled “Point-to-Point Transaction Guidance Apparatuses, Methods and Systems,” (attorney docket no. Fidelity336US2);
claims benefit to priority under 35 USC § 120 as a continuation-in-part of: U.S. patent application Ser. No. 14/799,229, filed Jul. 14, 2015, entitled “Point-to-Point Transaction Guidance Apparatuses, Methods and Systems,” (attorney docket no. Fidelity336US3);
claims benefit to priority under 35 USC § 120 as a continuation-in-part of: U.S. patent application Ser. No. 14/963,165, filed Dec. 8, 2015, entitled “Social Aggregated Fractional Equity Transaction Partitioned Acquisition Apparatuses, Methods and Systems,” (attorney docket no. Fidelity339US);
claims benefit to priority under 35 USC § 120 as a continuation-in-part of: U.S. patent application Ser. No. 15/019,926, filed Feb. 9, 2016, entitled “Computationally Efficient Transfer Processing and Auditing Apparatuses, Methods and Systems,” (attorney docket no. Fidelity340US);
claims benefit to priority under 35 USC § 120 as a continuation-in-part of: U.S. patent application Ser. No. 15/209,701, filed Jul. 13, 2016, entitled “Point-to-Point Transaction Guidance Apparatuses, Methods and Systems,” (attorney docket no. Fidelity0336CP1);
claims benefit to priority under 35 USC § 120 as a continuation-in-part of: U.S. patent application Ser. No. 15/209,709, filed Jul. 13, 2016, entitled “Point-to-Point Transaction Guidance Apparatuses, Methods and Systems,” (attorney docket no. Fidelity0336CP2);
claims benefit to priority under 35 USC § 120 as a continuation-in-part of: U.S. patent application Ser. No. 15/209,714, filed Jul. 13, 2016, entitled “Point-to-Point Transaction Guidance Apparatuses, Methods and Systems,” (attorney docket no. Fidelity0336CP3);
claims benefit to priority under 35 USC § 120 as a continuation-in-part of: Patent Cooperation Treaty application serial no. PCT/US16/42169, filed Jul. 13, 2016, entitled “Computationally Efficient Transfer Processing, Auditing, and Search Apparatuses, Methods and Systems,” (attorney docket no. Fidelity0340PC);
claims benefit to priority under 35 USC § 120 as a continuation-in-part of: U.S. patent application Ser. No. 15/210,781, filed Jul. 14, 2016, entitled “Computationally Efficient Transfer Processing, Auditing, and Search Apparatuses, Methods and Systems,” (attorney docket no. Fidelity0340CP1);
claims benefit to priority under 35 USC § 120 as a continuation-in-part of: U.S. patent application Ser. No. 15/486,243, filed Apr. 12, 2017, entitled “Computationally Efficient Transfer Processing, Auditing, and Search Apparatuses, Methods and Systems,” (attorney docket no. Fidelity0340CP2A);
claims benefit to priority under 35 USC § 120 as a continuation-in-part of: U.S. patent application Ser. No. 15/844,375, filed Dec. 15, 2017, entitled “Social Data Tracking Datastructures, Apparatuses, Methods and Systems,” (attorney docket no. Fidelity0477US);
claims benefit to priority under 35 USC § 120 as a continuation-in-part of: U.S. patent application Ser. No. 15/844,404, filed Dec. 15, 2017, entitled “Social Data Tracking Datastructures, Apparatuses, Methods and Systems,” (attorney docket no. Fidelity0478US);
claims benefit to priority under 35 USC § 120 as a continuation-in-part of: U.S. patent application Ser. No. 15/844,387, filed Dec. 15, 2017, entitled “Social Data Tracking Datastructures, Apparatuses, Methods and Systems,” (attorney docket no. Fidelity0501US).

The entire contents of the target sources, e.g., aforementioned applications, are herein expressly incorporated by reference and any and all such incorporations by reference throughout the disclosure are to be considered actual and literal incorporations, in which the literal incorporation is considered to be an actual appending of the target sources en toto (e.g., charts, tables, text, visuals, etc.) into the current disclosure, as if it were typed and/or placed herein, originally, at the time of the disclosure; and such incorporation is instituted with no prejudice nor disclaimer of any matter, and no reading into any contrast as to any differences and/or similarity as between the instant disclosure and the target source matter is to be discerned because the incorporated matter is to be considered as literally present herein as part of the instant application at the time of drafting and filing, and no other interpretations are contemplated nor to be considered legitimate.

### FIELD

The present innovations generally address information technology, and more particularly, include Computationally Efficient Transfer Processing, Auditing, and Search Apparatuses, Mechanisms, Mediums, Processes and Systems.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. § 112.

### BACKGROUND

Bitcoin is the first successful implementation of a distributed crypto-currency. Bitcoin is more correctly described as the first decentralized digital currency. It is the largest of its kind in terms of total market value and is built upon the notion that money is any object, or any sort of record, accepted as payment for goods and services and repayment of debts. Bitcoin is designed around the idea of using cryptography to control the creation and transfer of money. Bitcoin enables instant payments to anyone, anywhere in the world. Bitcoin uses peer-to-peer technology to operate with no central authority. Transaction management and money issuance are carried out collectively by the network via consensus.

Bitcoin is an open source software application and a shared protocol. It allows users to anonymously and instantaneously transact Bitcoin, a digital currency, without needing to trust counterparties or separate intermediaries. Bitcoin achieves this trustless anonymous network using public/private key pairs, a popular encryption technique.

Bitcoin, a cryptographically secure decentralized peer-to-peer (P2P) electronic payment system enables transactions involving virtual currency in the form of digital tokens. Such digital tokens, Bitcoin coins (BTCs), are a type of crypto-currency whose implementation relies on cryptography to generate the tokens as well as validate related transactions. Bitcoin solves counterfeiting and double-spending problems without any centralized authority. It replaces trust in a third-party such as a bank with a cryptographic proof using a public digital ledger accessible to all network nodes in which all BTC balances and transactions are announced, agreed upon, and recorded. Transactions are time-stamped by hashing them into an ongoing chain of hash-based proof-of-work (PoW) forming a record that can't be changed without redoing the entire chain. Anonymity is maintained through public-key cryptography by using peer-to-peer (P2P) addresses without revealing user identity.

Bitcoin coin (BTC) is essentially a hashed chain of digital signatures based upon asymmetric or public key cryptography. Each participating Bitcoin address in the P2P network is associated with a matching public key and private key wherein a message signed by private key can be verified by others using the matching public key. A Bitcoin address corresponds to the public key which is a string of 27-34 alphanumeric characters (such as: 1BZ9aCZ4hHX7rnnrt2uHTfYAS4hRbph3UN or 181TK6dMSy88SvjNImmoDkjB9TmvXRqCCv) and occupies about 500 bytes. The address is not a public key. An Address is a RIPEMD-160 hash of an SHA256 hash of a public key. If that public key hashes (RIPEMD160) to the Bitcoin Address in a previously unclaimed transaction, it can be spent. Users are encouraged to create a new address for every transaction to increase privacy for both sender and receiver. While this creates anonymity for both sender and receiver, however, given irreversibility of transactions, nonrepudiation may be compromised. Addresses can be created using Bitcoin clients or ‘wallets’. The sender uses his or her private key to assign payments to receiver's public key or address. Characters within the address also serve as checksum to validate any typographical errors in typing the address. The private key is the secret key that is necessary to access BTCs assigned to the corresponding public key address. Private keys start with first character ‘1’ or ‘3,’ where ‘1’ implies use of one key while ‘3’ denotes multiple private keys for ‘unlocking’ a payment. Bitcoin addresses and associated private keys are stored in encrypted wallet data files typically backed up offline for security. If a wallet or a private key is lost, related BTCs are then also irretrievably lost.

### BRIEF DESCRIPTION OF THE DRAWINGS

Appendices and/or drawings illustrating various, non-limiting, example, innovative aspects of the Computationally Efficient Transfer Processing, Auditing, and Search Apparatuses, Mechanisms, Mediums, Processes and Systems (hereinafter “SOCOACT”) disclosure, include:

FIG. 1A shows an exemplary model for the SOCOACT;

FIG. 1A2 shows an exemplary model for the SOCOACT;

FIG. 1B shows a block diagram illustrating embodiments of a network environment including the SOCOACT;

FIG. 2 shows a block diagram illustrating embodiments of a network environment including the SOCOACT;

FIG. 3 shows a block diagram illustrating embodiments of a network nodes of the SOCOACT

FIG. 4 shows a datagraph diagram illustrating embodiments of a login process for the SOCOACT;

FIG. 5 shows a datagraph illustrating embodiments of an event trace for a typical transaction for the SOCOACT;

FIG. 6 shows a flowchart of a blockchain generation process for the SOCOACT;

FIG. 7 shows a flowchart of a blockchain auditing process for the SOCOACT;

FIG. 8 shows a flowchart of a virtual currency transaction process for the SOCOACT;

FIG. 9 shows a Bluetooth or NFC-enabled environment for enabling a SOCOACT transaction;

FIG. 10 shows a flowchart of a Bluetooth payment process for the SOCOACT;

FIG. 11 shows a flowchart of a Bluetooth inter-party payment process for the SOCOACT;

FIG. 12 shows a flowchart of a verified payment process for the SOCOACT;

FIG. 13 shows a flowchart of a meter reading process for the SOCOACT;

FIG. 14 shows a flowchart of a resource monitoring process for the SOCOACT;

FIG. 15 shows a flowchart of a micropayment button payment process for the SOCOACT;

FIG. 16 shows a flowchart of a personnel tracking process for the SOCOACT;

FIG. 17 shows a flowchart of a voting process for the SOCOACT;

FIG. 18 shows a logic flow diagram illustrating embodiments of a fractional ownership equity purchase process for the SOCOACT;

FIG. 19 shows a datagraph diagram illustrating embodiments of an equity research process for the SOCOACT;

FIG. 20 shows a datagraph diagram illustrating embodiments of a fractional ownership equity transaction process for the SOCOACT;

FIG. 21 shows a datagraph diagram illustrating embodiments of an equity ownership audit process for the SOCOACT;

FIG. 22 shows a schematic representation of generating an ownership block for the blockchain maintained by the SOCOACT;

FIG. 23 shows a schematic representation of the data structure of an equity ownership transaction block in the blockchain maintained by the SOCOACT;

FIG. 24 shows a schematic representation of the data structure of the blockheader field of the ownership transaction block in the blockchain maintained by the SOCOACT;

FIG. 25 shows a schematic representation of the creation of a blockchain from individual blocks as may be performed by the SOCOACT;

FIG. 26 is a schematic graphical representation of possible transactions between multiple parties that may be performed via the SOCOACT;

FIG. 27 shows a datagraph of a general matrix determination and tuple storage process as may be performed by the SOCOACT in various embodiments;

FIG. 28 shows a flow chart of a general matrix determination and LIL tuple storage process as may be performed by the SOCOACT in various embodiments;

FIG. 29 shows a flow chart of a general transaction query process as may be performed via the SOCOACT in various embodiments;

FIG. 30 shows a schematic representation of the data structure of the inputs and outputs for Bitcoin-like transactions performed by the SOCOACT;

FIG. 31 is an exemplary representation of a distance matrix generated by the SOCOACT to represent the various transactions depicted in FIG. 30;

FIG. 32 is an exemplary representation of a distance matrix generated by the SOCOACT to represent BTC outflow from the various vertices of FIG. 30;

FIG. 33 is an exemplary representation of a distance matrix generated by the SOCOACT to represent BTC inflow from the various vertices of FIG. 30;

FIG. 34 is an exemplary representation of a sparse matrix generated by the SOCOACT from the distance matrix of FIG. 31;

FIG. 35 is a schematic representation of a Bloom Filter as may be used by the SOCOACT for string storage and query;

FIG. 36 is a schematic representation the data structure of transaction tuples stored by the SOCOACT;

FIG. 37 shows an exemplary model for the SOCOACT;

FIG. 38 shows an exemplary model for the SOCOACT;

FIG. 39 shows an exemplary usage scenario for the SOCOACT;

FIGS. 40A-40B show a datagraph diagram illustrating embodiments of a data flow for the SOCOACT;

FIG. 41 shows a logic flow diagram illustrating embodiments of a smart contract generating (SCG) component for the SOCOACT;

FIG. 42 shows a logic flow diagram illustrating embodiments of a smart contract fulfillment (SCF) component for the SOCOACT;

FIG. 43 shows a screenshot diagram illustrating embodiments of the SOCOACT;

FIG. 44 shows a screenshot diagram illustrating embodiments of the SOCOACT;

FIG. 45 shows a screenshot diagram illustrating embodiments of the SOCOACT;

FIG. 46 shows a datagraph diagram illustrating embodiments of a data flow for the SOCOACT;

FIG. 47 shows a logic flow diagram illustrating embodiments of a MKADSD generating (MKADSDG) component for the SOCOACT;

FIG. 48 shows a logic flow diagram illustrating embodiments of a crypto key recovery (CKR) component for the SOCOACT;

FIG. 49 shows a datagraph diagram illustrating embodiments of a data flow for the SOCOACT;

FIG. 50 shows a logic flow diagram illustrating embodiments of a voter authentication (VA) component for the SOCOACT;

FIG. 51 shows a logic flow diagram illustrating embodiments of a vote processing (VP) component for the SOCOACT;

FIG. 52 shows a screenshot diagram illustrating embodiments of the SOCOACT;

FIG. 53 shows a screenshot diagram illustrating embodiments of the SOCOACT;

FIG. 54 shows a screenshot diagram illustrating embodiments of the SOCOACT;

FIG. 55 shows a datagraph diagram illustrating embodiments of a data flow for the SOCOACT;

FIG. 56 shows a logic flow diagram illustrating embodiments of a verification processing (VEP) component for the SOCOACT;

FIG. 57 shows a screenshot diagram illustrating embodiments of the SOCOACT;

FIG. 58 shows an exemplary transfer of assets (TOA) integration model for the SOCOACT;

FIG. 59 shows an exemplary TOA model for the SOCOACT;

FIG. 60 shows an exemplary architecture for the SOCOACT;

FIG. 61 shows an exemplary broker to broker API calls model for the SOCOACT;

FIG. 62 shows an exemplary broker to broker API calls model for the SOCOACT;

FIG. 63 shows an exemplary smart contracts model for the SOCOACT;

FIG. 64 shows an exemplary smart contracts model for the SOCOACT;

FIG. 65 shows a datagraph diagram illustrating embodiments of a data flow for the SOCOACT;

FIG. 66 shows a logic flow diagram illustrating embodiments of a TOA transaction initiating (TTI) component for the SOCOACT;

FIG. 67 shows a logic flow diagram illustrating embodiments of a TOA transaction processing (TTP) component for the SOCOACT;

FIG. 68 shows a screenshot diagram illustrating embodiments of the SOCOACT;

FIG. 69 shows a screenshot diagram illustrating embodiments of the SOCOACT;

FIG. 70 shows an exemplary identity verification model for the SOCOACT;

FIG. 71 shows an exemplary hash calculation for the SOCOACT;

FIG. 72 shows an exemplary asset creation model for the SOCOACT;

FIG. 73 shows an exemplary asset creation model for the SOCOACT;

FIG. 74 shows an exemplary asset issuance model for the SOCOACT;

FIG. 75 shows an exemplary asset issuance model for the SOCOACT;

FIG. 76 shows an exemplary wallet administration model for the SOCOACT;

FIG. 77 shows an exemplary TOA blockchain transaction for the SOCOACT;

FIG. 78 shows an exemplary TOA smart contract for the SOCOACT;

FIG. 79 shows an exemplary embodiment of a user data model for the SOCOACT;

FIGS. 80A-80B show exemplary embodiments of transactions and tree state for the SOCOACT;

FIGS. 81A-81B show a datagraph diagram illustrating embodiments of a data flow for the SOCOACT;

FIG. 82 shows a logic flow diagram illustrating embodiments of an order processing (OP) component for the SOCOACT;

FIG. 83 shows a logic flow diagram illustrating embodiments of an access facilitating (AF) component for the SOCOACT;

FIG. 84 shows a logic flow diagram illustrating embodiments of a storage facilitating (SF) component for the SOCOACT;

FIG. 85 shows a logic flow diagram illustrating embodiments of a transaction validating (TV) component for the SOCOACT;

FIGS. 86A-86B show a datagraph diagram illustrating embodiments of a data flow for the SOCOACT;

FIG. 87 shows a logic flow diagram illustrating embodiments of a transaction processing (TP) component for the SOCOACT;

FIG. 88 shows a logic flow diagram illustrating embodiments of an agency action (AA) component for the SOCOACT;

FIG. 89 shows an exemplary use case for the SOCOACT;

FIGS. 90A-90B show a datagraph diagram illustrating embodiments of a data flow for the SOCOACT;

FIG. 91 shows a logic flow diagram illustrating embodiments of a transaction processing (TP) component for the SOCOACT;

FIG. 92 shows a logic flow diagram illustrating embodiments of an inter-blockchain exchange processing (IEP) component for the SOCOACT;

FIG. 93 shows an exemplary blockchain exchange model for the SOCOACT;

FIG. 94 shows an architecture for the SOCOACT;

FIG. 95 shows an architecture for the SOCOACT;

FIG. 96 shows implementation case(s) for the SOCOACT;

FIG. 97 shows a datagraph illustrating data flow(s) for the SOCOACT;

FIG. 98 shows a datagraph illustrating data flow(s) for the SOCOACT;

FIG. 99A shows a logic flow illustrating embodiments of a blockchain sync adapter (BSA) component for the SOCOACT;

FIG. 99B shows a logic flow illustrating embodiments of a transaction process optimizer (TPO) component for the SOCOACT;

FIG. 100 shows a screenshot for the SOCOACT;

FIG. 101 shows a screenshot illustrating user interface(s) of the SOCOACT;

FIG. 102 shows a screenshot illustrating user interface(s) of the SOCOACT;

FIG. 103 shows a screenshot illustrating user interface(s) of the SOCOACT;

FIG. 104 shows a screenshot illustrating user interface(s) of the SOCOACT;

FIG. 105 shows a screenshot illustrating user interface(s) of the SOCOACT;

FIG. 106 shows a screenshot illustrating user interface(s) of the SOCOACT;

FIG. 107 shows a screenshot illustrating user interface(s) of the SOCOACT;

FIG. 108 shows a screenshot illustrating user interface(s) of the SOCOACT;

FIG. 109 shows a screenshot illustrating user interface(s) of the SOCOACT;

FIG. 110 shows a screenshot illustrating user interface(s) of the SOCOACT;

FIG. 111 shows a screenshot illustrating user interface(s) of the SOCOACT;

FIG. 112 shows a screenshot illustrating user interface(s) of the SOCOACT;

FIG. 113 shows a screenshot illustrating user interface(s) of the SOCOACT;

FIGS. 114A-B show exemplary architectures for the SOCOACT;

FIGS. 115A-B show exemplary deployment diagrams for the SOCOACT;

FIG. 116 shows an exemplary single HSM use case for the SOCOACT;

FIGS. 117A-B show exemplary dual HSM use cases for the SOCOACT;

FIG. 118A shows a datagraph diagram illustrating embodiments of a data flow for the SOCOACT;

FIGS. 118B-C show a datagraph diagram illustrating embodiments of a data flow for the SOCOACT;

FIG. 119A shows a logic flow diagram illustrating embodiments of a secure firmware transaction signing (SFTS) component for the SOCOACT;

FIG. 119B shows a logic flow diagram illustrating embodiments of a transaction server transaction signing (TSTS) component for the SOCOACT;

FIG. 119C shows a logic flow diagram illustrating embodiments of a secure firmware transaction signing (SFTS) component for the SOCOACT;

FIGS. 120A-B shows an exemplary data model for the SOCOACT;

FIG. 121 shows an exemplary authentication model for the SOCOACT;

FIG. 122 shows an exemplary authentication use case for the SOCOACT;

FIG. 123 shows an exemplary key backup model for the SOCOACT;

FIGS. 124A-B show a datagraph diagram illustrating embodiments of a data flow for the SOCOACT;

FIG. 125 shows a logic flow diagram illustrating embodiments of a backup utility key backup (BUKB) component for the SOCOACT;

FIG. 126 shows a logic flow diagram illustrating embodiments of a secure firmware key backup (SFKB) component for the SOCOACT;

FIG. 127 shows a screenshot diagram illustrating embodiments of the SOCOACT;

FIG. 128 shows a screenshot diagram illustrating embodiments of the SOCOACT;

FIG. 129A shows an exemplary seed shares geographic distribution model for the SOCOACT;

FIG. 129B shows an exemplary seed shares implementation case for the SOCOACT;

FIG. 130 shows a screenshot diagram illustrating embodiments of the SOCOACT;

FIG. 131 shows an exemplary key recovery model for the SOCOACT;

FIG. 132 shows a datagraph diagram illustrating embodiments of a data flow for the SOCOACT;

FIG. 133 shows a logic flow diagram illustrating embodiments of a recovery utility key recovery (RUKR) component for the SOCOACT;

FIG. 134 shows a logic flow diagram illustrating embodiments of a secure firmware key recovery (SFKR) component for the SOCOACT;

FIG. 135 shows a screenshot diagram illustrating embodiments of the SOCOACT;

FIG. 136 shows an exemplary architecture for the SOCOACT;

FIGS. 137A-B show a datagraph diagram illustrating embodiments of a data flow for the SOCOACT;

FIG. 138 shows a logic flow diagram illustrating embodiments of a transaction server transaction signing (TSTS) component for the SOCOACT;

FIG. 139 shows a logic flow diagram illustrating embodiments of a secure firmware transaction signing (SFTS) component for the SOCOACT;

FIGS. 140A-C show a datagraph diagram illustrating embodiments of a data flow for the SOCOACT;

FIG. 141 shows a logic flow diagram illustrating embodiments of an online transaction server transaction signing (NTSTS) component for the SOCOACT;

FIG. 142 shows a logic flow diagram illustrating embodiments of a hot secure firmware transaction signing (HSFTS) component for the SOCOACT;

FIG. 143 shows a logic flow diagram illustrating embodiments of an offline transaction server transaction signing (FTSTS) component for the SOCOACT;

FIG. 144 shows a logic flow diagram illustrating embodiments of a cold secure firmware transaction signing (CSFTS) component for the SOCOACT;

FIG. 145 shows non-limiting, example embodiments of an architecture for the SOCOACT;

FIG. 146 shows non-limiting, example embodiments of a contract deployment architecture for the SOCOACT;

FIGS. 147A-B show non-limiting, example embodiments of a datagraph illustrating data flow(s) for the SOCOACT;

FIG. 148 shows non-limiting, example embodiments of a logic flow illustrating a transaction server contract deployment (TSCD) component for the SOCOACT;

FIG. 149 shows non-limiting, example embodiments of a logic flow illustrating a secure firmware contract deployment (SFCD) component for the SOCOACT;

FIG. 150 shows non-limiting, example embodiments of a transaction signing architecture for the SOCOACT;

FIGS. 151A-B show non-limiting, example embodiments of a datagraph illustrating data flow(s) for the SOCOACT;

FIG. 152 shows non-limiting, example embodiments of a logic flow illustrating a transaction server contract transaction signing (TSCTS) component for the SOCOACT;

FIG. 153 shows non-limiting, example embodiments of a logic flow illustrating a secure firmware contract transaction signing (SFCTS) component for the SOCOACT;

FIG. 154 shows non-limiting, example embodiments of an architecture for the SOCOACT;

FIG. 155 shows non-limiting, example embodiments of an architecture for the SOCOACT;

FIG. 156 shows non-limiting, example embodiments of an architecture for the SOCOACT;

FIGS. 157A-B show non-limiting, example embodiments of a datagraph illustrating data flow(s) for the SOCOACT;

FIG. 158 shows non-limiting, example embodiments of a logic flow illustrating an online transaction server integrity-enhanced transaction signing (NTSITS) component for the SOCOACT;

FIG. 159 shows non-limiting, example embodiments of a logic flow illustrating an offline transaction server integrity-enhanced transaction signing (FTSITS) component for the SOCOACT;

FIG. 160 shows non-limiting, example embodiments of a logic flow illustrating a secure firmware integrity-enhanced transaction signing (SFITS) component for the SOCOACT;

FIG. 161 shows non-limiting, example embodiments of implementation case(s) for the SOCOACT;

FIG. 162 shows non-limiting, example embodiments of implementation case(s) for the SOCOACT;

FIG. 163 shows non-limiting, example embodiments of an architecture for the SOCOACT;

FIG. 164 shows non-limiting, example embodiments of an architecture for the SOCOACT;

FIGS. 165A-C show non-limiting, example embodiments of a datagraph illustrating data flow(s) for the SOCOACT;

FIG. 166 shows non-limiting, example embodiments of a logic flow illustrating a multi-coin omnibus wallet unified multi-sig transaction signing (MOWUMTS) component for the SOCOACT;

FIG. 167 shows non-limiting, example embodiments of a logic flow illustrating an online transaction server unified multi-sig transaction signing (NTSUMTS) component for the SOCOACT;

FIG. 168 shows non-limiting, example embodiments of a logic flow illustrating a hot secure firmware unified multi-sig transaction signing (HSFUMTS) component for the SOCOACT;

FIG. 169 shows non-limiting, example embodiments of a logic flow illustrating an offline transaction server unified multi-sig transaction signing (FTSUMTS) component for the SOCOACT;

FIG. 170 shows non-limiting, example embodiments of a logic flow illustrating a cold secure firmware unified multi-sig transaction signing (CSFUMTS) component for the SOCOACT;

FIG. 171 shows non-limiting, example embodiments of implementation case(s) for the SOCOACT;

FIG. 172 shows non-limiting, example embodiments of implementation case(s) for the SOCOACT;

FIG. 173 shows a block diagram illustrating non-limiting, example embodiments of a SOCOACT controller;

APPENDICES 1-2 illustrate embodiments of the SOCOACT.

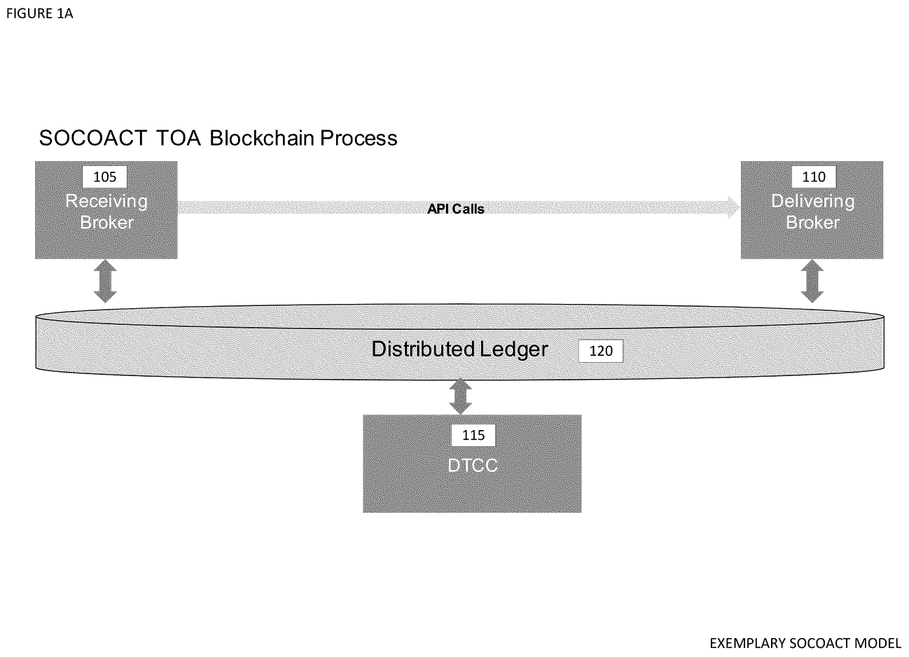

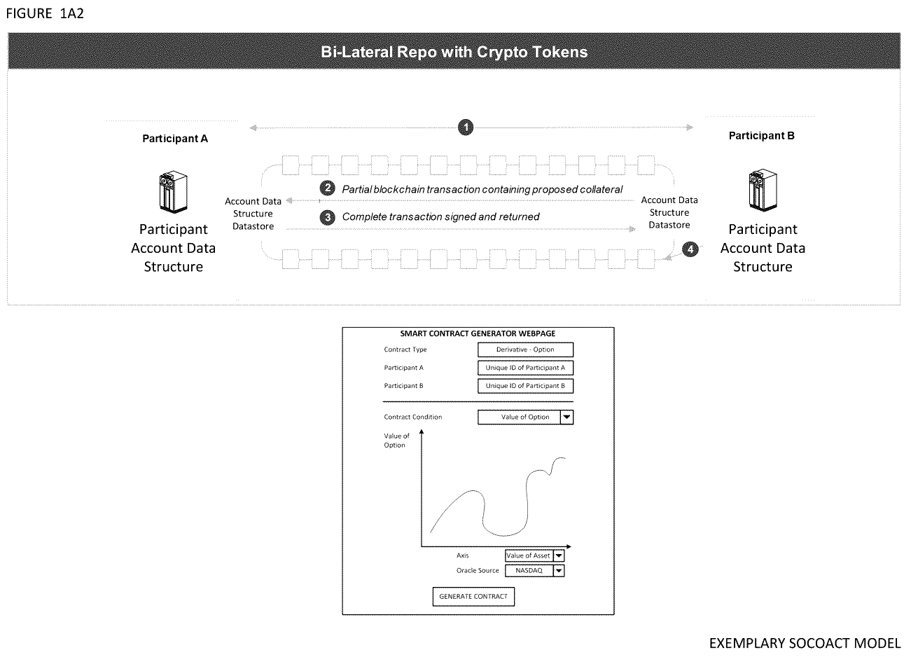

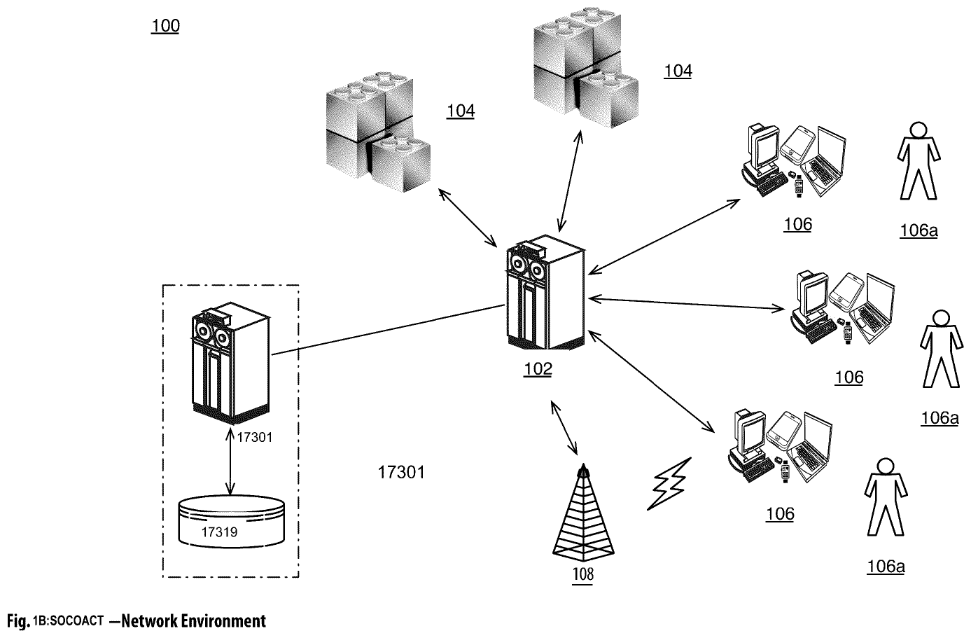

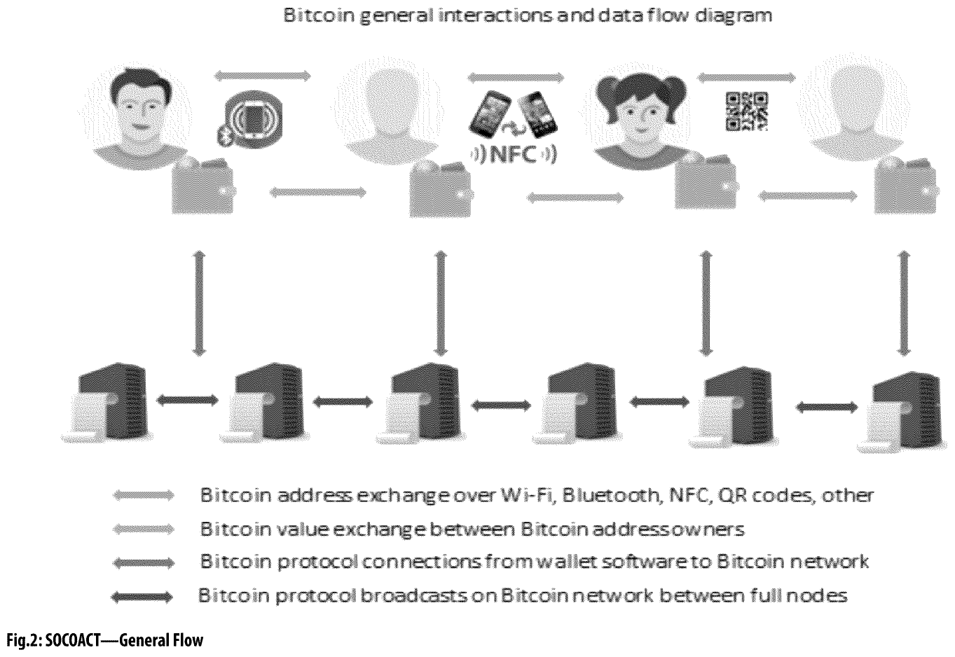

Generally, the leading number of each citation number within the drawings indicates the figure in which that citation number is introduced and/or detailed. As such, a detailed discussion of citation number 101 would be found and/or introduced in FIG. 1. Citation number 201 is introduced in FIG. 2, etc. Any citations and/or reference numbers are not necessarily sequences but rather just example orders that may be rearranged and other orders are contemplated. Citation number suffixes may indicate that an earlier introduced item has been re-referenced in the context of a later figure and may indicate the same item, evolved/modified version of the earlier introduced item, etc., e.g., server 199 of FIG. 1 may be a similar server 299 of FIG. 2 in the same and/or new context.

### DETAILED DESCRIPTION

The Computationally Efficient Transfer Processing, Auditing, and Search Apparatuses, Mechanisms, Mediums, Processes and Systems (hereinafter “SOCOACT”) transforms transfer of assets (TOA) initiation request, brokerage order request, blockchain transaction request, agency action request, borrow transaction request, contract deployment request, transaction signing request, key backup request, key recovery request datastructure/inputs, via SOCOACT components (e.g., Virtual Currency, Blockchain, Transact. Confirm., TTI, TTP, OP, AF, SF, TV, TP, AA, IEP, BSA, TPO, SFTS, BUKB, SFKB, RUKR, SFKR, TSTS, NTSTS, HSFTS, FTSTS, CSFTS, TSCD, SFCD, TSCTS, SFCTS, NTSITS, FTSITS, SFITS, MOWUMTS, NTSUMTS, HSFUMTS, FTSUMTS, CSFUMTS, etc. components), into TOA confirm., brokerage order confirm., transaction confirm., agency action notif., borrow transaction init notification, borrow transaction sync notification, contract deployment response, transaction signing resp., key backup resp., key recovery resp. datastructure/outputs. The SOCOACT components, in various embodiments, implement advantageous features as set forth below.

### INTRODUCTION

The SOCOACT provides unconventional features (e.g., receive a plurality of transaction record datastructures for each of a plurality of transactions, each transaction record datastructure comprising a source address, a destination address, a transaction amount and a timestamp of a transaction; verify, via the source address corresponding to the source digital wallet, that the transaction amount is available in the source digital wallet; cryptographically record the transaction record datastructure in a blockchain; receive the source address and the destination address; hash the source address using a bloom filter to generate a source wallet address; hash the destination address using the bloom filter to generate a destination wallet address; add the source wallet address as a first row and a column entry to a matrix datastructure representing a weighted graph of the plurality of transactions; add the destination wallet address as a second row and column entry to the matrix datastructure representing a weighted graph of the plurality of transactions; add the transaction amount and the timestamp as an entry to the row corresponding to the source wallet address and the column corresponding to the destination wallet address; and generate a list representation of the matrix datastructure, where each entry in the list comprises a tuple having the source wallet address, the destination wallet address, the transaction amount and the timestamp) that were never before available in information technology.

Bitcoin transactions are typically posted on a public, distributed ledger called a blockchain. The Bitcoin network stores complete copies of the blockchain on nodes that are distributed around the world. Anyone can install the Bitcoin software on a networked computer to begin running a node. Because the blockchain is public, anyone can see the complete history of Bitcoin transactions and the public addresses that are currently “storing” Bitcoin.

In order to move Bitcoin between public addresses, a user must prove that he owns the sending address that is storing the Bitcoin to be sent, and know the receiving address where the Bitcoin is to be transferred.

Before Bitcoin can be transferred out of a public address, the owner of that address must prove that he owns the address by signing the transaction with the same private key that was used to generate the public address. Upon successfully doing so, the transaction is then broadcast to the Bitcoin network. The network groups transactions into blocks, confirms that the transactions are valid, and adds the block to the blockchain.

Bitcoin as a form of payment for products and services has grown, and merchants have an incentive to accept it because fees are lower than the 2-3% typically imposed by credit card processors. Unlike credit cards, any fees are paid by the purchaser, not the vendor. The European Banking Authority and other authorities have warned that, at present, Bitcoin users are not protected by refund rights or an ability to obtain chargebacks with respect to fraudulent or erroneous transactions. These and other limitations in the previous implementation of Bitcoin are now readily addressed.

In one embodiment, the SOCOACT facilitates utilizing user-owned data in a variety of settings while allowing the user to retain access control over the data. In another embodiment, the SOCOACT provides an agency oversight configured blockchain that allows an agency to unwind blockchain transactions. In another embodiment, the SOCOACT facilitates inter-blockchain network transactions. For example, a user, who lives on the west coast of the US and utilizes a regional agency oversight configured blockchain network serving the west coast, may utilize the user's user-owned data to make a stock purchase from another user, who lives on the east coast of the US and utilizes a regional agency oversight configured blockchain network serving the east coast, via an inter-blockchain network transaction that transfers the user's crypto tokens (e.g., 50 Bitcoins) to the other user (e.g., in exchange for the purchased stock).

### Implementation Variations

One possible non-monetary implementation for the SOCOACT is as a shared (virtual) ledger used to monitor, track and account for actual people that may go missing. Social media systems could use SOCOACT as a more secure and flexible way to keep track of people, identities and personas.

Using a SOCOACT as a way to store the identities will enable broad access to authorized users and can be implemented in a publicly-available way. Each and every addition or deletion to the ledger of identities will be traceable and viewable within the SOCOACT's Blockchain ledger.

This can be done by defining a few fields, with size and other attributes, publicly sharing the definition and allowing those skilled in the art to access and update, delete, change entries via tracing and auditing.

Implementations such as this could be used, for example with universities or governments and allow greater transparency. For instance, imagine there is a migration of peoples out of one country, say, in response to war or natural disaster. Typically, in historical cases there has been no feasible way to quickly track migrants during their relocation. A non-governmental organization (NGO) could use SOCOACT to create a Blockchain ledger of all displaced persons and that ledger could be used to track them through resettlement. The ledger could be referenced by individuals who could compare their credentials with those that are encrypted and stored through the ledger at a specific time and date in a Bitcoin-like format.

The SOCOACT system could also be used for voting in places where there may not be well developed voting tabulation systems and where voting tallies are suspect. For example, it can be used to build a voting system in a developing country. By using the blockchain technology, an immutable ledger is created that records the votes of each citizen. The record would allow for unique identification of each voting individual and allow for tabulation of votes. One could easily tell if people actually voted, for whom they voted, and confirms that no one voted twice. A virtual fingerprinting or other biometrics could be added to the ledger to help avoid fraud, as described herein in more detail with respect to additional embodiments.

SOCOACT may also be used for Proxy Voting for stocks or Corporations Annual Meetings that have questions put to a vote or for directors. The Blockchain adds transparency, speed and access to the information- and it can be verified and interrogated by many people. Accordingly, no one source needs to be trusted, as anyone in the public can see the ledger.

In underdeveloped areas the transport method could easily be 3G\LTE\4G\Mesh Networks with TCP\IP or other protocols used to transport the messages from a remote area, serviced by Mobile phone service—to the cloud where the accessible, shared Blockchain ledgers are maintained and made publicly available.

Implementations for better tracking of usage of resources can be enabled through the SOCOACT. For example, water meters, electric & gas meters, as well as environmental monitoring devices such as C02 emitter meters can be used to inform enable a Bitcoin-style transaction involving resource usage or pollution emission. Using measurement devices that track the usage of these household resources or industrial pollutants, a Bitcoin-enabled marketplace between individuals, corporations and government entities can be created.

Suppose Alex lives a community or state that taxes greenhouse gases. By using the SOCOACT, both government waste as well as friction in the financial system can be mitigated. Alex may instantly receive a credit or a surcharge based on his use of resources. Micro transactions, which are not practical today because of the relatively high transaction costs, are easily accommodated as SOCOACT-enabled transactions, on the other hand, and can be moved daily, hourly or weekly with little transaction overhead.

For example, Alex makes a payment via SOCOACT that can be placed on the block chain for the tax amount due, but which may not be valid until a certain date (e.g. end of the month). When the transaction becomes valid, Bitcoin-like virtual currency is transferred to the town treasury and the town immediately credits some amount back, based on the meter reading.

Alex may have a $500 carbon surcharge on his taxes today. The monitors on Alex's furnace, his gas meter and electric meter can sum up all his uses resulting in carbon emissions and then net them out—all using the blockchain. Then because the blockchain is accessible by his local town he can get the surcharged reduced by, for example, $250 per year in response to Alex's environmentally friendly actions. Whereas in previous systems, Alex would have had to write out a check and mail it in, now, with SOCOACT, a simple entry in the blockchain is created, read by the town hall and a corresponding entry is made in the town hall ledger. By moving virtual currency between the two ledgers (could be the same ledger but different accounts) we have “monies” moved without the mailing of a check, without the meter reader coming by, and without the bank processing as in prior systems.

Much like in home uses of SOCOACT, the SOCOACT may create a new paradigm for costs and billings of hotels, residences, dormitories, or other housings and lodgings having resources that are metered and billed to its occupants. The Blockchain may be used to track usage of resources such as water, electricity, TV charges, movie rentals, items taken from the refrigerator or mini-bar, heat and room temperature controls and the like. Hotel customers, resident, students or the like residing in individual or mass housing or lodging may then be credited or surcharged for their stay based on Bitcoin-enabled transactions and monitoring of their use of resources.

Monitors can be setup on appliances, heaters, a room-by-room water meter, and the like. The monitors can communicate with each other via Bluetooth, Zigbee, X.10, NFC, Wifi or other known means. Since low power consumption is generally preferred, the monitors may be coordinated by a single device in the room.

Through a hotel's use of SOCOACT, a client may check in, get a room assignment and receive a virtual key to enter the assigned room. The virtual key may be sent to the client's SOCOACT ledger, stored on his smartphone or other portable electronic device, and may be used to open the door when the phone is placed in proximity to the hotel room door lock, for example, where the smartphone or other device is Bluetooth or NFC-enabled and is in communication range of a corresponding reader in the room. This reader then connects with each measuring device for TV, heat, room service, water usage, etc. Throughout the client's stay, it tracks when the lights or air conditioning are left on, when in-room movies are rented, water usage for bath, sink and toilet and other chargeable room uses. A hotel client's bill upon check out can be reduced or enhanced with the hotel client's usage. Blockchain technology may also be used to record check-in and check-out times in order to more quickly free up the room to be rented again.

Also, SOCOACT may be used to enable a seamless checkout process. When a client checks in, a smart contract is created to move Bitcoin-like virtual currency after his checkout date. Since the address that the client provides at the time of check-out might not contain enough funds as it did on check-in, the projected funds for this transaction may remain locked by the SOCOACT, which can become valid and transferrable at a later time, i.e. upon check-out date. The hotel will immediately send credits or debits based on the actual usage of the hotel's amenities.

A consumer focused creation for SOCOACT could be using a Bluetooth Beacon as a method for determining where to send a payment from a virtual currency wallet. The housekeeper could tag a hotel room with her Bluetooth beacon. A client staying in the room could use their mobile device to pick up that Beacon, receive a virtual id of the housekeeper, and transfer an amount to the virtual id as a tip. In the same manner, the SOCOACT system could be used for the valet who retrieves the client's car, as well as other service providers at the hotel that may receive gratuities or the like.

Clients could also pay for Pay Per View Movies by Bluetooth/NFC sync and pay using their SOCOACT wallet.

Currently the Bluetooth Beacon is of a size that does not physically allow all uses, but over time it will shrink in size and allow uses on many devices and many purposes. Paying the housekeeper, the dog walker, the valet, and possibly tipping your waitress. The blockchain technology provides many ways to pay someone without having to even talk to them and without the exchange of cash or credit card number, thus reducing the potential for fraud that commonly results from such transactions presently.

Another implementation of SOCOACT is transactions involving a high value. For example, two persons which to make a face-to face transaction may meet in proximity of a Bluetooth beacon, where the Bluetooth or NFC chips in their respective electronic devices are matched. SOCOACT can enable the transaction of a large sum of money and micro-payments from the SOCOACT address of a payer to the SOCOACT address of the payee via the Bluetooth beacon or NFC reader, while avoiding the transaction fees that may render such transactions traditionally infeasible.

Using alternative, electronic currencies supported by Blockchain technology, individuals can carry all the funds needed in a currency that is not susceptible to local changes-allowing the seller to get paid and transfer his monies back into dollars or another currency.

Another example is using a pre-built device that is used to order small amounts of relatively inexpensive items in a fast and convenient way. SOCOACT could make these micro transactions feasible. For instance, a product or its packaging could include a button connected via Bluetooth or WiFi, Radio Frequencies or NFC (see, e.g., AMAZON DASH). This button could be re-usable and disposable. Once pushed the button will result in an order to a vendor or fulfillment house for a replacement of the individual product. On the back end, the shipping of the items could be aggregated through new or existing systems.

However, on the payment processing side there is an overhead percentage that must be paid to credit- or debit-payment processing facilities that facilitate a traditional currency-based transaction. When payment is made with virtual currency via SOCOACT in place of traditional currency transaction, the actual transaction cost is much lower.

Unlike prior Bitcoin implementations, the SOCOACT also provides a centralized source for transaction processing, clearance and auditing. AS such the operator of the SOCOACT, for example, may collect transaction fees associated with use of the SOCOACT network. The operator may also be a guarantor of the accuracy of the transactions, and may reimburse a user in case of fraud or erroneous processing.

In some implementations, the SOCOACT includes features such as:

Crypto (e.g., Bitcoin) voting and conditional actions. For example, SOCOACT allows for electronic voting where votes are recorded on blockchain, and conditional and fractional voting is also enabled (at least in part) on block chain. If candidate A is losing, vote A, but if candidate A is winning vote C, if candidate B is winning vote half for A and half for B.

Also, action voting with conditional evaluation (and where a result can be a ‘vote’ or an action like a stock purchase); for example, based on my usage of Coke, or McDonalds, buy the stock of same. Part of the action could include tracking of action via email javascript to register activity.

UI triggerable crypto (e.g., blockchain) smart rules engine (e.g., contract) generator. The SOCOACT can include a custom exotic derivatives UI where value of option vs value of asset plot is drawn and creates a blockchain smart contract. The slope and (e.g., polynomial) path of the curve can be reversed into a constraints function that is generated from a user simply drawing a curve.

In another embodiment, SOCOACT allows for UI having GPS map that allows a user to draw a geofence, with a list of options to, e.g., settle smart contracts, restrict bitcoin wallet access, release extra key, buy stock, vote, etc. upon triggering the geofence as prescribed.

SOCOACT also can provide time range fencing with a list of options to, e.g., settle smart contracts like restrict bitcoin wallet access, release extra key, buy stock, vote, etc. For example, providing a slider timeline UI representing years, months, weeks, days, hours, etc. as the bounding time line fence.

In another embodiment, SOCOACT includes an anti-ping mechanism with a list of options to, e.g., settle smart contracts like: restrict bitcoin wallet access, release extra key, buy stock, vote, etc. when SOCOACT does not receive the requisite number/frequency/timely ping.

In another embodiment, SOCOACT includes a crowdsource (e.g., weather from smartphones) to inform a blockchain oracle to act as trigger for actions, with a list of options to, e.g., settle smart contracts like: restrict bitcoin wallet access, release extra key, buy stock, vote, etc. For example, if lots of sales of corn, buy counter stock/hedge. Or, for example, if lots of corn producers weather reports drought, buy corn futures.

Transaction/consumption tracking with a list of options to, e.g., settle smart contracts like restrict bitcoin wallet access, release extra key, buy stock, vote, etc.

This triggerable SOCOACT system may be used in all number of application, e.g., crypto voting above, and other features noted below, etc.

Crypto wallet currency (e.g., Bitcoin) recovery key. In one embodiment, the SOCOACT may generate a 2nd key for a crypto wallet so that if customer loses their crypto (e.g., Bitcoin) wallet, their financial services institution (e.g., Fidelity) account will offer another key to gain access to their crypto wallet corpus.

In one embodiment, SOCOACT provides the triggerable smart rules engine, already discussed, which may include the following examples:
0239.1. Anti-ping (detecting a lack of activity)
0239.2. Time of day, only accessible at certain times
0239.3. GPS if outside or inside a certain region would make keys (in) accessible
   0239.3.1. e.g., kids or people don't want wallet accessible when they are not at home.
0239.4. Other atmospherics
0239.5. Helps for fraud detection and key hiding under unscrupulous circumstances
0239.6. 2nd machine/escrow/encryption system with password access. Could be a 3rd party providing the backup store

Crypto asset digitization/tokenization on blockchain. In one embodiment, SOCOACT allows for the creation of digital assets such that, for example, the Fed may issue funds on the blockchain. Upon creating a ‘trust’ between counterparts with special encrypted token/smart contracts. Financial institutions would make a permissioned block chain where all counter parties know each other. Then counter parties can go to the SOCOACT facility and exchange existing assets, e.g., treasuries/money, and go to Fed and exchange existing assets for digitized versions issued on the block chain, and have the Fed put them on a wallet on the block chain. If desired, digitized versions may be exchanged by the Fed back into existing assets.

Once asset digitized, then bilateral exchange doable on block chain significantly faster, more efficiently, and securely. SOCOACT could allow the following features on such an exchange, including: check collateral, set where you want assets delivered to, wallet updating, obtaining results in quicker and much more efficient exchange of asset.

Crypto “captcha” account owner/wallet verification. In one embodiment, SOCOACT allows a user to login on and see a captcha verification/test phrase. The user then initiates a micro bitcoin transaction, puts a challenge word in field. Then the target verifies account upon detecting match of field. In another embodiment, optionally, metadata, GPS, time of data, UI triggerables, etc. may be added as part of the passphrase transaction. For example, send $0.03 first, and then send $0.11 back to help verify the account.

Crypto asset transfer. In one embodiment, the SOCOACT facilitates broker to broker account transfers. Instead of following a Depository Trust & Clearing Corporation (DTCC) cycle called Automated Customer Account Transfer Service (ACATS), which takes 5 to 6 business days for asset transfers, the SOCOACT allows brokers to interact directly, reducing the delay introduced by a middle man and allowing transfer settlement to be substantially real time. Benefits associated with crypto asset transfer may include accelerated settlement of assets, improved customer experience, collateral elimination, reduced system complexity, and reduced number of reject cases.

### Examples of Features

The following features (e.g., collateral, fully paid securities, enrolling in fully paid program, fully paid collateral management, participants in fully paid collateral management process, blockchain, user interface, middle tier, data tier, etc.) may be used by the SOCOACT, and are non-limiting example expressions of such features discussed herein provided to aid in the understanding.

### Collateral

Collateral is an asset pledged by a borrower to a lender, usually in return for a loan.

When borrowing securities (e.g., stocks) the borrower may post collateral to the lender, usually to the lender's account with a collateral agent, in exchange for the shares. Collateral is returned to the borrower when the shares are returned to the lender. The lender may have to pay any applicable interest on the collateral to the borrower.

When a broker-dealer such as Fidelity borrows security from a customer, the broker-dealer may pledge some amount of collateral (e.g., either equal to or greater than the market value of security) to the customer's collateral agent such as Bank of America or Wells Fargo Securities in the customer's account.

### Fully Paid Securities

The term “fully paid securities” refers to securities held in a customer's margin or cash account that have been completely paid for and are not being pledged as collateral to support the purchase of other securities on margin. The term is relevant from a regulatory perspective as the SEC requires that U.S. broker-dealers segregate and maintain in a good control location (e.g., DTC or bank) all customer securities which are fully paid. Such securities cannot be pledged or loaned to finance the activities of the firm or other customers.

### Enrolling in Fully Paid Program

When a customer enrolls in a broker-dealer's fully paid lending program, the customer can loan to the broker-dealer certain fully paid or excess-margin securities that the broker-dealer desires to borrow. The customer can sell loaned securities or end loans at any time.

### Fully Paid Collateral Management

The process describes the management of collateral for fully paid securities in an enrolled customer's account. The customer's account may be held at a collateral agent. Collateral may get settled daily based on market value of securities (due to the daily price changes of the security).

### Participants in Fully Paid Collateral Management Process

Participants may include:
Broker-dealer (Borrower)
Customer (Lender)
Collateral Agent (Custodian of Collateral)

### Blockchain

A blockchain is a continuously growing list of records, called blocks, which are linked and secured using cryptography. Each block typically contains a cryptographic hash of the previous block, a timestamp and transaction data.

By design, a blockchain is inherently resistant to modification of the data. It is “an open, distributed ledger that can record transactions between two parties efficiently and in a verifiable and permanent way”.

In one implementation, once recorded, the data in any given block cannot be altered retroactively without the alteration of all subsequent blocks.

### User Interface (UI)

User Interface is responsible for the presentation of data and interacting with the user.

### Middle Tier

Middle Tier provides the logic that contains the business rules, and also contains the code to interface with the data tier. This layer connects the User Interface and Data Storage by moving and processing data between both User Interface and Data Storage.

### Data Tier (Data Storage Tier)

The data-tier is responsible for data storage and may be implemented using a relational database management system (RDBMS) such as SQL Server or Oracle.

### SOCOACT Introduction

Collateral management for fully paid securities is now a very complex process with interrelated functions involving multiple parties. Moreover, fully paid collateral management process is opaque and centralized with lack of real time visibility for the involved parties. This has led to a tedious manual process, wherein the brokers, collateral agents and fully paid customers have to constantly communicate and check-in using various forms of communication including email and phone calls for tracking purposes.

In various embodiments, the SOCOACT is a unique approach which leverages the emerging Blockchain technology.

In this approach, each user can access the process online where they can track transactions in real time. The process also includes storing transactions on the Blockchain so that transactions can be stored in a decentralized manner where cyber security is stronger and no single party can make changes to the transaction once it is approved and confirmed by borrower and lender.

The SOCOACT leverages a combination of on-chain and off-chain storage functionality as Blockchain is inherently slow and can take some time for the transaction to be included in a block; with the SOCOACT approach, the process is made faster.

In one implementation, transactional & critical data is included on the Blockchain (on-chain) and the rest of the data is stored on distributed servers (off-chain).

Transactional data attributes may include the following: quantity of the security, rate of the security, ID of the security (Ticker, Cusip, Sedol and ISIN), timestamp of the transaction, etc.

Static/non-transactional data attributes may include the following: company name, country, customer name and address, customer details, broker dealer details, collateral management address, etc.

Moreover, each view (Customer View, Broker-Dealer View, Regulator View and Custodian Agent View) may only be accessible to the appropriate participant. Balances held in each view and transaction amounts are shielded, ensuring financial privacy.

### Example Advantages of the SOCOACT

The SOCOACT approach has multiple advantages, over the current process, some of which are listed below:
System based data sharing (Data is complete, accurate and consistent with the members).
Decentralization aspect of distributed aggregated database (e.g., Blockchain) preserves the trust and validity of the transaction data.
Transactions on a Blockchain are cryptographically secured and provide integrity.
As the system is based on various nodes in a peer-to-peer network, and the data is replicated and updated on each and every node, the system becomes highly available. Even if nodes leave the network or become inaccessible, the network as a whole continues to work, thus making it highly available.
Customers can access independent reporting via User Interface on Blockchain.
Single transaction ID on Blockchain (the participants have the same record)
Reduction in overhead cost as verification and reconciliation are minimal because a single version of agreed upon data is already available on a shared ledger between various counter parties.

### Additional Embodiments

Cryptocurrency (e.g., Bitcoin, Ethereum) funds and appropriate operations on them are intrinsically linked to asymmetric cryptography keys: funds are received at addresses based on public keys and spent using private keys that confirm ownership. Non-trivial Bitcoin wallet implementations operate multiple keys for the following reasons:
a) Operations are published on the Blockchain and become publicly visible
b) Reuse of receiving addresses allows data analysis that leads to identification of actively used addresses with significant funds and compromises the privacy of cryptocurrency transactions
c) An enterprise-hosted wallet structure usually utilizes different accounts for different organizational units and for different purposes

The use of independent keys for each operation, purpose, or organizational unit, aka flat wallets, makes both backing up keys and securing keys very complicated. In order to address this issue, Bitcoin improvement proposal #32 (Bip32) describes a deterministic algorithm that allows the building of a tree of private/public key pairs from a single secret seed (e.g., master key) and allows creation and management of hierarchical deterministic wallets instead of flat ones. Accordingly, by following Bip32:
a) Mapping of addresses for organizational units, particular operations, or purposes to transaction signing keys is done in a predictable manner
b) Securing of persistent keys is reduced to securing the seed
c) Backup and recovery procedures are simplified because the whole hierarchy of keys can be restored from the seed

A reliable way (e.g., one of the most secure ways) to store information (e.g., crypto keys) securely is inside a FIPS 140-2—certified hardware security module (HSM) appliance that provides tamper-proof storage of sensitive information. There is no external access to the dynamic memory inside a HSM, and, in some implementations, any attempts to physically access the tamper-proof storage may trigger complete deletion of stored information.

Current industry implementations of wallet and key management systems for secure wallets utilize a (e.g., software-based) Transaction Signing Server (TSS) to implement key derivation and transaction signing procedures. This creates a security threat because private keys, including the master key, are created in TSS memory, where, as the memory of a TSS server does not have strict physical boundaries, they can be stolen by an attacker. Multiple known memory attacks, such as Direct Memory Access (e.g., steal sensitive information directly from the memory) and Core Dump (e.g., cause a system crash and steal information from the memory dump generated during the crash) exist, and, despite existing protective measures and practices, the risk of private keys being stolen from the TSS memory (e.g., by malicious insiders) remains high. Additionally, as there is no reliable way to identify such unauthorized memory access and key theft, keys may be stolen and used at a later time when fund losses associated with those keys are significant.

Further, as cryptographic funds are tightly coupled with cryptographic keys, the loss or theft of keys is identical to the loss of funds. In case of hierarchical deterministic wallets, loss or theft of seeds is identical to the loss or theft of funds associated with keys that can be derived from these seeds. This means that seeds should be backed up reliably and securely. Even though multiple backup copies of HSM devices storing seeds may be created, it is desirable to have distributed hard copies of keys (e.g., paper printouts, metal engravings), which provide means to recover keys in case of severe disasters when not only HSM devices but whole data centers may become unavailable. Regular hardcopies of seeds suffer from the following weaknesses:
a) If stolen, they provide full seeds to an attacker
b) In order to be printed, seeds are extracted from HSMs into a computer's memory in the plain text format and can be stolen using memory targeting attacks
c) While being recovered from hard copies, seeds are processed in a computer's memory in the plain text format and can be stolen using memory targeting attacks
d) While being distributed from one location to another or recovered from hard copies, seeds can be copied and even memorized by the operational staff

Thus, even though seeds or private keys may not be exposed outside of HSM during regular cryptographic operations, during key generation, key backup and restore operations, since master seeds have to exist outside of HSM for a period of time before being deposited into bank safety box for safe backup store, there exist attack vectors and seed materials can be compromised.

In one additional embodiment, the SOCOACT includes Deterministic Derivation of Cryptocurrency Signing Keys with Split Master Seed and Enforcement of M-of-N Authentication Policy. This supports the SOCOACT with innovations in Bitcoin, Ethereum and Blockchain, new service and product offerings in cryptocurrency. It includes splitting Bitcoin or Ethereum master private key into multiple key shares (e.g., into two halves) when stored in FIPS 140-2 Level 3 HSM appliances to achieve combined BIP-32 hierarchical deterministic key derivation for transaction signing and M-of-N authentication enforcement on HSMs. In one implementation, two paired HSMs may be utilized such that a first HSM storing a first master key share receives an encrypted second master key share from a second HSM whose access is controlled by M-of-N authentication policy, and the first HSM decrypts the second master key share and recovers the master private key from the two master key shares. This technique is applied to a Bitcoin cold storage key vault and fund transfer implementation to protect master private keys from physical and/or software key theft and to enforce MofN (e.g., 2-person rule) security policy with regard to accessing the transaction signing capability on HSM.

In one additional embodiment, the SOCOACT may be utilized to provide multi-signature support and/or the same secure storage protection as multiple keys for Externally Owned Account (EOA) transactions on Ethereum blockchain. Previously, to support more secure multiple signatures as in Bitcoin, Ethereum smart-contracts have been used. Any smart contract multi-sig implementation carries inherent risk of fund loss and is known to be subject to various attacks, because potential code bugs and vulnerabilities could be introduced in contract Solidity code. Two well-known examples of these types of attacks are Parity Wallet Multi-sig hack and DAO hack. The SOCOACT achieves the same secure store with multiple keys in a multi-sig wallet but does so without having the risk of a smart contract to secure Ethereum transactions.

In one additional embodiment, the SOCOACT may be utilized to provide wallet address verification for Ethereum multi-sig wallets. Standard EIP-1014 addresses depend only on the contract's bytecode and address of the deploying contract factory. The SOCOACT also adds the dependency on keys, controlling multi-signature wallets. The SOCOACT may include a deployment procedure of Ethereum multi-signature smart contracts that creates a dependency among addresses of deployed contracts and their owners' public keys, and a verification procedure of proving the legitimacy of wallet addresses owned by the parties controlling owners' key pairs. Thus, the SOCOACT increases the level of protection of Ethereum multi-sig wallets by linking wallets' addresses to the existing key infrastructure. In one implementation, the following approach may be utilized:
1. Modify the wallet deployment procedure to make a wallet address dependent on its owners' public keys.
2. Sign wallet addresses with the same owners' private keys as m-sig.
3. Validate wallet addresses during transaction signing:
   Submit wallet address's requests for transactions, involving a particular source and/or destination wallet, along with its signatures obtained in Step 2.
   Validate wallet address's signatures using key materials controlled at the key storage and proceed with signing only if the signatures are valid.
   Require the same number of address signatures as required by the appropriate wallet configuration.

This approach may provide multi-signature enforcement for both transaction signing on transfer of assets and validation of addresses, centrally controlled by the key management and transaction signing system.

In one additional embodiment, the SOCOACT may increase the level of protection of offline wallets by preventing potential injection of malware and/or providing automated monitoring of system data. The SOCOACT may implement:
One-way data transfer from offline storages of digital assets to online machines, capable to process business information and upload auxiliary data into automated monitoring tools.
Authentication and verification procedures for proving the source of information being transferred as well as its integrity.

In one implementation, the following approach may be utilized:

1. Configuration of the receiving online server with public keys, corresponding to the private keys, hosted by the offline workstation.

2. Transfer of the signing request in the form of printed QR codes.

3. Import of signing request into the offline workstation using the optical QR-code reader and verification of data by operational staff.

4. Standard signing procedure.

5. Transfer of signing response data along with auxiliary information via an integrity authentication communication channel (e.g., a server/router one-way port connection, a unidirectional quantum-secured communication channel, etc.). For example, using a unidirectional optical channel (e.g., Terra Quantum equipment):
one-way data communication-no chances of backward injection of malicious data
integrity check of the communication channel with a OTDR (optical time-domain reflectometer)
analysis of data losses and identification of potential eavesdropping

4. Signing of signing request files along with all response files with private keys, hosted by the signing workstation.

5. Verification of signatures for each file being transferred using public keys, configured on the receiving online server.

In various implementations, the SOCOACT may provide at least some of the following features:

1. Server/router one-way port connection, and/or Quantum optics protection of communication channel and prevention of potentially dangerous backward communication.

2. End-to-end contactless procedure for transaction signing.

3. Integration of system information and audit trail files with the enterprise automated monitoring tools.

4. Non-interactive authentication of the parties.

5. Integrity checks for both interaction channel and data being transferred.

In one additional embodiment, the SOCOACT may be utilized to provide support for a digital asset wallet of multiple crypto currencies with multi-signature (multisig or m-sig) transaction signing support. In one implementation, the SOCOACT may provide off-chain authorization enforcement in a custom firmware module on off-line HSM device(s) to mitigate multisig authorization bypass and malware risks. For a hosted omnibus wallet that supports multiple coins, the SOCOACT may provide an HSM-based multisig transaction signing and key storage solution that unifies multi-signature and single-signature blockchains. For single-sig Ethereum transactions, the SOCOACT may provide the same multisig scheme as Bitcoin and enforce signature verifications at an offline transaction signing system prior to signing the on-chain EOA transactions using a single EOA private key, thus, off-chain multisig authorization. The off-chain multisig authorization may be implemented in a custom firmware module on a FIPS 140-2 L3 HSM device to mitigate the single-point-of-failure security risk where this multisig authorization could potentially be bypassed by malware. In one implementation, the following approach may be utilized:
0313.1. For a hosted omnibus wallet that supports multiple crypto coins, the SOCOACT may be utilized to provide an HSM-based multisig transaction signing and key storage solution that unifies multi-signature and single-signature blockchains to have the:
   0313.1.1. Same key at-rest protection on FIPS 140-2 Level 3 HSM devices at multiple locations, while maintaining runtime key redundancy and availability for transaction signing. Together with HSM key replication, hardware redundancy and high-availability deployment, the HSM-based key storage infrastructure offers high scalability, load-balance, and fail-over capabilities.
   0313.1.2. Same transaction signing process and API interface
   0313.1.3. Same online and offline fund transfer operational process
   0313.1.4. Same key data model, multiple key usage and storage structure
   0313.1.5. Same key ceremonies in crypto key lifecycle management processes, including key storage, generation, distribution, backup and recovery, key revocation.
   0313.1.6. Same multisig solution can be deployed to both online and offline keys for hot and cold storages or, in one secure deployment implementation, to mixed online and offline keys for air-gapped cold storage transaction signing.
   0313.1.7. Use of industry-standard cryptography and HSM solutions without the use of lesser tested key storage solutions.
   0313.2. Using Bitcoin and Ethereum blockchains as an example, we illustrate a cold storage transaction signing system for an omnibus BIP32 HD wallet application to sign native multisig BTC transactions and single-sig EOA transactions in a 3-of-4 multisig scheme where one master private seed is stored on an online HSM appliance and three private seeds on three offline HSM devices located in three different cold storage sites. It is to be understood that the SOCOACT may be utilized with other cryptocurrencies and blockchains, including tokens on the Bitcoin and Ethereum blockchains such as Bitcoin Cash, Litecoin, Dogecoin, Ethereum Classic, USD Coin, ERC-20 tokens, Polkadot, etc.
   0313.3. For single-sig Ethereum transactions, the SOCOACT may be utilized to provide the same multisig scheme as Bitcoin and enforce signature verifications at an offline transaction signing system prior to signing an on-chain EOA transaction using a single EOA private key, thus, providing off-chain multisig authorization.
   0313.4. The off-chain multisig authorization may be implemented in a custom firmware module (FM) on a FIPS 140-2 L3 HSM device to mitigate the single-point-of-failure security risk where this multisig authorization could potentially be bypassed by malware. The use of a firmware module protects against tampering of the signing application on the server by a malicious insider, since any transaction signing on the HSM device goes through the custom BIP32 FM for HD key derivation with non-extractable master seed on the device, and the FIPS 140-2 Level 3 devices provide strong protection against tampering with the FM itself. It may also enforce a signing order (e.g., where the first transaction signature should be an online transaction signature).

### SOCOACT

FIG. 1A shows an exemplary model for the SOCOACT. As shown in FIG. 1A, the SOCOACT may be used to facilitate crypto asset transfer. Crypto asset transfer may be utilized in areas such as broker to broker direct asset transfer systems in financial services, token transfers between two entities that are part of the same chain (e.g., transfer of reward points from Starbucks to Chase), digital cash transfer, and/or the like. For example, a customer may initiate a broker to broker transfer of assets (TOA) for various reasons, such as the customer may be unhappy with the current broker, the customer's stockbroker has taken a job with a new broker and the customer wishes to remain a client of the stockbroker, and/or the like.

As shown in FIG. 1A, brokers (e.g., including a receiving broker 105 and a delivering broker 110) and/or agencies (e.g., including a regulatory body such as the DTCC 115) may utilize a permissioned ledger 120 (e.g., on a permissioned blockchain) to facilitate crypto asset transfer. In one embodiment, the receiving broker may utilize API calls to request TOA from the delivering broker to a delivery address. The delivering broker may communicate with the DTCC to exchange assets associated with the customer for digitized versions issued on the block chain (e.g., crypto tokens), and/or may update the block chain ledger by depositing the digitized crypto assets to the delivery address. Once the broker to broker transfer transaction is validated, the transaction is distributed to participating nodes in the permissioned ledger. The transaction may be encrypted, such that the identities of the customer and/or of the brokers are not revealed.

FIG. 1A2 shows an exemplary model for the SOCOACT. As shown in FIG. 1A2, the SOCOACT may be used to facilitate transactions (e.g., a bilateral repo transaction) between participants using crypto tokens. Each of the participants, Participant A and Participant B, may be associated with a participant account data structure (e.g., which may include cryptographic data associated with the participant) that facilitates blockchain transactions, and with an account data structure datastore (e.g., an electronic wallet with crypto tokens) that is modified in accordance with blockchain transactions. In one embodiment, the participants may engage in a bilateral transaction using a user interface triggerable smart contract, which may be generated using a GUI illustrated in the figure. The GUI may facilitate specifying data (e.g., terms) associated with the smart contract, which may then be transformed into a form usable on the blockchain.

FIG. 1B shows a block diagram illustrating networked embodiments of the SOCOACT.

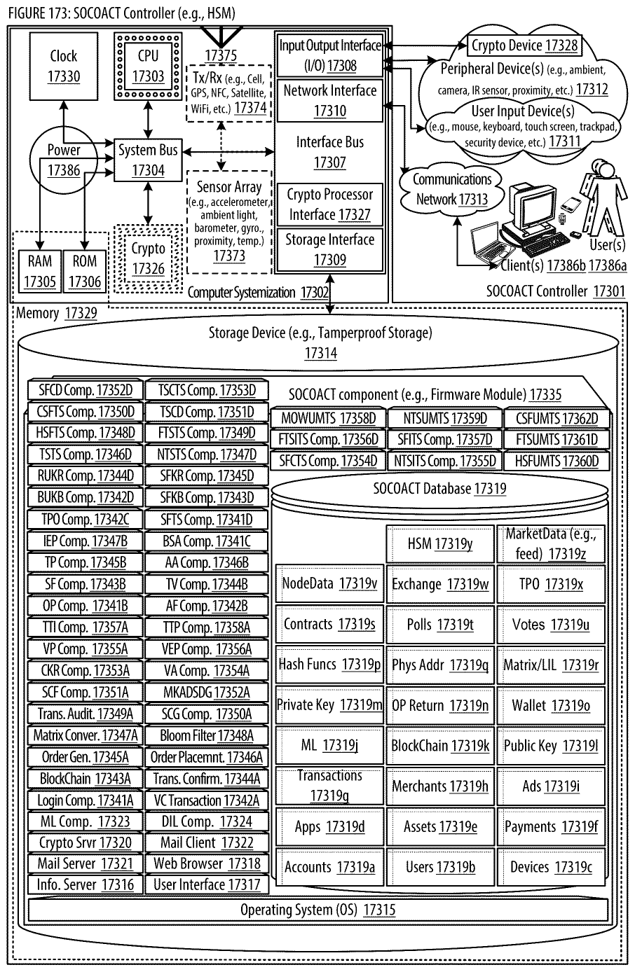

The network environment 100 may include a SOCOACT Server 17301, the functions and components of which described in detail below with respect to FIG. 173. The SOCOACT Server 17301 may comprise one or many servers, which may collectively be included in the SOCOACT System.

The network environment 100 may further include a SOCOACT Database 17319, which may be provided to store various information used by the SOCOACT Server 17301 including client portfolio data, financial transaction data, and any other data as described, contemplated and used herein.

The network environment 100 may further include a Network Interface Server 102, which, for example, enables data network communication between the SOCOACT Server 17301, Third Party Server(s) 104, wireless beacon 108 and Client Terminal(s) 106, in accordance with the interactions as described herein.

The one or more Client Terminals 106 may be any type of computing device that may be used by Clients 106a to connect with the SOCOACT Server 17301 over a data communications network. Clients 106a, in turn, may be customers who hold financial accounts with financial or investing institutions, as described further herein.

The Third Party Server(s) 104 may be operated by any other party that is involved in a transaction. Accordingly, the third party server 104 may be any type of computing device described herein as may be operated by a vendor, a payment processor, an individual, a corporation, a government agency, a financial institution, and the like.

The wireless beacon 108 may be any type of wireless transceiver for relaying information between client devices 106 for sending or receiving payment information within a localized geographic area. Accordingly, the wireless beacon 108 may be Bluetooth, Near Field Communication (NFC), WiFi (such as IEEE 802.11) wireless routers, and the like.

The servers and terminals represented in FIG. 1B cooperate via network communications hardware and software to initiate the collection of data for use in the SOCOACT system, the processes involving which will now be described in more detail.

FIG. 2 shows a second block diagram illustrating embodiments of a network environment including the SOCOACT. This includes the interactions between various parties using the SOCOACT system.

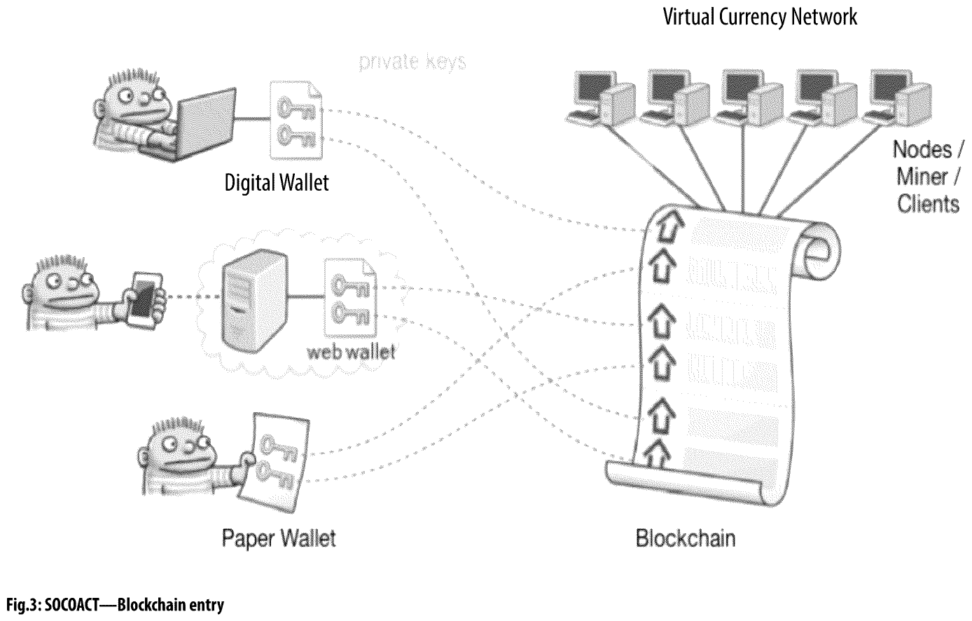

FIG. 3 shows a block diagram illustrating embodiments of network nodes of the SOCOACT, in which virtual currency wallet transactions are recorded in Bitcoin-style blockchains.

Virtual currency users manage their virtual currency addresses by using either a digital or paper “wallet.” Wallets let users send or receive virtual currency payments, calculate the total balance of addresses in use, and generate new addresses as needed. Wallets may include precautions to keep the private keys secret, for example by encrypting the wallet data with a password or by requiring two-factor authenticated logins.

Virtual wallets provide the following functionality: Storage of virtual currency addresses and corresponding public/private keys on user's computer in a wallet.dat file; conducting transactions of obtaining and transferring virtual currency, also without connection to the Internet; and provide information about the virtual balances in all available addresses, prior transactions, spare keys. Virtual wallets are implemented as stand-alone software applications, web applications, and even printed documents or memorized passphrases.

Virtual wallets that directly connect to the peer-to-peer virtual currency network include bitcoind and Bitcoin-Qt, the bitcoind GUI counterparts available for Linux, Windows, and Mac OS X. Other less resource intensive virtual wallets have been developed, including mobile apps for iOS and Android devices that display and scan QR codes to simplify transactions between buyers and sellers. Theoretically, the services typically provided by an application on a general purpose computer could be built into a stand-alone hardware device, and several projects aim to bring such a device to market.

Virtual wallets provide addresses associated with an online account to hold virtual currency funds on the user's behalf, similar to traditional bank accounts that hold real currency. Other sites function primarily as real-time markets, facilitating the sale and purchase of virtual currency with established real currencies, such as US dollars or Euros. Users of this kind of wallet are not obliged to download all blocks of the block chain, and can manage one wallet with any device, regardless of location. Some wallets offer additional services. Wallet privacy is provided by the website operator. This “online” option is often preferred for the first acquaintance with a virtual currency system and short-term storage of small virtual currency amounts and denominations.

Any valid virtual currency address keys may be printed on paper, i.e., as paper wallets, and used to store virtual currency offline. Compared with “hot wallets”-those that are connected to the Internet—these non-digital offline paper wallets are considered a “cold storage” mechanism better suited for safekeeping virtual currency. It is safe to use only if one has possession of the printed the paper itself. Every such paper wallet obtained from a second party as a present, gift, or payment should be immediately transferred to a safer wallet because the private key could have been copied and preserved by a grantor.

Various vendors offer tangible banknotes, coins, cards, and other physical objects denominated in bitcoins. In such cases, a Bitcoin balance is bound to the private key printed on the banknote or embedded within the coin. Some of these instruments employ a tamper-evident seal that hides the private key. It is generally an insecure “cold storage” because one can't be sure that the producer of a banknote or a coin had destroyed the private key after the end of a printing process and doesn't preserve it. A tamper-evident seal in this case doesn't provide the needed level of security because the private key could be copied before the seal was applied on a coin. Some vendors will allow the user to verify the balance of a physical coin on their website, but that requires trusting that the vendor did not store the private key, which would allow them to transfer the same balance again at a future date before the holder of the physical coin.

To ensure safety of a virtual wallet in the SOCOACT system, on the other hand, the following measures are implemented: wallet backup with printing or storing on flash drive in text editor without connection to Internet; encryption of the wallet with the installation of a strong password; and prudence when choosing a quality service.

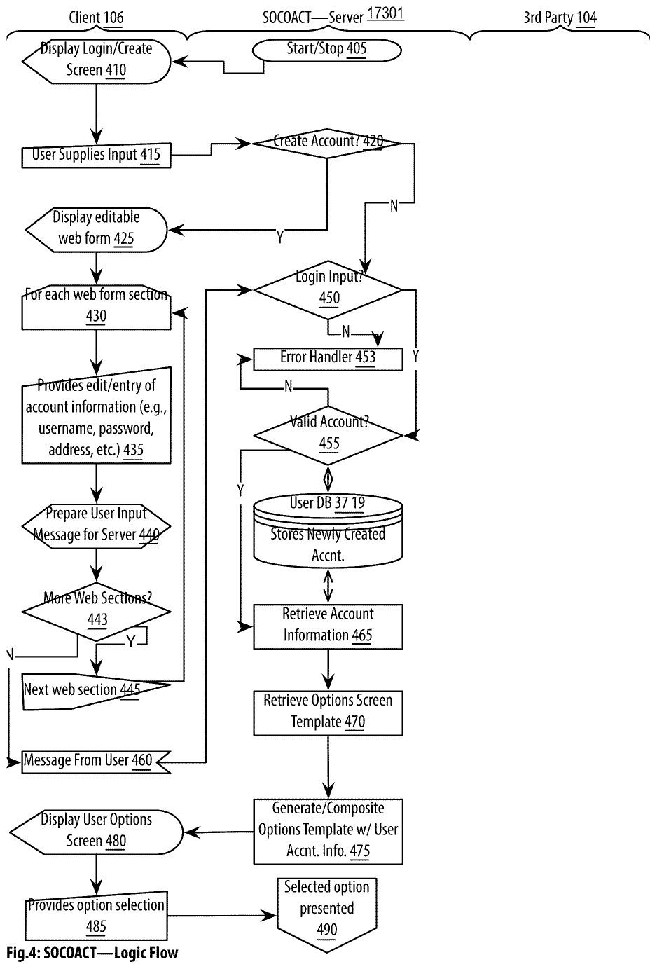

FIG. 4 shows a datagraph diagram illustrating embodiments of a login process for the SOCOACT. Commencing at step 405, the SOCOACT Controller 17301 responds to a user's (i.e., a recruiter's or candidate's) login request and displays a login/create account screen on the Client Terminal 106 (step 410). The user responsively enters an input (step 415) comprising either a login request to an existing account, or a request to create a new account. At step 420, if the user is requesting to create an account, the process continues to step 425 below. If instead, the user is requesting access to an existing account, the process continues to step 435 below.

When the user's entry comprises a request to create a new account, the SOCOACT Controller 17301 prepares and transmits a web form and fields for creating a new account (step 425).

Next, at step 430, the user enters any requisite information in the displayed web form fields. Such web form may include fields for entering the user's full name, address, contact information, a chosen username, a chosen password and/or any other useful identification information to associate with the account (step 435). The user's inputs are then prepared for transmission to the SOCOACT Controller 17301 (step 440). The Client Terminal 106 confirms whether there are more web sections or forms to complete (step 443). If so, the next web section is presented (step 445) and the process returns to step 430 above. Otherwise, the process continues to step 460, where the entered account information is transmitted to the SOCOACT Controller 17301 for storage in, for example, the maintained Account Database 17319a, as described in more detail later below.

From either step 420 or 460 above, the process continues to step 450, wherein the SOCOACT Controller 17301 determines whether a login input has been received. If so, the process continues to step 455 below. Otherwise, the process continues to an error handling routine (step 453), wherein the user may be given a limited number of attempts to enter a login input that corresponds to a valid stored investment account. If no valid login is presented within the given number of allowed attempts, the user is denied access to the SOCOACT Controller 17301.

At step 455, the SOCOACT Controller 17301 determines whether a valid login input has been received, for example by comparing the received login input to data stored in the SOCOACT Database 17319. If the received login credentials are valid, the process continues to step 465 below. Otherwise the process returns to step 453 above.

At step 465, when valid login credentials have been received from the Client Terminal 106, the SOCOACT Controller 17301 retrieves account information appropriate for the user. Next, at step 470, the SOCOACT Controller 17301 retrieves an options screen template based on the user, and then generates a composite options screen with the user's account information (step 475), which is transmitted to the client terminal 106 for display to a user on a display device thereof (step 480). The user then provides inputs representing options selections (step 485) and the selected option (which may represent commencement of one of the later processes described herein below) may be initiated and presented for display to the user (step 490).

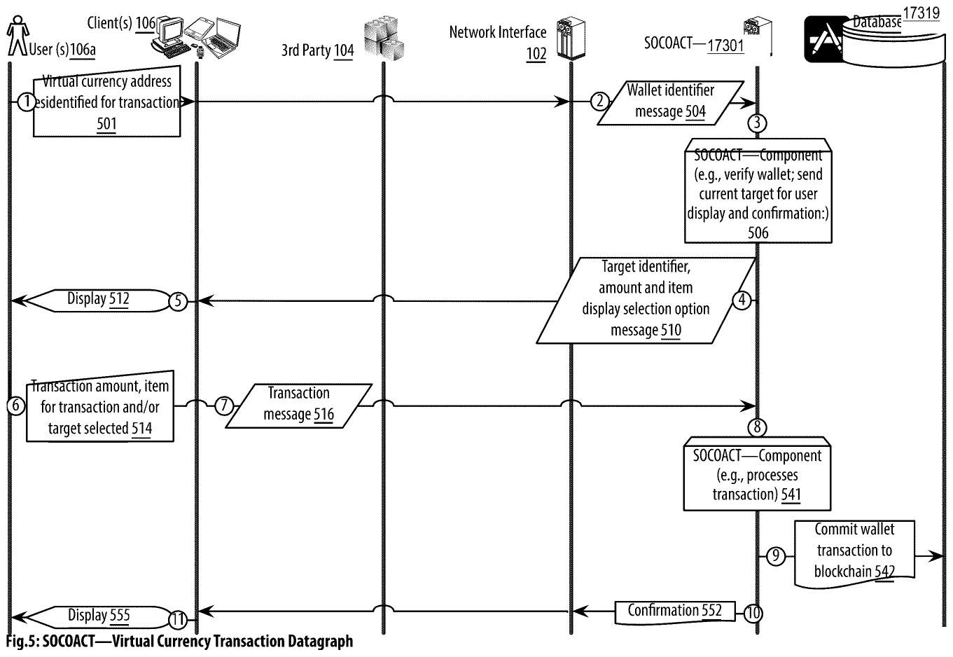

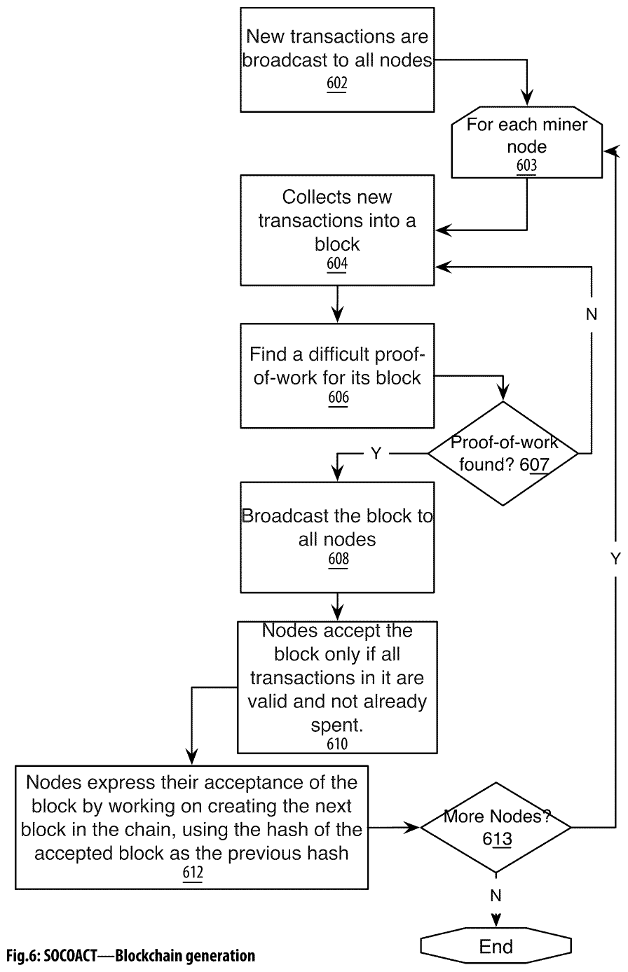

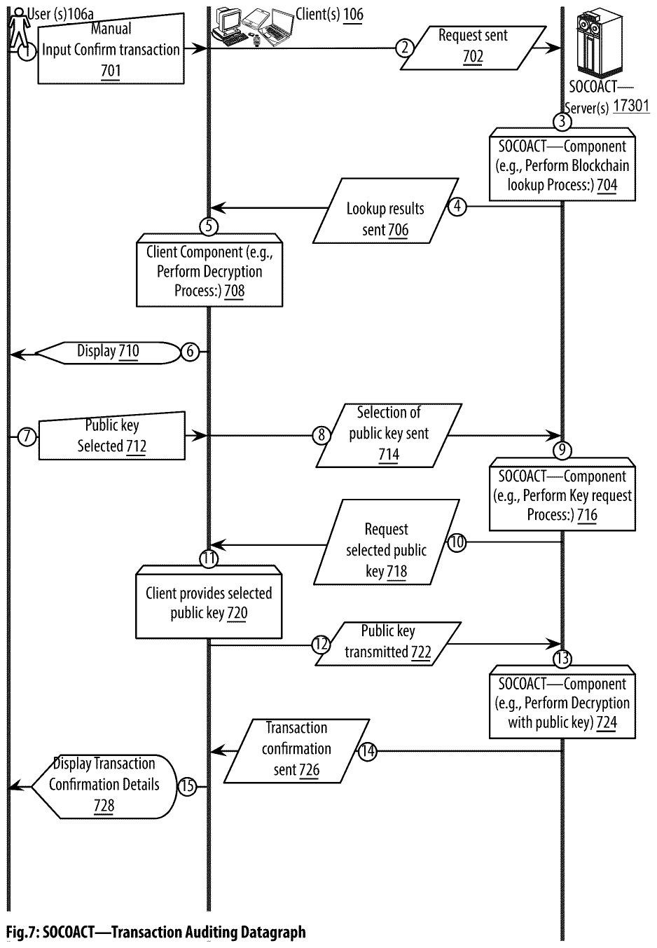

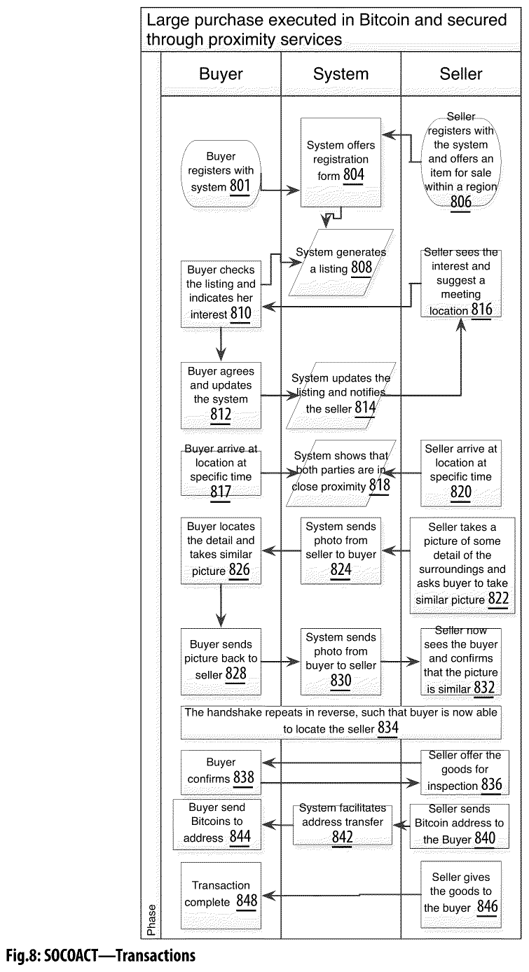

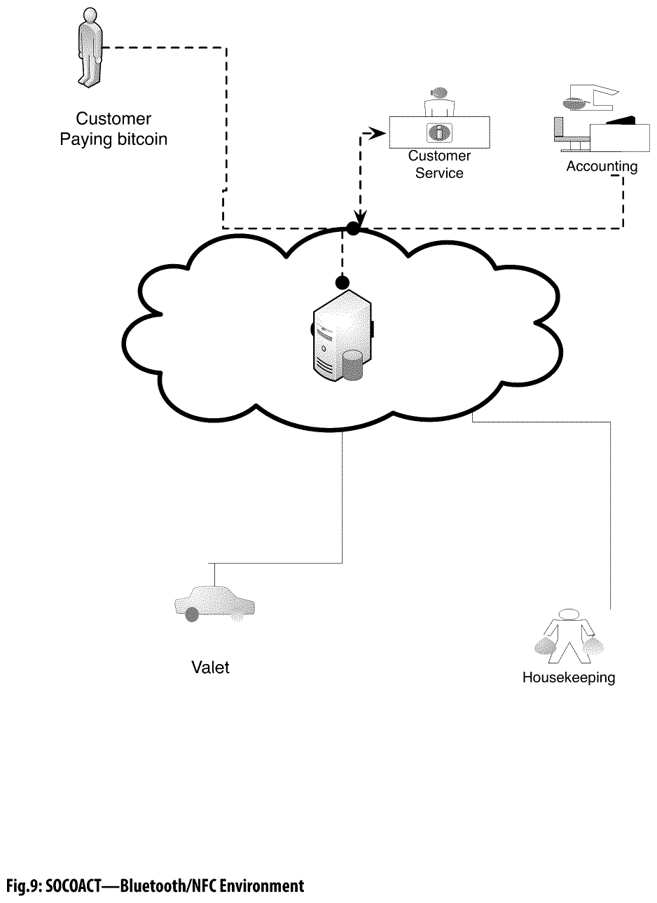

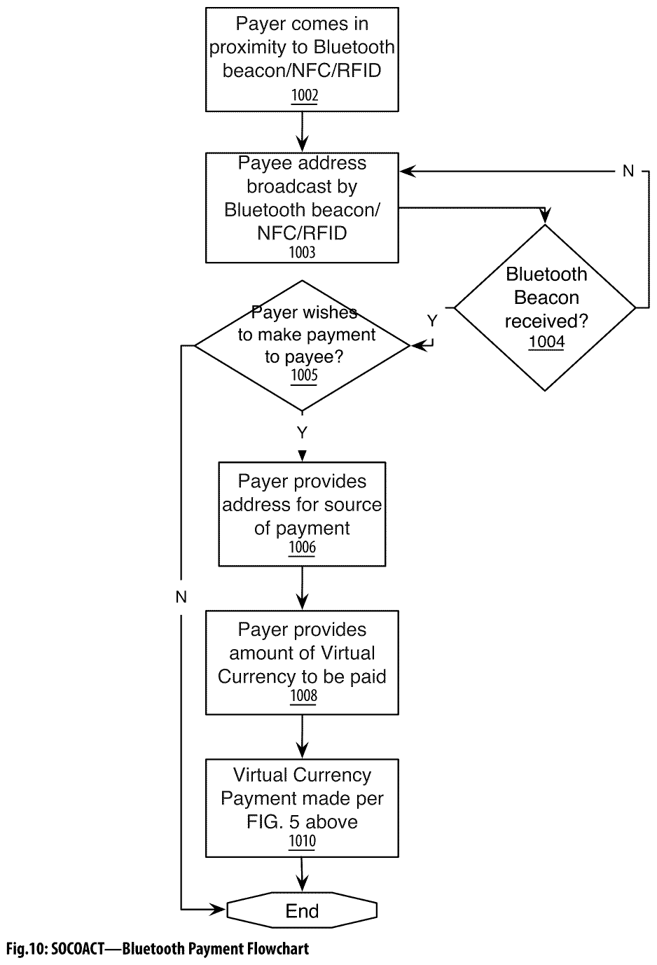

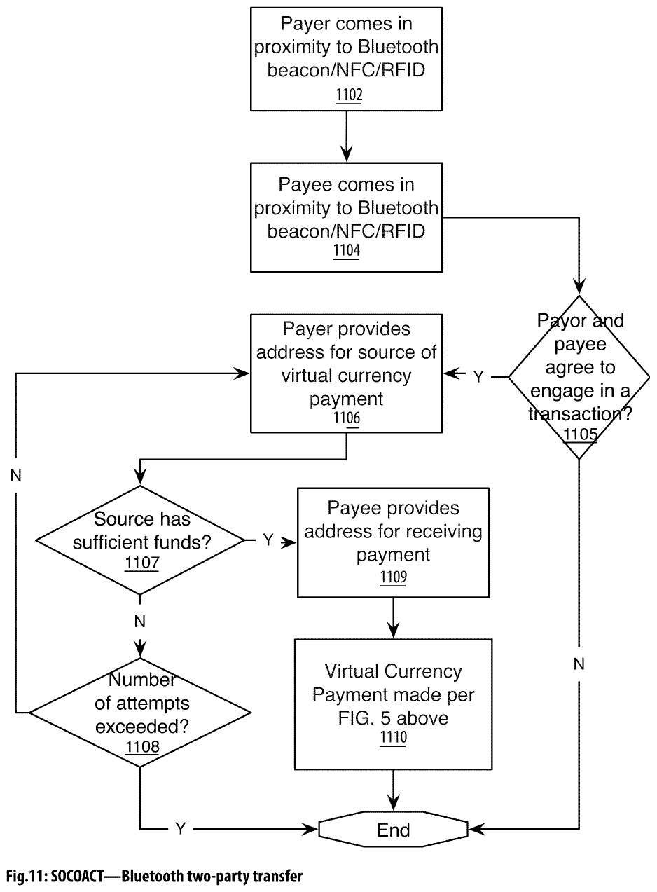

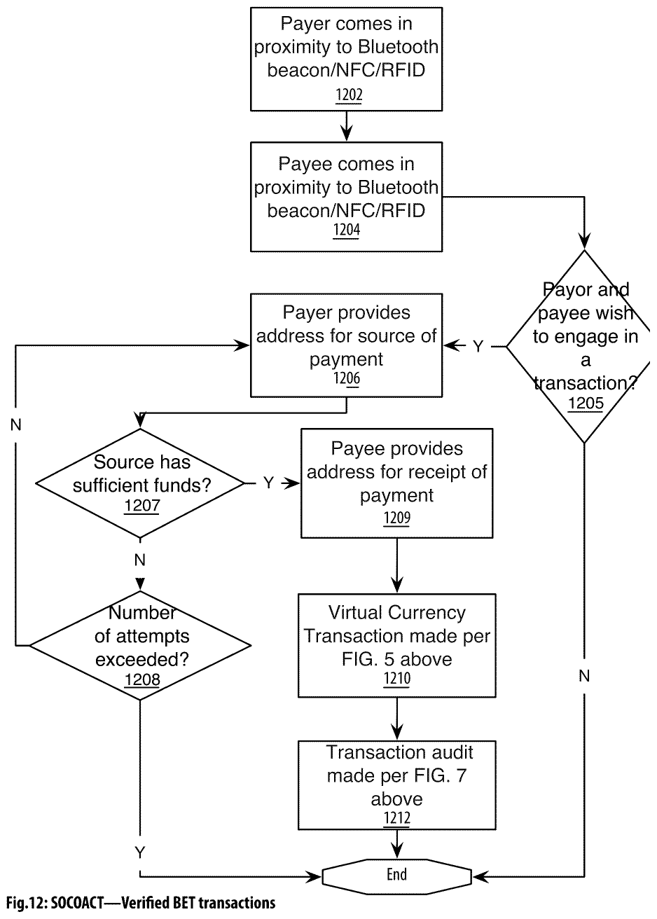

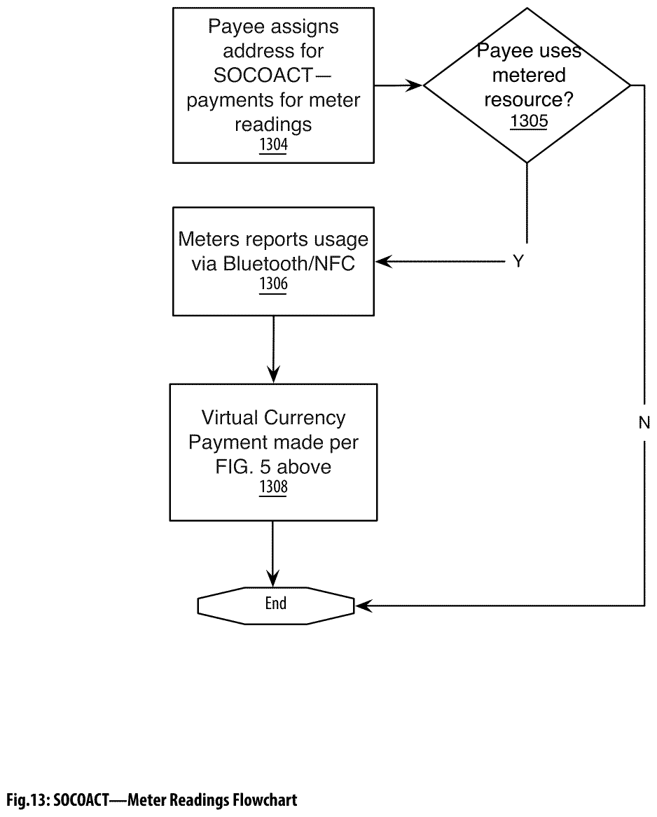

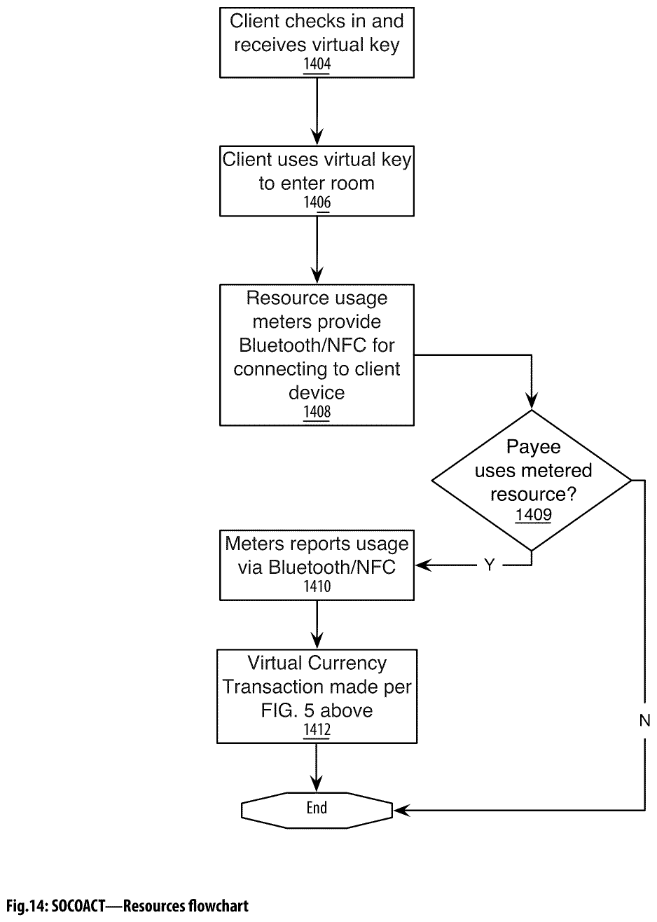

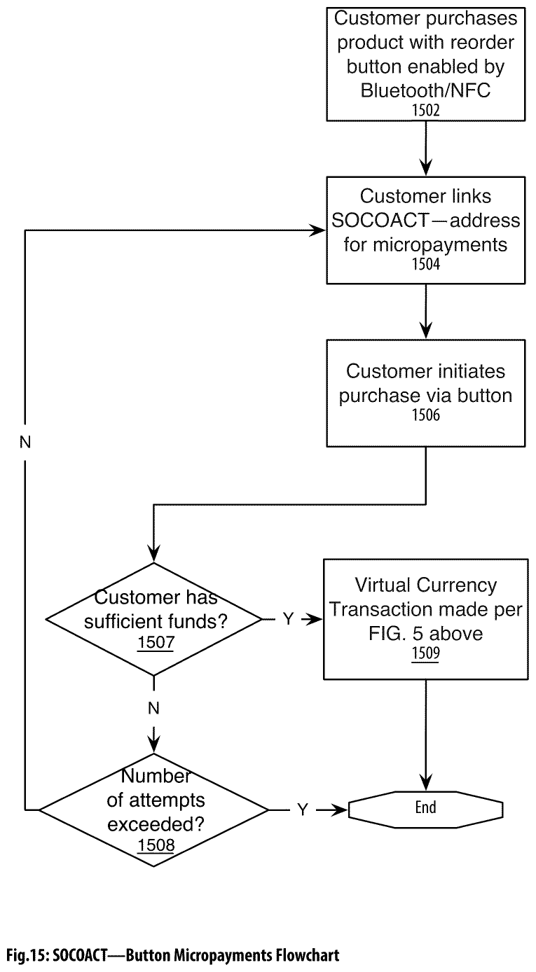

FIG. 5 shows a datagraph illustrating embodiments of a virtual currency transaction performed by the SOCOACT. A user 106a may engage their client 106 such that their virtual wallet interacts with the SOCOACT to affect a transfer of virtual currency to a third party. The third party may confirm the transaction via third-party device 104. In one example, the network interface 102 includes a beacon that may be attached to another device (e.g., a utility monitoring device, a consumable item, another mobile client device, a smartphone, computer, etc.). The beacon may provide a destination virtual currency address to which a transfer of virtual currency is to be completed. Alternatively, or in addition thereto, the third party device 104 may provide the destination address for a transaction in place of a beacon, according to the various implementations described herein. Likewise, the client may provide the destination address with the transaction request when it is otherwise known to the client 106. The network device 102 may be configured to enable network communication between at least one SOCOACT server 17301 and the client terminal 106 and/or third party device 104.

To commence a transaction, the client terminal 106 forwards a wallet identifier message (step 504) to the server 17301. In one embodiment, the SOCOACT server may have instantiated a SOCOACT component 17341A, which in turn may verify that the wallet identifier is valid. In one embodiment, the SOCOACT component will determine that the client's 106 unique identifying address matches and is a valid source of sufficient virtual currency and is properly associated with the wallet identifier (e.g., by checking with a blockchain database 17319k, a wallet database 173190, and/or the like) (step 506). If the wallet identifier is a non-invalid identifier, the SOCOACT may generate a user interface prompt to allow a user to specify a target for payment proceeds, a selection mechanism for the target (e.g., a person, organization, cause, etc.), an amount to pay (e.g., in various electronic and/or real currencies), an item specification for the transaction (e.g., goods, services, equities, derivatives, etc.). In one embodiment, the SOCOACT will search a database to determine what target wallets are currently associated with the client terminal 106. For example, in one embodiment, a hotel cleaning employee may have registered a room, or a valet may have registered with a valet parking beacon, etc., and their digital wallet will be retrieved and an address therefrom specified as a target for a transaction. Upon generating the interface (e.g., by retrieving an HTML template from the SOCOACT database and compositing retrieved information, etc.), the SOCOACT server 17301 may provide the user's client 106 with an interaction interface message (step 510) (e.g., allowing the user to see the target payment/transaction identifier (e.g., hotel valet, and/or hotel organization name, etc.), specify an amount to pay (e.g., a tip amount), an item for transaction (e.g., a towel), and a mechanism to instantiate the transaction (e.g., a ‘pay’ button) for display (step 512). Upon obtaining inputs for these UI selection mechanisms (step 514), the network device 102 may further on the user's transaction message with selections (step 516) to the SOCOACT server 17301 for transaction processing by the SOCOACT component (step 541).

In one embodiment, the client may provide the following example guidance transaction request, substantially in the form of a (Secure) Hypertext Transfer Protocol (“HTTP(S)”) POST message including extensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<guidanceTransactionRequest>
  <timestamp>2020-12-31 23:59:59</timestamp>
  <user_accounts_details>
        <user_account_credentials>
              <user_name>JohnDaDoeDoeDoooe@gmail.com</account_name>
              <password>abc123</password>
              //OPTIONAL <cookie>cookieID</cookie>
              //OPTIONAL <digital_cert_link>www.mydigitalcertificate.com/
JohnDoeDaDoeDoe@gmail.com/mycertifcate.dc</digital_cert_link>
              //OPTIONAL <digital_certificate>_DATA_</digital_certificate>
        </user_account_credentials>
  </user_accounts_details>
  <client_details> //iOS Client with App and Webkit
              //it should be noted that although several client details
              //sections are provided to show example variants of client
              //sources, further messages will include only on to save
              //space
        <client_IP>10.0.0.123</client_IP>
        <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
        <client_product_type>iPhone6,1</client_product_type>
        <client_serial_number>DNXXX1X1XXXX</client_serial_number>
        <client_UDID>3XXXXXXXXXXXXXXXXXXXXXXXXD</client_UDID>
        <client_OS>iOS</client_OS>
        <client_OS_version>7.1.1</client_OS_version>
        <client_app_type>app with webkit</client_app_type>
        <app_installed_flag>true</app_installed_flag>
        <app_name>SOCOACT.app</app_name>
        <app_version>1.0 </app_version>
        <app_webkit_name>Mobile Safari</client_webkit_name>
        <client_version>537.51.2</client_version>
  </client_details>
  <client_details> //iOS Client with Webbrowser
        <client_IP>10.0.0.123</client_IP>
        <user_agent_string>Mozilla/5.0 (iPhone; CPU iPhone OS 7_1_1 like Mac
OS X) AppleWebKit/537.51.2 (KHTML, like Gecko) Version/7.0 Mobile/11D201
Safari/9537.53</user_agent_string>
        <client_product_type>iPhone6,1</client_product_type>
        <client_serial_number>DNXXX1X1XXXX</client_serial_number>
        <client_UDID>3XXXXXXXXXXXXXXXXXXXXXXXXD</client_UDID>
        <client_OS>iOS</client_OS>
        <client_OS_version>7.1.1</client_OS_version>
        <client_app_type>web browser</client_app_type>
        <client_name>Mobile Safari</client_name>
        <client_version>9537.53</client_version>
  </client_details>
  <client_details> //Android Client with Webbrowser
        <client_IP>10.0.0.123</client_IP>
        <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
        <client_product_type>Nexus S</client_product_type>
        <client_serial_number>YXXXXXXXXZ</client_serial_number>
        <client_UDID>FXXXXXXXXX-XXXX-XXXX-XXXX-XXXXXXXXXXXXX</client_UDID>
        <client_OS>Android</client_OS>
        <client_OS_version>4.0.4</client_OS_version>
        <client_app_type>web browser</client_app_type>
        <client_name>Mobile Safari</client_name>
        <client_version>534.30</client_version>
  </client_details>
  <client_details> //Mac Desktop with Webbrowser
        <client_IP>10.0.0.123</client_IP>
        <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
        <client_product_type>MacPro5,1</client_product_type>
        <client_serial_number>YXXXXXXXXZ</client_serial_number>
        <client_UDID>FXXXXXXXXX-XXXX-XXXX-XXXX-XXXXXXXXXXXXX</client_UDID>
        <client_OS>Mac OS X</client_OS>
        <client_OS_version>10.9.3</client_OS_version>
        <client_app_type>web browser</client_app_type>
        <client_name>Mobile Safari</client_name>
        <client_version>537.75.14</client_version>
    </client_details>
    <walletID>abc123456789</walletID>
        <walletType>source</walletType>
        <currencyType>Bitcoin</currencyType>
        <security_identifier>PETS</security_identifier>
    </availability_lookup_request>
  </auth_request>
```

In one embodiment, the SOCOACT component 541 may then provide a commit transaction as between the target wallet identifier (e.g., the hotel valet) and the source wallet identifier (e.g., the initiating user 106) and eventually cause a blockchain entry of the transaction to be recorded (step 542). Thereafter, the SOCOACT server 17301 may provide a confirmation message (step 552) to the client 106 for display (step 555).

An electronic coin may be a chain of digital signatures. Each owner transfers the coin to the next by digitally signing a hash of the previous transaction and the public key of the next owner and adding these to the end of the coin. A payee can verify the signatures to verify the chain of ownership. So, effectively if BTCO is the previous transaction, the new transaction is:

Kp(Owner1)
hash := H(BTC0,Kp(Owner1))
S(hash,Ks(Owner0)), where
Kp(Owner1) is the public key fo the recipient (Owner1)
hash := H(BTC0,Kp(Owner1)) is the hash of the previous transaction together with
the public key of the recipient; and
S(hash,Ks(Owner0)) is the previously computed hash, signed with the private key
sender (Owner0).
Principle example of a Bitcoin transaction with 1 input and 1 output only
Input:
Previous tx: f5d8ee39a430901c91a5917b9f2dc19d6d1a0e9cea205b009ca73dd04470b9a6
Index: 0
scriptSig: 304502206e21798a42fae0e854281abd38bacd1aeed3ee3738d9e1446618c4571d10
90db022100e2ac980643b0b82c0e88ffdfec6b64e3e6ba35e7ba5fdd7d5d6cc8d25c6b241501
Output:
Value: 5000000000
scriptPubKey: OP_DUP OP_HASH160 404371705fa9bd789a2fcd52d2c580b65d35549d
OP_EQUALVERIFY OP_CHECKSIG

The input in this transaction imports 50 denominations of virtual currency from output #0 for transaction number the transaction number starting with character f5d8 . . . above. Then the output sends 50 denominations of virtual currency to a specified target address (expressed here in hexadecimal string starting with 4043 . . . ). When the recipient wants to spend this money, he will reference output #0 of this transaction as an input of his next transaction.

An input is a reference to an output from a previous transaction. Multiple inputs are often listed in a transaction. All of the new transaction's input values (that is, the total coin value of the previous outputs referenced by the new transaction's inputs) are added up, and the total (less any transaction fee) is completely used by the outputs of the new transaction. According to blockchain technology, a transaction is a hash of previous valid transaction strings. Index is the specific output in the referenced transaction. ScriptSig is the first half of a script (discussed in more detail later).

The script contains two components, a signature and a public key. The public key must match the hash given in the script of the redeemed output. The public key is used to verify the redeemer's or payee's signature, which is the second component. More precisely, the second component may be an ECDSA signature over a hash of a simplified version of the transaction. It, combined with the public key, proves the transaction created by the real owner of the address in question. Various flags define how the transaction is simplified and can be used to create different types of payment.

Two consecutive SHA-256 hashes are used for transaction verification. RIPEMD-160 is used after a SHA-256 hash for virtual currency digital signatures or “addresses.” A virtual currency address is the hash of an ECDSA public-key, which may be computed as follows:

Key hash = Version concatenated with RIPEMD-160 (SHA-256 (public
key))
Checksum = 1st 4 bytes of SHA-256 (SHA-256 (Key hash))
Bitcoin address = Base58Encode (Key hash concatenated with Checksum)

The virtual currency address within a wallet may include an identifier (account number), for example, starting with 1 or 3 and containing 27-34 alphanumeric Latin characters (except, typically: 0, O, I, and 1 to avoid possible confusion). The address can be also represented as the QR-code and is anonymous and does not contain information about the owner. It can be obtained for free, using SOCOACT.

The ability to transact virtual currency without the assistance of a central registry is facilitated in part by the availability of a virtually unlimited supply of unique addresses, which can be generated and disposed of at will. The balance of funds at a particular address can be ascertained by looking up the transactions to and from that address in the block chain. All valid transfers of virtual currency from an address are digitally signed using the private keys associated with it.

A private key in the context of virtual currency is a secret number that allows denominations of the virtual currency to be spent. Every address within a wallet has a matching private key, which is usually saved in the wallet file of the person who owns the balance, but may also be stored using other means and methods. The private key is mathematically related to the address, and is designed so that the address can be calculated from the private key while, importantly, the reverse cannot be done.

An output contains instructions for sending virtual currency. ScriptPubKey is the second half of a script. There can be more than one output that shares the combined value of the inputs. Because each output from one transaction can only ever be referenced once by an input of a subsequent transaction, the entire combined input value needs to be sent in an output to prevent its loss. If the input is worth 50 coins but one only wants to send 25 coins, SOCOACT will create two outputs worth 25 coins, sending one to the destination and one back to the source. Any input not redeemed in an output is considered a transaction fee, and whoever operates the SOCOACT will get the transaction fee, if any.

To verify that inputs are authorized to collect the values of referenced outputs, SOCOACT uses a custom scripting system. The input's scriptSig and the referenced output's scriptPubKey are evaluated in that order, with scriptPubKey using the values left on the stack by scriptSig. The input is authorized if scriptPubKey returns true. Through the scripting system, the sender can create very complex conditions that people have to meet in order to claim the output's value. For example, it's possible to create an output that can be claimed by anyone without any authorization. It's also possible to require that an input be signed by ten different keys, or be redeemable with a password instead of a key.

SOCOACT transactions create two different scriptSig/scriptPubKey pairs. It is possible to design more complex types of transactions, and link them together into cryptographically enforced agreements. These are known as Contracts.

An exemplary Pay-to-PubkeyHash is as follows:

scriptPubKey: OP_DUP OP_HASH16∅ <pubKeyHash>
OP_EQUALVERIFY OP_CHECKSIG
scriptSig: <sig> <pubKey>

An address is only a hash, so the sender can't provide a full public key in scriptPubKey. When redeeming coins that have been sent to an address, the recipient provides both the signature and the public key. The script verifies that the provided public key does hash to the hash in scriptPubKey, and then it also checks the signature against the public key.

FIG. 6 shows a flowchart of a blockchain generation process for the SOCOACT. New transactions are broadcast to all nodes (step 602). The steps of this process that follow are performed iteratively for each miner node (step 603). Each miner node collects new transactions into a block(step 604). Each miner node works on finding a difficult proof-of-work for its block (step 606). At step 607, the SOCOACT determines whether a proof of work is found. If so, the process continues to step 608. Otherwise, the process returns to step 604 above. When a node finds a proof-of-work, it broadcasts the block to all nodes (step 608). Nodes accept the block only if all transactions in it are valid and not already spent (step 610). Nodes express their acceptance of the block by working on creating the next block in the chain, using the hash of the accepted block as the previous hash (step 612).

Transaction confirmation is needed to prevent double spending of the same money. After a transaction is broadcast to the SOCOACT network, it may be included in a block that is published to the network. When that happens it is said that the transaction has been mined at a depth of one block. With each subsequent block that is found, the number of blocks deep is increased by one. To be secure against double spending, a transaction should not be considered as confirmed until it is a certain number of blocks deep. This feature was introduced to protect the system from repeated spending of the same coins (double-spending). Inclusion of transaction in the block happens along with the process of mining.

The SOCOACT server 17301 may show a transaction as “unconfirmed” until the transaction is, for example, six blocks deep in the blockchain. Sites or services that accept virtual currency as payment for their products or services can set their own limits on how many blocks are needed to be found to confirm a transaction. However, the number six was specified deliberately. It is based on a theory that there's low probability of wrongdoers being able to a mass more than 10% of entire network's hash rate for purposes of transaction falsification and an insignificant risk (lower than 0.1%) is acceptable. For offenders who don't possess significant computing power, six confirmations are an insurmountable obstacle with readily accessible computing technology. In their turn people who possess more than 10% of network power aren't going to find it hard to get six confirmations in a row. However, to obtain such a power would require millions of dollars' worth of upfront investments, which significantly defers the undertaking of an attack. Virtual currency that is distributed by the network for finding a block can only be used after, e.g., one hundred discovered blocks.

FIG. 7 shows a flowchart of a blockchain auditing process for the SOCOACT. The process commences when a client inputs a request to confirm a transaction (step 701). The client may select, enter, retrieve or otherwise provide a public key corresponding to the payer or payee of a transaction or transactions to be audited.

Next, the request is transmitted to the SOCOACT (step 702). In response, the SOCOACT Component performs a Blockchain lookup Process using the public key and other information provided (step 704).

The lookup results are then sent to client (step 706). The client next transmits a Decryption Process request (step 708). Responsively, a request to select a public key is displayed to the client (step 710) before the decryption process can commence.

Next, at step 712, the user inputs a selection of a stored public key. The selection of the public key is then sent to SOCOACT (step 714). Responsively, the SOCOACT Component performs a Key Comparison Request process (step 716). The SOCOACT then requests the selected public key from the processor of the client 106 (step 718). The client 106 responsively retrieves the selected public key from a memory of the client 106 (step 720). The public key is then transmitted to the SOCOACT (step 722). The SOCOACT Component then decrypts the transaction record in the stored blockchain using the public key (step 724). The decryption results are transmitted to the client 106 (step 726), which, in turn, displays the transaction confirmation details to the user 106a on a display of the client 106 or the like (step 728). This auditing process then ends.

FIG. 8 shows a flowchart of a virtual currency transaction process between a buyer and a seller using the SOCOACT. At a commencement of the process, a buyer (i.e., a payer) requests registration with the SOCOACT system (step 801). In response, the SOCOACT serves a registration form for completion by the buyer (step 804). The registration form may include an identification of the buyer, the buyers wallet, and a source of funds to be established in the wallet.

Likewise, a seller (i.e., a payee) registers with the system and offers an item for sale locally (step 806). The SOCOACT may generate a listing for the seller's item that is accessible to other users of the SOCOACT (step 808). Alternatively, or in addition thereto, the listing may provided at a physical or virtual location other than through the SOCOACT. The buyer, at any later point, checks the listing and indicates her interest in the item (step 810). The SOCOACT updates the listing and notifies the seller (step 814). The seller sees the interest and suggests a meeting location to the buyer via the SOCOACT (step 816). The buyer agrees and notifies the seller via the SOCOACT (step 812).

Next, the Buyer arrives at the agreed upon location at the designated time (step 817). Using a beacon or NFC, as described herein, or similar means, the SOCOACT may be able to determine when both parties are in close proximity (step 818) and begin the transaction there-between, for example, on their respective portable electronic devices.

Alternatively, the buyer and seller may determine their proximity directly in any of a variety of manners. For example, the seller may arrive or otherwise be established or open at physical location at a specified time (step 820). Seller takes a picture of some detail of the surroundings and asks buyer to take a similar picture (step 822). The SOCOACT sends the photo from the seller to the buyer (step 824). The buyer may then locate a detail in the received picture and take a similar picture of the detail (step 826). The buyer sends his/her picture back to the SOCOACT (step 828). The SOCOACT responsively sends the photo from the buyer to the seller (step 830). The seller confirms that the picture is similar and locates the buyer at the location (step 832). The handshake may also be repeated in reverse, such that buyer is able to locate the seller in a similar manner to the foregoing (step 834).

When the buyer and seller meet, the seller may then offer the goods for inspection by the buyer (step 836). The buyer then confirms that the item is acceptable (step 838). The seller then sends a virtual currency address from the seller's wallet to the Buyer via the SOCOACT (step 840). Responsively, the SOCOACT forwards the address to the buyer (step 842). The buyer then sends the agreed-upon denomination of virtual currency from the buyer's wallet address to the seller's address (step 844). Once the transaction is confirmed, for example, by auditing the SOCOACT blockchain according to FIG. 7, the seller gives the goods to the buyer (step 846). The transaction then ends (step 848).

FIG. 9 shows a Bluetooth or NFC-enabled environment for enabling a SOCOACT transaction, such as the transactions described in FIG. 8. Using Bluetooth or NFC beacons, various people and systems can be paid where real-world cash would normally be used, such as the valet, housekeeper at a hotel. In addition, by binding a smartphone or other portable electronic device to a hotel room upon entry, and then de-binding on exit, a hotel customer can keep very granular track of usage and payments with a seamless, friction-free payment and accounting system.

FIG. 10 shows a flowchart of a Bluetooth payment process for the SOCOACT in an environment such as FIG. 9, where the location of the payee is fixed to a particular locale or property. At a commencement of the process, a payer comes in proximity to a bluetooth or NFC beacon established on the property (step 1002), where a payee's virtual currency address is broadcast by the beacon (step 1003). Next, at step 1004, when the Bluetooth beacon is received by a payer, the process continues to step 1005. Otherwise, the process returns to step 1003 above. At step 1005, it is determined whether the payer wishes to make a payment to the payee. If so, the process continues to step 1006. Otherwise, the process ends. Next, the payer provides a source address for a virtual currency payment (step 1006). The payer authorizes an amount of payment to be made in denominations of the virtual currency (step 1008). This virtual currency payment may then be completed in accordance with FIG. 5 above (step 1010).

FIG. 11 shows a flowchart of a Bluetooth or NFC inter-party payment process enabled by the SOCOACT. A payer comes in proximity to a third-party Bluetooth or NFC beacon (step 1102). A payee comes in proximity to the same beacon (step 1104). If the payer and payee wish to engage in a transaction (step 1105), the process continues to step 1106. Otherwise, the process ends. The payer provides his address as a source of virtual currency payment (step 1106). Next, at step 1107, the SOCOACT system confirms whether the payer source of funds has a sufficient balance for completing the transaction. This may be done by comparing the requested transaction amount to the balance stored in the source account or wallet. If the balance is sufficient, the process continues to step 1109 below. Otherwise, the process continues to step 1108, where it is determined whether the payer has exceeded any established number of attempts to provide a source of sufficient funds. If not, the process returns to step 1106 above. Otherwise, when the number of attempts has been exceeded, the process ends.

Continuing from step 1107 above, the payee next provides a destination address corresponding to the seller's wallet for receiving payment of the virtual currency (step 1109). The virtual currency payment may then be made in accordance with FIG. 5 above (step 1110).

FIG. 12 shows a flowchart of a verified payment process for the SOCOACT. A payer comes in proximity to a third-party Bluetooth or NFC beacon (step 1202). A payee comes in proximity to the same beacon (step 1204). If the payer and payee wish to engage in a transaction (step 1205), the process continues to step 1206. Otherwise, the process ends. The payer next provides his address as a source of virtual currency payment (step 1206). Next, at step 1207, the SOCOACT system confirms whether the payer source of funds has a sufficient balance for completing the transaction. If the balance is sufficient, the process continues to step 1209 below. Otherwise, the process continues to step 1208, where it is determined whether the payer has exceeded any established number of attempts to provide a source of sufficient funds. If not, the process returns to step 1206 above. Otherwise, when the number of attempts has been exceeded, the process ends.

Continuing from step 1207 above, the payee next provides a destination address corresponding to the seller's wallet for receiving payment of the virtual currency (step 1209). The virtual currency payment may then be made in accordance with FIG. 5 above (step 1210). The transaction may then be verified according to the auditing process described in FIG. 7 above.

FIG. 13 shows a flowchart of a meter reading process enabled by the SOCOACT. At a commencement of this process, a payee assigns a wallet address for SOCOACT payments for meter readings (step 1304). For instance, the meters may represent gas, oil, water, electricity and/or other residential or commercial resource monitors that may be established and installed by utility companies, government agencies and the like. Next, at step 1305, it is determined whether the payee has used one or more metered resources. If not, the process ends. Otherwise, the process continues to step 1306 where the meters reports usage via Bluetooth/NFC in communication or integrated with one or more of the meters. A virtual currency payment is then made periodically to cover resource usage in accordance with FIG. 5 above (step 1308).

FIG. 14 shows a flowchart of a hotel resource monitoring process enabled by the SOCOACT. At a commencement of this process, a hotel customer checks in and, after providing a wallet address for a source of virtual currency payment, receives on his smartphone or portable electronic device a virtual key that may be used in conjunction with Bluetooth or NFC beacons to gain access to the customer's hotel room (step 1404). Next, the customer uses virtual key to enter the room (Step 1406). Resource usage meters in the room provide a beacon for connecting to the customer's device (step 1408). Next, at step 1409, it is determined whether the payee has used one or more metered resources. If not, the process ends. Otherwise, the process continues to step 1410 where the meters report resource usage via Bluetooth/NFC to both the customer's device and to the SOCOACT. Upon check out, a payment based on resource usage may then be made in accordance with FIG. 5 above (step 1412).

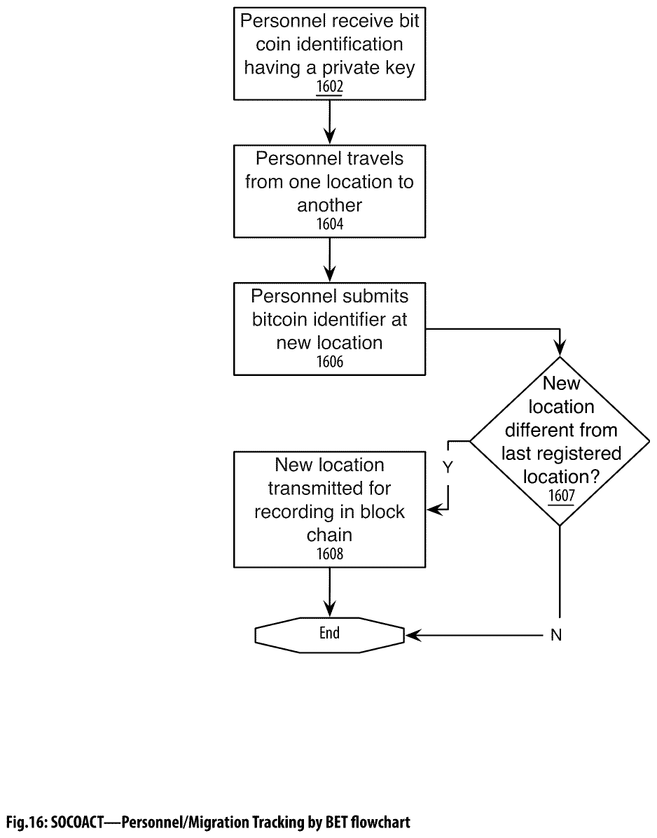

FIG. 15 shows a flowchart of a micropayment button payment process for the SOCOACT. A customer may purchase a product having a re-order button enabled by Bluetooth/NFC (step 1502). One example of such functionality is provided by AMAZON DASH. As with the foregoing embodiments, such functionality may likewise be provided by Radio Frequency Identification (RFID) tags, NFC and other local code reading devices. The customer then links a SOCOACT address for issuing micropayments in order to replenish the product on demand (step 1504). The customer initiates a purchase via the button (step 1506). Next, at step 1507, the SOCOACT system confirms whether the payer source of funds has a sufficient balance for completing the transaction. If the balance is sufficient, the process continues to step 1509 below. Otherwise, the process continues to step 1508, where it is determined whether the payer has exceeded any established number of attempts to provide a source of sufficient funds. If not, the process returns to step 1504 above. Otherwise, when the number of attempts has been exceeded, the process ends. Continuing from step 1507, a virtual currency payment may then be made in accordance with FIG. 5 above (step 1509).

FIG. 16 shows a flowchart of a non-monetary personnel or item tracking process enabled by the SOCOACT. At the start of such process, a person or item is assigned a virtual identifier in the form of a private key (step 1602). In various embodiments involving the tracking of personnel, biometric data of a person can be used as the identifier, or otherwise incorporated into the identifier. The biometric data may include retinal scan or fingerprint scan data, facial recognition technology and other known and useful biometric identifications. All or a meaningful portion of the biometric data may be used in the public key assigned to the person. Other similar implementations are readily contemplated.

Next, the person or item then travels from one location to another (step 1604). The person or item then submits the virtual identifies at a new geographic location (step 1606). Next, at step 1607, the SOCOACT system determines whether the new location being registered is different from the last registered (i.e., within a different region, state or country). If not, the process ends. Otherwise, when the location is different, the new location is transmitted to the SOCOACT for recording in the block chain (step 1608). The process then ends.

In non-monetary transactions, a virtual token can convey particularized information using OP Return codes or the like. Such field can place bits of information into the transaction's scriptSig value so that the irreversibility of the blockchain can be used to make that information verifiable at later times. OP_RETURN is a valid opcode to be used in a bitcoin transaction, which allows 80 arbitrary bytes to be used in an unspendable transaction.

An exemplary transaction which has an OP_RETURN in its scriptSig, the hash of which may be for example, a text string such as:
8bae12b5f4c088d940733dcd1455efc6a3a69cf9340e17a981286d3778615684

A command entered into a node of the SOCOACT, such as:
$>bitcoind getrawtransaction 8bae12b5f4c088d940733dcd1455efc6a3a69cf9340e17a981286d37786 15684

would yield the following output:

{
″hex″
″0100000001c858ba5f607d762fe5be1dfe97ddc121827895c2562c4348d69d02b91dbb408e01000
0008b4830450220446df4e6b875af246800c8c976de7cd6d7d95016c4a8f7bcdbba81679cbda2420
22100c1ccfacfeb5e83087894aa8d9e37b11f5c054a75d030d5bfd94d17c5bc953d4a0141045901f
6367ea950a5665335065342b952c5d5d60607b3cdc6c69a03df1a6b915aa02eb5e07095a2548a98d
cdd84d875c6a3e130bafadfd45e694a3474e71405a4ffffffff020000000000000000156a1363686
1726c6579206c6f766573206865696469400d0300000000001976a914b8268ce4d481413c4e848ff
353cd 16104291c45b88ac00000000″,
″txid″ : ″8bae12b5f4c088d940733dcd1455efc6a3a69cf9340e17a981286d3778615684″ ,
″version″ : 1,
″locktime″ : 0,
″vin″ : [
{
″txid″
″8e40bb1db9029dd648432c56c295788221c1dd97fe1dbee52f767d605fba58c8″ ,
″vout″ : 1,
″scriptSig″ : {
″asm″
:
″30450220446df4e6b875af246800c8c976de7cd6d7d95016c4a8f7bcdbba81679cbda242022100c
1ccfacfeb5e83087894aa8d9e37b11f5c054a75d030d5bfd94d17c5bc953d4a01
045901f6367ea950a5665335065342b952c5d5d60607b3cdc6c69a03df1a6b915aa02eb5e07095a2
548a98dcdd84d875c6a3e130bafadfd45e694a3474e71405a4″ ,
″hex″
:
″4830450220446df4e6b875af246800c8c976de7cd6d7d95016c4a8f7bcdbba81679cbda24202210
0c1ccfacfeb5e83087894aa8d9e37b11f5c054a75d030d5bfd94d17c5bc953d4a0141045901f6367
ea950a5665335065342b952c5d5d60607b3cdc6c69a03df1a6b915aa02eb5e07095a2548a98dcdd8
4d875c6a3e130bafadfd45e694a3474e71405a4″
},
″sequence″ : 4294967295
}
1,
″vout″ : [
{
″value″ : 0.00000000,
″n″ : 0,
″scriptPubKey″ : {
″asm″ : ″OP_RETURN 636861726c6579206c6f766573206865696469″,
″hex″ : ″6a13636861726c6579206c6f766573206865696469″,
″type″ : ″nulldata″
}
},
{
″value″ : 0.00200000,
″n″ : 1,
″scriptPubKey″ : {
″asm″ : ″OP_DUP OP_HASH160 b8268ce4d481413c4e848ff353cd16104291c45b
OP_EQUALVERIFY OP_CHECKSIG″,
″hex″ : ″76a914b8268ce4d481413c4e848ff353cd 16104291c45b88ac″ ,
″reqSigs″ : 1,
″type″ : ″pubkeyhash″,
″addresses″ : [
″ 1HnhWpkMHMjgt 167kvgcPyurMmsCQ2WPgg″
]
}
}
],
″blockhash″
″000000000000000004c31376d7619bf0f0d65af6fb028d3b4a410ea39d22554c″,
″confirmations″ : 2655,
″time″ : 1404107109,
″blocktime″ : 1404107109

The OP_RETURN code above is represented by the hex value 0x6a. This first byte is followed by a byte that represents the length of the rest of the bytes in the scriptPubKey. In this case, the hex value is Ox13, which means there are 19 more bytes. These bytes comprise the arbitrary less-than-80 bytes one may be allowed to send in a transaction marked by the OP_RETURN opcode.

For purposes of personnel tracking, the virtual currency distributed by the SOCOACT system may include the following data fields in conjunction with OP Return Code mechanism:

| Unique Identifier (UN-ID) | 10 positions (non-rewriteable) |
|---|---|
| Code | |
| GPS start location | 20 positions (non-rewriteable) |
| GPS inter location | 20 positions (this field can keep changing) |
| GPS final location | 20 positions (cannot change) |
| Name | 14 positions |
| Gender | 1 position (M/F) |
| Age at assignment | 2 positions |
| Examples: | |
| UN-ID code | 0123456789 |
| GPS Start Location | 36.8166700, −1.2833300 |
| GPS inter location | 38.897709, −77.036543 |
| GPS final location | 41.283521, −70.099466 |
| Name | Doe, John |
| Gender | M |
| Age at assignment | 53 |

Each person is provided a unique identifier in addition to any government issued documentation associated with the person. The SOCOACT blockchain database 17319k stores and maintains records from the person's departing country along with a photo, a recording, voiceprint, and/or other biometric identification of person along with the established identifier. At a later date, the SOCOACT can access the Block Chain publicly, and personnel location can be transparent and tracked.

In an additional example, the 80-byte header containing personnel tracking information recorded in the blockchain may take the following form in an XML-enabled format:

<?xml version=“1.0”?>
<ROWSET>
<ROW>
<UN_ID_Code>GPS Start location (low precision)</UN_ID_Code>
<10_-_numeric>12 numeric</10_-_numeric>
<1323249990>35.8864, −78.8589</1323249990>
</ROW>
<ROW>
<UN_ID_Code>GPS inter location</UN_ID_Code>
<10_-_numeric>12 numeric</10_-_numeric>
<1323249990>53.1355, −57.6604</1323249990>
</ROW>
<ROW>
<UN_ID_Code>GPS final location </UN_ID_Code>
<10_-_numeric>12 numeric</10_-_numeric>
<1323249990>42.3330, −71.0487</1323249990>
</ROW>
<ROW>
<UN_ID_Code>Name</UN_ID_Code>
<10_-_numeric>20 alpa</10_-_numeric>
<1323249990>Fitzgerald, Michael</1323249990>
</ROW>
<ROW>
<UN_ID_Code>Gender</UN_ID_Code>
<10_-_numeric>M/F</10_-_numeric>
<1323249990>M</1323249990>
</ROW>
<ROW>
<UN_ID_Code>Age at Assignment</UN_ID_Code>
<10_-_numeric>2 numeric</10_-_numeric>
<1323249990>12</1323249990>
</ROW>
<ROW>
<UN_ID_Code>Filler</UN_ID_Code>
<10_-_numeric>11 blank</10_-_numeric>
<1323249990></1323249990>
</ROW>
<ROW>
<UN_ID_Code></UN_ID_Code>
<10_-_numeric>80 positions</10_-_numeric>
<1323249990></1323249990>
</ROW>
</ROWSET>

The foregoing exemplary XML datastructure can be represented by the following table of its field names, field types, field sizes and field data:

| | Field | |
|---|---|---|
| Field Name | size/type | Field Data |
| UN ID Code | 10 numeric | 123456789 |
| GPS Start location | 12 numeric | 36.81, −1.28 |
| (low precision) | | |
| GPS inter location | 12 numeric | 38.89, −77.03 |
| GPS final location | 12 numeric | 41.28, −70.09 |
| Name | 14 alpha | Obama, Barack, H |
| Gender | M/F | M |
| Age at Assignment | 2 numeric | 53 |
| Filler | 17 blank | |
| | 80 positions | |

In a further example, the 80-byte header containing personnel tracking information recorded in the blockchain may take the following form in an XML-enabled format:

<? xml version=″1.0″ ?>
<ROWSET>
<ROW>
<UN ID_Code>GPS Start location (low precision) </UN_ID_Code>
<10 _-_ numeric>12 numeric</10 _-_ numeric>
<1323249990>35.8864, -78.8589</1323249990>
< / ROW>
<ROW>
<UN_ID_Code>GPS inter location</UN_ID_Code>
<10 _-_ numeric>12 numeric</10 _-_ numeric>
<1323249990>53. 1355, -57. 6604</ 1323249990>
< / ROW>
<ROW>
<UN_ID_Code>GPS final location </UN_ID_Code>
<10 _-_ numeric>12 numeric</10 _-_ numeric>
<1323249990>42. 3330, -71. 0487</ 1323249990>
</ ROW>
<ROW>
<UN_ID_Code>Name</UN_ID_Code>
<10 _-_ numeric>20 alpa</10 _-_ numeric>
<1323249990>Fitzgerald, Michael</ 1323249990>
</ ROW>
<ROW>
<UN_ID_Code>Gender</UN_ID_Code>
<10 _-_ numeric>M/F</10 _-_ numeric>
<1323249990>M</1323249990>
< / ROW>
<ROW>
<UN_ID_Code>Age at Assignment</UN_ID_Code>
<10 _-_ numeric>2 numeric</ 10 _-_ numeric>
<1323249990>12</1323249990>
</ROW>
<ROW>
<UN_ID_Code>Filler</UN_ID_Code>
<10 _-_ numeric>11 blank</10 _-_ numeric>
<1323249990></1323249990>
< / ROW>
<ROW>
<UN_ID_Code></UN_ID_Code>
<10 _-_ numeric>80 positions</10 _-_ numeric>
<1323249990></ 1323249990>
< / ROW>
< / ROWSET>

The foregoing exemplary XML datastructure can be represented by the following table of its field names, field types, field sizes and field data:

| | Field | |
|---|---|---|
| Field Name | size/type | Field Data |
| UN ID Code | 10 numeric | 1323249990 |
| GPS Start location | 12 numeric | 35.88, −78.85 |
| (low precision) | | |
| GPS inter location | 12 numeric | 53.13, −57.66 |
| GPS final location | 12 numeric | 42.33, −71.04 |
| Name | 20 alpha | Fitzgerald, |
| | | Michael |
| Gender | M/F | M |
| Age at Assignment | 2 numeric | 12 |
| Filler | 11 blank | |
| | 80 positions | |

In a still further example, the 80-byte header containing personnel tracking information recorded in the blockchain may take the following form in an XML-enabled format:

<? xml version=″1.0″ ?>
<ROWSET>
<ROW>
<UN_ID_Code>GPS Start location (low precision) </UN_ID_Code>
<10 _-_ numeric>12 numeric</10 _-_ numeric>
<3102521980>37.5629, -122.325</3102521980>
< / ROW>
<ROW>
<UN_ID_Code>GPS inter location</UN_ID_Code>
<10 _-_ numeric>12 numeric</10 _-_ numeric>
<3102521980>42.2808, -83.7430</3102521980>
< / ROW>
<ROW>
<UN_ID_Code>GPS final location </UN_ID_Code>
<10 _-_ numeric>12 numeric</10 _-_ numeric>
<3102521980>42.3317, -71. 1211</3102521980>
< / ROW>
<ROW>
<UN_ID_Code>Name</UN_ID_Code>
<10 _-_ numeric>20 alpa</ 10 _-_ numeric>
<3102521980>Brady, Thomas </3102521980>
< / ROW>
<ROW>
<UN_ID_Code>Gender</UN_ID_Code>
<10 _-_ numeric>M/F</10 _-_ numeric>
<3102521980>M</3102521980>
</ROW>
<ROW>
<UN_ID_Code>Age at Assignment</UN_ID_Code>
<10 _-_ numeric>2 numeric</10 _-_ numeric>
<3102521980>38</3102521980>
</ ROW>
<ROW>
<UN_ID_Code>Filler</UN_ID_Code>
<10 _-_ numeric>11 blank</10 _-_ numeric>
<3102521980></3102521980>
</ ROW>
<ROW>
<UN_ID_Code></UN_ID_Code>
<10 _-_ numeric>80 positions</10 _-_ numeric>
<3102521980></3102521980>
< / ROW>
< / ROWSET>

The foregoing exemplary XML datastructure can be represented by the following table of its field names, field types, field sizes and field data:

| | Field | |
|---|---|---|
| Field Name | size/type | Field Data |
| UN ID Code | 10 numeric | 3102521980 |
| GPS Start location (low precision) | 12 numeric | 37.56, −122.32 |
| GPS inter location | 12 numeric | 42.08, −83.74 |
| GPS final location | 12 numeric | 42.37, −71.12 |
| Name | 20 alpha | Brady, Thomas |
| Gender | M/F | M |
| Age at Assignment | 2 numeric | 38 |
| Filler | 11 blank | |
| | 80 positions | |

Another useful datastructure for personnel tracking can be represented by the following exemplary table of field names, field types, field sizes and field data (the corresponding XML datastructure is similar to those examples provided in the foregoing):

| Field | Purpose | Updated when . . . | Type | Size | Example |
|---|---|---|---|---|---|
| UN-ID | 10 positions | Never changes | Integer | 10 | 123456789 |
| Code | (should not change) | | | | |
| GPS start | 20 positions | Never changes | Double | 20 | 38.897709, |
| location | (cannot change) | | Int | | −77.036543 |
| GPS Inter | 20 positions (this field can | Per update on | Double | 20 | −1.81508, |
| location | keep changing) | location | Int | | −3.0306 |
| GPS final | 20 positions (this field can | Per update on | Double | 20 | 40.712784, |
| location | keep changing) | location | Int | | −74.005941 |
| Name | Current target in compact | Never changes | Char | 14 | John S |
| | format | | | | Smith |
| Gender | Gender M/F | Gender change | Bolean | 1 | M |
| Age at | 16-bit number (starts at 0) | At assignement | Integer | 2 | 42 |
| assignment | | | | | |

In an additional monetary example, an 80-byte header containing transaction information to be recorded in the blockchain may take the following form in an XML-enabled format:

<? xml version=“1.0”?>
<ROWSET>
<ROW>
<Field></Field>
<Purpose></Purpose>
<Updated_when_></Updated_when_>
<FIELD4>Type</FIELD4>
<Size></Size>
<Example></Example>
< / ROW>
<ROW>
<Field>Version</Field>
<Purpose>Block version number</Purpose>
<Updated_when_>When software upgraded</Updated_when_>
<FIELD4>Integer</FIELD4>
<Size>4</Size>
<Example> 1012</Example>
< / ROW>
<ROW>
<Field></Field>
<Purpose></Purpose>
<Updated_when_]></Updated_when _? >
<FIELD4></FIELD4>
<Size></Size>
<Example></Example>
< / ROW>
<ROW>
<Field>Stock Code</Field>
<Purpose>256-bit hash of the previous block header</Purpose>
<Updated_when_>Stock Symbol; Exchange; Amount (% share)
</Updated_when_>
<FIELD4>Char</FIELD4>
<Size>32</Size>
<Example>GOOG. ; NASDAQ:0.00023</Example>
< / ROW>
<ROW>
<Field></Field>
<Purpose></Purpose>
<Updated_when __ ></Updated_when _? >
<FIELD4></FIELD4>
<Size></Size>
<Example></Example>
< / ROW>
<ROW>
<Field>Op_Return </Field>
<Purpose>256-bit hash based on all of the transactions in the block (aka
checksum) </Purpose>
<Updated_when_>A transaction is accepted</Updated_when_>
<FIELD4>Double Int</FIELD4>
<Size>32</Size>
<Example>0x444f4350524f4f46</Example>
< / ROW>
<ROW>
<Field></Field>
<Purpose></Purpose>
<Updated_when_></Updated_when_>
<FIELD4></FIELD4>
<Size></Size>
<Example></Example>
</ROW>
<ROW>
<Field>Time</Field>
<Purpose>Current timestamp as seconds since 1970-01-01T00:00 UTC
</Purpose>
<Updated_when_>Every few seconds</Updated_when_>
<FIELD4>Int</FIELD4>
<Size>4</Size>
<Example> 1444655572</Example>
< / ROW>
<ROW>
<Field></Field>
<Purpose></Purpose>
<Updated_when __ ></Updated_when_]>
<FIELD4></FIELD4>
<Size></Size>
<Example></Example>
< / ROW>
<ROW>
<Field>Bits</Field>
<Purpose>Current target in compact format</Purpose>
<Updated_when_>The difficulty is adjusted</Updated_when _? >
<FIELD4></FIELD4>
<Size>4</Size>
<Example>484b4512</Example>
< / ROW>
<ROW>
<Field></Field>
<Purpose></Purpose>
<Updated_when_]></Updated_when _? >
<FIELD4></FIELD4>
<Size></Size>
<Example></Example>
< / ROW>
<ROW>
<Field>Nonce</Field>
<Purpose>32-bit number (starts at 0) </Purpose>
<Updated_when_]>A hash is tried (increments) </Updated_when _? >
<FIELD4></FIELD4>
<Size>4</Size>
<Example>67953845</Example>
</ ROW>
<ROW>
<Field></Field>
<Purpose></Purpose>
<Updated_when_></Updated_when _? >
<FIELD4></FIELD4>
<Size></Size>
<Example></Example>
< / ROW>
</ROWSET>

The foregoing exemplary XML datastructure can be represented by the following table of its field names, field types, field sizes and field data:

| Field | Purpose | Updated when . . . | Type | Size | Example |
|---|---|---|---|---|---|
| Version | Block version number | When software | Integer | 4 | |
| | | upgraded | | | |
| Stock | 256-bit hash of the | Stock Symbol; | Char | 32 | GOOG.; NASDAQ: |
| Code | previous block header | Exchange; | | | 0.00023 |
| | | Amount | | | |
| | | (% share) | | | |
| Op_Return | 256-bit hash based on | A transaction is | Double | 32 | 0x444f4350524f4f46 |
| | all of the transactions | accepted | Int | | |
| | in the block | | | | |
| | (aka checksum) | | | | |
| Time | Current timestamp as | Every few | Int | 4 | 1444655572 |
| | seconds since 1970- | seconds | | | |
| | 01-01T00:00 UTC | | | | |
| Bits | Current target in | The difficulty is | | 4 | |
| | compact format | adjusted | | | |
| Nonce | 32-bit number | A hash is tried | | 4 | |
| | (starts at 0) | (increments) | | | |

Another useful datastructure for accomplishing transactions as described herein can be represented by the following exemplary table of field names, field types, field sizes and field data (the corresponding XML datastructure of which is similar to those examples provided in the foregoing):

| | | Updated | | | |
|---|---|---|---|---|---|
| Field | Purpose | when . . . | Type | Size | Example |
| Sender | Block version | MAC | 128 bit | 16 | 2001:0D88:AC10:FD01:0000: |
| Wireless ID | number | address IP | | | 0000:0000:0000 (Hex) |
| | | v6 | | | |
| Receiver | Block version | MAC | 128 bit | 16 | 2001:0D88:AC10:FD01:0000: |
| Wireless ID | number | address IP | | | 0000:0000:0000 (Hex) |
| | | v6 | | | |
| SenderID | 256-bit hash of | A new | Double | 10 | a7ffc6f8bf1ed76651c14756a061 |
| | the previous | block | | | d662f580ff4de43b49fa82d80a4b |
| | block header | comes in | | | 80f8434a |
| Receiver | 256-bit hash | A | Double | 10 | b7efc6f7bf1ed76441c146568f61 |
| Public Key | based on all of | transaction | | | d662f580ff4de43b49fa82d80a4b |
| | the transactions | is accepted | | | 80f3245c |
| | in the block (aka | | | | |
| | checksum) | | | | |
| hashMerkle | 256-bit hash | A | Double | 16 | $20 |
| Root | based on all of | transaction | | | |
| | the transactions | is accepted | | | |
| | in the block (aka | | | | |
| | checksum) | | | | |
| Time | Current | Every few | Int | 4 | 1444655572 |
| | timestamp as | seconds | | | |
| | seconds since | | | | |
| | 1970-01-01T00:00 UTC | | | | |
| Bits | Current target | The | Int | 4 | 8 |
| | in compact | difficulty is | | | |
| | format | adjusted | | | |
| Nonce | 32-bit number | A hash is | Int | 4 | 25 |
| | (starts at 0) | tried | | | |
| | | (increments) | | | |

Another useful datastructure for accomplishing transactions as described herein can be represented by the following exemplary table of field names, field types, field sizes and field data (the corresponding XML datastructure of which is similar to those examples provided in the foregoing):

| | | Updated | | | |
|---|---|---|---|---|---|
| Field | Purpose | when . . . | Type | Size | Example |
| Sender | Block version | MAC | 128 | 16 | 2001:0D88:AC10:FD01:0000: |
| Wireless | number | address IP | bit | | 0000:0000:0000 (Hex) |
| ID | | v6 | | | |
| Receiver | Block version | MAC | 128 | 16 | 2001:0D88:AC10:FD01:0000: |
| Wireless | number | address IP | bit | | 0000:0000:0000 (Hex) |
| ID | | v6 | | | |
| SenderID | 256-bit hash of the | A new block | Double | 18 | a7ffc6f8bf1ed76651c14756a |
| | previous block | comes in | | | 061d662f580ff4de43b49fa82 |
| | header | | | | d80a4b80f8434a |
| Receiver | 256-bit hash based | A | Double | 18 | b7efc6f7bf1ed76441c146568 |
| Public Key | on all of the | transaction | | | f61d662f580ff4de43b49fa82 |
| | transactions in the | is accepted | | | d80a4b80f3245c |
| | block (aka | | | | |
| | checksum) | | | | |
| hashMerkl | 256-bit hash based | A | Double | 16 | $2,346 |
| eRoot | on all of the | transaction | | | |
| | transactions in the | is accepted | | | |
| | block (aka | | | | |
| | checksum) | | | | |
| Time | | | Int | 4 | 1444655572 |
| | Current timestamp | Every few | | | |
| | as seconds since | seconds | | | |
| | 1970-01-01T00:00 | | | | |
| | UTC | | | | |
| Bits | Current target in | The | Int | 4 | |
| | compact format | difficulty is | | | |
| | | adjusted | | | |
| Nonce | 32-bit number | A hash is | Int | 4 | 25 |
| | (starts at 0) | tried | | | |
| | | (increments) | | | |

Another useful datastructure for accomplishing transactions as described herein can be represented by the following exemplary table of field names, field types, field sizes and field data (the corresponding XML datastructure of which is similar to those examples provided in the foregoing):

| | | Updated | | | |
|---|---|---|---|---|---|
| Field | Purpose | when . . . | Type | Size | Example |
| Version | Block version | When | Integer | 4 | |
| | number | software | | | |
| | | upgraded | | | |
| hashNewAddr | 256-bit hash f New | A new block | | 32 | a7ffc6f8bf1ed76651c14 |
| | Address | comes in | | | 756a061d662f580ff4de |
| | | | | | 43b49fa82d80a4b80f84 |
| | | | | | 34a |
| RandomNumH | 256-bit hash based | A transaction | | 32 | b7efc6f7bf1ed76441c1 |
| ead | on all of the | is accepted | | | 46568f61d662f580ff4d |
| | transactions in the | | | | e43b49fa82d80a4b80f3 |
| | block (aka | | | | 245c |
| | checksum) | | | | |
| Time | Current timestamp | Every few | Int | 4 | 1444655572 |
| | as seconds since | seconds | | | |
| | 1970-01-01T00:00 | | | | |
| | UTC | | | | |
| Bits | Current target in | The difficulty | | 4 | |
| | compact format | is adjusted | | | |
| Nonce | 32-bit number | A hash is tried | | 4 | |
| | (starts at 0) | (increments) | | | |

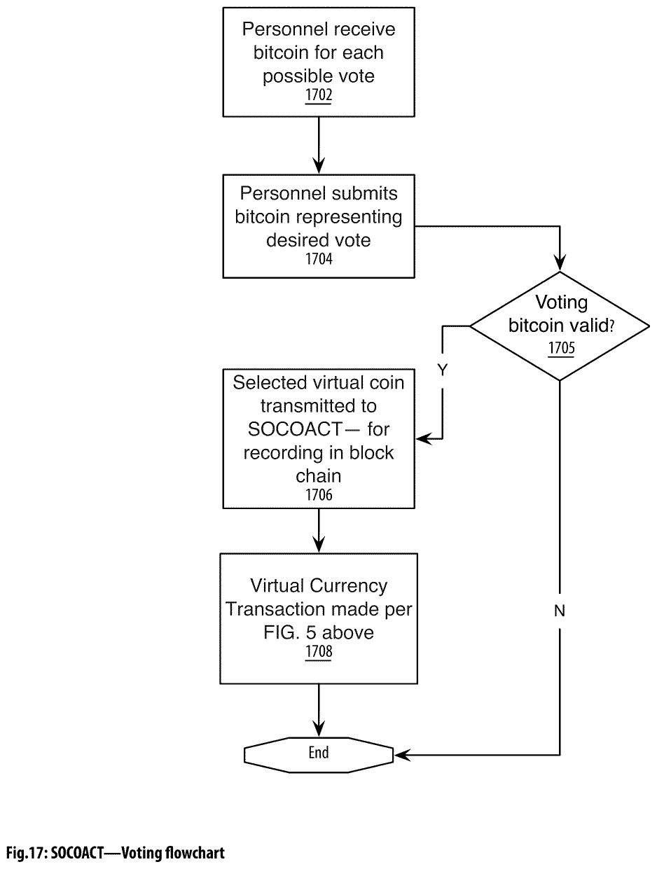

FIG. 17 shows a flowchart of a voting process for the SOCOACT. At a commencement of this process, appropriate personnel may receive a virtual coin representing each possible vote (step 1702). Each virtual coin may contain a hash of the person's SOCOACT identifier and the desired vote. The virtual coin would have no real or virtual currency associated with it. Each person submits a single virtual coin representing his or her desired vote (step 1704). At step 1705, the SOCOACT determines whether the submitted voting Bitcoin is valid, for example, by comparing hashed or dehashed values against known, stored values that guarantee authenticity, as described elsewhere herein. If the voting Bitcoin is not valid, the process ends. Otherwise, the selected bit coin is transmitted to the SOCOACT for recording in the block chain established for the vote (step 1706). This coin-enabled transaction may then be made in a similar manner as virtual currency transaction as described with respect to FIG. 5 above (step 1708). In various embodiments, the unused voting coins may be invalidated by the SOCOACT upon the submission and validation of one of the virtual coins represented by the desired vote.

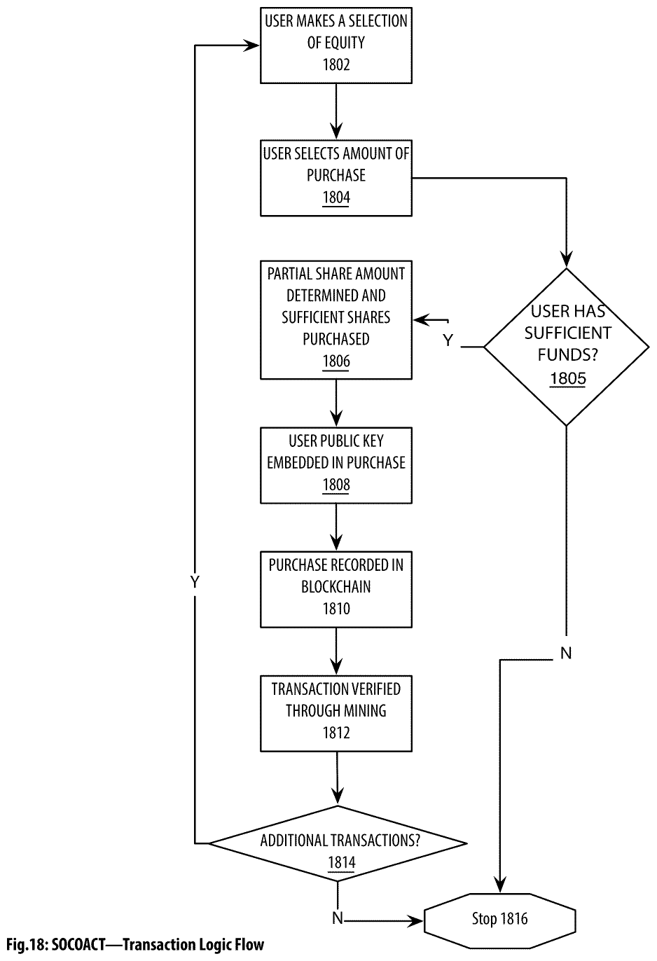

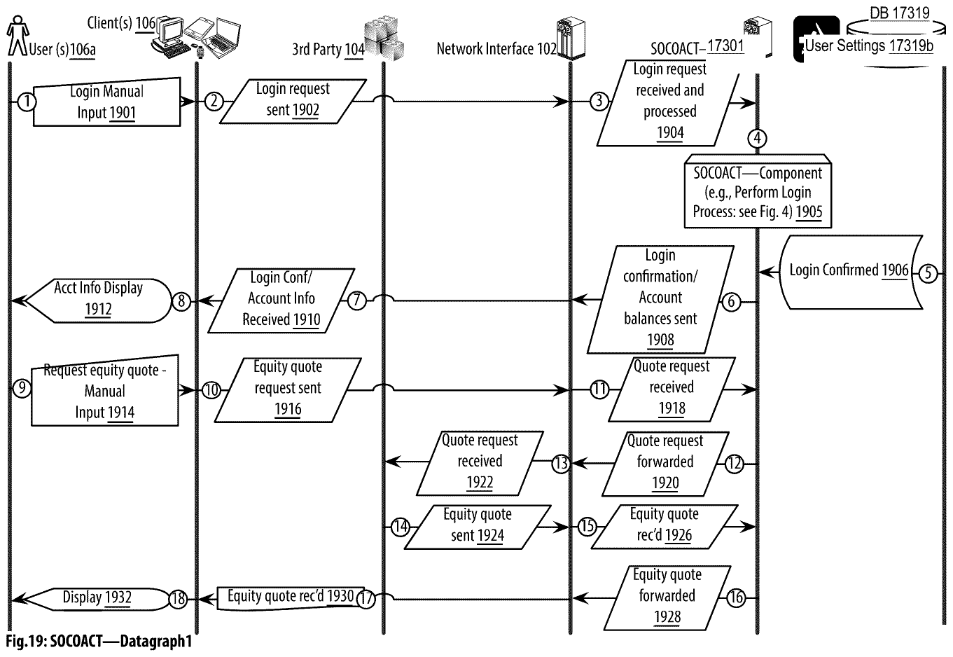

Referring to FIG. 18, therein is depicted a logic flow diagram illustrating an overview of a fractional ownership equity purchase process performed via the SOCOACT. At the commencement of this process, a user or client make a selection of an equity to be purchased (step 1802). The user selects an amount of share or monetary value of the equity to be purchased (step 1804). Next, at step 1805, the SOCOACT system determines whether the user has sufficient funds in the identified source to undertake the purchase transaction. If not, the process ends. Otherwise, the user may be presented with multiple options, such as to buy, sell, option, or trade with respect to the selected equity. Based on the user selections, a partial share amount for the transaction is determined. For example, a request to purchase 0.018559 shares of GOOGLE stock may be recorded in the blockchain as, e.g., “BUY 0.018559 GOOG” and sufficient shares are purchased by the SOCOACT to cover the order along with the orders of any other fractional share owners (step 1806). The user's public key is embedded in the block recording the fractional ownership purchase (step 1808). For example, the public key may be recorded in the blockchain as, e.g., 3J98t1WpEZ73CNmQviecrnyiWrnqRhWNLy. Next, at step 1810, the purchase is recorded in a blockchain maintained by the SOCOACT. The transaction may be thereafter verified through mining of the blockchain (step 1812). Finally, at step 1814, the user is asked whether there are any other fractional ownership transactions to be processed. If so, the process returns to step 1802 above. Otherwise, this instance of the process ends (step 1816).

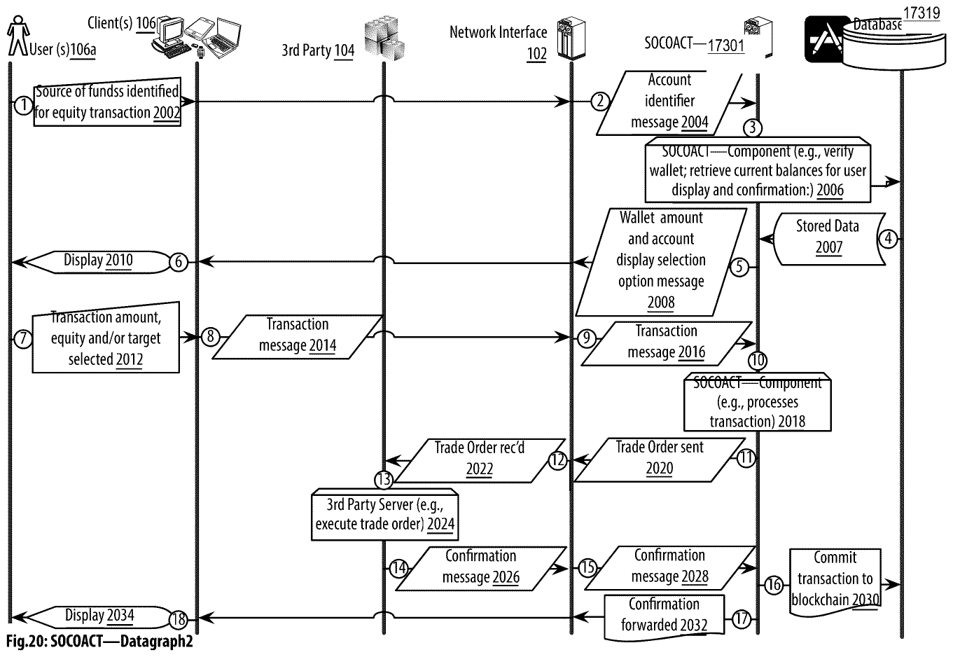

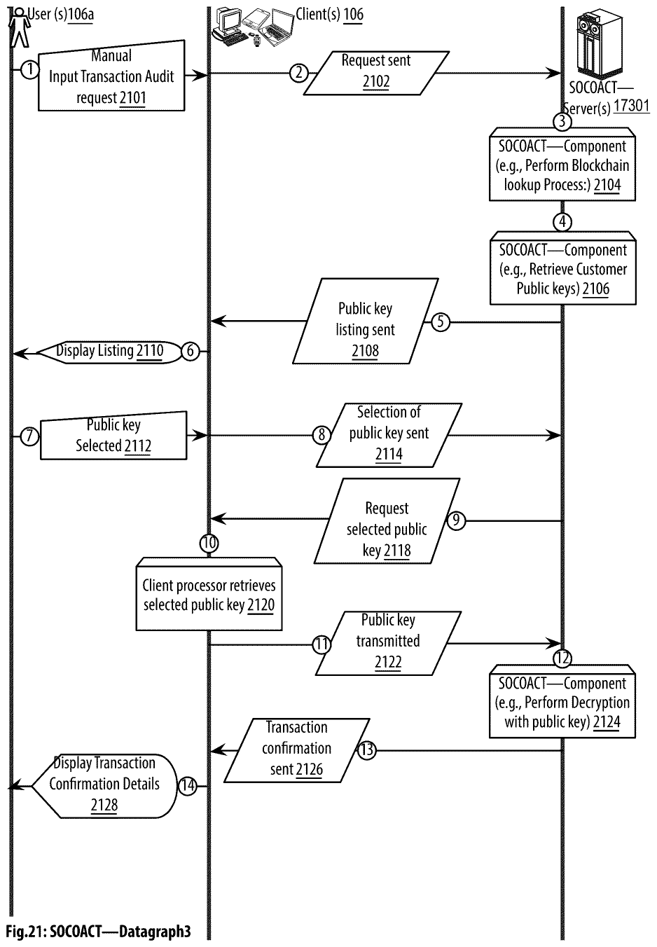

The foregoing steps 1802-1810 are described in more detail below with respect to FIGS. 19-20. The foregoing step 1812 is described in more detail below with respect to FIG. 21.

Turning to FIG. 19, therein is depicted a datagraph diagram illustrating embodiments of an equity research process for the SOCOACT. This process commences at step 1901 where a client or user 106a using a client terminal 106 accesses the SOCOACT 17301 via the data communications network 100 in order to login. A login request is sent from the client terminal 106 to the SOCOACT 17301 via the data communication network 100 (step 1902). The datastructure of the login request may be of the general same form as previously presented above. The login request is then received and processed by the SOCOACT (step 1904). The SOCOACT then performs a login process, such as that depicted in FIG. 4 above (step 1905), after which the login is confirmed (step 1906).

Upon login confirmation, the SOCOACT retrieves the user's current account balances from, for example, Accounts database 17319a and forwards the account information to the client terminal 106 via the data communication network (step 1908). The querying of the database may include a datastructure in the same general form as discussed in the foregoing for other database retrieval requests. The login confirmation and account information is received by client terminal 106 (step 1910) and displayed to the client 106a on a display device of the client terminal 106 (step 1912).

Next, at step 1914, the client 106a using client terminal 106 may request a quote for the current price of an equity. The datastructure of this request is of the same general form as described above for other database queries. The equity quote request is sent to the SOCOACT by client terminal 106 via the data communications network 100 (step 1916). The quote request is received by the SOCOACT 17301 via network interface servers 102 (step 1918). The SOCOACT then forwarded the quote request to third-party trade execution servers 104 to obtain the current market price for the requested equity (step 1920). The trade execution servers 104 receive the quote request and determines the current price from available market data (step 1922). The equity quote is then sent from trade execution servers 104 to the SOCOACT 17301 via network interface server 102 over the data communication network (step 1924). The SOCOACT 17301 receives and stores the equity quote, for example in Market Feed database 17319z (step 1926). The SOCOACT then forwards the equity quote to the client terminal 106 via the data communications network (step 1928). The equity quote is then received by the client terminal 106 (step 1930) and displayed to the client 106a on a display device thereof (step 1932).

FIG. 20 shows a datagraph diagram illustrating embodiments of a fractional ownership equity transaction process for the SOCOACT. This process continues from the process of FIG. 19 and commences when a client 106a using client terminal 106 identifies a source of funds to be used to purchase a fractional share of an equity (step 2002). The source of funds may include a wallet address as described previously above, when the transaction involves payment via a virtual currency. The source of funds may include an identification of a financial account, such as a bank account or an investment account, when the purchase is to be made by real currency, i.e., dollars. The account identified by the client 106a is sent in an account identification message by the client terminal 106 to the SOCOACT 17301 via the data communications network 100 (step 2004). The SOCOACT 17301 then verifies the amount of funds in the wallet or current account balances available for an fractional equity purchase. (step 2006) by retrieve stored wallet/account data for example from Account database 17319a (step 2007). The retrieved wallet or account data is sent to the client terminal 106 via the network interface servers 102 and the data communications network 100 (step 2008). The wallet/account data is then displayed to the client 106a on a display device of the terminal 106 (step 2010).

Next, at step 2012, the client enters a selection of a transaction or equity purchase amount relating to a target equity to be purchased as part of trade execution request. The trade execution message is sent by the client terminal 106 (step 2014) and then received by the SOCOACT 17301 via the data communication network 100 and the network interface servers 102 (step 2016). The Order Generation Component 17345A of the SOCOACT 17301 then processes the transaction, which may include withdrawing funds from the client's account or virtual wallet prior to execution of the trade order (step 2018). Upon successful processing, the Order Placement Component 17346A of the SOCOACT 17301 sends the trade order to the third party trade execution servers 104 (step 2020). The trade order is received and verified by the servers 104 (step 2022), after which the servers 104 execute the trade order, for example, by placing a corresponding buy/sell order on a market exchange (step 2024). Upon successful execution of the trade order, the trade execution servers 104 transmit a trade confirmation message to the SOCOACT (step 2026). Once the confirmation message is received (step 2028), the Blockchain component 17343A of the SOCOACT 17301 commits the transaction to the blockchain (see, e.g., the process of FIG. 6) (step 2030). The trade order confirmation is then forwarded to the client terminal 106 (step 2032), where it is displayed to the client 106a on a display device thereof (step 2034). This instance of the process may then terminate.

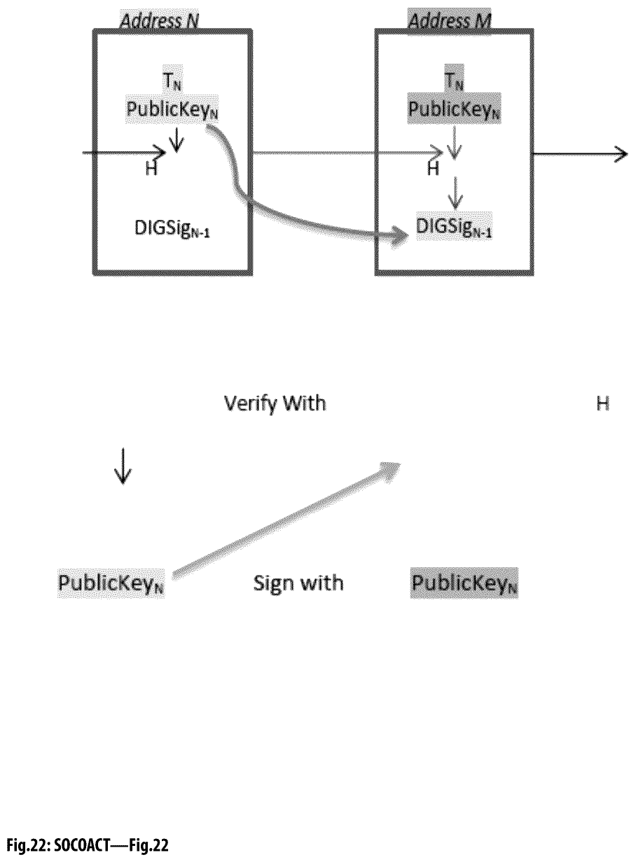

The exchange and ownership of partial shares is certified via embedding its SHA256 digest in the Bitcoin-like blockchain maintained by the SOCOACT. This is done by generating a special bitcoin-like transaction that contains and encodes a hash value of the transaction data within an OP_RETURN script stored in the block generated by the SOCOACT (see FIGS. 22-25). The OP_RETURN is a scripting opcode that marks the transaction output as provably unspendable and allows a small amount of data to be inserted (for example, 80 bytes), which along with a transaction identification field or the like, becomes part of the block's hash.

Once the transaction is confirmed, the exchange/ownership is permanently certified and proven to exist at least as early as the time the transaction was entered in the blockchain. If the exchange/ownership of partial shares hadn't existed at the time the transaction entered the blockchain, it would have been impossible to embed its digest in the transaction. This is because of the hash function's property of being “second pre-image resistant.” Embedding some hash and then adapting a future document to match the hash is also impossible due to the inherent pre-image resistance of hash functions. This is why once the SOCOACT blockchain confirms the transaction generated for the block, its existence is proven, permanently, with no trust required.

FIG. 21 shows a datagraph diagram illustrating embodiments of an equity ownership audit process for the SOCOACT, by which a blockchain may be searched to prove ownership of one or more fractional shares by any number of clients. This process commences at step 2101 where the client 106a enters an audit request into the client terminal 106. The client terminal forwards the audit request to the SOCOACT (step 2102). The SOCOACT's Blockchain component 17343A commences a blockchain lookup process (step 2104). The SOCOACT's Blockchain Component 17343A retrieves an identification of the client's available public keys (step 2106). The SOCOACT then transmits the public key listing to the client terminal 106 via the data communication network 100 (step 2108). The public key listing is then displayed on the client terminal 106 (step 2110).

Next, at step 2112, the client 106a selects one or more of his/her available public keys via inputs to the client terminal 106. The selection of the public key is transmitted by the client terminal 106 to the SOCOACT 17301 (step 2114). The SOCOACT in turn requests the selected public key from the client terminal 106 (step 2118). The client terminal retrieves the selected public key from its internal memory (step 2120) and forwards it to the SOCOACT (step 2122). The SOCOACT's Blockchain Component 17343A perform decryption of relevant block chain data with the client's selected public key (step 2124). Transaction confirmations corresponding to the public key are retrieved and sent to the client terminal 106 (step 2126), and are then displayed to a client 106a on a display device thereof (step 2128), after which this instance of an audit process ends.

When a client 106 wants to confirm the transaction's existence at the time-stamped time, the following steps are performed as part of the blockchain lookup:
(i) the transaction's SHA256 digest is calculated.
(ii) A transaction in the SOCOACT blockchain containing an OP_RETURN output by which the transaction's hash is searched for.
   Some online services like COIN SZECRETS or blockchain.info can easily be used to locate OP_RETURN transactions. The existence of a transaction in the blockchain proves that the document existed at the time the transaction got included into a block.

FIG. 22 shows a schematic representation of generating an ownership block for the blockchain maintained by the SOCOACT. SOCOACT's blockchain functionality is based upon elliptic curve cryptography, where addresses are derived from elliptic-curve public keys and transactions authenticated using digital signatures. Elliptic Curve Digital Signature Algorithm (ECDSA) is the cryptographic algorithm used by Bitcoin to ensure that funds are spent by rightful owners. The private key, a single unsigned 256 bit integer of 32 bytes, is essentially a randomly generated ‘secret’ number, which is known only to the person that generated it. The range of valid private keys is governed by the “secp256k1 ECDSA standard” used by Bitcoin. The public key corresponds to a private key, but does not need to be kept secret.

A public key can be computed from a private key, but it is technologically infeasible to compute the private key from a public key. A public key can thus be used to authenticate or confirm the validity of the digital signature. As shown in FIG. 22, a source address N transfers a payment to destination address M by digitally signing, using its private key, the mathematically generated hash H of prior transaction TN and public key of address M. Also, as shown, the digital signature of address N can be verified by using N's public key without knowing its private key. The SOCOACT block chain contains all such transactions ever executed, wherein each block contains the SHA-256 hash of the previous block.

The elliptic curve over a finite field Fp, with most popular choice being prime fields GF (p) where all arithmetic is performed modulo a prime p, is the set of all pairs (x, y) E Fp which fulfill E:

$${y}^{2} = {x}^{3} + a . x . + b mod p$$

together with an imaginary point of infinity O, where p>3 is prime, and a, bεFp. The cryptographic signatures used in SOCOACT's blockchain are ECDSA signatures and use the curve ‘secp256k1’ defined over Fp where p=2256-232-977, which has a 256-bit prime order. This choice deviates from National Institute of Standards and Technology (NIST) recommended “FIPS 186-4” standard in that the curve coefficients are different in order to speed up scalar multiplication and computations of Pollard's rho algorithm for discrete logarithms.

Given ECDSA public-key K, a Bitcoin address is generated using the cryptographic hash functions SHA-256 and RIPEMD-160:

$$HASH 160 = RIPEMD - 160 ( SHA - 256 ( K ) ) .$$

A SOCOACT address is computed directly from the HASH160 value as illustrated below, where base58 is a binary-to-text encoding scheme:

$$base 58 ( 0 \times 00 HASH 160 [ SHA - 256 ( 256 ( SHA - 256 ( 0 \times 00 HASH 160 ) ) / {2}^{224} ] )$$

However, ECDSA signatures may be susceptible to the following potential encryption related vulnerabilities and threats: (i) insufficient or poor randomness when the same public key is used for multiple transactions or the same key pair is used to protect different servers owned by the same entity; (ii) an invalid-curve attack in which an attacker obtains multiples with secret scalars of a point on the quadratic twist, e.g. via fault injection if the point doesn't satisfy the correct curve equation (iii) implementation issues such as side-channel attacks, software bugs, design or implementation flaws; (iv) hardness assumptions about number theoretic problems such as integer factorization and discrete logarithms computation in finite fields or in groups of points on an elliptic curve not applying as assumed in specific contexts. Recent recommendations by RSA SECURITY LLC, about withholding use of Dual Elliptic Curve Deterministic Random Bit Generation (or Dual EC DRBG) and the influence of DRBG compromise on consuming applications, such as DSA, also deserve attention.

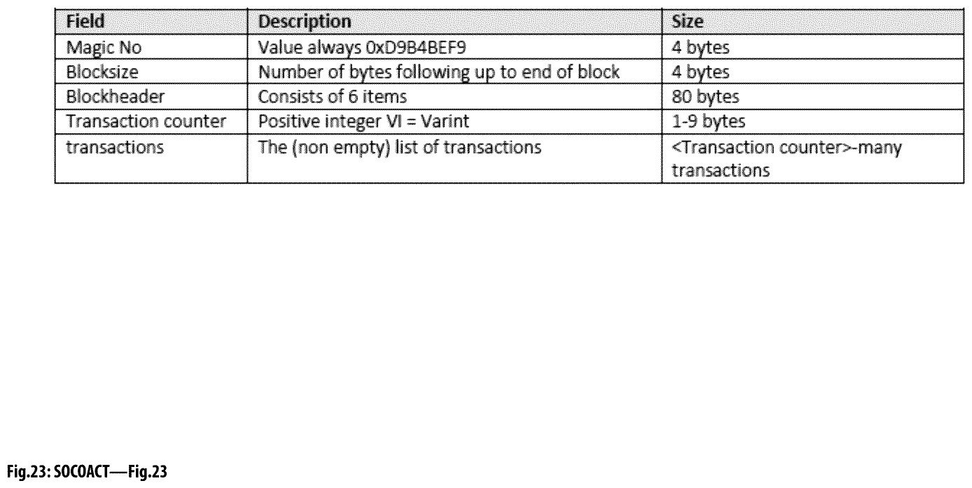

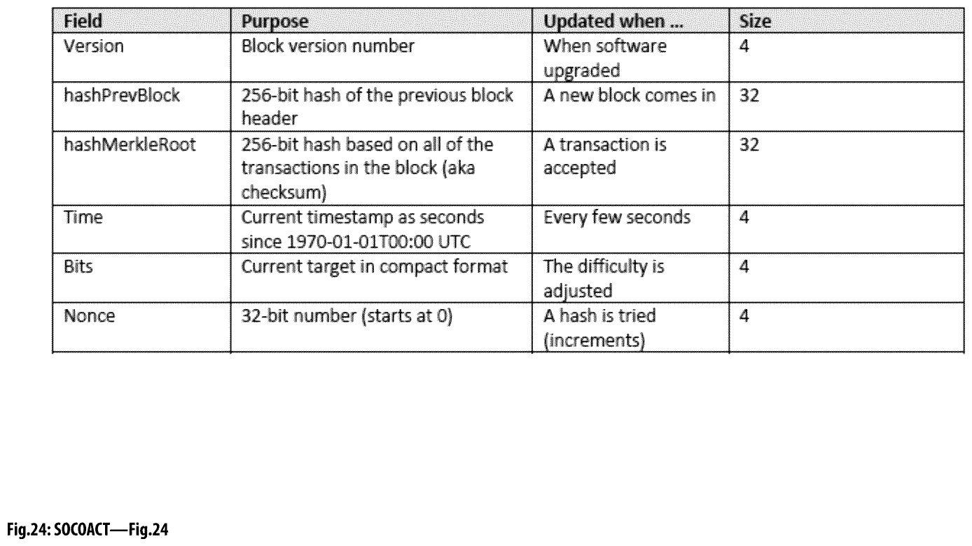

A transaction is a signed section of data broadcast to the network and collected into blocks. It typically references prior transaction(s) and assigns a specific transaction value from it to one or more recipient addresses. Transactions are recorded in the network in form of files called blocks. Structures of the block and its corresponding blockheader are shown in FIGS. 23 and 24, respectively.

FIG. 23 shows a schematic representation of the data structure of an equity ownership transaction block in the blockchain maintained by the SOCOACT.

The block may contain the following fields as shown: a “Magic No.” field that typically stores a constant and may be limited to 4 bytes in size, a “Block Size” field that typically stores the size in bytes of the current block as a 4 byte value, a “Blockheader” field that is described in more detail below with respect to FIG. 24, a “transaction counter” field that lists the number of transactions stored in the present block and may be limited in size to 1-9 bytes, and a transactions fields that may contain the OP_RETURN code values described previously above.

FIG. 24 shows a schematic representation of the data structure of the blockheader field of the ownership transaction block in the blockchain maintained by the SOCOACT. The blockheader field may contains the following sub-fields: a version field containing a block version number that may be four bytes, a “hashPrevBlock” field containing a 256-bit hash of the previous block in the blockchain, a “hashMerkelRoot” field containing a 256-bit hash based on a checksum of all of the transactions within a block, a “time” field containing the timestamp of the transaction, a “bits” field and a “nonce” field, containing the current target and a 32-bit number, respectively.

A block contains the most recent transactions sent to the network that have not yet been recorded in prior blocks. Each block includes in its blockheader, a record of some or all recent transactions and a reference to the prior block. It also contains the ‘answer’ to a difficult-to-solve mathematical problem related to the verification of transactions for the block. This problem relates to finding factors of a very large integer, which is computationally difficult to solve but thereafter easy to verify by other nodes once factors are found.

The chain of ownership is created by using a timestamp server that creates and widely publishes a hash of a block of items to be time-stamped, with each timestamp including previous timestamps in its hash value. To prevent double-spending, i.e., ensuring that the BTC payer didn't sign an earlier transaction for same BTC or already spent the BTC, a timestamp server is used to maintain a single chronological history in which each transaction was received. This process ensures that at the time of the transaction, the payee knows that majority of nodes agree to having received the current transaction as the first received. Subsequent transactions for the same BTC don't need to be recorded as they are rejected in the verification process.

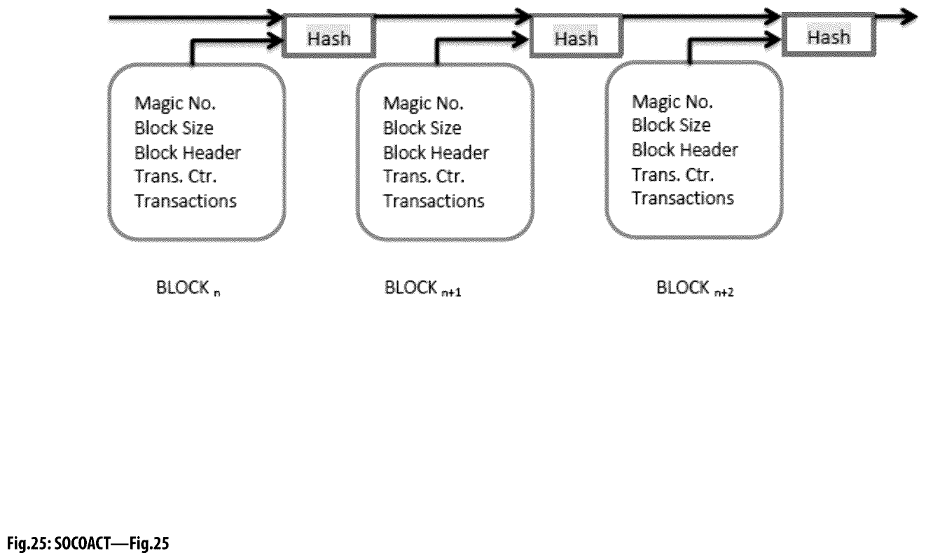

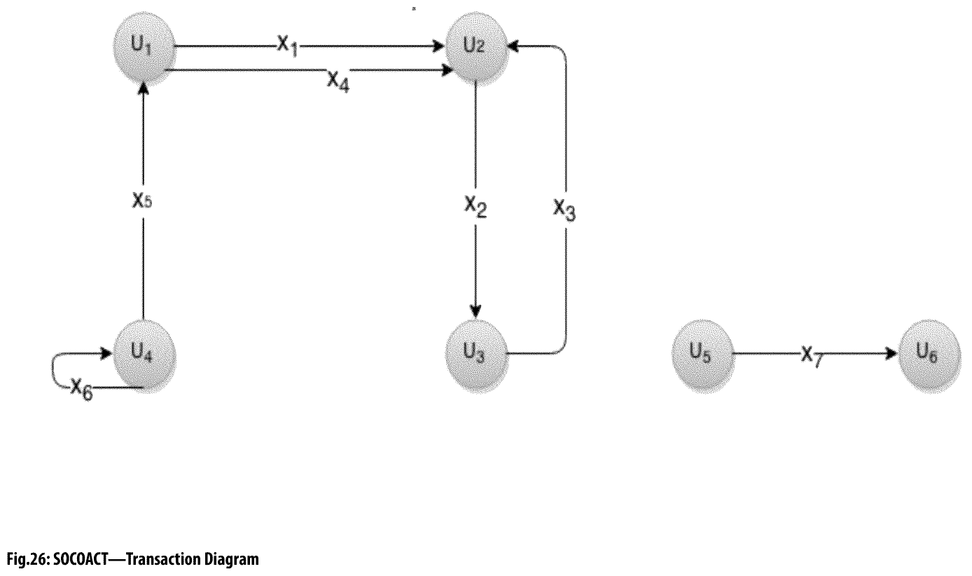

FIG. 25 shows a schematic representation of the creation of a blockchain from individual blocks as maybe performed by the SOCOACT. As the only way to confirm absence of a transaction is to maintain a record of all transactions, as seen in FIG. 25, each timestamp includes the previous timestamp in its hash starting from first transaction.

The block chain makes double spending very difficult as each block is preceded by prior block in chronological order as well as is based upon its hash value. To prevent double-spending, i.e., spending of the same BTC twice, public keys and signatures are published as part of publicly available and auditable block chain. To make it infeasible to falsify the block-chain, proof of work (PoW) is used to make addition of each block very costly.

The SOCOACT system provides the following benefits. It gives users a publicly verifiable proof of purchase with transparency. The SOCOACT system provides a cost effective mechanism for partial or fractional share purchase, and opens the door to usage of blockchain technology beyond the initial Bitcoin realm.

The number of current world-wide Bitcoin transactions is enormous. Currently, there are about one hundred thousand transactions per minute. If a Bitcoin address receives money today and transfers money out three months later, there can be on the order of ten billion transactions that happen in between. Accordingly, tracing of Bitcoin-like virtual currency transactions present extreme computational difficulties, making large-scale monitoring of such transactions virtually impossible. Additionally, while BTC users may be identified by their public keys to the Blockchain and all transactions are identified by their source and/or destination addresses, not all public keys and addresses may be published and identifiable to a particular party.

The SOCOACT introduced herein includes data structures to simplify transaction recording in the BlockChain, thereby reducing transaction tracing operations to practical computation sizes and making large-scale auditing of billions of transaction easily achievable in a reasonable amount of computing time.

However, in addition to BlockChain storage, which involves encryption, decryption and other computationally-intensive computing operations, the SOCOACT may additionally or alternatively include use of graph theory, matrix theory and Bloom filtering to create a record of transactions that are reduced in size as compared to the blockchain recording described above. Accordingly, such record allows for quicker verification and auditing of BTC transactions.

Bitcoin and other digital/virtual currency transactions can have different genres regarding the money movement and the user relations. FIG. 26 is a schematic representation of possible transactions between multiple parties that may be performed by the SOCOACT, where User 1 through User 6 are represented with the notation U1, U2, U3, U4, U5, U6, respectively. An example of a first genre In/Out Transaction is provided in FIG. 26 where it is shown that U1 transfers X1 amount of currency to U2. Namely, U1 has money flowing out in the transaction, and U2 has money flowing in in the transaction
A second genre, Circular Transactions, is likewise shown where U2 transfers X2 amount to U3 and later U3 transfer X3 amount to U2.
A third genre, multiple transactions with the same origin and target, is likewise shown where U1 transfers X1 amount to U2 and separately, U1 transfers X4 amount to U2 at some other time.
A fourth genre, a Self-Transaction, arises because of the nature of the Bitcoin and like virtual currency transactions. Suppose U4 wants to transfer X5 amount of money to U1, but U4 owns more than X5 in balance in his/her wallet. The transaction automatically be split in two, as described previously, with X5 going to U1, and the remaining balance X6 amount transferred to U4 by the SOCOACT.

A fifth and final genre of transactions are those occurring among disconnected user groups. As represented in FIG. 26, U5 transfers X7 amount to U6, and both of them do not have transactional relations with any other users in the entire system.

Note that the types of transactions illustrated above can be separated by millions of other transactions and millions of other users in like manner. The specially-programmed SOCOACT system will be able to process a vast plurality of such transactions at a time, with scalability to match the amount of users of the system.

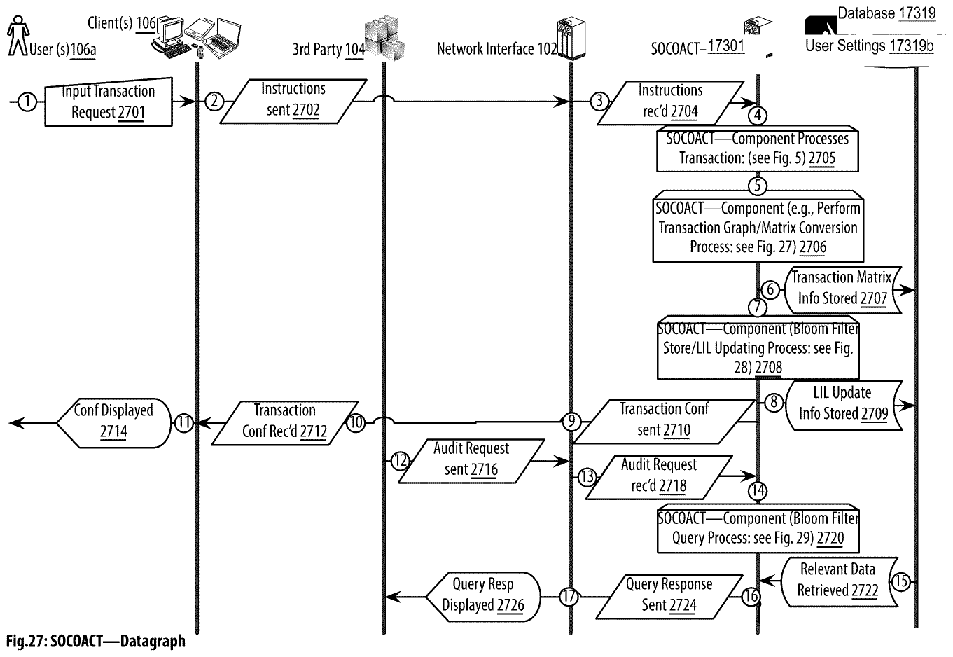

FIG. 27 shows a datagraph of a general matrix determination and tuple storage process 2700 as may be performed by the SOCOACT in various embodiments to store transaction data such that it may be audited with greater computational efficiency. Such process commences when a user 106 enters a transaction request via client 106a (step 2701). The request is sent over a data communications network (step 2702) to a Network Interface 102, where it is forwarded to the SOCOACT system 17301 (step 2704). The VC Transaction Component 17342A of the SOCOACT system 17301 processes the transaction, for example, as described with respect to FIG. 5 above (step 2705).

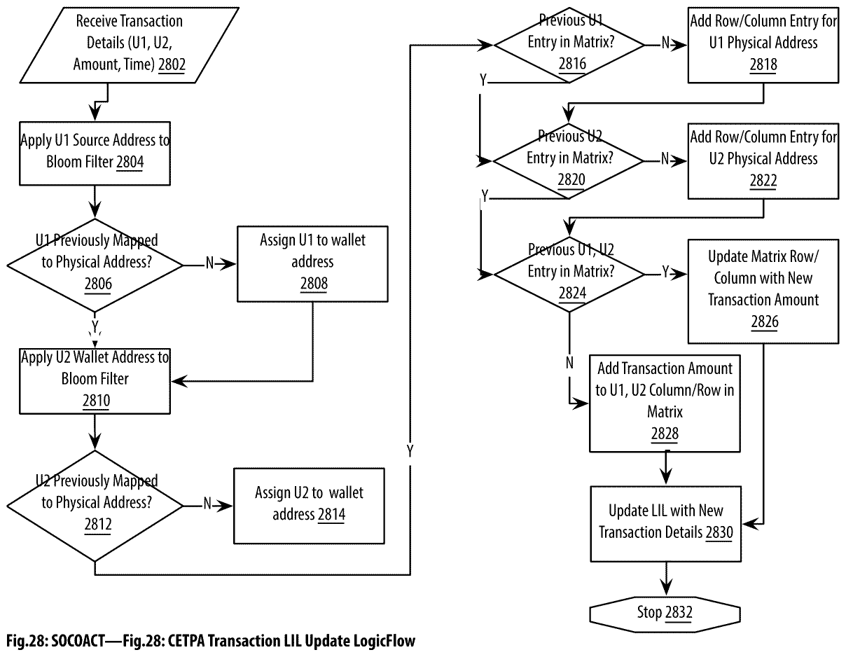

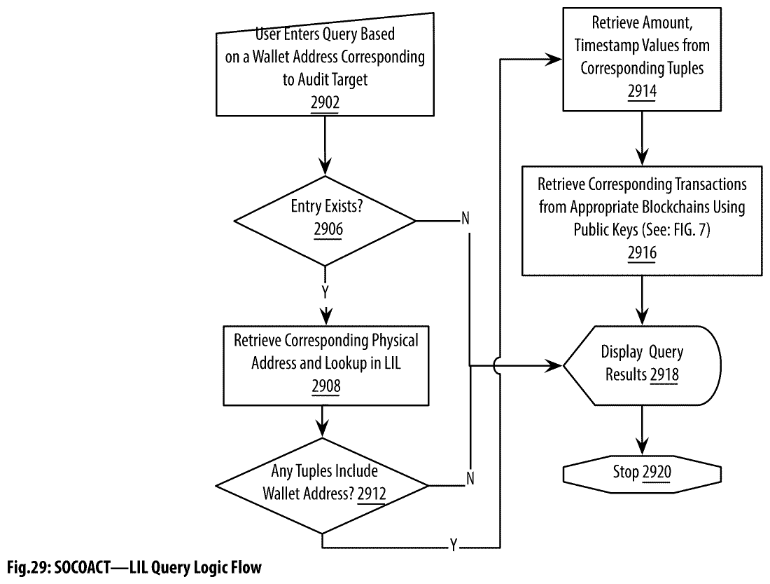

Next, the Matrix Conversion Component 17347A of the SOCOACT system 17301 performs graph/matrix conversion of the transaction request (step 2706), as described in detail with respect to FIG. 28 below. The matrix information including the new transaction is stored, for example, in Matrix/LIL database 17319r of the SOCOACT system 17301 (step 2707).

Next, the Bloom Filter component 17348A of the SOCOACT system 17301 performs a physical address storage and LIL Update Process (step 2708), as described in more detail with respect to FIG. 29 below. The resulting physical addresses maybe stored in the Physical address database 17319q of the SOCOACT system 17301. The updates to the LIL representing all transactions in a matrix may be stored in Matrix/LIL database 17319r of the SOCOACT system 17301 (step 2709).

Upon completion of a transaction, the SOCOACT system sends a transaction confirmation (step 2710) via the data communications network, which is received by the client 106a (step 2712) and displayed to the user (step 2714).

Thereafter, a third party may request to audit transaction (step 2716). Such a request may come from a financial institution, a government agency, another user or the like, who wishes to audit transactions from the blockchain. Since the encrypted blockchain contents can be computationally intensive to search through directly, especially as the transaction approach magnitudes of millions or billions of transactions in size, the SOCOACT system 17301 enables auditing of transactions using the LIL storage of transactions described in further detail below.

The audit request is received by the SOCOACT system 17301 from the data communications network (step 2718). Responsively, the Bloom Filter component 17348A of the SOCOACT system 17301 performs a Transaction Query process 2720, as described in more detail below with respect to FIG. 29. The query results are determined from the data stored in the Matrix/LIL database 17319r and ultimately retrieved from the blockchain database 17319k (step 2722). A query response, including any retrieved data, is then transmitted by the SOCOACT system 17301 to the third party server 104 from whence the request originated (step 2724). The query results may then be displayed to the third party (step 2726), after which the process 2700 ends.

FIG. 28 shows a flow chart of a general matrix determination and tuple list storage process 2800 as may be performed by the SOCOACT system 17301 in accordance with the foregoing process 2700. The process 2800 will be explained in terms of the processing of a single transaction. However, it should be appreciated that the SOCOACT system is contemplated to process billions of transaction over its lifetime, and to process many transactions simultaneously, in accordance with demand for the system by users.

The process 2800 commences when the SOCOACT system receives a transaction request having transaction information (step 2802). Typically, within the context of a digital currency transfer, such transaction information includes at least the following data: a source address (U1) as a source of the funds, a destination address (U2) that is the destination for the funds, the amount of currency to transfer, and the time or timestamp of the transaction. As described previously, the source and destination addresses are typically based on the public keys held within a digital currency wallet of the respective users. In particular, such addresses are, in various embodiments, a RIPEMD-160 hash of an SHA256 hash of a public key. The hash operations and the large number of resulting bits (at least 160 bits) pragmatically guarantees the uniqueness of each address. However, it can be computationally intensive to electronically query and compare a large number of such addresses in the SOCOACT system directly.

There are different ways to store graphs in a computer system. The data structure used depends on both the graph structure and the algorithm used for manipulating the graph. Given the description of the transactions in FIG. 26, we can convert the transactional relations into a graph, according to well-known graph theory. The various users are represented as “vertices” (U1, U2 . . . ), with money flowing out represented as an “edge,” or line, out of a vertex and money flowing in is an edge into a vertex. The transaction amount can be represented by the weight or length of an edge. All money movements through the SOCOACT can be represented as a weighted, directed, cyclic, non-connected graph. According to graph theory, a graph can be represented in an “adjacency matrix” and weighted graphs can be represented in a “distance matrix.” An adjacency matrix is a means of representing those vertices that are transactionally adjacent to other vertices. An adjacency matrix is a square matrix used to represent a finite graph. The elements of the matrix indicate whether pairs of vertices are adjacent or not in the graph. If vertex 1 is adjacent to vertex 2, then the value (row, column) in the matrix is 1 (or true), otherwise, 0 (or false).

The distance matrix resembles the adjacency matrix. However, it records not only whether or not two vertices are connected, but if so, then the distance is the weight between the row/columns representing those vertices, rather than entry of a unit value. In a distance matrix, position (i,j) represents the distance between vertices Ui and Uj. The distance is the weight of a path connecting the vertices. In the case of the SOCOACT, the distance entry will correspond to the amount of a transaction between party Ui and party Uj. The distance matrix is accordingly used to record the money flow, so transactions with the same origin and target are combined, with a transaction timestamp recorded with the transaction amount. Self-Transactions are NOT included in the distance matrix, because there is no amount transacted between two parties. Because of this, all values on the diagonals of a distance matrix stored by the SOCOACT will be zeros.

In addition to BlockChain storage, which involves encryption, decryption and other computationally-intensive computing operations, the SOCOACT may additionally or alternatively include use of graph theory, matrix theory and Bloom filtering to create a record of transactions that are reduced in size as compared to the blockchain recording described above. Accordingly, such record allows for quicker verification and auditing of BTC transactions.

Bitcoin and other digital/virtual currency transactions can have different genres regarding the money movement and the user relations. FIG. 26 is a schematic representation of possible transactions between multiple parties that may be performed by the SOCOACT, where User 1 through User 6 are represented with the notation U1, U2, U3, U4, U5, U6, respectively. An example of a first genre In/Out Transaction is provided in FIG. 26 where it is shown that U1 transfers X1 amount of currency to U2. Namely, U1 has money flowing out in the transaction, and U2 has money flowing in in the transaction
A second genre, Circular Transactions, is likewise shown where U2 transfers X2 amount to U3 and later U3 transfer X3 amount to U2.
A third genre, multiple transactions with the same origin and target, is likewise shown where U1 transfers X1 amount to U2 and separately, U1 transfers X4 amount to U2 at some other time.
A fourth genre, a Self-Transaction, arises because of the nature of the Bitcoin and like virtual currency transactions. Suppose U4 wants to transfer X5 amount of money to U1, but U4 owns more than X5 in balance in his/her wallet. The transaction automatically be split in two, as described previously, with X5 going to U1, and the remaining balance X6 amount transferred to U4 by the SOCOACT.
A fifth and final genre of transactions are those occurring among disconnected user groups. As represented in FIG. 26, U5 transfers X7 amount to U6, and both of them do not have transactional relations with any other users in the entire system.

Note that the types of transactions illustrated above can be separated by millions of other transactions and millions of other users in like manner. The specially-programmed SOCOACT system will be able to process a vast plurality of such transactions at a time, with scalability to match the amount of users of the system.

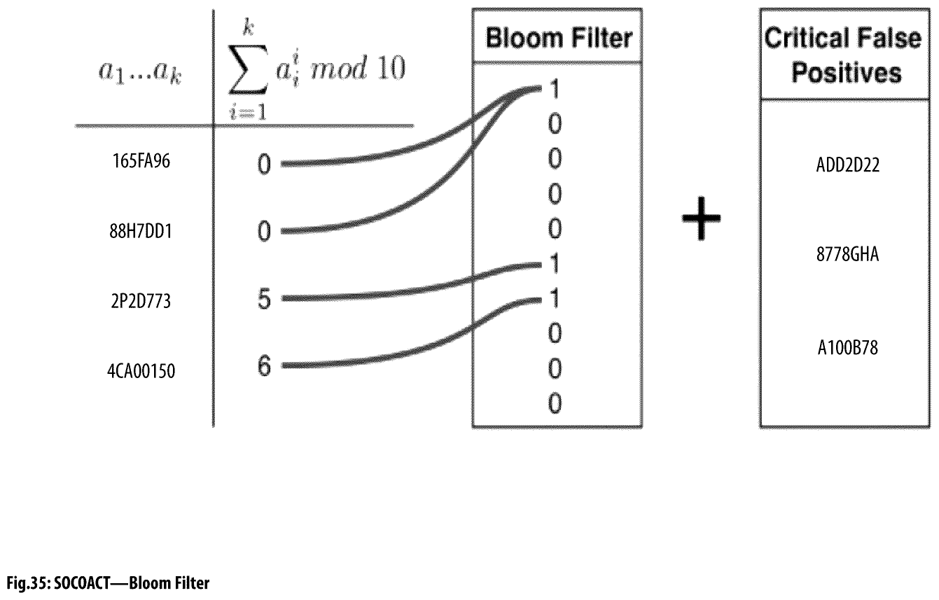

In order to perform such searches quickly, Bloom Filters are used to hash addresses for more computationally feasible storage look up, thus solving a problem that is unique to computerized cryptographic functions. A Bloom filter (see, e.g., FIG. 35) is a space-efficient probabilistic data structure that is used to test whether a data element is a member of a set that may be stored in a database. As is well-known in the art, a Bloom filter itself does not store retrievable data. Instead, the Bloom filter indicates whether a given element of data is stored within a given database. A Bloom filter also typically stores an indication of the location of the element within the database, by storing pointers that may be used to fetch queried data elements from a specific location in a database. Accordingly, the Bloom filter is not a storage data structure for data elements themselves, but instead store simple “yes” or “no” indicators for the existence of a element within a database at each of a plurality of established filter positions. All positions in the Bloom filter store “0” (or false) when the filter and corresponding database are empty, or for those positions that do not relate to currently stored elements. One or multiple positions in the Bloom filter stores a binary “1” (or true) when a element stored in the database is mapped to that position according to the functions of the Bloom filter, which will be described in detail later below. One element can turn one or multiple positions into true. False positive matches are possible, but false negatives are not, thus a Bloom filter has a 100% recall rate. In other words, a given query for an element returns one of two answers: either “possibly in set” or “definitely not in set.” Elements can be added to the set, but not removed. The more elements that are added to the set, the larger the probability of false positives. Bloom filters are typically appropriate for applications where the amount of source data would require an impractically large amount of memory if “conventional” error-free hashing techniques were applied, such as with large numbers of blockchain operations.

A Bloom filter needs only a constant number of bits per prospective element, independent from the size of the elements' universe. Both the insertion and look up time complexity are on the magnitude of O(1), according to “big O notation” in mathematics. This means that for increasing data storage, the computational requirements stay at a constant complexity level, rather than, say, increasing with the magnitude of the data storage size or exponentially or linearly, etc. As a result, where the total number of transaction is from, say, one to one billion, it may take only three to five hashing operations or false positive comparisons to add a transaction to a transaction matrix or query a transaction from a list of matrix tuples. Additionally, it is a mathematical property of blockchains that a hashed public key cannot be recovered from the generated wallet address by using a reverse hashing algorithm. Multiple hash functions may be used to improve computational performance by lowering the false positive rate, but this is not necessarily so. Useful hash functions include known or equivalent encryption hashing functions, such as Murmur Hash or SHA-1. When dealing with large datasets and stored data elements, the possibility that different elements have the same hash value is expected to be extremely rare. Handling mechanisms have many options too, such as performing multiple additional hashes, storing known false positives for stored data elements, and padding data elements with extra binary 0's prior to storage. The Bloom Filter functions will be described in more detail with respect to FIG. 35 below.

Returning to the process 2800, the SOCOACT system applies a Bloom Filter to the source address (U1) (step 2804) and then determines whether U1 has been previously mapped to a physical address resulting from the application of the Bloom Filter (step 2806). This may be determined by look up within the Physical Address database 17319q. If U1 has not previously been assigned a physical address (i.e., when U1 has never before engaged in a transaction), U1 is assigned to the physical address that may result from application of the Bloom Filter (step 2808), which assigned address is then recorded in the database 17319q in conjunction with U1's cryptocurrency wallet address that is generated from public key.

If on the other hand, U1 has been previously assigned a physical address, the process 2800 continues to apply the Bloom Filter to destination address U2 (step 2810). The SOCOACT then determines whether U2 has been previously mapped to a physical address resulting from the application of the Bloom Filter (step 2812). This may be determined by Bloom Filter look-up. If the Bloom Filter look-up does not yield U2, the Bloom Filter look-upresult is false, and accordingly no database look up is necessary. If U2 has not previously been assigned a wallet address (i.e., when U2 has never before engaged in a transaction using the SOCOACT system), U2 is assigned to the wallet address that may result from application of the Bloom Filter (step 2814), which assigned address is then recorded in the database 17319q.

Next, the SOCOACT determines whether U1 entries exist in the column and row entries of a transaction matrix that is used to monitor all transactions occurring via the SOCOACT (step 2816). If no prior transactions have involved U1 then there will be no existing row, column entry in the transaction matrix, and in such case the SOCOACT will add a Row/Column Entry based on U1's wallet address (step 2818).

If, on the other hand, U1 entries already exist in the matrix, the process 2800 next determines whether U2 row/column entries exist in the transaction matrix (step 2820). If U2 entries do not exist, the SOCOACT adds a U2 row/column entry to the transaction distance matrix based on U2's wallet address (step 2822). From step 2820 or 2822 above, the process 2800 then continues to step 2824.

Next, at step 2824, the SOCOACT determines whether a previous transaction involving both U1 and U2 exist. If no such prior transaction exists, the SOCOACT will simply add the transaction amount to the U1, U2 row/column in the transaction matrix (step 2828). On the other hand, if prior entries exist in the (row, column) entry corresponding to (U1, U2) in the transaction matrix, the SOCOACT system will instead update the total transaction amount to include the new transaction amount (step 2826). In various embodiments, the total transaction amount will be the amount of all recorded transactions between U1 and U2. IN additional embodiments, the amount of each individual transaction between U1 and U2, along with the timestamp of each transaction is stored within the value stored in the transaction matrix.

The distance matrix is used to record the transactions that happen between every pair of users that have ever involved in any transactions. However, especially with a huge base of users, there will be a high percentage of the row/column entries in the distance matrix where the value zero, because there exist no transactions between such user pairs. When most of the elements are zero, the matrix is mathematically considered a “sparse matrix.”

Graphs can be represented in a matrix concept. Storage of a matrix can be in different formats. Depending on the characteristics of matrix and storage data structure, matrix operation can be of different complexity.

There exist many ways to electronically store a sparse matrix, such as Dictionary of Keys (DOK), List of Lists (LIL), Coordinate List COO), Compressed Sparse Row (CSR) or Compressed Sparse Column (CSC), as these are known by those of ordinary skill in the art. LIL will be referenced in the examples described herein, although the remaining and other equivalent data structures may likewise be used.

In this embodiment, LIL stores one tuple per list, with each entry containing the row index, the column index and the value. It is a good format for incremental matrix construction, which fits the Bitcoin and virtual or digital currency transaction scenarios where new transactions come frequently and in large numbers. Accordingly, at step 2830, the updated matrix is stored as an updated LIL with the new transaction details. The process 2800 then ends with respect to this individual transaction (step 2832).

Once transactions are stored in the foregoing processes, it becomes computationally efficient to audit and search such transactions, in a manner that is quicker and less resource intensive than searching blockchains directly. FIG. 29 shows a flow chart of a general transaction query process 2900 as may be performed via the SOCOACT in various embodiments.

The process 2900 commences when a user 106 enters and transmits via client 106a a Transaction Query including an address corresponding to a user that is, for example, an audit target (step 2902).

Responsively, the SOCOACT determines whether there is an entry that corresponds to the address (step 2906). The SOCOACT may do this by applying the address to the Bloom Filter to determine if a wallet address is recorded without actually looking up the database. Alternatively, the SOCOACT may search the Physical Address database 17319q to determine whether an entry for the wallet address exists. If no entry exists, the process 2900 continues to step 2918 below and the audit result is that the required wallet is not involved in a transaction. Otherwise, the SOCOACT retrieves the corresponding wallet address and performs a lookup in the LIL (step 2908).

The SOCOACT next determines whether any transaction record tuples in the LIL include the queried Wallet Address(step 2912). If not, the process continues at step 2918 below. Otherwise, if a corresponding tuple is found, the SOCOACT instead retrieves the transaction amounts and timestamp values from the corresponding transaction record tuples (step 2914).

Optionally, at step 2916, the SOCOACT than identifies the appropriate blockchain that was recorded at a time of the transaction identified in the tuple and retrieves the corresponding transactions from the appropriate blockchains by searching using the query target's address (See, e.g., the process described above with respect to FIG. 7) (step 2916).

When all transaction information has been retrieved from the blockchain(s), the query results are transmitted by the SOCOACT to the client for display to the querying user. (step 2918). The process 2900 then ends with respect to the individual query (step 2920).

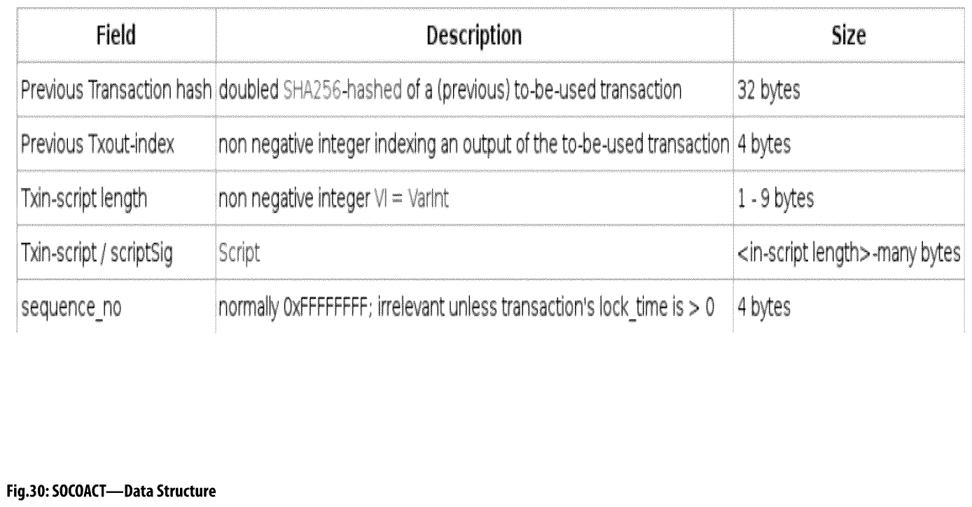

In accordance with the foregoing, FIG. 30 shows a schematic representation of the data structure of the inputs and outputs for Bitcoin-like transactions performed by the SOCOACT. Like BTC, the SOCOACT uses a previous transaction hash that is added to the block chain for verification purposes and to reduce the possibility of entry of fraudulent transactions. The SOCOACT data structure may include a previous transactions hash field, which may be a double SHA-256 hash of a previous transaction record with an exemplary field length of 32 bytes. The transaction record data structure may also include a 4 byte Previous Transaction Out field storing a non-negative integer indexing an output of the to-be-used transaction. A 1-9 byte Transaction Script Length field contains a non-negative integer representing the data structure length of any accompanying script, for transmission verification purposes. Finally, there may be a four byte sequence number field, for recording the sequential number of this SOCOACT-processed transaction.

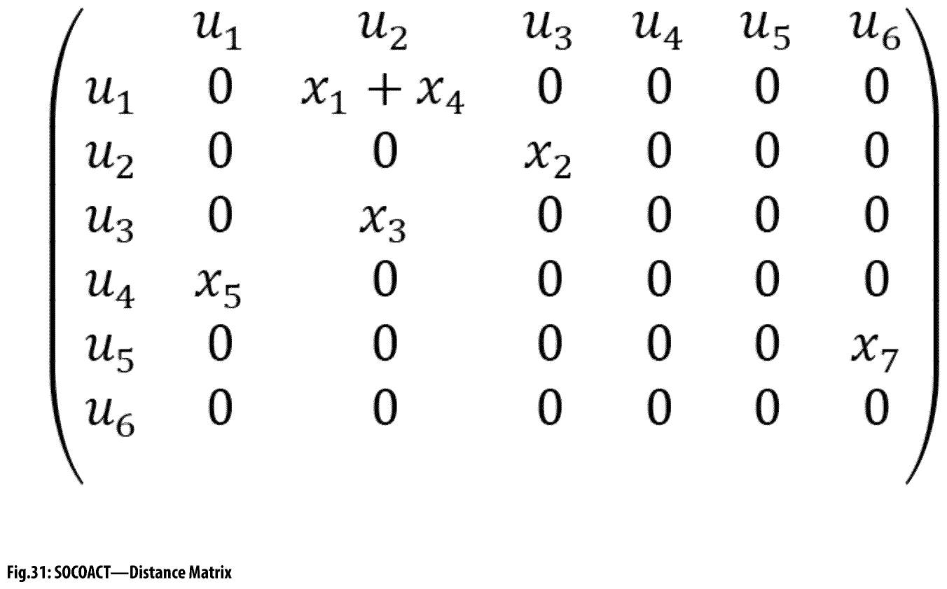

FIG. 31 is an exemplary representation of a distance matrix generated by the SOCOACT to represent the various transactions depicted in FIG. 26. The use of a distance matrix represents a significant improvement to prior art blockchain technologies. In this instance, only six users (U1 . . . . U6) are represented. The transaction amounts, which correspond to the transactions graphed in FIG. 26, are shown in the appropriate column/row entries.

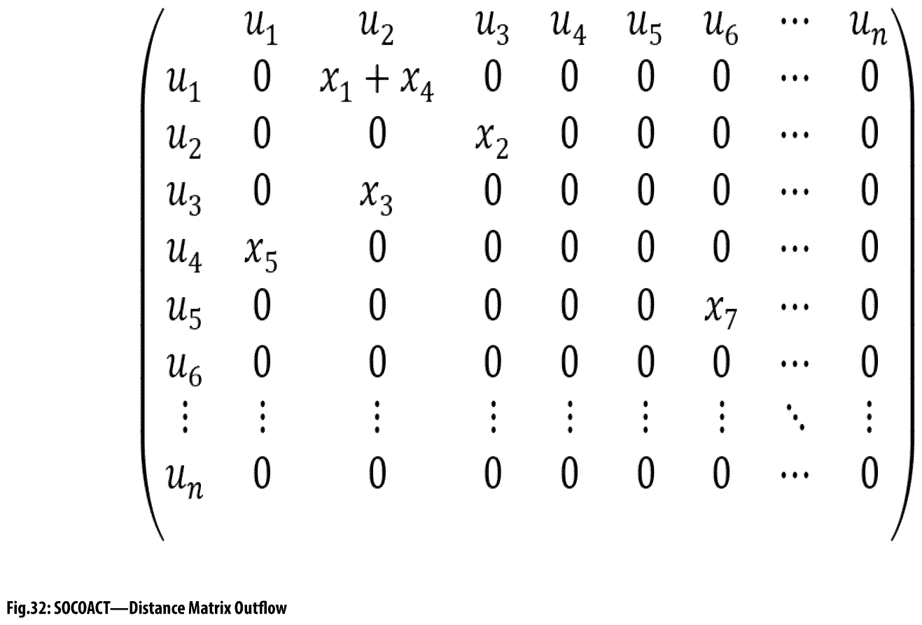

FIG. 32 is an exemplary representation of a distance matrix generated by the SOCOACT to represent outflow from the various vertices of FIG. 26, and which has been expanded to include any number of users. Suppose the transactions shown in FIG. 26 are a small subset of millions of transactions, the generic money flow can be represented with the matrix M of FIG. 32, which for every position (i,j), it shows money flowing out of vertex Ui and into vertex Uj.

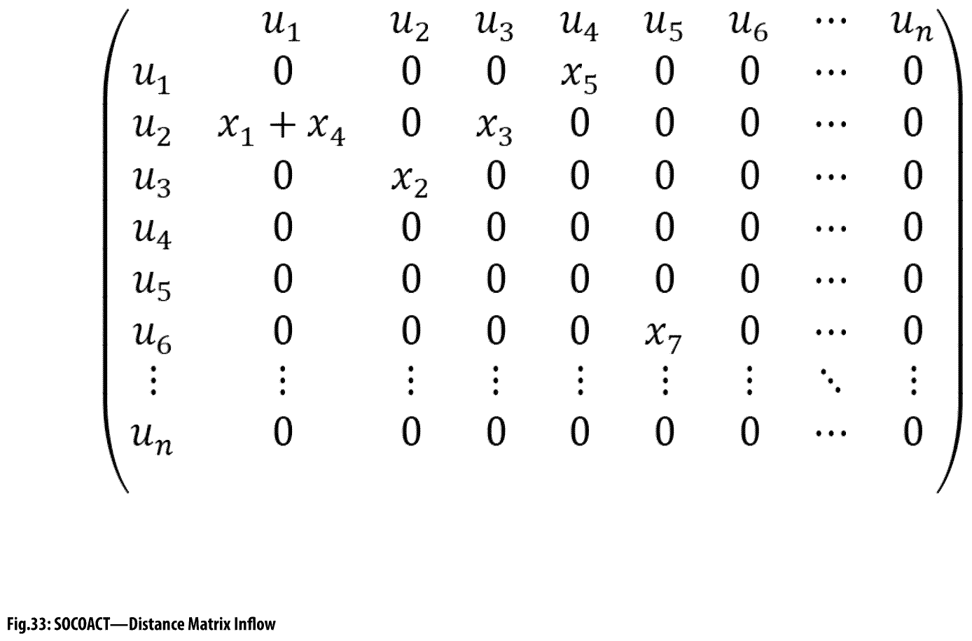

To trace money flow in the other direction, the matrix M can be transposed to a matrix M^{T}, in which for every position (i,j), it shows money flowing into vertex Ui and out of vertex Uj. FIG. 33 is an exemplary representation of a transposed distance matrix M^{T} generated and used by the SOCOACT to represent inflow from the various vertices of FIG. 26. For the functions herein described with respect to matrices, it should be appreciated that the distance matrix M and transposed matrix M^{T} may be simultaneously used and stored by the SOCOACT system 17301.

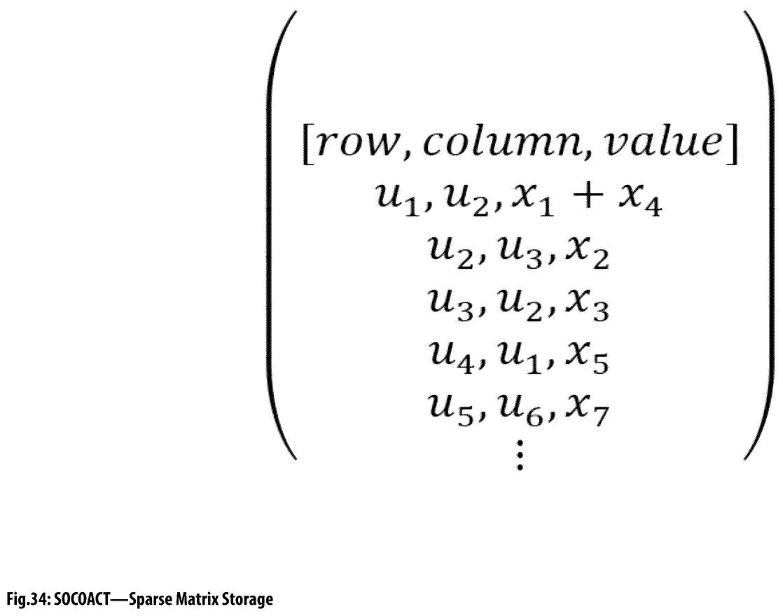

FIG. 34 is an exemplary representation of a LIL list generated from the sparse matrix M (and/or transposed matrix M^{T}) by the SOCOACT from the distance matrix of FIG. 31. The sparse matrix M can be stored in a list of (row, column, value) tuples. FIG. 34 shows how the tuples of the sparse matrix M are stored. Sparse matrix M^{T} is similar and so a separate demonstration of M^{T} is omitted. The storage space complexity of the LIL sparse matrix is on the magnitude of O(n), according to Big O notation, where n is the number of total transactions. Hence, the complexity of storage increases only in accordance with the magnitude of the data being stored, as would happen with cryptographic storage and retrieval.

FIG. 35 is a schematic representation of a Bloom Filter as may be used by the SOCOACT for transaction storage and query as described in the foregoing. For transaction tracing purposes, there are two major usages of the transaction records. The first is to insert a new transaction into the matrix M and, accordingly, the LIL used to represent M. The other is to look up the LIL for transaction tracing, given one address to start with.

As visually represented in FIG. 35, Bloom Filters can use one or more hashing algorithms. To pick out a proper hash algorithms, the following factors are to be considered: data format requirements for the array of tuples, data volume from the billions of transactions that grow with time, data usage (particularly, infrequent query compared to the data volume, i.e., only query when suspicious activities are suspected), update requirements (i.e., all new transactions need to be logged), performance expectations (given the amount of data and the expected data volume growth, algorithms that are independent of the data volume are preferred).

Given the uniqueness of the source and destination addresses, there are many hash algorithms in the field that can be applicable to these requirements. We use Linear Congruential Generators (LCG) here as an example to show how it works. An LCG is an algorithm that yields a sequence of pseudo-randomized numbers calculated with a discontinuous piecewise linear equation. One such useful LCG may be generally defined by the recurrence relation:

$${x}_{n + 1} = ( a {x}_{n} + c ) mod m$$

where x is the sequence of values, m is the modulus, a is a multiplier in the range 0<a<m, c is an incremental value in the range 0<=c<m. X₀ is the start value or “seed.” The modulo operation, or modulus, finds the remainder after division of one number by another. An LCG of this form can calculate a pre-defined number one or more times to get the targeted value in a single hash operation. It should be appreciated that the LCG can be applied to an address value a sequential number of times to yield a physical address as used herein. Alternatively, or additionally, the LCG can be applied to separate segments of the hashed public key one or more times to yield a physical address.

It should be noted that LCGs are not typically used with cryptographic applications anymore. This is because when a linear congruential generator is seeded with a character and then iterated once, the result is a simple classical cipher that is easily broken by standard frequency analysis. However, since the physical addresses are never broadcast by the SOCOACT system to any outside party, there is no reason to fear its usage being cracked by hackers or other untrustworthy parties.

The following examples of an application of a Bloom Filter are for illustration purposes. Hashing algorithms that would create a conflict are deliberately chosen so as to show how conflicts are reconciled. With the right choice of hashing functions, conflicts are extremely rare. That's how the search or insertion performance can be nearly as good as O(1). The principles to choose hash functions for a Bloom Filter include: (1) Using multiple independent hash functions (MURMURHASH or SHA-1); (2) Using a cryptographic hash function such as SHA512; and (3) Using two independent hash functions that are then linearly combined.

The size (required number of bits, m) of the bloom filter and the number of hash functions to be used depends on the application and can be calculated using: m=−n*ln (p)/(ln(2)\hat{ }2 wheren n is the number of inserted elements and p is a desired (optimized) false positive probability.

This formula will provide the required number of bits m to use for the filter, given the number n of inserted elements in filter and the desired false positive probability p to be achieved. The formula represents that for a given false positive probability p, the length of a Bloom filter m is proportionate to the number of elements being filtered n. The ideal number of hash functions k is then calculated as: k=0.7*m/n

If the values p and n are known for the required application, the above formula will yield the values of m and k, and how to appropriately choose the k hash functions.

As the volume of the data grows and the Bloom Filter false positive probability p grows, n*ln (p) gets bigger and bigger. Additional hash functions are expected to keep the false positive rate low. However, it may still reach a stage that the Bloom Filter needs a renovation—for example, by using a new hash function and re-arranging all the items stored inside. This effort, if needed at all, arises rarely, but can significantly improve the Bloom Filter performance when required.

An example ASCII to Hexidecimal (HEX) conversion table may be as follows:

| | |
|---|---|
| A | 41 |
| B | 42 |
| C | 43 |
| M | 4D |
| N | 4E |

An exemplary first LCG hashing function and its parameter values may be as follows:

$$x = ( a * ( decimal element value ) + c ) mod m \qquad Hash Function 1$$

$$let a = 5 , \text{} c = \text{} 8 , \text{} m = 17 ( or other prime number )$$

For this example, the size of the Bloom Filter is set to be as big as the modulus value m, but this is not required. In practice the modulus is normally a large prime number, but this is not required either. In this example, the Bloom Filter may have seventeen positions, based on the mod value m selected above.

A second exemplary hashing function (which must be independent of the first hashing function above for satisfactory performance), maybe as follows:

$$Hash function \#2$$

$$x = ( add the value of the odd \text{} - \text{} positioned \text{} values in an element ) \text{}$$

$$let m = \text{} 11$$

Bitcoin wallet addresses, including both “from” and “to”, are represented in the form of Strings. Simplified example strings may be calculated from the first hashing function above as follows:
Element1=‘ABM’

$$\begin{matrix}ABM = 41 + 42 + 4 D ( from ASCII to HEX conversion table above ) \\ = D 0 ( in HEX , when foregoing HEX values are added ) \\ = 208 ( when converted from HEX to decimal from )\end{matrix}$$

Similarly, Element2=‘BCN’

$$BCN = 42 + 43 + 4 E = 211$$

And, Element3=‘BAM’

$$BAM = 42 + 41 + 4 D = 208$$

Hash functions are then used to calculate a corresponding hash in the Bloom Filter for each of these elements.

$$\begin{matrix}Hash 1 ( ABM ) = ( 5 * 208 + 8 ) mod 17 = 11 \\ Hash 2 ( ABM ) = ( value “ A ” + value “ M ” ) mod 11 \\ = ( 41 + 4 D ) mod 11 ( Hex ) \\ = ( 65 + 77 ) mod 11 ( Decimal ) \\ = 10\end{matrix}$$

Accordingly, as a result of the hash functions above, a binary “1” will be stored in positions 11 and 10 of the Bloom filter. A pointer to the element ABM's location in the database may be attached to the Hash2 index and so will be stored in association with position 10.

The following is an example of adding a second element (“BCN”) into the Bloom Filter:

$$Hash 1 ( BCN ) = ( 5 * 211 + 8 ) mod 17 = 9$$

$$Hash 2 ( BCN ) = ( value “ B ” + value “ N ” ) mod 11 = 1$$

Accordingly, as a result of the hash functions above, a binary “1” will be stored in positions 9 and 1 of the Bloom filter. A pointer to the element BCN's location in the database may be attached to the Hash2 index and so will be stored in association with position 1.

The following is an example of adding a third element (“BAM”) into the Bloom filter:

$$Hash 1 ( BAM ) = ( 5 * 208 + 8 ) mod 17 = 11$$

$$Hash 2 ( BAM ) = ( value “ B ” + value “ M ” ) mod 11 = 0$$

Accordingly, as a result of the hash functions above, a binary “1” should be stored in positions 11 and 0 of the Bloom filter, however, the position 11 is already populated with a binary 1 from the entry of the element ABM above. A pointer to the element ABM's location in the database may be attached to the Hash2 index and so will be stored in association with position 11.

The following is an example of conflict handling with a Bloom filter. Suppose there is an entry of an element X which results in Hash1 (X)=10 and Hash2 (X)=1. This creates a conflict with the entry of the previous elements above, since positions 1 and 10 have been previously occupied. There are many ways to handle this conflict. The first way is to add an additional independent hash function to generate a third value and using the third value as the index to the pointer for the storage of element X in the database. The second way is to pad the conflicted value to the existing value in storage.

The following is an example of a Bloom Filter look-up function of a fourth element Y in which Hash1(Y)=3 and Hash2 (Y)=10. Since, according to the foregoing element entries and results, there is no “1” stored in position 3, there is 100% certainty that this element does not exist at all in the database.

The following is an example of false positive handling that may be encountered with use of a Bloom filter. For a lookup of an element T, assume that Hash1 (T)=10 and Hash2 (T)=1. This of course conflicts with the previous entries above for which positions 10 and 1 of the Bloom filter were occupied. Accordingly, the results of this search yield a false positive. In such case, the data is retrieved according to the pointer stored in position 1 (being the result of Hash2). From the foregoing elements, the element BCN is stored in conjunction with position 1 and this element does not match the queried element T. The lookup query may then continue in accordance with the selected manner of conflict handling (ie., by preforming a third hash function and looking for the data pointer stored win conjunction with the resulting value, or by looking in the padded field stored at position 1 of the Bloom filter.

According to the foregoing, during look-up, one or more hashing function are used to determine the existence of an element. If all bits corresponding to the hashes are turned on to be true, it may mean the element is in the database, or it is a false positive. But if any of the bit corresponding to the hashes is false, it means the element definitely does not exist in the database. In a large database of values, and particularly in real-world examples where much larger elements will be encountered, the use of a Bloom Filter greatly reduces the number of calculations needed to determine the presence or absence of a given element, resulting in computational efficiency.

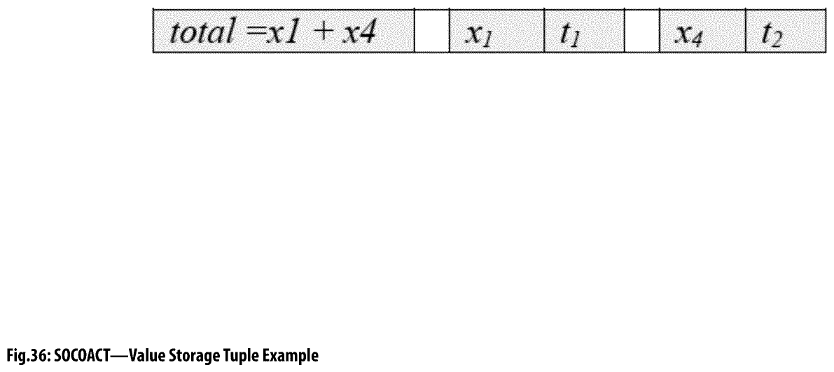

Turning now to FIG. 36, an exemplary schematic representation the data structure of transaction tuples stored by the SOCOACT is presented. The (row, column, value) tuples are stored in the LIL. Row and column are the two parties involved in the transaction. The From and To addresses are stored and are ready for look up using the Bloom Filter as described herein. Matrix M may be used to trace money out, and transposed matrix M^{T} may be used to trace money in to a specific user.

In various embodiments, the value in the tuple is not a numerical number to denote the amount of money in one transaction. It is instead a structure of an <amount, timestamp> pair. Transactions happening at different times can be separated from each other more readily in this manner, and used for precise tracing. The transactions between in between U1 and U2 in FIG. 26 are represented in the data structure shown in FIG. 36.

The innovation proposed a solution to trace BTC or other virtual or digital currency blockchain transactions in optimal computational efficiency. The storage is in the magnitude of O(n), where n is the number of total transactions, and therefore linear growth. The time complexity is in the magnitude of O(1), and therefore uses a constant-size lookup table. Once one transaction is identified as problematic, the entire money flow is completely traceable in optimal computational complexities, and therefore can be used to facilitate the prevention and prosecution of fraudulent transactions, such as money laundry, that may be attempted by users of the SOCOACT system.

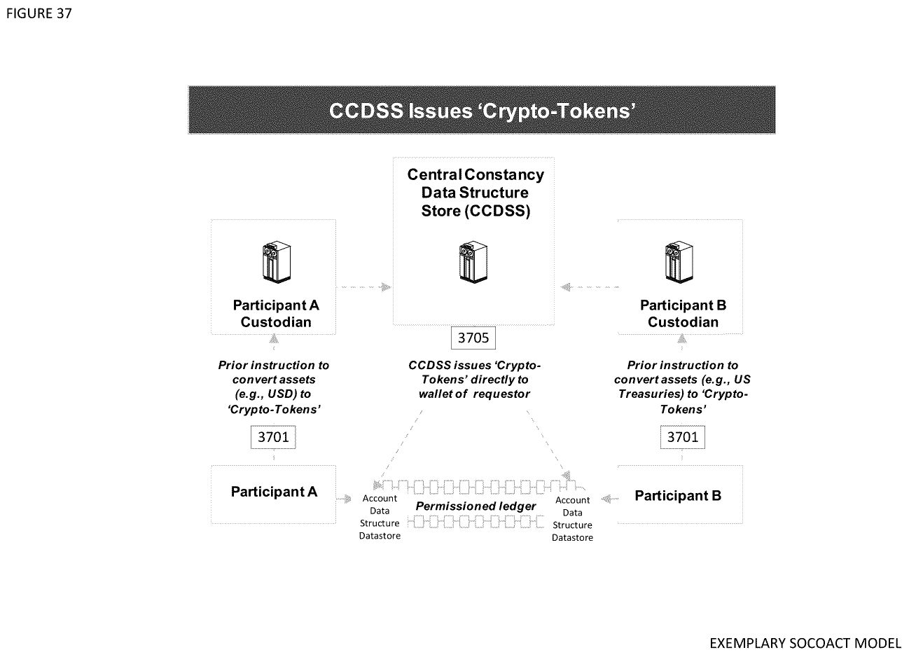

FIG. 37 shows an exemplary model for the SOCOACT. In FIG. 37, a central constancy data structure store (CCDSS) issues crypto tokens that may be usable with a permissioned ledger (e.g., on the permissioned block chain). In various embodiments, crypto tokens may be issued for a variety of assets such as currency (e.g., US Dollars (USD)), securities (e.g., treasuries, equities, bonds, derivatives), real world items (e.g., a car), and/or the like. Participants (e.g., Participant A and Participant B) may convert assets into crypto tokens by issuing instructions to their respective custodians at 3701. For example, Participant A may issue instructions to convert USD into crypto tokens. In another example, Participant B may issue instructions to convert US Treasuries into crypto tokens. In some implementations, the assets may be deposited with or control over the assets may be transferred to the CCDSS in exchange for the crypto tokens (e.g., to guarantee the value of the crypto tokens). The CCDSS (e.g., the Fed) may issue crypto tokens to an account data structure datastore (e.g., an electronic wallet associated with a permissioned ledger) of the requesting participant at 3705. Crypto tokens may then be used (e.g., in bilateral transactions between Participant A and Participant B) with the benefit of eliminating risks such as counterparty risk (e.g., whether the funds are actually available), foreign currency risk (e.g., BTC value vs. USD may fluctuate, but USD crypto tokens value vs. USD does not), and timing risk (e.g., via simultaneous transactions facilitated via SCG and SCF components).

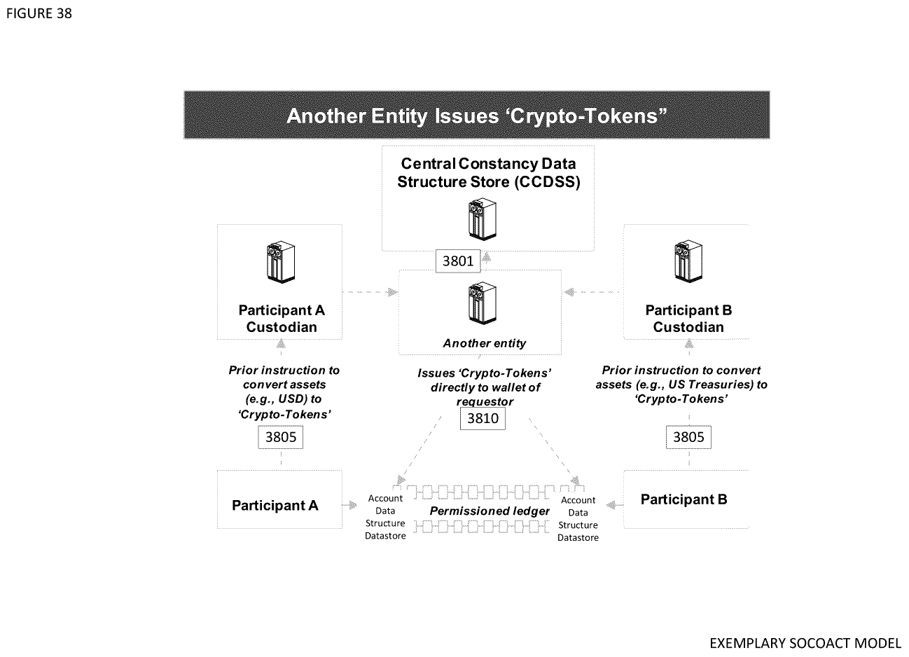

FIG. 38 shows an exemplary model for the SOCOACT. In FIG. 38, another trusted entity (e.g., depository trust and clearing corporation (DTCC)) may issue crypto tokens instead of the CCDSS. In one embodiment, the trusted entity may establish an account with the CCDSS at 3801 for the purpose of immobilizing (e.g., depositing, transferring control) assets that are exchanged for crypto tokens. Participants (e.g., Participant A and Participant B) may convert assets into crypto tokens by issuing instructions to their respective custodians at 3805. For example, Participant A may issue instructions to convert USD into crypto tokens. In another example, Participant B may issue instructions to convert US Treasuries into crypto tokens. In some implementations, the assets may be deposited with or control over the assets may be transferred to the CCDSS via the trusted entity in exchange for the crypto tokens (e.g., to guarantee the value of the crypto tokens). The trusted entity (e.g., DTCC) may issue crypto tokens to an account data structure datastore (e.g., an electronic wallet associated with a permissioned ledger) of the requesting participant at 3810. Crypto tokens may then be used (e.g., in bilateral transactions between Participant A and Participant B) with the benefit of eliminating risks such as counterparty risk, foreign currency risk, and timing risk.

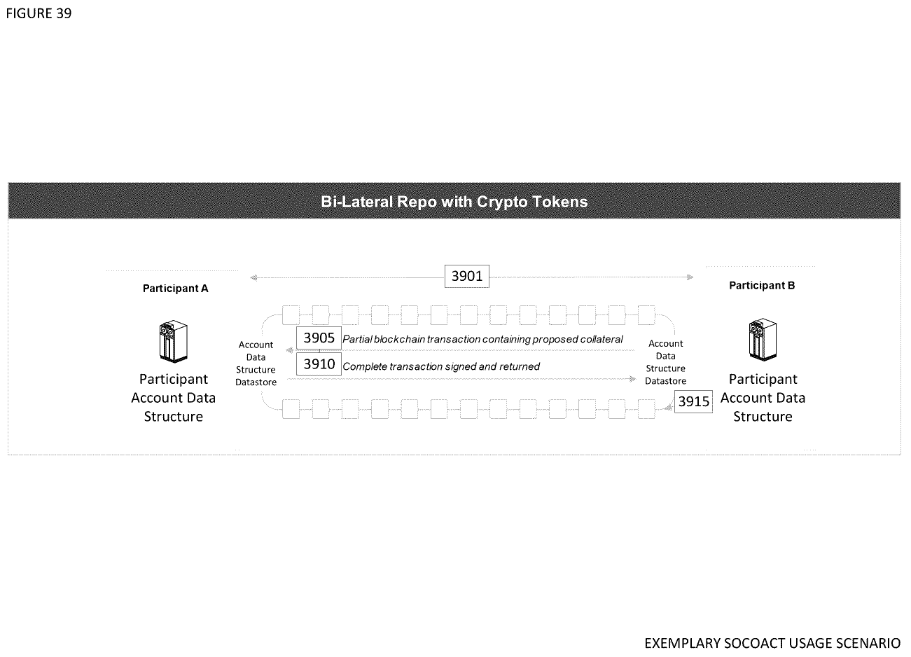

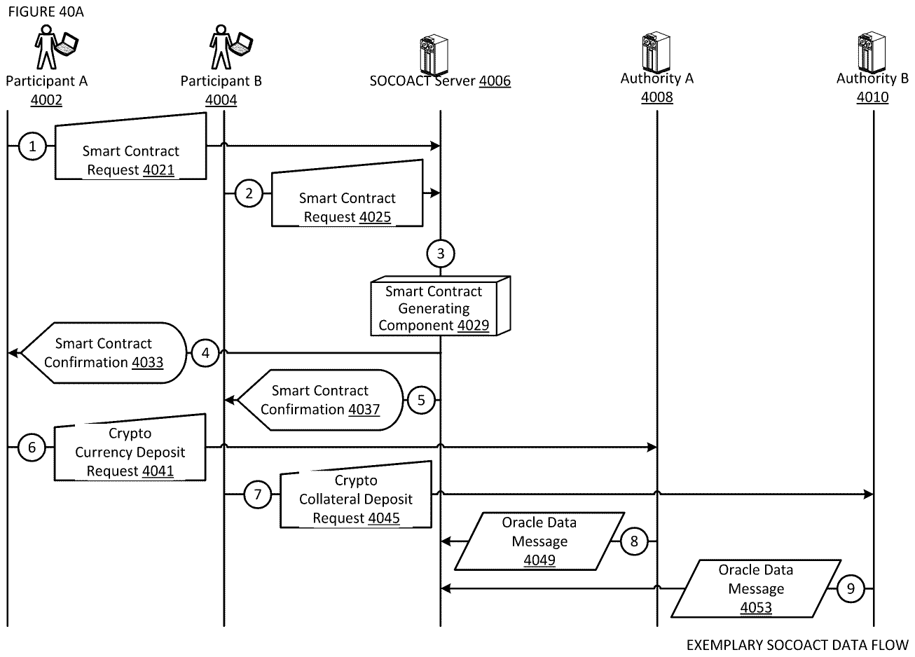

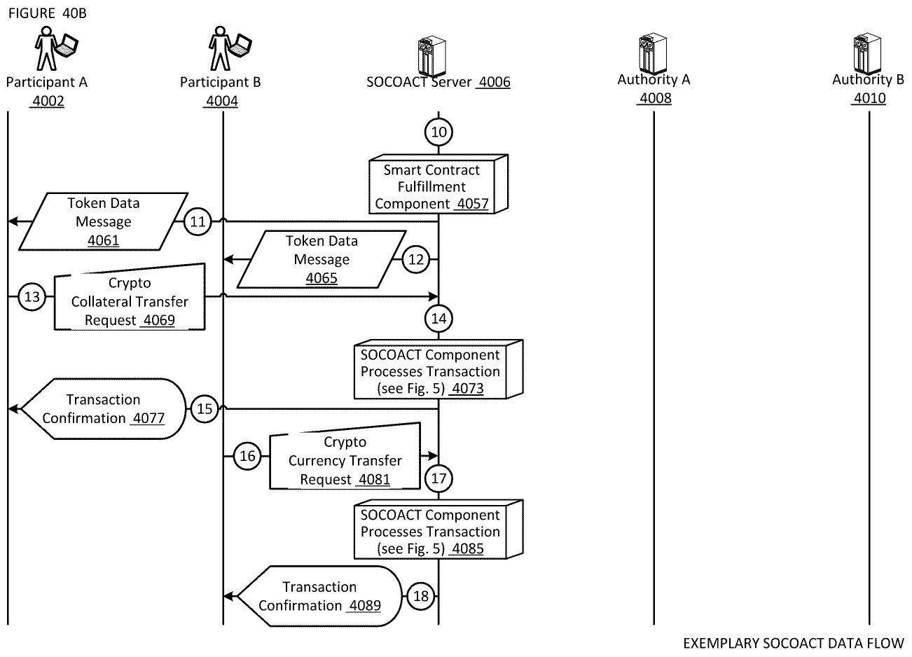

FIG. 39 shows an exemplary usage scenario for the SOCOACT. In FIG. 39, a bilateral repo with crypto tokens is illustrated. Each of the participants, Participant A (e.g., a fund) and Participant B (e.g., a dealer), may be associated with a participant account data structure (e.g., which may include cryptographic data associated with the participant, such as the participant's private key) that facilitates blockchain transactions, and with an account data structure datastore (e.g., an electronic wallet with crypto tokens) that is modified in accordance with blockchain transactions. At 3901, the participants may negotiate the size of a deal and assets to be exchanged (e.g., USD crypto tokens and collateral US Treasuries crypto tokens). In one implementation, Participant B (e.g., a dealer) may propose specific collateral and currency amounts at 3905. For example, Participant B may use a smart contractor generator GUI. Participant A (e.g., a fund) may agree to the proposed smart contract, and a smart contract may be submitted to the block chain via the SCG component at 3910. Crypto tokens specified in the smart contract may be deposited (e.g., with one or more authorities) by the participants and the exchange may be facilitated via the SCF component at 3915. The participants' account data structure datastores may be updated to reflect the exchange.

FIGS. 40A-40B show a datagraph diagram illustrating embodiments of a data flow for the SOCOACT. In FIGS. 40A-40B, Participant A 4002 may send a smart contract request 4021 to a SOCOACT Server 4006. For example, Participant A (e.g., a fund) may wish to engage in a repo transaction with Participant B 4004 (e.g., a dealer), and may use a client device (e.g., a desktop, a laptop, a tablet, a smartphone) to access a smart contract generator to define the terms of a smart contract for the repo transaction and/or to facilitate generating the smart contract request. In one implementation, the smart contract request may include data such as a request identifier, contract type, contract parties, contract terms, contract inputs, oracles for external inputs, a cryptographic signature, a smart contract address, and/or the like. For example, the client may provide the following example smart contract request, substantially in the form of a HTTP(S) POST message including XML-formatted data, as provided below:

```
POST /smart_contract_request. php HTTP/ 1. 1
Host: www.server. com
Content-Type: Application/XML
Content-Length: 667
<? XML version = “1.0” encoding = “UTF-8”?>
<smart_contract_request>
  <request_identifier>ID_request_1</request_identifier>
  <contract_type>repo</contract_type>
  <contract_parties>Participant A, Participant B</contract_parties>
  <contract_terms>
    <duration>1 day</duration>
    <participant_obligation>
      <obligation_identifier>ID_obligation_1</obligation_identifier>
      <participant>Participant A</participant>
      <deliverable>crypto tokens - $1 Billion</deliverable>
    </participant_obligation>
    <participant_obligation>
      <obligation_identifier>ID_obligation_2</obligation_identifier>
      <participant>Participant B</participant>
      <deliverable>crypto tokens - 9,174,312 shares of
NASDAQ : AAPL</deliverable>
    </participant_obligation>
    </contract_terms>
    <contract_inputs>
      <input>
    <input_identifier>ID_obligation_1_confirm_input</input_identifier>
        <type>external</type>
        <oracle>ID_Authority_A</oracle>
    </input>
    <input>
<input_identifier>ID_obligation_2_confirm_input</input_identifier>
      <type>external</type>
      <oracle>ID_Authority_B</oracle>
    </input>
  </contract_inputs>
  <signatures>
    <signature>Participant A signature</signature>
  </signatures>
  <contract_address>1HnhWpkMHMjgt167kvgcPyurMmsCQ2WPgg
</contract_address>
</smart_contract_request>
```

Participant B 4004 may agree to the proposed smart contract for the repo transaction (e.g., borrow $1 Billion currency for 1 day using 9,174,312 shares of NASDAQ: AAPL as collateral), and may send a smart contract request 4025 to the SOCOACT Server 4006. For example, Participant B may use a client device to sign the proposed smart contract to indicate agreement and/or to facilitate generating the smart contract request. For example, the client may provide the following example smart contract request, substantially in the form of a HTTP(S) POST message including XML-formatted data, as provided below:

```
POST /smart_contract_request. php HTTP/ 1. 1
Host: www.server. com
Content-Type: Application/XML
Content-Length: 667
<? XML version = “1.0” encoding = “UTF-8”?>
<smart_contract_request>
  <request_identifier>ID_request_1</request_identifier>
  <contract_type>repo</contract_type>
  <contract_parties>Participant A, Participant B</contract_parties>
  <contract_terms>
    <duration>1 day</duration>
    <participant_obligation>
      <obligation_identifier>ID_obligation_1</obligation_identifier>
      <participant>Participant A</participant>
      <deliverable>crypto tokens - $1 Billion</deliverable>
    </participant_obligation>
    <participant_obligation>
      <obligation_identifier>ID_obligation_2</obligation_identifier>
      <participant>Participant B</participant>
      <deliverable>crypto tokens - 9,174,312 shares of
NASDAQ : AAPL</deliverable>
    </participant_obligation>
    </contract_terms>
    <contract_inputs>
      <input>
    <input_identifier>ID_obligation_1_confirm_input</input_identifier>
        <type>external</type>
        <oracle>ID_Authority_A</oracle>
    </input>
    <input>
<input_identifier>ID_obligation_2_confirm_input</input_identifier>
      <type>external</type>
      <oracle>ID_Authority_B</oracle>
    </input>
  </contract_inputs>
  <signatures>
    <signature>Participant A signature</signature>
  </signatures>
  <contract_address>1HnhWpkMHMjgt167kvgcPyurMmsCQ2WPgg
</contract_address>
</smart_contract_request>
```

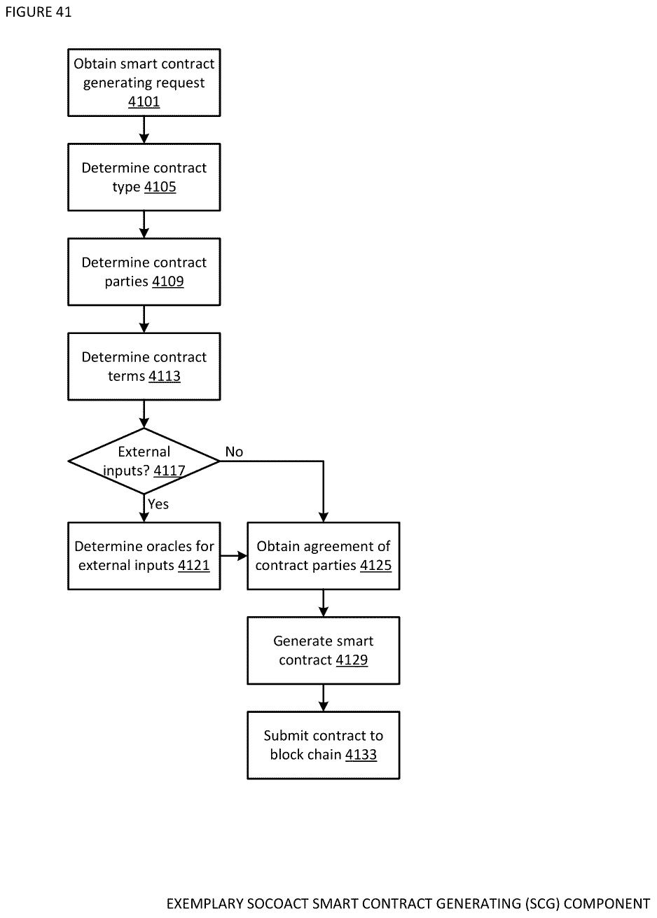

Smart contract request data may be used by a smart contract generating (SCG) component 4029 to facilitate generating a smart contract and/or submitting the smart contract to the block chain. See FIG. 41 for additional details regarding the SCG component.

The SOCOACT Server may notify Participant A and/or Participant B that the smart contract has been signed by both parties and submitted to the block chain using a smart contract confirmation 4033 and/or a smart contract confirmation 4037, respectively.

Participant A may send a crypto currency deposit request 4041 to Authority A 4008 to fulfill its obligation of delivering crypto tokens (e.g., previously obtained from the CCDSS or another trusted entity) worth $1 Billion. Authority A may be the CCDSS (e.g., the Fed), another trusted entity (e.g., DTCC), an escrow agent, a special account at Participant A, and/or the like. In one embodiment, the crypto currency deposit request may be a block chain transaction that transfers the crypto tokens from an account data structure datastore (e.g., an electronic wallet associated with a permissioned ledger) of Participant A to an account data structure datastore of Authority A.

Participant B may send a crypto collateral deposit request 4045 to Authority B 4010 to fulfill its obligation of delivering crypto tokens (e.g., previously obtained from the CCDSS or another trusted entity) worth 9,174,312 shares of NASDAQ: AAPL. Authority B may be the CCDSS (e.g., the Fed), another trusted entity (e.g., DTCC), an escrow agent, a special account at Participant B, and/or the like. It is to be understood that in some implementations Authority A and Authority B could be the same entity. In one embodiment, the crypto collateral deposit request may be a block chain transaction that transfers the crypto tokens from an account data structure datastore (e.g., an electronic wallet associated with a permissioned ledger) of Participant B to an account data structure datastore of Authority B.

Authority A may send an oracle data message 4049 to the SOCOACT Server to provide oracle data utilized by the smart contract. In one embodiment, the oracle data message may specify crypto tokens that have been deposited with Authority A (e.g., in a header with viewable metadata) in association with the smart contract (e.g., based on the address of the smart contract) and/or may include access token data (e.g., a password, a private key) that allows access to the deposited crypto tokens (e.g., not available to Participant B until the smart contract is unlocked). For example, Authority A may provide the following example oracle data message, substantially in the form of a HTTP(S) POST message including XML-formatted data, as provided below:

```
POST /oracle_data_message.php HTTP/ 1. 1
Host: www.server.com
Content-Type: Application/XML
Content-Length: 667
<? XML version = “1.0” encoding = “UTF-8”?>
<oracle_data_message>
  <source>Authority A</source>
  <contract_address>1HnhWpkMHMjgt167kvgcPyurMmsCQ2WPgg
</contract_address>
  <token_data>
    <header>crypto tokens - $1 Billion deposited</header>
    <access_token_data>encrypted access token data</access_token_data>
  </token_data>
</oracle_data_message>
```

Authority B may send an oracle data message 4053 to the SOCOACT Server to provide oracle data utilized by the smart contract. In one embodiment, the oracle data message may specify crypto tokens that have been deposited with Authority B (e.g., in a header with viewable metadata) in association with the smart contract (e.g., based on the address of the smart contract) and/or may include access token data (e.g., a password, a private key) that allows access to the deposited crypto tokens (e.g., not available to Participant A until the smart contract is unlocked). For example, Authority B may provide the following example oracle data message, substantially in the form of a HTTP(S) POST message including XML-formatted data, as provided below:

```
POST /oracle_data_message.php HTTP/1. 1
Host: www.server.com
Content-Type: Application/XML
Content-Length: 667
<? XML version = “1.0” encoding = “UTF-8”?>
<oracle_data_message>
  <source>Authority B</source>
  <contract_address>1HnhWpkMHMjgt 167kvgcPyurMmsCQ2WPgg</contract_address>
  <token_data>
    <header>crypto tokens - 9,174,312 shares of NASDAQ:AAPL
deposited</header>
    <access_token_data>encrypted token data</access_token_data>
  </token_data>
</oracle_data_message>
```

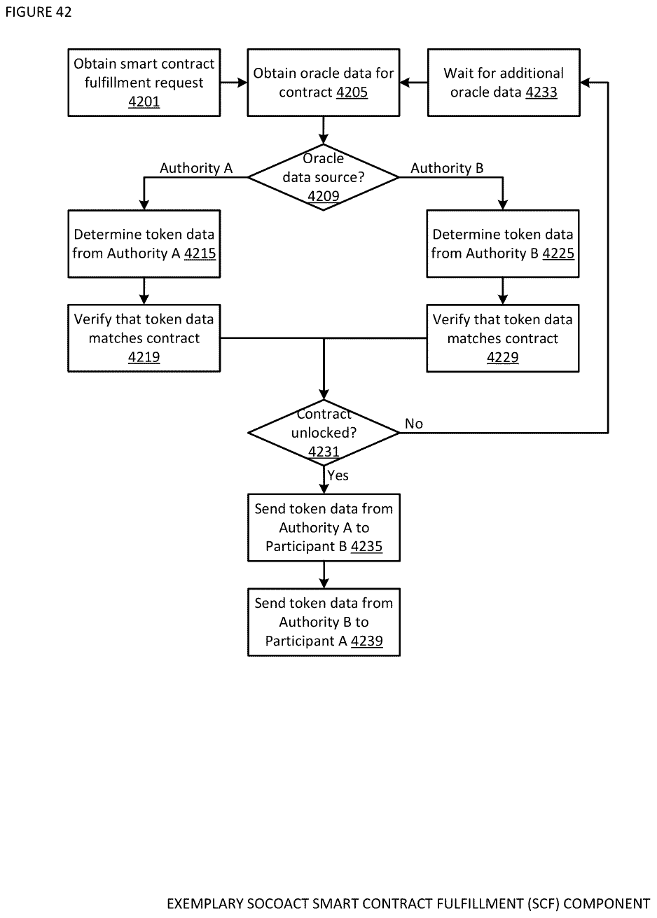

Oracle data may be used by a smart contract fulfillment (SCF) component 4057 to facilitate unlocking the smart contract and/or sending access token data to participants. See FIG. 42 for additional details regarding the SCF component.

The SOCOACT Server may send access token data to Participant A and/or Participant B that allows access to deposited crypto tokens using a token data message 4061 and/or token data message 4065, respectively. In one implementation, access token data for a participant may be secured by being encrypted with the participant's public key, and the participant may decrypt it using the participant's private key.

Participant A may send a crypto collateral transfer request 4069 (e.g., a block chain transaction) to the SOCOACT Server to transfer collateral crypto tokens associated with the repo transaction from the account data structure datastore of Authority B (e.g., an electronic wallet associated with a permissioned ledger) to the account data structure datastore of Participant A. The SOCOACT Server may facilitate this transaction in a similar manner as described with respect to FIG. 5 at 4073, and may send a transaction confirmation 4077 to Participant A.

Participant B may send a crypto currency transfer request 4081 (e.g., a block chain transaction) to the SOCOACT Server to transfer currency crypto tokens associated with the repo transaction from the account data structure datastore of Authority A (e.g., an electronic wallet associated with a permissioned ledger) to the account data structure datastore of Participant B. The SOCOACT Server may facilitate this transaction in a similar manner as described with respect to FIG. 5 at 4085, and may send a transaction confirmation 4089 to Participant B.

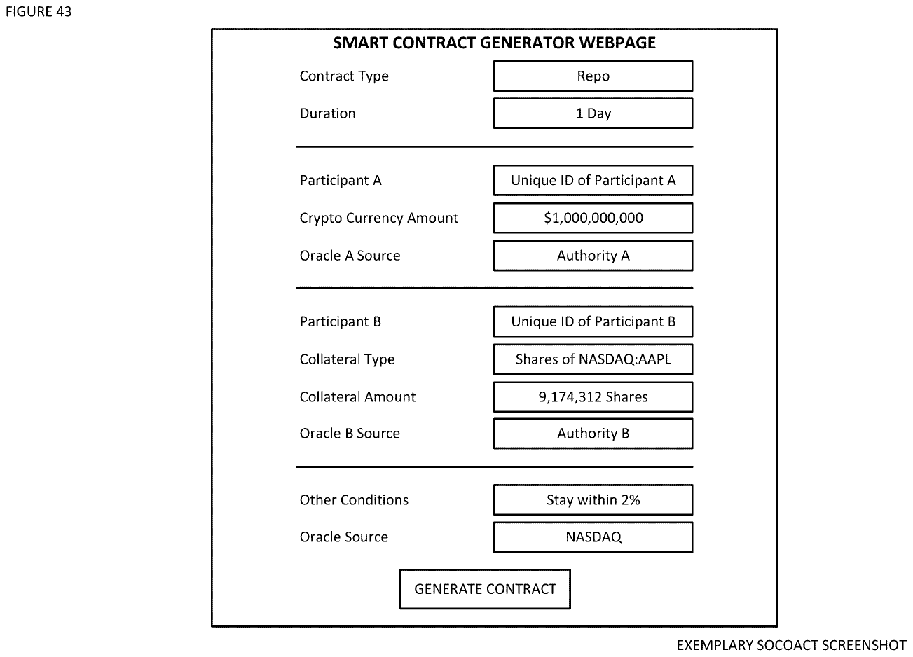

FIG. 41 shows a logic flow diagram illustrating embodiments of a smart contract generating (SCG) component for the SOCOACT. In FIG. 41, a smart contract generating request may be obtained at 4101. For example, the smart contract generating request may be obtained as a result of a participant using a smart contract generator (e.g., a website, an application) to generate a smart contract. See FIGS. 43-45 for examples of smart contract generator GUIs that may be utilized by the participant.

A contract type associated with the smart contract may be determined at 4105. In various embodiments, smart contracts may be used to engage in a repo transaction (e.g., repo type), to define a derivative (e.g., derivative type), to transfer assets (e.g., transfer type), to vote (e.g., vote type), to restrict access to an account data structure datastore (e.g., restrict type), to release an extra key to an account data structure datastore (e.g., backup type), to purchase stock (e.g., purchase type), and/or the like. It is to be understood that a wide variety of contract types associated with various smart contract generator GUIs may be utilized. In one implementation, the contract type associated with the smart contract may be determined based on the value (e.g., specified by the participant) associated with Contract Type field of a smart contract generator GUI.

Contract parties associated with the smart contract may be determined at 4109. In one implementation, contract parties associated with the smart contract may be determined based on the values (e.g., specified by the participant) associated with Participant (e.g., Participant A, Participant B) fields of a smart contract generator GUI. It is to be understood that, in various embodiments, any number of participants (e.g., 1 participant, 2 participants, 3 or more participants) may be specified for the smart contract depending on the type and/or configuration of the smart contract.

Contract terms associated with the smart contract may be determined at 4113. In one embodiment, contract terms may include identifiers and/or amounts of assets to be exchanged. In another embodiment, contract terms may include a specification of the value of an asset based on data provided by an oracle source. In another embodiment, contract terms may include a specification of an action to take (e.g., restrict access, release an extra key, purchase stock, vote in a certain way) based on geofencing, time range fencing, anti-ping (e.g., lack of activity), transaction/consumption tracking (e.g., how crypto tokens are spent), weather, and/or the like (e.g., natural events such as flood, earthquake, volcanic eruption, lava flow; political events such as political unrest, war, terrorist attacks) conditions (e.g., based on data provided by an oracle source). In another embodiment, contract terms may include another smart contract (e.g., that acts as an oracle) resulting in a cascading smart contract. It is to be understood that a wide variety of contract terms associated with various smart contract generator GUIs may be utilized. In one implementation, contract terms associated with the smart contract may be determined based on the values (e.g., specified by the participant) associated with various fields, graphs, maps, and/or the like of one or more smart contract generator GUIs.

A determination may be made at 4117 whether the contract includes external inputs. If so, oracles for such external inputs may be determined at 4121. In one implementation, oracles associated with the smart contract may be determined based on the values (e.g., specified by the participant) associated with Oracle Source fields of a smart contract generator GUI. It is to be understood that a wide variety of oracles may be utilized (e.g., stock exchanges, GPS data providers, date/time providers, crowdsourced decentralized data providers, news providers, activity monitors, RSS feeds, and other oracle sources) for the smart contract. In various embodiments, RSS feeds may be from sensor based devices such as a mobile phone (e.g., with data from many such devices aggregated into a feed), may be social network (e.g., Twitter, Facebook) or news feeds (e.g., which may be further filtered down by various parameters), may be market data feeds (e.g., Bloomberg's PhatPipe, Consolidated Quote System (CQS), Consolidated Tape Association (CTA), Consolidated Tape System (CTS), Dun & Bradstreet, OTC Montage Data Feed (OMDF), Reuter's Tib, Triarch, US equity trade and quote market data, Unlisted Trading Privileges (UTP) Trade Data Feed (UTDF), UTP Quotation Data Feed (UQDF), and/or the like feeds, e.g., via ITC 2.1 and/or respective feed protocols), and/or the like, and selecting an oracle may make a request to obtain the selected feed's data stream. In one implementation, a crowdsourced decentralized weather provider may obtain (e.g., from smartphones of participating users) crowdsourced weather data (e.g., temperature, humidity), and provide such (e.g., combined) weather data for the smart contract. For example, the smart contract may specify that an order for an asset (e.g., corn futures) should be placed if the crowdsourced weather data matches specifications.

Agreement of contract parties may be obtained at 4125. In one implementation, contract parties may provide cryptographic signatures to indicate that they agree to the smart contract.

The smart contract may be generated in a format compatible with a permissioned ledger at 4129 and submitted to the block chain at 4133 (e.g., stored in contracts database 17319s). In one embodiment, the smart contract may be generated by converting the determined contract data into the compatible format (e.g., via an API). In one implementation, the smart contract may be stored in an arbitrary 80-byte header one may be allowed to send in a blockchain transaction. For example, the 80-byte header containing smart contract information recorded in the blockchain may take the following form in an XML-enabled format:

<?xml version=“1.0”?>
<FIELD>
<ROW>
<Field></Field>
<Purpose></Purpose>
<Updated_when_Ö></Updated_when_Ö>
<FIELD4>Type</FIELD4>
<Size></Size>
<Example></Example>
</ROW>
<ROW>
<Field>Version</Field>
<Purpose>Block version number</Purpose>
<Updated_when_Ö>When software upgraded</Updated_when_Ö>
<FIELD4>Integer</FIELD4>
<Size>4</Size>
<Example></Example>
</ROW>
<ROW>
<Field></Field>
<Purpose></Purpose>
<Updated_when_Ö></Updated_when_Ö>
<FIELD4></FIELD4>
<Size></Size>
<Example></Example>
</ROW>
<ROW>
<Field>Stock Code</Field>
<Purpose>256-bit hash of the previous block header</Purpose>
<Updated_when_Ö>Stock Symbol; Exchange; Amount (%
share)</Updated_when_Ö>
<FIELD4>Char</FIELD4>
<Size>32</Size>
<Example>GOOG.;NASDAQ: 0.00023</Example>
</ROW>
<ROW>
<Field></Field>
<Purpose></Purpose>
<Updated_when_Ö></Updated_when_Ö>
<FIELD4></FIELD4>
<Size></Size>
<Example></Example>
</ROW>
<ROW>
<Field>Op_Return </Field>
<Purpose>256-bit hash based on all of the transactions in the block (aka
checksum)</Purpose>
<Updated_when_Ö>A transaction is accepted</Updated_when_Ö>
<FIELD4>Double Int</FIELD4>
<Size>32</Size>
<Example>0x444f4350524f4f46</Example>
</ROW>
<ROW>
<Field></Field>
<Purpose></Purpose>
<Updated_when_Ö></Updated_when_Ö>
<FIELD4></FIELD4>
<Size></Size>
<Example></Example>
</ROW>
<ROW>
<Field>Time</Field>
<Purpose>Current timestamp as seconds since 1970-01-01T00:00
UTC</Purpose>
<Updated_when_Ö>Every few seconds</Updated_when_Ö>
<FIELD4>Int</FIELD4>
<Size>4</Size>
<Example>1444655572</Example>
</ROW>
<ROW>
<Field></Field>
<Purpose></Purpose>
<Updated_when_Ö></Updated_when_Ö>
<FIELD4></FIELD4>
<Size></Size>
<Example></Example>
</ROW>
<ROW>
<Field>Bits</Field>
<Purpose>Current target in compact format</Purpose>
<Updated_when_Ö>The difficulty is adjusted</Updated_when_Ö>
<FIELD4></FIELD4>
<Size>4</Size>
<Example></Example>
</ROW>
<ROW>
<Field></Field>
<Purpose></Purpose>
<Updated_when_Ö></Updated_when_Ö>
<FIELD4></FIELD4>
<Size></Size>
<Example></Example>
</ROW>
<ROW>
<Field>Nonce</Field>
<Purpose>32-bit number (starts at 0)</Purpose>
<Updated_when_Ö>A hash is tried (increments)</Updated_when_Ö>
<FIELD4></FIELD4>
<Size>4</Size>
<Example></Example>
</ROW>
<ROW>
<Field></Field>
<Purpose></Purpose>
<Updated_when_Ö></Updated_when_Ö>
<FIELD4></FIELD4>
<Size></Size>
<Example></Example>
</ROW>
</FIELD>

The foregoing exemplary XML datastructure can be represented by the following table of its field names, field types, field sizes and field data:

| Field | Purpose | Updated when . . . | Type | Size |
|---|---|---|---|---|
| Version | Block version number | When software upgraded | Integer | 4 |
| Coefficient | 256-bit hash of | Per formula of | Int | 4 |
| | Formula co-efficient term N | Nth polynomial | | |
| Coefficient | 256-bit hash of | Per Formula | Int | 4 |
| | Formula co-efficient | | | |
| | term a | | | |
| Coefficient | 256-bit hash of | Per Formula | Int | 4 |
| | Formula co-efficient | | | |
| | term r | | | |
| SmartStart | Start address of Smart | | | 32 |
| | Contract | | | |
| RandomNumHead | 256-bit hash based on | A transaction is | | 16 |
| | all of the transactions | accepted | | |
| | in the block (aka | | | |
| | checksum) | | | |
| hashMerkleRoot | 256-bit hash based on | A transaction is | Double | 16 |
| | all of the transactions | accepted | | |
| | in the block (aka | | | |
| | checksum) | | | |
| Bits | Current target in | The difficulty is | | 4 |
| | compact format | adjusted | | |
| Nonce | 32-bit number (starts | A hash is tried | | 4 |
| | at 0) | (increments) | | |

$${P ( G ; X )}^{n} = {\sum }_{k = 0}^{N} ( \begin{matrix}n \\ k\end{matrix} ) {x}^{k} {a}^{n - k} = {X}^{N} - {qX}^{N - 2} - 2 {r}_{3} 3 {X}^{N - 3} - {a}_{4} {x}^{N - 4} + {a}_{5} {x}^{N - 5} + ⋯ + {a}_{N - 2} {X}^{2} + {a}_{N - 1} X + {a}_{N}$$

For example, the generated smart contract data may be represented by a data structure as illustrated below:

```
<?XML version = “1.0” encoding = “UTF-8”?>
<smart_contract>
  <contract_type>repo</contract_type>
  <contract_parties>Participant A, Participant B</contract_parties>
  <contract_data>
    <duration>1 day</duration>
    <participant_obligation>
      <participant>Participant A</participant>
      <deliverable>crypto tokens - $1 Billion</deliverable>
      <oracle>ID_Authority_A</oracle>
    </participant_obligation>
    <participant_obligation>
      <participant>Participant B</participant>
      <deliverable>crypto tokens - 9,174,312 shares of
NASDAQ:AAPL</deliverable>
      <oracle>ID_Authority_B</oracle>
    </participant_obligation>
  </contract_data>
  <contract_address>1HnhWpkMHMjgt167kvgcPyurMmsCQ2WPgg</contract_address>
</smart_contract>
```

FIG. 42 shows a logic flow diagram illustrating embodiments of a smart contract fulfillment (SCF) component for the SOCOACT. In FIG. 42, a smart contract fulfillment request may be obtained at 4201. For example, the smart contract fulfillment request may be obtained to determine whether a smart contract should be unlocked.

Oracle data for the smart contract may be obtained at 4205. For example, for a repo smart contract oracle data may be obtained to confirm that both parties fulfilled their obligations (e.g., Participant A deposits crypto tokens worth $1 Billion and Participant B deposits crypto tokens worth 9,174,312 shares of NASDAQ: AAPL). In one implementation, an oracle (e.g., Authority A, Authority B) may send oracle data based on the address associated with the smart contract.

A determination may be made at 4209 regarding the source of the obtained oracle data. If the source is Authority A, token data from Authority A may be determined at 4215 (e.g., by parsing an oracle data message from Authority A). In one implementation, a header associated with the oracle data message may be parsed to determine what has been deposited with Authority A. The SOCOACT may verify that token data matches the corresponding smart contract obligation specification at 4219. For example, header data (e.g., crypto tokens—$1 Billion deposited) may be compared with obligation deliverable (e.g., crypto tokens—$1 Billion) to verify that the correct currency amount has been deposited with Authority A. In some embodiments, additional verification may be performed. For example, if the smart contract specifies that a real world item (e.g., a car with a specified VIN) should be delivered by Participant A, the real world item may be tracked (e.g., via a constant video stream). If the real world item is moved after it has been delivered to a designated location, token data associated with the real world item (e.g., linked based on the VIN) may be set to be invalid.

If the source is Authority B, token data from Authority B may be determined at 4225 (e.g., by parsing an oracle data message from Authority B). In one implementation, a header associated with the oracle data message may be parsed to determine what has been deposited with Authority B. The SOCOACT may verify that token data matches the corresponding smart contract obligation specification at 4229. For example, header data (e.g., crypto tokens—9,174,312 shares of NASDAQ: AAPL deposited) may be compared with obligation deliverable (e.g., crypto tokens—9,174,312 shares of NASDAQ: AAPL) to verify that the correct collateral has been deposited with Authority B. In some embodiments, additional verification may be performed (e.g., as described above with regard to real world items.

A determination may be made at 4231 whether the smart contract should be unlocked. In one implementation, the smart contract should be unlocked if data from specified oracles has been received and matches contract data. If some of the oracle data has not been received, the SOCOACT may wait for additional oracle data at 4233.

If oracle data has been received and matches contract data, access token data from Authority A may be sent to Participant B at 4235 and/or access token data from Authority B may be sent to Participant A at 4239. In one embodiment, access token data may be sent by the SOCOACT. In another embodiment, authorities (e.g., Authority A and Authority B) may be informed that that smart contract has been unlocked and may send access token data to appropriate participants.

FIG. 43 shows a screenshot diagram illustrating embodiments of the SOCOACT. Using the shown smart contract generator GUI, a repo smart contract may be generated. The smart contract may be configured to have a duration of 1 day and to be between two participants. Participant A may be obligated to deliver crypto tokens currency worth $1 Billion to Authority A, and Participant B may be obligated to deliver crypto tokens collateral worth 9,174,312 shares of NASDAQ: AAPL to Authority B. Further the smart contract may be configured to be a cascading smart contract that utilizes another smart contract to specify that if the value of the collateral changes (e.g., based on data from NASDAQ) by more than 2%, the amount of the deposited collateral should be adjusted to compensate for deviation in value. The Generate Contract button may be used to generate this smart contract.

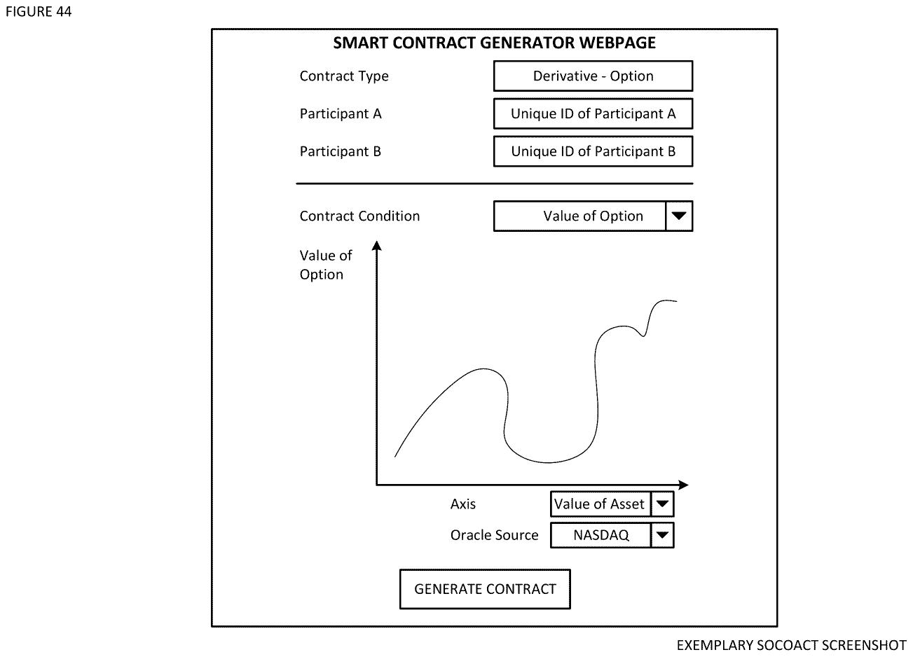

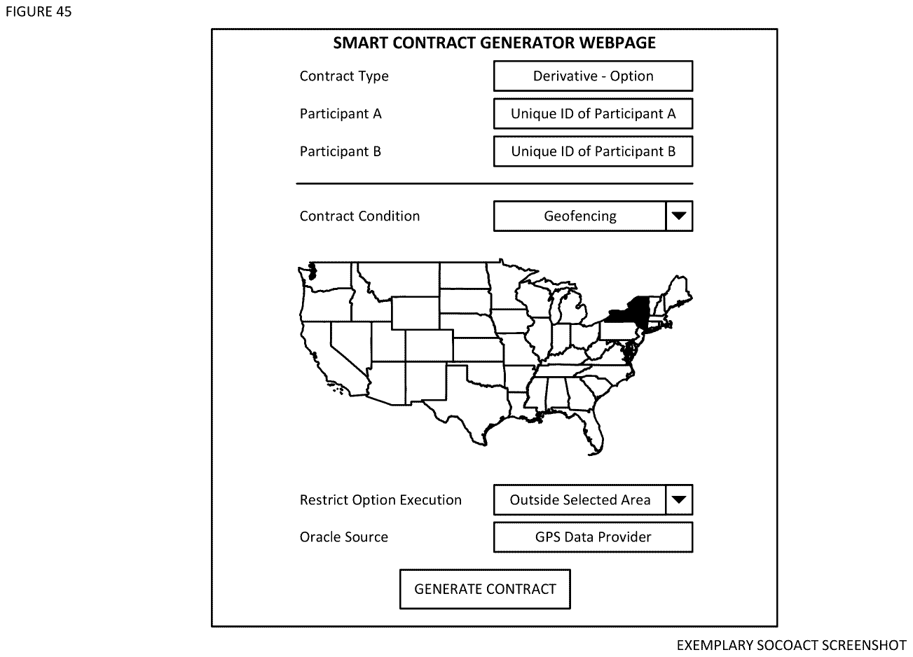

FIG. 44 shows a screenshot diagram illustrating embodiments of the SOCOACT. Using the shown smart contract generator GUI, an exotic derivative smart contract may be generated. The shown smart contract generator GUI lets a user draw a payout structure (e.g., a line, a curve) of how the value of an exotic derivative (e.g., an option) changes based on the value (e.g., based on data from NASDAQ) of an asset. The smart contract may specify that Participant A obtains this derivative from Participant B. FIG. 45 shows a screenshot diagram illustrating embodiments of the SOCOACT. Using the shown smart contract generator GUI, the smart contract may be further configured to specify that execution of the option described in FIG. 44 is restricted based on geofencing. Accordingly, Participant A users located in NY state (e.g., based on data regarding user locations from a GPS data provider) are allowed to execute the option, but other users are restricted from executing the option.

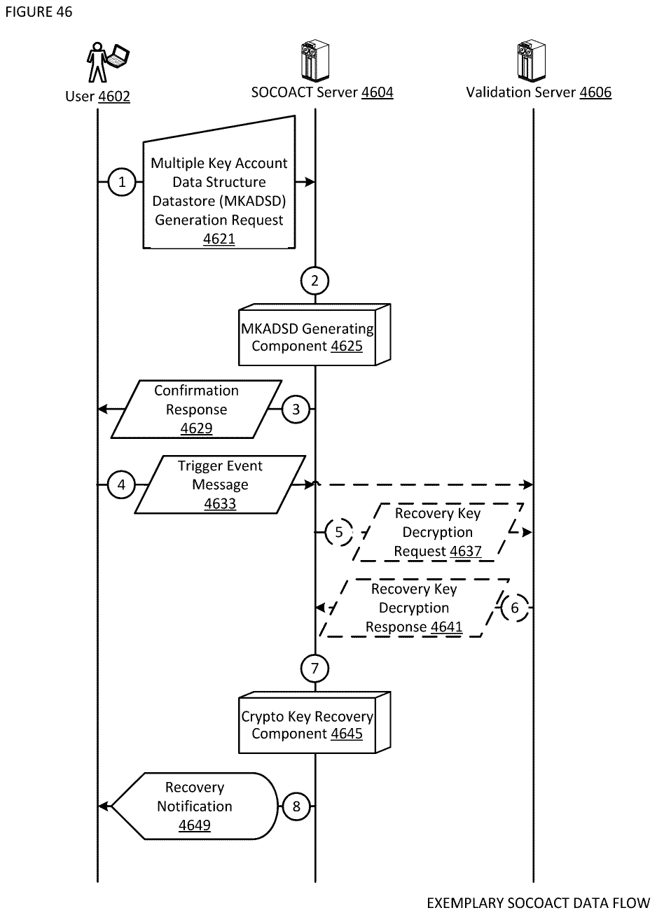

FIG. 46 shows a datagraph diagram illustrating embodiments of a data flow for the SOCOACT. In FIG. 46, dashed lines indicate data flow elements that may be more likely to be optional. In FIG. 46, a user 4602 (e.g., a person who wishes to use an electronic wallet with crypto tokens) may use a client device (e.g., a desktop, a laptop, a tablet, a smartphone) to send a multiple key account data structure datastore (MKADSD) generation request 4621 to a SOCOACT Server 4604. For example, a MKADSD (e.g., a multisignature electronic wallet) may be associated with one or more multisignature addresses, and crypto tokens associated with each of these multisignature addresses may be accessed using multiple private keys (e.g., crypto tokens associated with a 1-of-2 multisig address may be accessed using either one of the two associated private keys). In one implementation, the MKADSD generation request may include data such as a request identifier, a user identifier, a set of private keys, a set of public keys, validation server settings, recovery settings, and/or the like. For example, the client may provide the following example MKADSD generation request, substantially in the form of a HTTP(S) POST message including XML-formatted data, as provided below:

```
POST /MKADSD_generation_request.php HTTP/1.1
Host: www.server.com
Content-Type: Application/XML
Content-Length: 667
<?XML version = “1.0” encoding = “UTF-8”?>
<MKADSD_generation_request>
  <request_identifier>ID_request_1</request_identifier>
  <user_identifier>ID_user_1</user_identifier>
  <private_keys>
    <recovery_key>”recovery private key”</recovery_key>
    <recovery_key_encrypted>TRUE</recovery_key_encrypted>
  </private_keys>
  <public_keys>
    <normal_use_key>”normal use public key”</normal_use_key>
    <recovery_key>”recovery public key”</recovery_key>
  </public_keys>
  <validation_server_settings>
    <server_location>www.validation-server-location.com</server_location>
  </validation_server_settings>
  <recovery_settings>
    <recovery_setting>
      <trigger_event>user lost private key</trigger_event>
      <trigger_event_type>TYPE_LOST</trigger_event_type>
      <action>recover crypto tokens</action>
    </recovery_setting>
    <recovery_setting>
      <trigger_event>child's client device left designated geographic
area</trigger_event>
  <trigger_event_type>TYPE_PARENTAL_PERMISSION</trigger_event_type>
      <action>recover child's crypto tokens to parent's
address</action>
      <address>3HnhWpkMHMjgt167kvgcPyurMmsCQ2WPgg</address>
    </recovery_setting>
  </recovery_settings>
</MKADSD_generation_request>
```

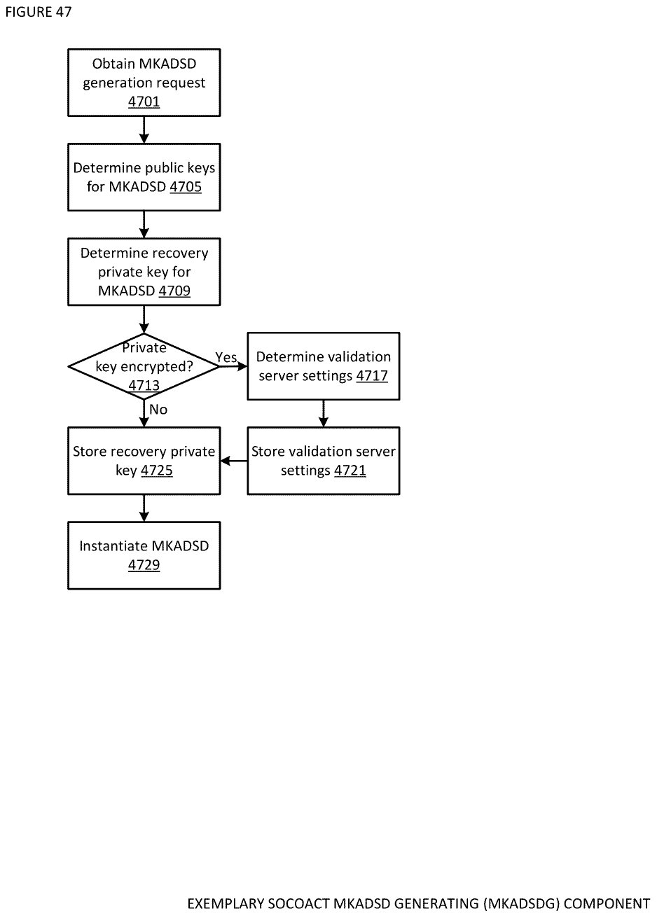

MKADSD generation request data may be used by a MKADSD generating (MKADSDG) component 4625 to facilitate generating a MKADSD and/or one or more addresses associated with the MKADSD. See FIG. 47 for additional details regarding the MKADSDG component.

The SOCOACT Server may send a confirmation response 4629 to the user to confirm that the MKADSD was generated successfully. For example, the SOCOACT Server may provide the following example confirmation response, substantially in the form of a HTTP(S) POST message including XML-formatted data, as provided below:

```
POST /confirmation_response.php HTTP/1.1
Host: www.server.com
Content-Type: Application/XML
Content-Length: 667
<?XML version = “1.0” encoding = “UTF-8”?>
<confirmation_response>
  <response_identifier>ID_response_1</response_identifier>
  <status>OK</status>
</confirmation_response>
```

The user may send a trigger event message 4633 to the SOCOACT Server upon occurrence of a trigger event. For example, the user may click on a “I lost my private key” widget of a SOCOACT website or application (e.g., a mobile app), and the trigger event message may be generated. In another example, the user's client may send the trigger event message upon detecting occurrence of a trigger event (e.g., the client was stolen and taken outside the allowed geofence). In one implementation, the trigger event message may include data such as a request identifier, a user identifier, a MKADSD identifier, trigger event data, and/or the like. For example, the client may provide the following example trigger event message, substantially in the form of a HTTP(S) POST message including XML-formatted data, as provided below:

```
POST /trigger_event_message.php HTTP/1.1
Host: www.server.com
Content-Type: Application/XML
Content-Length: 667
<?XML version = “1.0” encoding = “UTF-8”?>
<trigger_event_message>
  <request_identifier>ID_request_2</request_identifier>
  <user_identifier>ID_user_1</user_identifier>
  <MKADSD_identifier>ID_MKADSD_1</MKADSD_identifier>
  <trigger_event_data>
    <trigger_event_type>TYPE_LOST</trigger_event_type>
    <trigger_event_details>occurred on
    date/time</trigger_event_details>
  </trigger_event_data>
</trigger_event_message>
```

In various implementations, a trigger event may be user request, occurrence of geofence constraint violation (e.g., a child leaves an approved store at the mall), anti-ping detection (e.g., lack of activity from the user's client), occurrence of time range fencing violation, occurrence of transaction/consumption constraint violation, occurrence of account balance constraint violation, occurrence of specified threshold oracle data value, occurrence of a smart contract generator GUI generated crypto smart rule violation, occurrence of specified weather and/or the like (e.g., natural events such as flood, earthquake, volcanic eruption, lava flow; political events such as political unrest, war, terrorist attacks) conditions, detection of fraud (e.g., an attempt to execute a fraudulent transaction by an attacker), detection of a specified vote (a vote outcome, a conditional vote), detection of a specified vote result, detection of a request to add an external feature to an account, detection of a specified crypto verification response (e.g., a valid crypto verification response, an invalid crypto verification response), and/or the like. It is to be understood that while in this embodiment the trigger event message is sent by the user, in other embodiments the trigger event message may be sent by other entities (e.g., by an oracle, by another device such as a client of the user's child). For example, the trigger event message may be an oracle data message from an oracle. In another example, the trigger event message may be generated by the SOCOACT Server (e.g., upon detection of fraud).

In some implementations, a recovery private key associated with the user's MKADSD may be encrypted, and a trigger event message may be sent (e.g., by the user, by other entities) to a validation server 4606 to inform the validation server that the SOCOACT Server is permitted to decrypt the recovery private key. The SOCOACT Server may send a recovery key decryption request 4637 to the validation server. For example, the recovery key decryption request may specify that a decryption key associated with the user is requested. The validation server may send a recovery key decryption response 4641 to the SOCOACT Server. For example, the recovery key decryption response may include the requested decryption key. In an alternative embodiment, the validation server may be provided with the encrypted recovery private key and may return the decrypted recovery private key.

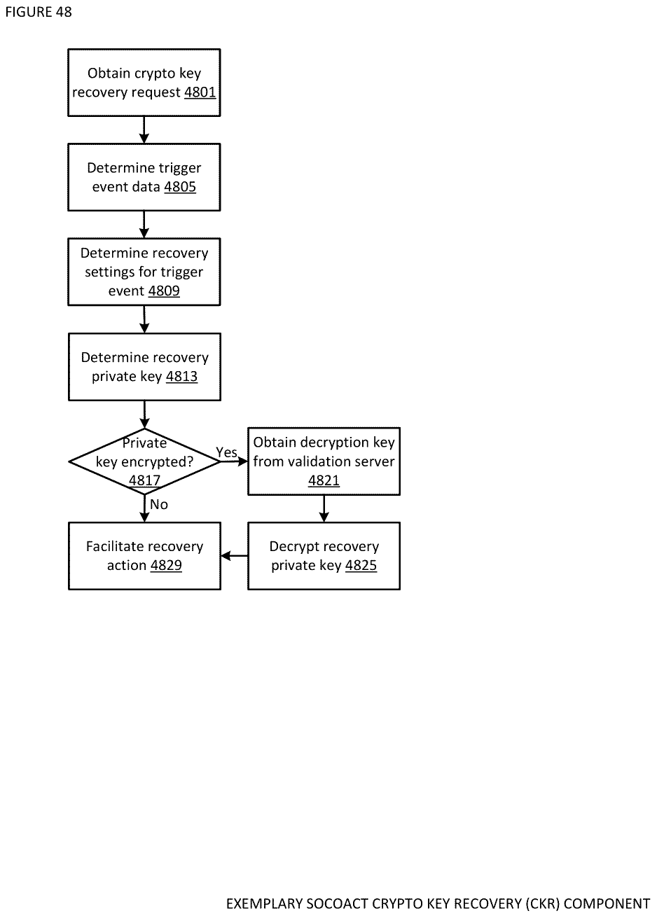

Trigger event message data and/or recovery key decryption response data may be used by a crypto key recovery (CKR) component 4645 to facilitate a recovery action associated with the trigger event. See FIG. 48 for additional details regarding the CKR component.

The SOCOACT Server may send a recovery notification 4649 to the user. The recovery notification may be used to inform the user regarding the recovery action that was facilitated. For example, the recovery notification may be displayed using a SOCOACT website or application (e.g., a mobile app), sent via email or SMS, and/or the like.

FIG. 47 shows a logic flow diagram illustrating embodiments of a MKADSD generating (MKADSDG) component for the SOCOACT. In FIG. 47, a MKADSD generation request may be obtained at 4701. For example, the MKADSD generation request may be obtained as a result of a user using a SOCOACT website or application to request creation of a MKADSD for the user.

Public keys for the MKADSD may be determined at 4705. In one implementation, the MKADSD generation request may be parsed (e.g., using PHP commands) to determine the public keys (e.g., a normal use public key and a recovery public key). For example, the user may utilize a normal use private key corresponding to the normal use public key to engage in transactions using the MKADSD. In another implementation, the public keys may be generated by the SOCOACT Server. For example, the SOCOACT Server may provide the user with the generated normal use public key and with a normal use private key corresponding to the generated normal use public key (e.g., via the confirmation response 4629).

A recovery private key for the MKADSD may be determined at 4709. In one implementation, the MKADSD generation request may be parsed (e.g., using PHP commands) to determine the recovery private key. For example, the recovery private key may correspond to the recovery public key, and the SOCOACT may utilize the recovery private key to conduct recovery actions. In another implementation, the recovery private key may be generated by the SOCOACT Server.

A determination may be made at 4713 whether the recovery private key is encrypted. In one implementation, the MKADSD generation request may be parsed (e.g., using PHP commands) to make this determination. If the recovery private key is encrypted, validation server settings may be determined at 4717. In one implementation, the MKADSD generation request may be parsed (e.g., using PHP commands) to determine the validation server settings. For example, the validation server settings may include a URL of the validation server. The validation server settings may be stored at 4721. In one implementation, the validation server settings may be stored in the wallet database 173190.

The recovery private key may be stored at 4725. In one implementation, the recovery private key may be stored in the wallet database 173190. For example, the recovery private key may be set via a MySQL database command similar to the following:

UPDATE wallet
SET recoveryPrivateKey = “determined recovery private key for the
MKADSD”
WHERE accountID = ID_MKADSD_1;

The MKADSD may be instantiated at 4729. For example, the MKADSD may be created and assigned to the user. In one implementation, one or more multisig addresses associated with the MKADSD may be generated using a command similar to the following:

```
addmultisigaddress 1
″′
  [
    “normal use public key”,
    ”recovery public key”
  ]
″′
```

In one implementation, transfer of crypto tokens via the MKADSD may be facilitated. For example, the user may add BTC crypto tokens to the MKADSD. In one implementation, trigger event recovery settings for the MKADSD may be set. For example, the user may specify trigger events and associated recovery settings for the MKADSD (e.g., using a crypto smart rule generated via the smart contract generator GUI and submitted to the block chain).

FIG. 48 shows a logic flow diagram illustrating embodiments of a crypto key recovery (CKR) component for the SOCOACT. In FIG. 48, a crypto key recovery request may be obtained at 4801. For example, the crypto key recovery request may be obtained as a result of receiving a trigger event message for a MKADSD of a user.

Trigger event data may be determined at 4805. In one implementation, the crypto key recovery request may be parsed (e.g., using PHP commands) to determine the trigger event data. For example, the type of the trigger event may be determined (e.g., TYPE_LOST). In another example, details associated with the trigger event (e.g., description, occurrence date and/or time) may be determined. In one implementation, different types of trigger events may have different details associated with them. For example, if the user lost the normal use private key associated with the MKADSD, event details may include information about when the user requested recovery of funds, which client device the user used, and/or the like. In another example, if a fraudulent transaction associated with the MKADSD has been detected, event details may include information about the transaction, location where the transaction originated, and/or the like.

Recovery settings for the trigger event may be determined at 4809. For example, recovery settings may specify a recovery action to take for each trigger event (e.g., based on the type of the trigger event, based on the details associated with the trigger event). In one implementation, the recovery settings for the trigger event may be retrieved from the wallet database 173190. For example, the recovery settings for the trigger event may be retrieved via a MySQL database command similar to the following:

SELECT recoverySettings
FROM wallet
WHERE accountID = ID_MKADSD_1 AND triggerEventType =
TYPE_LOST;

Recovery private key for the MKADSD may be determined at 4813. In one implementation, the recovery private key for the MKADSD may be retrieved from the wallet database 173190. For example, the recovery private key for the MKADSD may be retrieved via a MySQL database command similar to the following:

SELECT recoveryPrivateKey
FROM wallet
WHERE accountID = ID_MKADSD_1;

A determination may be made at 4817 whether the recovery private key for the MKADSD is encrypted. For example, this determination may be made based on a setting stored in the wallet database 173190. If the recovery private key is encrypted, a decryption key to decrypt the encrypted recovery private key may be obtained from a validation server at 4821 (e.g., based on validation server settings) and the encrypted recovery private key may be decrypted at 4825.

A recovery action associated with the trigger event may be facilitated at 4829. In one implementation, the recovery private key may be used to transfer crypto tokens from a multisig address associated with the MKADSD to a different address. For example, if the user lost the normal use private key for the MKADSD or if an attempt to make a fraudulent transaction has been detected, crypto tokens associated with the MKADSD may be transferred to a special SOCOACT recovery address from which the user may later retrieve the crypto tokens (e.g., upon providing proof of the user's identity and/or account ownership). In another example, if the user's child violates a geofence constraint by leaving an approved store at the mall, crypto tokens associated with the MKADSD of the child may be transferred to an address of the parent (e.g., to prevent the child from spending crypto tokens in a non-approved store). In another implementation, the recovery private key may be provided to the user (e.g., sent via a SOCOACT website or application, sent via email or SMS).

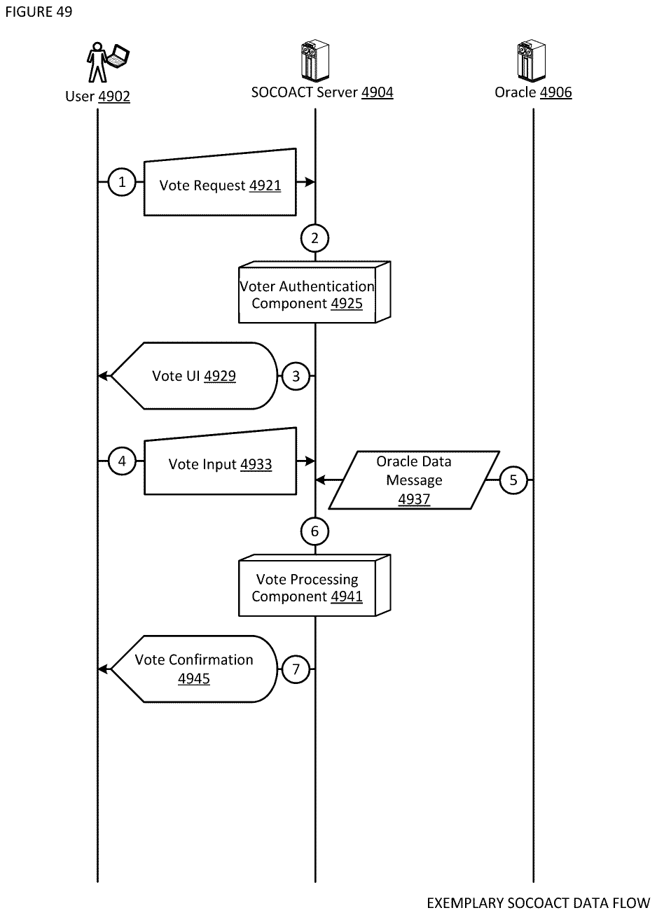

FIG. 49 shows a datagraph diagram illustrating embodiments of a data flow for the SOCOACT. In FIG. 49, a user 4902 (e.g., a voter) may use a client device (e.g., a desktop, a laptop, a tablet, a smartphone, a dedicated voting terminal) to send a crypto vote request 4921 to a SOCOACT Server 4904. For example, the user may wish to vote in a poll (e.g., a presidential election, a corporate action vote). In one implementation, the vote request may include data such as a request identifier, a user identifier, a poll identifier, authentication data, and/or the like. For example, the client may provide the following example vote request, substantially in the form of a HTTP(S) POST message including XML-formatted data, as provided below:

```
POST /vote_request.php HTTP/1.1
Host: www.server.com
Content-Type: Application/XML
Content-Length: 667
<?XML version = “1.0” encoding = “UTF-8”?>
<vote_request>
  <request_identifier>ID_request_1</request_identifier>
  <user_identifier>ID_user_1</user_identifier>
  <poll_identifier>ID_poll_1</poll_identifier>
  <authentication_data>authentication data for user (e.g., crypto
verification)</authentication_data>
</vote_request>
```

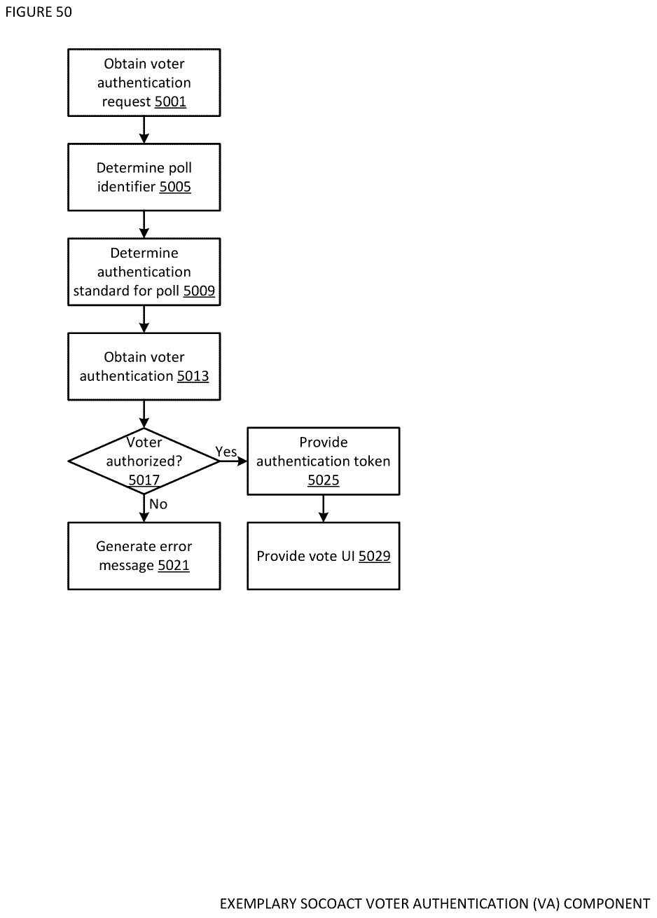

Vote request data may be used by a voter authentication (VA) component 4925 to facilitate authenticating the user and/or verifying that the user is authorized to participate in the poll. See FIG. 50 for additional details regarding the VA component.

The SOCOACT Server may provide a vote UI 4929 to the user. In various implementations, the vote UI may facilitate voting in the poll, allocating fractional votes to various options (e.g., to multiple candidates, to multiple corporate actions), specifying conditional voting selections (e.g., based on data from an oracle), specifying action voting (e.g., where the result of a conditional vote is an action such as a stock purchase), and/or the like. For example, the vote UI may be provided via a SOCOACT website or application (e.g., a mobile app).

The user may send a crypto vote input 4933 to the SOCOACT Server. For example, the user may provide vote selections via the vote UI. In one implementation, the vote input may include data such as a request identifier, a user identifier, a poll identifier, authentication data, vote selections, and/or the like. For example, the client may provide the following example vote input, substantially in the form of a HTTP(S) POST message including XML-formatted data, as provided below:

```
POST /vote_input.php HTTP/1.1
Host: www.server.com
Content-Type: Application/XML
Content-Length: 667
<?XML version = “1.0” encoding = “UTF-8”?>
<vote_input>
  <request_identifier>ID_request_2</request_identifier>
  <user_identifier>ID_user_1</user_identifier>
  <poll_identifier>ID_poll_1</poll_identifier>
  <authentication_data>authentication data for user (e.g., authentication
token)</authentication_data>
  <vote_selections>
    <vote_selection>
      <condition>Stock Price < $5</condition>
      <vote_outcome>Candidate A</vote_outcome>
    </vote_selection>
    <vote_selection>
      <condition>$5 ≤ Stock Price ≤ $7</condition>
      <vote_outcome>Candidate C</vote_outcome>
    </vote_selection>
    <vote_selection>
      <condition>Stock Price > $7</condition>
      <vote_outcome>50% for Candidate A</vote_outcome>
      <vote_outcome>50% for Candidate B</vote_outcome>
      <action>Buy 100 shares of Company X stock</action>
    </vote_selection>
  </vote_selections>
</vote_input>
```

An oracle 4906 may send an oracle data message 4937 to the SOCOACT Server. In one implementation, the provided oracle data may be utilized to determine the result of a conditional vote (e.g., of the vote stored on the blockchain in the form of a smart contract). For example, the oracle may provide the following example oracle data message, substantially in the form of a HTTP(S) POST message including XML-formatted data, as provided below:

```
POST /oracle_data_message.php HTTP/1.1
Host: www.server.com
Content-Type: Application/XML
Content-Length: 667
<?XML version = “1.0” encoding = “UTF-8”?>
<oracle_data_message>
  <source>Oracle - NASDAQ</source>
  <vote_address>1HnhWpkMHMjgt167kvgcPyurMmsCQ2WPgg</vote_address>
  <oracle_data>
    <stock_ticker>Company X stock ticker</stock_ticker>
    <price>$8 per share</price>
    <date_time>date and/or time of occurrence for the provided
price</date_time>
  </oracle_data>
</oracle_data_message>
```

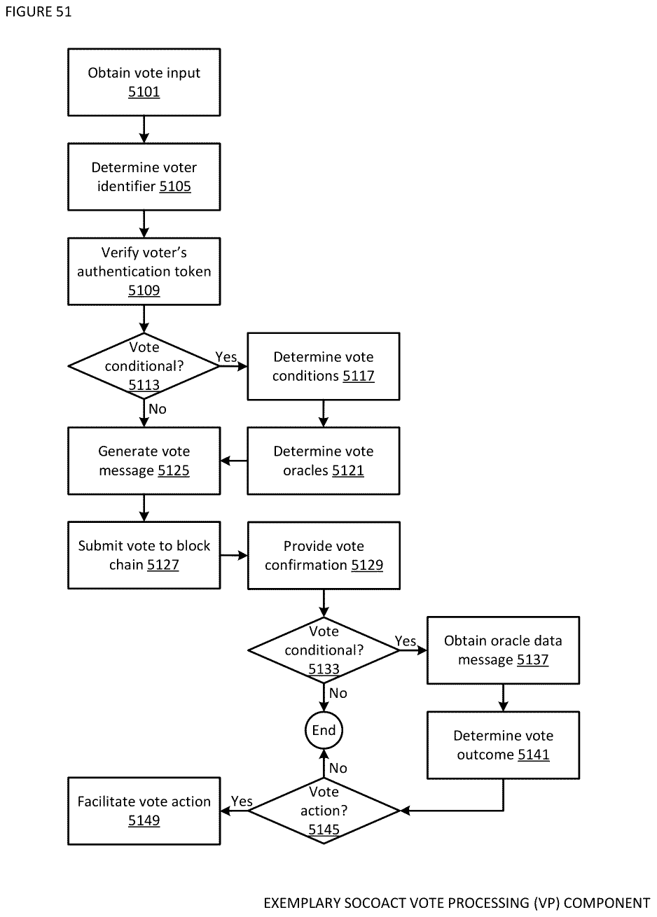

Vote input data and/or oracle data may be used by a vote processing (VP) component 4941 to facilitate determining the user's vote outcome and/or to facilitate a vote action associated with the vote outcome. See FIG. 51 for additional details regarding the VP component.

The SOCOACT Server may send a vote confirmation 4945 to the user to confirm that the user's vote was received. For example, the SOCOACT Server may provide the following example vote confirmation, substantially in the form of a HTTP(S) POST message including XML-formatted data, as provided below:

```
POST /vote_confirmation.php HTTP/1.1
Host: www.server.com
Content-Type: Application/XML
Content-Length: 667
<?XML version = “1.0” encoding = “UTF-8”?>
<vote_confirmation>
  <response_identifier>ID_response_2</response_identifier>
  <status>OK</status>
</vote_confirmation>
```

FIG. 50 shows a logic flow diagram illustrating embodiments of a voter authentication (VA) component for the SOCOACT. In FIG. 50, a voter authentication request may be obtained at 5001. For example, the voter authentication request may be obtained as a result of a user using a SOCOACT website or application to request access to vote in a poll (e.g., via a vote request).

A poll identifier for the poll may be determined at 5005. In one implementation, the voter authentication request may be parsed (e.g., using PHP commands) to determine the poll identifier.

Authentication standard for the poll may be determined at 5009. In one embodiment, the authentication standard may specify the kind of identity authentication that the user should provide to verify the user's identity (e.g., to prevent someone from impersonating the user, to prevent the user from voting multiple times). For example, the user may have to log into a SOCOACT account that was created based on the user providing proof of identity, such as the user's driver's license, social security card, and an authentication code sent to the user's smartphone. In another example, the user may have to satisfy a smart contract using a private key corresponding to a public key known to belong to the user. In one implementation, the authentication standard for the poll may be retrieved from a polls database 17319t. For example, the authentication standard for the poll may be retrieved via a MySQL database command similar to the following:

SELECT authenticationStandard
FROM Polls
WHERE pollID = ID_poll_1;

Voter authentication may be obtained at 5013. In one implementation, the user may provide login credentials to log into the SOCOACT account. In another implementation, the user may satisfy a smart contract by transferring a crypto token (e.g., provided by the SOCOACT) from a crypto address known to belong to the user (e.g., based on the user's public key) to a special SOCOACT vote address.

A determination may be made at 5017 whether the user is authorized to vote. In one implementation, if the user provides correct voter authentication data and/or the user did not yet vote, the user may be authorized to vote. In another implementation, an authorized voters setting associated with the poll may be checked to determine whether the user is authorized to vote (e.g., the user is on a voters list). For example, the user may have to be a shareholder of Company X to be authorized to vote in a corporate election poll. If the user is not authorized to vote, an error message may be generated at 5021. For example, the user may be informed that the user is not authorized to vote and/or may be asked to provide correct voter authentication data.

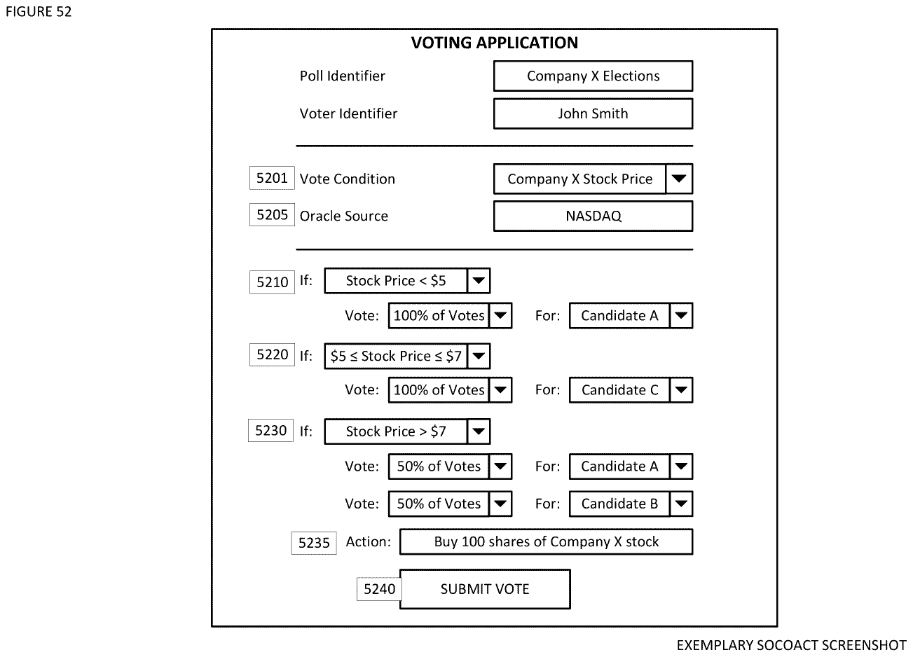

If it is determined that the user is an authorized voter, the user may be provided with an authentication token. In one implementation, the authentication token may be used by the user when casting the vote. For example, the authentication token may verify that the user is an authorized voter when the user provides vote input and/or may be used by the user to vote anonymously (e.g., the authentication token may not be linked to the user's identity). A vote UI may be provided to the user at 5029. In one implementation, the user may utilize the vote UI (e.g., a smart contract generator GUI) to provide vote input associated with the poll. See FIG. 52 for an example of a vote UI that may be utilized by the voter.

FIG. 51 shows a logic flow diagram illustrating embodiments of a vote processing (VP) component for the SOCOACT. In FIG. 51, a vote input may be obtained at 5101. For example, the vote input may be obtained as a result of a user casting a vote in a poll using a vote UI (e.g., using a SOCOACT website or application).

The user's voter identifier may be determined at 5105. In one implementation, the vote input may be parsed (e.g., using PHP commands) to determine the voter identifier (e.g., in a poll in which votes are not anonymous). The user's eligibility to vote may be verified at 5109. In one implementation, the user's authentication token may be verified to confirm that the authentication token is valid and/or authorizes the user to vote in the poll and/or is associated with the user's voter identifier.

A determination may be made at 5113 whether the vote submitted by the user is conditional. In one embodiment, the user's vote may not be conditional and may specify how the user voted as a fixed vote outcome. In another embodiment, the user's vote may be conditional and may specify that the user's vote depends on one or more conditions (e.g., the user's vote depends on oracle data to be provided by an oracle). In one implementation, the vote input may be parsed (e.g., using PHP commands) to determine whether the vote submitted by the user is conditional.

If it is determined that the user's vote is conditional, vote conditions associated with the user's vote (e.g., the user's vote changes depending on a company's closing stock price tomorrow) may be determined at 5117 and oracles associated with the vote conditions may be determined at 5121 (e.g., the stock price is to be provided by NASDAQ). In one implementation, the vote input may be parsed (e.g., using PHP commands) to determine vote conditions and/or oracles.

A vote message that specifies the user's vote (e.g., including vote outcomes, vote conditions, vote oracles, vote actions) may be generated at 5125 and submitted to the block chain at 5127 (e.g., stored in a votes database 17319u). In one embodiment, the vote message may be generated in a format compatible with submission to the block chain (e.g., as a blockchain transaction with the user's vote, as a smart contract with the user's vote outcome to be determined based on oracle data). For example, storing the user's vote on the blockchain may provide a permanent record of each user's vote and/or may facilitate tallying and/or auditing results of the poll. In some implementations, the block chain may be a permissioned ledger. In some implementation, the block chain may be public and the user's vote may be encrypted to restrict access to voting data to authorized users.

A vote confirmation may be provided to the user at 5129. The vote confirmation may be used to confirm that the user's vote was processed. For example, the vote confirmation may be displayed using a SOCOACT website or application (e.g., a mobile app).

A determination may be made at 5133 whether the vote submitted by the user is conditional. If so, oracle data for the vote may be obtained via an oracle data message from an oracle at 5137. It is to be understood that a wide variety of oracles may be utilized (e.g., stock exchanges, GPS data providers, date/time providers, crowdsourced decentralized data providers, news providers, activity monitors, RSS feeds, other oracles, etc.). In various embodiments, RSS feeds may be from sensor based devices such as a mobile phone (e.g., with data from many such devices aggregated into a feed), may be social network (e.g., Twitter, Facebook) or news feeds (e.g., which may be further filtered down by various parameters), may be market data feeds (e.g., Bloomberg's PhatPipe, Consolidated Quote System (CQS), Consolidated Tape Association (CTA), Consolidated Tape System (CTS), Dun & Bradstreet, OTC Montage Data Feed (OMDF), Reuter's Tib, Triarch, US equity trade and quote market data, Unlisted Trading Privileges (UTP) Trade Data Feed (UTDF), UTP Quotation Data Feed (UQDF), and/or the like feeds, e.g., via ITC 2.1 and/or respective feed protocols), and/or the like, and selecting an oracle may make a request to obtain the selected feed's data stream. In one implementation, a crowdsourced decentralized usage tracking provider may obtain (e.g., from smartphones of participating users) crowdsourced usage data (e.g., which soft drinks college students consume, which social media services people utilize), and provide such (e.g., combined) usage data for the vote. The obtained oracle data may be used to determine the vote outcome of the conditional vote at 5141. For example, the obtained oracle data may specify that the stock price is $8 per share, resulting in the vote outcome of 50% fractional vote for Candidate A and 50% fractional vote for Candidate B. In one implementation, this determination may be made based on the outcome of the smart contract used for the vote.

A determination may be made at 5145 whether the vote is associated with a vote action. If so, the vote action may be facilitated at 5149. It is to be understood that a wide variety of vote actions may be facilitated (e.g., restrict access to an account, release an extra key, purchase stock, vote in a certain way in another poll) based on the obtained oracle data and/or the vote outcome. In one implementation, a stock purchase and/or sale may be facilitated. For example, if the vote outcome is that the user makes a 50% fractional vote for Candidate A and 50% fractional vote for Candidate B, the vote action may be to purchase 100 shares of the company's stock. In another example, if usage data from a crowdsourced decentralized usage tracking provider oracle for the vote specifies that college students increased their consumption of Coke, the vote action may be to purchase shares of The Coca-Cola Company. In yet another example, stock purchases and/or sales may be facilitated by following stock purchases and/or sales (e.g., as specified in the obtained oracle data) of another entity (e.g., a mutual fund).

FIG. 52 shows a screenshot diagram illustrating embodiments of the SOCOACT. Using the shown vote UI, a user may provide vote input and the vote may be submitted. As illustrated in FIG. 52, a user, John Smith, may utilize the shown vote UI to vote in Company X elections. As illustrated at 5201, the user specified that the user's vote is conditional on Company X stock price (e.g., at the time the poll closes) as follows: as illustrated at 5210, if the stock price is less than $5 per share, the user wishes to vote for Candidate A; as illustrated at 5220, if the stock price is between $5 and $7 per share, the user wishes to vote for Candidate C; as illustrated at 5230, if the stock price is greater than $7 per share, the user wishes to use fractional voting (e.g., to allocate the user's voting power to multiple options in a specified way) and utilize 50% of the user's voting power to vote for Candidate A and 50% of the user's voting power to vote for Candidate B. Further, as illustrated at 5235, the user specified that if the stock price is greater than $7 per share, the user wishes to execute a vote action-buy 100 shares of Company X stock. It is to be understood that a vote condition may be based on any data provided by an oracle. As illustrated at 5205, the user selected NASDAQ as the oracle that provides Company X stock price for the vote condition. The Submit Vote button 5240 may be used by the user to submit the user's vote.

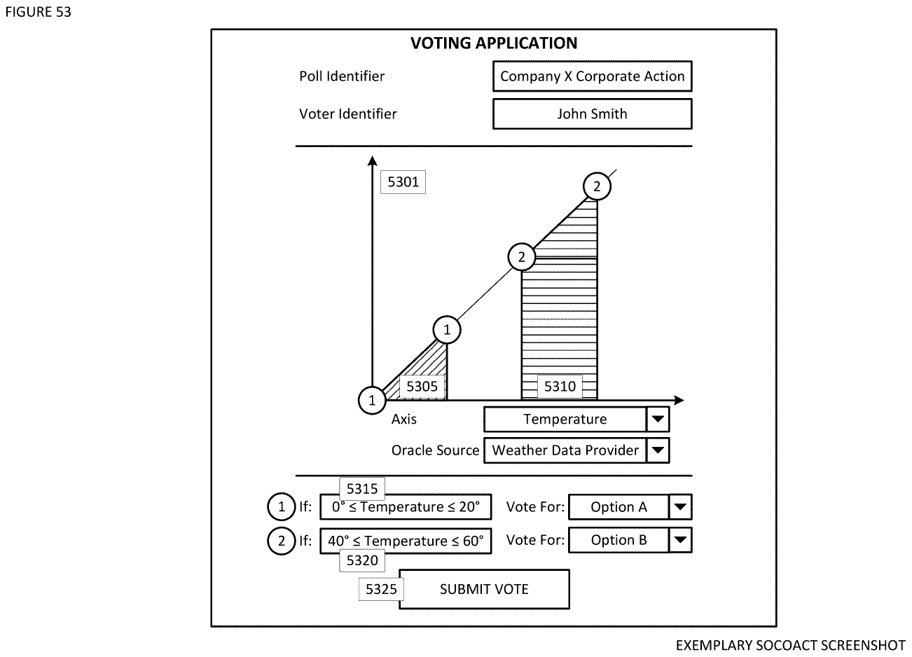

FIG. 53 shows a screenshot diagram illustrating embodiments of the SOCOACT. Using the shown vote UI, a user may provide vote input and the vote may be submitted. As illustrated in FIG. 53, a user, John Smith, may utilize the shown vote UI to vote for a Company X corporate action. The user may select and utilize a graph 5301 that shows temperate as provided by a weather data provider oracle to specify that the user's vote with regard to the corporate action is conditional on the temperature. For example, the temperate may be for a geographic region in which Company X grows crops (e.g., these crops may grow well or poorly depending on the temperature), and the user may wish to vote with regard to the corporate action involving these crops based on the reported temperature. The user's vote may be conditional on the temperature as follows: if the temperature is in the first range 5305 between 0 and 20 degrees, the user wishes to vote for Option A; if the temperature is in the second range 5310 between 40 and 60 degrees, the user wishes to vote for Option B. In one implementation, the user may utilize (e.g., click on) the graph to make these temperature range selections. For example, the user may select region 5305 on the graph to make the corresponding temperature range appear in box 5315, and the user may select region 5310 on the graph to make the corresponding temperature range appear in box 5320. The Submit Vote button 5325 may be used by the user to submit the user's vote.

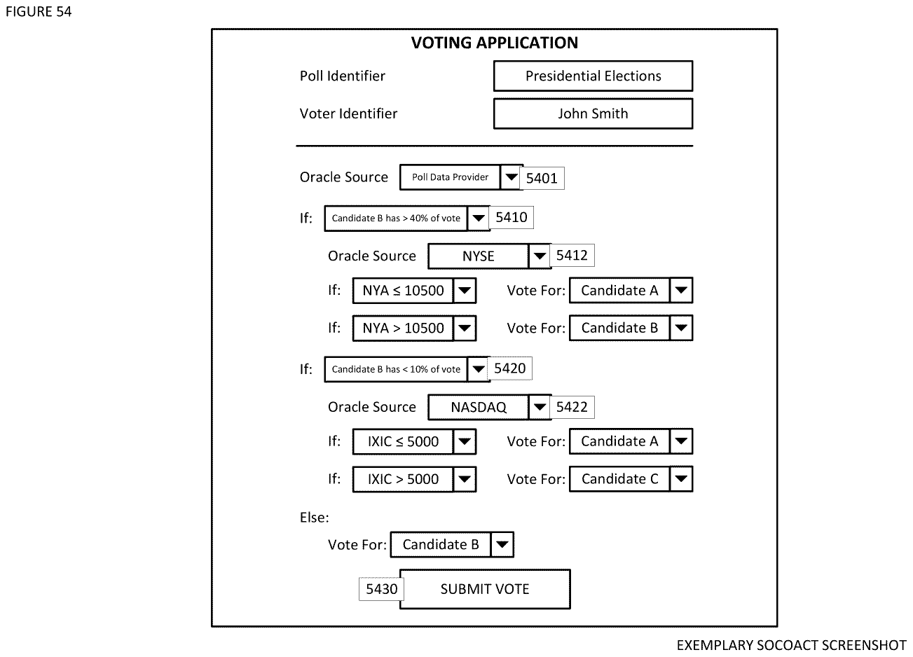

FIG. 54 shows a screenshot diagram illustrating embodiments of the SOCOACT. Using the shown vote UI, a user may provide vote input and the vote may be submitted. As illustrated in FIG. 54, a user, John Smith, may utilize the shown vote UI to vote in presidential elections. The user may specify that the user's vote is conditional using cascading oracle data. As illustrated, the user's vote is conditional on vote data from a poll data provider 5401. Further, for choices 5410 and 5420, the user's vote is further conditional on oracle data from NYSE 5412 and NASDAQ 5422, respectively. As illustrated, the user's vote is conditional as follows: if oracle data from a poll data provider indicates that Candidate B currently has more than 40% of the vote, then the user's vote depends on oracle data from NYSE regarding the NYSE Composite Index-if the index is less than or equal to 10,500 the user wishes to vote for Candidate A, if the index is greater than 10,500 the user wishes to vote for Candidate B; if oracle data from a poll data provider indicates that Candidate B currently has less than 10% of the vote, then the user's vote depends on oracle data from NASDAQ regarding the NASDAQ Composite Index-if the index is less than or equal to 5,000 the user wishes to vote for Candidate A, if the index is greater than 5,000 the user wishes to vote for Candidate C; otherwise, the user wishes to vote for Candidate B. It is to be understood that any number of cascading levels may be specified by the user based on oracle data (e.g., if the NYSE Composite Index is less than or equal to 10,500, the user's vote may be further broken down depending on additional oracle data). The Submit Vote button 5430 may be used by the user to submit the user's vote.

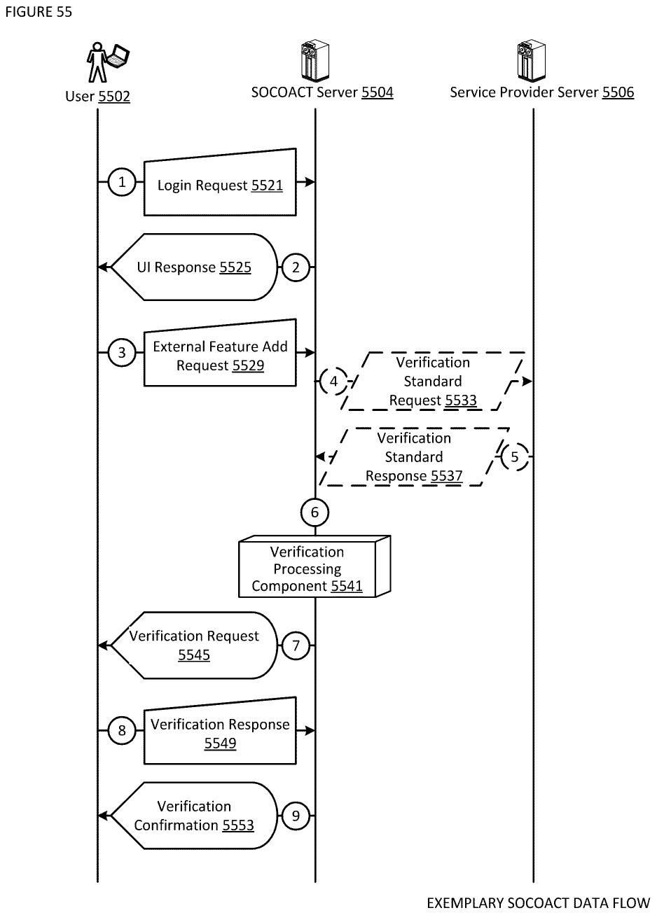

FIG. 55 shows a datagraph diagram illustrating embodiments of a data flow for the SOCOACT. In FIG. 55, a user 5502 may use a client device (e.g., a desktop, a laptop, a tablet, a smartphone) to send a login request 5521 to a SOCOACT Server 5504. For example, the user may wish to authenticate (e.g., provide login credentials) himself to make changes to the user's account (e.g., a participant account data structure stored in an accounts database 17319a). The SOCOACT Server may provide a UI Response 5525 to the authenticated user to facilitate user interaction with the account. For example, the UI Response may be provided via a SOCOACT website or application (e.g., a mobile app).

The user may send an external feature add request 5529 to the SOCOACT Server. For example, the user may request (e.g., via SOCOACT UI) that an account data structure datastore (e.g., a third party electronic wallet) be added to the user's account. In one implementation, the external feature add request may include data such as a request identifier, a user identifier, an external feature request type, an external feature identifier, a verification address, a linked service identifier, and/or the like. For example, the client may provide the following example external feature add request, substantially in the form of a HTTP(S) POST message including XML-formatted data, as provided below:

```
POST /external_feature_add_request.php HTTP/1.1
Host: www.server.com
Content-Type: Application/XML
Content-Length: 667
<?XML version = “1.0” encoding = “UTF-8”?>
<external_feature_add_request>
  <request_identifier>ID_request_1</request_identifier>
  <user_identifier>ID_user_1</user_identifier>
  <account_identifier>ID_account_1</account_identifier>
  <external_feature_request_type>TYPE_ADD_EXTERNAL_ADSD</external_feature_requ
est_type>
  <external_feature_identifier>ID_External_ADSD_1</external_feature_identifier
>
  <verification_address>1HnhWpkMHMjgt167kvgcPyurMmsCQ2WPgg</verification_addre
ss>
  <linked_service_identifier>ID_voting_application_1</linked_service_identifie
r>
</external_feature_add_request>
```

The SOCOACT Server may send a verification standard request 5533 to a service provider server 5506. For example, a linked service provider may provide a linked service (e.g., a voting application) and may specify a verification standard (e.g., confirm the user's location) associated with allowing the user to utilize an external feature (e.g., a third party wallet) via the user's account when interacting with the linked service (e.g., to use the third party wallet for voter authentication). In one implementation, the verification standard request may include data such as a request identifier, a service identifier, a request type, and/or the like. For example, the SOCOACT Server may provide the following example verification standard request, substantially in the form of a HTTP(S) POST message including XML-formatted data, as provided below:

```
POST /verification_standard_request.php HTTP/1.1
Host: www.server.com
Content-Type: Application/XML
Content-Length: 667
<?XML version = “1.0” encoding = “UTF-8”?>
<verification_standard_request>
  <request_identifier>ID_request_2</request_identifier>
  <service_identifier>ID_voting_application_1</service_identifier>
  <request_type>TYPE_GET_VERIFICATION_STANDARD</request_type>
</verification_standard_request>
```

The service provider server may send a verification standard response 5537 to the SOCOACT Server. For example, the verification standard response may specify the verification standard utilized by the service. In one implementation, the verification standard response may include data such as a request identifier, a service identifier, voting standard data, and/or the like. For example, the service provider server may provide the following example verification standard response, substantially in the form of a HTTP(S) POST message including XML-formatted data, as provided below:

```
POST /verification_standard_response.php HTTP/1.1
Host: www.server.com
Content-Type: Application/XML
Content-Length: 667
<?XML version = “1.0” encoding = “UTF-8”?>
<verification_standard_response>
  <request_identifier>ID_response_2</request_identifier>
  <service_identifier>ID_voting_application_1</service_identifier>
  <verification_standard_data>
    <item>use base SOCOACT verification</item>
    <item>use additional location verification</item>
  </verification_standard_data>
</verification_standard_response>
```

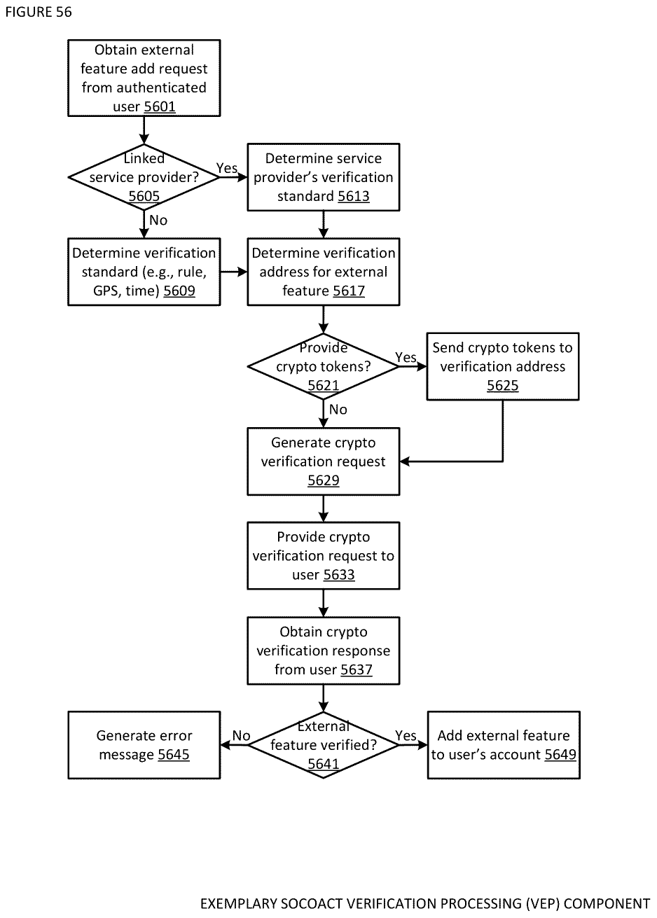

External feature add request data and/or verification standard response data may be used by a verification processing (VEP) component 5541 to facilitate verifying that the external feature (e.g., an electronic wallet) is associated with the user (e.g., belongs to the user) and/or adding the external feature to the user's account (e.g., facilitating the use of the external feature with a linked service). See FIG. 56 for additional details regarding the VEP component.

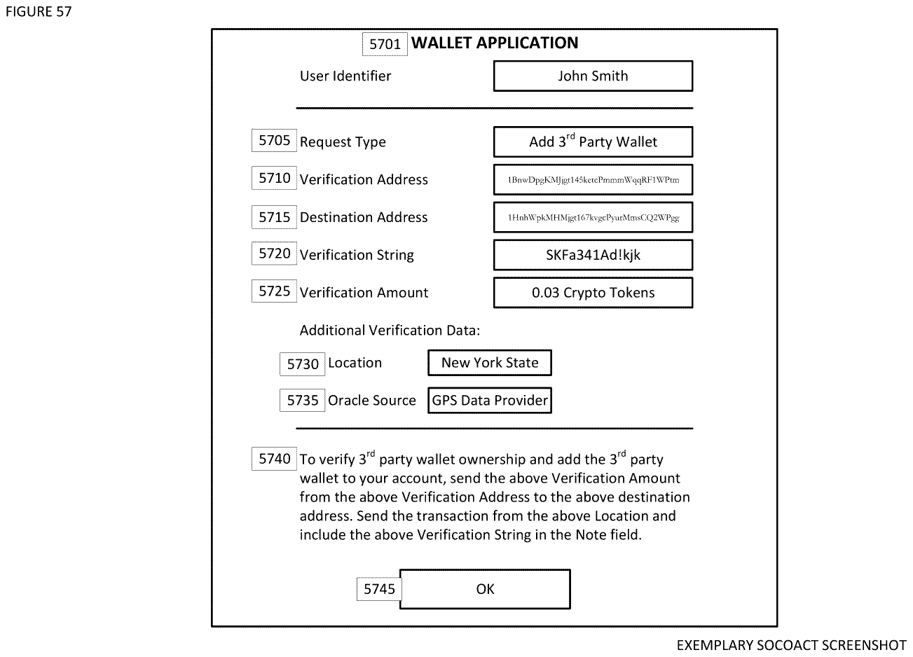

The SOCOACT Server may send a crypto verification request 5545 to the user. In one embodiment, the SOCOACT Server may request that the user verify that the user has control over the external feature and/or may specify how the user should provide verification. See FIG. 57 for an example of a GUI that may be used to provide the crypto verification request to the user.

The user may send a crypto verification response 5549 to the SOCOACT Server. In one embodiment, the user may submit a verification transaction to the block chain to provide the crypto verification response. For example, the user may execute a transaction (e.g., via a GUI associated with the third party wallet), which includes a verification string (e.g., in a note field), to transfer a verification amount from a verification address to a SOCOACT destination address.

A verification confirmation may be provided to the user at 5553. The verification confirmation may be used to confirm that the external feature was added to the user's account. For example, the verification confirmation may be displayed using a SOCOACT website or application (e.g., a mobile app).

FIG. 56 shows a logic flow diagram illustrating embodiments of a verification processing (VEP) component for the SOCOACT. In FIG. 56, an external feature add request may be obtained from an authenticated user at 5601. For example, the external feature add request may be obtained as a result of a user using a SOCOACT website or application to request that an external feature (e.g., a third party wallet) be added to the user's account. Accordingly, the VEP component may be utilized to verify that the user has control over the external feature (e.g., to prevent fraud).

A determination may be made at 5605 whether a linked service provider is associated with the external feature add request. In one implementation, the external feature add request may be parsed (e.g., using PHP commands) to make this determination. If it is determined that there is no linked service provider, verification standard associated with the user's account may be determined at 5609. In various embodiments, the verification standard may specify that the user should submit to the block chain a verification transaction that includes one or more of: a verification string, a verification amount, location data, a time stamp, metadata, UI triggerables, and/or the like. In some embodiments, the verification standard may specify that the verification transaction should satisfy a crypto smart rule (e.g., generated via the smart contract generator GUI). For example, the crypto smart rule (e.g., a smart contract) may specify that the verification transaction should include a verification string and the location from which the verification transaction was submitted, and that the location should be obtained from an oracle associated with the crypto smart rule (e.g., GPS data from the user's client). In one implementation, the verification standard associated with the user's account may be retrieved from an accounts database 17319a. For example, the verification standard associated with the user's account may be retrieved via a MySQL database command similar to the following:

SELECT accountVerificationStandard
FROM accounts
WHERE accountID = ID_account_1;

If it is determined that there is a linked service provider, the linked service provider's verification standard may be determined at 5613. In one embodiment, the linked service provider's verification standard may specify that a default SOCOACT verification standard should be used. In another embodiment, the linked service provider's verification standard may modify or replace the default SOCOACT verification standard as specified by the linked service provider. In one implementation, the linked service provider's verification standard may be obtained from a service provider server.

A verification address for the external feature may be determined at 5617. In one embodiment, the verification address is associated with the external feature (e.g., the verification address is one of the addresses associated with the third party wallet) and control over the verification address may signify control over the external feature (e.g., control over the verification address signifies control over the third party wallet). In one implementation, the external feature add request may be parsed (e.g., using PHP commands) to determine a user specified verification address. In another implementation, a verification address may be determined as a crypto address known to be associated with the external feature (e.g., based on a public key associated with the external feature).

A determination may be made at 5621 whether to provide crypto tokens for the verification transaction. For example, as part of the verification process, one or more crypto tokens (e.g., a verification data parameter) may be sent to the third party wallet and the user may be requested to send these crypto tokens back via the verification transaction. In one implementation, this determination may be made based on the determined verification standard. If it is determined that crypto tokens should be provided, the crypto tokens may be sent to the verification address at 5625. For example, crypto tokens worth $0.03 may be sent to the verification address. In another example, encrypted crypto token data (e.g., encrypted with a public key associated with the external feature) may be sent, and the user may be requested to decrypt the crypto token data (e.g., using the corresponding private key associated with the external feature) and send the decrypted crypto token data back via the verification transaction. In an alternative embodiment, the user may be requested to send one or more crypto tokens from the verification address via the verification transaction, and the crypto tokens may then be returned to the user.

A crypto verification request may be generated at 5629. In one embodiment, generating the crypto verification request may include determining verification request parameters (e.g., in accordance with the determined verification standard). In one implementation, a verification string (e.g., a captcha) for the verification request may be determined. For example, the verification string may be randomly generated. In another implementation, other verification data parameters (e.g., location, time stamp, metadata) may be determined. For example, allowed locations from which the user may submit the verification transaction (e.g., based on the user's residency) and the oracle that will provide location data may be determined. In another example, acceptable time stamp range for the verification transaction may be determined (e.g., the user is allowed to submit the verification transaction within 24 hours after the crypto verification request is generated). In yet another example, permitted metadata for the verification transaction may be determined (e.g., metadata should indicate that the verification transaction was submitted using a client device known to belong to the user, such as based on the unique identifiers of the user's client devices). In yet another implementation, a SOCOACT destination address for the verification transaction may be determined. For example, the user may be requested to transfer one or more crypto tokens (e.g., having monetary value, having specified data) from the verification address to the SOCOACT destination address via the verification transaction. In another embodiment, generating the crypto verification request may include instantiating a smart contract on the block chain. For example, the smart contract may be configured to be satisfied upon receipt of the verification transaction that is configured in accordance with instructions specified in the crypto verification request.

The crypto verification request may be provided to the user at 5633. In one embodiment, the crypto verification request may specify how the user should provide verification of control over the external feature in accordance with the determined verification request parameters. In various implementations, the crypto verification request may be displayed using a SOCOACT website or application (e.g., a mobile app), sent via email or SMS, and/or the like. See FIG. 57 for an example of a GUI that may be used to provide the crypto verification request to the user.

A crypto verification response may be obtained from the user at 5637. In one embodiment, user submission of the verification transaction to the block chain (e.g., in accordance with instructions specified in the crypto verification request) may be detected. In one implementation, transfer of crypto tokens to the SOCOACT destination address may be monitored, and the associated verification transaction may be analyzed.

A determination may be made at 5641 whether the verification transaction indicates that the user verified having control over the external feature. In one implementation, the verification transaction may be parsed to determine whether the specified verification request parameters have been satisfied. For example, the verification transaction may be parsed to determine whether the verification string is included in a note field. In another example, the verification transaction may be parsed to determine whether the verification transaction was submitted from an allowed location (e.g., as reported by an oracle). If control over the external feature has not been verified, an error message may be generated for the user at 5645. For example, the user may be informed that the user failed to verify control over the external feature and/or may be asked to resubmit the verification transaction to the block chain in accordance with instructions specified in the crypto verification request.

If control over the external feature has been verified, the external feature may be added to the user's account at 5649. For example, the external feature may be added via a MySQL database command similar to the following:

UPDATE accounts
SET accountExternalFeatures = “add the verified external feature to
the set of allowed external features”
WHERE accountID = ID_account_1;

In one implementation, the user may utilize the external feature via the user's account. For example, the user may log into the account and utilize a third party electronic wallet as the payment method for an action to buy shares for a conditional vote in a voting application.

FIG. 57 shows a screenshot diagram illustrating embodiments of the SOCOACT. Using the shown vote UI, a user may be shown crypto verification request instructions regarding how the user should provide verification of control over an external feature. As illustrated at 5701, the user's account is associated with a wallet application. As illustrated at 5705, the user requested that a third party wallet be added to the user's account. For example, the user may wish to use the account to consolidate the user's electronic wallets, so that the user may utilize either the associated wallet or any other third party wallet when paying for transactions using the account. As illustrated at 5710, the third party wallet is associated with a verification address. For example, transferring crypto tokens from the verification address may verify third party wallet ownership. As illustrated at 5715, a destination address where crypto tokens should be transferred may be specified. For example, the destination address may be a special SOCOACT address utilized to receive verification crypto tokens. As illustrated at 5720, a verification string may be specified. For example, the verification string (e.g., a captcha) should be included by the user in a specified field of a crypto verification response. As illustrated at 5725, a verification amount may be specified. For example, the verification amount may be sent to the user (e.g., once the user clicks on the OK button 5745) and the user may be requested to return the verification amount from the verification address. Additional verification data may also be requested from the user. As illustrated at 5730, the user's location may be requested to be included in the crypto verification response. For example, the user may be requested to send the crypto verification response from New York State. As illustrated at 5735, an oracle may be specified by the SOCOACT for reporting the location from which the crypto verification response is sent. For example, a smart contract associated with the crypto verification request may be instantiated (e.g., once the user clicks on the OK button 5745) with the specified oracle. As illustrated at 5740, the user may be given detailed instructions regarding how the user should provide verification of control over the third party wallet.

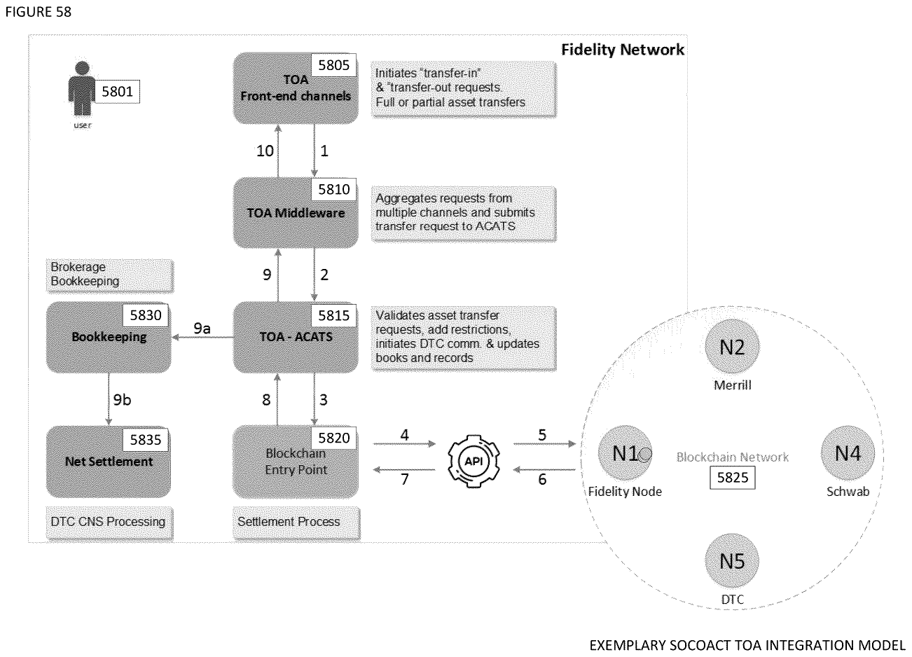

FIG. 58 shows an exemplary transfer of assets (TOA) integration model for the SOCOACT. In FIG. 58, a model of how SOCOACT crypto asset transfer may be integrated into a brokerage platform to facilitate broker to broker TOA is illustrated. In one embodiment, the brokerage platform may include components such as: TOA front-end channels 5805 that a user 5801 may utilize to initiate transfer-in and/or transfer-out requests (e.g., full asset transfers, partial asset transfers); TOA middleware 5810 that aggregates requests from multiple channels and submits transfer requests; and TOA-ACATS 5815 that validates TOA requests, adds restrictions, initiates communication with an agency (e.g., The Depository Trust Company (DTC)), and updates books and records. The blockchain entry point component 5820 integrates with the TOA-ACATS component, and may utilize API calls to facilitate utilization of blockchain network 5825 for settlement of transfer-in and/or transfer-out requests. In one implementation, the agency (e.g., DTC) may utilize the SOCOACT for crypto asset transfer. As such, the DTC may have a blockchain node N5 in the blockchain network. In another implementation, the agency (e.g., DTC) may not utilize the SOCOACT for crypto asset transfer. As such, the brokerage platform may include components such as: bookkeeping 5830 that facilitates brokerage bookkeeping; and net settlement 5835 that facilitates DTC Continuous Net Settlement (CNS) processing.

In one embodiment, when facilitating TOA, a delivering broker (e.g., Fidelity via Fidelity node N1), a receiving broker (e.g., Merrill via Merrill node N2), and the agency (e.g., DTC via DTC node N5) may have full visibility regarding the asset transfer. Other listener nodes (e.g., Schwab node N4) may have a copy of the transaction, but the transaction may be encrypted, such that the data is inaccessible to other brokers.

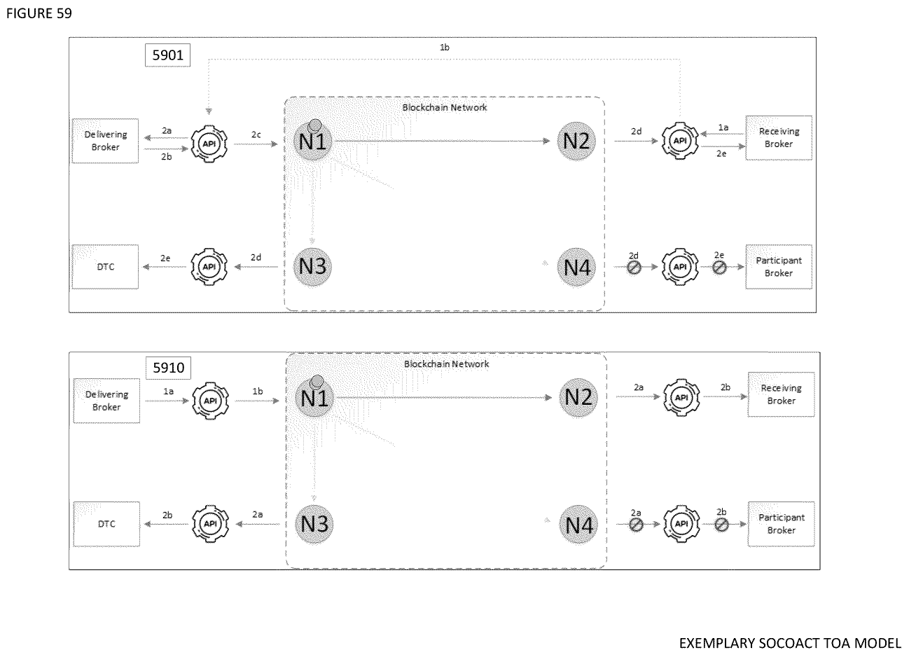

FIG. 59 shows an exemplary TOA model for the SOCOACT. Screen 5901 illustrates a model of receiving broker initiated TOA. At 1a, a receiving broker initiates an asset transfer, interacting with APIs connecting to a blockchain network. At 1b, an API call is made to a contra broker (e.g., a delivering broker) and a wallet address where the deposited assets are to be received is provided to the contra broker. At 2a, the API interacts with the contra broker's books and records to determine whether to accept or reject the transfer. At 2b, if approved, the contra broker deposits assets to the provided wallet address of the receiving broker by making a call to the API. At 2c, once the transfer transaction is committed, the transaction is broadcast to the blockchain network for nodes of the blockchain network to accept the state change. At 2d, node N2, of the receiving broker, receives the asset deposit; node N3, of the DTC, receives the transaction and can read the asset settlement data; node N4, of another broker, receives the transaction but cannot read the asset settlement data. At 2e, the receiving broker and/or the DTC update their books and/or records in accordance with the transfer.

Screen 5910 illustrates a model of delivering broker initiated TOA. At 1a, a delivering broker initiates an asset transfer, interacting with APIs connecting to a blockchain network. At 1b, node N1, of the delivering broker, commits a transaction depositing assets into a receiving broker's wallet (e.g., to the omnibus wallet address associated with the receiving broker). At 2a, the transaction is broadcast to nodes of the blockchain network to accept the state change. Node N2, of the receiving broker, receives the asset deposit; node N3, of the DTC, receives the transaction and can read the asset settlement data; node N4, of another broker, receives the transaction but cannot read the asset settlement data. At 2b, the receiving broker and/or the DTC update their books and/or records in accordance with the transfer. If assets are not acceptable, the receiving broker may reject the transfer and deposit the assets back to the delivering address (e.g., to the omnibus wallet address associated with the delivering broker).

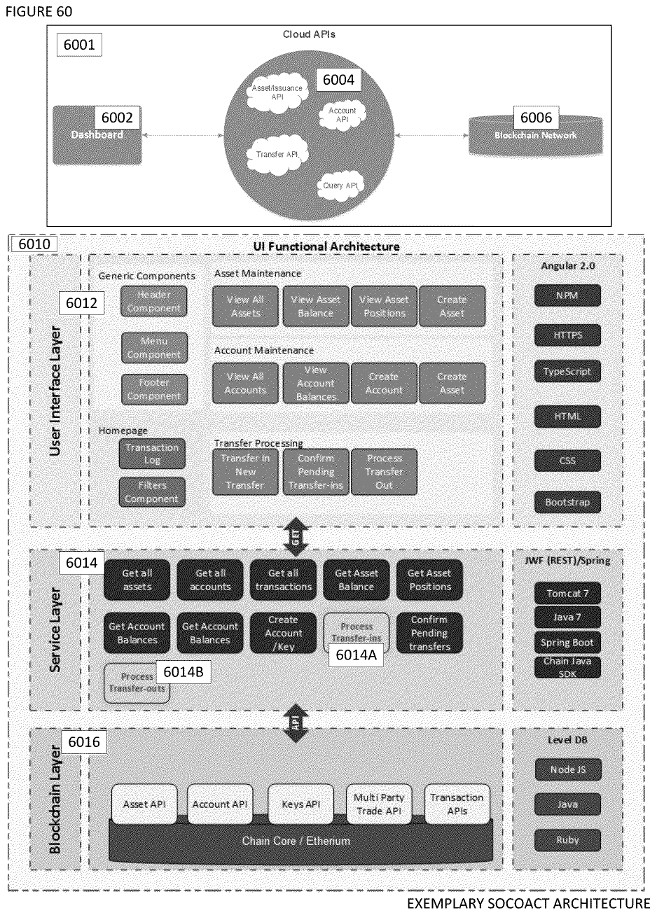

FIG. 60 shows an exemplary architecture for the SOCOACT. Screen 6001 illustrates that a TOA architecture may include components such as: a dashboard 6002 that may be used by a user to initiate TOA; cloud APIs 6004 that may be utilized to facilitate TOA via a blockchain network; and a blockchain network 6006 that may be utilized to implement a permissioned ledger.

Screen 6010 illustrates that a TOA UI functional architecture may include components such as: a user interface layer 6012 that allows a user initiate TOA; a service layer 6014 (e.g., including a process transfer-ins component 6014A and a process transfer-outs component 6014B) that facilitates transforming UI requests into API calls (e.g., to facilitate transfer-ins and/or transfer-outs); and a blockchain layer 6016 that facilitates implementing a permissioned ledger (e.g., based on a blockchain platform such as Chain Core, Etherium, and/or the like).

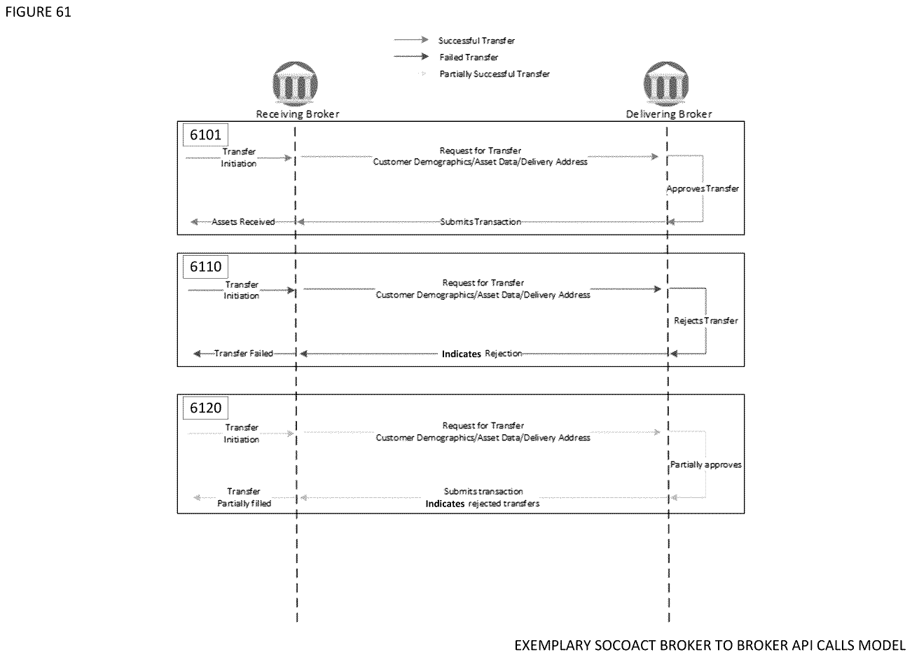

FIG. 61 shows an exemplary broker to broker API calls model for the SOCOACT. Screen 6101 illustrates how an approved TOA may be processed. Transfer initiation may occur at the receiving broker. The receiving broker may send (e.g., via an API call) a request for transfer to the delivering broker. The request for transfer may include data such as customer demographics, asset data (e.g., description of assets to be transferred), delivery address, and/or the like. The delivering broker may utilize (e.g., verify) data provided in the request for transfer to approve (e.g., customer demographics match and assets may be transferred) the transfer. The delivering broker may submit (e.g., via a blockchain network) a transfer transaction, and the receiving broker may be notified that the assets were received.

Screen 6110 illustrates how a rejected TOA may be processed. Transfer initiation may occur at the receiving broker. The receiving broker may send (e.g., via an API call) a request for transfer to the delivering broker. The request for transfer may include data such as customer demographics, asset data (e.g., description of assets to be transferred), delivery address, and/or the like. The delivering broker may utilize (e.g., verify) data provided in the request for transfer to reject (e.g., customer demographics do not match) the transfer. The delivering broker may indicate that the transfer was rejected, and the receiving broker may be notified that the transfer failed.

Screen 6120 illustrates how a partially approved TOA may be processed. Transfer initiation may occur at the receiving broker. The receiving broker may send (e.g., via an API call) a request for transfer to the delivering broker. The request for transfer may include data such as customer demographics, asset data (e.g., description of assets to be transferred), delivery address, and/or the like. The delivering broker may utilize (e.g., verify) data provided in the request for transfer to partially approve (e.g., customer demographics match but some of the assets are nontransferable) the transfer. The delivering broker may submit (e.g., via a blockchain network) a transfer transaction that transfers transferable assets and may indicate nontransferable assets that were not transferred, and the receiving broker may be notified that the transfer was partially filled.

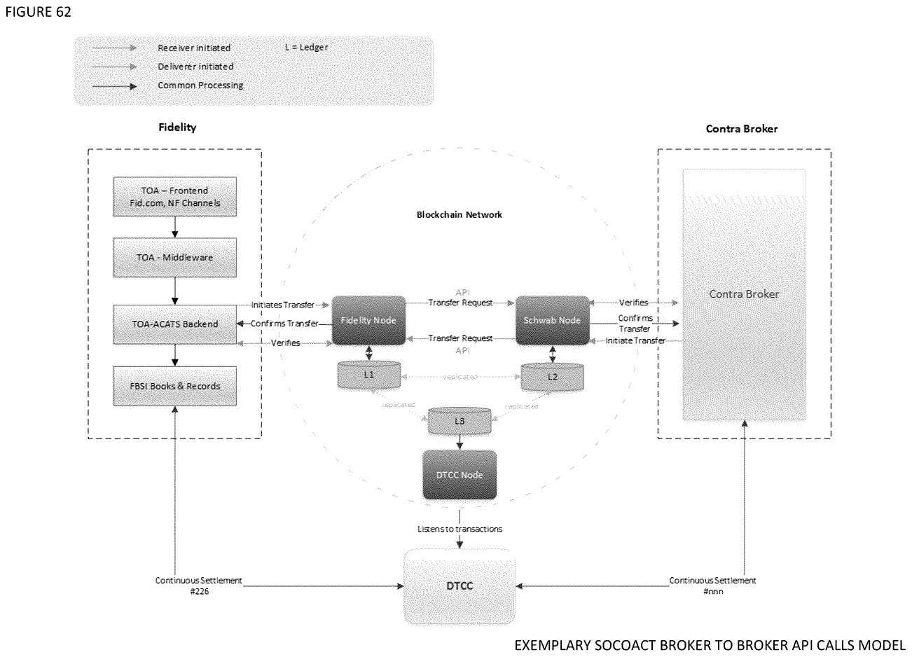

FIG. 62 shows an exemplary broker to broker API calls model for the SOCOACT. As illustrated in FIG. 62, either a receiving broker (e.g., a contra broker) or a delivering broker (e.g., Fidelity) may initiate a TOA. A blockchain network node of the initiating broker may send a transfer request via an API call to a blockchain network node of the other broker that is a party to the TOA. The other broker may verify that the transfer should be approved and/or may submit a transfer transaction to the blockchain, and the blockchain network nodes may confirm the transfer to the brokers.

The permissioned ledger maintained by the blockchain network is replicated among the various blockchain network nodes. A blockchain network node of an agency (e.g., DTCC) associated with the blockchain network may facilitate agency interaction (e.g., wallet administration, asset definition administration, asset issuance administration, and/or the like) with the blockchain network.

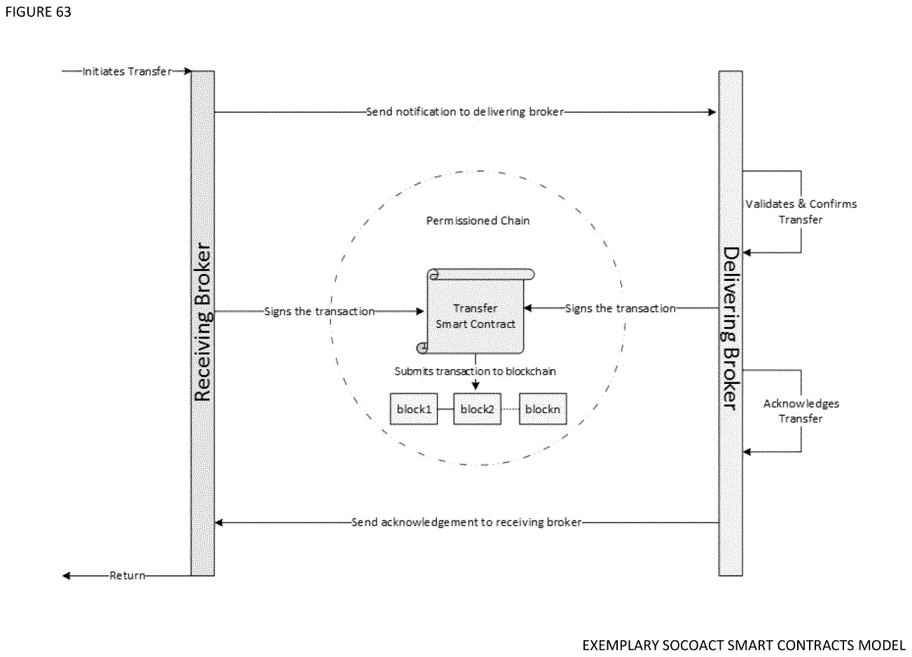

FIG. 63 shows an exemplary smart contracts model for the SOCOACT. As illustrated in FIG. 63, transfer initiation may occur at the receiving broker. The receiving broker may generate and sign a smart contract that facilitates asset transfer, and may send a TOA notification to the delivering broker. The TOA notification may include a contract address of the smart contract. The delivering broker may utilize (e.g., verify) data provided in the TOA notification and/or in the smart contract to approve the transfer, and may sign the smart contract to facilitate the transfer. The delivering broker may send a TOA acknowledgement to the receiving broker to indicate that the delivering broker signed the smart contract.

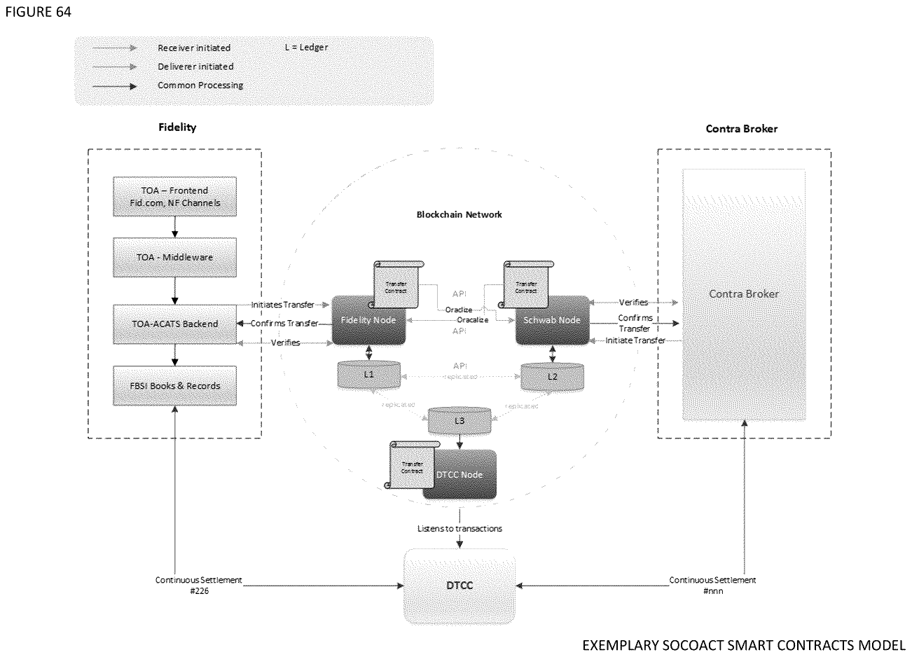

FIG. 64 shows an exemplary smart contracts model for the SOCOACT. As illustrated in FIG. 64, either a receiving broker (e.g., a contra broker) or a delivering broker (e.g., Fidelity) may initiate a TOA. A blockchain network node of the initiating broker may generate (e.g., on the blockchain) and sign a smart contract that facilitates asset transfer (e.g., via an API call). The smart contract may utilize a blockchain network node of the other broker that is a party to the TOA as an oracle that provides a signature (e.g., the signature may be the oracle data that unlocks the smart contract). The other broker may verify that the transfer should be approved and may sign the smart contract to facilitate the transfer (e.g., once both signatures are obtained the assets will move to the delivery address of the receiving broker), and the blockchain network nodes may confirm the transfer to the brokers.

The permissioned ledger maintained by the blockchain network is replicated among the various blockchain network nodes. A blockchain network node of an agency (e.g., DTCC) associated with the blockchain network may facilitate agency interaction (e.g., wallet administration, asset definition administration, asset issuance administration, and/or the like) with the blockchain network.

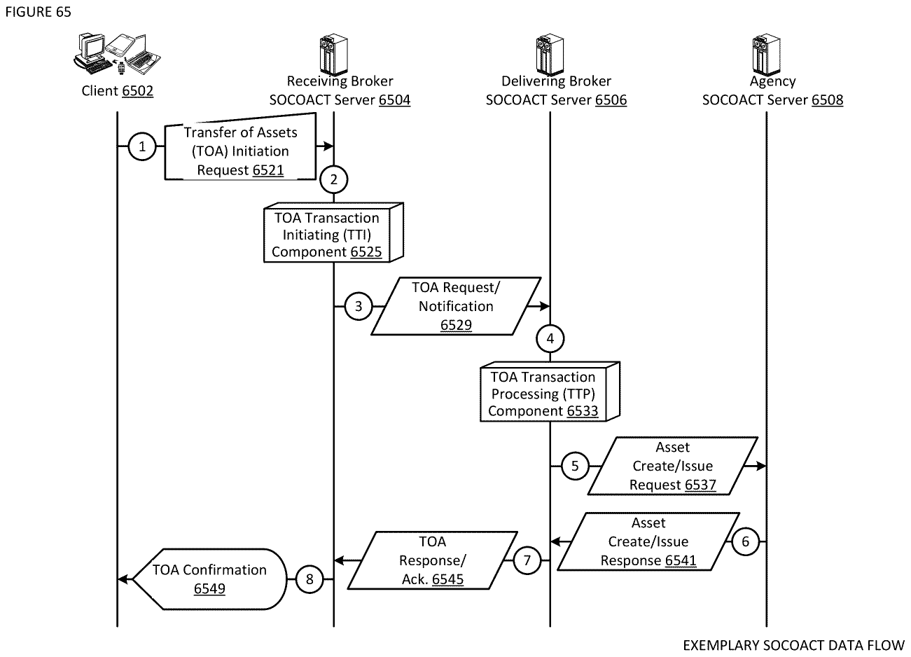

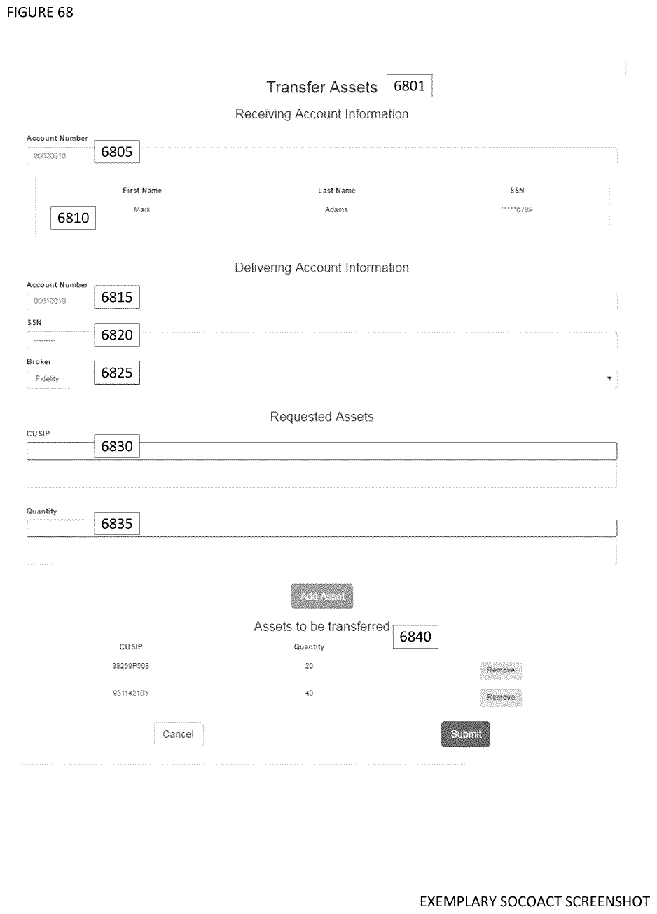

FIG. 65 shows a datagraph diagram illustrating embodiments of a data flow for the SOCOACT. In FIG. 65, a client 6502 (e.g., of a user associated with a receiving broker) may send a TOA initiation request 6521 to a receiving broker SOCOACT server 6504 to facilitate TOA of a customer's assets from a delivering broker to the receiving broker. For example, the client may be a desktop, a laptop, a tablet, a smartphone, and/or the like that is executing a client application. See FIG. 68 for an example of a GUI that may be utilized by the user to submit the TOA initiation request. In one implementation, the TOA initiation request may include data such as a request identifier, request type (e.g., full TOA, partial TOA), receiving broker information, delivering broker information, customer information, information regarding assets to be transferred, and/or the like. In one embodiment, the client may provide the following example TOA initiation request, substantially in the form of a HTTP(S) POST message including XML-formatted data, as provided below:

```
POST /TOA_initiation_request.php HTTP/1.1
Host: www.server.com
Content-Type: Application/XML
Content-Length: 667
<?XML version = “1.0” encoding = “UTF-8”?>
<TOA_initiation_request>
  <request_identifier>ID_request_1</request_identifier>
  <request_type>FULL_TOA</request_type>
  <receiving_broker_identifier>ID_broker_1</receiving_broker_identifier>
  <delivering_broker_identifier>ID_broker_2</delivering_broker_identifier>
  <customer_first_name>John</customer_first_name>
  <customer_last_name>Smith</customer_last_name>
  <customer_receiving_broker_account>ID_account_101</customer_receiving_broker
_account>
  <customer_delivering_broker_account>ID_account_201</customer_delivering_brok
er_account>
  <requested_assets>
    <asset>
      <CUSIP>38259P508</CUSIP>
      <Symbol>GOOGL</Symbol>
      <Description>Google Corporation</Description>
      <Quantity>20 Shares</Quantity>
    </asset>
    <asset>
      <CUSIP>931142103</CUSIP>
      <Symbol>WMT</Symbol>
      <Description>Walmart Stores INC</Description>
      <Quantity>40 Shares</Quantity>
    </asset>
  </requested_assets>
</TOA_initiation_request>
```

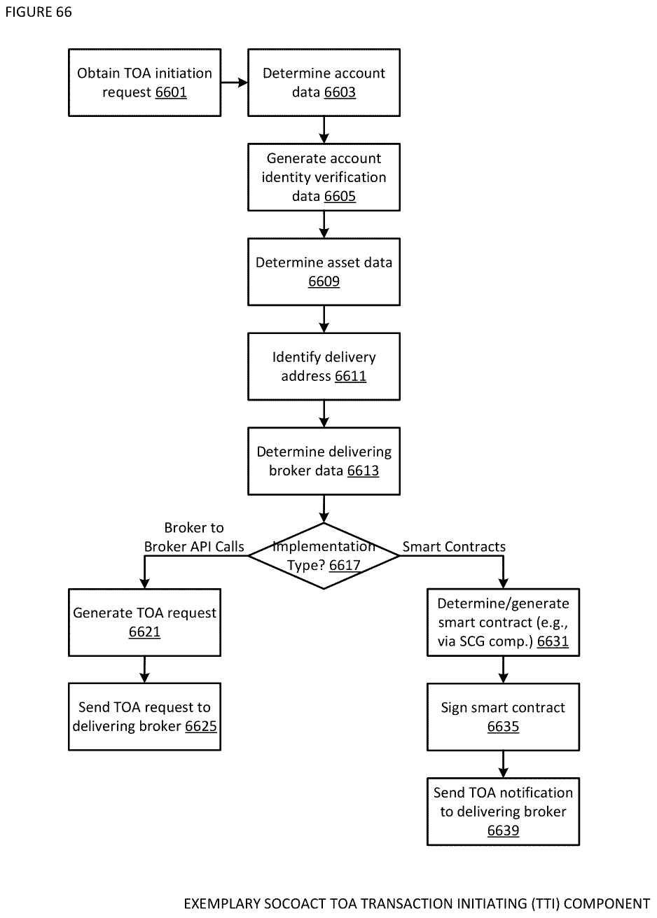

A TOA transaction initiating (TTI) component 6525 may utilize data provided in the TOA initiation request to, when utilizing a broker to broker API calls implementation, facilitate generating and sending a TOA request to the delivering broker, or, when utilizing a smart contracts implementation, to facilitate generating a smart contract and sending a TOA notification to the delivering broker. See FIG. 66 for additional details regarding the TTI component.

In one embodiment, when utilizing a broker to broker API calls implementation, the receiving broker SOCOACT server may send a TOA request 6529 to a delivering broker SOCOACT server 6506 to facilitate the TOA. In one implementation, the TOA request may include data such as a request identifier, request type, receiving broker information, delivery address of the receiving broker, account identity verification data, customer information, information regarding assets to be transferred, and/or the like. In one embodiment, the receiving broker SOCOACT server may provide the following example TOA request, substantially in the form of a HTTP(S) POST message including XML-formatted data, as provided below:

```
POST /TOA_request.php HTTP/1.1
Host: www.server.com
Content-Type: Application/XML
Content-Length: 667
<?XML version = “1.0” encoding = “UTF-8”?>
<TOA_request>
  <request_identifier>ID_request_2</request_identifier>
  <request_type>FULL_TOA</request_type>
  <receiving_broker_identifier>ID_broker_1</receiving_broker_identifier>
  <delivery_address>1HnhWpkMHMjgt167kvgcPyurMmsCQ2WPgg</delivery_address>
  <account_identity_verification_data>aBcdEfgHijK</account_identity_verificati
on_data>
  <customer_first_name>John</customer_first_name>
  <customer_last_name>Smith</customer_last_name>
  <customer_delivering_broker_account>ID_account_201</customer_delivering_brok
er_account>
  <requested_assets>
    <asset>
      <CUSIP>38259P508</CUSIP>
      <Symbol>GOOGL</Symbol>
      <Description>Google Corporation</Description>
      <Quantity>20 Shares</Quantity>
    </asset>
    <asset>
      <CUSIP>931142103</CUSIP>
      <Symbol>WMT</Symbol>
      <Description>Walmart Stores INC</Description>
      <Quantity>40 Shares</Quantity>
    </asset>
  </requested_assets>
</TOA_request>
```

In another embodiment, when utilizing a smart contracts implementation, the receiving broker SOCOACT server may send a TOA notification 6529 to the delivering broker SOCOACT server 6506 to facilitate the TOA. In one implementation, the TOA notification may include data such as a request identifier, request type, receiving broker information, smart contract address, account identity verification data, customer information, information regarding assets to be transferred, and/or the like. In one embodiment, the receiving broker SOCOACT server may provide the following example TOA notification, substantially in the form of a HTTP(S) POST message including XML-formatted data, as provided below:

```
POST /TOA_notification.php HTTP/1.1
Host: www.server.com
Content-Type: Application/XML
Content-Length: 667
<?XML version = “1.0” encoding = “UTF-8”?>
<TOA_notification>
  <request_identifier>ID_request_2</request_identifier>
  <request_type>FULL_TOA</request_type>
  <receiving_broker_identifier>ID_broker_1</receiving_broker_identifier>
  <contract_address>3HnhWpkMHMjgt167kvgcPyurMmsCQ2WPgg</contract_address>
  <account_identity_verification_data>aBcdEfgHijK</account_identity_verificati
on_data>
  <customer_first_name>John</customer_first_name>
  <customer_last_name>Smith</customer_last_name>
  <customer_delivering_broker_account>ID_account_201</customer_delivering_brok
er_account>
  <requested_assets>
    <asset>
      <CUSIP>38259P508</CUSIP>
      <Symbol>GOOGL</Symbol>
      <Description>Google Corporation</Description>
      <Quantity>20 Shares</Quantity>
    </asset>
    <asset>
      <CUSIP>931142103</CUSIP>
      <Symbol>WMT</Symbol>
      <Description>Walmart Stores INC</Description>
      <Quantity>40 Shares</Quantity>
    </asset>
  </requested_assets>
</TOA_notification>
```

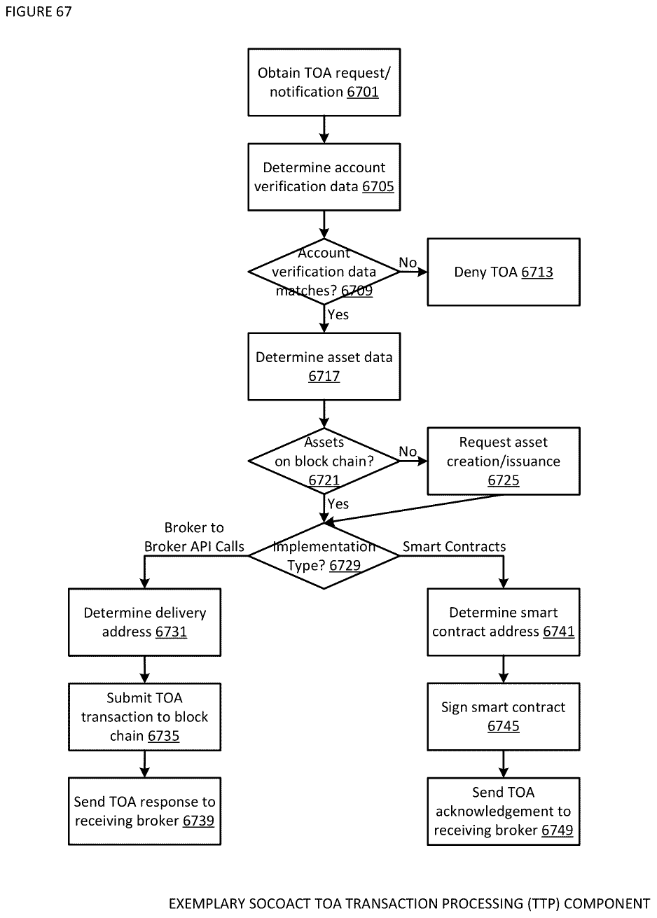

A TOA transaction processing (TTP) component 6533 may utilize data provided in the TOA request/notification to, when utilizing a broker to broker API calls implementation, facilitate submitting a TOA blockchain transaction to a blockchain, or, when utilizing a smart contracts implementation, to facilitate smart contract signing. See FIG. 67 for additional details regarding the TTP component.

The delivering broker SOCOACT server may send an asset create/issue request 6537 to an agency SOCOACT server 6508 to facilitate asset creation/issuance of assets to be transferred to the receiving broker. In one embodiment, when an asset definition for an asset does not exist on the blockchain, as asset create request may be sent. In one implementation, the asset create request may include data such as a request identifier, requesting broker information, information regarding assets to be created, and/or the like. In one embodiment, the delivering broker SOCOACT server may provide the following example asset create request, substantially in the form of a HTTP(S) POST message including XML-formatted data, as provided below:

```
POST /asset_create_request.php HTTP/1.1
Host: www.server.com
Content-Type: Application/XML
Content-Length: 667
<?XML version = “1.0” encoding = “UTF-8”?>
<asset_create_request>
  <request_identifier>ID_request_3</request_identifier>
  <requesting_broker_identifier>ID_broker_2</requesting_broker_identifier>
  <requested_assets>
    <asset>
      <CUSIP>38259P508</CUSIP>
      <Symbol>GOOGL</Symbol>
      <Description>Google Corporation</Description>
    </asset>
  </requested_assets>
</asset_create_request>
```

In another embodiment, when asset units for an asset should be issued on the blockchain, as asset issue request may be sent. In one implementation, the asset issue request may include data such as a request identifier, requesting broker information, delivery address of the requesting broker, information regarding assets to be issued, and/or the like. In one embodiment, the delivering broker SOCOACT server may provide the following example asset issue request, substantially in the form of a HTTP(S) POST message including XML-formatted data, as provided below:

```
POST /asset_issue_request.php HTTP/1.1
Host: www.server.com
Content-Type: Application/XML
Content-Length: 667
<?XML version = “1.0” encoding = “UTF-8”?>
<asset_issue_request>
  <request_identifier>ID_request_4</request_identifier>
  <requesting_broker_identifier>ID_broker_2</requesting_broker_identifier>
  <delivery_address>1HnhWpkMHMjgt167kvgcPyurMmsCQ2WPhh</delivery_address>
  <requested_assets>
    <asset>
      <CUSIP>38259P508</CUSIP>
      <Symbol>GOOGL</Symbol>
      <Description>Google Corporation</Description>
      <Quantity>20 Shares</Quantity>
    </asset>
    <asset>
      <CUSIP>931142103</CUSIP>
      <Symbol>WMT</Symbol>
      <Description>Walmart Stores INC</Description>
      <Quantity>40 Shares</Quantity>
    </asset>
  </requested_assets>
</asset_issue_request>
```

The agency SOCOACT server may send an asset create/issue response 6541 to the delivering broker SOCOACT server to confirm that the asset create/issue request was processed successfully.

In one embodiment, when utilizing a broker to broker API calls implementation, the delivering broker SOCOACT server may send a TOA response 6545 to the receiving broker SOCOACT server to confirm that the assets were transferred and/or to provide the transaction identifier of the TOA blockchain transaction submitted to the blockchain. In one implementation, the TOA response may include data such as a response identifier, a status, a transaction identifier, and/or the like. In one embodiment, the delivering broker SOCOACT server may provide the following example TOA response, substantially in the form of a HTTP(S) POST message including XML-formatted data, as provided below:

```
POST /TOA_response.php HTTP/1.1
Host: www.server.com
Content-Type: Application/XML
Content-Length: 667
<?XML version = “1.0” encoding = “UTF-8”?>
<TOA_response>
  <response_identifier>ID_response_2</response_identifier>
  <status>OK</status>
  <transaction_identifier>transaction identifier of the TOA blockchain
transaction</transaction_identifier>
</TOA_response>
```

In another embodiment, when utilizing a smart contracts implementation, the delivering broker SOCOACT server may send a TOA acknowledgment 6545 to the receiving broker SOCOACT server to confirm that the smart contract was countersigned. In one implementation, the TOA acknowledgment may include data such as a response identifier, a status, and/or the like. In one embodiment, the delivering broker SOCOACT server may provide the following example TOA acknowledgment, substantially in the form of a HTTP(S) POST message including XML-formatted data, as provided below:

```
POST /TOA_acknowledgment.php HTTP/1.1
Host: www.server.com
Content-Type: Application/XML
Content-Length: 667
<?XML version = “1.0” encoding = “UTF-8”?>
<TOA_acknowledgment>
  <response_identifier>ID_response_2</response_identifier>
  <status>OK</status>
</TOA_acknowledgment>
```

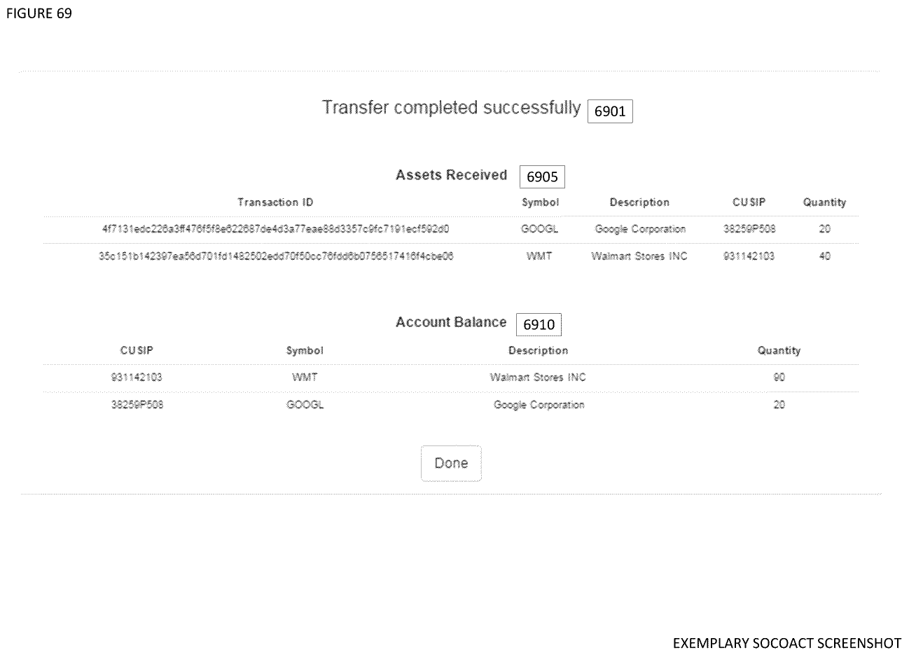

The receiving broker SOCOACT server may send a TOA confirmation 6549 to the client to inform the user that the assets were transferred. For example, the TOA confirmation may be displayed using a SOCOACT website or application (e.g., a mobile app). See FIG. 69 for an example of information that may be provided to the user.

FIG. 66 shows a logic flow diagram illustrating embodiments of a TOA transaction initiating (TTI) component for the SOCOACT. In FIG. 66, a TOA initiation request may be obtained at 6601. For example, the TOA initiation request may be obtained as a result of a user (e.g., associated with a receiving broker) initiating TOA to facilitate transfer of a customer's assets from a delivering broker. See FIG. 68 for an example of a GUI that may be utilized by the user.

Account data associated with the customer may be determined at 6603. For example, account data associated with the customer may include demographics and/or other data (e.g., primary account holder's first name, primary account holder's last name, primary account holder's social security number, secondary account holder's first name, secondary account holder's last name, secondary account holder's social security number). In one implementation, the TOA initiation request may be parsed (e.g., using PHP commands) to determine the customer's account identifier (e.g., account number) at the receiving broker (e.g., based on the value of the customer_receiving_broker_account field). The determined account identifier may be used to retrieve desired account data from a database. For example, desired account data may be determined via a MySQL database command similar to the following:

SELECT primaryFirstName, primaryLastName, primarySSN,
secondaryFirstName, secondaryLastName, secondarySSN
FROM users
WHERE accountID = ID_account_1∅1;

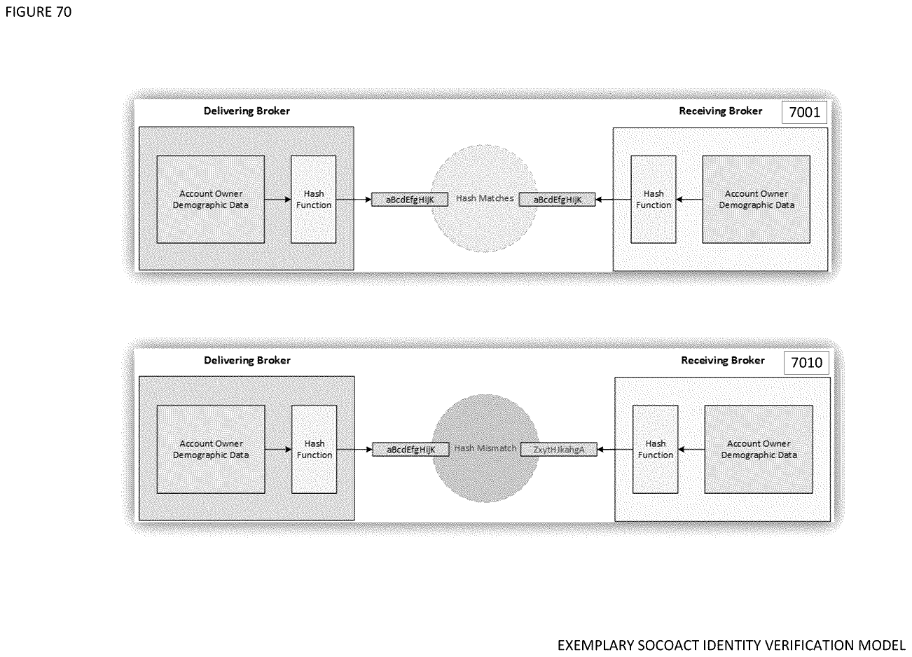

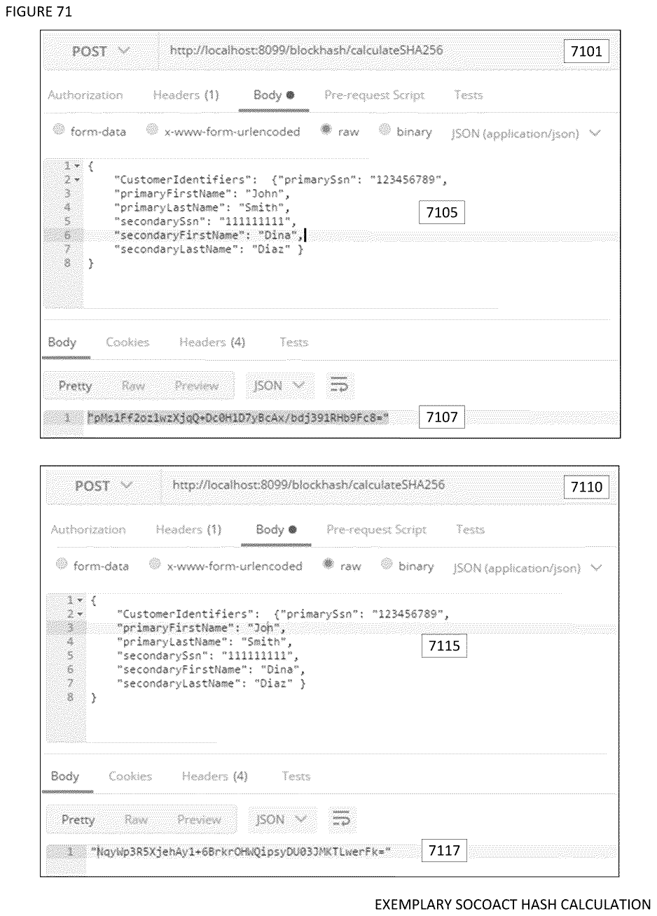

Account identity verification data may be generated at 6605. In one embodiment, account identity verification data may be utilized to ensure that the identity of the customer's account at the receiving broker matches the identity of the customer's account at the delivering broker. In one implementation, account identity verification data may be generated by utilizing a hash function to generate a hash of the determined account data. See FIGS. 70-71 for additional details regarding proving identity of accounts.

Asset data associated with the TOA initiation request may be determined at 6609. In one embodiment, the asset data may include information regarding assets to be transferred to the receiving broker. In one implementation, the TOA initiation request may be parsed (e.g., using PHP commands) to determine the asset data specified by the user (e.g., based on the value of the requested_assets field).

A delivery address for the assets to be transferred may be identified at 6611. In one implementation, an omnibus wallet address associated with the receiving broker may be determined (e.g., via an API call). In another implementation, a delivery address may be generated (e.g., via an API call in accordance with Bitcoin Improvement Proposal 32 (BIP32)) for the transfer transaction.

Delivering broker data associated with the TOA initiation request may be determined at 6613. In one implementation, the TOA initiation request may be parsed (e.g., using PHP commands) to determine the delivering broker identifier (e.g., based on the value of the delivering_broker_identifier field). For example, the delivering broker identifier may be utilized when making an API call or utilizing a smart contract to identify the delivering broker counterparty to the transfer transaction. In another implementation, the TOA initiation request may be parsed (e.g., using PHP commands) to determine the customer's account identifier (e.g., account number) at the delivering broker (e.g., based on the value of the customer_delivering_broker_account field). For example, the customer's account identifier at the delivering broker may be utilized when making an API call or utilizing a smart contract to identify the account at the delivering broker from which the requested assets should be transferred.

As shown at 6617, in one embodiment, if the TOA process is implemented using broker to broker API calls, a TOA request associated with the TOA initiation request may be generated at 6621. In one embodiment, the TOA request may instruct the delivering broker to transfer the customer's assets to the receiving broker in accordance with the specified TOA parameters. The TOA request may be sent (e.g., via an API call) to the delivering broker at 6625.

In another embodiment, if the TOA process is implemented using smart contracts, a smart contract associated with the TOA initiation request may be determined or generated at 6631. In one embodiment, the smart contract may facilitate transfer of the customer's assets from the delivering broker to the receiving broker upon receiving signatures from both brokers. In one implementation, a smart contract address of a previously generated (e.g., by the delivering broker) smart contract may be determined. In another implementation, the smart contract may be generated via a SCG component (e.g., using the signature of the delivering broker as oracle data that unlocks the smart contract). The receiving broker may sign (e.g., via an API call) the smart contract at 6635. A TOA notification may be generated and sent (e.g., via an API call) to the delivering broker at 6639. In one embodiment, the TOA notification may instruct the delivering broker to transfer the customer's assets to the receiving broker in accordance with the specified TOA parameters via the smart contract.

FIG. 67 shows a logic flow diagram illustrating embodiments of a TOA transaction processing (TTP) component for the SOCOACT. In FIG. 67, a TOA request (e.g., if the TOA process is implemented using broker to broker API calls) or a TOA notification (e.g., if the TOA process is implemented using smart contracts) may be obtained at 6701. For example the TOA request/notification may be obtained as a result of a receiving broker requesting transfer of a customer's assets from a delivering broker.

Account verification data associated with the TOA request/notification may be determined at 6705. In one implementation, the TOA request/notification may be parsed (e.g., using PHP commands) to determine account data associated with the customer provided by the receiving broker. For example, the customer's first name, the customer's last name, and the customer's account identifier (e.g., account number) at the delivering broker may be determined (e.g., based on the values of customer_first_name, customer_last_name, and customer_delivering_broker_account fields, respectively). In another implementation, the TOA request/notification may be parsed (e.g., using PHP commands) to determine account identity verification data provided by the receiving broker (e.g., based on the value of the account_identity_verification_data field). As per description above, utilizing account identity verification data that is based on a hash function is unconventional because, as sensitive customer information (e.g., social security number) does not have to be sent in the TOA request/notification and may not be determined from a hash, data transfer is secured. As such, in some alternative implementations, account identity verification data may be placed into a smart contract (e.g., for increased efficiency and/or speed of processing the transaction) without compromising security of sensitive customer information.

A determination may be made at 6709 whether account verification data matches. In one implementation, account data associated with the customer stored by the delivering broker may be retrieved (e.g., via one or more SQL statements) and compared with account data associated with the customer provided by the receiving broker to determine whether the data matches. In another implementation, a hash of account data associated with the customer stored by the delivering broker may be generated and compared with account identity verification data (e.g., a hash) provided by the receiving broker to determine whether the data matches. See FIGS. 70-71 for additional details regarding proving identity of accounts. If the account verification data does not match, the transfer transaction may be denied at 6713. For example, the receiving broker may be notified that the TOA failed.

If the account verification data matches, asset data associated with the TOA request/notification may be determined at 6717. In one embodiment, the asset data may include information regarding assets to be transferred to the receiving broker. In one implementation, the TOA request/notification may be parsed (e.g., using PHP commands) to determine the asset data provided by the receiving broker (e.g., based on the value of the requested_assets field).

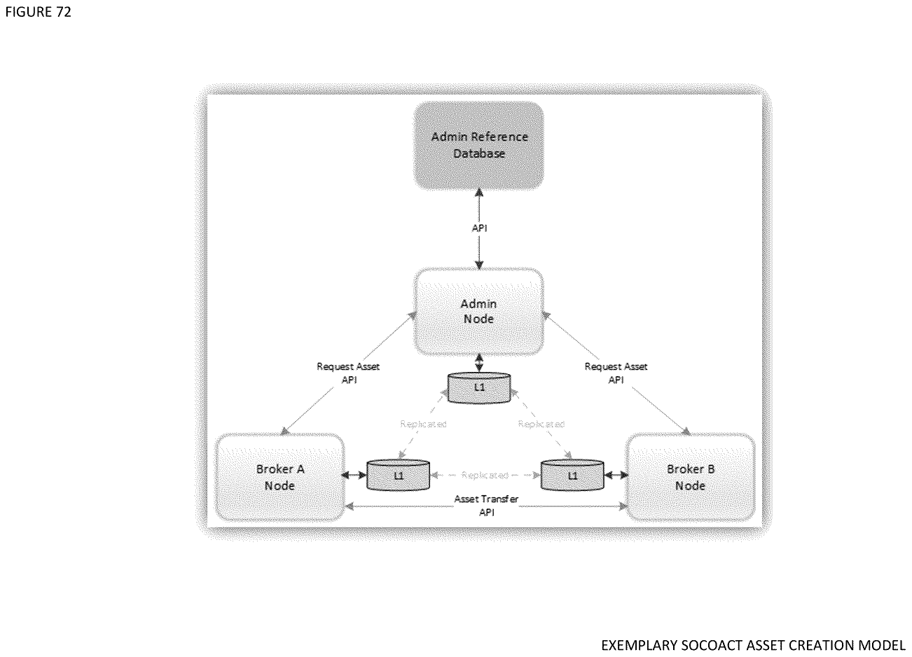

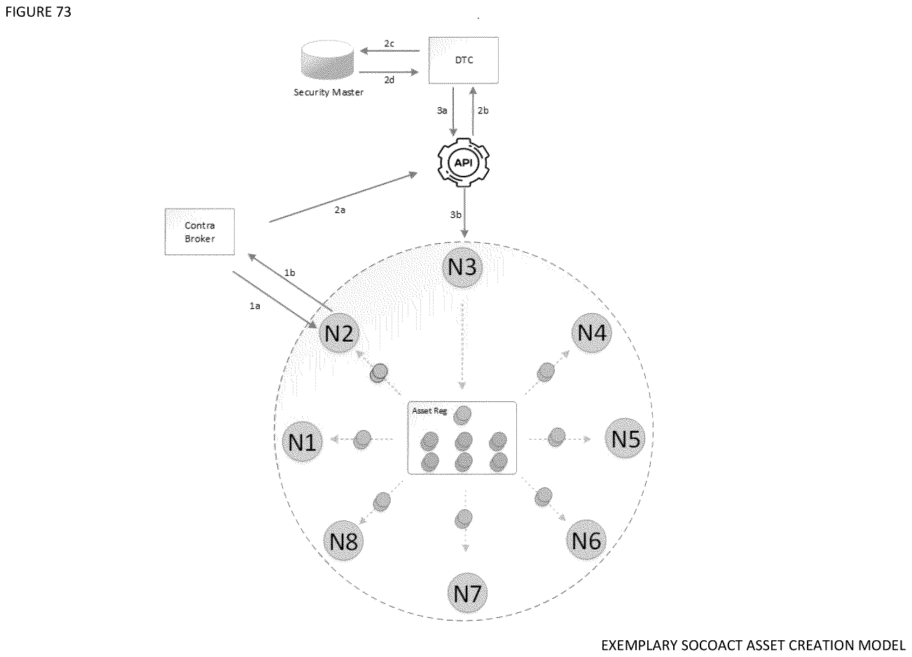

A determination may be made at 6721 whether the assets to be transferred are on the blockchain (e.g., in the delivering broker's wallet). If the assets to be transferred are not on the blockchain, blockchain asset creation and/or asset issuance for the assets to be transferred may be requested from an administrative node (e.g., a blockchain network node of an agency (e.g., DTC)) of the blockchain network at 6725. In one implementation, the customer's account (e.g., the assets to be transferred) may be set up on the blockchain. See FIGS. 72-76 for additional details regarding asset creation, asset issuance, and wallet administration.

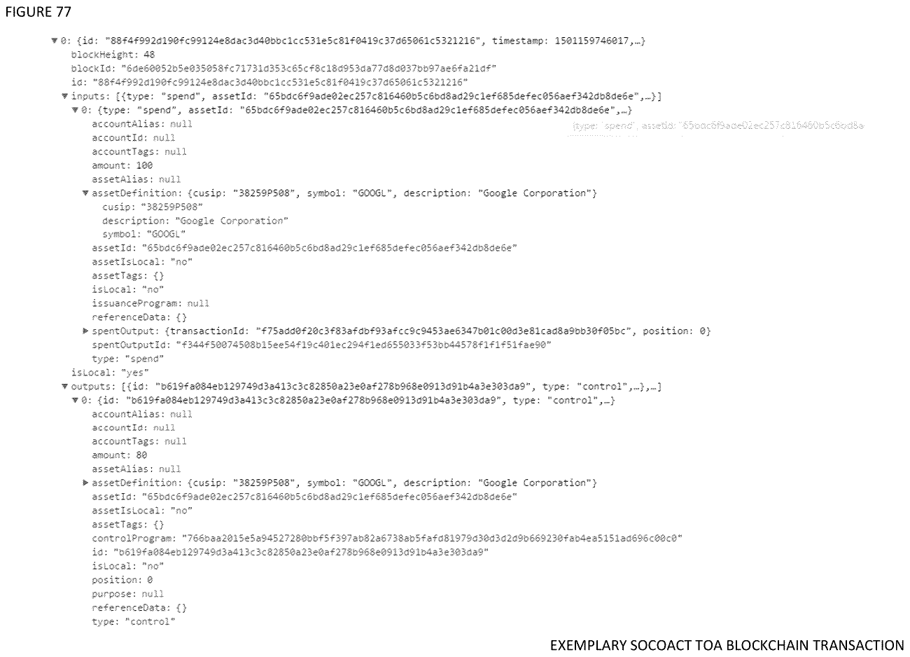

As shown at 6729, in one embodiment, if the TOA process is implemented using broker to broker API calls, a delivery address for the assets to be transferred may be determined at 6731. In one implementation, the TOA request may be parsed (e.g., using PHP commands) to determine the delivery address provided by the receiving broker (e.g., based on the value of the delivery_address field). A TOA blockchain transaction may be submitted to the blockchain at 6735. In one embodiment, the TOA blockchain transaction may transfer the customer's assets from the delivering broker's wallet to the receiving broker's wallet. See FIG. 77 for an example of a TOA blockchain transaction. A TOA response may be sent (e.g., via an API call) to the receiving broker at 6739. In one embodiment, the TOA response may be used to confirm that the customer's assets were transferred and/or to provide the transaction identifier of the TOA blockchain transaction submitted to the blockchain.

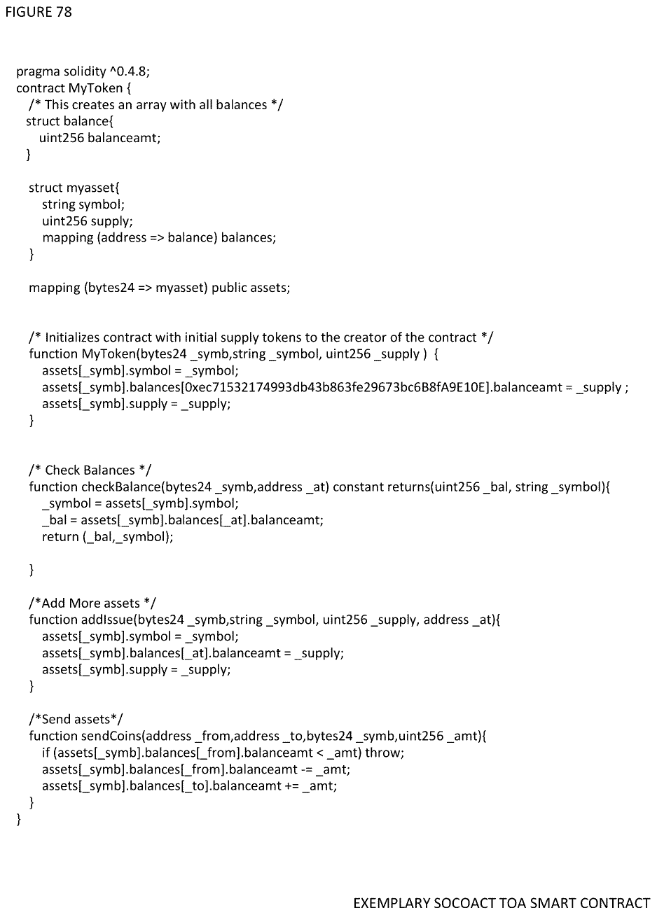

In another embodiment, if the TOA process is implemented using smart contracts, a smart contract address of a smart contract associated with the TOA notification may be determined at 6741. In one implementation, the TOA notification may be parsed (e.g., using PHP commands) to determine the smart contract address provided by the receiving broker (e.g., based on the value of the contract_address field). The smart contract may be signed (e.g., via an API call) by the delivering broker at 6745. In one embodiment, countersigning the smart contract may trigger the transfer of the customer's assets from the delivering broker's wallet to the receiving broker's wallet. In one implementation, data specified in the TOA notification (e.g., requested assets) may be compared to data specified in the smart contract to verify that the data matches. See FIG. 78 for an example of a smart contract implementation. A TOA acknowledgement may be sent (e.g., via an API call) to the receiving broker at 6749. In one embodiment, the TOA acknowledgement may be used to confirm that the smart contract was countersigned and/or that the customer's assets were transferred.

FIG. 68 shows a screenshot diagram illustrating embodiments of the SOCOACT. In FIG. 68, a GUI 6801 that may be utilized by a user to submit a TOA initiation request to facilitate transfer of a customer's assets is illustrated. The user may utilize an account number widget 6805 to specify the customer's account number at a receiving broker. Widget 6810 shows additional account data associated with the customer that may be retrieved based on the customer's account number (e.g., first name, last name, social security number).

The user may utilize account number widget 6815 to specify the customer's account number at a delivering broker. The user may utilize SSN widget 6820 to specify the customer's social security number. The user may utilize broker widget 6825 to specify the delivering broker.

The user may utilize CUSIP widget 6830 and Quantity widget 6835 to specify an identifier and a quantity, respectively, of each asset to be transferred from the delivering broker to the receiving broker. Assets to be transferred section 6840 shows assets to be transferred that have been specified by the user.

FIG. 69 shows a screenshot diagram illustrating embodiments of the SOCOACT. In FIG. 69, a transaction receipt GUI 6901 that may be utilized to provide a transaction receipt for a TOA transaction is illustrated. Assets received section 6905 shows assets received by a receiving broker as a result of the TOA transaction. Account balance section 6910 shows a customer's account balance, updated to reflect the receipt of the transferred assets.

FIG. 70 shows an exemplary identity verification model for the SOCOACT. The identity verification model may be utilized for a TOA transaction to ensure that the identity of a customer's account at a receiving broker matches the identity of the customer's account at a delivering broker (e.g., while on blockchain, instead of utilizing the DTC). In FIG. 70, a hash function may be utilized to generate a hash of the customer's account owner demographic data. Screen 7001 shows that if the hash generated by the delivering broker matches the hash generated by the receiving broker, the TOA transaction is approved. Screen 7010 shows that if the hash generated by the delivering broker does not match the hash generated by the receiving broker, the TOA transaction is denied.

FIG. 71 shows an exemplary hash calculation for the SOCOACT. In one embodiment, the hash calculation may be utilized to facilitate account identity verification. In one implementation, an id may be generated by stringing together account owner demographic data, and a hash of the id may be calculated. For example, the hash calculation may be implemented as follows:

```
@RestController
public class HashController {
  private ObjectMapper objMapper = new ObjectMapper( );
  @RequestMapping(value = “/calculateSHA256”, method = RequestMethod.POST,
consumes = { “application/json” }, produces = { “application/json” })
  public String calculateSHA256(@RequestBody Identifiers id)
      throws JsonProcessingException {
    String output = null;
    String input = null;
    if (id != null) {
      input = id.getIdentifier( ).getPrimarySsn( )
        + id.getIdentifier( ).getPrimaryFirstName( )
        + id.getIdentifier( ).getPrimaryLastName( )
        + id.getIdentifier( ).getSecondarySsn( )
        + id.getIdentifier( ).getSecondaryFirstName( )
        + id.getIdentifier( ).getSecondaryLastName( );
    }
    output = objMapper.writeValueAsString(calculateSHA256(input));
    return output;
  }
  public String calculateSHA256(String base) {
    try {
      MessageDigest digest = MessageDigest.getInstance(“SHA-256”);
      byte[ ] hash = digest.digest(base.getBytes(“UTF-8”));
      return Base64.encodeBytes(hash).toString( );
    } catch (Exception ex) {
      throw new RuntimeException(ex);
    }
  }
}
```

Screen 7101 shows that the result of utilizing the hash calculation on the set of account owner demographic data shown at 7105 is a hash shown at 7107. In one implementation, the following request and response may be utilized:

```
Request 1:
Method: POST
Url: http://localhost:8099/blockhash/calculateSHA256
Request Body:
{
  “CustomerIdentifiers”: {“primarySsn”: “123456789”,
  “primaryFirstName”: “John”,
  “primaryLastName”: “Smith”,
  “secondarySsn”: “111111111”,
  “secondaryFirstName”: “Dina”,
  “secondaryLastName”: “Diaz” }
}
Response 1:
pMs1Ff2oz1wzXjqQ+Dc0H1D7yBcAx/bdj391RHb9Fc8=
```

Screen 7110 shows that the result of utilizing the hash calculation on the set of account owner demographic data shown at 7115 is a hash shown at 7117. As shown, a one character difference (e.g., primary first name changed from John to Jon) results in an entirely different hash. In one implementation, the following request and response may be utilized:

```
Request 2:
Method: POST
Url: http://localhost:8099/blockhash/calculateSHA256
Request Body:
{
  “CustomerIdentifiers”: {“primarySsn”: “123456789”,
  “primaryFirstName”: “Jon”,
  “primaryLastName”: “Smith”,
  “secondarySsn”: “111111111”,
  “secondaryFirstName”: “Dina”,
  “secondaryLastName”: “Diaz” }
}
Response 2:
NqyWp3R5XjehAy1+6BrkrOHWQipsyDU03 JMKTLwerFk=
```

FIG. 72 shows an exemplary asset creation model for the SOCOACT. In one embodiment, assets defined on the blockchain are unique (e.g., each asset is defined once). Accordingly, a central administrative node that controls asset definition on the blockchain may be utilized. Other parties on the blockchain may reference the asset definition of the administrative node (e.g., with data stored in an administrative reference database). In one implementation, an asset may be defined using its Committee on Uniform Securities Identification Procedures identifier (CUSIP), ticker symbol, International Securities Identification Number (ISIN), and description (e.g., 2 lines). In one implementation, a smart contract and/or a control program may be utilized to reject asset definition without an administrative key and/or for a duplicate asset (e.g., with the same CUSIP). If a broker wishes to define position data for an account onto the blockchain to facilitate TOA, and the account includes an asset that is not defined on the blockchain, the broker may make an API call to the administrative node to define the asset. The administrative node may define the asset on-demand and make the asset definition available to other nodes in the network. In one implementation, if the asset is unsupported (e.g., the asset does not have a CUSIP) the administrative node may decline to create the asset and the asset transfer may be denied (e.g., the customer associated with the asset transfer may have to liquidate the unsupported asset and transfer funds).

FIG. 73 shows an exemplary asset creation model for the SOCOACT. At 1a, a broker may interface with blockchain node N2 to look up whether an asset is defined on the blockchain. At 1b, blockchain node N2 responds to the broker with the requested data. At 2a and 2b, if the asset is not defined on the blockchain, the broker calls asset creation API to request that an administrator (e.g., DTC) create an asset definition for the asset. At 2c and 2d, the administrator confirms that the asset definition may be created, and issues an asset creation request to add the asset definition to the administrative reference database (e.g., security master). At 3a and 3b, the administrator may utilize the API to invoke a smart contract in blockchain node N3 to create the asset definition on the blockchain. The smart contract may be executed in the nodes of the blockchain network to make the asset definition reference available to the nodes of the blockchain network.

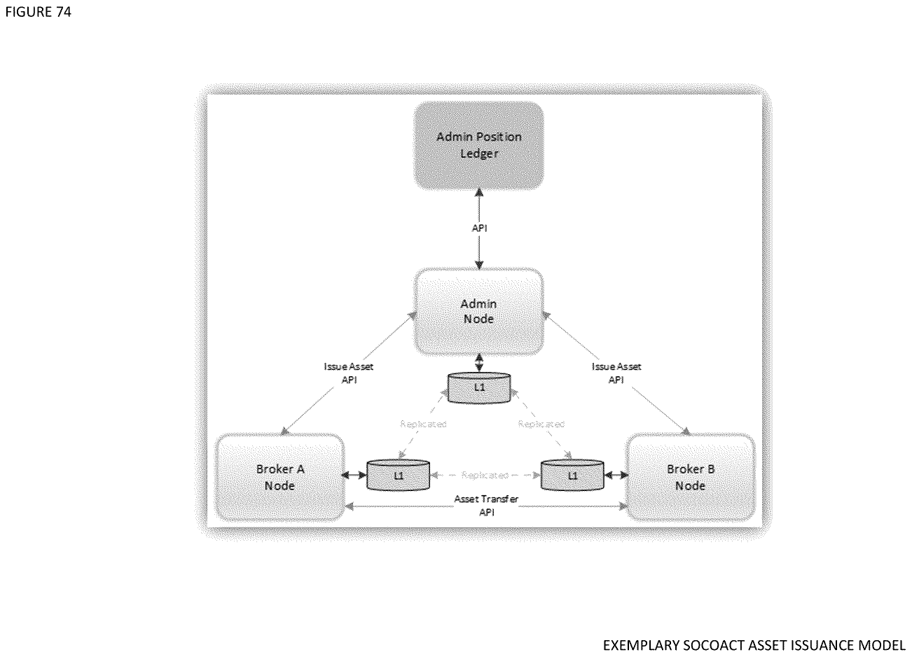

FIG. 74 shows an exemplary asset issuance model for the SOCOACT. In one embodiment, when an account of a customer associated with TOA is set up on the blockchain, assets to be transferred are allocated to the account (e.g., the account may be represented on the blockchain via a public key or address generated in accordance with BIP32) to facilitate tracking ownership of assets issued on the blockchain. A central administrative node that controls asset issuance (e.g., with data stored in an administrative position ledger) on the blockchain may be utilized (e.g., the same entity that controls asset definition). In one implementation, when establishing a position ledger on the blockchain, a broker node may make an asset issuance API call to the administrative node to issue new asset units (e.g., crypto tokens) based on the broker's specifications (e.g., based on the assets to be transferred). The administrative node may validate the asset issuance request (e.g., to verify the broker's identity, to verify availability of assets), and may issue the requested asset units to the broker's omnibus wallet address. In one implementation, upon receipt of the newly issued asset units, the broker may reallocate the newly issued asset units to the customer's account.

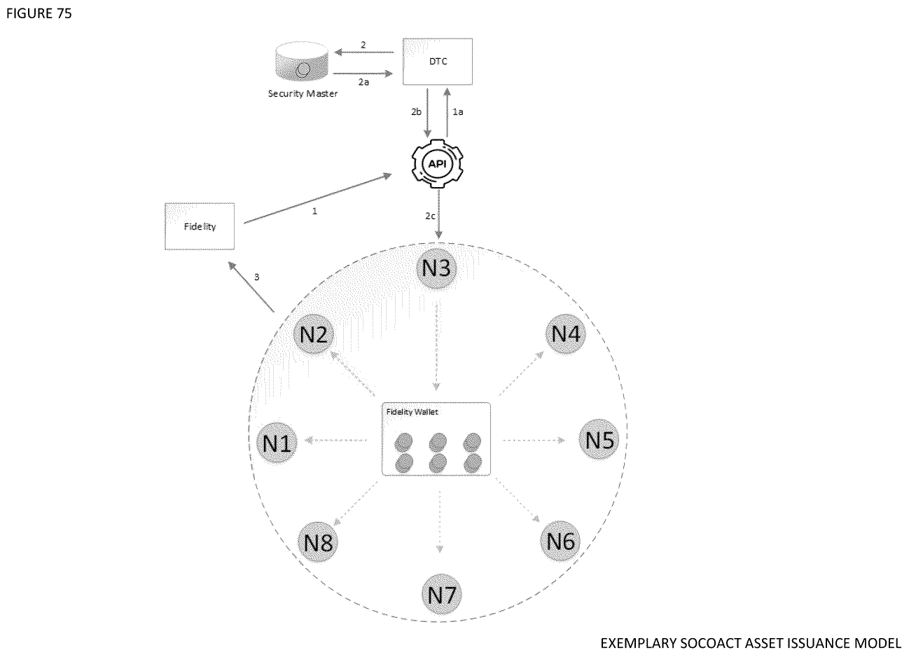

FIG. 75 shows an exemplary asset issuance model for the SOCOACT. At 1 and 1a, a broker (e.g., Fidelity) may call asset issuance API to request that an administrator (e.g., DTC) issue new asset units, while depositing assets to the blockchain. At 2, 2a, and 2b, the administrator issues an asset issuance request to add the newly created asset units to the administrative position ledger (e.g., security master). At 2c, the administrator may utilize the API to communicate with blockchain node N3 to add the newly created asset units to the broker's wallet (e.g., to the broker's omnibus wallet address). In one implementation, a copy of the broker's wallet is shared with the nodes of the blockchain network. The wallet may be encrypted such that the asset holdings are visible to the broker, but not to other brokers.

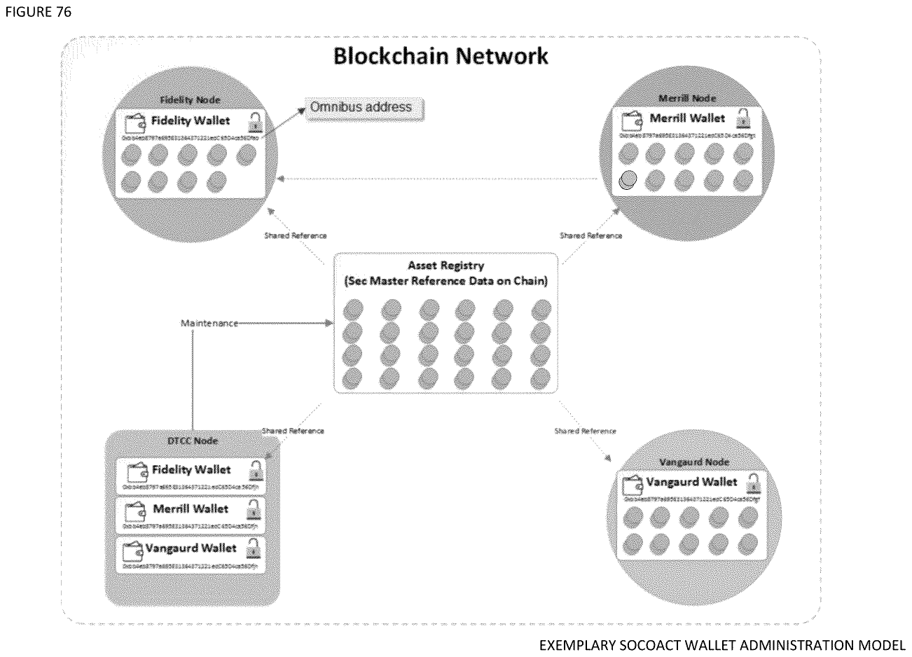

FIG. 76 shows an exemplary wallet administration model for the SOCOACT. In FIG. 76, each broker has an omnibus wallet address on the blockchain to which assets may be deposited based on custodial positions. An asset registry (e.g., asset definition data) may be shared across the nodes of the blockchain network. Positions data for the wallets may also be shared across the nodes of the blockchain network. The positions data may be encrypted such that full access to a wallet is restricted to the broker who owns the wallet and/or to the administrator (e.g., DTCC).

FIG. 77 shows an exemplary TOA blockchain transaction for the SOCOACT. For example, the TOA blockchain transaction may be utilized via a blockchain platform such as Chain Core. The TOA blockchain transaction shows sample input and output JSON messages that may be utilized to move 100 units of GOOGL from one account to another. In one implementation, the control program may be the temporary receiver of the transferred assets (e.g., the generated temporary address to which the asset deposits are requested).

FIG. 78 shows an exemplary TOA smart contract for the SOCOACT. For example, the shown smart contract implementation may be utilized via a blockchain platform such as Etherium. As shown, functions may be implemented to initialize a contract with crypto tokens, to check balances, to add assets, to send assets, and/or the like.

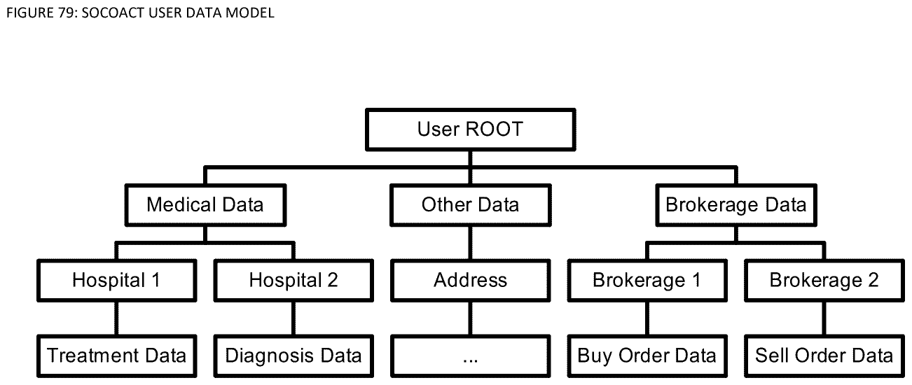

FIG. 79 shows an exemplary embodiment of a user data model for the SOCOACT. In FIG. 79, a tree of user-owned data (e.g., the user retains access control over the data) is illustrated. The data belongs to the user associated with the User ROOT node. The data may include a variety of categories (e.g., medical data, other data, brokerage data) and/or subcategories (e.g., data associated with hospital 1, data associated with hospital 2, data associated with brokerage firm 1, data associated with brokerage firm 2), and/or data (e.g., treatment data, diagnosis data, the user's address, buy order data, sell order data). The user may read data from and/or write data to the tree. The user may also grant others (e.g., institutions such as hospitals and brokerage firms) rights to read data from and/or write data to the tree. For example, the user may grant a hospital the right to write treatment data, diagnostic data, and/or the like to the tree, and the user may grant medical providers (e.g., other hospitals, medical practitioners) the right to read such data (e.g., to give read access to any data nodes specified by the user). In another example, the user may grant a brokerage firm the right to write buy order data to the tree, and the user may grant another brokerage firm the right to read such data from the tree and utilize it to execute a sell order, and/or to write sell order data to the tree. In one implementation, the tree may be implemented using a set of interrelated blockchain nodes that facilitate access control of the user-owned data.

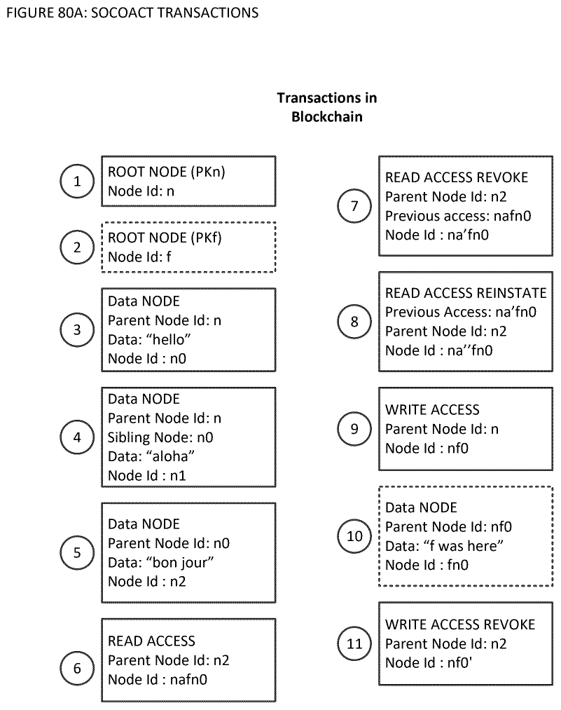

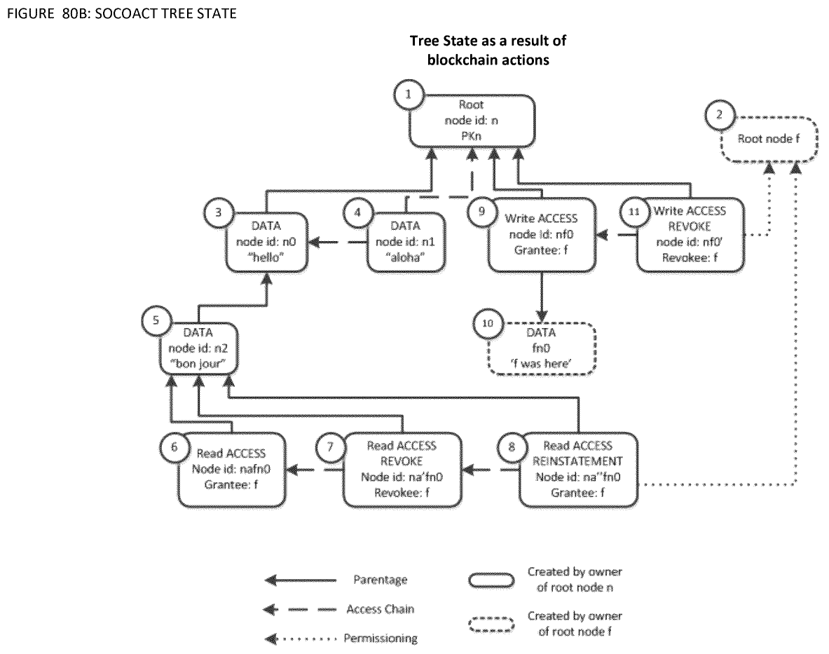

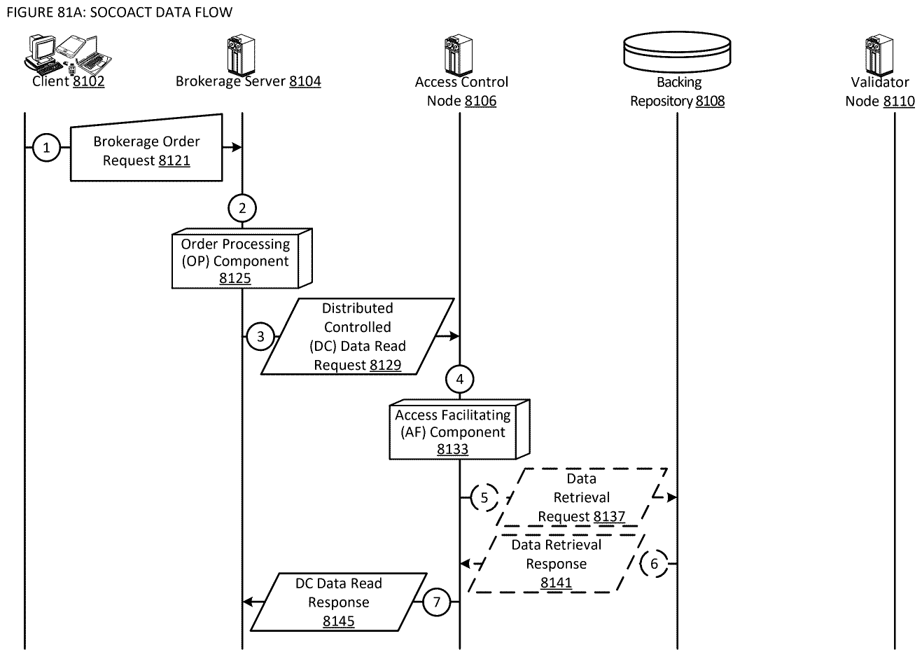

FIGS. 80A-80B show exemplary embodiments of blockchain transactions and corresponding tree state for the SOCOACT. In FIGS. 80A-80B, a set of transactions in a blockchain are shown to illustrate various exemplary embodiments of operations that may be performed via the SOCOACT.

### Root Node Creation

User 1 (e.g., the owner of data associated with root node n) creates an ECDSA private key/public key pair (pKₙ, PKₙ). User 1 creates a root node transaction thus announcing a public key (PKₙ) on the blockchain that can be used to validate further transactions. In some alternative implementations, an encoded public key may be utilized as an address instead of the raw public key. The transaction has the following structure:

Root Node Transaction

Transaction type: ROOT
Public Key/address: PKₙ
Message: “ROOT”
Signature: SIG=>pKₙ(HASH(tx_type, “ROOT”))
Txid: HASH(signature) → Node Id: n

User 1 may create a signature using the private key pKₙ associated with PKₙ. The signature may be created using a HASH (e.g., SHA-256) of 1) the transaction type (tx_type) and 2) Message field included in the transaction (e.g., “ROOT”). The transaction id (Txid) is a hash of the signature and may be considered the node id and referred to as n. In some alternative implementations, the transaction (Txid) is a hash of the transaction (e.g., including the signature).

User 2 (e.g., a brokerage firm) creates a root node transaction on the blockchain. The transaction is based on a different private key/public key pair (pK_{f}, PK_{f}) created by User 2. User 2's public key is referred to as PK_{f}. The transaction id of the root node transaction may be considered the node id and referred to as f. The transaction has the following structure:

Root Node Transaction

Transaction type: ROOT
Public Key/address: PK_{f}
Message: “ROOT”
Signature: SIG=>pK_{f}(HASH(tx_type,“ROOT”))
Txid: HASH(signature) → Node Id: f

These transactions are inserted (e.g., grouped into blocks) on the blockchain. A validator of these root node transactions can validate the signature of a transaction using the public key that is associated with the private key that was used to create the signature for the transaction.

### Data Node Creation

User 1 may create a data node, using a data node transaction with the following structure:

Data Node Transaction

Transaction type: Data
Parent node: n
Data: [data blob]
Signature: SIG=>pKₙ(HASH(tx_type, data, n))
Txid: HASH(signature) → Node Id: n₀

User 1 may store a data blob in this node (e.g., encrypted or unencrypted). User 1 may create a signature using the private key pKₙ associated with PKₙ using as input the hash of: 1) the transaction type (tx_type), 2) the data blob, and 3) the parent node id. The transaction id of this node is a hash of the signature and the node may be referred to by node id: n₀.

A validator of this transaction can see that the parent node refers to a root node n. The validator can validate the signature was created using the private key pKₙ associated with public key PKₙ which is associated with node n. In this way, the validator can validate that the owner (e.g., creator) of the data was n. The validator can validate that this is the first child node of node n because it identifies no sibling node; this is enforced in the signature. In one implementation, once this child node is created, the n node is “spent”; subsequent child nodes of n should refer to this n₀ node.

### Sibling Data Node Creation

User 1 may create additional children nodes, using a data node transaction which has the following structure:

Data Node Transaction

Transaction type: Data
Parent node: n
Sibling node: n₀
Data: [data blob]
Signature: SIG=>pKₙ(HASH(tx_type, data, n, n₀))
Txid: HASH(signature) → Node Id: n₁

User 1 may store a data blob in this node (e.g., encrypted or unencrypted). User 1 may create a signature using the private key pKₙ associated with PK, using as an input the HASH of: 1) the transaction type, 2) the data blob, 3) the parent node id, and 4) the previous sibling node. The transaction id of this node is a hash of the signature and the node may be referred to by node id: no.

A validator of this transaction can see the parent node refers to a root node n. The validator can validate the signature was created using the private key pKₙ associated with public key PKₙ which is associated with node n. In this way the validator can validate that the creator of the data was n. The validator can validate that this an additional child node of node n because it identifies the previous sibling node, n₀; this is enforced in the signature. In one implementation, once this sibling node is created, the n₀ node is “spent”; subsequent child nodes of n should refer to this n₁ node.

### Child Data Node Creation

User 1 may create a data node that uses another data node as a parent using a similar data node transaction with a different parent node id. The transaction has the following structure:

Data Node Transaction

Transaction type: Data
Parent node: n₀
Data: [data blob]
Signature: SIG=>pKₙ(HASH(tx_type, data, n₀))
Txid: HASH(signature) → Node Id: n₂

User 1 may store a data blob in this node (e.g., encrypted or unencrypted). User 1 may create a signature using the private key pKₙ associated with PKₙ using as input the hash of: 1) the transaction type, 2) the data blob, and 3) the parent node id. The transaction id of this node is a hash of the signature and the node may be referred to by node id: n₂.

A validator of this transaction can see the parent node refers to a data node no. The validator can see that no refers to a parent node which is root node n. The validator can validate the signature was created using the private key pKₙ associated with public key PK, which is associated with root node n. In this way, the validator can validate that the creator of the data was n. The validator can validate that this is the first child node of node no because it identifies no sibling node; this is enforced in the signature. In one implementation, once this child node is created, the n₀ node is “spent”; subsequent child nodes of no should refer to this n₂ node.

By following the tree back up through parent nodes, the root node may be reached. Once the root node is determined, each node step back down the tree can be validated using the public key associated with the root node to validate the signatures included in each data node.

### Read Access Grant

User 1 may create a read access grant node which grants User 2 access to read a data node (e.g., and child nodes of that data node). The transaction has the following structure:

Access Node Transaction

Transaction type: Read Access
Parent node: n₀
Permissioned node: f
Signature: SIG=>pKₙ(HASH(tx_type, n₀, f))
Txid: HASH(signature) → Node Id: nₐ^{f}ₙ₀

User 1 may create a read access grant transaction identifying a parent data node and another root node (e.g., f) that is permissioned to read the data node. User 1 may use the private key pKₙ associated with PKₙ to create a signature using as input the hash of: 1) the transaction type, 2) the parent node id, and 3) the permissioned node id. The transaction id of this node is a hash of the signature and the node may be referred to by node id: nₐ^{f}ₙ₀.

A validator of this transaction can see the parent node refers to a data node n₀. The validator can see that n0 is a data node and refers to a root node n. The validator can validate the signature was created using the private key pKₙ associated with public key PK, which is associated with node n. In this way the validator can validate that access was granted by n to f. In one implementation, once this node is created the n₀ node is “spent” for purposes of f node access to the n₀ node; subsequent changes to read access to n₀ node should refer to this nₐ^{f}ₙ₀ node.

A Read Access node can be provided at any depth in a data node tree. In one implementation, this transaction type can be submitted once for each data node it refers to.

### Read Access Revocation

User 1 may create a read access revocation node which revokes a previously granted access to User 2 to read a data node (e.g., and child nodes of that data node). The transaction has the following structure:

Access Node Transaction

Transaction type: Read Access Revoke
Parent node: n₀
Previous access node: nₐ^{f}ₙ₀
Permissioned node: f
Signature: SIG=>pKₙ(HASH(tx_type, n₀, nₐ^{f}ₙ₀, f))
Txid: HASH(signature) → Node Id: nₐ^{,f}ₙ₀

User 1 may create a revoke access node identifying a previous read access grant node and a root node for which the permission to read a data node is revoked. User 1 may use the private key pKₙ associated with public key PKₙ to create a signature using as input the hash of: 1) the transaction type, 2) the parent data node id, 3) the previous access grant node id, and 4) the node id of the root node whose read access is being revoked. The transaction id of this node is a hash of the signature, and the node may be referred to by node id: n_{a′}^{f}ₙ₀.

A validator of this transaction can see that the parent node refers to a previous read access grant node nₐ^{f}ₙ₀. The validator can see that nₐ^{f}ₙ₀ is access granted to a data node n₀. The validator can see that n₀ is a data node and refers to a root node n. The validator can validate that the signature of the read access revoke transaction was created using the private key pKₙ associated with public key PKₙ which is associated with node n. In this way, the validator can validate that revocation of access is requested by n for f. In one implementation, once this node is created, the nₐ^{f}ₙ₀ node is “spent” for purposes of f node read access to the n₀ node; subsequent changes to read access to no node should refer to this n_{a′}^{f}ₙ₀ node.

### Read Access Reinstatement

This is similar to the read access revocation transaction, but the transaction type is read access reinstatement. The previous access node should refer to a read access revocation node (transaction).

### Write Access Node Creation

User 1 may create an access node which grants User 2 access to write child nodes of this access node on behalf of User 1. The transaction has the following structure:

Access Node Transaction

Transaction type: Write Access
Parent node: n
Permissioned node: f
Signature: SIG=>pKₙ(HASH(tx_type, n, f))
Txid: HASH(signature) → Node Id: n^{f}₀

User 1 may use the private key pKₙ associated with PK, to create a signature using as input the hash of: 1) the transaction type, 2) the root node id identifying the grantor, and 3) the permissioned node id. The transaction id of this node is a hash of the signature and the node may be referred to by node id: n^{f}₀.

A validator of this transaction can use the public key seen in the parent node transaction n to validate the signature indicating the owner of node n allowed the owner of node f write access. In one implementation, once this node is created the n node is “spent” for purposes of f node write access to the n node; subsequent changes to write access to n node should refer to this n^{f}₀ node.

Another data node in the tree that originates with root node n can be used as parent node; the data node can be traced back to the root node.

### Permissioned Data Node Creation

User 2, having been given permission, may create a data node with the Write Access Node as parent. The transaction has the following structure:

Data Node Transaction

Transaction type: Data
Parent node: n^{f}₀
Data: [data blob]
Signature: SIG=>pK_{f}(HASH(tx_type, data, n^{f}₀))
Txid: HASH(signature) → Node Id: fⁿ₀

User 2 may store data in this node (e.g., encrypted or unencrypted as agreed upon with User 1). User 2 may create a signature using the private key pK_{f} associated with PK_{f} using as input the hash of: 1) the transaction type (tx_type), 2) the data blob, and 3) the parent access node. The transaction id of this node is a hash of the signature and the node may be referred to by node id: fⁿ₀.

A validator of this transaction can see that the parent node refers to an access node that refers to two root nodes n and f, where n grants permission to f. The validator can validate the signature was created using the private key pK_{f} associated with public key PK_{f} which is associated with node f. In this way it can validate that the creator of the data was f. It can validate that this is the first child node of node n^{f}₀ because it identifies no sibling node; this is enforced in the signature. In one implementation, once this child node is created, the n^{f}₀ node is “spent”; subsequent child nodes of n^{f}₀ should refer to this fⁿ₀ node.

Sibling nodes can be created in a similar manner as other data nodes.

### Write Access Revocation

User 1 may create a write access revocation transaction which revokes a previously granted write access to User 2 to write a data node that is a child of a previous write access node. The transaction has the following structure:

Access Node Transaction

Transaction type: Write Access Revoke
Parent node: n
Previous access node: n^{f}₀
Permissioned node: f
Signature: SIG=>pKₙ(HASH(tx_type, n, f, n^{f}₀))
Txid: HASH(signature) → Node Id: n^{f}₀^{,}

User 1 may create a revoke write access node identifying a previous write access grant node and a root node for which the permission to write a data node is revoked. User 1 may use the private key pKₙ associated with public key PKₙ to create a signature using as input the hash of: 1) transaction type, 2) the parent data node id, 3) the previous access grant node id, and 4) the node id of the root node whose write access is being revoked. The transaction id of this node is a hash of the signature, and the node may be referred to by node id: n^{f}_{0′}.

A validator of this transaction can see that the parent node refers to a previous write access grant node n^{f}₀. The validator can see that n^{f}₀ is access granted to a data node n₀. The validator can see that no is a data node and refers to a root node n. The validator can validate that the signature of the revoke access transaction was created using the private key pKₙ associated with public key PKₙ which is associated with node n. In this way, the validator can validate that revocation of access is requested by n for f. In one implementation, once this node is created the n^{f}₀ node is “spent” for purposes of f node write access to the n node; subsequent changes to write access to n node should refer to this n^{f}_{0′} node.

In the presence of the revocation, the blockchain transaction validator should invalidate a transaction where f attempts to create a data node with the original write access node as a parent.

### Write Access Reinstatement

This is similar to the write access revocation transaction, but the transaction type is write access reinstatement. The previous access node should refer to a write access revocation node (transaction).

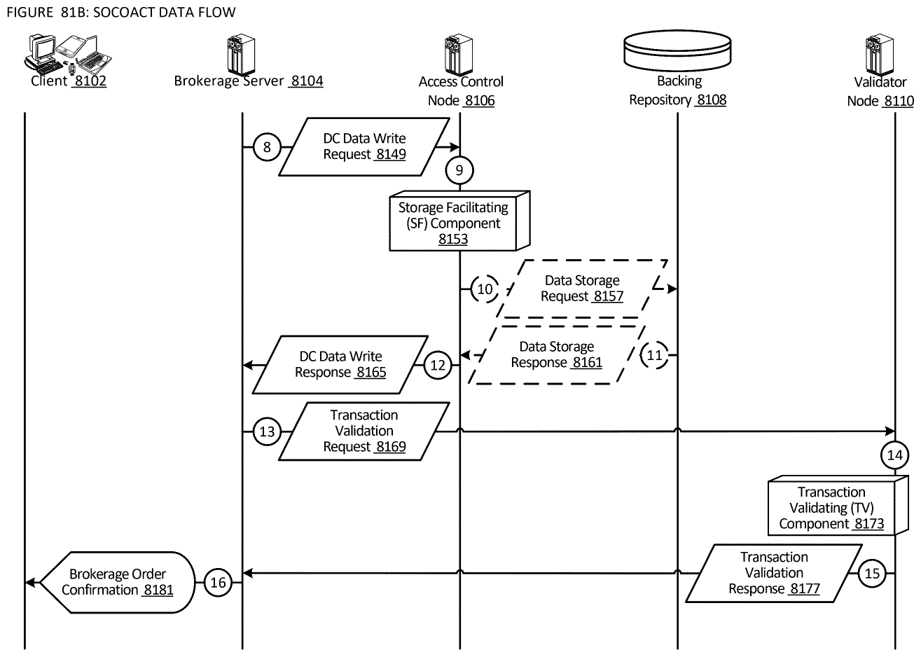

FIGS. 81A-81B show a datagraph diagram illustrating embodiments of a data flow for the SOCOACT. In FIGS. 81A-81B, dashed lines indicate data flow elements that may be more likely to be optional. In FIGS. 81A-81B, a user's client 8102 may send a brokerage order request 8121 to a brokerage server 8104 to request that a brokerage order (e.g., a stock purchase) be executed. For example, the client may be a desktop, a laptop, a tablet, a smartphone, and/or the like that is executing a client application. In one implementation, the brokerage order request may include data such as a request identifier, user data information, a security identifier, an order action, an order type, a quantity, and/or the like. In one embodiment, the client may provide the following example brokerage order request, substantially in the form of a (Secure) Hypertext Transfer Protocol (“HTTP(S)”) POST message including extensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</account_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <client_details> //iOS Client with App and Webkit
      //it should be noted that although several client details
      //sections are provided to show example variants of client
      //sources, further messages will include only on to save
      //space
    <client_IP>10.0.0.123</client_IP>
    <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXXD</client_UDID>
    <client_OS>iOS</client_OS>
    <client_OS_version>7.1.1</client_OS_version>
    <client_app_type>app with webkit</client_app_type>
    <app_installed_flag>true</app_installed_flag>
    <app_name>SOCOACT.app</app_name>
    <app_version>1.0 </app_version>
    <app_webkit_name>Mobile Safari</client_webkit_name>
    <client_version>537.51.2</client_version>
  </client_details>
  <client_details> //iOS Client with Webbrowser
    <client_IP>10.0.0.123</client_IP>
    <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>web browser</client_app_type>
    <client_name>Mobile Safari</client_name>
    <client_version>9537.53</client_version>
  </client_details>
  <client_details> //Android Client with Webbrowser
    <client_IP>10.0.0.123</client_IP>
    <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
    <client_product_type>Nexus S</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Android</client_OS>
    <client_OS_version>4.0.4</client_OS_version>
    <client_app_type>web browser</client_app_type>
    <client_name>Mobile Safari</client_name>
    <client_version>534.30</client_version>
  </client_details>
  <client_details> //Mac Desktop with Webbrowser
    <client_IP>10.0.0.123</client_IP>
    <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
    <client_product_type>MacPro5,1</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Mac OS X</client_OS>
    <client_OS_version>10.9.3</client_OS_version>
    <client_app_type>web browser</client_app_type>
    <client_name>Mobile Safari</client_name>
    <client_version>537.75. 14</client_version>
  </client_details>
  <brokerage_order_request>
    <request_identifier>ID_request_1</request_identifier>
    <user_data_information>
      <user_root_node_identifier>n</user_root_node_identifier>
      <authentication_data>data signed with n's private
key</authentication_data>
  <access_control_node>www.access_control_node.com</access_control_node>
      <read_access>
        <data_node>n₃</data_node>
        <read_access_grant_node>nₐ^{f}ₙ₃</read_access_grant_node>
      </read_access>
      <write_access>
        <write_access_node>n₄^{f}₀</write_access_node>
      </write_access>
    </user_data_information>
    <security>NYSE:IBM</security>
    <order_action>BUY</order_action>
    <order_type>Limit</order_type>
    <quantity>100</quantity>
    <price>$150</price>
  </brokerage_order_request>
</auth_request>
```

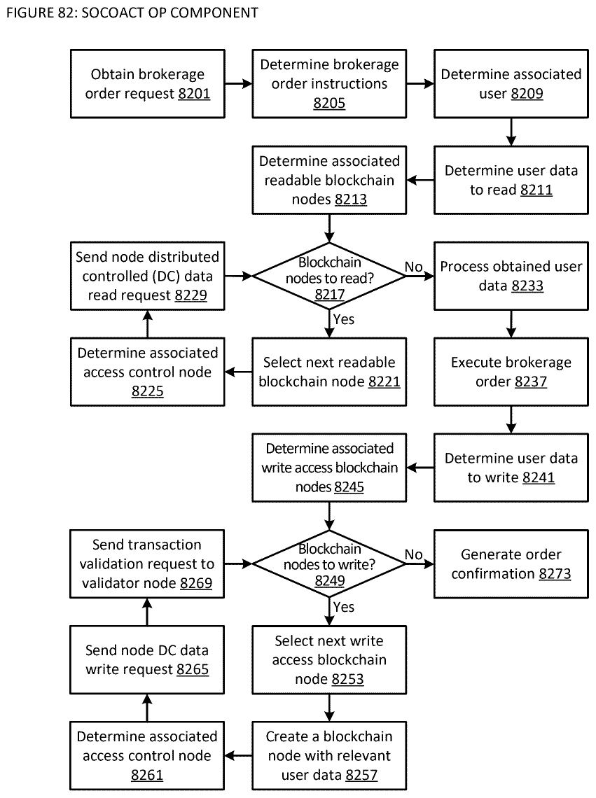

An order processing (OP) component 8125 may utilize data provided in the brokerage order request to facilitate processing the brokerage order. See FIG. 82 for additional details regarding the OP component.

The brokerage server may send a distributed controlled (DC) data read request 8129 to an access control node 8106 (e.g., specified in the brokerage order request) to obtain user data, to which the brokerage server was granted read access by the user, that the brokerage server utilizes to facilitate processing the brokerage order. In one implementation, the DC data read request may include data such as a request identifier, brokerage server authentication data, a data node identifier, a read access grant node identifier (e.g., for the data node), a requested data subset, and/or the like. In one embodiment, the brokerage server may provide the following example DC data read request, substantially in the form of a HTTP(S) POST message including XML-formatted data, as provided below:

```
POST /DC_data_read_request.php HTTP/1.1
Host: www.server.com
Content-Type: Application/XML
Content-Length: 667
<?XML version = “1.0” encoding = “UTF-8”?>
<DC_data_read_request>
  <request_identifier>ID_request_2</request_identifier>
  <brokerage_server_authentication_data>
  <brokerage_server_root_node_identifier>f</brokerage_server_root_node_identif
ier>
    <authentication_data>data signed with f's private
key</authentication_data>
  </brokerage_server_authentication_data>
  <data_node>n₃</data_node>
  <read_access_grant_node>nₐ^{f}ₙ₃</read_access_grant_node>
  <requested_data_subset>address</requested_data_subset>
</DC_data_read_request>
```

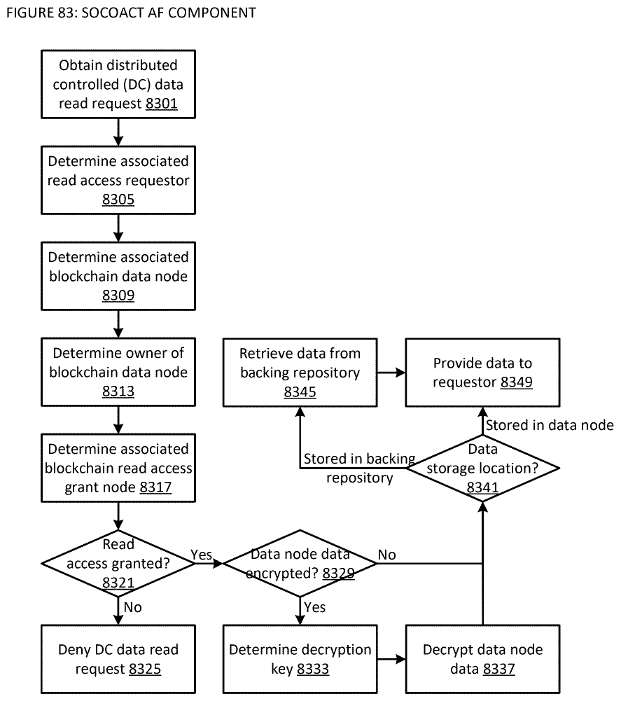

An access facilitating (AF) component 8133 may utilize data provided in the data read request to facilitate providing the requested data to the brokerage server. See FIG. 83 for additional details regarding the AF component.

The access control node may send a data retrieval request 8137 to a backing repository 8108 (e.g., if the requested data is stored in the backing repository). In one implementation, the data retrieval request may comprise one or more SQL statements. The backing repository may provide the requested data to the access control node via a data retrieval response 8141.

The access control node may send a DC data read response 8145 to the brokerage server to provide the requested data to the brokerage server. In one implementation, the DC data read response may include data such as a response identifier, the requested data, and/or the like. In one embodiment, the access control node may provide the following example DC data read response, substantially in the form of a HTTP(S) POST message including XML-formatted data, as provided below:

```
POST /DC_data_read_response.php HTTP/1.1
Host: www.server.com
Content-Type: Application/XML
Content-Length: 667
<?XML version = “1.0” encoding = “UTF-8”?>
<DC_data_read_response>
  <response_identifier>ID_response_2</response_identifier>
  <requested_data>user's mailing address</requested_data>
</DC_data_read_response>
```

The brokerage server may send a DC data write request 8149 to the access control node (e.g., this access control node may be the same as or different from the access control node utilized for the DC data read request) to facilitate storing data (e.g., decryption key data, backing repository data) associated with a newly created blockchain data node (e.g., that stores data regarding the stock purchase). In one implementation, the DC data write request may include data such as a request identifier, brokerage server authentication data, a write access node identifier, a data node identifier, data node write data (e.g., contents of the newly created blockchain data node), data node decryption key, backing repository data (e.g., data to be stored in a backing repository), and/or the like. In one embodiment, the brokerage server may provide the following example DC data write request, substantially in the form of a HTTP(S) POST message including XML-formatted data, as provided below:

```
POST /DC_data_write_request.php HTTP/1.1
Host: www.server.com
Content-Type: Application/XML
Content-Length: 667
<?XML version = “1.0” encoding = “UTF-8”?>
<DC_data_write_request>
  <request_identifier>ID_request_3</request_identifier>
  <brokerage_server_authentication_data>
  <brokerage_server_root_node_identifier>f</brokerage_server_root_node_identif
ier>
    <authentication_data>data signed with f's private
key</authentication_data>
  </brokerage_server_authentication_data>
  <write_access_node>n₄^{f}₀</write_access_node>
  <data_node>fⁿ₄</data_node>
  <data_node_decryption_key>decryption key<data_node_decryption_key>
  <backing_repository_data>data contents</backing_repository_data>
</DC_data_write_request>
```

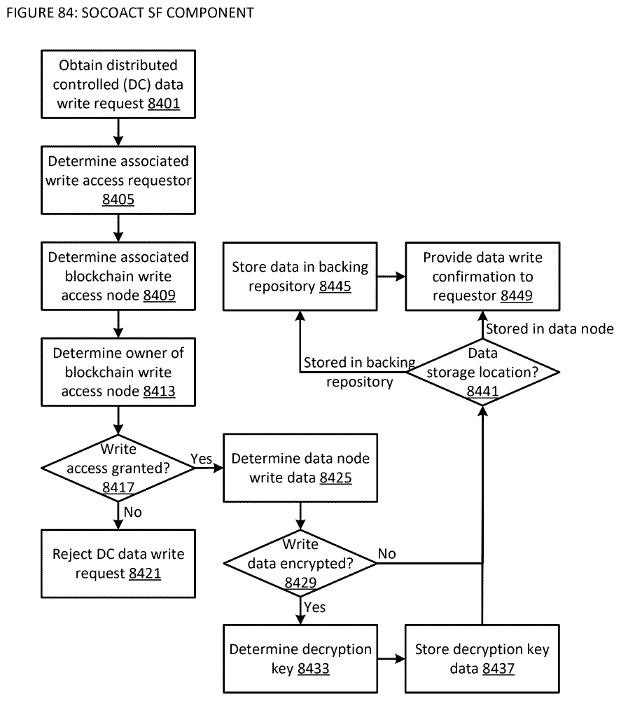

A storage facilitating (SF) component 8153 may utilize data provided in the DC data write request to facilitate storing the specified data. See FIG. 84 for additional details regarding the SF component.

The access control node may send a data storage request 8157 to the backing repository (e.g., if the specified data should be stored in the backing repository; this backing repository may be the same as or different from the backing repository utilized for the DC data read request). In one implementation, the data storage request may comprise one or more SQL statements. The backing repository may store the specified data, and/or may inform the access control node via a data storage response 8161 that the specified data was stored.

The access control node may send a DC data write response 8165 to the brokerage server to provide a data write confirmation to the brokerage server. In one implementation, the DC data write response may include data such as a response identifier, a status, and/or the like. In one embodiment, the access control node may provide the following example DC data write response, substantially in the form of a HTTP(S) POST message including XML-formatted data, as provided below:

```
POST /DC_data_write_response.php HTTP/1.1
Host: www.server.com
Content-Type: Application/XML
Content-Length: 667
<?XML version = “1.0” encoding = “UTF-8”?>
<DC_data_write_response>
  <response_identifier>ID_response_3</response_identifier>
  <status>Data Written Successfully</status>
</DC_data_write_response>
```

The brokerage server may send a transaction validation request 8169 to a validator node 8110 to facilitate storing (e.g., by validating a blockchain transaction to create a data node with the write access node, to which the brokerage server was granted write access by the user, as parent) data (e.g., stock purchase data) on the blockchain. In one implementation, the transaction validation request may include data such as a request identifier, a data node identifier, contents of the newly created blockchain data node, and/or the like. In one embodiment, the brokerage server may provide the following example transaction validation request, substantially in the form of a HTTP(S) POST message including XML-formatted data, as provided below:

```
POST /transaction_validation_request.php HTTP/1.1
Host: www.server.com
Content-Type: Application/XML
Content-Length: 667
<?XML version = “1.0” encoding = “UTF-8”?>
<transaction_validation_request>
  <request_identifier>ID_request_4</request_identifier>
  <data_node>fⁿ₄</data_node>
</transaction_validation_request>
```

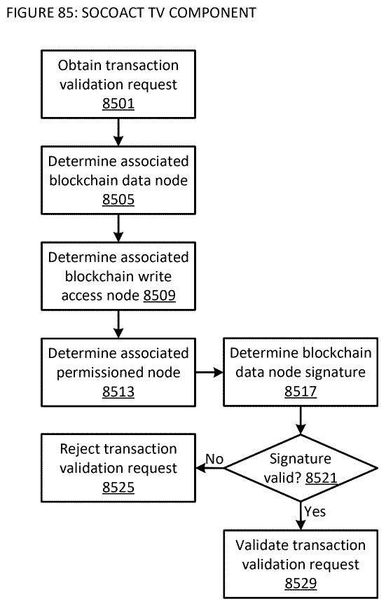

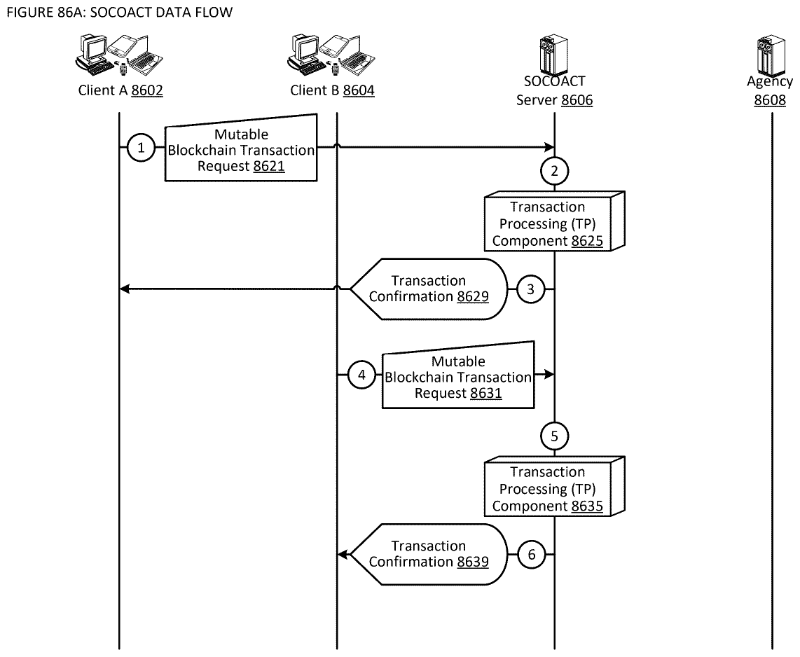

A transaction validating (TV) component 8173 may utilize data provided in the transaction validation request to facilitate validating the associated blockchain transaction. See FIG. 85 for additional details regarding the TV component.

The validator node may send a transaction validation response 8177 to the brokerage server to confirm whether the associated blockchain transaction was validated. In one implementation, the transaction validation response may include data such as a response identifier, a status, and/or the like. In one embodiment, the validator node may provide the following example transaction validation response, substantially in the form of a HTTP(S) POST message including XML-formatted data, as provided below:

```
POST /transaction_validation_response.php HTTP/1.1
Host: www.server.com
Content-Type: Application/XML
Content-Length: 667
<?XML version = “1.0” encoding = “UTF-8”?>
<transaction_validation_response>
  <response_identifier>ID_response_4</response_identifier>
  <status>Transaction Validated</status>
</transaction_validation_response>
```

The brokerage server may send a brokerage order confirmation 8181 to the client to inform the user that the brokerage order has been processed. In one implementation, the brokerage order confirmation may include data such as a response identifier, a status, and/or the like. In one embodiment, the brokerage server may provide the following example brokerage order confirmation, substantially in the form of a HTTP(S) POST message including XML-formatted data, as provided below:

```
POST /brokerage_order_confirmation.php HTTP/1.1
Host: www.server.com
Content-Type: Application/XML
Content-Length: 667
<?XML version = “1.0” encoding = “UTF-8”?>
<brokerage_order_confirmation>
  <response_identifier>ID_response_1</response_identifier>
  <status>Order Processed Successfully</status>
</brokerage_order_confirmation>
```

FIG. 82 shows a logic flow diagram illustrating embodiments of an order processing (OP) component for the SOCOACT. In FIG. 82, a brokerage order request may be received at 8201. For example, a user may send the brokerage order request to request that a brokerage order (e.g., a stock purchase) be executed.

Brokerage order instructions may be determined at 8205. In one implementation, the brokerage order request may be parsed (e.g., using PHP commands) to determine the brokerage order instructions. For example, the user may wish to place an order to buy 100 shares of IBM stock with a limit price of $150 per share.

The user associated with the brokerage order request may be determined at 8209. In one implementation, the brokerage order request may be parsed (e.g., using PHP commands) to determine the user's user root node identifier (e.g., n). In another implementation, authentication data (e.g., specified data signed with n's private key) may be validated (e.g., decrypted with n's public key) to confirm that the brokerage order request was sent by the user (e.g., n).

User data to read may be determined at 8211. In one implementation, such data may be determined based on information utilized to process the brokerage order. For example, such data may include the user's mailing address, the user's name, the user's funds (e.g., Bitcoins) used to pay for the stock purchase, and/or the like.

Associated readable blockchain nodes utilized to obtain the user data to read may be determined at 8213. In one implementation, the brokerage order request may be parsed (e.g., using PHP commands) to determine the read access data nodes provided by the user. In another implementation, the brokerage order request may be parsed (e.g., using PHP commands) to also determine read access grant nodes associated with the read access data nodes (e.g., to make the process of finding the associated read access grant nodes more efficient for access control nodes).

A determination may be made at 8217 whether there remain readable blockchain data nodes to read. In one implementation, any readable blockchain data node specified by the user may be read. In another implementation, readable blockchain data nodes that include the user data to read may be determined and read. If there remain readable blockchain data nodes to read, the next readable blockchain data node may be selected at 8221.

An access control node associated with the selected readable blockchain data node may be determined at 8225. In one embodiment, an access control node may be utilized to obtain user data specified in a blockchain data node (e.g., the access control node may verify that a read access grant node grants a requestor access to the blockchain data node, and/or may provide the requestor with the specified user data). In one implementation, the brokerage order request may be parsed (e.g., using PHP commands) to determine the associated access control node. For example, a URI utilized to send data read requests to the access control node may be determined. In another implementation, the associated access control node may be determined by retrieving a user setting that specifies an access control node utilized by the user from a database.

A distributed controlled (DC) data read request may be sent to the associated access control node at 8229 to obtain user data specified in the selected readable blockchain data node. In one implementation, the DC data read request may be sent (e.g., via an API call) to the URI associated with the access control node, and the user data may be obtained from the access control node via a DC data read response.

The obtained user data may be processed at 8233. In one implementation, the obtained user data may be utilized to generate the brokerage order. For example, order information (e.g., the user's mailing address) may be filled out using the obtained user data. In another example, availability of funds to pay for the brokerage order may be verified.

The brokerage order may be executed at 8237. In one implementation, the brokerage order may be sent to a stock exchange for execution. User data to write may be determined at 8241. In one implementation, such data may be determined based on information that should be recorded to document the brokerage order (e.g., the stock purchase). For example, a brokerage firm may write data that indicates that the user owns 100 shares of IBM stock.

Associated write access blockchain nodes utilized to write the user data to write may be determined at 8245. In one implementation, the brokerage order request may be parsed (e.g., using PHP commands) to determine the write access blockchain nodes provided by the user. For example, a write access blockchain node may grant the brokerage firm (e.g., based on the brokerage firm's user root node identifier f) permission to create data nodes with the write access blockchain node as parent (e.g., the brokerage firm may write data to the user's tree of user-owned data).

A determination may be made at 8249 whether there remain blockchain data nodes to write. In one implementation, the user data to write may be written to a blockchain data node with the determined write access blockchain node as parent. In another implementation, the user data to write associated with a category and/or subcategory may be written to a blockchain data node with determined parent write access blockchain node associated with the corresponding category and/or subcategory. If there remain blockchain data nodes to write, the next write access blockchain node may be selected at 8253.

A blockchain data node with relevant user data to write and with the selected write access blockchain node as parent may be created at 8257. In one embodiment, the newly created blockchain data node may be signed with the brokerage firm's signature (e.g., using the brokerage firm's private key pK_{f}). In one implementation, the user data to write may be stored in the newly created blockchain data node (e.g., encrypted or unencrypted). In another implementation, the user data to write may be stored in a backing repository, and the newly created blockchain data node may store data (e.g., an identifier of a database and/or database record) that may be utilized to retrieve the user data to write.

An access control node associated with the newly created blockchain data node may be determined at 8261. In one embodiment, an access control node may be utilized to store a decryption key associated with a blockchain data node. In another embodiment, an access control node may be utilized to store data (e.g., the user data to write) in a backing repository. In one implementation, the brokerage order request may be parsed (e.g., using PHP commands) to determine the associated access control node. For example, a URI utilized to send data write requests to the access control node may be determined. In another implementation, the associated access control node may be determined by retrieving a user setting that specifies an access control node utilized by the user from a database.

A DC data write request may be sent to the associated access control node at 8265. For example, the associated access control node may verify that a write access node grants a requestor (e.g., the brokerage firm with user root node identifier f) access to create a child blockchain data node, may store the associated decryption key, may store data in a backing repository, and/or the like. In one implementation, the DC data write request may be sent (e.g., via an API call) to the URI associated with the access control node.

A transaction validation request may be sent to a validator node at 8269. For example, the validator node may verify that the signature of the newly created blockchain data node is valid, may add the newly created blockchain data node to the blockchain, and/or the like. In one implementation, the validator node may be a peer in a network (e.g., a miner in the Bitcoin network).

An order confirmation for the brokerage order may be generated for the user at 8273. For example, the user may be informed that the brokerage order has been processed. The information associated with the processed brokerage order (e.g., the user owns 100 shares of IBM stock) is stored in a blockchain data node (e.g., in the user's tree of user-owned data) that is signed by the brokerage firm. As such, other brokerage firms (e.g., in a network of trusted brokerage firms), to which the user grants read access, may trust this information because it is signed by a trusted member brokerage firm.

FIG. 83 shows a logic flow diagram illustrating embodiments of an access facilitating (AF) component for the SOCOACT. In FIG. 83, a distributed controlled (DC) data read request may be obtained at 8301. For example, a user (e.g., via a client) may send the DC data read request to access the user's data. In another example, a brokerage firm (e.g., via a brokerage server) may send the DC data read request to access the user's data.

A requestor (e.g., the user, the brokerage firm) associated with the DC data read request may be determined at 8305. In one implementation, the DC data read request may be parsed (e.g., using PHP commands) to determine the requestor's (e.g., the brokerage firm's) user root node identifier (e.g., f). In another implementation, authentication data (e.g., specified data signed with f's private key) may be validated (e.g., decrypted with f's public key) to confirm that the DC data read request was sent by the requestor (e.g., f).

A blockchain data node (e.g., or a set of blockchain data nodes) associated with the DC data read request may be determined at 8309. In one implementation, the DC data read request may be parsed (e.g., using PHP commands) to determine the blockchain data node specified by the requestor (e.g., the blockchain data node with node identifier n₃).

The owner (e.g., the user with user root node identifier n) of the blockchain data node may be determined at 8313. In one implementation, the blockchain data node may be parsed (e.g., using PHP commands) to determine the value of the “parent node” field. The “parent node” field may be used to iteratively traverse the owner's tree of user-owned data to reach the root node, which specifies the owner's user root node identifier (e.g., n).

A read access grant node (e.g., the read access grant node with node identifier nₐ^{f}ₙ₃) associated with the blockchain data node may be determined at 8317. In one implementation, the blockchain may be analyzed (e.g., searched through) to determine the associated read access grant node. In another implementation, the DC data read request may be parsed (e.g., using PHP commands) to determine the associated read access grant node.

A determination may be made at 8321 whether read access to the blockchain data node has been granted to the requestor. In one implementation, the requestor's user root node identifier may be compared with the owner's user root node identifier to make this determination (e.g., if the requestor is the owner, the requestor has read access). In another implementation, the requestor's user root node identifier may be compared with the value of the “permissioned node” field of the associated read access grant node (e.g., to check if the requestor was granted read access by the owner). If it is determined that read access has not been granted, the DC data read request may be denied at 8325. For example, the requestor may be informed that the requestor does not have read access to the blockchain data node.

If it is determined that read access has been granted, a determination may be made at 8329 whether data in the blockchain data node is encrypted. In one implementation, the blockchain data node data may be parsed (e.g., using PHP commands) to make this determination. In another implementation, a database record (e.g., stored in a backing repository) associated with the blockchain data node (e.g., based on the node identifier of the blockchain data node) may be checked to make this determination.

If it is determined that the blockchain data node data is encrypted, the decryption key associated with the blockchain data node data may be retrieved at 8333. In one implementation, the decryption key may be retrieved (e.g., based on the node identifier of the blockchain data node) from the backing repository. The blockchain data node data may be decrypted using the retrieved decryption key at 8337.

A determination may be made at 8341 regarding the storage location of the data (e.g., the owner's mailing address) requested by the requestor. In one embodiment, the requested data may be stored in the backing repository. Accordingly, the requested data may be retrieved from the backing repository at 8345. For example, the blockchain data node data may include a database record identifier that may be used to retrieve the requested data via a MySQL database command similar to the following:

SELECT mailingAddress
FROM DataNode
WHERE dataNodeID = ID_database_record;

In another embodiment, the requested data may be stored in the blockchain data node. Accordingly, the requested data may be determined (e.g., parsed) from the blockchain data node data. For example, the decrypted blockchain data node data may be parsed to determine the owner's mailing address.

The requested data may be provided to the requestor at 8349. In one implementation, the requested data may be provided via a DC data read response.

FIG. 84 shows a logic flow diagram illustrating embodiments of a storage facilitating (SF) component for the SOCOACT. In FIG. 84, a distributed controlled (DC) data write request may be obtained at 8401. For example, a user (e.g., via a client) may send the DC data write request to store data, associated with a blockchain data node in the user's tree of user-owned data, in a backing repository. In another example, a brokerage firm (e.g., via a brokerage server) may send the DC data write request to store data, associated with a blockchain data node created by the brokerage firm in the user's tree of user-owned data, in a backing repository.

A requestor (e.g., the user, the brokerage firm) associated with the DC data write request may be determined at 8405. In one implementation, the DC data write request may be parsed (e.g., using PHP commands) to determine the requestor's (e.g., the brokerage firm's) user root node identifier (e.g., f). In another implementation, authentication data (e.g., specified data signed with f's private key) may be validated (e.g., decrypted with f's public key) to confirm that the DC data write request was sent by the requestor (e.g., f).

A write access blockchain node (e.g., or a set of write access blockchain nodes) associated with the DC data write request may be determined at 8409. In one implementation, the DC data write request may be parsed (e.g., using PHP commands) to determine the write access blockchain node specified by the requestor (e.g., the write access blockchain node with node identifier n₄^{f}₀). In another implementation, the DC data write request may be parsed (e.g., using PHP commands) to determine a blockchain data node created by the requestor (e.g., the blockchain data node with node identifier fⁿ₄). The value of the “parent node” field of the blockchain data node created by the requestor may be determined. The “parent node” field may be used to iteratively traverse the owner's tree of user-owned data to reach the associated write access blockchain node (e.g., the write access blockchain node with node identifier n₄^{f}₀).

The owner (e.g., the user with user root node identifier n) of the write access blockchain node may be determined at 8413. In one implementation, the write access blockchain node may be parsed (e.g., using PHP commands) to determine the value of the “parent node” field. The “parent node” field may be used to iteratively traverse the owner's tree of user-owned data to reach the root node, which specifies the owner's user root node identifier (e.g., n).

A determination may be made at 8417 whether write access has been granted to the requestor by the write access blockchain node. In one implementation, the requestor's user root node identifier may be compared with the user root node identifier of the owner of the tree of user-owned data to make this determination (e.g., if the requestor is the owner, the requestor has write access). In another implementation, the requestor's user root node identifier may be compared with the value of the “permissioned node” field of the associated write access blockchain node (e.g., to check if the requestor was granted write access by the owner). If it is determined that write access has not been granted, the DC data write request may be rejected at 8421. For example, the requestor may be informed that the requestor does not have write access to create a blockchain data node with the write access blockchain node as parent.

If it is determined that write access has been granted, write data associated with the blockchain data node created by the requestor may be determined at 8425. In one implementation, the DC data write request may be parsed (e.g., using PHP commands) to make this determination. For example, the write data may include data stored in the blockchain data node. In another example, the write data may include data associated with the blockchain data node to be stored in the backing repository.

A determination may be made at 8429 whether the write data is encrypted. In one implementation, the blockchain data node data may be parsed to make this determination. In another implementation, the DC data write request may be parsed (e.g., using PHP commands) to make this determination.

If it is determined that the write data is encrypted, the decryption key associated with the write data may be determined at 8433. In one implementation, the DC data write request may be parsed (e.g., using PHP commands) to determine the decryption key. Decryption key data (e.g., the decryption key, the blockchain data node associated with the decryption key) may be stored at 8437 (e.g., in the backing repository).

A determination may be made at 8441 regarding the storage location of the write data (e.g., the user owns 100 shares of IBM stock). In one embodiment, the write data should be stored in the backing repository. Accordingly, the write data may be stored in the backing repository at 8445. For example, the blockchain data node created by the requestor may include a database record identifier that may be used to store the write data via a MySQL database command similar to the following:

INSERT INTO DataNode (dataNodeID, stockOwnershipData)
VALUES (ID_database_record, “100 shares of IBM stock”);

A data write confirmation may be provided to the requestor at 8449. In one implementation, the data write confirmation may be provided via a DC data write response to inform the requestor that the DC data write request was processed successfully.

FIG. 85 shows a logic flow diagram illustrating embodiments of a transaction validating (TV) component for the SOCOACT. In FIG. 85, a transaction validation request may be obtained (e.g., by a validator node) at 8501 from a requestor. For example, a user (e.g., via a client) may send the transaction validation request to add a blockchain data node in the user's tree of user-owned data to the blockchain. In another example, a brokerage firm (e.g., via a brokerage server) may send the transaction validation request to add a blockchain data node created by the brokerage firm in the user's tree of user-owned data to the blockchain.

A blockchain data node associated with the transaction validation request may be determined at 8505. In one implementation, the transaction validation request may be parsed (e.g., using PHP commands) to determine the blockchain data node (e.g., the blockchain data node with node identifier fⁿ₄) to add specified by the requestor (e.g., the user, the brokerage firm).

A write access blockchain node associated with the blockchain data node may be determined at 8509. In one implementation, the blockchain data node may be parsed (e.g., using PHP commands) to determine the value of the “parent node” field of the blockchain data node. The “parent node” field may be used to iteratively traverse the user's tree of user-owned data to reach the associated write access blockchain node (e.g., the write access blockchain node with node identifier n₄^{f}₀).

A permissioned node specified by the write access blockchain node may be determined at 8513. In one implementation, the write access blockchain node may be parsed (e.g., using PHP commands) to determine the value of the “permissioned node” field (e.g., f) of the write access blockchain node.

A signature associated with the blockchain data node may be determined at 8517. In one implementation, the blockchain data node may be parsed (e.g., using PHP commands) to determine the signature.

A determination may be made at 8521 whether the signature of the blockchain data node is valid. In one implementation, the public key associated with the permissioned node (e.g., the brokerage firm's public key PKr) may be used with the signature to determine whether the signature is valid. For example, the signature may be decrypted using the public key and compared to the value of a hash of: 1) the transaction type (tx_type), 2) the data blob, and 3) the parent access node, associated with the blockchain data node. If the values of the decrypted signature and the hash match, the signature is valid.

If it is determined that the signature of the blockchain data node is not valid, the transaction validation request may be rejected at 8525. For example, the requestor may be informed that the blockchain data node is invalid.

If it is determined that the signature of the blockchain data node is valid, the transaction validation request may be validated at 8529. In some implementations, the blockchain data node may be added to the blockchain copy of the validator node and/or sent to other network peers for validation. In some implementations, a transaction validation response may be sent to the requestor to inform the requestor that the transaction was validated successfully.

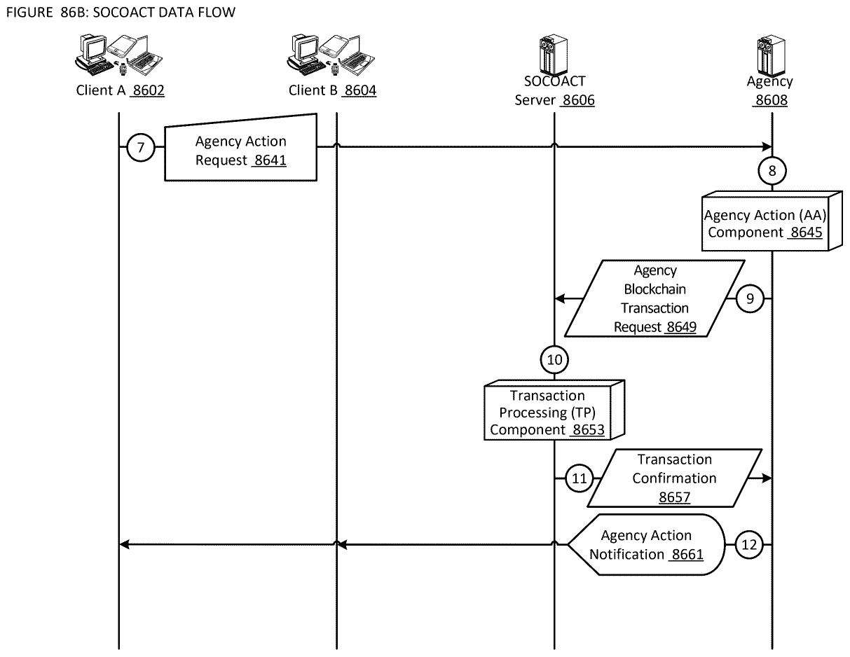

FIGS. 86A-86B show a datagraph diagram illustrating embodiments of a data flow for the SOCOACT. In FIGS. 86A-86B, client A 8602 (e.g., of user A utilizing an agency oversight configured blockchain) may send a mutable blockchain transaction request 8621 to a SOCOACT server 8606 to facilitate processing (e.g., adding to the blockchain) a mutable blockchain transaction (e.g., the transaction may involve transferring crypto tokens (e.g., 50 Bitcoins) from user A to user B associated with client B 8604). For example, client A may be a desktop, a laptop, a tablet, a smartphone, and/or the like that is executing a client application. In one implementation, the mutable blockchain transaction request may include data such as a request identifier, blockchain transaction data, and/or the like. In one embodiment, client A may provide the following example mutable blockchain transaction request, substantially in the form of a HTTP(S) POST message including XML-formatted data, as provided below:

```
POST /mutable_blockchain_transaction_request.php HTTP/1.1
Host: www.server.com
Content-Type: Application/XML
Content-Length: 667
<?XML version = “1.0” encoding = “UTF-8”?>
<mutable_blockchain_transaction_request>
  <request_identifier>ID_request_11</request_identifier>
  <blockchain_transaction_data>
    <input>
      <previous_transaction_hash>transaction
identifier</previous_transaction_hash>
      <index>0</index>
      <scriptSig>
        <signature>user A's signature</signature>
        <serialized_script>
          {1 [user A's public key] [agency's public key] 2
          OP_CHECKMULTISIG}
        </serialized_script>
      </scriptSig>
    </input>
    <output>
      <value>5000000000</value>
      <scriptPubKey>
        OP_HASH160
        [20-byte-hash of {1 [user B's public key] [agency's public
```

| | |
|---|---|
| key] | 2 |

```
        OP_CHECKMULTISIG}]
        OP_EQUAL
      </scriptPubKey>
    </output>
  </blockchain_transaction_data>
</mutable_blockchain_transaction_request>
```

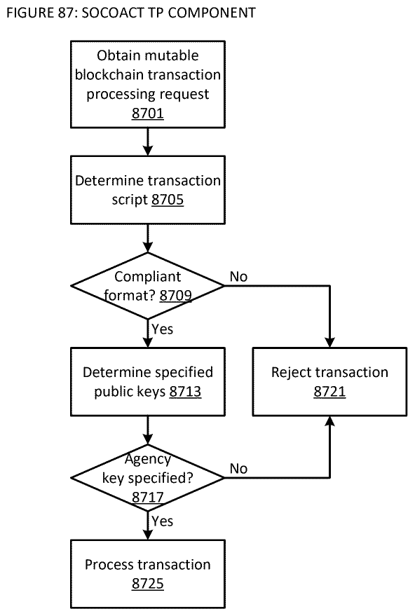

A transaction processing (TP) component 8625 may verify that a specially formatted mutable blockchain transaction request compatible with the agency oversight configured blockchain was received and/or may facilitate transaction processing. See FIG. 87 for additional details regarding the TP component.

The SOCOACT server may send a transaction confirmation 8629 to client A to inform user A whether the mutable blockchain transaction was processed successfully. In one implementation, the transaction confirmation may include data such as a response identifier, a status, and/or the like. In one embodiment, the SOCOACT server may provide the following example transaction confirmation, substantially in the form of a HTTP(S) POST message including XML-formatted data, as provided below:

```
POST /transaction_confirmation.php HTTP/1.1
Host: www.server.com
Content-Type: Application/XML
Content-Length: 667
<?XML version = “1.0” encoding = “UTF-8”?>
<transaction_confirmation>
  <response_identifier>ID_response_11</response_identifier>
  <status>OK</status>
</transaction_confirmation>
```

Client B 8604 (e.g., of user B utilizing the agency oversight configured blockchain) may send a mutable blockchain transaction request 8631 to the SOCOACT server to facilitate processing (e.g., adding to the blockchain) a mutable blockchain transaction (e.g., the transaction may involve transferring crypto tokens (e.g., 50 Bitcoins received from user A) from user B to user C). For example, client B may be a desktop, a laptop, a tablet, a smartphone, and/or the like that is executing a client application. In one implementation, the mutable blockchain transaction request may include data such as a request identifier, blockchain transaction data, and/or the like. In one embodiment, client B may provide the following example mutable blockchain transaction request, substantially in the form of a HTTP(S) POST message including XML-formatted data, as provided below:

```
POST /mutable_blockchain_transaction_request.php HTTP/1.1
Host: www.server.com
Content-Type: Application/XML
Content-Length: 667
<?XML version = “1.0” encoding = “UTF-8”?>
<mutable_blockchain_transaction_request>
  <request_identifier>ID_request_12</request_identifier>
  <blockchain_transaction_data>
    <input>
      <previous_transaction_hash>transaction
identifier</previous_transaction_hash>
      <index>0</index>
      <scriptSig>
        <signature>user B's signature</signature>
        <serialized_script>
          {1 [user B's public key] [agency's public key] 2
          OP_CHECKMULTISIG}
        </serialized_script>
      </scriptSig>
    </input>
    <output>
      <value>5000000000</value>
      <scriptPubKey>
        OP_HASH160
        [20-byte-hash of {1 [user C's public key] [agency's public
```

| | |
|---|---|
| key] | 2 |

```
        OP_CHECKMULTISIG}]
        OP_EQUAL
      </scriptPubKey>
    </output>
  </blockchain_transaction_data>
</mutable_blockchain_transaction_request>
```

A transaction processing (TP) component 8635 may verify that a specially formatted mutable blockchain transaction request compatible with the agency oversight configured blockchain was received and/or may facilitate transaction processing. See FIG. 87 for additional details regarding the TP component.

The SOCOACT server may send a transaction confirmation 8639 to client B to inform user B whether the mutable blockchain transaction was processed successfully. In one implementation, the transaction confirmation may include data such as a response identifier, a status, and/or the like. In one embodiment, the SOCOACT server may provide the following example transaction confirmation, substantially in the form of a HTTP(S) POST message including XML-formatted data, as provided below:

```
POST /transaction_confirmation.php HTTP/1.1
Host: www.server.com
Content-Type: Application/XML
Content-Length: 667
<?XML version = “1.0” encoding = “UTF-8”?>
<transaction_confirmation>
  <response_identifier>ID_response_12</response_identifier>
  <status>OK</status>
</transaction_confirmation>
```

Client A may send an agency action request 8641 to an agency 8608 (e.g., the agency providing oversight over the agency oversight configured blockchain) to request that the agency unwind a specified mutable blockchain transaction (e.g., the transaction associated with the mutable blockchain transaction request 8621). For example, user A may wish to unwind the specified transaction for a variety of reasons, such as the transaction was made by mistake, the transaction was unauthorized, user B failed to honor the terms of an agreement associated with the transaction, and/or the like. In one implementation, the agency action request may include data such as a request identifier, reason for request, transaction to unwind, unwind amount, unwind address (e.g., address associated with user A where unwound crypto tokens should be deposited), and/or the like. In one embodiment, client A may provide the following example agency action request, substantially in the form of a HTTP(S) POST message including XML-formatted data, as provided below:

```
POST /agency_action_request.php HTTP/1.1
Host: www.server.com
Content-Type: Application/XML
Content-Length: 667
<?XML version = “1.0” encoding = “UTF-8”?>
<agency_action_request>
  <request_identifier>ID_request_13</request_identifier>
  <reason>unauthorized transaction</reason>
  <transaction_to_unwind>
    transaction identifier associated with the mutable blockchain
transaction request 8621
  </transaction_to_unwind>
  <unwind_amount>5000000000</unwind_amount>
  <unwind_address>3HnhWpkMHMjgt167kvgcPyurMmsCQ2WPgg</unwind_address>
</agency_action_request>
```

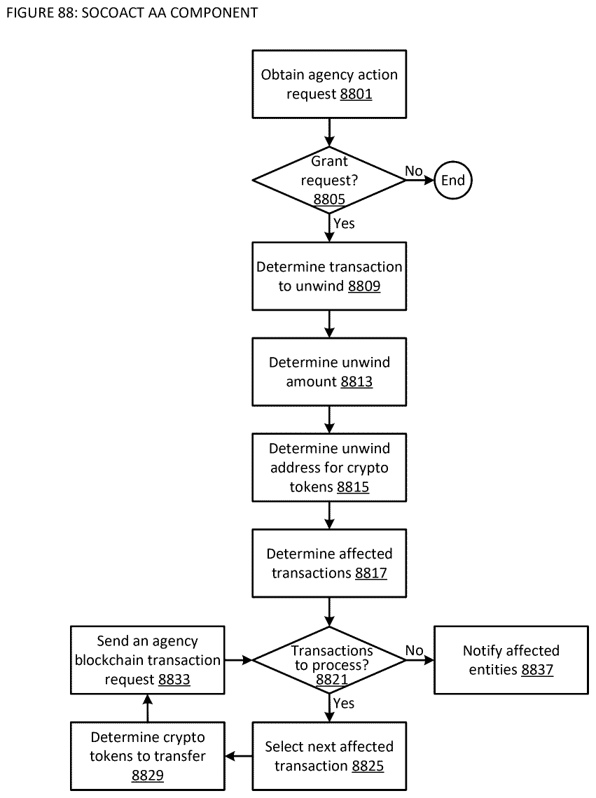

An agency action (AA) component 8645 may utilize data provided in the agency action request to facilitate unwinding the specified transaction. See FIG. 88 for additional details regarding the AA component.

The agency may send one or more agency blockchain transaction requests 8649 to the SOCOACT server to facilitate unwinding the specified transaction. For example, the agency may transfer crypto tokens associated with the specified transaction to the unwind address. In one implementation, the agency blockchain transaction request may include data such as a request identifier, blockchain transaction data, and/or the like. In one embodiment, the agency may provide the following example agency blockchain transaction request, substantially in the form of a HTTP(S) POST message including XML-formatted data, as provided below:

```
POST /agency_blockchain_transaction_request.php HTTP/1.1
Host: www.server.com
Content-Type: Application/XML
Content-Length: 667
<?XML version = “1.0” encoding = “UTF-8”?>
<agency_blockchain_transaction_request>
  <request_identifier>ID_request_14</request_identifier>
  <blockchain_transaction_data>
    <input>
      <previous_transaction_hash>
        transaction identifier associated with the mutable
```

| | |
|---|---|
| blockchain | transaction |

```
        request 8631
      </previous_transaction_hash>
      <index>0</index>
      <scriptSig>
        <signature>agency's signature</signature>
        <serialized_script>
          {1 [user C's public key] [agency's public key] 2
          OP_CHECKMULTISIG}
        </serialized_script>
      </scriptSig>
    </input>
    <output>
      <value>5000000000</value>
      <scriptPubKey>
        OP_HASH160
        [20-byte-hash of {1 [unwind address] [agency's public key]
2
        OP_CHECKMULTISIG}]
        OP_EQUAL
      </scriptPubKey>
    </output>
  </blockchain_transaction_data>
</agency_blockchain_transaction_request>
```

A transaction processing (TP) component 8653 may verify that a specially formatted agency blockchain transaction request compatible with the agency oversight configured blockchain was received and/or may facilitate transaction processing. See FIG. 87 for additional details regarding the TP component.

The SOCOACT server may send a transaction confirmation 8657 to the agency to inform the agency whether the agency blockchain transaction was processed successfully. In one implementation, the transaction confirmation may include data such as a response identifier, a status, and/or the like. In one embodiment, the SOCOACT server may provide the following example transaction confirmation, substantially in the form of a HTTP(S) POST message including XML-formatted data, as provided below:

```
POST /transaction_confirmation.php HTTP/1.1
Host: www.server.com
Content-Type: Application/XML
Content-Length: 667
<?XML version = “1.0” encoding = “UTF-8”?>
<transaction_confirmation>
  <response_identifier>ID_response_14</response_identifier>
  <status>OK</status>
</transaction_confirmation>
```

The agency may send an agency action notification 8661 to users utilizing the agency oversight configured blockchain who were affected by the agency action. The agency action notification may be used to inform these users (e.g., user A, user B, user C) regarding the agency action (e.g., that the specified transaction was unwound and crypto tokens transferred). For example, the agency action notification may be displayed using a SOCOACT website, application (e.g., a mobile app), sent via SMS, sent via email, and/or the like.

FIG. 87 shows a logic flow diagram illustrating embodiments of a transaction processing (TP) component for the SOCOACT. In FIG. 87, a mutable blockchain transaction processing request may be obtained at 8701. For example, the mutable blockchain transaction processing request may be obtained as a result of a user sending a mutable blockchain transaction request to add a transaction to an agency oversight configured blockchain.

A transaction script associated with the transaction may be determined at 8705. In one implementation, the mutable blockchain transaction request may be parsed (e.g., using PHP commands) to determine the value of the scriptPubKey field. For example, the scriptPubKey field may include a redeem script (e.g., {1 [user B's public key] [agency's public key] 2 OP_CHECKMULTISIG}) and a 20 byte hash of the redeem script. In other implementations, Etherium, smart contracts, and/or the like may be utilized, and an analogous transaction script may be determined.

A determination may be made at 8709 whether the transaction has a compliant format. In one implementation, this determination may be made based on the redeem script (e.g., whether the redeem script is a 1-of-n multisignature (multisig) script). In other implementations, Etherium, smart contracts, and/or the like may be utilized, and an analogous determination may be made. If the transaction is not in a compliant format, the transaction may be rejected (e.g., not added to the blockchain) at 8721.

If the transaction is in a compliant format, specified public keys associated with the redeem script may be determined at 8713. In one implementation, the redeem script may be parsed (e.g., using PHP commands) to determine the public keys specified for the 1-of-n multisig.

A determination may be made at 8717 whether a public key associated with the agency providing oversight over the agency oversight configured blockchain is one of the specified public keys. For example, having a public key associated with the agency specified for the 1-of-n multisig may ensure that the agency is able to unwind the transaction. In one implementation, this determination may be made by making an API call (e.g., to the agency) to check whether any of the specified public keys is associated with the agency. If none of the specified public keys is associated with the agency, the transaction may be rejected (e.g., not added to the blockchain) at 8721.

If one of the specified public keys is associated with the agency, the transaction may be processed at 8725. In one implementation, the transaction may be added to the blockchain (e.g., in a similar manner as a Bitcoin transaction). In other implementations, Etherium, smart contracts, and/or the like may be utilized, and the transaction may be processed in an analogous manner.

FIG. 88 shows a logic flow diagram illustrating embodiments of an agency action (AA) component for the SOCOACT. In FIG. 88, an agency action request may be obtained at 8801. For example, the agency action request may be obtained as a result of a user (e.g., user A) requesting that the agency unwind a specified mutable blockchain transaction (e.g., the transaction associated with the mutable blockchain transaction request 8621).

A determination may be made at 8805 whether to grant the agency action request. In one implementation, the agency action request may be parsed (e.g., using PHP commands) to determine the reason for the request. If the reason is legitimate (e.g., the transaction was unauthorized), the request to unwind the transaction may be granted.

The transaction to unwind may be determined at 8809. In one implementation, the agency action request may be parsed (e.g., using PHP commands) to determine a transaction identifier of the unwind transaction (e.g., the transaction identifier associated with the mutable blockchain transaction request 8621).

An unwind amount may be determined at 8813. For example, the unwind amount may be the amount of crypto tokens that should be returned to the requesting user (e.g., the full amount associated with the unwind transaction, a partial amount). In one implementation, the agency action request may be parsed (e.g., using PHP commands) to determine the unwind amount.

An unwind address for crypto tokens may be determined at 8815. For example, the unwind address may be an address associated with the requesting user where unwound crypto tokens should be deposited. In one implementation, the agency action request may be parsed (e.g., using PHP commands) to determine the unwind address.

Affected transactions may be determined at 8817. In one embodiment, the crypto tokens associated with the unwind transaction may be unspent. As such, the unwind transaction may be the affected transaction (e.g., user B has not spent the crypto tokens, and the crypto tokens may be transferred from the multisig address associated with the mutable blockchain transaction request 8621). In another embodiment, the crypto tokens associated with the unwind transaction may be spent. As such, transactions associated with the crypto tokens being spent (e.g., the transaction associated with the mutable blockchain transaction request 8631 in which user B sent the crypto tokens to user C) for which the crypt tokens are unspent may be the affected transactions. In one implementation, the affected transactions may be determined by analyzing the agency oversight configured blockchain to determine transactions with unspent crypt tokens that originated from the unwind transaction. See FIG. 11 for an example of determining affected transactions.

A determination may be made at 8821 whether there remain affected transactions to process. In one implementation, each of the affected transactions may be processed. If there remain affected transactions to process, the next affected transaction may be selected at 8825. For example, the transaction associated with the mutable blockchain transaction request 8631 may be selected.

Crypto tokens to transfer may be determined at 8829. In one implementation, the amount of crypto tokens to transfer may be determined based on (e.g., equal to) the amount of crypto tokens associated with the selected affected transaction that originated from the unwind transaction. For example, the amount of crypto tokens to transfer for the transaction associated with the mutable blockchain transaction request 8631 may be 50 Bitcoins. See FIG. 11 for an example of determining the amount of crypto tokens to transfer.

An agency blockchain transaction request that facilitates transferring the determined amount of crypto tokens to the unwind address may be sent at 8833. In one implementation, separate agency blockchain transaction requests may be sent for each affected transaction (e.g., if there are multiple affected transactions, a plurality of unwind addresses may be utilized (e.g., an unwind address for each affected transaction) to transfer the crypto tokens). In another implementation, an agency blockchain transaction request may be utilized for the set of the affected transactions (e.g., the agency blockchain transaction request may include a plurality of input fields (e.g., an input field for each affected transaction)).

Affected entities may be notified at 8837. For example, the affected entities (e.g., user A, user B, user C) may be notified that the unwind transaction was unwound and/or how the affected entities were affected (e.g., crypto tokens sent to user C from user B were transferred back to user A because crypto tokens sent to user C originated from an unauthorized transaction).

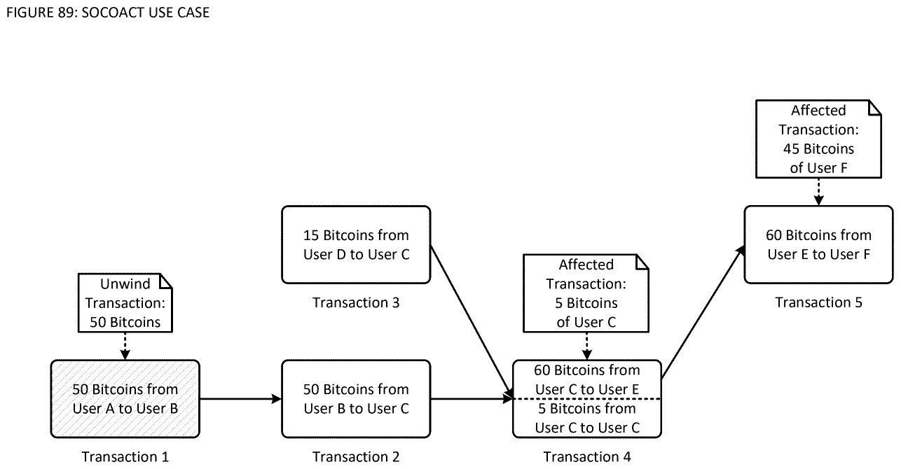

FIG. 89 shows an exemplary use case for the SOCOACT. In FIG. 89, an exemplary set of mutable blockchain transactions recorded on an agency oversight configured blockchain is shown. Transaction 1 involved transferring 50 Bitcoins from user A to user B. Transaction 1 was unauthorized, however, and user A sent an agency action request to unwind transaction 1 and to transfer 50 Bitcoins back to user A.

The agency providing oversight over the agency oversight configured blockchain may analyze (e.g., by tracing transactions via previous transaction identifiers of input fields) the blockchain to determine transactions with unspent crypto tokens that originated from the unwind transaction. The agency may determine that the Bitcoins associated with transaction 1 were transferred as follows. Transaction 2 involved transferring 50 Bitcoins from user B to user C. Transaction 4 involved transferring 45 of the 50 Bitcoins (and 15 Bitcoins from transaction 3 for a total of 60 Bitcoins) from user C to user E, and transferring the remaining 5 (e.g., change) of the 50 Bitcoins from one address associated with user C to another address associated with user C. Transaction 5 involved transferring 60 Bitcoins, of which 45 originated from the unwind transaction, from user E to user F.

Accordingly, the agency may determine that the affected transactions are: transaction 4, which involves 5 unspent Bitcoins of user C that originated from the unwind transaction, and transaction 5, which involves 45 unspent Bitcoins of user F that originated from the unwind transaction. The agency may unwind transaction 1 by transferring these 50 Bitcoins associated with the affected transactions to an unwind address associated with user A.

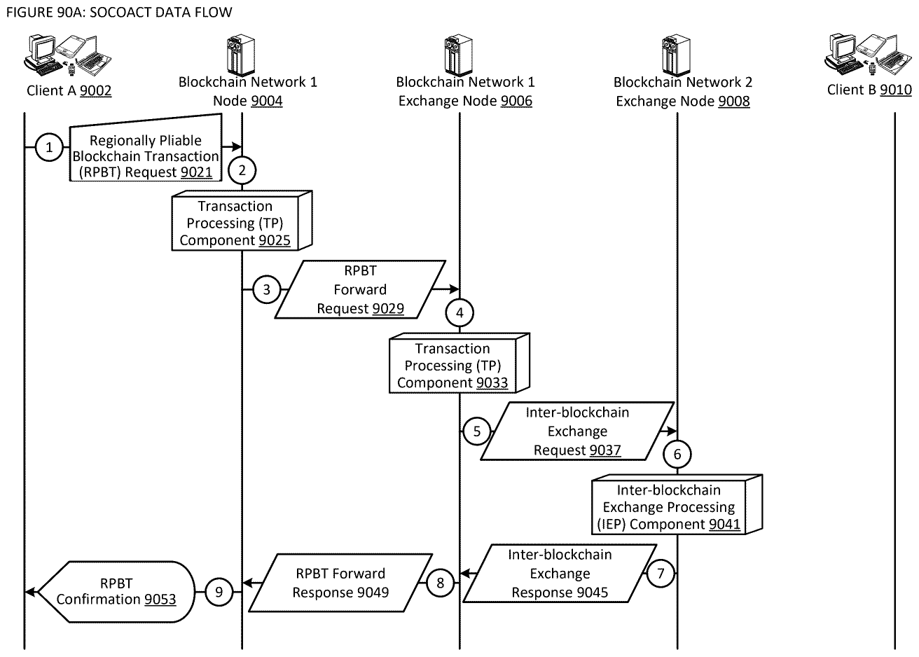

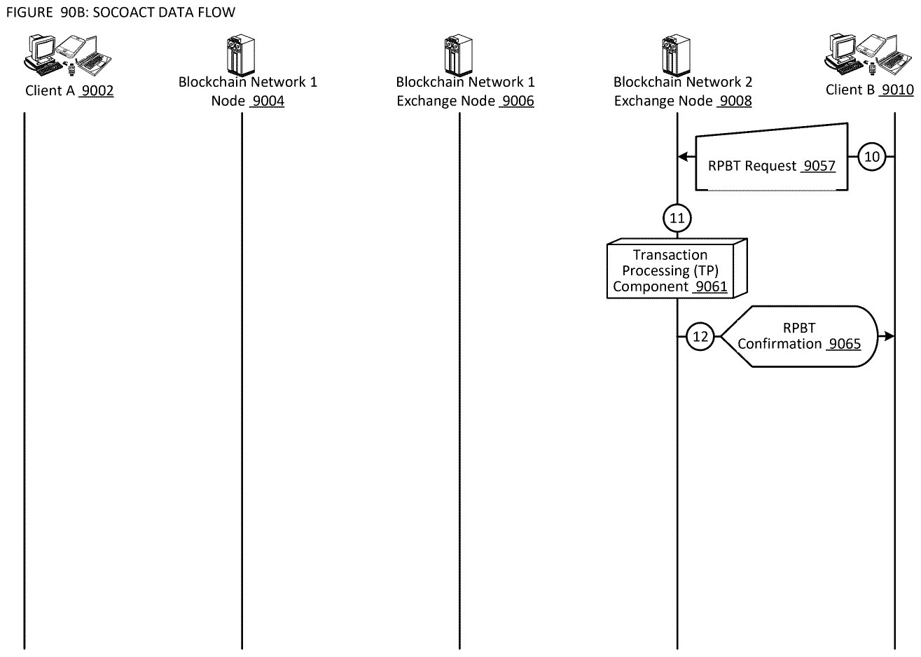

FIGS. 90A-90B show a datagraph diagram illustrating embodiments of a data flow for the SOCOACT. In FIGS. 90A-90B, client A 9002 (e.g., of user A utilizing blockchain network 1) may send a regionally pliable blockchain transaction (RPBT) request 9021 to a blockchain network 1 node 9004 to facilitate processing (e.g., adding to the blockchains of blockchain network 1 and blockchain network 2) a blockchain transaction (e.g., the transaction may involve transferring crypto tokens (e.g., 50 Bitcoins) from user A to user B, who is utilizing blockchain network 2). For example, client A may be a desktop, a laptop, a tablet, a smartphone, and/or the like that is executing a client application. In one implementation, the RPBT request may include data such as a request identifier, blockchain transaction data, and/or the like. In one embodiment, client A may provide the following example RPBT request, substantially in the form of a HTTP(S) POST message including XML-formatted data, as provided below:

```
POST /RPBT_request.php HTTP/1.1
Host: www.server.com
Content-Type: Application/XML
Content-Length: 667
<?XML version = “1.0” encoding = “UTF-8”?>
<RPBT_request>
  <request_identifier>ID_request_21</request_identifier>
  <blockchain_transaction_data>
    <input>
  <source_blockchain_network>ID_blockchain_network_1</source_blockchain_networ
k>
      <previous_transaction_hash>transaction
identifier</previous_transaction_hash>
      <index>0</index>
      <scriptSig>
        <signature>user A's signature</signature>
        <serialized_script>
          {[user A's public key] OP_CHECKSIG}
        </serialized_script>
      </scriptSig>
    </input>
    <output>
  <target_blockchain_network>ID_blockchain_network_2</target_blockchain_networ
k>
      <exchange_node>ID_exchange_node_4</exchange_node>
      <value>5000000000</value>
      <scriptPubKey>
        OP_HASH160
        [20-byte-hash of {[user B's public key] OP_CHECKSIG}]
        OP_EQUAL
      </scriptPubKey>
    </output>
  </blockchain_transaction_data>
</RPBT_request>
```

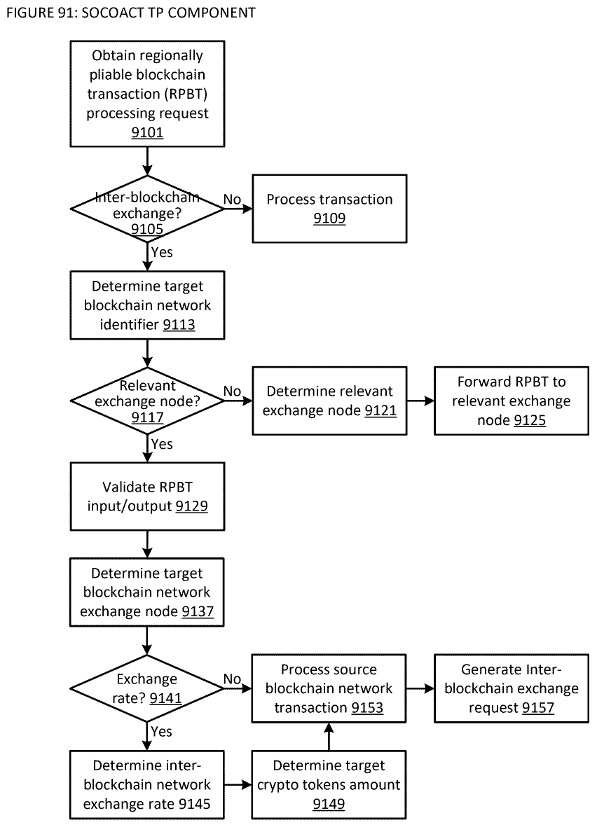

A transaction processing (TP) component 9025 may utilize data provided in the RPBT request to facilitate (e.g., by forwarding the transaction to a relevant exchange node) transaction processing (e.g., transferring crypto tokens from blockchain network 1 to blockchain network 2). See FIG. 91 for additional details regarding the TP component.

The blockchain network 1 node may send a RPBT forward request 9029 to a blockchain network 1 exchange node 9006 to forward the RPBT request to the relevant exchange node.

A transaction processing (TP) component 9033 may utilize data provided in the forwarded RPBT request to facilitate (e.g., by processing the source blockchain network portion of the transaction, and/or by generating an inter-blockchain exchange request for an exchange node of the target blockchain network) transaction processing (e.g., transferring crypto tokens from blockchain network 1 to blockchain network 2). See FIG. 91 for additional details regarding the TP component.

The blockchain network 1 exchange node may send an inter-blockchain exchange request 9037 to a blockchain network 2 exchange node 9008 to facilitate transaction processing. In one implementation, the inter-blockchain exchange request may include data such as a request identifier, blockchain transaction data, and/or the like. In one embodiment, the blockchain network 1 exchange node may provide the following example inter-blockchain exchange request, substantially in the form of a HTTP(S) POST message including XML-formatted data, as provided below:

```
POST /inter-blockchain_exchange_request.php HTTP/1.1
Host: www.server.com
Content-Type: Application/XML
Content-Length: 667
<?XML version = “1.0” encoding = “UTF-8”?>
<inter-blockchain_exchange_request>
  <request_identifier>ID_request_23</request_identifier>
  <blockchain_transaction_data>
    <input>
  <source_blockchain_network>ID_blockchain_network_1</source_blockchain_networ
k>
      <source_secured_data>
        proof that source crypto tokens are secured (e.g., sent
to a special address
        from which crypto tokens may not be retrieved)
      </source_secured_data>
      <previous_transaction_hash>transaction
identifier</previous_transaction_hash>
      <index>0</index>
      <scriptSig>
        <signature>user A's signature</signature>
        <serialized_script>
          {[user A's public key] OP_CHECKSIG}
        </serialized_script>
      </scriptSig>
    </input>
    <output>
  <target_blockchain_network>ID_blockchain_network_2</target_blockchain_networ
k>
      <exchange_node>ID_exchange_node_4</exchange_node>
      <value>5000000000</value>
      <converted_value>10000000000</converted_value>
      <scriptPubKey>
        OP_HASH160
        [20-byte-hash of {[user B's public key] OP_CHECKSIG}]
        OP_EQUAL
      </scriptPubKey>
    </output>
  </blockchain_transaction_data>
</inter-blockchain_exchange_request>
```

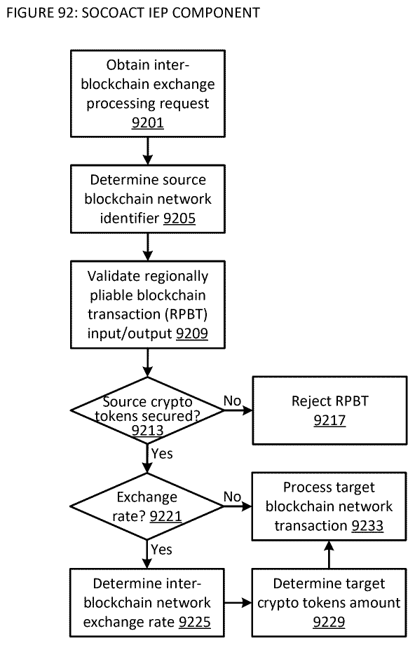

An inter-blockchain exchange processing (TEP) component 9041 may utilize data provided in the inter-blockchain exchange request to facilitate (e.g., by processing the target blockchain network portion of the transaction, and/or by forwarding the transaction to a relevant exchange node (e.g., if the current blockchain network is an intermediary forwarding the transaction to its ultimate destination blockchain network)) transaction processing (e.g., transferring crypto tokens from blockchain network 1 to blockchain network 2). See FIG. 92 for additional details regarding the IEP component.

The blockchain network 2 exchange node may send an inter-blockchain exchange response 9045 to the blockchain network 1 exchange node to provide a transaction confirmation to the blockchain network 1 exchange node. In one implementation, the inter-blockchain exchange response may include data such as a response identifier, a status, and/or the like. In one embodiment, the blockchain network 2 exchange node may provide the following example inter-blockchain exchange response, substantially in the form of a HTTP(S) POST message including XML-formatted data, as provided below:

```
POST /inter-blockchain_exchange_response.php HTTP/1.1
Host: www.server.com
Content-Type: Application/XML
Content-Length: 667
<?XML version = “1.0” encoding = “UTF-8”?>
<inter-blockchain_exchange_response>
  <response_identifier>ID_response_23</response_identifier>
  <status>Transaction Processed Successfully</status>
</inter-blockchain_exchange_response>
```

The blockchain network 1 exchange node may send a RPBT forward response 9049 to the blockchain network 1 node to forward the inter-blockchain exchange response to the blockchain network 1 node.

The blockchain network 1 node may send a RPBT confirmation 9053 to client A to inform user A whether the RPBT was processed successfully. In one implementation, the RPBT confirmation may include data such as a response identifier, a status, and/or the like. In one embodiment, the blockchain network 1 node may provide the following example RPBT confirmation, substantially in the form of a HTTP(S) POST message including XML-formatted data, as provided below:

```
POST /RPBT_confirmation.php HTTP/1.1
Host: www.server.com
Content-Type: Application/XML
Content-Length: 667
<?XML version = “1.0” encoding = “UTF-8”?>
<RPBT_confirmation>
  <response_identifier>ID_response_21</response_identifier>
  <status>OK</status>
</RPBT_confirmation>
```

Client B 9010 (e.g., of user B utilizing blockchain network 2) may send a RPBT request 9057 to the blockchain network 2 exchange node to facilitate processing (e.g., adding to the blockchain of blockchain network 2) a blockchain transaction (e.g., the transaction may involve transferring crypto tokens (e.g., 50 Bitcoins received from user A) from user B to user C, who is also utilizing blockchain network 2). For example, client B may be a desktop, a laptop, a tablet, a smartphone, and/or the like that is executing a client application. In one implementation, the RPBT request may include data such as a request identifier, blockchain transaction data, and/or the like. In one embodiment, client B may provide the following example RPBT request, substantially in the form of a HTTP(S) POST message including XML-formatted data, as provided below:

```
POST /RPBT_request.php HTTP/1.1
Host: www.server.com
Content-Type: Application/XML
Content-Length: 667
<?XML version = “1.0” encoding = “UTF-8”?>
<RPBT_request>
  <request_identifier>ID_request_24</request_identifier>
  <blockchain_transaction_data>
    <input>
      <previous_transaction_hash>transaction
identifier</previous_transaction_hash>
      <index>0</index>
      <scriptSig>
        <signature>user B's signature</signature>
        <serialized_script>
          {[user B's public key] OP_CHECKSIG}
        </serialized_script>
      </scriptSig>
    </input>
    <output>
      <value>5000000000</value>
      <scriptPubKey>
        OP_HASH160
        [20-byte-hash of {[user C's public key] OP_CHECKSIG}]
        OP_EQUAL
      </scriptPubKey>
    </output>
  </blockchain_transaction_data>
</RPBT_request>
```

A transaction processing (TP) component 9061 may utilize data provided in the RPBT request to facilitate transaction processing (e.g., processing an ordinary transaction on blockchain network 2). See FIG. 91 for additional details regarding the TP component.

The blockchain network 2 exchange node may send a RPBT confirmation 9065 to client B to inform user B whether the RPBT was processed successfully. In one implementation, the RPBT confirmation may include data such as a response identifier, a status, and/or the like. In one embodiment, the blockchain network 2 exchange node may provide the following example RPBT confirmation, substantially in the form of a HTTP(S) POST message including XML-formatted data, as provided below:

```
POST /RPBT_confirmation.php HTTP/1.1
Host: www.server.com
Content-Type: Application/XML
Content-Length: 667
<?XML version = “1.0” encoding = “UTF-8”?>
<RPBT_confirmation>
  <response_identifier>ID_response_24</response_identifier>
  <status>OK</status>
</RPBT_confirmation>
```

FIG. 91 shows a logic flow diagram illustrating embodiments of a transaction processing (TP) component for the SOCOACT. In FIG. 91, a regionally pliable blockchain transaction (RPBT) processing request may be obtained at 9101. For example, the RPBT processing request may be obtained as a result of a user sending a RPBT request for a transaction to transfer crypto tokens to another user, who is utilizing a different blockchain network (e.g., a blockchain network serving a different region (e.g., geographic area, unit in an organization, sidechain)).

A determination may be made at 9105 whether the transaction involves an inter-blockchain exchange (e.g., an inter-blockchain network transaction). In one embodiment, the transaction involves an inter-blockchain exchange if crypto tokens are transferred from a source blockchain network to a target blockchain network. In one implementation, this determination may be made by parsing (e.g., using PHP commands) the RPBT request to determine whether the transaction is in an inter-blockchain network transaction format (e.g., the transaction specifies a source blockchain network identifier of the source blockchain network and a target blockchain network identifier of the target blockchain network). If the transaction is not an inter-blockchain network transaction, the transaction may be processed at 9109 as an ordinary transaction. In one implementation, the transaction may be added to the blockchain (e.g., in a similar manner as a Bitcoin transaction).

If the transaction is an inter-blockchain network transaction, a target blockchain network identifier may be determined at 9113. In one implementation, the RPBT request may be parsed (e.g., using PHP commands) to determine the target blockchain network identifier (e.g., ID_blockchain_network_2).

A determination may be made at 9117 whether the node executing the TP component is a relevant exchange node. In one embodiment, the node is a relevant exchange node if the node, of the source blockchain network, is configured to interact with an exchange node of the target blockchain network to facilitate crypto tokens exchange between the two networks. In one implementation, the node may check a configuration setting to determine whether it is configured to interact with an exchange node of the blockchain network identified by the target blockchain network identifier. In another embodiment, the node is a relevant exchange node if the node is specified as the exchange point between the source blockchain network and the target blockchain network. In one implementation, the RPBT request may be parsed (e.g., using PHP commands) to determine whether the exchange_node field specifies the node identifier of the node.

If the node is not a relevant exchange node, a relevant exchange node may be determined at 9121. In one implementation, a relevant exchange node may be determined based on the target blockchain network identifier (e.g., the closest (e.g., in terms of network proximity) relevant exchange node configured to interact with the target blockchain network). In another implementation, a relevant exchange node may be determined based on the value of the exchange_node field in the RPBT request. The transaction may be forwarded to the relevant exchange node at 9125. In one implementation, a network addressing table may be consulted to determine the next hop node, on a route to the relevant exchange node, to which the transaction should be forwarded. In another implementation, the transaction may be forwarded to the relevant exchange node identified by the exchange_node field.

If the node is a relevant exchange node, input and/or output associated with the RPBT transaction may be validated at 9129. In one implementation, input data (e.g., input field in the RPBT request) may be validated to confirm that the input is valid (e.g., to confirm that the user has the authority to transfer the source crypto tokens). In another implementation, output data (e.g., output field in the RPBT request) may be validated to confirm that the output is valid (e.g., includes a valid script in the scriptPubKey field) on the target blockchain network.

A target blockchain network exchange node on the target blockchain network may be determined at 9137. In one implementation, the node may check a configuration setting to determine the target blockchain network exchange node (e.g., the node may be configured to communicate with a specific exchange node on the target blockchain network). In another implementation, the node may determine the target blockchain network exchange node dynamically (e.g., determine exchange node with the best latency, determine exchange node with the best crypto tokens exchange rate).

A determination may be made at 9141, whether there is an inter-blockchain network exchange rate (e.g., other than 1 to 1) between crypto tokens of the source blockchain network and crypto tokens of the target blockchain network, and/or whether the node is responsible for determining the inter-blockchain network exchange rate. In one implementation, the node may check a configuration setting to make this determination. If so, the inter-blockchain network exchange rate may be determined at 9145. In one implementation, a request may be sent to a third party market maker to determine the inter-blockchain network exchange rate. A target crypto tokens amount to be provided to the other user on the target blockchain network may be determined at 9149. In one implementation, the crypto tokens amount on the source blockchain network specified in the value field of the output may be converted to a crypto tokens amount on the target blockchain network using a calculation based on the inter-blockchain network exchange rate.

The portion of the transaction associated with the source blockchain network may be processed at 9153. In one embodiment, a securing transaction may be made on the source blockchain network to ensure that the source crypto tokens may not be reused on the source blockchain network. In one implementation, a transaction entry that transfers the source crypto tokens to an address on the source blockchain network from which crypto tokens may not be transferred (e.g., by anyone, by anyone except an agency providing oversight) may be utilized (e.g., added to the blockchain of the source blockchain network).

An inter-blockchain exchange request may be generated at 9157. In one embodiment, the inter-blockchain exchange request may be configured to allow the target blockchain network exchange node to verify that the portion of the transaction associated with the source blockchain network was processed, and/or to process the portion of the transaction associated with the target blockchain network. In one implementation, the inter-blockchain exchange request may include data such as data provided in the RPBT request, proof that the source crypto tokens may not be reused on the source blockchain network (e.g., the transaction identifier of the securing transaction), the calculated crypto tokens amount on the target blockchain network, and/or the like.

FIG. 92 shows a logic flow diagram illustrating embodiments of an inter-blockchain exchange processing (IEP) component for the SOCOACT. In FIG. 92, an inter-blockchain exchange processing request may be obtained at 9201. For example, the inter-blockchain exchange processing request may be obtained by an exchange node of a target blockchain network as a result of obtaining an inter-blockchain exchange request from an exchange node of a source blockchain network for a regionally pliable blockchain transaction (RPBT) to transfer crypto tokens from a user utilizing the source blockchain network to another user utilizing the target blockchain network.

A source blockchain network identifier of a source blockchain network may be determined at 9205. In one implementation, the inter-blockchain exchange request may be parsed (e.g., using PHP commands) to determine the source blockchain network identifier (e.g., ID_blockchain_network_1).

Input and/or output associated with the RPBT transaction may be validated at 9209. In one implementation, input data (e.g., input field in the inter-blockchain exchange request) may be validated to confirm that the input is valid (e.g., to confirm that the user has the authority to transfer the source crypto tokens). In another implementation, output data (e.g., output field in the inter-blockchain exchange request) may be validated to confirm that the output is valid (e.g., includes a valid script in the scriptPubKey field) on the target blockchain network.

A determination may be made at 9213 whether the source crypto tokens were secured (e.g., to confirm that the source crypto tokens may not be reused on the source blockchain network). In one embodiment, proof that the source crypto tokens may not be reused on the source blockchain network may be verified. In one implementation, the inter-blockchain exchange request may be parsed (e.g., using PHP commands) to determine an identifier of a securing transaction that ensures that the source crypto tokens may not be reused on the source blockchain network. The identifier of the securing transaction may be utilized to obtain associated transaction data to confirm that the securing transaction is a valid transaction on the source blockchain network that secures the source crypto tokens. If the source crypto tokens were not secured, the transaction may be rejected (e.g., not added to the blockchain of the target blockchain network) at 9217.

If the source crypto tokens were secured, a determination may be made at 9221, whether there is an inter-blockchain network exchange rate (e.g., other than 1 to 1) between crypto tokens of the source blockchain network and crypto tokens of the target blockchain network, and/or whether the exchange node of the target blockchain network is responsible for determining the inter-blockchain network exchange rate (e.g., instead of the exchange node of the source blockchain network, to confirm the converted value provided by the exchange node of the source blockchain network). In one implementation, the exchange node of the target blockchain network may check a configuration setting to make this determination. If so, the inter-blockchain network exchange rate may be determined at 9225. In one implementation, a request may be sent to a third party market maker to determine the inter-blockchain network exchange rate. A target crypto tokens amount to be provided to the other user on the target blockchain network may be determined at 9229. In one implementation, the crypto tokens amount on the source blockchain network specified in the value field of the output may be converted to a crypto tokens amount on the target blockchain network using a calculation based on the inter-blockchain network exchange rate. In another implementation, the calculated crypto tokens amount on the target blockchain network may be compared to the converted value specified by the exchange node of the source blockchain network in the converted_value field to verify the provided converted value.

The portion of the transaction associated with the target blockchain network may be processed at 9233. In one embodiment, the exchange node of the target blockchain network may be configured to recognize the secured source crypto tokens as valid transaction input. Accordingly, the transaction to transfer crypto tokens (e.g., the specified value amount, the converted value amount) to the other user may be added to the blockchain of the target blockchain network. In one implementation, the transaction may be added to the blockchain of the target blockchain network in its original form. For example, other nodes in the target blockchain network may be configured to be able to validate such exchange transactions. In another implementation, the transaction may be added to the blockchain of the target blockchain network in a modified form in accordance with the rules of the target blockchain network. For example, the exchange node of the target blockchain network may add a cryptographic signature to the input to indicate that the input was validated by the exchange node, and other nodes in the target blockchain network may be configured to utilize the cryptographic signature to validate the input when validating such inter-blockchain exchange transactions. In some embodiments, the target blockchain network may be an intermediary blockchain network (e.g., blockchain network 3) utilized to transfer crypto tokens (e.g., from blockchain network 1 to blockchain network 2 via blockchain network 3) to the ultimate destination blockchain network (e.g., blockchain network 2). Accordingly, the intermediary blockchain network may process the transaction (e.g., add to the blockchain of the intermediary blockchain network) and generate an inter-blockchain exchange request to the next hop blockchain network on a route to the ultimate destination blockchain network.

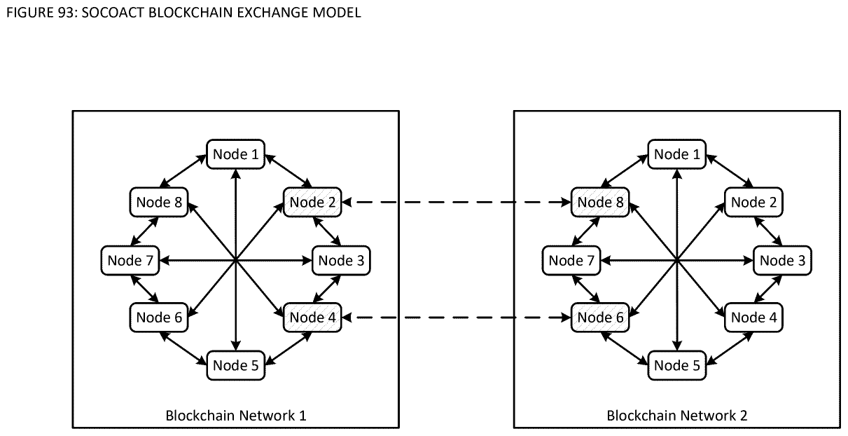

FIG. 93 shows an exemplary blockchain exchange model for the SOCOACT. In FIG. 93, two blockchain networks, blockchain network 1 and blockchain network 2, are illustrated. Each of the two blockchain networks operates with different nodes (e.g., nodes 1 through 8 of blockchain network 1 are different from nodes 1 through 8 of blockchain network 2) and entities (e.g., blockchain network 1 serves one region (e.g., eastern) and blockchain network 2 serves another region (e.g., western)), and maintains a separate digital ledger (e.g., blockchain). Blockchain network 1 contains eight nodes with each node having a reasonable level of interconnections with other peers (e.g., represented by solid lines). For simplicity, blockchain network 2 also contains eight nodes with each node having a reasonable level of interconnections with other peers (e.g., represented by solid lines), but representing different assets, valuations, rules of governance, and/or the like. Each node validates transactions and maintains a copy of the digital ledger for their respective blockchain network. Node 2 and node 4 of blockchain network 1, and node 6 and node 8 of blockchain network 2 are exchange nodes that facilitate inter-blockchain network transactions between the two blockchain networks (e.g., via pathways represented by dashed lines).

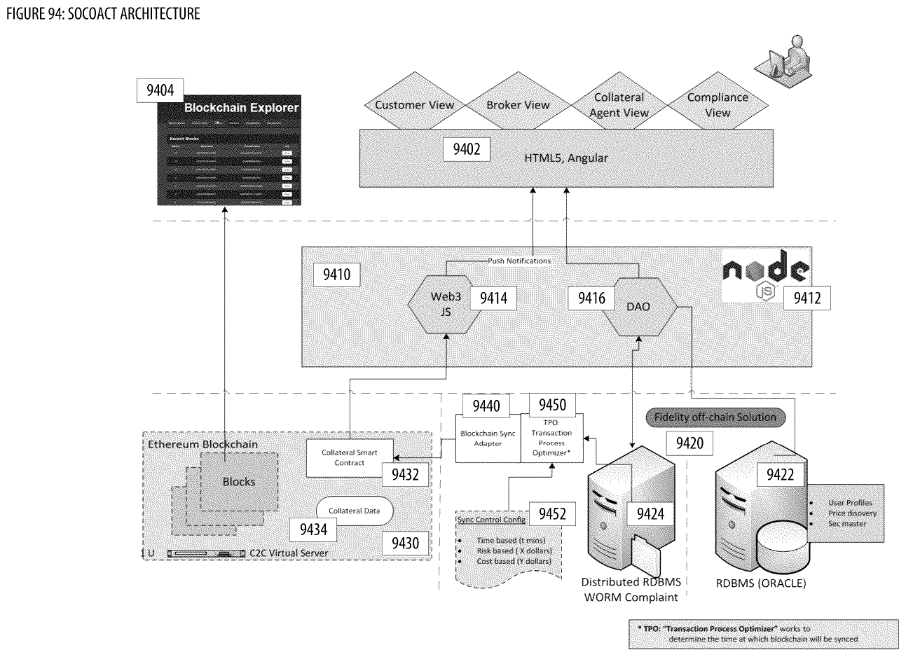

FIG. 94 shows an architecture for the SOCOACT. In FIG. 94, a user interface (UI) 9402 may be used by various users (e.g., a customer, a broker-dealer, a collateral agent, a compliance officer) to interact with the SOCOACT. A different view may be presented to each user. For example, the UI may be implemented using HTML5 and Angular application platform.

A middle tier 9410 may be utilized to connect the UI with a data tier 9420 and/or a blockchain 9430. In one implementation, the middle tier may utilize Node.js JavaScript run-time environment 9412 to execute JavaScript code. For example, the middle tier may include code that utilizes Web3.js Ethereum JavaScript API 9414 to communicate with the blockchain (e.g., to provide push notifications to the UI based on blockchain activity). See Appendix 2 for an example of how events from a smart contract on the blockchain may be handled. In another example, the middle tier may include code that utilizes a data access object (DAO) 9416 to communicate with the data tier (e.g., to process data and/or to store data in or retrieve data from databases).

In some embodiments, oracles can expand the capacity of smart contracts beyond the blockchain. In one implementation, the SOCOACT may include a crowdsource (e.g., weather from smartphones) to inform a blockchain oracle to act as trigger for actions, with a list of options to, e.g., settle smart contracts like: restrict bitcoin wallet access, release extra key, buy stock, vote, etc. For example, if lots of sales of corn, buy counter stock/hedge. Or, for example, if lots of corn producers weather reports drought, buy corn futures.

The data tier may include a RDBMS 9422 and a write once read many (WORM) database 9424. For example, the RDBMS may include static/non-transactional data such as user profiles, price discovery, securities master, and/or the like. In another example, the WORM database may include transactional data.

The blockchain may be implemented using the Ethereum decentralized platform. For example, a smart contract, such as a collateral smart contract 9432, and/or smart contract data, such as collateral data 9434, may be stored and/or executed by the blockchain. Blockchain information may be viewed by users using blockchain UI 9404. In one implementation, the smart contract may be written using Solidity programming language. See Appendix 1 for an example of an Ethereum smart contract written using Solidity programming language that may be utilized. A cloud-to-cloud migration (C2C) Virtual Server box may be used to host Ethereum private network and/or Ethereum miners/nodes. Further, the C2C Virtual Server box may be used to host SOCOACT components (e.g., UI, middle tier, data tier).

A blockchain sync adaptor (BSA) component 9440 may be utilized to synchronize transactional data to the blockchain as instructed by a transaction process optimizer (TPO) component 9450. For example, the BSA component and/or the TPO component may be implemented in JavaScript and may be executed using Node.js JavaScript run-time environment. In one implementation, the TPO component may be configured based on parameters 9452 such as time (e.g., based on minutes since the last sync, based on minutes since a transaction was executed), risk (e.g., based on the amount of dollars at risk), cost (e.g., based on the amount of dollars associated with cost), and/or the like.

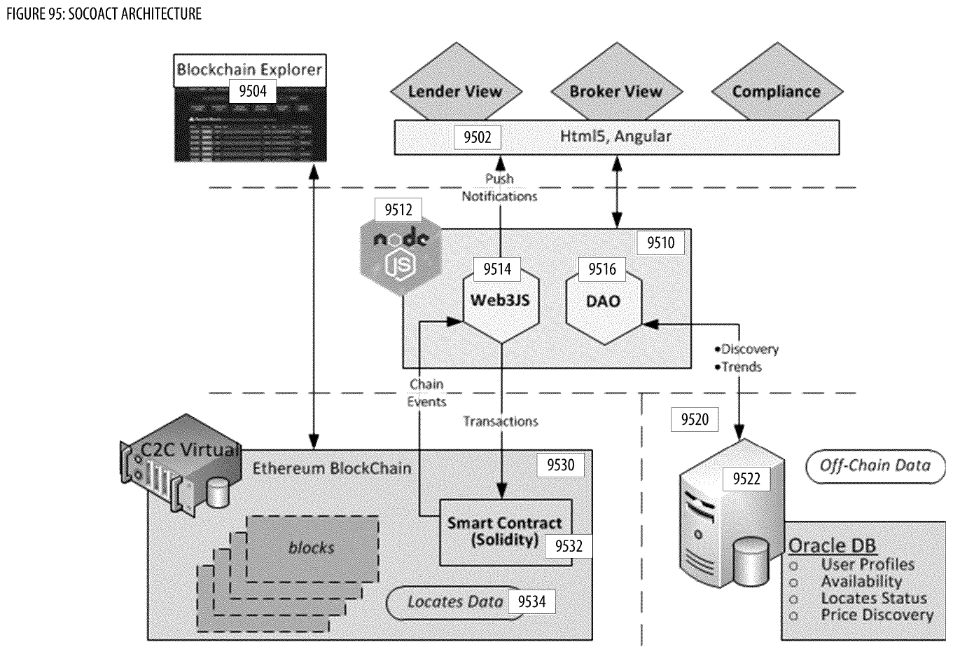

FIG. 95 shows an architecture for the SOCOACT. In FIG. 95, a user interface (UI) 9502 may be used by various users (e.g., a lender, a broker-dealer, a compliance officer) to interact with the SOCOACT. A different view may be presented to each user. For example, the UI may be implemented using HTML5 and Angular application platform.

A middle tier 9510 may be utilized to connect the UI with a data tier 9520 and/or a blockchain 9530. In one implementation, the middle tier may utilize Node.js JavaScript run-time environment 9512 to execute JavaScript code. For example, the middle tier may include code that utilizes Web3.js Ethereum JavaScript API 9514 to communicate with the blockchain (e.g., to provide push notifications to the UI based on blockchain events, to store transactions on the blockchain). See Appendix 2 for an example of how events from a smart contract on the blockchain may be handled. In another example, the middle tier may include code that utilizes a data access object (DAO) 9516 to communicate with the data tier (e.g., to process data and/or to store data in or retrieve data from databases).

In some embodiments, oracles can expand the capacity of smart contracts beyond the blockchain. In one implementation, the SOCOACT may include a crowdsource (e.g., weather from smartphones) to inform a blockchain oracle to act as trigger for actions, with a list of options to, e.g., settle smart contracts like: restrict bitcoin wallet access, release extra key, buy stock, vote, etc. For example, if lots of sales of corn, buy counter stock/hedge. Or, for example, if lots of corn producers weather reports drought, buy corn futures.

In one implementation, the middle tier may include a blockchain sync adaptor (BSA) component utilized to synchronize transactional data to the blockchain as instructed by a transaction process optimizer (TPO) component. For example, the BSA component and/or the TPO component may be implemented in JavaScript and may utilize Web3.js Ethereum JavaScript API and/or the DAO. In one implementation, the TPO component may be configured based on parameters such as time (e.g., based on minutes since the last sync, based on minutes since a transaction was executed), risk (e.g., based on the amount of dollars at risk), cost (e.g., based on the amount of dollars associated with cost), and/or the like.

The data tier may include a database 9522 (e.g., an Oracle database). For example, the database may include data such as user profiles, availability (e.g., of securities to borrow), locates status, price discovery, other off-chain data such as calculation intensive processing login (e.g., order book), and/or the like.

The blockchain may be implemented using the Ethereum decentralized platform. For example, a smart contract 9532 and/or locates data 9534 (e.g., digitized assets such as securities like TSLA) may be stored and/or executed by the blockchain. Blockchain information may be viewed by users using blockchain UI 9504. In one implementation, the smart contract may be written using Solidity programming language. See Appendix 1 for an example of an Ethereum smart contract written using Solidity programming language that may be utilized. A C2C Virtual Server box may be used to host Ethereum private network and/or Ethereum miners/nodes. Further, the C2C Virtual Server box may be used to host SOCOACT components (e.g., UI, middle tier, data tier).

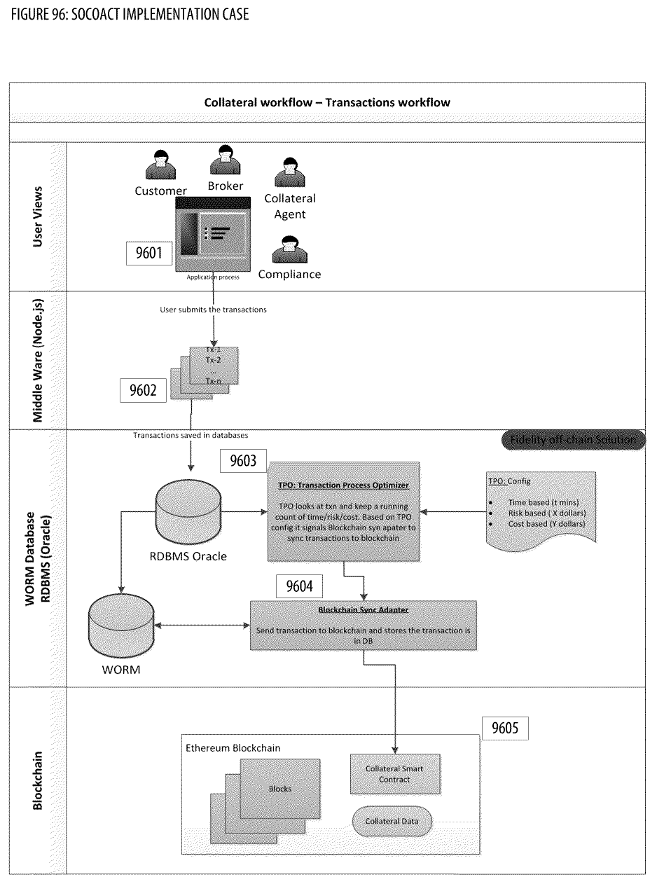

FIG. 96 shows implementation case(s) for the SOCOACT. In FIG. 96, an exemplary transaction workflow for a borrow transaction is illustrated. At 9601, a broker-dealer may initiate a borrow transaction to borrow 100 shares of TSLA from a fully paid customer (e.g., Customer A who enrolled in a broker-dealer's fully paid lending program) at a 10% rate. For example, the broker-dealer may utilize an application UI to initiate the borrow transaction. In one implementation, collateral for the borrow transaction may be calculated based on the last (e.g., yesterday's) closing price. In another implementation, collateral for the borrow transaction may be calculated based on the end-of-day (e.g., today's) closing price.

At 9602, transaction details flow from the UI into a data tier (e.g., Oracle database) through a middle tier. In one implementation, the middle tier may connect the UI and the data tier by moving and processing data between both the UI and the data tier. The middle tier may utilize Node.js JavaScript run-time environment to execute JavaScript code.

At 9603, transaction details for the borrow transaction may flow from a RDBMS (e.g., an Oracle database) into a WORM database. Transaction details are added to the Ethereum Blockchain based on TPO component rules. In one embodiment, the TPO component optimizes data load into the blockchain. In one implementation, the TPO component is configured to decide the timing of regular data load (e.g., based on average time, average amount of total transactions, and/or the like) into the blockchain. For example, the TPO component may keep a running count of time, risk, cost, and/or the like based on transaction details of incoming borrow transactions, and, based on the TPO component configuration settings, may signal a BSA component to synchronize (sync) transactions to the blockchain.

At 9604, the BSA component may send the borrow transactions to sync to the blockchain. Non-transactional details (e.g., TSLA name, company headquarters address, the customer's details, the broker-dealer's details) may be replicated onto distributed servers (e.g., the WORM database) where a collateral agent and the broker dealer both can access this data.

At 9605, transactional details (attributes) of the borrow transactions to sync are added to the Ethereum Blockchain. Ethereum Blockchain network comprises of various nodes which can include broker dealers and collateral agents.

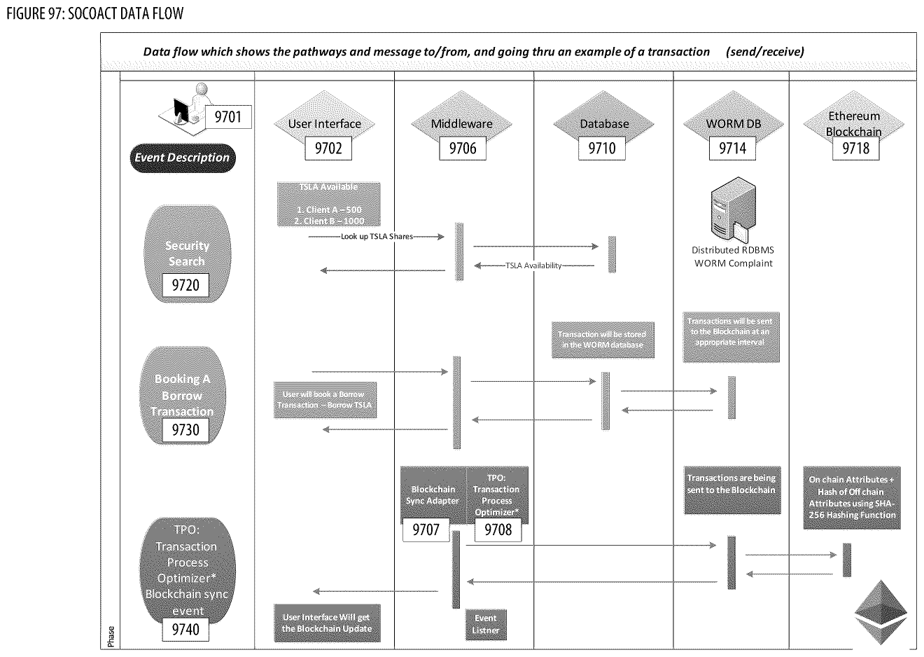

FIG. 97 shows a datagraph illustrating data flow(s) for the SOCOACT. In FIG. 97, a user 9701 (e.g., a broker-dealer) may initiate a security search 9720 to determine clients from which the broker-dealer may borrow TSLA shares. The user may utilize a user interface 9702 (e.g., via the user's client device) to input parameters of the security search. The user interface may communicate with middleware 9706 to look up availability of TSLA shares from a database 9710 (e.g., a RDBMS). The results of the security search may be presented to the user via the user interface. For example, the user may be informed that 500 TSLA shares are available from Customer A and 1000 TSLA share are available from Customer B. In one implementation, the user may be able to see customers holding the security, prior borrow of the security by the broker-dealer (on loan quantity), current quantity of the security for each customer (available to lend quantity), and/or the like.

The broker-dealer may initiate booking a borrow transaction 9730. For example, the broker-dealer may wish to borrow 100 shares of TSLA from Customer A. The user may utilize the user interface to input parameters of the borrow transaction. In one implementation, the user may be able to specify the number of shares the user wishes to borrow, the rate at which the trader wishes to borrow shares, and/or the like. The user interface may communicate with the middleware to store details of the borrow transaction in the database and/or a WORM database 9714. A confirmation that the borrow transaction was booked may be presented to the user via the user interface.

A blockchain sync adapter component 9707 may sync details of the borrow transaction (e.g., based on data stored in the WORM database) to the Ethereum Blockchain 9718 upon receiving a blockchain sync event 9740 from a transaction process optimizer component 9708. In one implementation, a set of on-chain attributes and a hash of off-chain attributes (e.g., computed using a SHA-256 hashing function) may be stored on the Ethereum Blockchain. A confirmation that the borrow transaction was stored on the blockchain may be presented to the user via the user interface.

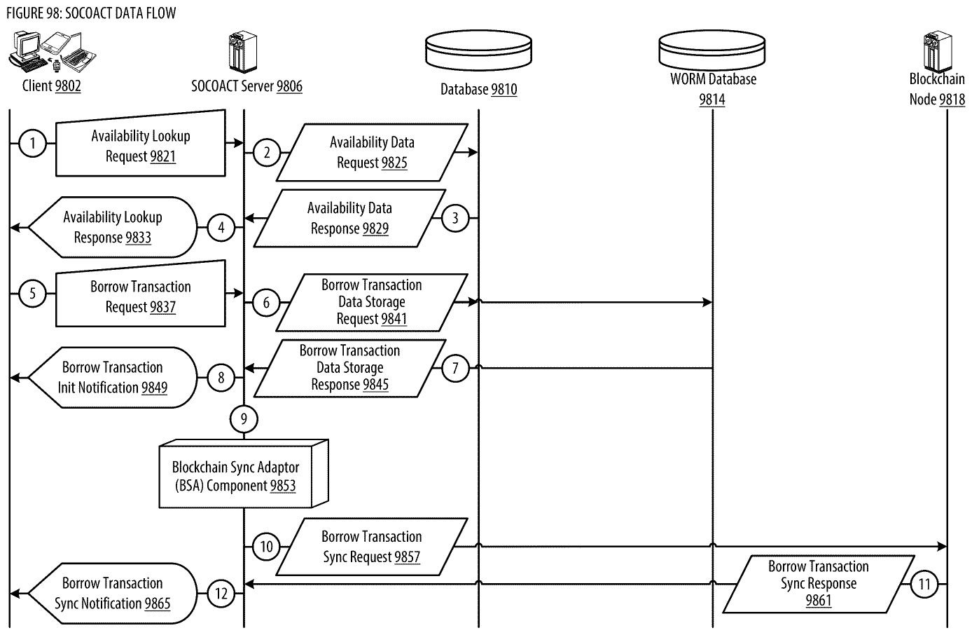

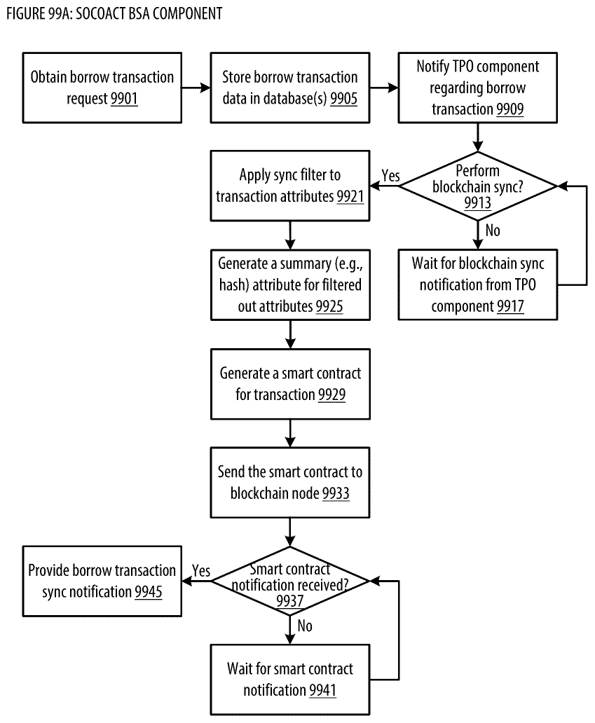

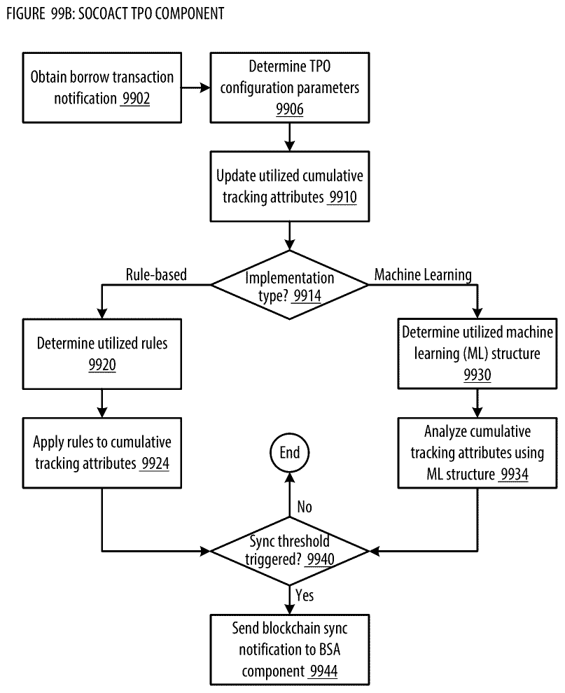

FIG. 98 shows a datagraph illustrating data flow(s) for the SOCOACT. In FIG. 98, a client 9802 (e.g., of a user) may send an availability lookup request 9821 to a SOCOACT server 9806 to initiate a security search. For example, the client may be a desktop, a laptop, a tablet, a smartphone, and/or the like that is executing a client application. In one implementation, the availability lookup request may include data such as a request identifier, a request type, a security identifier, and/or the like. In one embodiment, the client may provide the following example availability lookup request, substantially in the form of a (Secure) Hypertext Transfer Protocol (“HTTP(S)”) POST message including extensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</user_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <client_details> //iOS Client with App and Webkit
      //it should be noted that although several client details
      //sections are provided to show example variants of client
      //sources, further messages will include only on to save
      //space
    <client_IP>10.0.0.123</client_IP>
    <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
    <client_product_type>iPhone6, 1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>app with webkit</client_app_type>
    <app_installed_flag>true</app_installed_flag>
    <app_name>SOCOACT.app</app_name>
    <app_version>1.0 </app_version>
    <app_webkit_name>Mobile Safari</client_webkit_name>
    <client_version>537.51.2</client_version>
  </client_details>
  <client_details> //iOS Client with Webbrowser
    <client_IP>10.0.0.123</client_IP>
    <user_agent_string>Mozilla/5.0 (iPhone; CPU iPhone OS 7_1_1 like Mac OS
X) AppleWebKit/537.51.2 (KHTML, like Gecko) Version/7.0 Mobile/11D201
Safari/9537.53</user_agent_string>
    <client_product_type>iPhone6, 1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>web browser</client_app_type>
    <client_name>Mobile Safari</client_name>
    <client_version>9537.53</client_version>
  </client_details>
  <client_details> //Android Client with Webbrowser
    <client_IP>10.0.0.123</client_IP>
    <user_agent_string>Mozilla/5.0 (Linux; U; Android 4.0.4; en-us; Nexus
S Build/IMM76D) AppleWebKit/534.30 (KHTML, like Gecko) Version/4.0 Mobile
Safari/534.30</user_agent_string>
    <client_product_type>Nexus S</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Android</client_OS>
    <client_OS_version>4.0.4</client_OS_version>
    <client_app_type>web browser</client_app_type>
    <client_name>Mobile Safari</client_name>
    <client_version>534.30</client_version>
  </client_details>
  <client_details> //Mac Desktop with Webbrowser
    <client_IP>10.0.0.123</client_IP>
    <user_agent_string>Mozilla/5.0 (Macintosh; Intel Mac OS X 10_9_3)
AppleWebKit/537.75.14 (KHTML, like Gecko) Version/7.0.3
Safari/537.75.14</user_agent_string>
    <client_product_type>MacPro5, 1</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Mac OS X</client_OS>
    <client_OS_version>10.9.3</client_OS_version>
    <client_app_type>web browser</client_app_type>
    <client_name>Mobile Safari</client_name>
    <client_version>537.75.14</client_version>
  </client_details>
  <availability_lookup_request>
    <request_identifier>ID_request_1</request_identifier>
    <request_type>FULLY_PAID_SECURITIES_TO_BORROW</request_type>
    <security_identifier>PETS</security_identifier>
  </availability_lookup_request>
</auth_request>
```

The SOCOACT server may send an availability data request 9825 to a database 9810 (e.g., a RDBMS) to facilitate the security search. In one embodiment, the SOCOACT server may provide the following example availability data request, substantially in the form of a PHP/SQL listing, as provided below:

```
<?PHP
header(′Content-Type: text/plain′);
mysql_connect(“254.93.179.112”,$DBserver,$password); // access
database server
mysql_select_db(“CUSTOMERS.SQL”); // select database to search
//create query
$query = “SELECT accountID, accountOwnerID, assetQuantity FROM
Accounts
  WHERE assetIDs LIKE ′PETS’ AND
  accountEnrolledInFullyPaidSecurities = TRUE”;
$result = mysql_query($query); // perform the search query
mysql_close(“CUSTOMERS.SQL”); // close database access
?>
```

The database may send an availability data response 9829 to the SOCOACT server with the requested availability data.

The SOCOACT server may send an availability lookup response 9833 to the client to inform the user regarding customers from which the desired security may be borrowed and/or to facilitate borrowing the security. In one implementation, the availability lookup response may include data such as a response identifier, availability data, and/or the like. In one embodiment, the SOCOACT server may provide the following example availability lookup response, substantially in the form of a HTTP(S) POST message including XML-formatted data, as provided below:

```
POST /availability_lookup_response.php HTTP/1.1
Host: www.server.com
Content-Type: Application/XML
Content-Length: 667
<?XML version = “1.0” encoding = “UTF-8”?>
<availability_lookup_response>
  <response_identifier>ID_response_1</response_identifier>
  <availability_data>
    <security_identifier>PETS</security_identifier>
    <account>
      <account_identifier>ID_account_1</account_identifier>
      <account_owner_identifier>Customer A</account_owner_identifier>
      <available_quantity>500</available_quantity>
    </account>
    <account>
      <account_identifier>ID_account_2</account_identifier>
      <account_owner_identifier>Customer B</account_owner_identifier>
      <available_quantity>1000</available_quantity>
    </account>
  </availability_data>
</availability_lookup_response>
```

The client may send a borrow transaction request 9837 to the SOCOACT server to initiate a borrow transaction. In one implementation, the borrow transaction request may include data such as a request identifier, a transaction identifier, a customer account identifier, a security identifier, a quantity to borrow, and/or the like. In one embodiment, the client may provide the following example borrow transaction request, substantially in the form of a HTTP(S) POST message including XML-formatted data, as provided below:

```
POST /borrow_transaction_request.php HTTP/1.1
Host: www.server.com
Content-Type: Application/XML
Content-Length: 667
<?XML version = “1.0” encoding = “UTF-8”?>
<borrow_transaction_request>
  <request_identifier>ID_request_2</request_identifier>
  <transaction_identifier>ID_transaction_1</transaction_identifier>
  <account_identifier>ID_account_1</account_identifier>
  <security_identifier>PETS</security_identifier>
  <borrow_quantity>100</borrow_quantity>
</borrow_transaction_request>
```

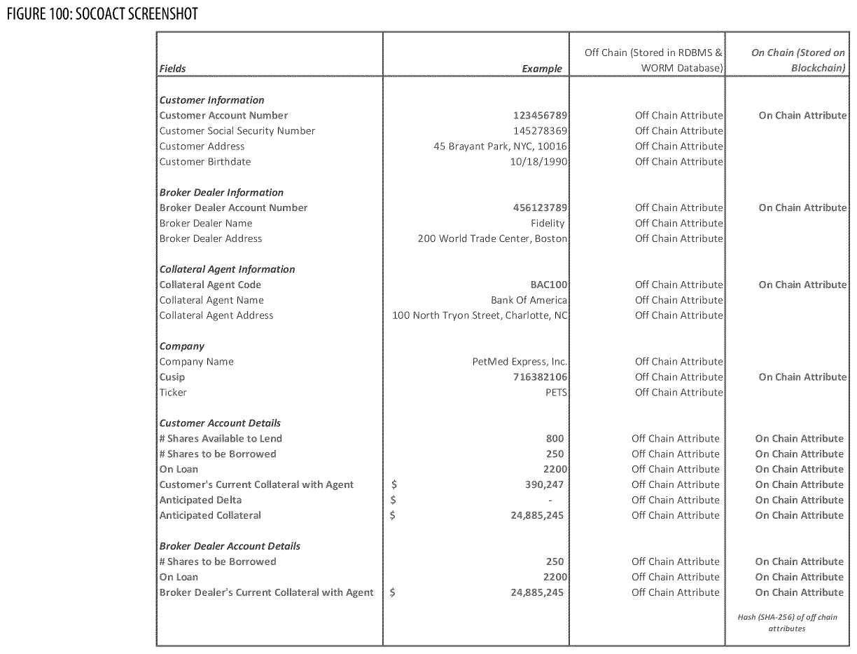

The SOCOACT server may send a borrow transaction data storage request 9841 to the database and/or to a WORM database 9814 to book the borrow transaction. In one implementation, the borrow transaction data storage request may comprise one or more PHP/SQL statements. See FIG. 100 for additional details regarding information that may be stored off chain. The database and/or the WORM database may confirm that the borrow transaction was stored via a borrow transaction data storage response 9845.

The SOCOACT server may send a borrow transaction init notification 9849 to the client. The borrow transaction init notification may be used to inform the user that the borrow transaction was initiated (e.g., booked). For example, the borrow transaction init notification may be displayed using a SOCOACT website, application (e.g., a mobile app), sent via SMS, sent via email, and/or the like.

A blockchain sync adapter (BSA) component 9853 may provide details regarding the borrow transaction (e.g., based on data stored in the database and/or the WORM database) to a blockchain node 9818 (e.g., of the Ethereum Blockchain network), based on a notification from a transaction process optimizer (TPO) component, to facilitate synchronizing details regarding the borrow transaction to a blockchain. See FIG. 99A for additional details regarding the BSA component. See FIG. 99B for additional details regarding the TPO component.

The SOCOACT server may send a borrow transaction sync request 9857 to the blockchain node. In one implementation, the borrow transaction sync request may comprise an Ethereum smart contract that stores details regarding the borrow transaction. See FIG. 100 for additional details regarding information that may be stored on chain. The blockchain node may confirm that the borrow transaction sync request was processed via a borrow transaction sync response 9861.

The SOCOACT server may send a borrow transaction sync notification 9865 to the client. The borrow transaction sync notification may be used to inform the user that the borrow transaction was synced to the blockchain. For example, the borrow transaction sync notification may be displayed using a SOCOACT website, application (e.g., a mobile app), sent via SMS, sent via email, and/or the like.

FIG. 99A shows a logic flow illustrating embodiments of a blockchain sync adapter (BSA) component for the SOCOACT. In FIG. 99A, a borrow transaction request may be obtained at 9901. For example, the borrow transaction request may be obtained as a result of a user (e.g., broker-dealer) utilizing a UI to initiate a borrow transaction (e.g., to borrow shares of fully paid securities from a customer who enrolled in the broker-dealer's fully paid lending program).

Transaction data associated with the borrow transaction may be stored in databases(s) at 9905. In one implementation, transaction data may be stored in a RDBMS (e.g., an Oracle database). In another implementation, transaction data may be stored in a WORM database. For example, the transaction data may be stored via a MySQL database command similar to the following:

INSERT INTO Transactions (transactionID, transactionType, accountID, assetID,
transactionQuantity)
VALUES (ID_Transaction_1, BORROW_FULLY_PAID_SECURITIES, ID_account_1, “PETS”,
100);

A TPO component may be notified regarding the borrow transaction at 9909. For example, the TPO component may keep a running count of time, risk, cost, and/or the like based on transaction details of incoming borrow transactions, and, based on the TPO component configuration settings, may signal the BSA component when to synchronize (sync) transactions to a blockchain. In one implementation, the BSA component may send a borrow transaction notification regarding the borrow transaction to the TPO component when the borrow transaction request is received. In another implementation, storing the transaction data in the database(s) may activate a database trigger that notifies the TPO component regarding the borrow transaction.

A determination may be made at 9913 whether to sync the borrow transaction to the blockchain. In one implementation, this determination may be made based on whether a blockchain sync notification associated with the borrow transaction has been received from the TPO component. If a blockchain sync notification associated with the borrow transaction has not been received, the BSA component may wait for a blockchain sync notification at 9917.

If a blockchain sync notification associated with the borrow transaction has been received, a sync filter may be applied to transaction attributes at 9921 to determine the filtered transaction attributes (e.g., transactional attributes). In one implementation, the sync filter may be configured to filter out non-transactional attributes associated with the borrow transaction. For example, a filter mask may be applied to filter out off chain attributes shown in FIG. 100.

A summary attribute for the filtered-out attributes may be generated at 9925. In one implementation, the summary attribute may be generated using a hash of the filtered-out attributes. For example, a hash of off chain attributes may be computed using a SHA-256 hashing function.

A smart contract for the borrow transaction may be generated at 9929. For example, an Ethereum smart contract written using Solidity programming language may be generated. See Appendix 1 for an example of an Ethereum smart contract written using Solidity programming language that may be utilized. In one implementation, the smart contract may be configured to store on chain transaction data (e.g., transactional attributes and the summary attribute for the filtered-out non-transactional attributes) associated with the borrow transaction. In another implementation, the smart contract may be configured to provide borrow functionality (e.g., by transferring securities (assets) associated with the borrow transaction on the blockchain between the broker-dealer and the customer). In another implementation, the smart contract may be configured to provide collateral functionality (e.g., to settle the value of collateral by transferring funds between the broker-dealer's account and the customer's account with a collateral agent) associated with the borrow transaction (e.g., daily based on end of day market values of securities associated with the borrow transaction). The smart contract may be sent to a blockchain node (e.g., a node of the Ethereum Blockchain network) at 9933.

A determination may be made at 9937 whether a smart contract notification associated with the smart contract has been received. In one implementation, this determination may be made based on whether a borrow transaction sync response confirming that the smart contract was processed has been received from the blockchain node. In another implementation, this determination may be made based on whether a notification (e.g., confirming that the smart contract was processed, confirming that assets were transferred, confirming that collateral was transferred, confirming that an action was taken, etc.) has been received from the smart contract.

In some embodiments, the smart contract may take actions (e.g., transfer assets, transfer collateral) based on data provided by one or more oracles. In one implementation, contract terms may include a specification of the value of an asset based on data provided by an oracle. In another implementation, contract terms may include a specification of an (e.g., additional) action to take (e.g., restrict access, release an extra key, purchase stock, vote in a certain way) based on geofencing, time range fencing, anti-ping (e.g., lack of activity), transaction/consumption tracking (e.g., how crypto tokens are spent), weather, and/or the like (e.g., natural events such as flood, earthquake, volcanic eruption, lava flow; political events such as political unrest, war, terrorist attacks) conditions based on data provided by an oracle. In another implementation, contract terms may include another smart contract (e.g., that acts as an oracle) resulting in a cascading smart contract. For example, a crowdsourced decentralized weather provider oracle may obtain (e.g., from smartphones of participating users) crowdsourced weather data (e.g., temperature, humidity), and provide such (e.g., combined) weather data for the smart contract. The smart contract may specify that an order to borrow an asset (e.g., corn futures) should be placed if the crowdsourced weather data matches specifications. In another example, a crowdsourced decentralized usage tracking provider oracle may obtain (e.g., from smartphones of participating users) crowdsourced usage data (e.g., which social media services people utilize), and provide such (e.g., combined) usage data for a vote (e.g., to determine the vote outcome of a conditional vote (e.g., obtained oracle data may specify that the stock price of a popular social media services company is $8 per share, resulting in the vote outcome of 50% fractional vote for Candidate A and 50% fractional vote for Candidate B) and/or to facilitate a vote action associated with the vote outcome (e.g., to borrow 100 shares of the company's stock)). In another example, a crowdsourced decentralized usage tracking provider oracle may obtain (e.g., from smartphones of participating users) crowdsourced usage data (e.g., which soft drinks college students consume), and provide such (e.g., combined) usage data for a vote (e.g., if oracle data indicates that college students increased their consumption of Coke, the vote action may be to borrow shares of The Coca-Cola Company). In another example, borrowing and/or returning assets (e.g., stocks) may be facilitated by following stock purchases and/or sales (e.g., as specified in oracle data) of another entity (e.g., a mutual fund).

It is to be understood that a wide variety of oracles may be utilized (e.g., stock exchanges, GPS data providers, date/time providers, crowdsourced decentralized data providers, news providers, activity monitors, RSS feeds, other oracles, etc.). In various embodiments, RSS feeds may be from sensor based devices such as a mobile phone (e.g., with data from many such devices aggregated into a feed), may be social network (e.g., Twitter, Facebook) or news feeds (e.g., which may be further filtered down by various parameters), may be market data feeds (e.g., Bloomberg's PhatPipe, Consolidated Quote System (CQS), Consolidated Tape Association (CTA), Consolidated Tape System (CTS), Dun & Bradstreet, OTC Montage Data Feed (OMDF), Reuter's Tib, Triarch, US equity trade and quote market data, Unlisted Trading Privileges (UTP) Trade Data Feed (UTDF), UTP Quotation Data Feed (UQDF), and/or the like feeds, e.g., via ITC 2.1 and/or respective feed protocols), and/or the like, and selecting an oracle may make a request to obtain the selected feed's data stream.

See Appendix 2 for an example of how events from a smart contract on the blockchain may be handled. If a smart contract notification associated with the smart contract has not been received, the BSA component may wait for a smart contract notification at 9941.

If a smart contract notification associated with the smart contract has been received, a borrow transaction sync notification may be provided to the user at 9945. For example, the borrow transaction sync notification may be used to inform the user that the borrow transaction was synced to the blockchain. In one implementation, the borrow transaction sync notification may be a JavaScript push notification.

FIG. 99B shows a logic flow illustrating embodiments of a transaction process optimizer (TPO) component for the SOCOACT. In FIG. 99B, a borrow transaction notification for a borrow transaction may be obtained at 9902. In one implementation, the borrow transaction notification may be obtained from a BSA component (e.g., when the BSA component processes the borrow transaction). In another example, the borrow transaction notification may be obtained from a database (e.g., via a database trigger when details regarding the borrow transaction are stored in the database).

TPO configuration parameters may be determined at 9906. For example, TPO configuration parameters may specify utilized cumulative tracking attributes, implementation type (e.g., rule-based, machine learning), utilized rules, utilized machine learning (ML) structure, synchronization (sync) threshold, and/or the like. In one implementation, a configuration file may be parsed (e.g., using PHP commands) to determine TPO configuration parameters. In another implementation, a database may be queried (e.g., using SQL statements) to determine TPO configuration parameters.

Utilized cumulative tracking attributes may be updated to reflect the impact of the borrow transaction at 9910. For example, cumulative tracking attributes may include time, risk, cost, and/or the like. In one implementation, the TPO component may keep a running count of the utilized cumulative tracking attributes based on transaction details of incoming borrow transactions. For example, the TPO component may update the cost (e.g., based on last closing price) of securities associated with borrow transactions that have not yet been synchronized to a blockchain. Accordingly, the cost of securities associated with the borrow transaction may be added to the running count of the cost. In another example, the TPO component may add the borrow transaction to the set of borrow transactions that have not yet been synchronized to the blockchain since the last time that a sync to the blockchain occurred.

A determination may be made at 9914 regarding the implementation type. If the implementation is rule-based, utilized rules may be determined at 9920. In one embodiment, a set of rules may be utilized to determine when borrow transactions should be synchronized to the blockchain based on a sync threshold. For example, the rules may specify that a sync should occur if the cumulative cost of securities associated with non-synchronized borrow transactions exceeds $10 million or if 12 hours passed since the last sync. In one implementation, time-based rules may be utilized. For example, time-based rules may specify that a sync should occur periodically (e.g., every twenty-four hours, every five minutes), at set times, and/or the like. In another implementation, cost-based rules may be utilized. For example, cost-based rules may specify that a sync should occur if the cumulative cost of securities associated with non-synchronized borrow transactions exceeds a threshold (e.g., $15 million). In another implementation, risk-based rules may be utilized. For example, risk-based rules may specify that a sync should occur if the cumulative risk (e.g., calculated based on a standard deviation of returns) of securities associated with non-synchronized borrow transactions exceeds a threshold. In another example, risk-based rules may specify that a sync should occur if the risk associated with calculating variable values (e.g., when variable values are rapidly changing, such as when rules are based on real-time asset prices) is acceptable (e.g., have high confidence that the most volatile values have been calculated). Accordingly, such a rule (e.g., utilized to prevent writing out failed contracts to the blockchain, which would be inefficient) may specify that when a set of variables (e.g., 7 out of 10) specified by the rule (e.g., based on a statistical analysis, based on analysis by a ML component) have been solved for, a sync should occur. Further, such a rule may specify that when a smart contract utilized for the sync is generated, the smart contract should include a hash of the set of variables (e.g., 7 variables) that have been solved for and a wrapper with the set of variables (e.g., 3 variables) that still remain to be solved for. Because the riskiest values have been calculated, the risk (e.g., the risk associated with calculating the remaining variables off chain, the risk associated with writing the remaining variables to the blockchain at a later time) is assuaged. The utilized rules may be applied to the utilized cumulative tracking attributes at 9924. In one embodiment, the utilized set of rules may be applied to determine whether a sync threshold associated with the utilized set of rules has been triggered (e.g., exceeded). In one implementation, a blockchain sync should occur if the sync threshold is triggered.

If the implementation is ML-based, a utilized ML structure may be determined at 9930. In one embodiment, a ML structure may be utilized to determine when borrow transactions should be synchronized to the blockchain based on historical data analysis. In one implementation, the ML structure (e.g., a neural network) may use cumulative tracking attributes as inputs and output a value to indicate whether a sync should occur. For example, the ML structure may be generated using the Scikit-learn machine learning library for the Python programming language. Various methods, such as Classification, Support Vector Machine, etc., can be used to analyze historical transactions data sets (e.g., fields such as time-stamp of a transaction, amount associated with a transaction, customer identifier associated with a transaction) to identify the pattern to optimize transactions push timing (sync timing) to the blockchain. The cumulative tracking attributes may be analyzed using the utilized ML structure at 9934. In one embodiment, the utilized ML structure may be used to determine whether a sync threshold has been triggered (e.g., if the output value exceeds a specified threshold). In one implementation, a blockchain sync should occur if the sync threshold is triggered.

A determination may be made at 9940 whether the sync threshold has been triggered. If the sync threshold has been triggered, the TPO component may send a blockchain sync notification to the BSA component. In one implementation, the blockchain sync notification may specify a set of borrow transactions that should be synchronized to the blockchain. In another implementation, the blockchain sync notification may specify how smart contracts utilized for the sync should be configured.

FIG. 100 shows a screenshot for the SOCOACT. In FIG. 100, the “Fields” column shows attribute names and the “Example” column shows the corresponding attribute values that may be utilized for processing a borrow transaction. The “Off Chain” column shows attributes that may be stored off chain. The “On Chain” column shows attributes that may be stored on chain. The “On Chain” column shows that in addition to regular attributes, a hash of off chain attributes computed using a SHA-256 hashing function may be stored on chain.

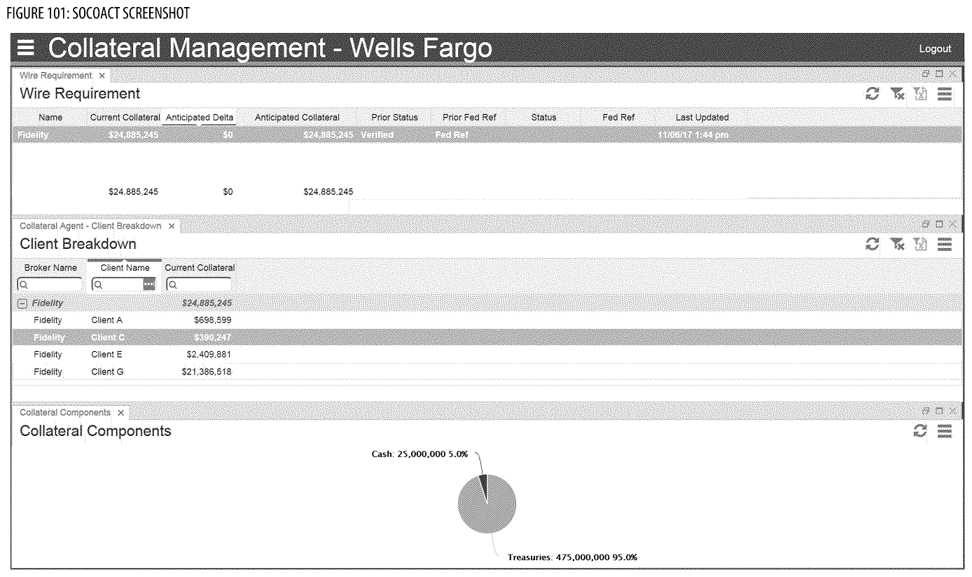

FIGS. 101-113 show various states of exemplary user interface screens that may be provided to different users throughout a borrow transaction. For example, the borrow transaction may involve a broker-dealer (e.g., Fidelity) borrowing 250 shares of PETS (Cusip-716382106) @2500 bps from a customer (e.g., Client C). Details before the borrow transaction is initiated may be as follows:

| Client | Client C |
|---|---|
| Company | PetMed Express, Inc. |
| Cusip | 716382106 |
| Ticker | PETS |
| # Shares Available to Lend | 800 |
| # Shares to be Borrowed | 250 |
| Client's Current Collateral with Agent | $390,247 |
| Fidelity's Current Collateral with Agent | $24,885,245 |
| Anticipated Delta | $− |
| Anticipated Collateral | $24,885,245 |

FIG. 101 shows a screenshot illustrating user interface(s) of the SOCOACT. In FIG. 101, a collateral agent's view before the borrow transaction is initiated is illustrated. Details provided to the collateral agent (e.g., Wells Fargo) may be as follows:

| | |
|---|---|
| Client's Current Collateral with Agent | $390,247 |
| Fidelity's Current Collateral with Agent | $24,885,245 |
| Anticipated Delta | $− |
| Anticipated Collateral | $24,885,245 |

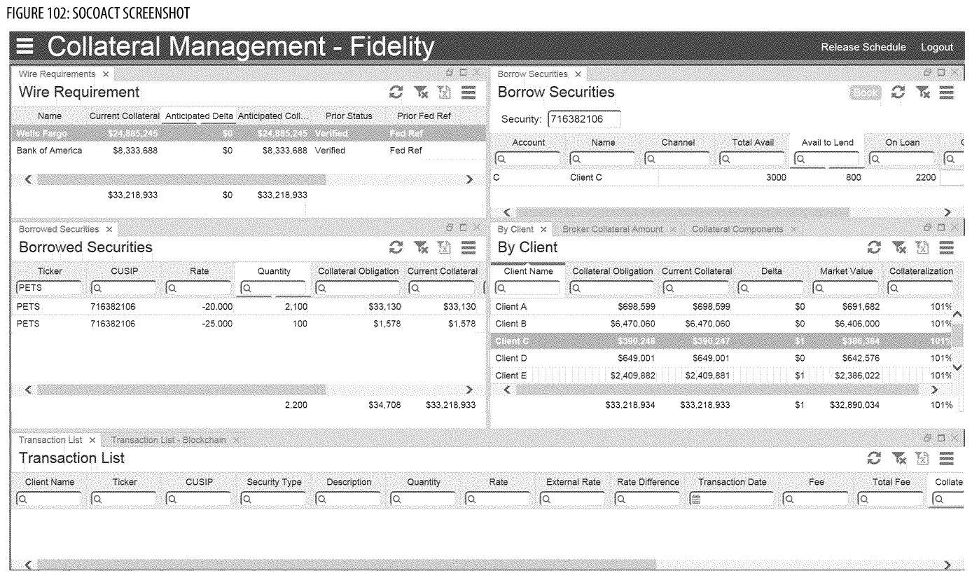

FIG. 102 shows a screenshot illustrating user interface(s) of the SOCOACT. In FIG. 102, a broker-dealer's view before the borrow transaction is initiated is illustrated. Details provided to the broker-dealer may be as follows:

| Client | Client C |
|---|---|
| Company | PetMed Express, Inc. |
| Cusip | 716382106 |
| Ticker | PETS |
| # Shares Available to Lend | 800 |
| # Shares to be Borrowed | 250 |
| On Loan | 2200 |
| Fidelity's Current Collateral with Agent | $24,885,245 |
| Fidelity's Current Collateral for Client C | $390,247 |

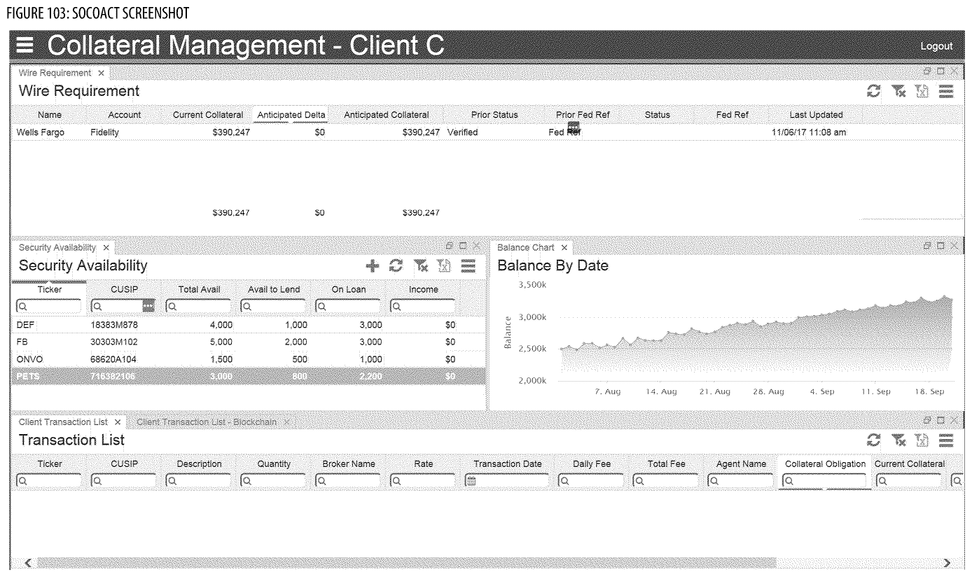

FIG. 103 shows a screenshot illustrating user interface(s) of the SOCOACT. In FIG. 103, a customer's view before the borrow transaction is initiated is illustrated. Details provided to the customer (client) may be as follows:

| Company | PetMed Express, Inc. |
|---|---|
| Cusip | 716382106 |
| Ticker | PETS |
| # Shares Available to Lend | 800 |
| On Loan | 2200 |
| Client's Current Collateral with Agent | $390,247 |

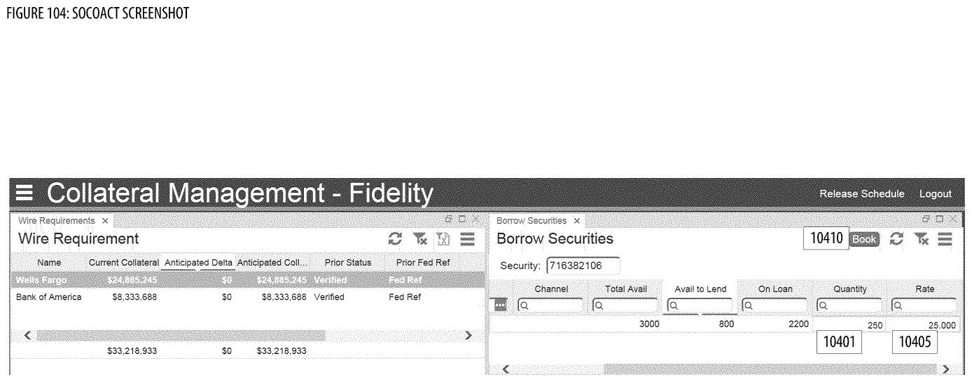

FIG. 104 shows a screenshot illustrating user interface(s) of the SOCOACT. When a trader of the broker-dealer wishes to initiate a borrow transaction, the trader may input the number of shares the trader wishes to borrow 10401 and/or a rate at which the trader wishes to borrow the shares 10405, and may utilize the “Book” button 10410 to initiate the borrow transaction.

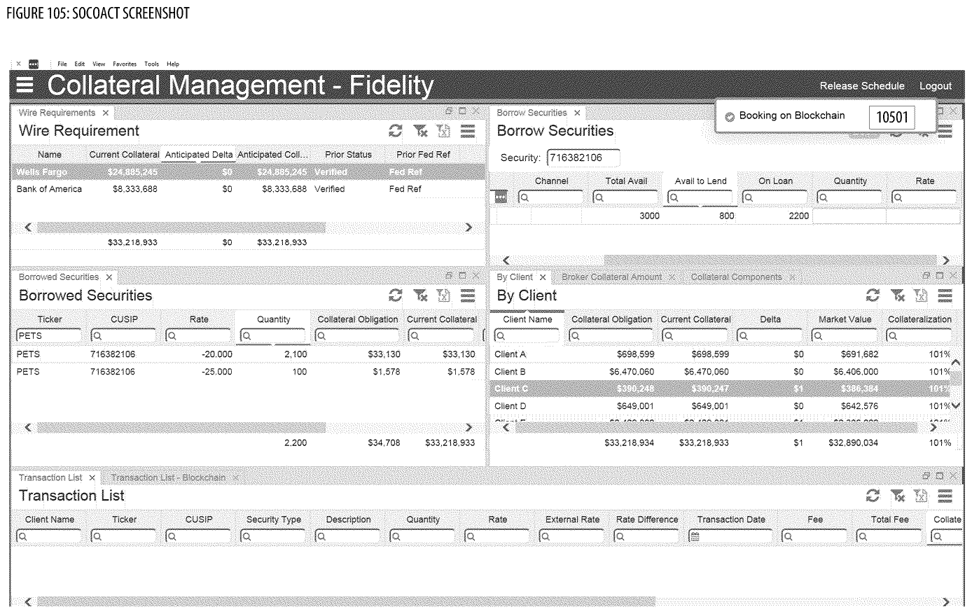

FIG. 105 shows a screenshot illustrating user interface(s) of the SOCOACT. Once the borrow transaction is initiated, the trader may be informed via an alert 10501 that the borrow transaction will be synced to a blockchain.

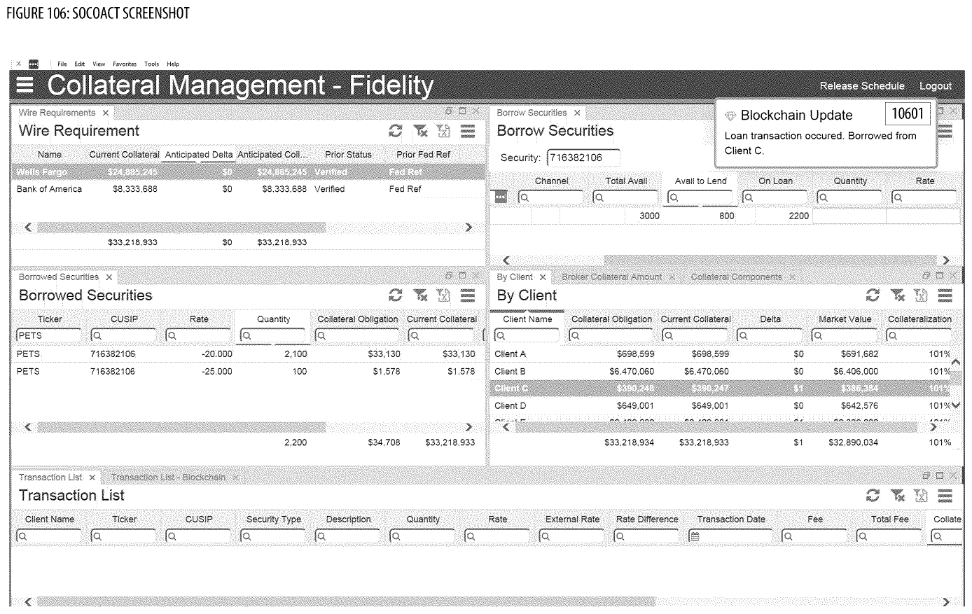

FIG. 106 shows a screenshot illustrating user interface(s) of the SOCOACT. Once the borrow transaction is synced to the blockchain, the trader may be informed via an alert 10601 that the broker-dealer has borrowed from the customer.

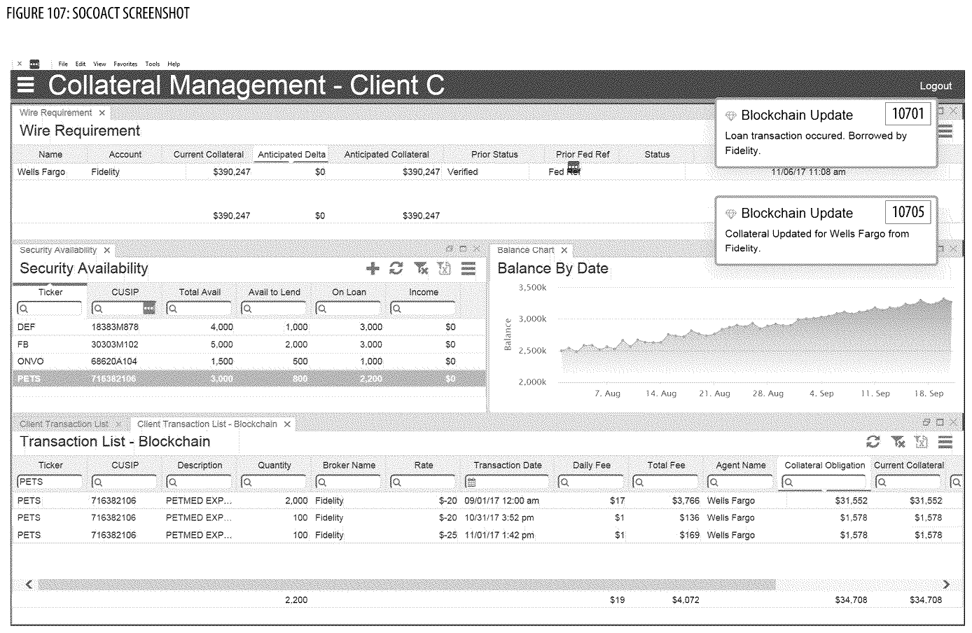

FIG. 107 shows a screenshot illustrating user interface(s) of the SOCOACT. Once the borrow transaction is synced to the blockchain, the customer may be informed via an alert 10701 that the broker-dealer has borrowed from the customer and/or via an alert 10705 that collateral associated with the customer's account with a collateral agent has been updated.

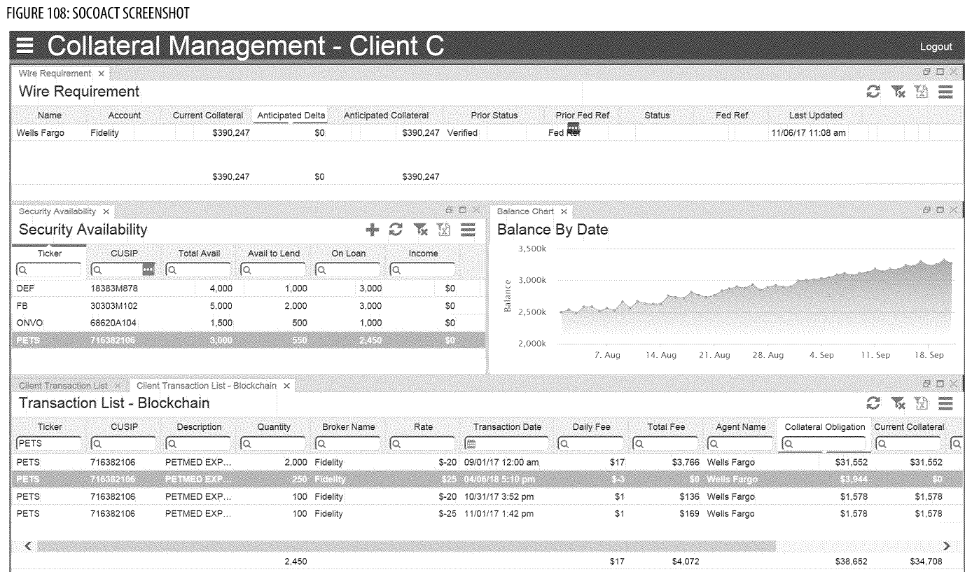

FIG. 108 shows a screenshot illustrating user interface(s) of the SOCOACT. Once the borrow transaction takes place, UI components (e.g., fields) such as transaction list, security availability, on loan, avail to land, and/or the like may be updated in the customer's view.

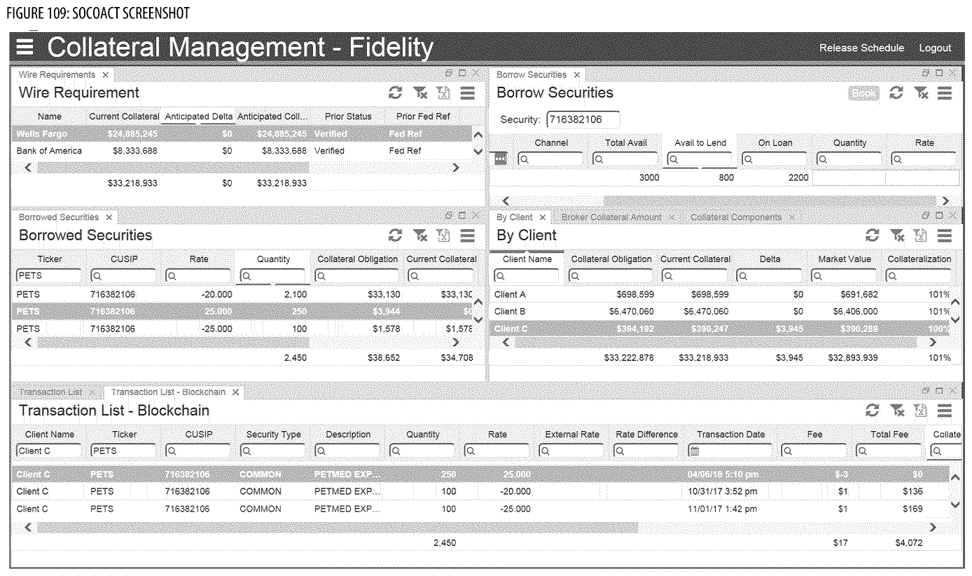

FIG. 109 shows a screenshot illustrating user interface(s) of the SOCOACT. Once the borrow transaction takes place, UI components (e.g., fields) such as transaction list, borrowed securities, on loan, avail to land, and/or the like may be updated in the broker-dealer's view.

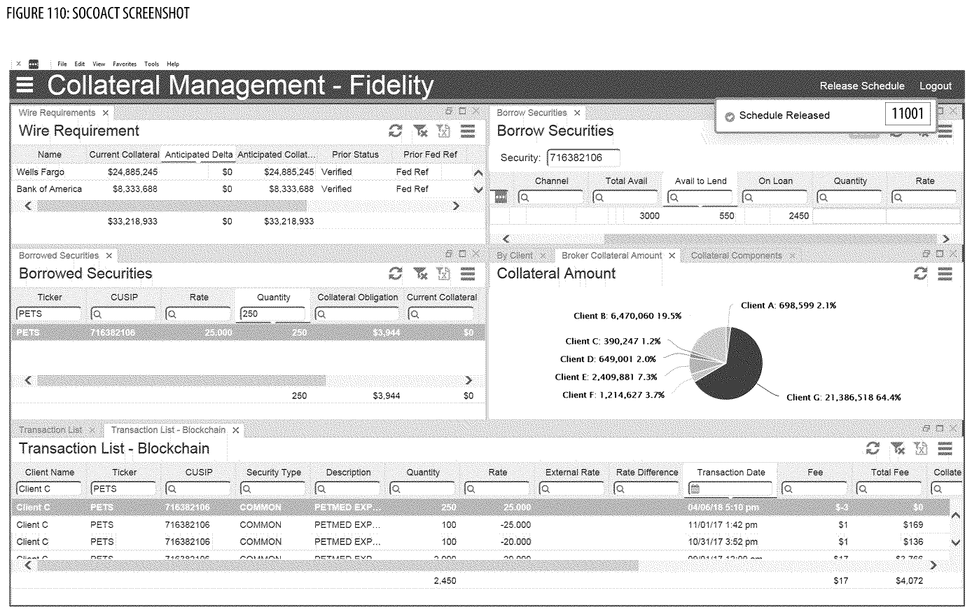

FIG. 110 shows a screenshot illustrating user interface(s) of the SOCOACT. Once the broker-dealer releases the collateral schedule, the trader may be informed via an alert 11001.

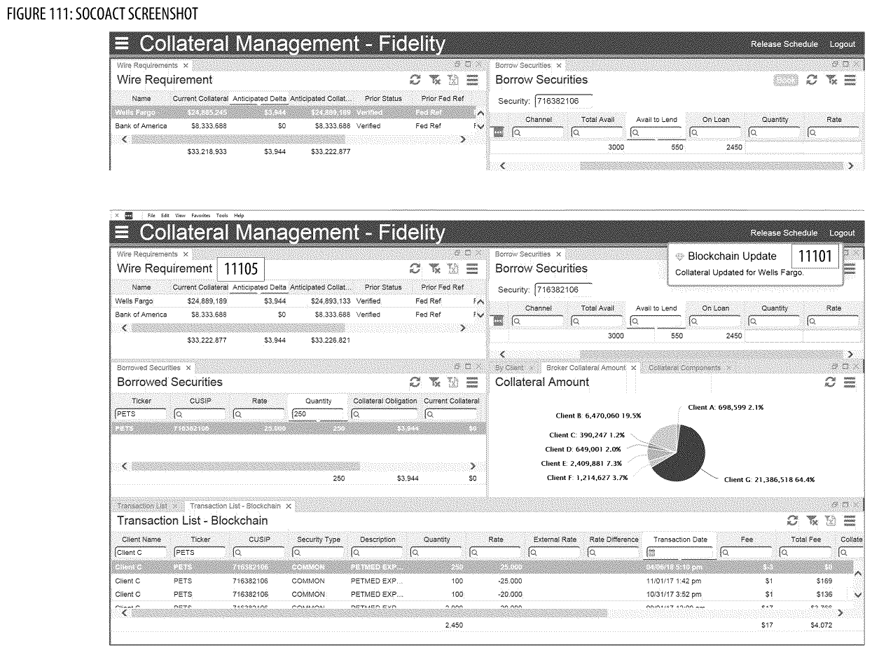

FIG. 111 shows a screenshot illustrating user interface(s) of the SOCOACT. Once the release of the collateral schedule is synced to the blockchain, a blockchain update happens as the anticipated amount of transfer from the broker-dealer's account to the customer's account with a collateral agent gets updated, and the trader may be informed via an alert 11101. Wire Requirement widget 11105 may be updated once the collateral is released by the broker-dealer. Anticipated Delta field may show the amount the collateral agent will get by the end of the day in the customer's account from the broker-dealer. If the amount is negative, that means the amount will be withdrawn.

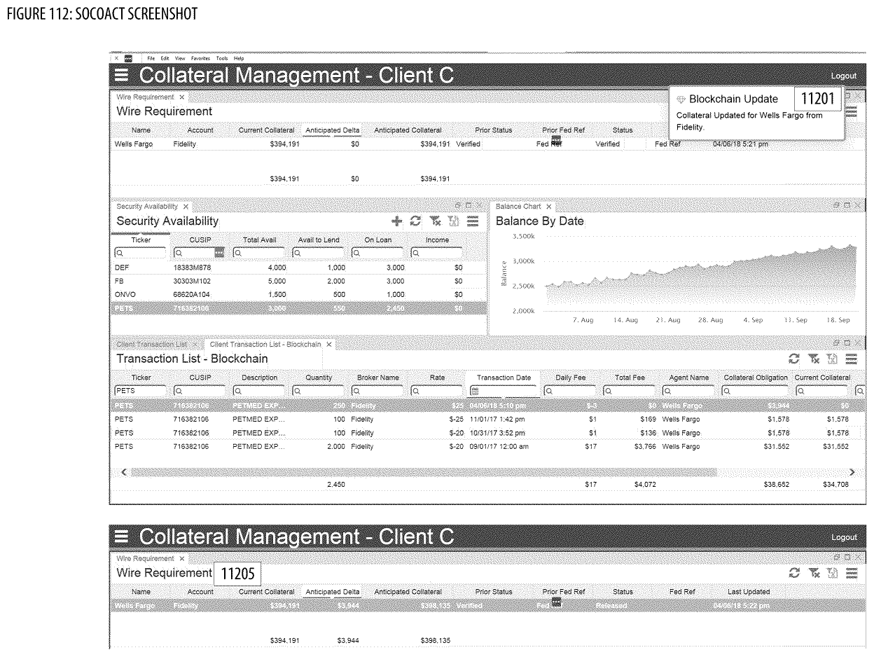

FIG. 112 shows a screenshot illustrating user interface(s) of the SOCOACT. Once the release of the collateral schedule is synced to the blockchain, a blockchain update happens as the anticipated amount of transfer from the broker-dealer's account to the customer's account with a collateral agent gets updated, and the customer may be informed via an alert 11201. Wire Requirement widget 11205 may be updated once the collateral is released by the broker-dealer. Anticipated Delta field may show the amount the collateral agent will get by the end of the day in the customer's account from the broker-dealer. If the amount is negative, that means the amount will be withdrawn.

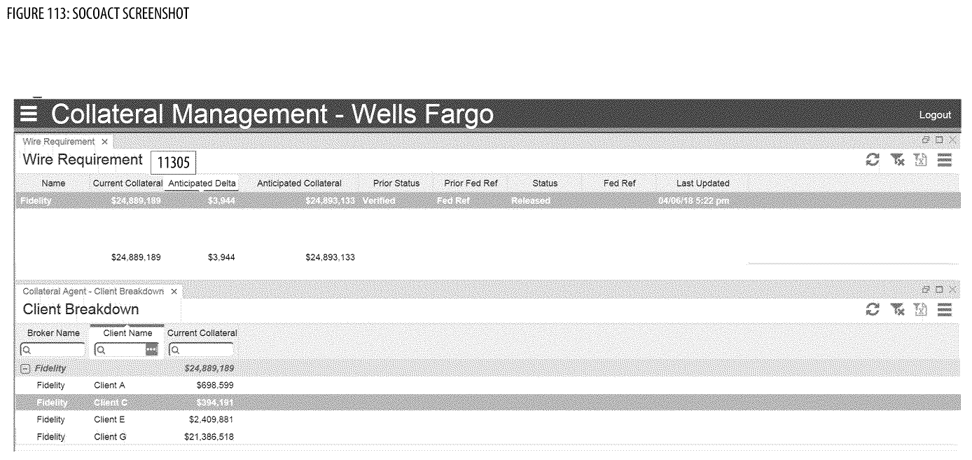

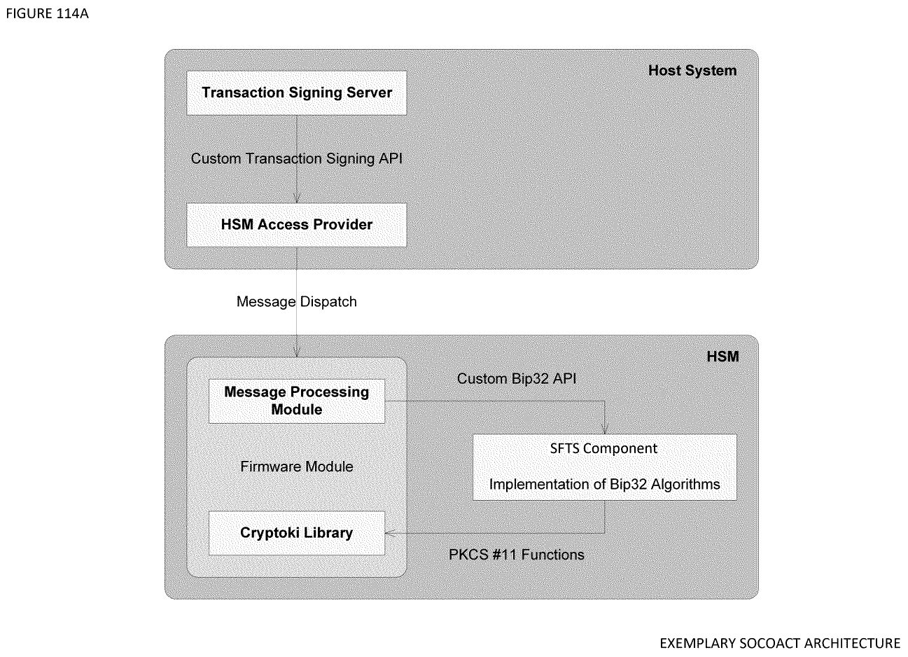

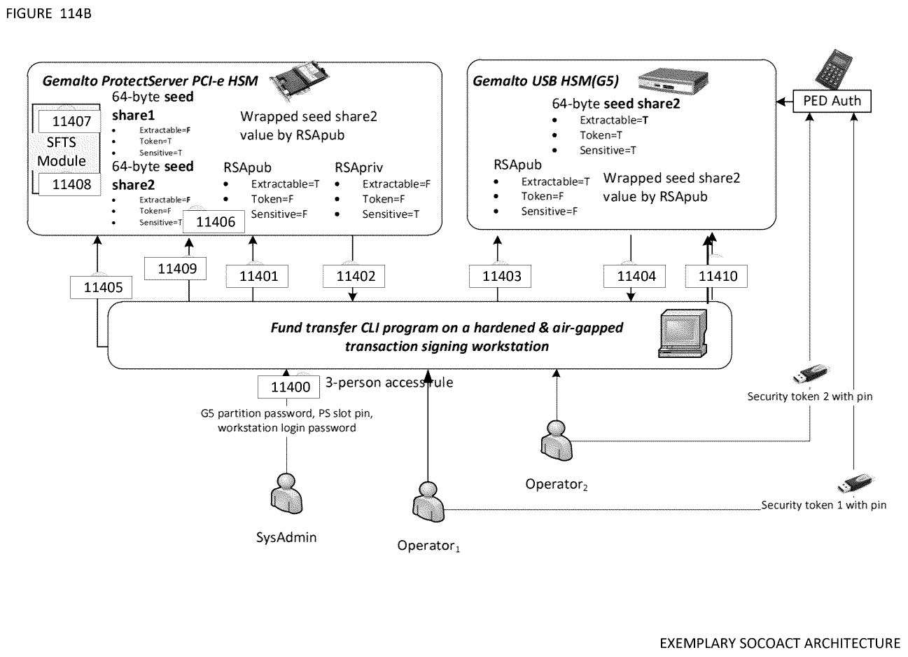

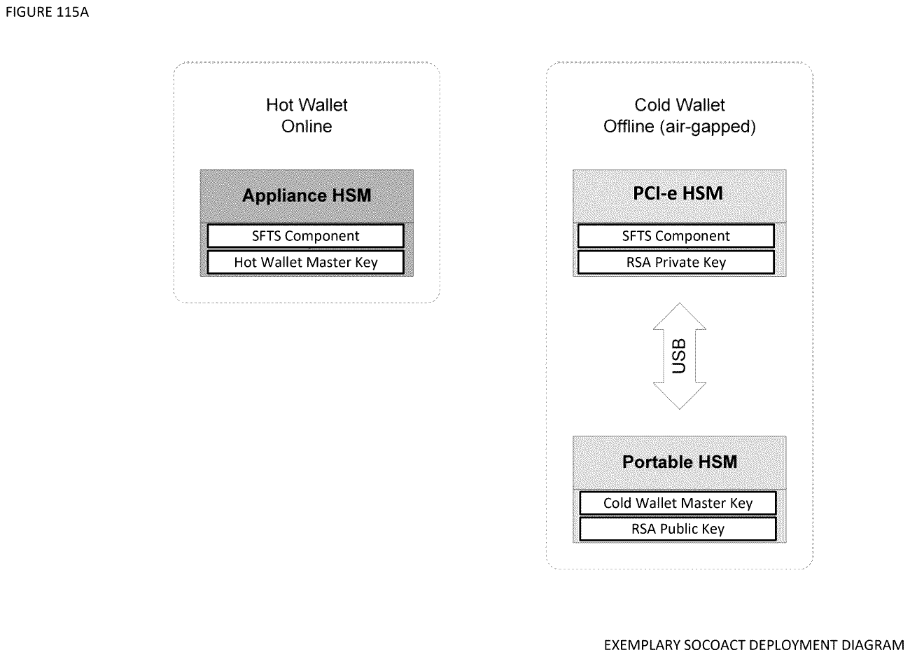

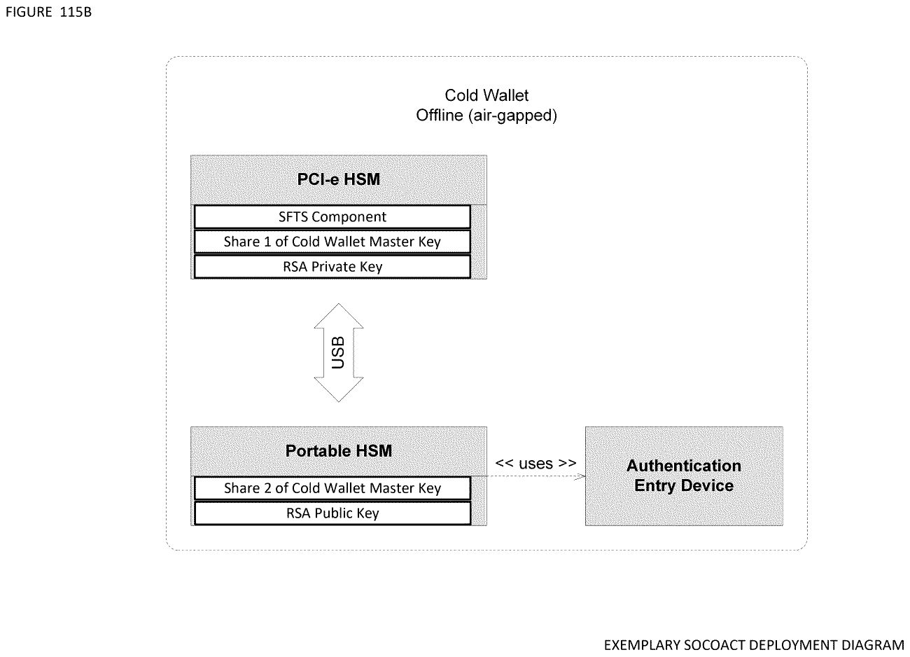

FIG. 113 shows a screenshot illustrating user interface(s) of the SOCOACT. Wire Requirement widget 11305 may be updated once the collateral is released by the broker-dealer. Anticipated Delta field may show the amount the collateral agent will get by the end of the day in the customer's account from the broker-dealer. If the amount is negative, that means the amount will be withdrawn.

FIG. 114A shows an exemplary architecture for the SOCOACT. In FIG. 114A, a TSS utilizes a custom transaction signing API via a HSM Access Provider (e.g., a module used to communicate with a HSM) to request transaction signing by a HSM (e.g., Gemalto's SafeNet HSM). The HSM may receive such requests via a message processing module of the HSM's firmware, and respond with signed transactions.

The HSM's firmware module is extended to include a secure firmware transaction signing (SFTS) module, which includes a SFTS component and/or other components (e.g., SFKB, SFKR, HSFTS, CSFTS) and an implementation of Bip32 algorithms. In some implementations, the SFTS module may utilize PKCS #11 API (e.g., via a Cryptoki Library) for message signing and hash generation. In some implementations, the SFTS module may implement high precision mathematical operations either ad hoc or using open source libraries (e.g., OpenSSL). In one embodiment, utilizing an HSM extended with a SFTS module to implement key derivation and transaction signing procedures improves security of hierarchical deterministic wallets.

FIG. 114B shows an exemplary architecture for the SOCOACT. As shown in FIG. 114B, two master private key (or seed) shares of a master private key (e.g., a 64-byte seed) were generated (e.g., via Shamir's Secret Sharing) and stored on HSMs. Seed share one (e.g., a 64-byte seed share) was generated and/or stored (e.g., with proper attributes) on Gemalto's ProtectServer PCI-e HSM. Seed share two (e.g., a 64-byte seed share) was generated and/or stored (e.g., with proper attributes) on Gemalto's G5 USB HSM. In one implementation, the following PKCS #11 key object attributes may be set:

CKA_EXTRACTABLE = whether a seed share is extractable from and can be wrapped out
of HSM
CKA_TOKEN = whether a seed share is a permanent or a transient/session object on
HSM
CKA_SENSITIVE = whether a seed share is readable (e.g., can be revealed in
plaintext) outside of HSM

For example, attributes for seed share one may be set to make seed share one sensitive and not exportable. In another example, attributes for seed share two may be set to make seed share two sensitive but exportable.

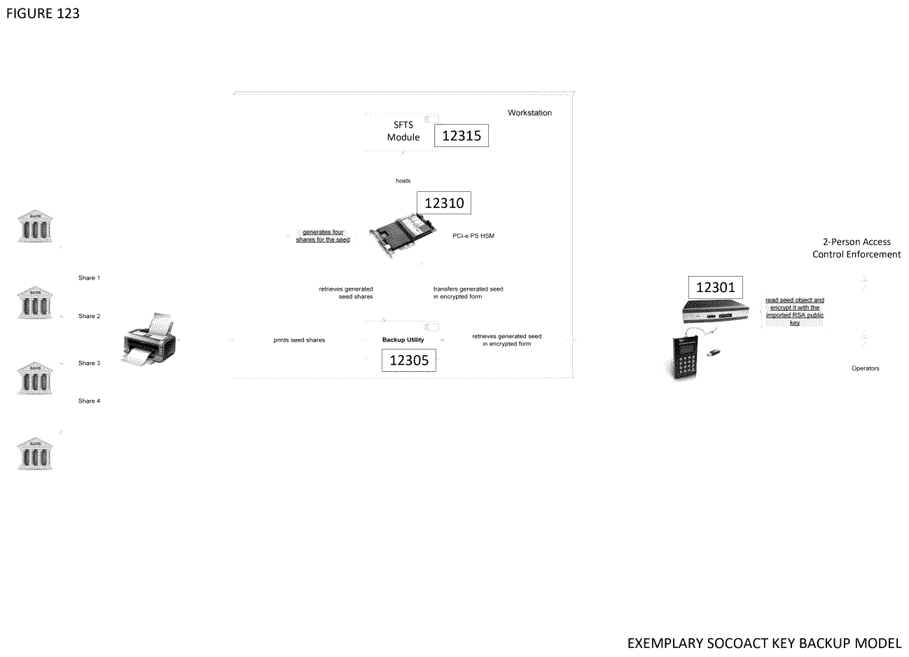

In one implementation, each seed share may be backed up (e.g., using a key backup model described with regard to FIG. 123) and may be recovered independently of other seed shares.

At 11400, in order to sign a transaction (e.g., to execute a fund transfer CLI program to transfer funds from a cold wallet to a hot wallet), multiple (e.g., three) operators may have to be present (e.g., physically present) to authenticate to a TSS and/or the HSMs. For example, a system administrator (e.g., SysAdmin) may have to provide a TSS login password, and/or PCI-e HSM slot pin, and/or USB HSM partition password. In another example, two operators (e.g., Operator) and Operator₂) may have to be authenticated to the USB HSM (e.g., via 2-factor authentication process with the first factor being a physical security token and the second factor being a PIN) via an authentication entry device (e.g., a PED) to enforce MofN security policy for exporting seed share two, and/or to the PCI-e HSM (e.g., via a PIN), and/or to the TSS (e.g., via a password).

At 11401, an RSA key pair (e.g., a RSA public key RSApub, and a RSA private key RSApriv) may be generated on the PCI-e HSM as wrapping/unwrapping keys. At 11402, the public key RSApub may be exported from the PCI-e HSM to RAM of the TSS for the fund transfer CLI program. At 11403, the fund transfer CLI program may import the public key RSApub into the USB HSM. At 11404, the USB HSM may wrap (e.g., encrypt) seed share two with the wrapping key RSApub and export the wrapped seed share two to RAM of the TSS for the fund transfer CLI program. At 11405, the fund transfer CLI program may import the wrapped seed share two into the PCI-e HSM. At 11406, the PCI-e HSM may unwrap (e.g., decrypt) the wrapped seed share two with the unwrapping key RSAPriv back to its original byte materials. Proper attribute settings for the unwrapped seed share two may be set. At 11407, a method such as Shamir's Secret Sharing may be utilized (e.g., via a SFTS module) to recover the master private key (e.g., from seed share one and seed share two) for BIP-32 hierarchical deterministic key derivation (e.g., via the SFTS module). At 11408, the transaction may be signed using the BIP-32 derived private key (e.g., via the SFTS module).

In one implementation, key materials other than seed share one on PCI-e HSM and seed share two on USB HSM are deleted from memory when a session is over (e.g., when the transaction is signed). At 11409, RSApub, RSApriv, wrapped seed share two, unwrapped seed share two, the recovered master private key, and the BIP-32 derived private key may be deleted from memory of PCI-e HSM. At 11410, RSApub and wrapped seed share two may be deleted from memory of USB HSM and/or TSS.

FIG. 115A shows an exemplary deployment diagram for the SOCOACT. In FIG. 115A, a deployment diagram for hot and cold storages of funds (e.g., wallets) is shown. A hot wallet (e.g., holding a small amount of funds for online purchases) is using an online network appliance HSM hosting both a hot wallet master private key and a SFTS component. A cold wallet (e.g., holding the majority of funds offline), is using an offline (e.g., PCI-e) HSM hosting a SFTS component and a RSA private key used for decrypting a cold wallet master private key retrieved from a portable HSM. The portable (e.g., USB-connected) HSM hosts the cold wallet master private key and the RSA public key matching the RSA private key stored in the offline (e.g., PCI-e) HSM.

In some embodiments, the SOCOACT may protect addresses used for receiving funds in transactions between paired cold and hot wallets. These addresses are derived from master keys in a similar way as the derivation of private keys used for transaction signing. Accordingly, these addresses may be protected if transaction composition code uses addresses generated directly from a HSM to transfer funds between cold and hot wallets.

FIG. 115B shows another exemplary deployment diagram for the SOCOACT. In FIG. 115B, a deployment diagram for cold storages of funds is shown. A cold wallet (e.g., holding the majority of funds offline), is using an offline (e.g., PCI-e) HSM hosting a SFTS component, a first cold wallet master private key share, and a RSA private key used for decrypting a second cold wallet master private key share retrieved from a portable HSM. The portable (e.g., USB-connected) HSM hosts the second cold wallet master private key share and the RSA public key matching the RSA private key stored in the offline (e.g., PCI-e) HSM. The portable HSM uses an authentication entry device (e.g., a PED) to enforce MofN security policy for exporting the second cold wallet master private key share.

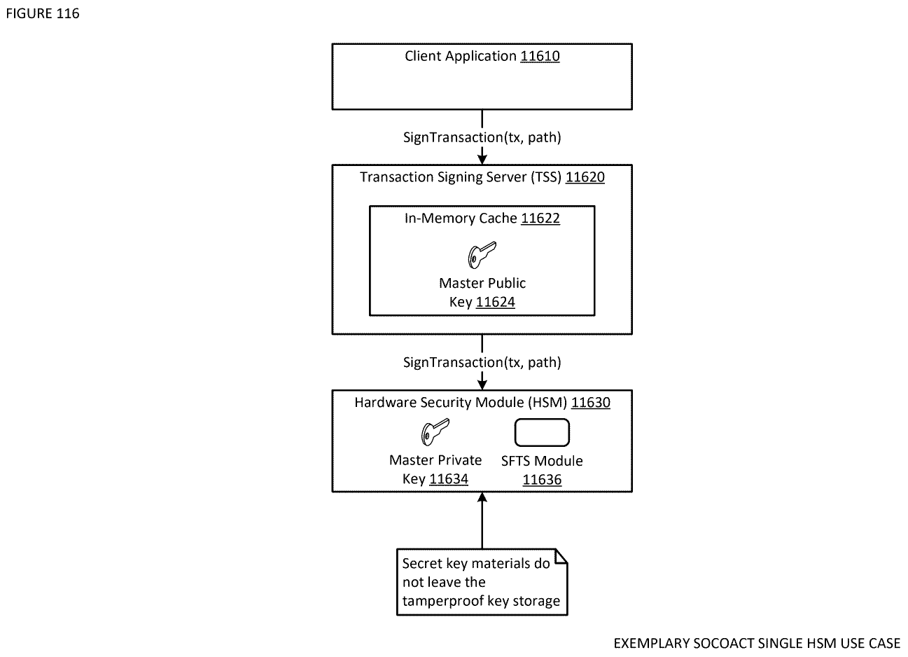

FIG. 116 shows an exemplary single HSM use case for the SOCOACT. For example, this use case may be utilized for a hot wallet. In FIG. 116, a client application 11610 (e.g., utilized by a user via a client device) may send a transaction signing request (e.g., including transaction data to sign and a keychain path to be used for Bip32 key derivation) to a TSS 11620. The TSS may include an in-memory cache 11622 that stores a master public key 11624. For example, the TSS may provide the master public key to the client application, if requested.

The TSS may forward the transaction signing request to a HSM 11630. For example, the HSM may be a network-attached HSM. The HSM's tamper-proof storage (e.g., the HSM's firmware) may store a master private key (e.g., an ECDSA private key) 11634 and a SFTS module 11636. The HSM may utilize the master private key and the SFTS module to sign the transaction, and may respond with a signed transaction (e.g., ECDSA signature in Distinguished Encoding Rules (DER) format). Sensitive operations, such as key derivation and transaction signing, are implemented inside the HSM appliance and master secret key materials do not leave the tamper-proof storage. Tamper-proof storage ensures that secret information is inaccessible to an attacker and that any attempted attack is detected and reported to the appropriate operational group.

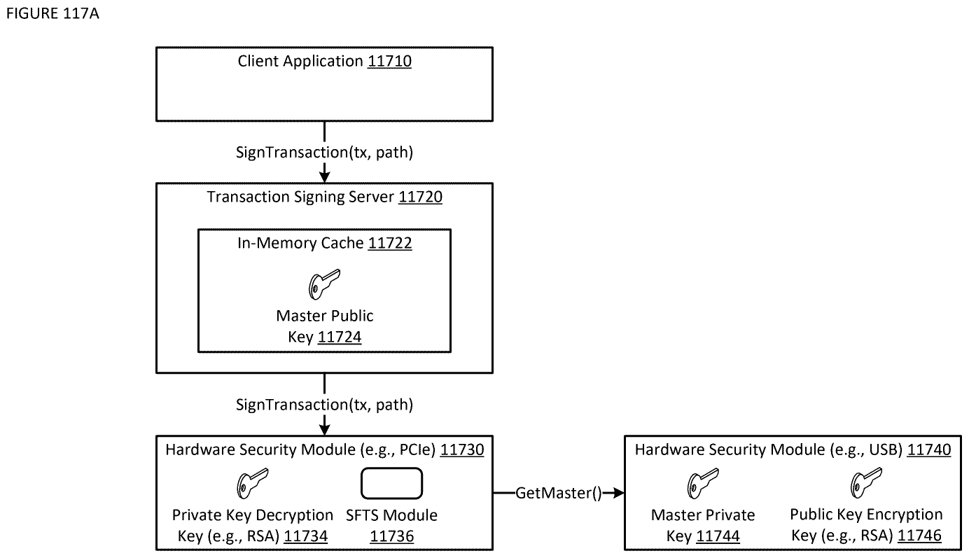

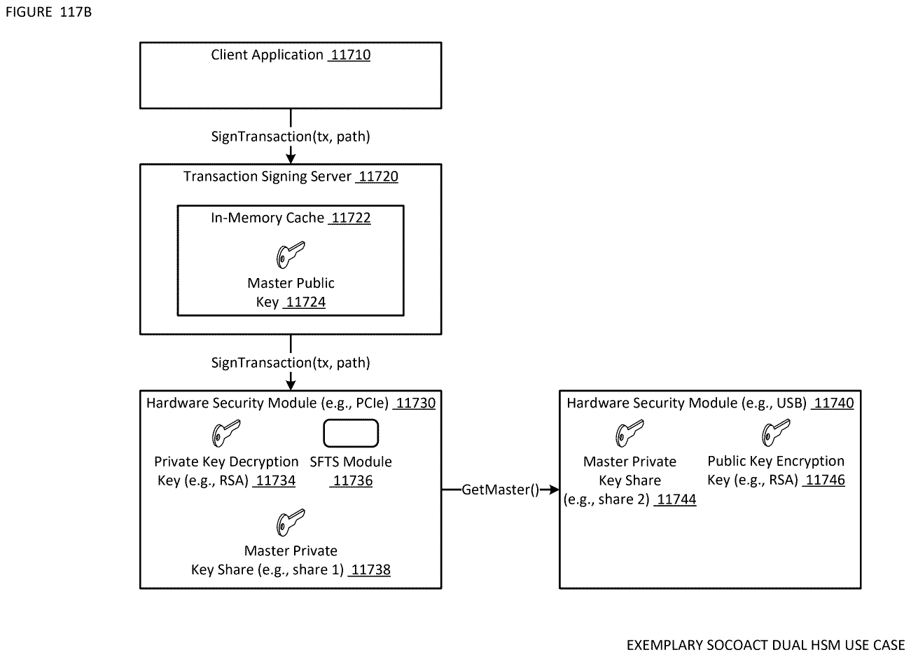

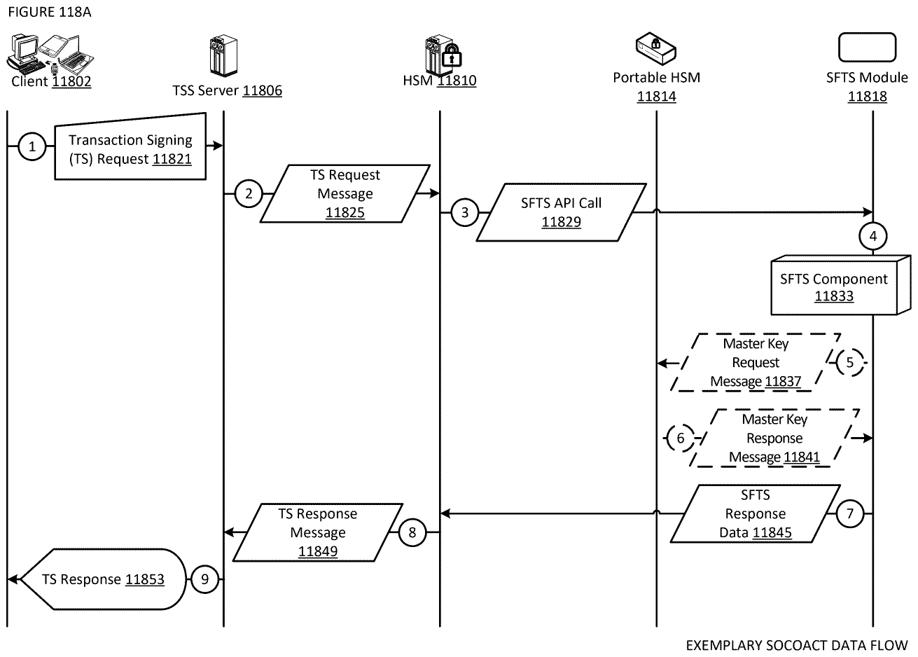

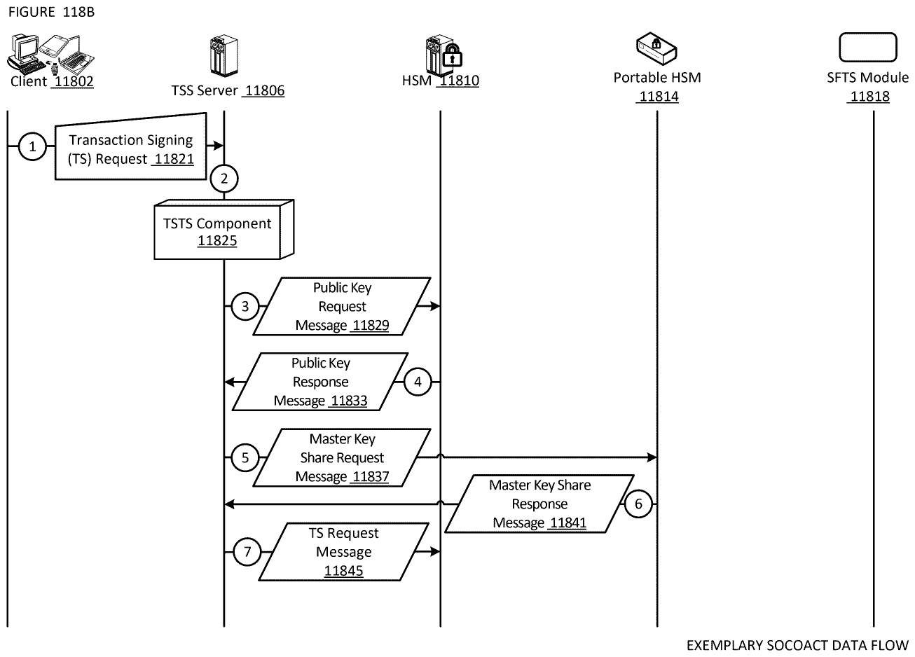

FIG. 117A shows an exemplary dual HSM use case for the SOCOACT. For example, this use case may be utilized for a cold wallet (e.g., corresponding to the cold wallet shown in FIG. 115A). In FIG. 117A, a client application 11710 (e.g., utilized by a user via a client device) may send a transaction signing request (e.g., including transaction data to sign and a keychain path to be used for Bip32 key derivation) to a TSS 11720. The TSS may include an in-memory cache 11722 that stores a master public key 11724. For example, the TSS may provide the master public key to the client application, if requested.

The TSS may forward the transaction signing request to a first HSM 11730. For example, the first HSM may be a PCIe HSM (e.g., installed in a TSS (e.g., machine)). The first HSM's tamper-proof storage (e.g., the first HSM's firmware) may store a private key decryption key (e.g., an RSA private key) 11734 and a SFTS module 11736.

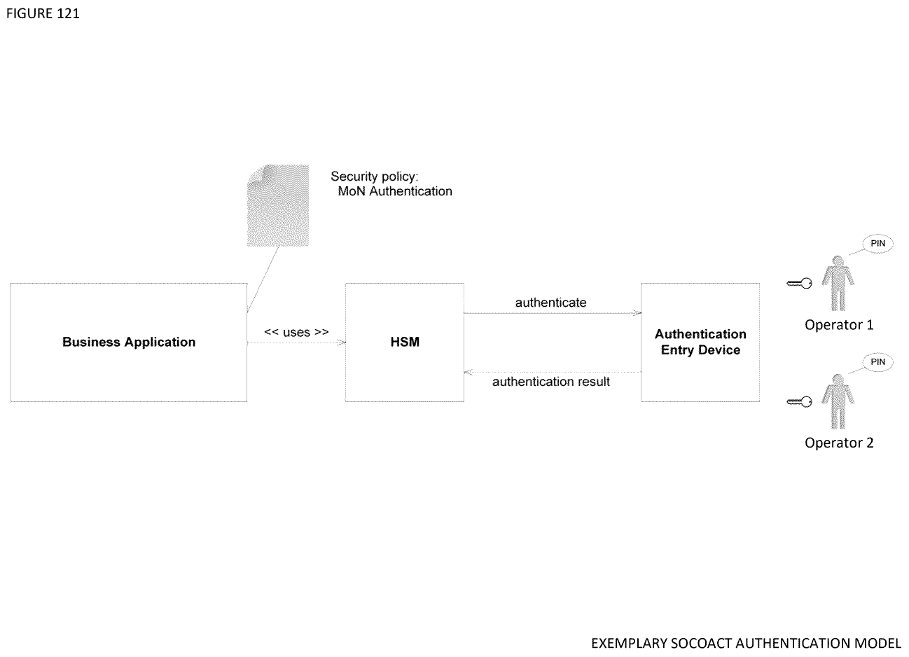

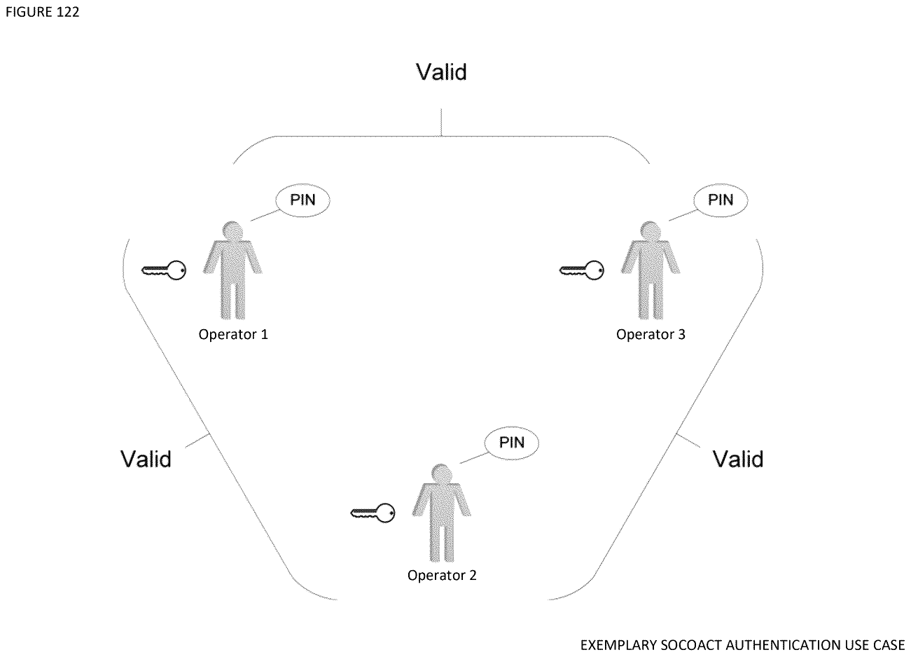

The first HSM may send a get master request to a second HSM 11740. For example, the second HSM may be a portable USB HSM. The second HSM's tamper-proof storage (e.g., the second HSM's firmware) may store a master private key (e.g., an ECDSA private key) 11744 and a public key encryption key (e.g., an RSA public key that corresponds to the RSA private key stored in the first HSM's tamper-proof storage) 11746. In one embodiment, the second HSM may include a split credentials PIN entry device (PED) to provide for multiple-person (e.g., M-of-N) user access rule for HSM activation and/or operation (e.g., 2-of-3 operation enforcement that allows access to the master private key if at least two out of three people provide their separate credentials to the second HSM). See FIGS. 121 and 122 for additional details regarding M-of-N authentication.

The second HSM may encrypt the master private key using the public key encryption key (e.g., associated with the first HSM), and may respond to the get master request by returning the encrypted master private key to the first HSM. The first HSM may decrypt the master private key using the private key decryption key, may utilize the decrypted master private key and the SFTS module to sign the transaction, and may respond with a signed transaction (e.g., ECDSA signature in DER format). Sensitive operations, such as key derivation and transaction signing, are implemented inside the first HSM appliance and secret key materials are encrypted when transferred between the two HSMs.

FIG. 117B shows an exemplary dual HSM use case for the SOCOACT. For example, this use case may be utilized for a cold wallet (e.g., corresponding to the cold wallet shown in FIG. 115B). In FIG. 117B, a client application 11710 (e.g., utilized by a user via a client device) may send a transaction signing request (e.g., including transaction data to sign and a keychain path to be used for Bip32 key derivation) to a TSS 11720. The TSS may include an in-memory cache 11722 that stores a master public key 11724. For example, the TSS may provide the master public key to the client application, if requested.

The TSS may forward the transaction signing request to a first HSM 11730. For example, the first HSM may be a PCIe HSM (e.g., installed in a TSS (e.g., machine)). The first HSM's tamper-proof storage (e.g., the first HSM's firmware) may store a private key decryption key (e.g., an RSA private key) 11734, a SFTS module 11736, and a first master private key share (e.g., an ECDSA private key share) 11738.

The first HSM may send a get master request to a second HSM 11740. For example, the second HSM may be a portable USB HSM. The second HSM's tamper-proof storage (e.g., the second HSM's firmware) may store a second master private key share (e.g., an ECDSA private key share) 11744 and a public key encryption key (e.g., an RSA public key that corresponds to the RSA private key stored in the first HSM's tamper-proof storage) 11746. In one embodiment, the second HSM may include a split credentials PIN entry device (PED) to provide for multiple-person (e.g., M-of-N) user access rule for HSM activation and/or operation (e.g., 2-of-3 operation enforcement that allows access to the second master private key share if at least two out of three people provide their separate credentials to the second HSM). See FIGS. 121 and 122 for additional details regarding M-of-N authentication.

The second HSM may encrypt the second master private key share using the public key encryption key (e.g., associated with the first HSM), and may respond to the get master request by returning the encrypted second master private key share to the first HSM. The first HSM may decrypt the second master private key share using the private key decryption key, may utilize the decrypted second master private key share, the first master private key share, any other master private key share(s) (e.g., in implementations where the master private key is split into more than two shares and retrieved from multiple portable HSMs (e.g., to reassemble the master private key from three shares)), and the SFTS module to sign the transaction, and may respond with a signed transaction (e.g., ECDSA signature in DER format). Sensitive operations, such as key derivation and transaction signing, are implemented inside the first HSM appliance and secret key materials are encrypted when transferred between the two HSMs.

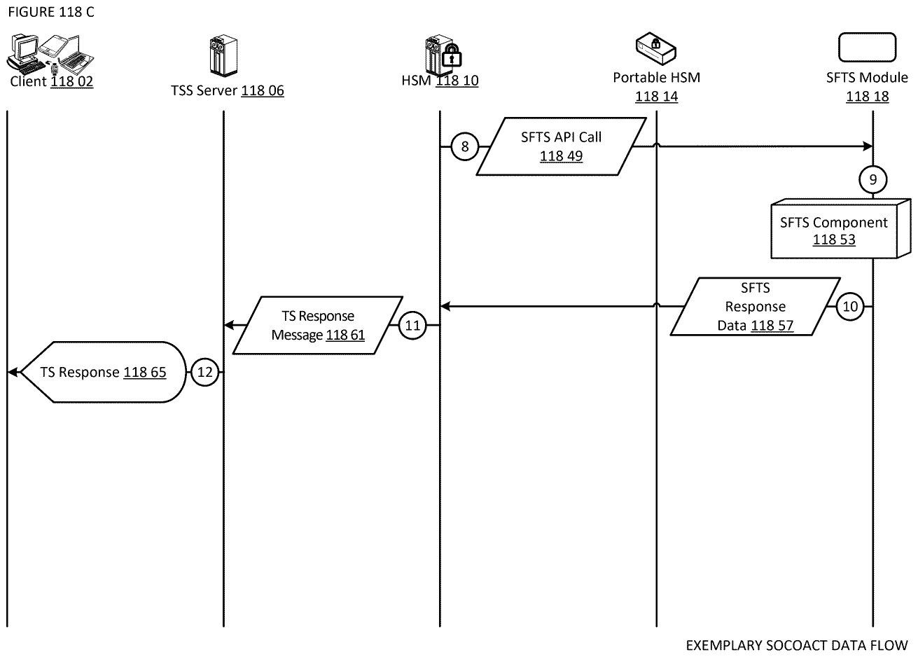

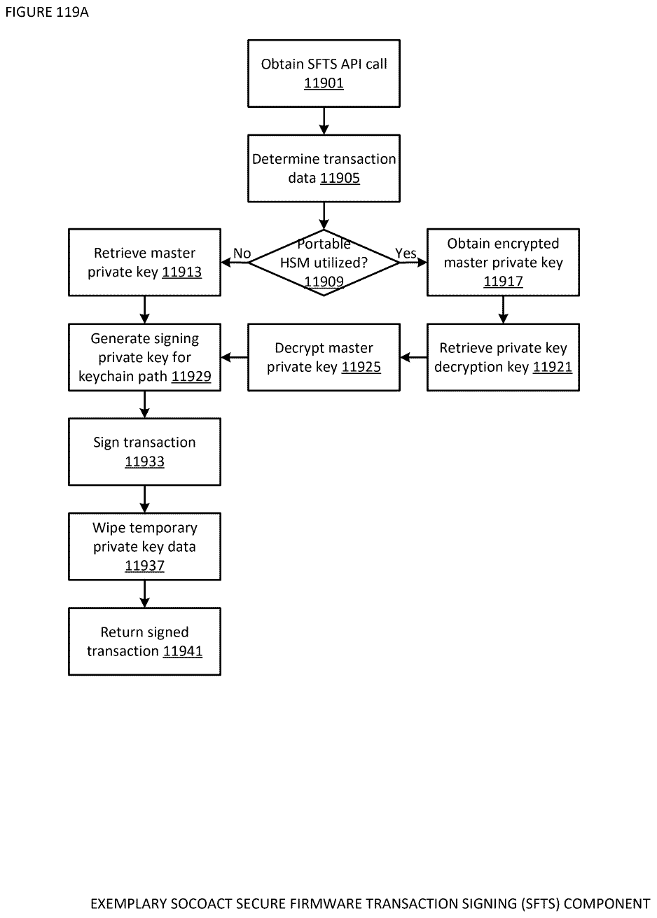

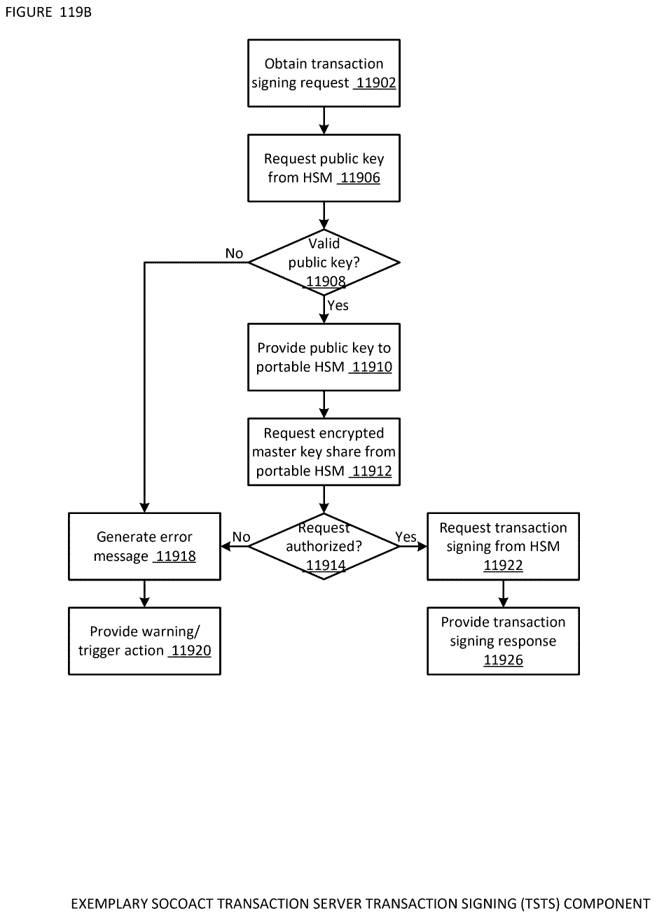

FIG. 118A shows a datagraph diagram illustrating embodiments of a data flow for the SOCOACT. In FIG. 118A, dashed lines indicate data flow elements that may be more likely to be optional. In FIG. 118A, a client 11802 may send a transaction signing (TS) request 11821 to a TSS server 11806 to request that a transaction be signed. For example, the client may be a desktop, a laptop, a tablet, a smartphone, and/or the like that is executing a client application. In one implementation, the TS request may include data such as a request identifier, user authentication data, a request type (e.g., sign message hash, get address hash), a wallet identifier, a transaction identifier, a transaction hash, a keychain path, and/or the like. In one embodiment, the client may provide the following example TS request, substantially in the form of a (Secure) Hypertext Transfer Protocol (“HTTP(S)”) POST message including extensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</account_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <TS_request>
    <request_identifier>ID_request_1</request_identifier>
    <request_type>SIGN_TRANSACTION</request_type>
    <wallet_identifier>ID_Wallet1</wallet_identifier>
    <transaction_identifier>ID_transaction_1</transaction_identifier>
    <transaction_hash>256-bit hash value to be signed</transaction_hash>
    <keychain_path>m/0/0/1/0</keychain_path>
  </TS_request>
</auth_request>
```

The TSS server may send a TS request message 11825 to a HSM 11810 to request that the HSM sign the transaction. In one implementation, the TS request message may be sent via a HSM Access Provider and may include data such as a request identifier, a request type (e.g., sign message hash, get address hash), a wallet identifier, a transaction hash, a keychain path, and/or the like. For example, the TSS server may provide the following example TS request message, substantially in the form of a HTTP(S) POST message including XML-formatted data, as provided below:

```
POST /TS_request_message.php HTTP/1.1
Host: www.server.com
Content-Type: Application/XML
Content-Length: 667
<?XML version = “1.0” encoding = “UTF-8”?>
<TS_request_message>
  <request_identifier>ID_request_2</request_identifier>
  <request_type>SIGN_TRANSACTION</request_type>
  <wallet_identifier>ID_Wallet1</wallet_identifier>
  <transaction_hash>256-bit hash value to be signed</transaction_hash>
  <keychain_path>m/0/0/1/0</keychain_path>
</TS_request_message>
```

The HSM may make a SFTS API call 11829 to a SFTS module 11818 to request that the SFTS module sign the transaction. In one implementation, the SFTS API call may include data such as a request type (e.g., sign message hash, get address hash), a wallet identifier, a transaction hash, a keychain path, and/or the like.

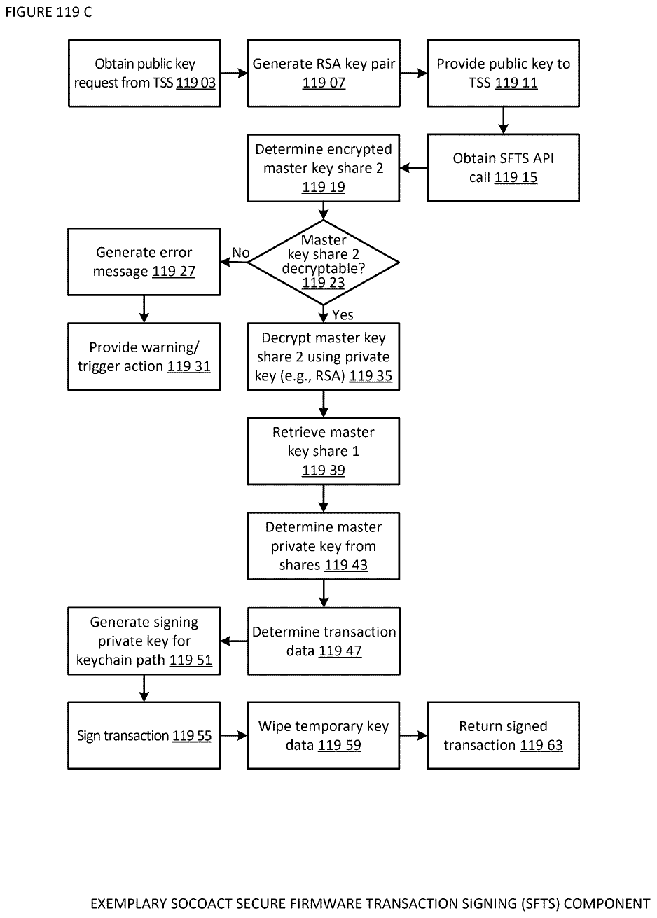

Data provided in the SFTS API call may be used by a secure firmware transaction signing (SFTS) component 11833 to sign the transaction (e.g., to generate an ECDSA signature in DER format). See FIG. 119A for additional details regarding the SFTS component.

In some embodiments, the SFTS module may send a master key request message 11837 to a portable HSM 11814 to request a master private key (e.g., for a specified wallet) from the portable HSM. In one implementation, the master key request message may include data such as a request identifier, a calling HSM identifier, a wallet identifier, and/or the like. For example, the SFTS module may provide the following example master key request message, substantially in the form of a HTTP(S) POST message including XML-formatted data, as provided below:

```
POST /master_key_request_message.php HTTP/1.1
Host: www.server.com
Content-Type: Application/XML
Content-Length: 667
<?XML version = “1.0” encoding = “UTF-8”?>
<master_key_request_message>
  <request_identifier>ID_request_3</request_identifier>
  <calling_HSM_identifier>ID_HSM_1</calling_HSM_identifier>
  <wallet_identifier>ID_Wallet1</wallet_identifier>
</master_key_request_message>
```

The portable HSM may provide the encrypted master private key to the SFTS module via a master key response message 11841.

The SFTS module may send SFTS response data 11845 to the HSM in response to the SFTS API call. In one implementation, the SFTS response data may include an ECDSA signature in DER format.

The HSM may send a TS response message 11849 to the TSS server (e.g., via a HSM Access Provider). In one implementation, the TS response message may include data such as a response identifier, a transaction signature, and/or the like. For example, the HSM may provide the following example TS response message, substantially in the form of a HTTP(S) POST message including XML-formatted data, as provided below:

```
POST /TS_response_message.php HTTP/1.1
Host: www.server.com
Content-Type: Application/XML
Content-Length: 667
<?XML version = “1.0” encoding = “UTF-8”?>
  <TS_response_message>
  <response_identifier>ID_response_2</response_identifier>
  <transaction_signature>ECDSA signature in DER
  format</transaction_signature>
</TS_response_message>
```

The TSS server may send a TS response 11853 to the client. In one implementation, the TS response may include data such as a response identifier, a transaction identifier, a transaction signature, and/or the like. For example, the TSS server may provide the following example TS response, substantially in the form of a HTTP(S) POST message including XML-formatted data, as provided below:

```
POST /TS_response.php HTTP/1.1
Host: www.server.com
Content-Type: Application/XML
Content-Length: 667
<?XML version = “1.0” encoding = “UTF-8”?>
<TS_response>
  <response_identifier>ID_response_1</response_identifier>
  <transaction_identifier>ID_transaction_1</transaction_identifier>
  <transaction_signature>ECDSA signature in DER
  format</transaction_signature>
</TS_response>
```

FIGS. 118B-C show a datagraph diagram illustrating embodiments of a data flow for the SOCOACT. In FIGS. 118B-C, a client 11802 may send a transaction signing (TS) request 11821 to a TSS server 11806 to request that a transaction be signed. For example, the client may be an air-gapped desktop, a laptop, a tablet, a smartphone, and/or the like that is executing a client application. In one implementation, the TS request may include data such as a request identifier, user authentication data, a request type (e.g., sign message hash, get address hash), a wallet identifier, a transaction identifier, a transaction hash, a keychain path, and/or the like. In one embodiment, the client may provide the following example TS request, substantially in the form of a HTTP(S) POST message including XML-formatted data, as provided below:

```
POST /authrequest.php HTTP/1.1
Host: localhost
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</account_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <TS_request>
    <request_identifier>ID_request_1</request_identifier>
    <request_type>SIGN_TRANSACTION</request_type>
    <wallet_identifier>ID_Wallet1</wallet_identifier>
    <transaction_identifier>ID_transaction_1</transaction_identifier>
    <transaction_hash>256-bit hash value to be signed</transaction_hash>
    <keychain_path>m/0/0/1/0</keychain_path>
  </TS_request>
</auth_request>
```

A transaction server transaction signing (TSTS) component 11825 may utilize parameters provided in the TS request to facilitate transaction signing. See FIG. 119B for additional details regarding the TSTS component.

The TSS server may send a public key request message 11829 to a HSM 11810 to request a RSA public key from the HSM. In one implementation, the public key request message may be sent via a HSM Access Provider and may include data such as a request identifier, a transaction identifier, and/or the like. In one embodiment, the TSS server may provide the following example public key request message, substantially in the form of a HTTP(S) POST message including XML-formatted data, as provided below:

```
POST /public_key_request_message.php HTTP/1.1
Host: localhost
Content-Type: Application/XML
Content-Length: 667
<?XML version = “1.0” encoding = “UTF-8”?>
<public_key_request_message>
  <request_identifier>ID_request_2</request_identifier>
  <transaction_identifier>ID_transaction_1</transaction_identifier>
</public_key_request_message>
```

The HSM may provide a RSA public key to the TSS server via a public key response message 11833. In one implementation, the public key response message may include data such as a response identifier, a transaction identifier, a RSA public key, and/or the like. In one embodiment, the HSM may provide the following example public key response message, substantially in the form of a HTTP(S) POST message including XML-formatted data, as provided below:

```
POST /public_key_response_message.php HTTP/1.1
Host: localhost
Content-Type: Application/XML
Content-Length: 667
<?XML version = “1.0” encoding = “UTF-8”?>
<public_key_response_message>
  <response_identifier>ID_response_2</response_identifier>
  <transaction_identifier>ID_transaction_1</transaction_identifier>
  <RSA_public_key>RSA public key provided by the
  HSM</RSA_public_key>
</public_key_response_message>
```

The TSS server may send a master key share request message 11837 to a portable HSM 11814 to request an encrypted master key share (e.g., for a specified wallet) from the portable HSM. In one implementation, the master key share request message may include data such as a request identifier, a transaction identifier, a wallet identifier, a RSA public key, and/or the like. In one embodiment, the TSS server may provide the following example master key share request message, substantially in the form of a HTTP(S) POST message including XML-formatted data, as provided below:

```
POST /master_key_share_request_message.php HTTP/1.1
Host: localhost
Content-Type: Application/XML
Content-Length: 667
<?XML version = “1.0” encoding = “UTF-8”?>
<master_key_share_request_message>
  <request_identifier>ID_request_3</request_identifier>
  <transaction_identifier>ID_transaction_1</transaction_identifier>
  <wallet_identifier>ID_Wallet1</wallet_identifier>
  <RSA_public_key>RSA public key provided by the
  HSM</RSA_public_key>
</master_key_share_request_message>
```

The portable HSM may provide the encrypted master key share to the TSS server via a master key share response message 11841. In one implementation, the master key share response message may include data such as a response identifier, a transaction identifier, a wallet identifier, an encrypted master key share, and/or the like. In one embodiment, the portable HSM may provide the following example master key share response message, substantially in the form of a HTTP(S) POST message including XML-formatted data, as provided below:

```
POST /master_key_share_response_message.php HTTP/1.1
Host: localhost
Content-Type: Application/XML
Content-Length: 667
<?XML version = “1.0” encoding = “UTF-8”?>
<master_key_share_response_message>
  <response_identifier>ID_response_3</response_identifier>
  <transaction_identifier>ID_transaction_1</transaction_identifier>
  <wallet_identifier>ID_Wallet1</wallet_identifier>
  <master_key_share>encrypted master key share provided by
  the portable
HSM</master_key_share>
</master_key_share_response_message>
```

The TSS server may send a TS request message 11845 to the HSM to request that the HSM sign the transaction. In one implementation, the TS request message may be sent via a HSM Access Provider and may include data such as a request identifier, a request type (e.g., sign message hash, get address hash), a wallet identifier, a transaction identifier, a transaction hash, a keychain path, an encrypted master key share, and/or the like. For example, the TSS server may provide the following example TS request message, substantially in the form of a HTTP(S) POST message including XML-formatted data, as provided below:

```
POST /TS_request_message.php HTTP/1.1
Host: localhost
Content-Type: Application/XML
Content-Length: 667
<?XML version = “1.0” encoding = “UTF-8”?>
<TS_request_message>
  <request_identifier>ID_request_4</request_identifier>
  <request_type>SIGN_TRANSACTION</request_type>
  <wallet_identifier>ID_Wallet1</wallet_identifier>
  <transaction_identifier>ID_transaction_1</transaction_identifier>
  <transaction_hash>256-bit hash value to be
  signed</transaction_hash>
  <keychain_path>m/0/0/1/0</keychain_path>
  <master_key_share>encrypted master key share provided by
  the portable
HSM</master_key_share>
</TS_request_message>
```

The HSM may make a SFTS API call 11849 to a SFTS module 11818 to request that the SFTS module sign the transaction. In one implementation, the SFTS API call may include data such as a request type (e.g., sign message hash, get address hash), a wallet identifier, a transaction identifier, a transaction hash, a keychain path, an encrypted master key share, and/or the like.

Data provided in the SFTS API call may be used by a secure firmware transaction signing (SFTS) component 11853 to determine a master private key from master key shares and to sign the transaction (e.g., to generate an ECDSA signature in DER format). See FIG. 119C for additional details regarding the SFTS component.

The SFTS module may send SFTS response data 11857 to the HSM in response to the SFTS API call. In one implementation, the SFTS response data may include an ECDSA signature in DER format.

The HSM may send a TS response message 11861 to the TSS server (e.g., via a HSM Access Provider). In one implementation, the TS response message may include data such as a response identifier, a transaction identifier, a transaction signature, and/or the like. For example, the HSM may provide the following example TS response message, substantially in the form of a HTTP(S) POST message including XML-formatted data, as provided below:

```
POST /TS_response_message.php HTTP/1.1
Host: localhost
Content-Type: Application/XML
Content-Length: 667
<?XML version = “1.0” encoding = “UTF-8”?>
<TS_response_message>
  <response_identifier>ID_response_4</response_identifier>
  <transaction_identifier>ID_transaction_1</transaction_identifier>
  <transaction_signature>ECDSA signature in DER
  format</transaction_signature>
</TS_response_message>
```

The TSS server may send a TS response 11865 to the client. In one implementation, the TS response may include data such as a response identifier, a transaction identifier, a transaction signature, and/or the like. For example, the TSS server may provide the following example TS response, substantially in the form of a HTTP(S) POST message including XML-formatted data, as provided below:

```
POST /TS_response.php HTTP/1.1
Host: www.server.com
Content-Type: Application/XML
Content-Length: 667
<?XML version = “1.0” encoding = “UTF-8”?>
<TS_response>
  <response_identifier>ID_response_1</response_identifier>
  <transaction_identifier>ID_transaction_1</transaction_identifier>
  <transaction_signature>ECDSA signature in DER format</transaction_signature>
</TS_response>
```

FIG. 119A shows a logic flow diagram illustrating embodiments of a secure firmware transaction signing (SFTS) component for the SOCOACT. In FIG. 119A, a SFTS API call may be obtained at 11901. For example, the SFTS API call may be obtained as a result of a call from a HSM associated with the SFTS component. It is to be understood that although the SFTS component is described with regard to an API method to sign a transaction (e.g., signMessageHash), in some embodiment, a variety of API methods may be available. In one embodiment, the following API methods may be available to the HSM and/or to a TSS:

```
signMessageHash - this method receives a message hash and a keychain path and
returns an ECDSA signature value. Key derivation steps are implemented by the
SFTS component. Temporary keys generated for signing are wiped out of the device
once the signing process is complete.
  Input:
    256-bit hash value to be signed
    keychain path to be used for Bip32 key derivation
  Output:
    ECDSA signature in DER format
getAddressHash - this method returns a public Pay-to-Script-Hash (P2SH) address
generated for a given keychain path. SFTS component code uses N extended master
public keys stored inside the HSM, generates N public keys corresponding to the
provided keychain path, and generates a Bitcoin address that can be used for
receiving funds.
  Input:
    keychain path to be used for Bip32 key derivation
  Output:
    P2SH hash value that can be converted by the requesting application
(e.g., client application) into a Bitcoin address in the appropriate format (e.g.,
main Bitcoin network, Testnet, etc.)
```

Transaction data may be determined at 11905. In one implementation, the transaction data may be provided in the SFTS API call and may include a wallet identifier, a transaction hash, a keychain path, and/or the like.

A determination may be made at 11909 whether a portable HSM is being utilized to sign the transaction. For example, a portable HSM may not be utilized for a hot wallet transaction. In another example, a portable HSM may be utilized for a cold wallet transaction. In one implementation, this determination may be made by checking a setting associated with the HSM.

If a portable HSM is not being utilized, a master private key may be retrieved at 11913. In one implementation, the master private key may be determined using a PKCS #11 function (e.g., C_FindObjectsInit( . . . )). In another implementation, the master private key may be determined via an internal call on a HSM environment setting configured externally at HSM deployment time.

If a portable HSM is being utilized, an encrypted master private key may be obtained at 11917. In one implementation, the portable HSM may be queried to obtain the encrypted private master key. For example, the private master key may be encrypted using a public key encryption key (e.g., associated with the HSM) stored by the portable HSM. A private key decryption key for the HSM may be retrieved at 11921. In one implementation, the private key decryption key may be determined using a PKCS #11 function (e.g., C_FindObjectsInit( . . . )). In another implementation, the private key decryption key may be determined via an internal call on a HSM environment setting configured externally at HSM deployment time.

Although one may choose to use the above to determine the master private key and/or the private key decryption key, in an alternative embodiment, the master private key and/or the private key decryption key may be determined via a MySQL database command (e.g., retrieved from a MySQL database in tamper-proof storage).

The encrypted master private key may be decrypted at 11925 using the retrieved private key decryption key.

A signing private key for the specified keychain path may be generated at 11929. In one implementation, the signing private key may be generated in accordance with a deterministic key derivation procedure as described in Bip32. The transaction may be signed at 11933. In one implementation, the generated signing private key may be used to sign the transaction hash in accordance with the hashing algorithm utilized by the Bitcoin protocol (e.g., RIPE160(SHA256 (SHA256 (message)

Temporary private key data may be wiped from memory at 11937. In one implementation, the master private key obtained from the portable HSM and/or the generated signing private key may be wiped from memory of the HSM associated with the SFTS component. The signed transaction may be returned at 11941. In one implementation, the Elliptic Curve Digital Signature Algorithm (ECDSA) signature in DER format may be returned.

FIG. 119B shows a logic flow diagram illustrating embodiments of a transaction server transaction signing (TSTS) component for the SOCOACT. In FIG. 119B, a transaction signing request may be obtained at 11902. For example, the transaction signing request may be obtained as a result of a user utilizing a UI of a fund transfer CLI program to initiate transaction signing (e.g., a fund transfer) using a master key associated with a hierarchical deterministic wallet.

A RSA public key may be requested from a HSM at 11906. In one implementation, a public key request message may be sent to the HSM to request the RSA public key.

A determination may be made at 11908 whether the obtained RSA public key is valid. For example, the fund transfer program may be configured to work with a specified set of HSMs, and the obtained RSA public key may have to be associated with one of the specified HSMs to be valid.

If the obtained RSA public key is not valid, an error message may be generated at 11918. For example, the error message may specify the error that occurred (e.g., RSA public key is not valid). A warning message may be provided to the user and/or an action may be triggered at 11920. In one implementation, a warning message based on the generated error message may be provided to the user to inform the user regarding the error. In another implementation, an action may be triggered based on a specified condition (e.g., invalid RSA public key obtained three times). For example, the triggered action may be to erase data associated with the wallet. In another example, the triggered action may be to invalidate the master key and to generate a new master key.

If the obtained RSA public key is valid, the RSA public key may be provided to a portable HSM at 11910. For example, the RSA public key may be utilized by the portable HSM to encrypt a second master private key share stored by the portable HSM such that the corresponding RSA private key, available to the HSM, may be used to decrypt the second master private key share. In one implementation, the RSA public key may be forwarded to the portable HSM via a master key share request message.

An encrypted second master private key share (e.g., for the specified wallet) may be requested from the portable HSM at 11912. In one implementation, a master key share request message may be sent to the portable HSM to request the second master private key share encrypted with the RSA public key.

A determination may be made at 11914 whether the request for the encrypted second master private key share is authorized. In one implementation, one or more operators (e.g., based on M-of-N authentication) may have to approve (e.g., via an authentication entry device associated with the portable HSM) the request to export the encrypted second master private key share from the portable HSM for the request to be authorized.

If the request for the encrypted second master private key share is not authorized, an error message may be generated at 11918. For example, the error message may specify the error that occurred (e.g., request to export the encrypted second master private key share from the portable HSM is not authorized). A warning message may be provided to the user and/or an action may be triggered at 11920. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with the wallet. In another example, the triggered action may be to invalidate the master key and to generate a new master key.

If the request for the encrypted second master private key share is authorized, transaction signing may be requested from the HSM at 11922. In one implementation, a transaction signing request message may be sent to the HSM to request transaction signing.

A transaction signing response may be provided to the client at 11926. In one implementation, a transaction signing response may be sent to the client to inform the user whether the transaction signing was completed successfully (e.g., via a UI of the fund transfer program).

FIG. 119C shows a logic flow diagram illustrating embodiments of a secure firmware transaction signing (SFTS) component for the SOCOACT. In FIG. 119C, a public key request from a TSS may be obtained at 11903. For example, the public key request may be obtained as a result of the TSS facilitating transaction signing.

A RSA key pair may be generated at 11907. In one embodiment, a RSA key pair (e.g., a RSA public key and a corresponding RSA private key) may be predefined (e.g., for a HSM). In one implementation, the RSA public key may be determined using a PKCS #11 function (e.g., C_FindObjectsInit( . . . )). In another implementation, the RSA public key may be determined via an internal call on a HSM environment setting configured externally at HSM deployment time. In an alternative implementation, the RSA public key may be determined via a MySQL database command (e.g., retrieved from a MySQL database in tamper-proof storage). In another embodiment, a RSA key pair may be generated dynamically (e.g., each time transaction signing is executed). In one implementation, a RSA public key may be generated using a PKCS #11 function (e.g., C_CreateObject( . . . )).

The RSA public key may be provided to the TSS at 11911. In one implementation, the RSA public key may be provided to the TSS via a public key response message.

A SFTS API call may be obtained at 11915. For example, the SFTS API call may be obtained as a result of a call from a HSM associated with the SFTS component. It is to be understood that although the SFTS component is described with regard to an API method to sign a transaction (e.g., signMessageHash), in some embodiment, a variety of API methods may be available. In one embodiment, the following API methods may be available to the HSM and/or to a TSS:

```
signMessageHash - this method receives a message hash, a keychain path and a
handle to the transient object containing a second master private key share (e.g.,
encrypted), and returns an ECDSA signature value. Seed concatenation and key
derivation steps are implemented by the SFTS component. Temporary keys generated
for signing are wiped out of the device once the signing process is complete.
  Input:
    256-bit hash value to be signed
    keychain path to be used for Bip32 key derivation
    handle to the transient object containing a second master private key
share (e.g., encrypted)
  Output:
    ECDSA signature in DER format
getAddressHash - this method returns a public Pay-to-Script-Hash (P2SH) address
generated for a given keychain path. SFTS component code uses N extended master
public keys stored inside the HSM, generates N public keys corresponding to the
provided keychain path, and generates a Bitcoin address that can be used for
receiving funds.
  Input:
    keychain path to be used for Bip32 key derivation
  Output:
    P2SH hash value that can be converted by the requesting application
(e.g., client application) into a Bitcoin address in the appropriate format (e.g.,
main Bitcoin network, Testnet, etc.)
```

An encrypted second master private key share utilized to recover a master private key may be determined at 11919. In one implementation, the encrypted second master private key share may be provided as an input parameter in the SFTS API call.

A determination may be made at 11923 whether the encrypted second master private key share is decryptable. In one implementation, this determination may be made by checking whether decrypting the encrypted second master private key share using the RSA private key results in a valid object.

If the encrypted second master private key share is not decryptable, an error message may be generated at 11927. For example, the error message may specify the error that occurred (e.g., second master private key share is not decryptable). A warning message may be provided to a user and/or an action may be triggered at 11931. In one implementation, a warning message based on the generated error message may be provided to the user (e.g., via the TSS) to inform the user regarding the error. In another implementation, an action may be triggered based on a specified condition (e.g., non-decryptable second master private key share obtained three times). For example, the triggered action may be to erase data associated with an associated wallet. In another example, the triggered action may be to invalidate the master key associated with the second master private key share and to generate a new master key.

If the encrypted second master private key share is decryptable, the encrypted second master private key share may be decrypted using the RSA private key at 11935. In one implementation, the RSA private key may be determined using a PKCS #11 function (e.g., C_FindObjectsInit( . . . )). In another implementation, the RSA private key may be determined via an internal call on a HSM environment setting configured externally at HSM deployment time. In an alternative implementation, the RSA private key may be determined via a MySQL database command (e.g., retrieved from a MySQL database in tamper-proof storage). In one implementation, the encrypted master key may be decrypted using a PKCS #11 function (e.g., C_Decrypt( . . . )).

A first master private key share may be retrieved at 11939. In one implementation, the first master private key share may be determined using a PKCS #11 function (e.g., C_FindObjectsInit( . . . )). In another implementation, the first master private key share may be determined via an internal call on a HSM environment setting configured externally at HSM deployment time. In an alternative implementation, the first master private key share may be determined via a MySQL database command (e.g., retrieved from a MySQL database in tamper-proof storage).

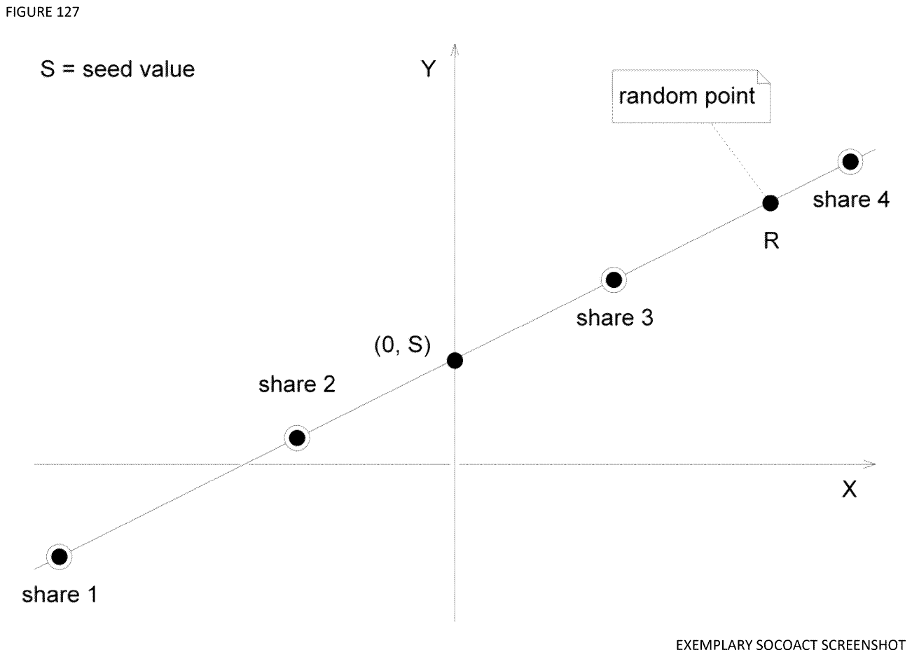

A master private key may be determined from master private key shares (e.g., from the first master private key share and the second master private key share) at 11943. In one embodiment, a method such as Shamir's Secret Sharing may be utilized to recover the master private key from the master private key shares. See FIG. 127 for additional details regarding utilizing Shamir's Secret Sharing.

Transaction data may be determined at 11947. In one implementation, the transaction data may be provided in the SFTS API call and may include a wallet identifier, a transaction identifier, a transaction hash, a keychain path, and/or the like.

A signing private key for the specified keychain path may be generated using the determined master private key at 11951. In one implementation, the signing private key may be generated in accordance with a deterministic key derivation procedure as described in Bip32. The transaction may be signed at 11955. In one implementation, the generated signing private key may be used to sign the transaction hash in accordance with the hashing algorithm utilized by the Bitcoin protocol (e.g., RIPE160(SHA256 (SHA256 (message)))).

Temporary private key data may be wiped from memory at 11959. In one implementation, the second master private key share obtained from the portable HSM, the determined master private key, and/or the generated signing private key may be wiped from memory of the HSM associated with the SFTS component. The signed transaction may be returned at 11963. In one implementation, the ECDSA signature in DER format may be returned.

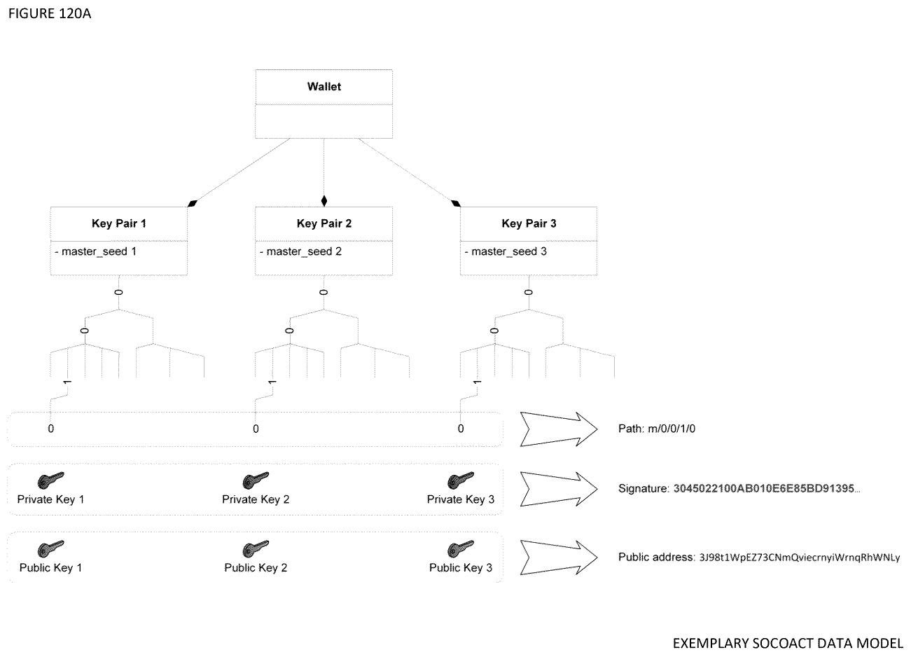

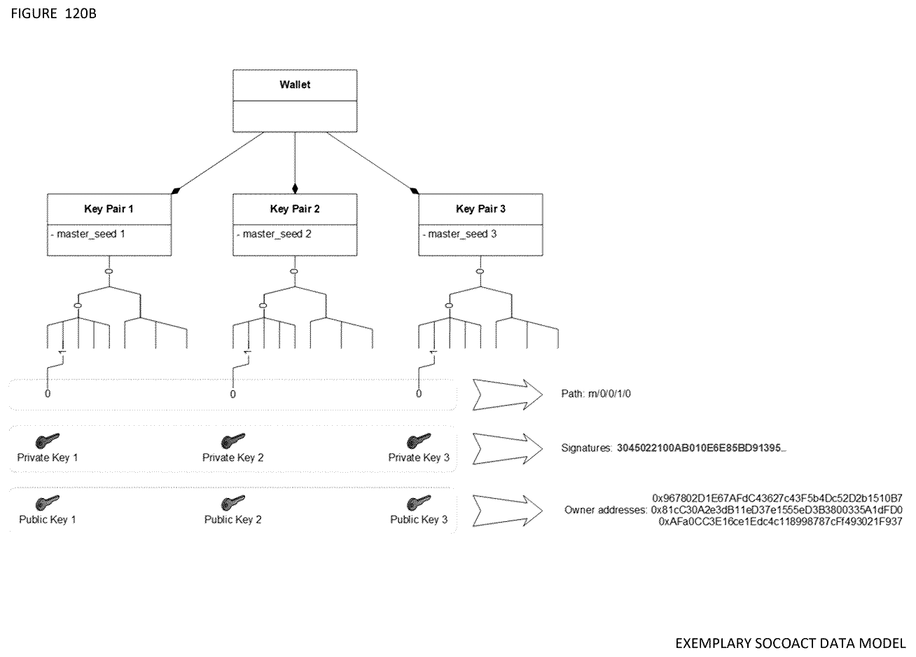

FIG. 120A shows an exemplary data model for the SOCOACT. In one embodiment, the data model may be a Bip32 data model. In FIG. 120A, a wallet composed of N (e.g., 3) master keys (or seeds) is shown. For each path, a pair of private and public keys may be derived. A private key may be used for generating a signature; a public key may be used for a public address for receiving funds.

FIG. 120B shows an exemplary data model for the SOCOACT. In one embodiment, the data model may be a Bip32 data model. In FIG. 120B, a wallet composed of N (e.g., 3) master keys (or seeds) is shown. For each path, a pair of children private and public keys may be derived. A private key may be used for generating a signature; a public key may be used for a generating an owner address. In one implementation, master key pairs are stored on FIPS 140-2 L3 HSM devices, and their derived children keys, address generation and signing occur inside the HSMs.

FIG. 121 shows an exemplary authentication model for the SOCOACT. In FIG. 121, M-of-N authentication utilizing an HSM is illustrated. For example, in order to start a highly sensitive business application operation (e.g., transaction signing for a transfer of large funds between accounts, key backup, key recovery), several physically present persons may have to authenticate to the HSM. Physical presence is ensured by presenting a physical authentication device, such as a smart card, token or encrypted key on a USB device. In addition to the physical device, each person also may have to authenticate using a password or PIN, which makes it a multi-factor authentication (MFA) process with the first factor being a key (something to have) and the second factor a PIN (something to know). This is schematically shown in FIG. 121 where two operators, each holding an encrypted key on a USB memory stick, one after another insert their USB key into an authentication entry device attached to a HSM and confirm their ownership of the key by entering a PIN associated with the key in order to start a business application operation. Authentication to the HSM may be tightly integrated in HSM firmware for access control and protection of key objects stored on the HSM through a key hierarchy of user keys on the USB token and master encryption keys on the HSM.

Security policy, defined for a business application and enforced on the HSM, contains a minimum number of persons that should successfully authenticate to the system out of a larger number of people that hold authentication keys and PINs. If we have N operators with separate USB keys and PINs but any M of them can authenticate to the system, this so called M-of-N(or MoN) authentication policy covers such real life situations as two-person access control, work force rotation, leaves of absence, sickness, etc. See FIG. 122 for an example of valid authentication combinations for N=3 and M=2.

FIG. 122 shows an exemplary authentication use case for the SOCOACT. In FIG. 122, valid authentication combinations for N=3 and M=2 are illustrated. As shown in FIG. 122, valid authentication combinations include: operator 1 and operator 2, operator 2 and operator 3, and operator 1 and operator 3.

FIG. 123 shows an exemplary key backup model for the SOCOACT. In FIG. 123, a seed (e.g., master key) may be backed up using seed shares. The seed may be generated and may be stored on a seed hosting HSM 12301 (e.g., Gemalto's G5 HSM), which supports M-of-N authentication. For example, this may be done as part of a master key generation operation. A backup utility 12305 may request that a backup HSM 12310 (e.g., Gemalto's ProtectServer PCI-e HSM), which supports firmware module extensions and hosts SFTS module 12315, generate a RSA key pair and provide the generated public key. The backup utility may export the generated RSA public key from the backup HSM and import it into the hosting HSM. The backup utility may request an export of the seed from the hosting HSM encrypted with the imported RSA public key. Operators may approve the seed export request by authenticating to an authentication entry device associated with the hosting HSM (e.g., using 2-of-3 access control enforcement). The backup utility may transfer the encrypted seed to the backup HSM. The backup HSM may decrypt the seed using the previously generated RSA private key and may create a local copy of the seed in memory protected from external intrusion. The backup utility may utilize an API call to request seed shares, generated using an implemented secret sharing method, from the backup HSM. See FIG. 127 for an example of a secret sharing method. The backup utility may print the provided seed shares (e.g., one at a time on a separate sealed tamper-protected form), and the printed seed shares may be distributed for storage in geographically distributed locations in order to avoid the recovery of a complete seed from shares available at any single location. Thus, the full seed is not exposed in decrypted form outside of an HSM device (e.g., in RAM of the host workstation) during the key backup process, which eliminates the risk of memory-attack theft. As seed shares may be backed up separately (e.g., on paper in bank safety boxes), multi-person access control and segmentation is further enforced.

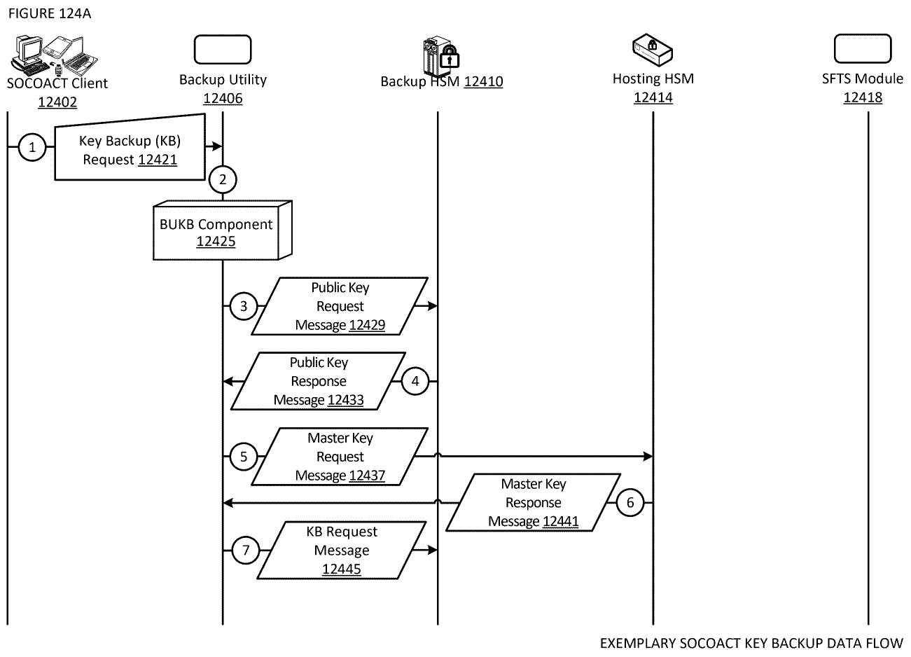

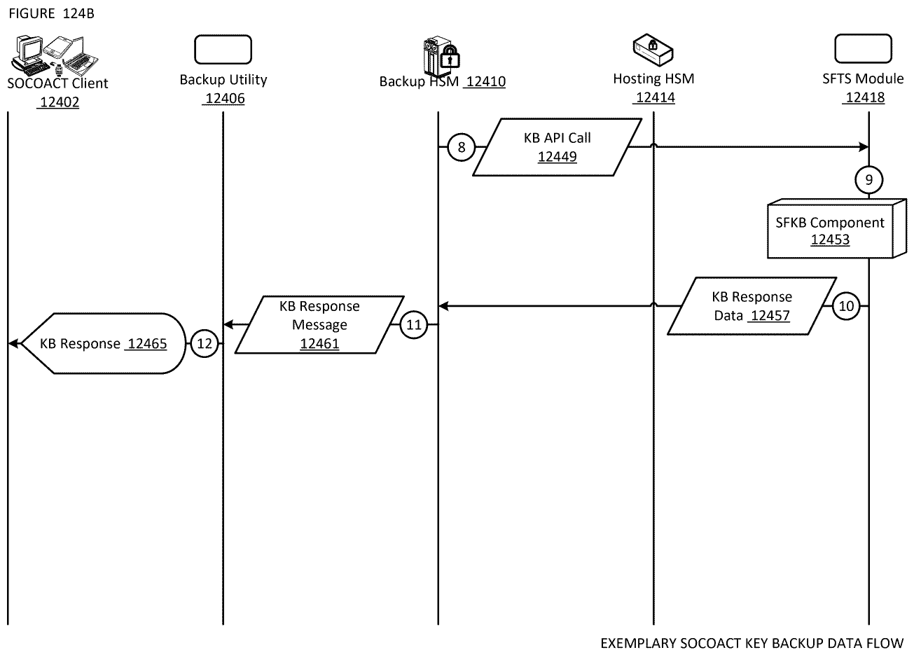

FIGS. 124A-B show a datagraph diagram illustrating embodiments of a data flow for the SOCOACT. In FIGS. 124A-B, a user of a SOCOACT client 12402 may send a key backup request 12421 to a backup utility 12406 to facilitate key backup (e.g., of a master key associated with a hierarchical deterministic wallet). For example, the SOCOACT client may be a desktop, a laptop, a tablet, a smartphone, and/or the like that is executing the backup utility. In one implementation, the key backup request may include parameters specified by the user (e.g., via a user interface (UI) of the backup utility) such as a request type (e.g., backup master key, recover master key), a wallet identifier (e.g., of the wallet whose master key should be backed up), the number of master key shares to generate, the number of master key shares sufficient to recover the master key, and/or the like.

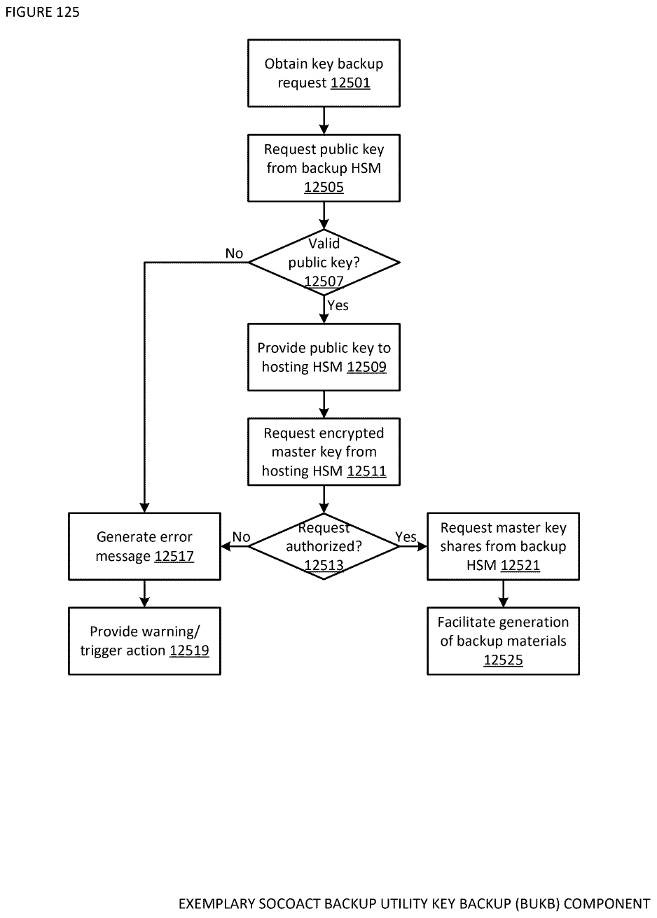

A backup utility key backup (BUKB) component 12425 may utilize parameters provided in the key backup request to facilitate generation of backup materials for the relevant master key (e.g., for the specified wallet). See FIG. 125 for additional details regarding the BUKB component.

The backup utility may send a public key request message 12429 to a backup HSM 12410 to request a RSA public key from the backup HSM. In one implementation, the public key request message may include data such as a request identifier, a backup request identifier, and/or the like. In one embodiment, the backup utility may provide the following example public key request message, substantially in the form of a HTTP(S) POST message including XML-formatted data, as provided below:

```
POST /public_key_request_message.php HTTP/1.1
Host: www.server.com
Content-Type: Application/XML
Content-Length: 667
<?XML version = “1.0” encoding = “UTF-8”?>
<public_key_request_message>
  <request_identifier>ID_request_11</request_identifier>
  <backup_request_identifier>ID_backup_request_1</backup_request_identifier>
</public_key_request_message>
```

The backup HSM may provide a RSA public key to the backup utility via a public key response message 12433. In one implementation, the public key response message may include data such as a response identifier, a backup request identifier, a RSA public key, and/or the like. In one embodiment, the backup HSM may provide the following example public key response message, substantially in the form of a HTTP(S) POST message including XML-formatted data, as provided below:

```
POST /public_key_response_message.php HTTP/1.1
Host: www.server.com
Content-Type: Application/XML
Content-Length: 667
<?XML version = “1.0” encoding = “UTF-8”?>
<public_key_response_message>
  <response_identifier>ID_response_11</response_identifier>
  <backup_request_identifier>ID_backup_request_1</backup_request_identifier>
  <RSA_public_key>RSA public key provided by the backup HSM</RSA_public_key>
</public_key_response_message>
```

The backup utility may send a master key request message 12437 to a hosting HSM 12414 to request an encrypted master key (e.g., for the specified wallet) from the hosting HSM. In one implementation, the master key request message may include data such as a request identifier, a backup request identifier, a wallet identifier, a RSA public key, and/or the like. In one embodiment, the backup utility may provide the following example master key request message, substantially in the form of a HTTP(S) POST message including XML-formatted data, as provided below:

```
POST /master_key_request_message.php HTTP/1.1
Host: localhost
Content-Type: Application/XML
Content-Length: 667
<?XML version = “1.0” encoding = “UTF-8”?>
<master_key_request_message>
  <request_identifier>ID_request_12</request_identifier>
  <backup_request_identifier>ID_backup_request_1</backup_request_identifier>
  <wallet_identifier>ID_Wallet1</wallet_identifier>
  <RSA_public_key>RSA public key provided by the backup HSM</RSA_public_key>
</master_key_request_message>
```

The hosting HSM may provide the encrypted master key to the backup utility via a master key response message 12441. In one implementation, the master key response message may include data such as a response identifier, a backup request identifier, a wallet identifier, an encrypted master key, and/or the like. In one embodiment, the hosting HSM may provide the following example master key response message, substantially in the form of a HTTP(S) POST message including XML-formatted data, as provided below:

```
POST /master_key_response_message.php HTTP/1.1
Host: localhost
Content-Type: Application/XML
Content-Length: 667
<?XML version = “1.0” encoding = “UTF-8”?>
<master_key_response_message>
  <response_identifier>ID_response_12</response_identifier>
  <backup_request_identifier>ID_backup_request_1</backup_request_identifier>
  <wallet_identifier>ID_Wallet1</wallet_identifier>
  <master_key>encrypted master key provided by the hosting HSM</master_key>
</master_key_response_message>
```

The backup utility may send a key backup request message 12445 to the backup HSM to request master key shares for the encrypted master key from the backup HSM. In one implementation, the key backup request message may include data such as a request identifier, a request type, a backup request identifier, an encrypted master key, the number of master key shares to generate, the number of master key shares sufficient to recover the master key, and/or the like. In one embodiment, the backup utility may provide the following example key backup request message, substantially in the form of a HTTP(S) POST message including XML-formatted data, as provided below:

```
POST /key_backup_request_message.php HTTP/1.1
Host: localhost
Content-Type: Application/XML
Content-Length: 667
<?XML version = “1.0” encoding = “UTF-8”?>
<key_backup_request_message>
  <request_identifier>ID_request_13</request_identifier>
  <request_type>BACKUP_MASTER_KEY</request_type>
  <backup_request_identifier>ID_backup_request_1</backup_request_identifier>
  <master_key>encrypted master key provided by the hosting HSM</master_key>
  <number_of_shares_to_generate>4</number_of_shares_to_generate>
  <number_of_shares_sufficient_to_recover>2</number_of_shares_sufficient_to_re
cover>
</key_backup_request_message>
```

The backup HSM may make a key backup API call 12449 to a SFTS module 12418 to request that the SFTS module generate master key shares. In one implementation, the key backup API call may include data such as a request type (e.g., backup master key, recover master key), an encrypted master key, the number of master key shares to generate, the number of master key shares sufficient to recover the master key, and/or the like.

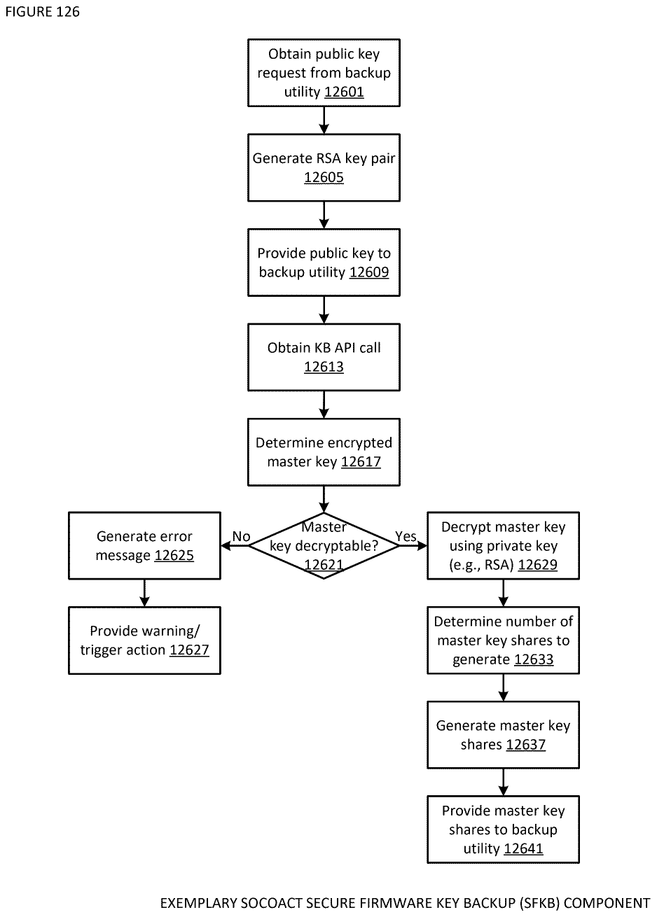

Data provided in the key backup API call may be used by a secure firmware key backup (SFKB) component 12453 to generate master key shares. See FIG. 126 for additional details regarding the SFKB component.

The SFTS module may send key backup response data 12457 to the backup HSM in response to the key backup API call. In one implementation, the key backup response data may include the generated master key shares.

The backup HSM may send a key backup response message 12461 to the backup utility. In one implementation, the key backup response message may include data such as a response identifier, a backup request identifier, generated master key shares, and/or the like. For example, data provided in the key backup response message may be utilized by the backup utility to facilitate printing and/or distributing the generated master key shares. In one embodiment, the backup HSM may provide the following example key backup response message, substantially in the form of a HTTP(S) POST message including XML-formatted data, as provided below:

```
POST /key_backup_response_message.php HTTP/1.1
Host: localhost
Content-Type: Application/XML
Content-Length: 667
<?XML version = “1.0” encoding = “UTF-8”?>
<key_backup_response_message>
  <response_identifier>ID_response_13</response_identifier>
  <backup_request_identifier>ID_backup_request_1</backup_request_identifier>
  <master_key_shares>
  <share>0_1D7927D78EAD692BB1694497180C66B3E88676F22B920625EDECAA1728F2921E
5E309297B76FE658B61DF9D501B49FB553255DFDC8FE966F2950DDD0078C809B02</share>
  <share>1_01658051EB654BBD692013E6E5FB6BA2D9C36980AE0D592D4D07516910646EE0
5B223C3C13C1DF6736232724DF32644791E4A1217DD642C8A7C0A240311DBD1172FE</share>
  <share>2_0191E6488B7976C0C147B244239459E2FF3DA2C64B554B9F215D1D6E8261B9F8
D9A1E78AC218260A8EEFCBD56A1BAE4E68A7F53DB2103AA70FBC070E8B0BFF414147</share>
  <share>3_01B2D2F13EBB73D1B486D84BA81B173D99AB2F56322452CDF97459965513F74F
5F7DD92EE1084F8847CBDA9FE118A133FEC788513A70C8B1343502C3C309052568E5</share>
  </master_key_shares>
</key_backup_response_message>
```

The backup utility may send a key backup response 12465 to the user. For example, the key backup response may be used to inform the user whether the key backup was completed successfully (e.g., via a UI of the backup utility).

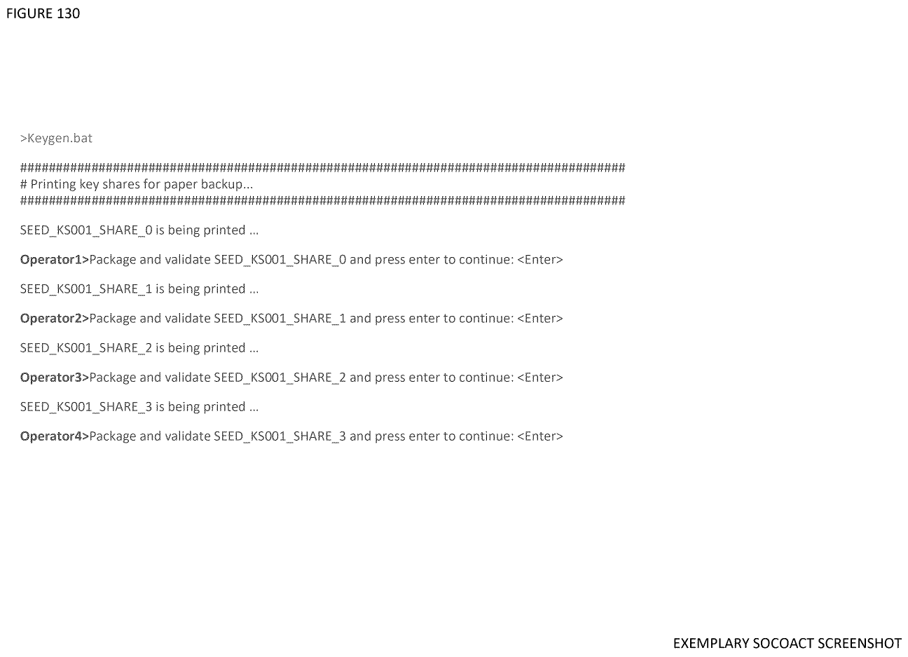

FIG. 125 shows a logic flow diagram illustrating embodiments of a backup utility key backup (BUKB) component for the SOCOACT. In FIG. 125, a key backup request may be obtained at 12501. For example, the key backup request may be obtained as a result of a user utilizing a UI of a backup utility to initiate key backup of a master key associated with a hierarchical deterministic wallet. See FIG. 130 for an example of a UI that may be utilized by the user.

A RSA public key may be requested from a backup HSM at 12505. In one implementation, a public key request message may be sent to the backup HSM to request the RSA public key.

A determination may be made at 12507 whether the obtained RSA public key is valid. For example, the backup utility may be configured to work with a specified set of backup HSMs, and the obtained RSA public key may have to be associated with one of the specified backup HSMs to be valid.

If the obtained RSA public key is not valid, an error message may be generated at 12517. For example, the error message may specify the error that occurred (e.g., RSA public key is not valid). A warning message may be provided to the user and/or an action may be triggered at 12519. In one implementation, a warning message based on the generated error message may be provided to the user to inform the user regarding the error. In another implementation, an action may be triggered based on a specified condition (e.g., invalid RSA public key obtained three times). For example, the triggered action may be to erase data associated with the wallet. In another example, the triggered action may be to invalidate the master key and to generate a new master key.

If the obtained RSA public key is valid, the RSA public key may be provided to a hosting HSM at 12509. For example, the RSA public key may be utilized by the hosting HSM to encrypt the master key hosted by the hosting HSM such that the corresponding RSA private key, available to the backup HSM, may be used to decrypt the master key. In one implementation, the RSA public key may be forwarded to the hosting HSM via a master key request message.

An encrypted master key (e.g., for the specified wallet) may be requested from the hosting HSM at 12511. In one implementation, a master key request message may be sent to the hosting HSM to request the master key encrypted with the RSA public key.

A determination may be made at 12513 whether the request for the encrypted master key is authorized. In one implementation, one or more operators (e.g., based on M-of-N authentication) may have to approve (e.g., via an authentication entry device associated with the hosting HSM) the request to export the encrypted master key from the hosting HSM for the request to be authorized.

If the request for the encrypted master key is not authorized, an error message may be generated at 12517. For example, the error message may specify the error that occurred (e.g., request to export the encrypted master key from the hosting HSM is not authorized). A warning message may be provided to the user and/or an action may be triggered at 12519. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with the wallet. In another example, the triggered action may be to invalidate the master key and to generate a new master key.

If the request for the encrypted master key is authorized, master key shares for the master key may be requested from the backup HSM at 12521. In one implementation, a key backup request message may be sent to the backup HSM to request generation of master key shares. For example, the key backup request message may specify how many master key shares to generate and/or how many master key shares should be sufficient to recover the master key.

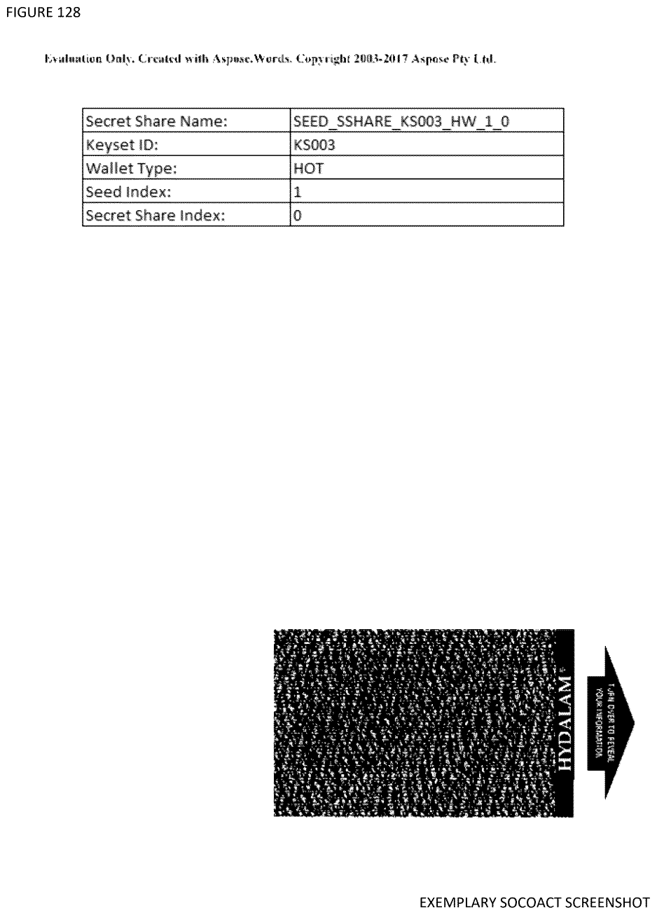

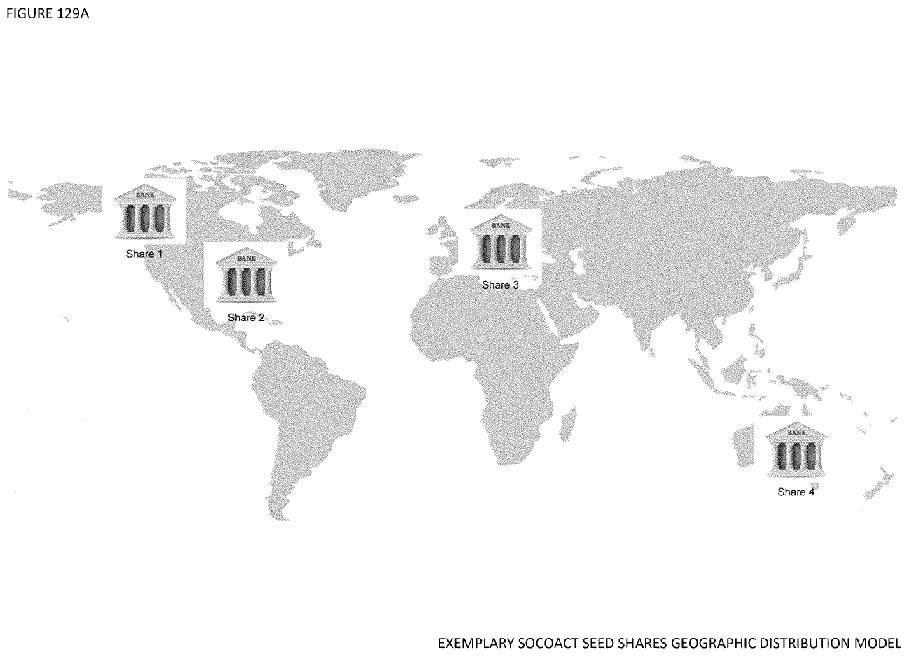

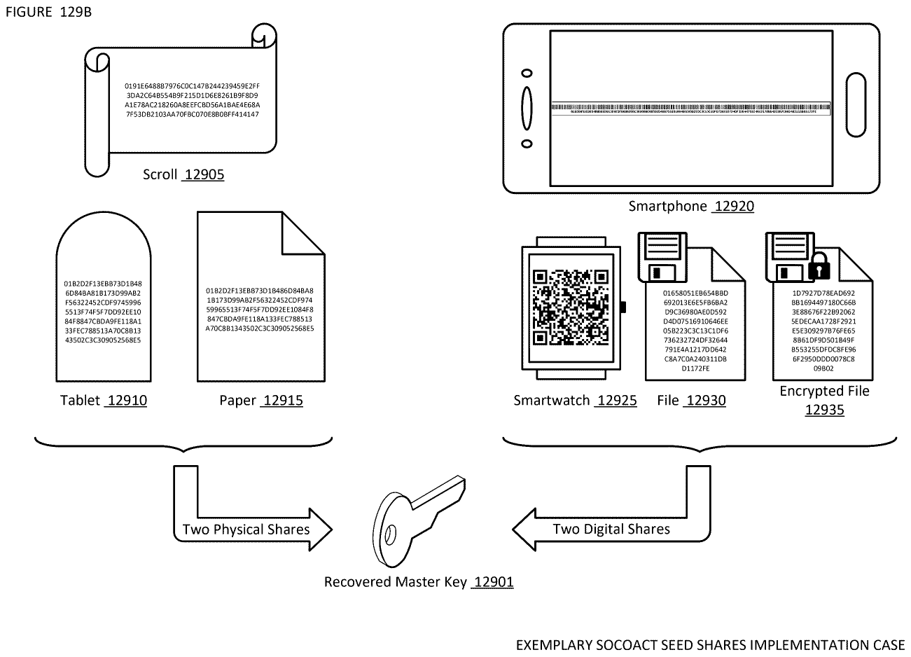

Generation of backup materials may be facilitated at 12525. In various implementations, the provided master key shares may be backed up using backup materials such as paper printouts, metal or plastic plates (e.g., Cryptosteel), USB keys, hard drives, solid state drives, portable HSMs, and/or the like. For example, the provided master key shares may be printed out (e.g., one at a time on a separate sealed tamper-evident form). See FIG. 128 for an example of a tamper-evident paper form. The backup materials may be distributed for storage in geographically distributed locations. In some implementations, a hybrid combination of several backup materials may be used (e.g., 4 paper copies, 4 USB keys and 4 portable HSM devices). For example, each geographic backup location may store a mixture of different types of backup materials or materials of just one type. See FIG. 129A for an example of how the provided master key shares may be distributed and stored geographically. In some implementations, the SOCOACT may be configured to require specified types of backup materials to recover the master key. For example, two master key shares stored on physical backup materials and two master key shares stored on digital backup materials may be required to recover the master key. See FIG. 129B for an example of backup materials that may be utilized to recover the master key.

FIG. 126 shows a logic flow diagram illustrating embodiments of a secure firmware key backup (SFKB) component for the SOCOACT. In FIG. 126, a public key request from a backup utility may be obtained at 12601. For example, the public key request may be obtained as a result of the backup utility executing a key backup.

A RSA key pair may be generated at 12605. In one embodiment, a RSA key pair (e.g., a RSA public key and a corresponding RSA private key) may be predefined (e.g., for a backup HSM). In one implementation, the RSA public key may be determined using a PKCS #11 function (e.g., C_FindObjectsInit( . . . )). In another implementation, the RSA public key may be determined via an internal call on a backup HSM environment setting configured externally at HSM deployment time. In an alternative implementation, the RSA public key may be determined via a MySQL database command (e.g., retrieved from a MySQL database in tamper-proof storage). In another embodiment, a RSA key pair may be generated dynamically (e.g., each time a key backup is executed). In one implementation, a RSA public key may be generated using a PKCS #11 function (e.g., C_CreateObject ( . . . )).

The RSA public key may be provided to the backup utility at 12609. In one implementation, the RSA public key may be provided to the backup utility via a public key response message.

A key backup API call may be obtained at 12613. For example, the key backup API call may be obtained as a result of a call from the backup HSM (e.g., based on receiving a key backup request message from the backup utility) associated with the SFKB component. In one embodiment, the following API method may be available to the backup HSM and/or to the backup utility:

```
SplitSeed - this method receives a master key value, 512-bit number, and returns
an array of master key secret shares. Generation of master key shares is
implemented by the SFKB component. Temporary materials, including the decrypted
master key value, are wiped out of the device once the master key shares generation
process is complete.
  Input:
    512-bit master key value encrypted with an RSA public key generated by
the backup HSM
  Output:
    full array of 256-bit master key shares (N master key shares)
```

In one implementation, a C implementation of this method for M-of-N key split may have the following interface:

```
SplitSeed(CK_ULONG slot_id,
  const char *pin,
  CK_OBJECT_HANDLE hSeed,
  CK_ULONG rec_shares_num,
  CK_ULONG backup_shares_num,
  CK_BYTE_PTR pRng_seed,
  CK_ULONG rng_seed_len,
  CK_BYTE_PTR *ppShares,
  CK_ULONG_PTR pShares_len);
```

The following table describes input and output parameters:

| | Input/ | | | Sample |
|---|---|---|---|---|
| Name | Output | Type | Description | Values |
| slot_id | In | CK_ULONG | Identifier of the target slot inside HSM | 0 |
| pin | In | const char * | User token PIN for HSM | 0123 |
| hSeed | In | CK_OBJECT_HANDLE | Handle value of the master key | 1000 |
| rec_shares_num | In | CK_ULONG | Number of recovery shares (M) sufficient | 4 |
| | | | to recover the original seed. | |
| backup_shares_ | In | CK_ULONG | Number of backup shares (N) to be | 12 |
| num | | | generated. | |
| pRng_seed | In | CK_BYTE_PTR | Pointer to a byte array containing an | |
| | | | initialization seed for the random | |
| | | | number generator | |
| rng_seed_len | In | CK_ULONG | Length of the array containing an | 64 |
| | | | initialization seed for the random | |
| | | | number generator | |
| ppShares | Out | CK_BYTE_PTR * | Pointer to the pointer to a byte array | |
| | | | containing the generated secret shares | |
| pShares_len | Out | CK_ULONG_PTR | Pointer to a long number containing the | 64 |
| | | | length of the byte array containing the | |
| | | | generated secret shares | |

An encrypted master key for which master key shares should be generated may be determined at 12617. In one implementation, the encrypted master key may be provided as an input parameter in the key backup API call.

A determination may be made at 12621 whether the encrypted master key is decryptable. In one implementation, this determination may be made by checking whether decrypting the encrypted master key using the RSA private key results in a valid object.

If the encrypted master key is not decryptable, an error message may be generated at 12625. For example, the error message may specify the error that occurred (e.g., master key is not decryptable). A warning message may be provided to a user and/or an action may be triggered at 12627. In one implementation, a warning message based on the generated error message may be provided to the user (e.g., via the backup utility) to inform the user regarding the error. In another implementation, an action may be triggered based on a specified condition (e.g., non-decryptable master key obtained three times). For example, the triggered action may be to erase data associated with a wallet. In another example, the triggered action may be to invalidate the master key and to generate a new master key.

If the encrypted master key is decryptable, the encrypted master key may be decrypted using the RSA private key at 12629. In one implementation, the encrypted master key may be decrypted using a PKCS #11 function (e.g., C_Decrypt( . . . )).

The number of master key shares to generate and/or the number of master key shares that should be sufficient to recover the master key may be determined at 12633. In one implementation, this data may be provided as input parameters in the key backup API call.

Master key shares for the master key may be generated at 12637. In one embodiment, a method such as Shamir's Secret Sharing may be utilized to generate master key shares based on the specified number of master key shares to generate and/or the specified number of master key shares that should be sufficient to recover the master key. See FIG. 127 for additional details regarding utilizing Shamir's Secret Sharing. In one implementation, the generated master key shares may take on the following form (e.g., in hexadecimal format):
0_1D7927D78EAD692BB1694497180C66B3E88676F22B920625EDECAA1728F2921E5E309297B76FE6 58B61DF9D501B49FB553255DFDC8FE966F2950DDD0078C809B02
1_01658051EB654BBD692013E6E5FB6BA2D9C36980AE0D592D4D07516910646EE05B223C3C13C1DF 6736232724DF32644791E4A1217DD642C8A7C0A240311DBD1172FE
2_0191E6488B7976C0C147B244239459E2FF3DA2C64B554B9F215D1D6E8261B9F8D9A1E78AC21826 0A8EEFCBD56A1BAE4E68A7F53DB2103AA70FBC070E8B0BFF414147
3_01B2D2F13EBB73D1B486D84BA81B173D99AB2F56322452CDF97459965513F74F5F7DD92EE 1084F 8847CBDA9FE118A133FEC788513A70C8B1343502C3C309052568E5
Where 0, . . . , 3 designate a master key share's index and the rest is its value.

The generated master key shares may be provided to the backup utility at 12641. In one implementation, the master key shares may be returned to the backup HSM as the output of the key backup API call, and/or the backup HSM may provide the master key shares to the backup utility via a key backup response message.

FIG. 127 shows a screenshot diagram illustrating embodiments of the SOCOACT. In FIG. 127, Shamir's Secret Sharing method that may be utilized for secret sharing and/or secret recovery is illustrated. Shamir's Secret Sharing is based on the generic algebraic fact that knowing N different points is sufficient to recover a polynomial of the order of N−1. For example, two points on a coordinate plane define a line on that plane. As shown in FIG. 127, this may be used to generate several secret shares any pair of which can be used to restore the original secret.

For a seed value S, a point with coordinates (0, S) may be chosen (i.e., a point on the Y axis). A second point R with coordinates (X, Y) may be randomly generated (e.g., using two random numbers X and Y). Together this random point (X, Y) and point (0, S) define a line on the coordinate plane. Any number (e.g., the specified number of master key shares to generate) of points (e.g., any four points) on this line may be selected to become the secret shares—each point by itself does not reveal any information about the original number S. However, any pair of such points fully recovers the original line whose Y-intercept gives the seed value S.

In one implementation, in order to reduce the size of the backup key materials used in calculations, a pre-determined set of X-coordinate values (e.g., 10², 10⁴, 10⁶, 10⁸) may be used for the shares and the Y-coordinates may be referred to by their indices in the range (e.g., [0 . . . 3]).

In implementations where more than two points (e.g., three points) are specified as being sufficient to recover the seed value S, Lagrange interpolation of polynomials may be utilized to generate secret shares and/or to recover the seed value.

FIG. 128 shows a screenshot diagram illustrating embodiments of the SOCOACT. In FIG. 128, a sample printed copy of concealed secret share's data on a tamper-evident paper form is illustrated.

FIG. 129A shows an exemplary seed shares geographic distribution model for the SOCOACT. In FIG. 129A, a schematic diagram of how generated seed shares may be distributed and stored geographically is shown. Each secret share backup material output (e.g., for the four generated secret shares) is distributed to a different geographic location and stored there in a secure location (e.g., a bank's vault).

For a seed recovery using 2-of-4 backup scheme, two shares from any two locations are sufficient to recover the seed. Similarly, in order to steal the seed, an attacker would have to successfully compromise at least two storage locations, which is more complicated than a single storage location. The seed becomes unrecoverable if at least three shares are completely destroyed, which is very unlikely even in case of a major disaster recovery.

FIG. 129B shows an exemplary seed shares implementation case for the SOCOACT. In FIG. 129B, the SOCOACT may be configured to require two master key shares stored on physical backup materials and two master key shares stored on digital backup materials to recover a master key 12901. Examples of physical backup materials that may be utilized include a scroll 12905, a stone table 12910, a piece of paper 12915, and/or the like. Examples of digital backup materials that may be utilized include a barcode shown on a smartphone 12920, a QR code shown on a smartwatch 12925, a file 12930, an encrypted file 12935, and/or the like. In one implementation, the SOCOACT may be configured to require the use of any physical backup materials and/or any digital backup materials. In another implementation, the SOCOACT may be configured to require the use of specified physical backup materials (e.g., one master key share stored on paper and one master key share stored on a stone tablet) and/or specified digital backup materials (e.g., one master key share stored in a QR code on a smartwatch and one master key share stored in an encrypted file).

FIG. 130 shows a screenshot diagram illustrating embodiments of the SOCOACT. In FIG. 130, an exemplary interactive command-line interface (CLI) of a backup utility is illustrated. In one implementation, upon generating a master key on a HSM, the master key may be split into master key shares inside the HSM. Each share may be exported to an air-gapped key-generation workstation and printed out one at a time such that the shares are not in the workstation's RAM at the same time.

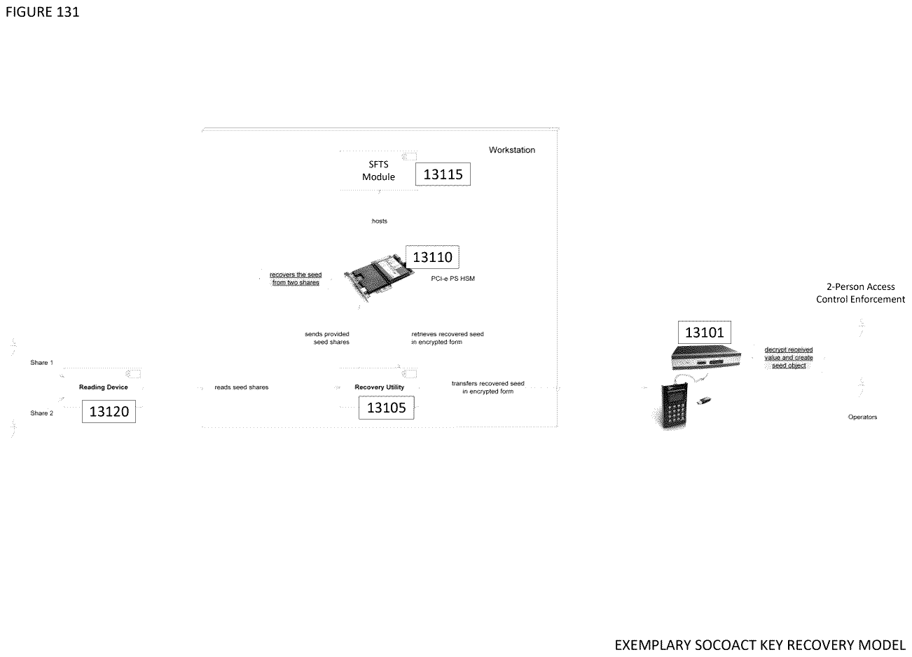

FIG. 131 shows an exemplary key recovery model for the SOCOACT. In FIG. 131, a seed (e.g., master key) may be recovered from seed shares. Seed shares utilized to recover the seed (e.g., a minimum number of seed shares) may be transferred from their storage locations to a recovery center. Operators participating in the key recovery process may enter the seed shares into a reading device 13120 (e.g., each operator may hold and enter a single seed via a barcode reader, keyboard, USB drive, hard drive, portable HSM, etc.), and the reading device may transfer the seed shares to a recovery utility 13105. The recovery utility may request that a seed hosting HSM 13101 (e.g., Gemalto's G5 HSM), which will host the recovered seed and which supports M-of-N authentication, generate a RSA key pair and provide the generated public key. Operators may approve the key pair generation and seed recovery process by authenticating to an authentication entry device associated with the hosting HSM (e.g., using 2-of-3 access control enforcement). The recovery utility may export the generated RSA public key from the hosting HSM and import it into a backup HSM 13110 (e.g., Gemalto's ProtectServer PCI-e HSM), which supports firmware module extensions and hosts SFTS module 13115. The recovery utility may utilize an API call to provide the entered seed shares to the backup HSM and to request recovery of the seed from the provided shares. The backup HSM may recover the seed using an implemented secret recovery method. See FIG. 127 for an example of a secret recovery method. The backup HSM may encrypt the recovered seed using the provided RSA public key and may return the encrypted seed to the recovery utility. The recovery utility may transfer the encrypted seed to the hosting HSM. The hosting HSM may decrypt the seed using the previously generated RSA private key and may store the seed in the hosting HSM. Thus, the full seed is not exposed in decrypted form outside of an HSM device (e.g., in RAM of the host workstation) during the key recovery process, which eliminates the risk of memory-attack theft. As M-of-N shares may be utilized to recover the seed, the redundancy of backup stores is further increased. For example, in a 2-of-4 backup scheme, 4 shares may be stored at four regions separately. If one or two regions are destroyed, shares from the other two regions can still be used to recover the full seed.

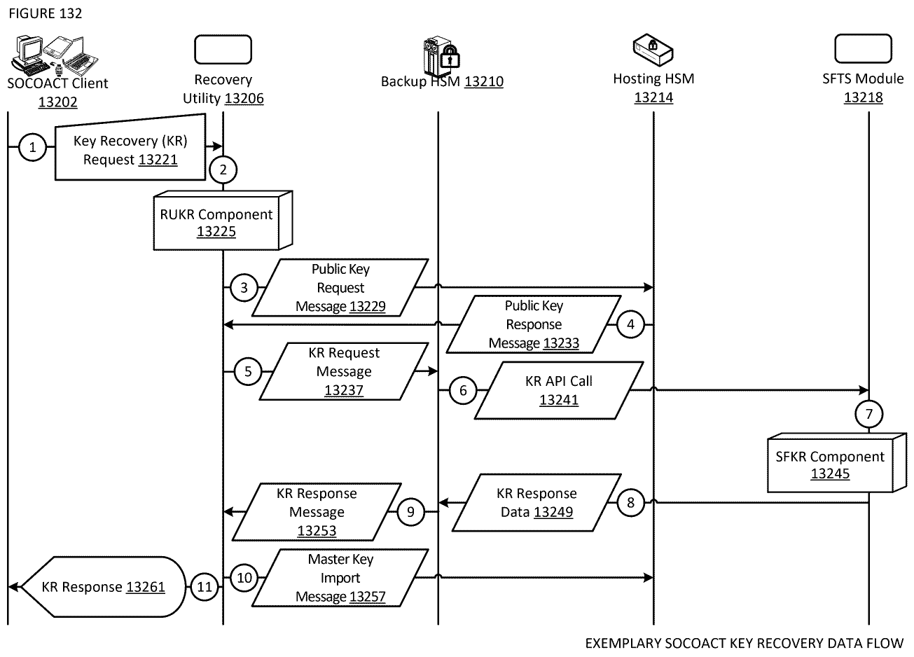

FIG. 132 shows a datagraph diagram illustrating embodiments of a data flow for the SOCOACT. In FIG. 132, a user of a SOCOACT client 13202 may send a key recovery request 13221 to a recovery utility 13206 to facilitate key recovery (e.g., of a master key associated with a hierarchical deterministic wallet). For example, the SOCOACT client may be a desktop, a laptop, a tablet, a smartphone, and/or the like that is executing the recovery utility (e.g., the recovery utility may be the same application as the backup utility or a separate application). In one implementation, the key recovery request may include parameters specified by the user (e.g., via a UI of the recovery utility) such as a request type (e.g., backup master key, recover master key), a wallet identifier (e.g., of the wallet whose master key should be recovered), the number of master key shares sufficient to recover the master key, master key shares (e.g., entered via a reading device), and/or the like.

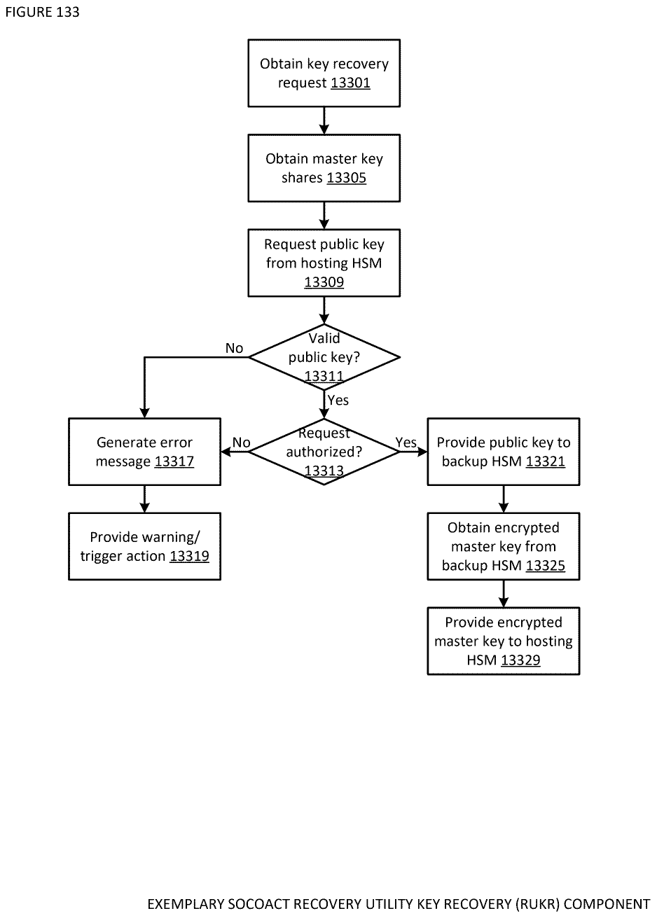

A recovery utility key recovery (RUKR) component 13225 may utilize parameters provided in the key recovery request to facilitate recovery of the relevant master key (e.g., for the specified wallet). See FIG. 133 for additional details regarding the RUKR component.

The recovery utility may send a public key request message 13229 to a hosting HSM 13214 to request a RSA public key from the hosting HSM. In one implementation, the public key request message may include data such as a request identifier, a recovery request identifier, and/or the like. In one embodiment, the recovery utility may provide the following example public key request message, substantially in the form of a HTTP(S) POST message including XML-formatted data, as provided below:

```
POST /public_key_request_message.php HTTP/1.1
Host: localhost
Content-Type: Application/XML
Content-Length: 667
<?XML version = “1.0” encoding = “UTF-8”?>
<public_key_request_message>
  <request_identifier>ID_request_21</request_identifier>
  <recovery_request_identifier>ID_recovery_request_1</recovery_request_identif
ier>
</public_key_request_message>
```

The hosting HSM may provide a RSA public key to the recovery utility via a public key response message 13233. In one implementation, the public key response message may include data such as a response identifier, a recovery request identifier, a RSA public key, and/or the like. In one embodiment, the hosting HSM may provide the following example public key response message, substantially in the form of a HTTP(S) POST message including XML-formatted data, as provided below:

```
POST /public_key_response_message.php HTTP/1.1
Host: localhost
Content-Type: Application/XML
Content-Length: 667
<?XML version = “1.0” encoding = “UTF-8”?>
<public_key_response_message>
  <response_identifier>ID_response_21</response_identifier>
  <recovery_request_identifier>ID_recovery_request_1</recovery_request_identif
ier>
  <RSA_public_key>RSA public key provided by the hosting HSM</RSA_public_key>
</public_key_response_message>
```

The recovery utility may send a key recovery request message 13237 to a backup HSM 13210 to request recovery of a master key (e.g., for the specified wallet) from the backup HSM. In one implementation, the key recovery request message may include data such as a request identifier, a request type, a recovery request identifier, a RSA public key, the number of master key shares sufficient to recover the master key, master key shares, and/or the like. In one embodiment, the recovery utility may provide the following example key recovery request message, substantially in the form of a HTTP(S) POST message including XML-formatted data, as provided below:

```
POST /key_recovery_request_message.php HTTP/1.1
Host: localhost
Content-Type: Application/XML
Content-Length: 667
<?XML version = “1.0” encoding = “UTF-8”?>
<key_recovery_request_message>
  <request_identifier>ID_request_22</request_identifier>
  <request_type>RECOVER_MASTER_KEY</request_type>
  <recovery_request_identifier>ID_recovery_request_1</recovery_request_identif
ier>
  <RSA_public_key>RSA public key provided by the hosting HSM</RSA_public_key>
  <number_of_shares_sufficient_to_recover>2</number_of_shares_sufficient_to_re
cover>
  <master_key_shares>
  <share>0_1D7927D78EAD692BB1694497180C66B3E88676F22B920625EDECAA1728F2921E
5E309297B76FE658B61DF9D501B49FB553255DFDC8FE966F2950DDD0078C809B02</share>
  <share>1_01658051EB654BBD692013E6E5FB6BA2D9C36980AE0D592D4D07516910646EE0
5B223C3C13C1DF6736232724DF32644791E4A1217DD642C8A7C0A240311DBD1172FE</share>
  </master_key_shares>
</key_recovery_request_message>
```

The backup HSM may make a key recovery API call 13241 to a SFTS module 13218 to request that the SFTS module recover the master key from the master key shares. In one implementation, the key recovery API call may include data such as a request type (e.g., backup master key, recover master key), a RSA public key, the number of master key shares sufficient to recover the master key, master key shares, and/or the like.

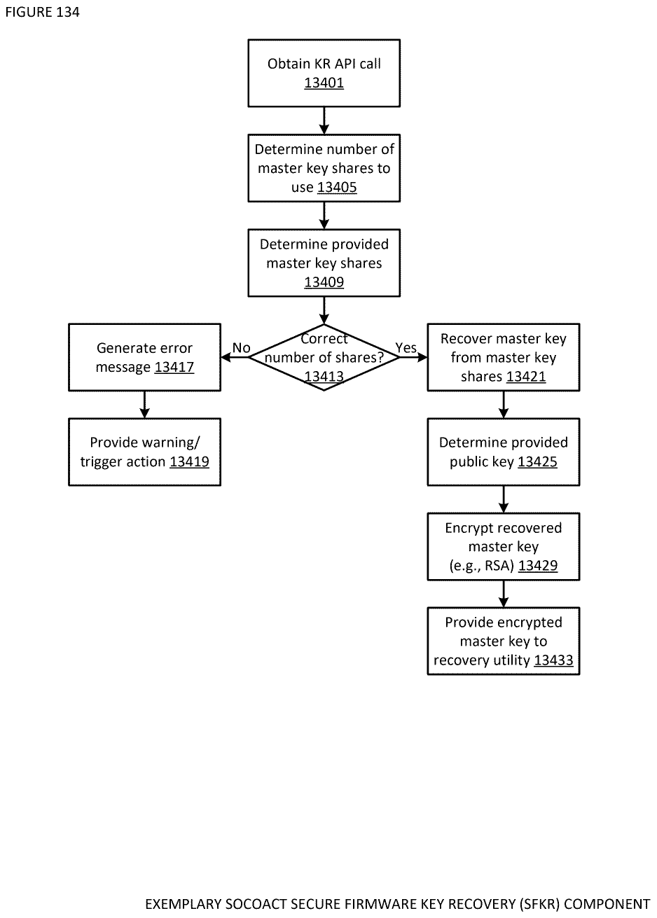

Data provided in the key recovery API call may be used by a secure firmware key recovery (SFKR) component 13245 to recover the master key from the master key shares. See FIG. 134 for additional details regarding the SFKR component.

The SFTS module may send key recovery response data 13249 to the backup HSM in response to the key recovery API call. In one implementation, the key recovery response data may include an encrypted recovered master key.

The backup HSM may send a key recovery response message 13253 to the recovery utility. In one implementation, the key recovery response message may include data such as a response identifier, a recovery request identifier, the encrypted recovered master key, and/or the like. In one embodiment, the backup HSM may provide the following example key recovery response message, substantially in the form of a HTTP(S) POST message including XML-formatted data, as provided below:

```
POST /key_recovery_response_message.php HTTP/1.1
Host: localhost
Content-Type: Application/XML
Content-Length: 667
<?XML version = “1.0” encoding = “UTF-8”?>
<key_recovery_response_message>
  <response_identifier>ID_response_22</response_identifier>
  <recovery_request_identifier>ID_recovery_request_1</recovery_request_identif
ier>
  <master_key>encrypted recovered master key provided by the backup
HSM</master_key>
</key_recovery_response_message>
```

The recovery utility may send a master key import message 13257 to the hosting HSM to import the recovered master key into the hosting HSM. In one implementation, the master key import message may include data such as a request identifier, a recovery request identifier, a wallet identifier, the encrypted recovered master key, and/or the like. For example, the hosting HSM may decrypt and/or store the recovered master key for the specified wallet. In one embodiment, the recovery utility may provide the following example master key import message, substantially in the form of a HTTP(S) POST message including XML-formatted data, as provided below:

```
POST /master_key_import_message.php HTTP/1.1
Host: localhost
Content-Type: Application/XML
Content-Length: 667
<?XML version = “1.0” encoding = “UTF-8”?>
<master_key_import_message>
  <request_identifier>ID_request_23</request_identifier>
  <recovery_request_identifier>ID_recovery_request_1</recovery_request_identif
ier>
  <wallet_identifier>ID_Wallet1</wallet_identifier>
  <master_key>encrypted recovered master key provided by the backup
HSM</master_key>
</master_key_import_message>
```

The recovery utility may send a key recovery response 13261 to the user. For example, the key recovery response may be used to inform the user whether the key recovery was completed successfully (e.g., via a UI of the recovery utility).

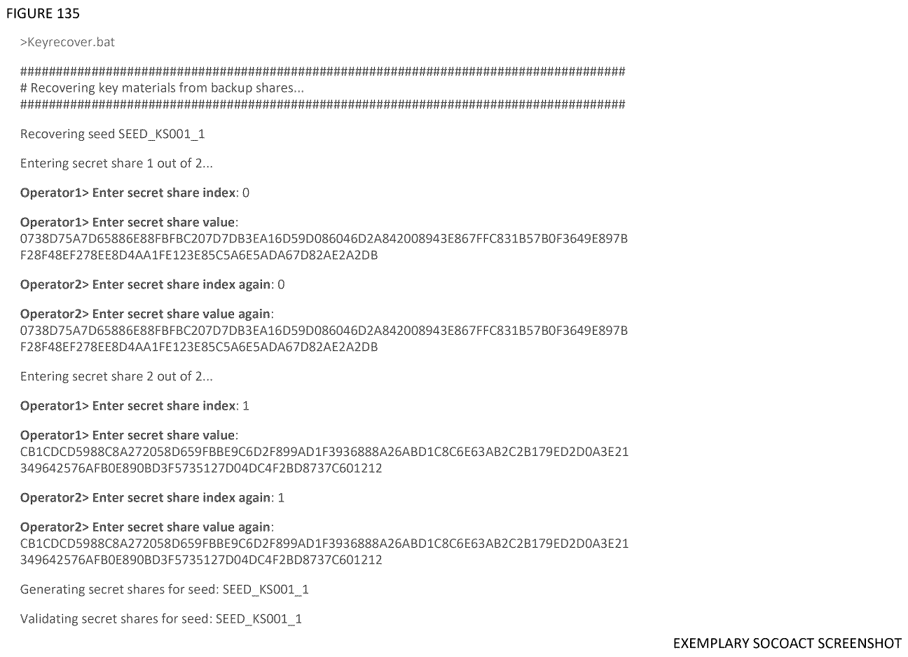

FIG. 133 shows a logic flow diagram illustrating embodiments of a recovery utility key recovery (RUKR) component for the SOCOACT. In FIG. 133, a key recovery request may be obtained at 13301. For example, the key recovery request may be obtained as a result of a user utilizing a UI of a recovery utility to initiate key recovery of a master key associated with a hierarchical deterministic wallet. See FIG. 135 for an example of a UI that may be utilized by the user.

Master key shares utilized to recover the master key (e.g., a minimum number of master key shares sufficient to recover the master key) may be obtained at 13305. In one implementation, the master key shares may be obtained from operators participating in the key recovery process via a reading device. In one implementation, the master key shares may be forwarded to a backup HSM via a key recovery request message.

A RSA public key may be requested from a hosting HSM at 13309. In one implementation, a public key request message may be sent to the hosting HSM to request the RSA public key.

A determination may be made at 13311 whether the obtained RSA public key is valid. For example, the recovery utility may be configured to work with a specified set of hosting HSMs, and the obtained RSA public key may have to be associated with one of the specified hosting HSMs to be valid.

If the obtained RSA public key is not valid, an error message may be generated at 13317. For example, the error message may specify the error that occurred (e.g., RSA public key is not valid). A warning message may be provided to the user and/or an action may be triggered at 13319. In one implementation, a warning message based on the generated error message may be provided to the user to inform the user regarding the error. In another implementation, an action may be triggered based on a specified condition (e.g., invalid RSA public key obtained three times). For example, the triggered action may be to erase data associated with the wallet. In another example, the triggered action may be to invalidate the master key and to generate a new master key.

If the obtained RSA public key is valid, a determination may be made at 13313 whether the key recovery request is authorized. In one implementation, one or more operators (e.g., based on M-of-N authentication) may have to approve (e.g., via an authentication entry device associated with the hosting HSM) the request to recover the master key and to import it into the hosting HSM.

If the key recovery request is not authorized, an error message may be generated at 13317. For example, the error message may specify the error that occurred (e.g., key recovery request is not authorized). A warning message may be provided to the user and/or an action may be triggered at 13319. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with the wallet. In another example, the triggered action may be to invalidate the master key and to generate a new master key.

If the key recovery request is authorized, the RSA public key may be provided to the backup HSM at 13321. For example, the RSA public key may be utilized by the backup HSM to encrypt the recovered master key such that the corresponding RSA private key, available to the hosting HSM, may be used to decrypt the recovered master key. In one implementation, the RSA public key may be forwarded to the backup HSM via the key recovery request message.

The encrypted recovered master key (e.g., for the specified wallet) may be obtained from the backup HSM at 13325. In one implementation, the encrypted recovered master key may be obtained via a key recovery response message sent by the backup HSM.

The encrypted master key may be provided to the hosting HSM at 13329. For example, the hosting HSM may decrypt and/or store the recovered master key for the specified wallet. In one implementation, the encrypted master key may be forwarded to the hosting HSM via a master key import message.

FIG. 134 shows a logic flow diagram illustrating embodiments of a secure firmware key recovery (SFKR) component for the SOCOACT. In FIG. 134, a key recovery API call may be obtained at 13401. For example, the key recovery API call may be obtained as a result of a call from a backup HSM (e.g., based on receiving a key recovery request message from a recovery utility) associated with the SFKR component. In one embodiment, the following API method may be available to the backup HSM and/or to the recovery utility:

```
CombineSeedShares - this method returns a 512-bit master key value restored from
provided master key shares and encrypted with an RSA public key generated by the
hosting HSM. The SFKR component uses provided master key shares to restore the
full master key value according to the secret sharing algorithm used in the
implementation.
  Input:
    subarray of master key shares sufficient to recover the master key (M
master key shares)
  Output:
    512-bit master key value encrypted with an RSA public key generated by
the hosting HSM
```

In one implementation, a C implementation of this method for M-of-N key split may have the following interface:

```
CombineSeedShares(CK_ULONG slot_id,
  const char *pin,
  CK_BYTE_PTR pShares,
  CK_ULONG shares_num,
  CK_BYTE_PTR *phSeed,
  CK_ULONG_PTR phSeed_len)
```

The following table describes input and output parameters:

| | Input/ | | | Sample |
|---|---|---|---|---|
| Name | Output | Type | Description | Values |
| slot_id | In | CK_ULONG | Identifier of the target slot inside HSM | 0 |
| pin | In | const char * | User PIN for HSM | 0123 |
| pShares | In | CK_BYTE_PTR | Pointer to the byte array containing the list of secret | |
| | | | shares along with their indices | |
| shares_num | In | CK_ULONG | Number of secret shares submitted for master key | 5 |
| | | | recovery | |
| phSeed | Out | CK_BYTE_PTR * | Pointer to the pointer to a byte array containing the | |
| | | | handle to the recovered full master key | |
| phSeed_len | Out | CK_ULONG_PTR | Pointer to a long number containing the length of the | |
| | | | byte array containing the handle to the recovered | |
| | | | master key | |

The number of master key shares to use (e.g., the number of master key shares sufficient to recover the master key) may be determined at 13405. In one implementation, this data may be provided as an input parameter in the key recovery API call. In another implementation, this determination may be made via an internal call on a HSM environment setting.

The provided master key shares may be determined at 13409. In one implementation, this data may be provided as input parameters in the key recovery API call.

A determination may be made at 13413 whether the correct number of master key shares was provided. In one implementation, this determination may be made by checking whether the number of provided master key shares matches the number of master key shares to use.

If an incorrect number of master key shares was provided, an error message may be generated at 13417. For example, the error message may specify the error that occurred (e.g., incorrect number of master key shares is provided). A warning message may be provided to a user and/or an action may be triggered at 13419. In one implementation, a warning message based on the generated error message may be provided to the user (e.g., via the recovery utility) to inform the user regarding the error. In another implementation, an action may be triggered based on a specified condition (e.g., incorrect number of master key shares provided three times). For example, the triggered action may be to erase data associated with the wallet. In another example, the triggered action may be to invalidate the master key and to generate a new master key.

If the correct number of master key shares is provided, a master key may be recovered from the provided master key shares at 13421. In one embodiment, a method such as Shamir's Secret Sharing may be utilized to recover the master key from the master key shares based on the specified number of master key shares to use. See FIG. 127 for additional details regarding utilizing Shamir's Secret Sharing. For example, in a 2-of-4 backup scheme, any arbitrary two shares can be used to reconstruct the original full master key.

The provided RSA public key may be determined at 13425. In one implementation, the RSA public key may be provided as an input parameter in the key recovery API call.

The recovered master key may be encrypted using the RSA public key at 13429. In one implementation, the recovered master key may be encrypted using a PKCS #11 function (e.g., C_Encrypt( . . . )).

The encrypted recovered master key may be provided to the recovery utility at 13433. In one implementation, the encrypted recovered master key may be provided to the recovery utility via a key recovery response message.

FIG. 135 shows a screenshot diagram illustrating embodiments of the SOCOACT. In FIG. 135, an exemplary interactive CLI of a recovery utility is illustrated. In one implementation, recovery of a master key may involve several users (operators) who authenticate to the involved devices using multi-factor authentication. For example, master key shares' indices and values may have to be manually entered (e.g., twice).

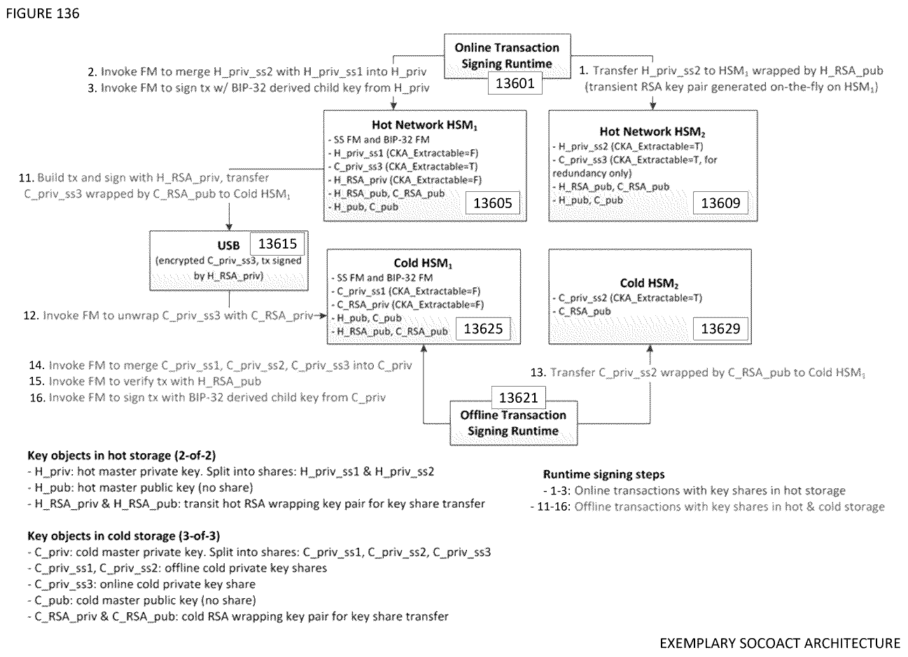

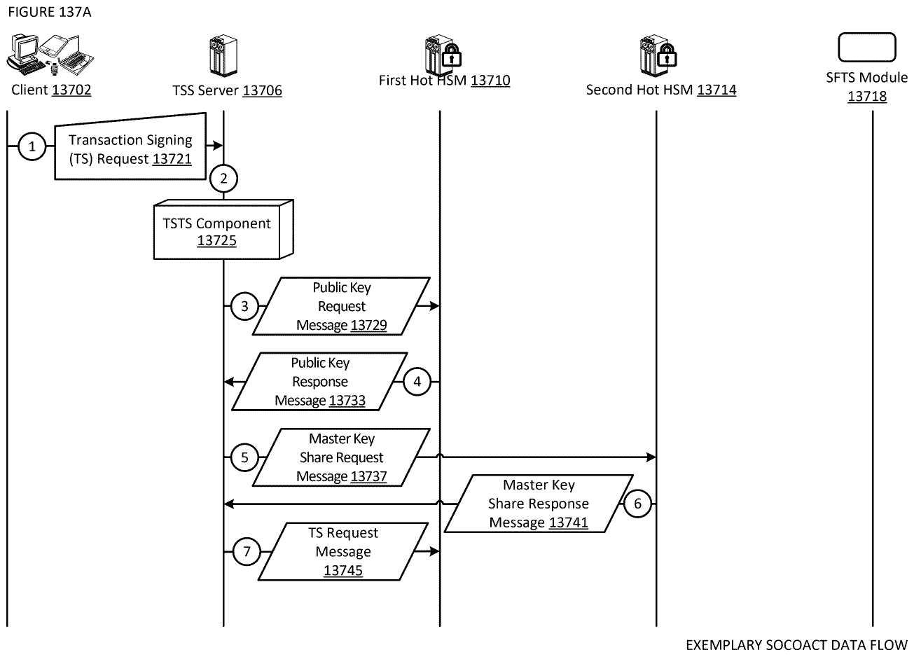

FIG. 136 shows an exemplary architecture for the SOCOACT. As shown in FIG. 136, in various embodiments, an Ethereum EOA master private key is split into multiple key shares (e.g., via Shamir's Secret Sharing) which are stored and protected across multiple HSMs. For example, Shamir's Secret Sharing may be implemented as a custom firmware functional module (FM) (e.g., a SFTS module) on a designated HSM device such that at transaction signing runtime the HSM securely reconstructs key shares (e.g., with some stored on other HSM devices) back into a transient full private key on the HSM. When key shares are created (e.g., from a master private key in a key-generation ceremony), one share may be marked as non-extractable on the designated HSM device where the FM with Shamir's Secret Sharing is deployed. HSM storage of this share, under certified FIPS 140-2 level 3 protections, ensures the entire master private key is not vulnerable to key theft since it is not exposed outside of the HSM. A full key compromise entails key share compromises of multiple distributed HSM devices. Reconstruction of the full key and signing occur on the HSM and thus is not vulnerable to memory-based attacks on a wallet host.

At Ethereum transaction signing runtime (e.g., a TSS), key wrapping (e.g., via RSA keys) is used to protect confidentiality and integrity of key shares and transactions being transferred from other HSM devices to the designated HSM for master key reconstruction and signing in the FM. Unwrapping RSA private keys and signing ECDSA keys do not leave the HSM. The SOCOACT architecture may be deployed to both online and offline keys for hot (e.g., networked) and cold (e.g., non-networked) storage (e.g., runtime signing steps 1-3 describe online transaction signing with two key shares in hot storage), and to mixed online and offline keys for air-gapped cold storage transaction signing (e.g., runtime signing steps 11-16 describe offline transaction signing with three key shares in hot and cold storage).

The M-of-N authentication schema may be used to achieve key at-rest protection on HSM devices at multiple locations, while maintaining runtime key redundancy and availability for transaction signing. Together with HSM key replication, hardware redundancy and high-availability deployment, the HSM-based key storage infrastructure may offer high scalability, load-balance and fail-over capabilities. The M-of-N authentication schema may also be used for key share backup in long-term offline storage locations for key recovery in case of disaster scenarios.

In one implementation, online transaction signing with key shares in hot storage may be utilized. A transaction (tx) to sign may be obtained (e.g., requested by a user) by an online transaction signing runtime (e.g., a TSS) 13601. A second hot HSM 13609 may wrap (e.g., encrypt) hot key share two H_priv_ss2 with the wrapping key H_RSA pub of an RSA key pair generated by a first hot HSM 13605 and transfer the wrapped hot key share two to the first hot HSM (e.g., via the online transaction signing runtime). The first hot HSM may unwrap hot key share two using the unwrapping key H_RSA_priv, and merge hot key share two with hot key share one H_priv_ss1 into the hot master private key H_priv using a method such as Shamir's Secret Sharing (e.g., via a SFTS module). The transaction may be signed using a BIP-32 derived child private key of the hot master private key (e.g., via the SFTS module).

In another implementation, offline transaction signing with key shares in hot and cold storage may be utilized. A transaction (tx) to sign may be obtained (e.g., requested by a user) by an online transaction signing runtime (e.g., a TSS) 13601 and provided to a first hot HSM 13605. The first hot HSM may sign the transaction with the unwrapping key H_RSA_priv of a hot RSA key pair generated by the first hot HSM, and may wrap (e.g., encrypt) online cold key share three C_priv_ss3 with the wrapping key C_RSA_pub of a cold RSA key pair generated by a first cold HSM 13625. The signed transaction and the wrapped online cold key share three may be transferred via an external storage device 13615 (e.g., a USB drive) to the first cold HSM. The first cold HSM may unwrap online cold key share three using the unwrapping key C_RSA_priv of the cold RSA pair. A second cold HSM 13629 may wrap (e.g., encrypt) offline cold key share two C_priv_ss2 with the wrapping key C_RSA_pub of the cold RSA pair and transfer the wrapped offline cold key share two to the first cold HSM (e.g., via an offline transaction signing runtime 13621 (e.g., a TSS)). The first cold HSM may unwrap offline cold key share two using the unwrapping key C_RSA_priv of the cold RSA pair, and merge online cold key share three, offline cold key share two, and offline cold key share one C_priv_ss1 into the cold master private key C_priv using a method such as Shamir's Secret Sharing (e.g., via a SFTS module). The first cold HSM may verify the signature of the transaction using the wrapping key H_RSA_pub of the hot RSA pair (e.g., to verify that the transaction was provided by the first hot HSM), and the transaction may be signed using a BIP-32 derived child private key of the cold master private key (e.g., via the SFTS module).

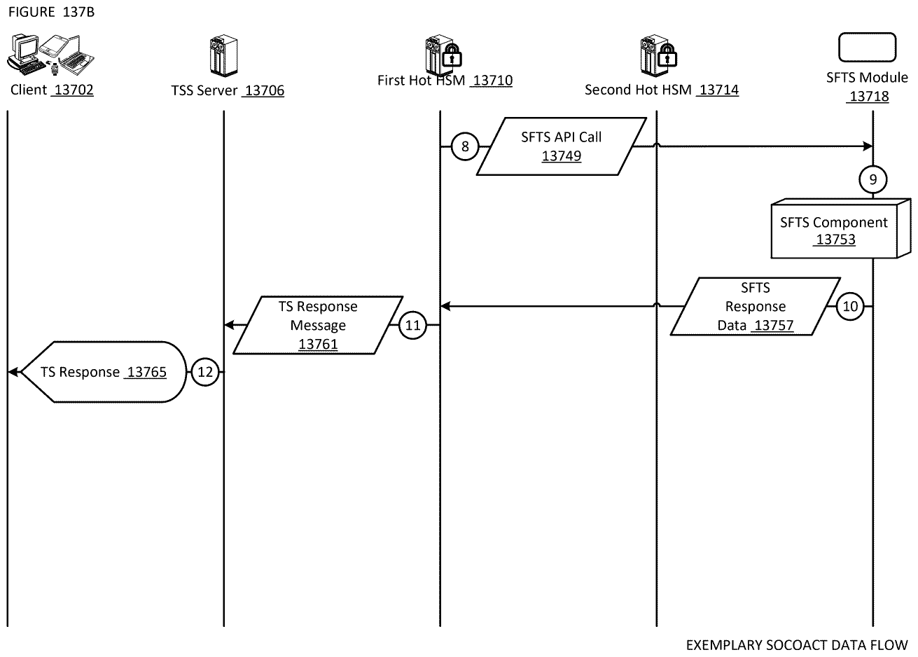

FIGS. 137A-B show a datagraph diagram illustrating embodiments of a data flow for the SOCOACT. In FIGS. 137A-B, a client 13702 may send a transaction signing (TS) request 13721 to a TSS server (e.g., an online transaction signing runtime) 13706 to request that an EOA transaction be signed. For example, the client may be a desktop, a laptop, a tablet, a smartphone, and/or the like that is executing a client application. In one implementation, the TS request may include data such as a request identifier, user authentication data, a request type (e.g., sign message hash), a wallet identifier, a transaction identifier, a transaction hash, a keychain path, and/or the like. In one embodiment, the client may provide the following example TS request, substantially in the form of a HTTP(S) POST message including XML-formatted data, as provided below:

```
POST /authrequest.php HTTP/1.1
Host: localhost
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</account_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <TS_request>
    <request_identifier>ID_request_31</request_identifier>
    <request_type>SIGN_TRANSACTION</request_type>
    <wallet_identifier>ID_Wallet31</wallet_identifier>
    <transaction_identifier>ID_transaction_31</transaction_identifier>
    <transaction_hash>256-bit hash value to be signed</transaction_hash>
    <keychain_path>m/0/0/1/0</keychain_path>
  </TS_request>
</auth_request>
```

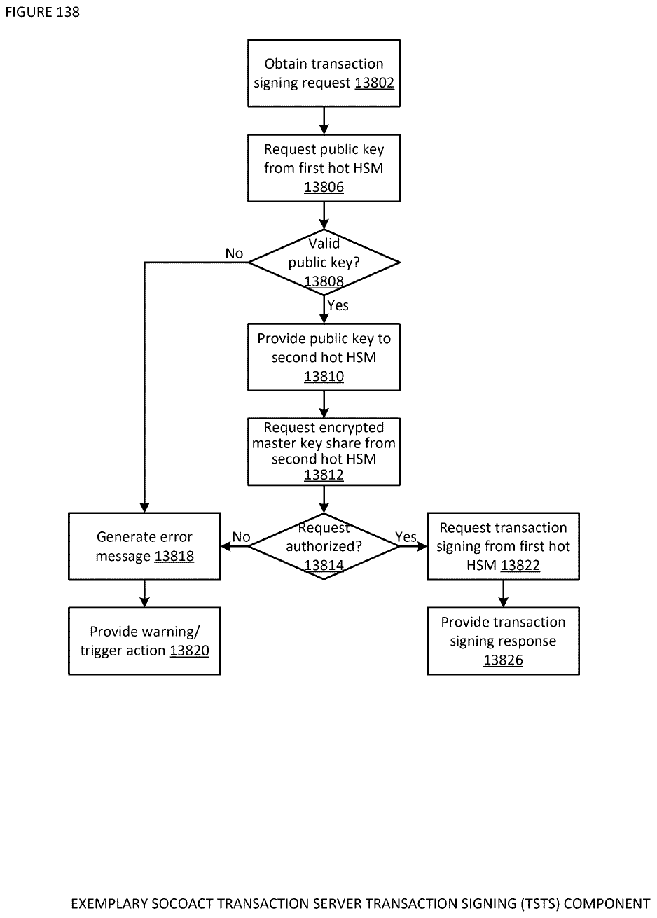

A transaction server transaction signing (TSTS) component 13725 may utilize parameters provided in the TS request to facilitate transaction signing. See FIG. 138 for additional details regarding the TSTS component.

The TSS server may send a public key request message 13729 to a first hot HSM 13710 to request a RSA public key from the first hot HSM. In one implementation, the public key request message may be sent via a HSM Access Provider and may include data such as a request identifier, a transaction identifier, and/or the like. In one embodiment, the TSS server may provide the following example public key request message, substantially in the form of a HTTP(S) POST message including XML-formatted data, as provided below:

```
POST /public_key_request_message.php HTTP/1.1
Host: localhost
Content-Type: Application/XML
Content-Length: 667
<?XML version = “1.0” encoding = “UTF-8”?>
<public_key_request_message>
  <request_identifier>ID_request_32</request_identifier>
  <transaction_identifier>ID_transaction_31</transaction_identifier>
</public_key_request_message>
```

The first hot HSM may provide a RSA public key to the TSS server via a public key response message 13733. In one implementation, the public key response message may include data such as a response identifier, a transaction identifier, a RSA public key, and/or the like. In one embodiment, the first hot HSM may provide the following example public key response message, substantially in the form of a HTTP(S) POST message including XML-formatted data, as provided below:

```
POST /public_key_response_message.php HTTP/1.1
Host: localhost
Content-Type: Application/XML
Content-Length: 667
<?XML version = “1.0” encoding = “UTF-8”?>
<public_key_response_message>
  <response_identifier>ID_response_32</response_identifier>
  <transaction_identifier>ID_transaction_31</transaction_identifier>
  <RSA_public_key>RSA public key provided by
  the 1^{st} hot HSM</RSA_public_key>
</public_key_response_message>
```

The TSS server may send a master key share request message 13737 to a second hot HSM 13714 to request an encrypted master key share (e.g., for a specified wallet) from the second hot HSM. In one implementation, the master key share request message may include data such as a request identifier, a transaction identifier, a wallet identifier, a RSA public key, and/or the like. In one embodiment, the TSS server may provide the following example master key share request message, substantially in the form of a HTTP(S) POST message including XML-formatted data, as provided below:

```
POST /master_key_share_request_message.php HTTP/1.1
Host: localhost
Content-Type: Application/XML
Content-Length: 667
<?XML version = “1.0” encoding = “UTF-8”?>
<master_key_share_request_message>
  <request_identifier>ID_request_33</request_identifier>
  <transaction_identifier>ID_transaction_31</transaction_identifier>
  <wallet_identifier>ID_Wallet31</wallet_identifier>
  <RSA_public_key>RSA public key provided by
  the 1^{st} hot HSM</RSA_public_key>
</master_key_share_request_message>
```

The second hot HSM may provide the encrypted master key share to the TSS server via a master key share response message 13741. In one implementation, the master key share response message may include data such as a response identifier, a transaction identifier, a wallet identifier, an encrypted master key share, and/or the like. In one embodiment, the second hot HSM may provide the following example master key share response message, substantially in the form of a HTTP(S) POST message including XML-formatted data, as provided below:

```
POST /master_key_share_response_message.php HTTP/1.1
Host: localhost
Content-Type: Application/XML
Content-Length: 667
<?XML version = “1.0” encoding = “UTF-8”?>
<master_key_share_response_message>
  <response_identifier>ID_response_33</response_identifier>
  <transaction_identifier>ID_transaction_31</transaction_identifier>
  <wallet_identifier>ID_Wallet31</wallet_identifier>
  <master_key_share>encrypted master key share
  provided by the 2^{nd} hot
HSM</master_key_share>
</master_key_share_response_message>
```

The TSS server may send a TS request message 13745 to the first hot HSM to request that the first hot HSM sign the transaction. In one implementation, the TS request message may be sent via a HSM Access Provider and may include data such as a request identifier, a request type (e.g., sign message hash), a wallet identifier, a transaction identifier, a transaction hash, a keychain path, an encrypted master key share, and/or the like. For example, the TSS server may provide the following example TS request message, substantially in the form of a HTTP(S) POST message including XML-formatted data, as provided below:

```
POST /TS_request_message.php HTTP/1.1
Host: localhost
Content-Type: Application/XML
Content-Length: 667
<?XML version = “1.0” encoding = “UTF-8”?>
<TS_request_message>
  <request_identifier>ID_request_34</request_identifier>
  <request_type>SIGN_TRANSACTION</request_type>
  <wallet_identifier>ID_Wallet31</wallet_identifier>
  <transaction_identifier>ID_transaction_31</transaction_identifier>
  <transaction_hash>256-bit hash value to be signed</transaction_hash>
  <keychain_path>m/0/0/1/0</keychain_path>
  <master_key_share>encrypted master key share
  provided by the 2^{nd} hot
HSM</master_key_share>
</TS_request_message>
```

The first hot HSM may make a SFTS API call 13749 to a SFTS module 13718 to request that the SFTS module sign the transaction. In one implementation, the SFTS API call may include data such as a request type (e.g., sign message hash), a wallet identifier, a transaction identifier, a transaction hash, a keychain path, an encrypted master key share, and/or the like.

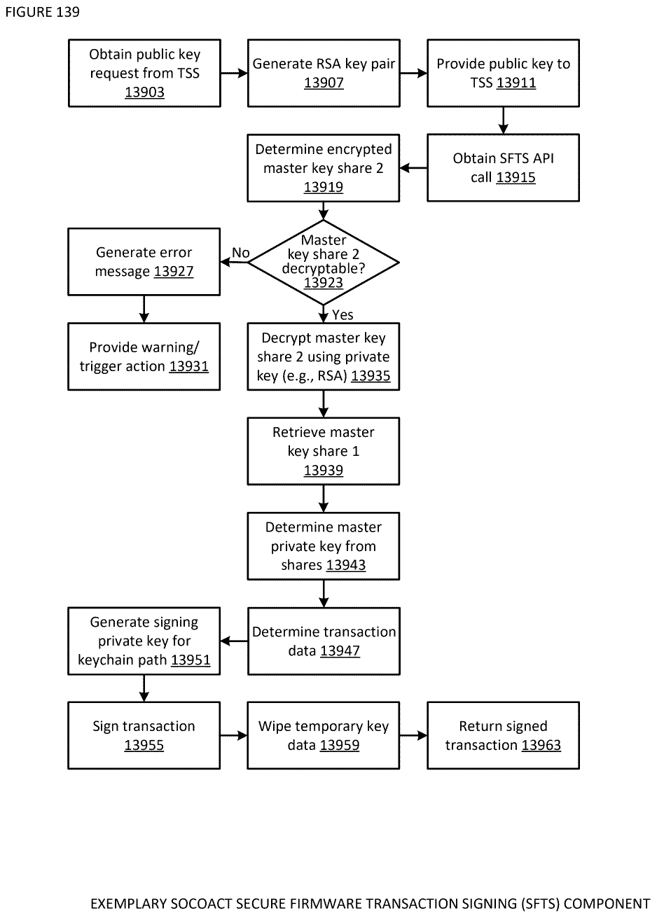

Data provided in the SFTS API call may be used by a secure firmware transaction signing (SFTS) component 13753 to determine a master private key from master key shares and to sign the transaction (e.g., to generate an ECDSA signature in DER format). See FIG. 139 for additional details regarding the SFTS component.

The SFTS module may send SFTS response data 13757 to the first hot HSM in response to the SFTS API call. In one implementation, the SFTS response data may include an ECDSA signature in DER format.

The first hot HSM may send a TS response message 13761 to the TSS server (e.g., via a HSM Access Provider). In one implementation, the TS response message may include data such as a response identifier, a transaction identifier, a transaction signature, and/or the like. For example, the first hot HSM may provide the following example TS response message, substantially in the form of a HTTP(S) POST message including XML-formatted data, as provided below:

```
POST /TS_response_message.php HTTP/1.1
Host: localhost
Content-Type: Application/XML
Content-Length: 667
<?XML version = “1.0” encoding = “UTF-8”?>
<TS_response_message>
  <response_identifier>ID_response_34</response_identifier>
  <transaction_identifier>ID_transaction_31</transaction_identifier>
  <transaction_signature>ECDSA signature in
  DER format</transaction_signature>
</TS_response_message>
```

The TSS server may send a TS response 13765 to the client. In one implementation, the TS response may include data such as a response identifier, a transaction identifier, a transaction signature, and/or the like. For example, the TSS server may provide the following example TS response, substantially in the form of a HTTP(S) POST message including XML-formatted data, as provided below:

```
POST /TS_response.php HTTP/1.1
Host: www.server.com
Content-Type: Application/XML
Content-Length: 667
<?XML version = “1.0” encoding = “UTF-8”?>
<TS_response>
  <response_identifier>ID_response_31</response_identifier>
  <transaction_identifier>ID_transaction_31</transaction_identifier>
  <transaction_signature>ECDSA signature in
  DER format</transaction_signature>
</TS_response>
```

FIG. 138 shows a logic flow diagram illustrating embodiments of a transaction server transaction signing (TSTS) component for the SOCOACT. In FIG. 138, a transaction signing request may be obtained at 13802. For example, the transaction signing request may be obtained as a result of a user utilizing a UI of an online transaction signing runtime CLI program to initiate transaction signing (e.g., a fund transfer EOA transaction on Ethereum blockchain) using a master key associated with a hierarchical deterministic wallet.

An RSA public key may be requested from a first hot HSM at 13806. In one implementation, a public key request message may be sent to the first hot HSM to request the RSA public key.

A determination may be made at 13808 whether the obtained RSA public key is valid. For example, the fund transfer program may be configured to work with a specified set of HSMs, and the obtained RSA public key may have to be associated with one of the specified HSMs to be valid.

If the obtained RSA public key is not valid, an error message may be generated at 13818. For example, the error message may specify the error that occurred (e.g., RSA public key is not valid). A warning message may be provided to the user and/or an action may be triggered at 13820. In one implementation, a warning message based on the generated error message may be provided to the user to inform the user regarding the error. In another implementation, an action may be triggered based on a specified condition (e.g., invalid RSA public key obtained three times). For example, the triggered action may be to erase data associated with the wallet. In another example, the triggered action may be to invalidate the master key and to generate a new master key.

If the obtained RSA public key is valid, the RSA public key may be provided to a second hot HSM at 13810. For example, the RSA public key may be utilized by the second hot HSM to encrypt a second master private key share stored by the second hot HSM such that the corresponding RSA private key, available to the first hot HSM, may be used to decrypt the second master private key share. In one implementation, the RSA public key may be forwarded to the second hot HSM via a master key share request message.

An encrypted second master private key share (e.g., for the specified wallet) may be requested from the second hot HSM at 13812. In one implementation, a master key share request message may be sent to the second hot HSM to request the second master private key share encrypted with the RSA public key.

A determination may be made at 13814 whether the request for the encrypted second master private key share is authorized. In one implementation, one or more operators (e.g., based on M-of-N authentication) may have to approve (e.g., via an authentication entry device associated with the second hot HSM) the request to export the encrypted second master private key share from the second hot HSM for the request to be authorized.

If the request for the encrypted second master private key share is not authorized, an error message may be generated at 13818. For example, the error message may specify the error that occurred (e.g., request to export the encrypted second master private key share from the second hot HSM is not authorized). A warning message may be provided to the user and/or an action may be triggered at 13820. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with the wallet. In another example, the triggered action may be to invalidate the master key and to generate a new master key.

If the request for the encrypted second master private key share is authorized, transaction signing may be requested from the first hot HSM at 13822. In one implementation, a transaction signing request message may be sent to the first hot HSM to request transaction signing.

A transaction signing response may be provided to the client at 13826. In one implementation, a transaction signing response may be sent to the client to inform the user whether the transaction signing was completed successfully (e.g., via a UI of the online transaction signing runtime).

FIG. 139 shows a logic flow diagram illustrating embodiments of a secure firmware transaction signing (SFTS) component for the SOCOACT. In FIG. 139, a public key request from a TSS may be obtained at 13903. For example, the public key request may be obtained as a result of the TSS facilitating transaction signing.

A RSA key pair may be generated at 13907. In one embodiment, a RSA key pair (e.g., a RSA public key and a corresponding RSA private key) may be predefined (e.g., for a HSM). In one implementation, the RSA public key may be determined using a PKCS #11 function (e.g., C_FindObjectsInit( . . . )). In another implementation, the RSA public key may be determined via an internal call on a HSM environment setting configured externally at HSM deployment time. In an alternative implementation, the RSA public key may be determined via a MySQL database command (e.g., retrieved from a MySQL database in tamper-proof storage). In another embodiment, a RSA key pair may be generated dynamically (e.g., each time transaction signing is executed). In one implementation, a RSA public key may be generated using a PKCS #11 function (e.g., C_CreateObject ( . . . )).

The RSA public key may be provided to the TSS at 13911. In one implementation, the RSA public key may be provided to the TSS via a public key response message.

A SFTS API call may be obtained at 13915. For example, the SFTS API call may be obtained as a result of a call from a first hot HSM associated with the SFTS component. It is to be understood that although the SFTS component is described with regard to an API method to sign a transaction (e.g., signMessageHash), in some embodiment, a variety of API methods may be available. In one embodiment, the following API methods may be available to the first hot HSM and/or to a TSS:

```
signMessageHash - this method receives a message hash, a keychain path and a
handle to the transient object containing a second master private key share (e.g.,
encrypted), and returns an ECDSA signature value. Seed reconstruction from shares
and key derivation steps are implemented by the SFTS component. Temporary keys
generated for signing are wiped out of the device once the signing process is
complete.
  Input:
    256-bit hash value to be signed
    keychain path to be used for Bip32 key derivation
    handle to the transient object containing a second master private key
share (e.g., encrypted)
  Output:
    ECDSA signature in DER format
```

An encrypted second master private key share utilized to recover a master private key may be determined at 13919. In one implementation, the encrypted second master private key share may be provided as an input parameter in the SFTS API call.

A determination may be made at 13923 whether the encrypted second master private key share is decryptable. In one implementation, this determination may be made by checking whether decrypting the encrypted second master private key share using the RSA private key results in a valid object.

If the encrypted second master private key share is not decryptable, an error message may be generated at 13927. For example, the error message may specify the error that occurred (e.g., second master private key share is not decryptable). A warning message may be provided to a user and/or an action may be triggered at 13931. In one implementation, a warning message based on the generated error message may be provided to the user (e.g., via the TSS) to inform the user regarding the error. In another implementation, an action may be triggered based on a specified condition (e.g., non-decryptable second master private key share obtained three times). For example, the triggered action may be to erase data associated with an associated wallet. In another example, the triggered action may be to invalidate the master key associated with the second master private key share and to generate a new master key.

If the encrypted second master private key share is decryptable, the encrypted second master private key share may be decrypted using the RSA private key at 13935. In one implementation, the RSA private key may be determined using a PKCS #11 function (e.g., C_FindObjectsInit( . . . )). In another implementation, the RSA private key may be determined via an internal call on a HSM environment setting configured externally at HSM deployment time. In an alternative implementation, the RSA private key may be determined via a MySQL database command (e.g., retrieved from a MySQL database in tamper-proof storage). In one implementation, the encrypted second master private key share may be decrypted using a PKCS #11 function (e.g., C_Decrypt( . . . )).

A first master private key share may be retrieved at 13939. In one implementation, the first master private key share may be determined using a PKCS #11 function (e.g., C_FindObjectsInit( . . . )). In another implementation, the first master private key share may be determined via an internal call on a HSM environment setting configured externally at HSM deployment time. In an alternative implementation, the first master private key share may be determined via a MySQL database command (e.g., retrieved from a MySQL database in tamper-proof storage).

A master private key may be determined from master private key shares (e.g., from the first master private key share and the second master private key share) at 13943. In one embodiment, a method such as Shamir's Secret Sharing may be utilized to recover the master private key from the master private key shares. See FIG. 127 for additional details regarding utilizing Shamir's Secret Sharing.

Transaction data may be determined at 13947. In one implementation, the transaction data may be provided in the SFTS API call and may include a wallet identifier, a transaction identifier, a transaction hash, a keychain path, and/or the like.

A signing private key for the specified keychain path may be generated using the determined master private key at 13951. In one implementation, the signing private key may be generated in accordance with a deterministic key derivation procedure as described in Bip32. The transaction may be signed at 13955. In one implementation, the generated signing private key may be used to sign the transaction hash in accordance with the hashing algorithm utilized by the Ethereum protocol (e.g., KECCAK256(RLP(message))). For example, the transaction may be signed using a Keccak hash function of a recursive length prefix (RLP) of the message.

Temporary private key data may be wiped from memory at 13959. In one implementation, the second master private key share obtained from the second hot HSM, the determined master private key, and/or the generated signing private key may be wiped from memory of the first hot HSM associated with the SFTS component. The signed transaction may be returned at 13963. In one implementation, the ECDSA signature in DER format may be returned.

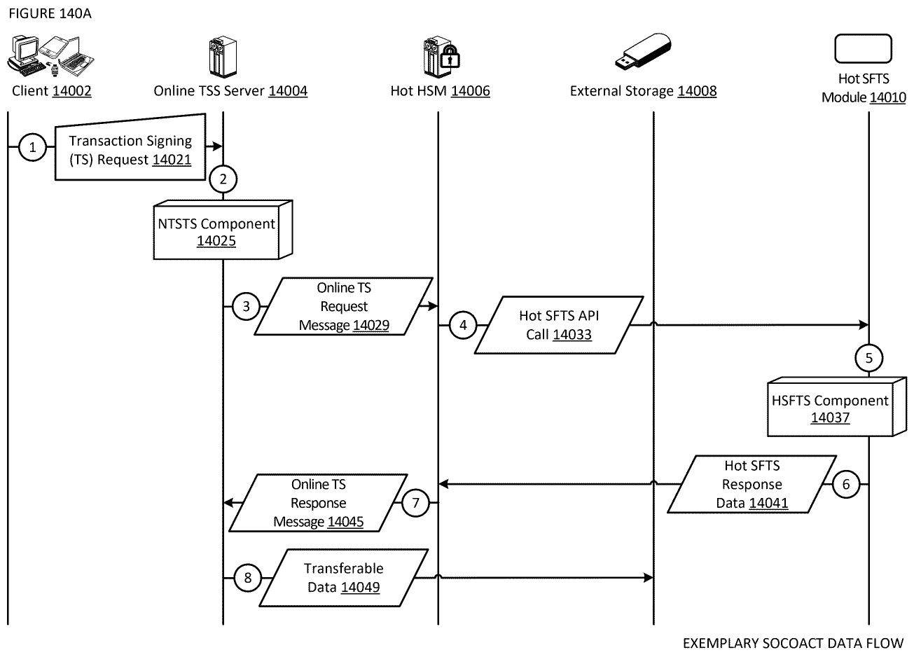

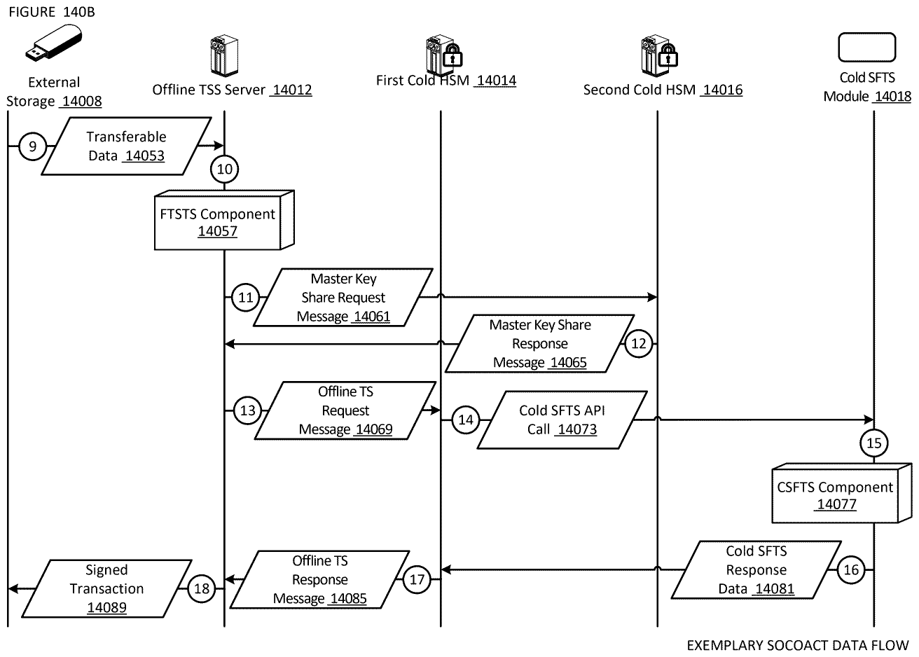

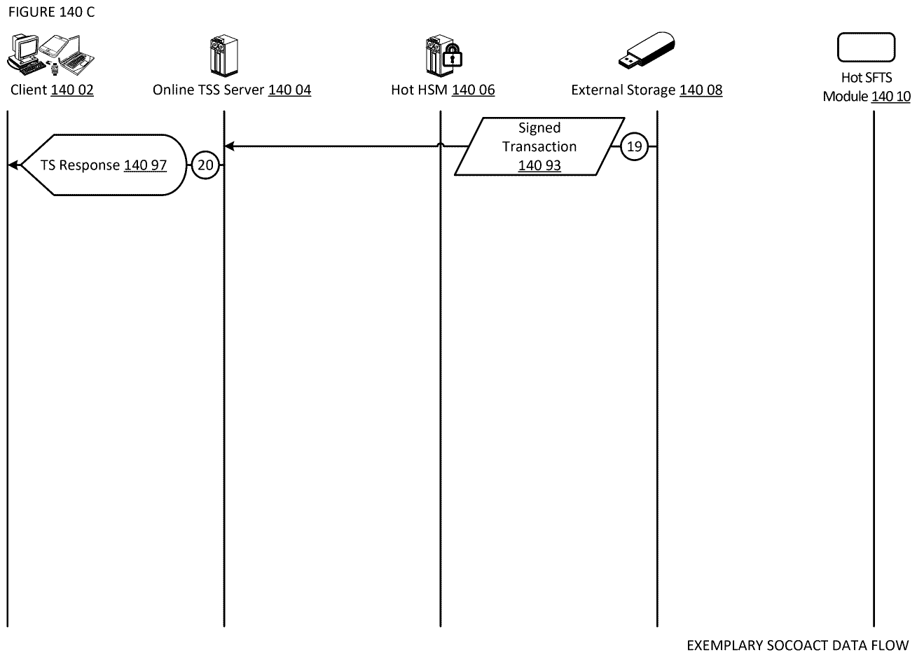

FIGS. 140A-C show a datagraph diagram illustrating embodiments of a data flow for the SOCOACT. In FIGS. 140A-C, a user of a client 14002 may send a transaction signing (TS) request 14021 to an online TSS server (e.g., an online transaction signing runtime) 14004 to request that an EOA transaction be signed. For example, the client may be a desktop, a laptop, a tablet, a smartphone, and/or the like that is executing a client application. In one implementation, the TS request may include data such as a request identifier, user authentication data, a request type (e.g., sign message hash), a wallet identifier, a transaction identifier, a transaction hash, a keychain path, and/or the like. In one embodiment, the client may provide the following example TS request, substantially in the form of a HTTP(S) POST message including XML-formatted data, as provided below:

```
POST /authrequest.php HTTP/1.1
Host: localhost
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</account_name>
      <password>abc123</password>
      / /OPTIONAL <cookie>cookieID</cookie>
      / /OPTIONAL <digital_cert_link>www.mydigitalcertificate.com/
JohnDoeDaDoeDoe@gmail.com/mycertifcate.dc</digital_cert_link>
      / /OPTIONAL <digital_certificate>_DATA_</digital_certificate>
    </user_account_credentials>
  </user_accounts_details>
  <TS_request>
    <request_identifier>ID_request_41</request_identifier>
    <request_type>SIGN_TRANSACTION</request_type>
    <wallet_identifier>ID_Wallet41</wallet_identifier>
    <transaction_identifier>ID_transaction_41</transaction_identifier>
    <transaction_hash>256-bit hash value to be signed</transaction_hash>
    <keychain_path>m/0/0/1/0</keychain_path>
  </TS_request>
</auth_request>
```

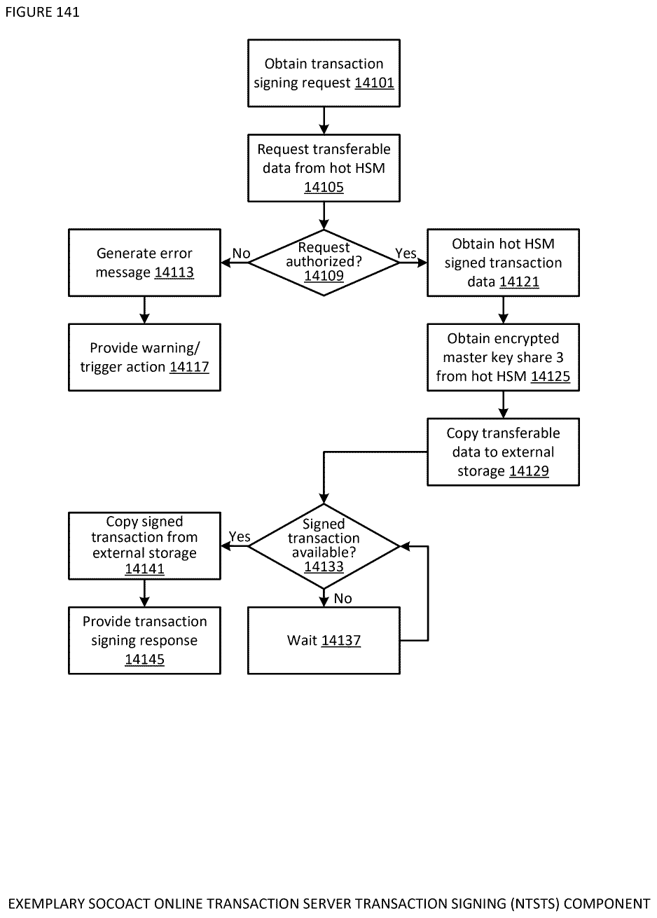

An online transaction server transaction signing (NTSTS) component 14025 may utilize parameters provided in the TS request to facilitate transaction signing. See FIG. 141 for additional details regarding the NTSTS component.

The online TSS server may send an online TS request message 14029 to a hot HSM 14006 to request transferable data from the hot HSM to facilitate transaction signing. In one implementation, the online TS request message may be sent via a HSM Access Provider and may include data such as a request identifier, a request type (e.g., get transferable data), a wallet identifier, a transaction identifier, transaction data, and/or the like. For example, the online TSS server may provide the following example online TS request message, substantially in the form of a HTTP(S) POST message including XML-formatted data, as provided below:

```
POST /online_TS_request_message.php HTTP/1.1
Host: localhost
Content-Type: Application/XML
Content-Length: 667
<?XML version = “1.0” encoding = “UTF-8”?>
<online_TS_request_message>
  <request_identifier>ID_request_42</request_identifier>
  <request_type>GET_TRANSFERABLE_DATA</request_type>
  <wallet_identifier>ID_Wallet41</wallet_identifier>
  <transaction_identifier>ID_transaction_41</transaction_identifier>
  <transaction_data>transaction data to be signed</transaction_data>
</online_TS_request_message>
```

The hot HSM may make a hot SFTS API call 14033 to a hot SFTS module 14010 to request that the hot SFTS module provide the transferable data. In one implementation, the hot SFTS API call may include data such as a request type (e.g., get transferable data), a wallet identifier, a transaction identifier, transaction data, and/or the like.

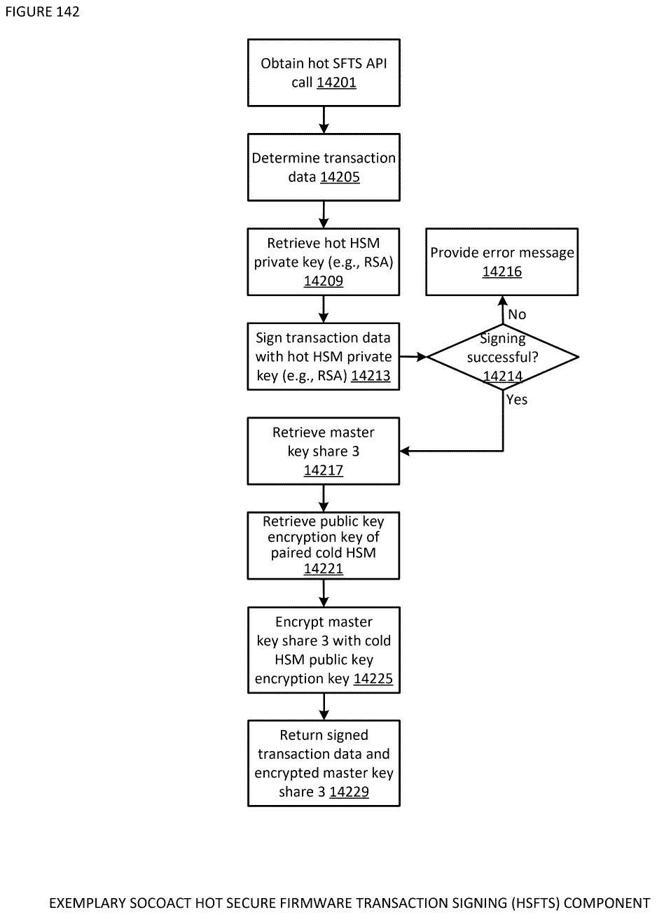

Data provided in the hot SFTS API call may be used by a hot secure firmware transaction signing (HSFTS) component 14037 to provide the transferable data. For example, the transferable data may include an encrypted third master private key share (e.g., encrypted with a public key encryption key of a first cold HSM 14014) and signed transaction data (e.g., signed with a RSA private key of the hot HSM). See FIG. 142 for additional details regarding the HSFTS component.

The hot SFTS module may send hot SFTS response data 14041 to the hot HSM in response to the hot SFTS API call. In one implementation, the hot SFTS response data may include the transferable data.

The hot HSM may send an online TS response message 14045 to the online TSS server (e.g., via a HSM Access Provider). In one implementation, the online TS response message may include data such as a response identifier, a transaction identifier, transferable data, and/or the like. For example, the hot HSM may provide the following example online TS response message, substantially in the form of a HTTP(S) POST message including XML-formatted data, as provided below:

```
POST /online_TS_response_message.php HTTP/1.1
Host: localhost
Content-Type: Application/XML
Content-Length: 667
<?XML version = “1.0” encoding = “UTF-8”?>
<online_TS_response_message>
  <response_identifier>ID_response_42</response_identifier>
  <transaction_identifier>ID_transaction_41</transaction_identifier>
  <transferable_data>
    <master_key_share>encrypted master key share
    provided by the hot
HSM</master_key_share>
    <transaction_data>hot HSM signed transaction
    data</transaction_data>
  </transferable_data>
</online_TS_response_message>
```

The online TSS server may copy the transferable data 14049 and/or other data to an external storage device 14008. In various implementations, the external storage device may be a USB drive (e.g., a flash drive, a hard drive), an SD card, an optical disk, and/or the like.

An offline TSS server 14012 may copy the transferable data 14053 and/or other data from the external storage device. In one implementation, the user may move the external storage device from the online TSS server to the offline TSS server, and may utilize the offline TSS server (e.g., an offline transaction signing runtime) to request that the transaction be signed using the transferable data (e.g., resulting in the copying).

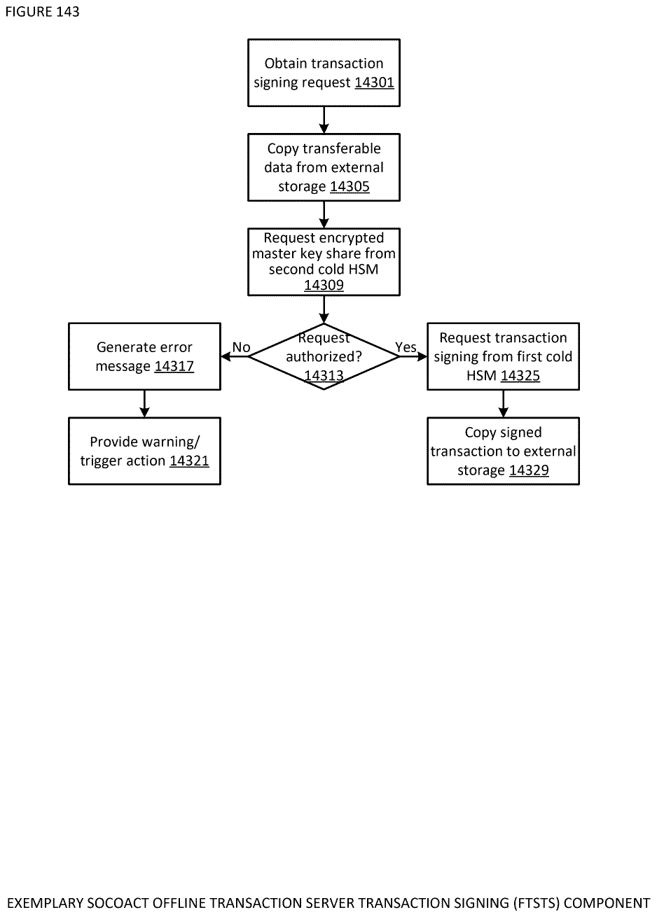

An offline transaction server transaction signing (FTSTS) component 14057 may utilize the transferable data to facilitate transaction signing. See FIG. 143 for additional details regarding the FTSTS component.

In some embodiments, the offline TSS server may send a master key share request message 14061 to a second cold HSM 14016 to request an encrypted master key share (e.g., for a specified wallet) from the second cold HSM. In one implementation, the master key share request message may include data such as a request identifier, a transaction identifier, a wallet identifier, and/or the like. For example, the offline TSS server may provide the following example master key share request message, substantially in the form of a HTTP(S) POST message including XML-formatted data, as provided below:

```
POST /master_key_share_request_message.php HTTP/1.1
Host: www.server.com
Content-Type: Application/XML
Content-Length: 667
<?XML version = “1.0” encoding = “UTF-8”?>
<master_key_share_request_message>
  <request_identifier>ID_request_43</request_identifier>
  <transaction_identifier>ID_transaction_41</transaction_identifier>
  <wallet_identifier>ID_Wallet41</wallet_identifier>
</master_key_share_request_message>
```

In some embodiments, the second cold HSM may provide the encrypted master private key share (e.g., second master private key share encrypted with a public key encryption key of the first cold HSM) to the offline TSS server via a master key response message 14065. In one implementation, the master key share response message may include data such as a response identifier, a transaction identifier, a wallet identifier, an encrypted master key share, and/or the like. In one embodiment, the second cold HSM may provide the following example master key share response message, substantially in the form of a HTTP(S) POST message including XML-formatted data, as provided below:

```
POST /master_key_share_response_message.php HTTP/1.1
Host: localhost
Content-Type: Application/XML
Content-Length: 667
<?XML version = “1.0” encoding = “UTF-8”?>
<master_key_share_response_message>
  <response_identifier>ID_response_43</response_identifier>
  <transaction_identifier>ID_transaction_41</transaction_identifier>
  <wallet_identifier>ID_Wallet41</wallet_identifier>
  <master_key_share>encrypted master key share
  provided by the 2^{nd} cold
HSM</master_key_share>
</master_key_share_response_message>
```

The offline TSS server may send an offline TS request message 14069 to the first cold HSM 14014 to request that the first cold HSM sign the transaction. In one implementation, the offline TS request message may be sent via a HSM Access Provider and may include data such as a request identifier, a request type (e.g., sign message hash), a wallet identifier, a transaction identifier, a transaction hash, a keychain path, transferable data, an encrypted master key share, and/or the like. For example, the offline TSS server may provide the following example offline TS request message, substantially in the form of a HTTP(S) POST message including XML-formatted data, as provided below:

```
POST /offline_TS_request_message.php HTTP/1.1
Host: localhost
Content-Type: Application/XML
Content-Length: 667
<?XML version = “1.0” encoding = “UTF-8”?>
<offline_TS_request_message>
  <request_identifier>ID_request_44</request_identifier>
  <request_type>SIGN_TRANSACTION</request_type>
  <wallet_identifier>ID_Wallet41</wallet_identifier>
  <transaction_identifier>ID_transaction_41</transaction_identifier>
  <transaction_hash>256-bit hash value to be signed</transaction_hash>
  <keychain_path>m/0/0/1/0</keychain_path>
  <transferable_data>
    <master_key_share>encrypted master key share provided by the hot
HSM</master_key_share>
    <transaction_data>hot HSM signed transaction
    data</transaction_data>
  </transferable_data>
  <master_key_share>encrypted master key share
  provided by the 2^{nd} cold
HSM</master_key_share>
</offline_TS_request_message>
```

The first cold HSM may make a cold SFTS API call 14073 to a cold SFTS module 14018 to request that the cold SFTS module sign the transaction. In one implementation, the cold SFTS API call may include data such as a request identifier, a request type (e.g., sign message hash), a wallet identifier, a transaction identifier, a transaction hash, a keychain path, transferable data, an encrypted master key share, and/or the like.

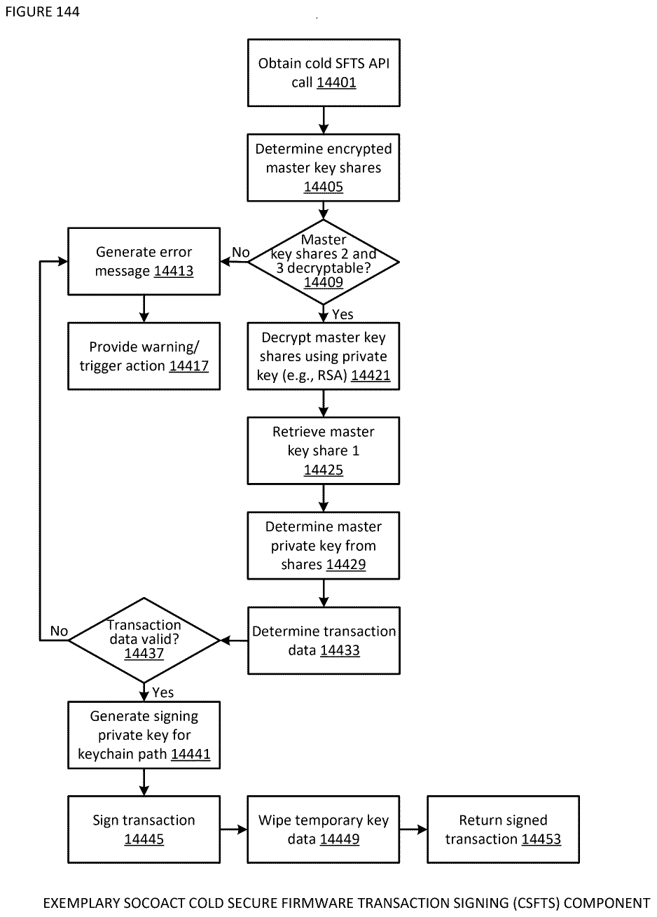

Data provided in the cold SFTS API call may be used by a cold secure firmware transaction signing (CSFTS) component 14077 to determine a master private key from master key shares and to sign the transaction (e.g., to generate an ECDSA signature in DER format). See FIG. 144 for additional details regarding the CSFTS component.

The cold SFTS module may send cold SFTS response data 14081 to the first cold HSM in response to the cold SFTS API call. In one implementation, the SFTS response data may include an ECDSA signature in DER format.

The first cold HSM may send an offline TS response message 14085 to the offline TSS server (e.g., via a HSM Access Provider). In one implementation, the offline TS response message may include data such as a response identifier, a transaction identifier, a transaction signature, and/or the like. For example, the first cold HSM may provide the following example offline TS response message, substantially in the form of a HTTP(S) POST message including XML-formatted data, as provided below:

```
POST /offline_TS_response_message.php HTTP/1.1
Host: localhost
Content-Type: Application/XML
Content-Length: 667
<?XML version = “1.0” encoding = “UTF-8”?>
<offline_TS_response_message>
  <response_identifier>ID_response_44</response_identifier>
  <transaction_identifier>ID_transaction_41</transaction_identifier>
  <transaction_signature>ECDSA signature in
  DER format</transaction_signature>
</offline_TS_response_message>
```

The offline TSS server may copy the signed transaction (e.g., the transaction signature) 14089 and/or other data to the external storage device.

The online TSS server may copy the signed transaction (e.g., the transaction signature) 14093 and/or other data from the external storage device. In one implementation, the user may move the external storage device from the offline TSS server to the online TSS server, and may utilize the online TSS server to finalize transaction processing using the signed transaction (e.g., resulting in the copying).

The online TSS server may send a TS response 14097 to the client. In one implementation, the TS response may include data such as a response identifier, a transaction identifier, a transaction signature, and/or the like. For example, the online TSS server may provide the following example TS response, substantially in the form of a HTTP(S) POST message including XML-formatted data, as provided below:

```
POST /TS_response.php HTTP/1.1
Host: www.server.com
Content-Type: Application/XML
Content-Length: 667
<?XML version = “1.0” encoding = “UTF-8”?>
<TS_response>
  <response_identifier>ID_response_41</response_identifier>
  <transaction_identifier>ID_transaction_41</transaction_identifier>
  <transaction_signature>ECDSA signature in
  DER format</transaction_signature>
</TS_response>
```

FIG. 141 shows a logic flow diagram illustrating embodiments of an online transaction server transaction signing (NTSTS) component for the SOCOACT. In FIG. 141, a transaction signing request may be obtained at 14101. For example, the transaction signing request may be obtained as a result of a user utilizing a UI of an online transaction signing runtime to initiate transaction signing (e.g., a fund transfer EOA transaction on Ethereum blockchain) using a master key associated with a hierarchical deterministic wallet.

Transferable data may be requested from a hot HSM at 14105. For example, the transferable data may include an encrypted third master private key share and signed transaction data. In one implementation, an online TS request message may be sent to the hot HSM to request the transferable data.

A determination may be made at 14109 whether the request for the transferable data is authorized. In one implementation, one or more operators (e.g., based on M-of-N authentication) may have to approve (e.g., via an authentication entry device associated with the hot HSM) the request to provide the transferable data for the request to be authorized.

If the request for the transferable data is not authorized, an error message may be generated at 14113. For example, the error message may specify the error that occurred (e.g., request to provide the transferable data is not authorized). A warning message may be provided to the user and/or an action may be triggered at 14117. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with the wallet. In another example, the triggered action may be to invalidate the master key and to generate a new master key.

If the request for the transferable data is authorized, transaction data signed by the hot HSM may be obtained at 14121 and the encrypted third master private key share may be obtained at 14125 as parts of the transferable data. The obtained transferable data and/or other data utilized to process the transaction may be copied to an external storage device at 14129.

A determination may be made at 14133 whether the signed transaction is available. In one implementation, the user may utilize the UI of the online transaction signing runtime to indicate that the external storage device (e.g., or another USB storage device) containing the signed transaction has been inserted. In another implementation, a notification that the external storage device (e.g., or another USB storage device) has been inserted may be obtained from the operating system and the external storage device may be checked to determine whether the external storage device contains the signed transaction. If the signed transaction is not available, the SOCOACT may wait until the signed transaction is available at 14137.

If the signed transaction is available, the signed transaction may be copied from the external storage at 14141. For example, the signed transaction may include an ECDSA signature in DER format.

A transaction signing response may be provided to the client at 14145. In one implementation, a transaction signing response may be sent to the client to inform the user whether the transaction signing was completed successfully (e.g., via a UI of the online transaction signing runtime).

FIG. 142 shows a logic flow diagram illustrating embodiments of a hot secure firmware transaction signing (HSFTS) component for the SOCOACT. In FIG. 142, a hot SFTS API call may be obtained at 14201. For example, the hot SFTS API call may be obtained as a result of a call from a hot HSM associated with the HSFTS component. It is to be understood that although the HSFTS component is described with regard to an API method to provide transferable data, in some embodiment, a variety of API methods may be available.

Transaction data may be determined at 14205. In one implementation, the transaction data may be provided in the hot SFTS API call and may include a wallet identifier, a transaction identifier, a transaction hash, a keychain path, and/or the like.

A RSA private key for the hot HSM may be retrieved at 14209. In one embodiment, a RSA key pair (e.g., a RSA public key and a corresponding RSA private key) may be predefined (e.g., for the hot HSM). In one implementation, the hot HSM RSA private key may be determined using a PKCS #11 function (e.g., C_FindObjectsInit( . . . )). In another implementation, the hot HSM RSA private key may be determined via an internal call on a HSM environment setting configured externally at HSM deployment time. In an alternative implementation, the hot HSM RSA private key may be determined via a MySQL database command (e.g., retrieved from a MySQL database in tamper-proof storage). In another embodiment, a RSA key pair may be generated dynamically (e.g., each time transaction signing is executed). In one implementation, the hot HSM RSA private key may be generated using a PKCS #11 function (e.g., C_CreateObject( . . . )).

The transaction data may be signed with the hot HSM RSA private key at 14213. In one implementation, the transaction data may be signed using a PKCS #11 function (e.g., C_Sign( . . . )).

A determination may be made at 14214 whether the transaction signing was successful. If an error was detected during the transaction signing, a corresponding error message may be provided to a user at 14216 to inform the user regarding the error.

A third master private key share may be retrieved at 14217. In one implementation, the third master private key share may be determined using a PKCS #11 function (e.g., C_FindObjectsInit( . . . )). In another implementation, the third master private key share may be determined via an internal call on a HSM environment setting configured externally at HSM deployment time. In an alternative implementation, the third master private key share may be determined via a MySQL database command (e.g., retrieved from a MySQL database in tamper-proof storage).

A public key encryption key of a paired cold HSM may be retrieved at 14221. For example, the public key encryption key may be an RSA public key that corresponds to the RSA private key stored in tamper-proof storage of the paired cold HSM (e.g., first cold HSM 14014). In one implementation, the public key encryption key may be determined using a PKCS #11 function (e.g., C_FindObjectsInit( . . . )). In another implementation, the public key encryption key may be determined via an internal call on a HSM environment setting configured externally at HSM deployment time. In an alternative implementation, the public key encryption key may be determined via a MySQL database command (e.g., retrieved from a MySQL database in tamper-proof storage). In another alternative implementation, the public key encryption key may be generated dynamically (e.g., each time transaction signing is executed) by the paired cold HSM and obtained using public key request and public key response messages (e.g., via an external storage device).

The third master private key share may be encrypted with the public key encryption key of the paired cold HSM at 14225. In one implementation, the third master private key share may be encrypted using a PKCS #11 function (e.g., C_Encrypt ( . . . )).

The signed transaction data and/or the encrypted third master private key share may be returned at 14229. In one implementation, the transferable data (e.g., the signed transaction data and/or the encrypted third master private key share) may be an output of the hot SFTS API call.

FIG. 143 shows a logic flow diagram illustrating embodiments of an offline transaction server transaction signing (FTSTS) component for the SOCOACT. In FIG. 143, a transaction signing request may be obtained at 14301. For example, the transaction signing request may be obtained as a result of a user utilizing a UI of an offline transaction signing runtime to request that a transaction (e.g., a fund transfer EOA transaction on Ethereum blockchain) be signed using transferable data from an external storage device (e.g., a USB drive inserted by the user).

The transferable data associated with the transaction may be copied from the external storage device at 14305. For example, the transferable data may include an encrypted third master private key share and transaction data signed by a hot HSM.

An encrypted second master private key share (e.g., for a wallet associated with the transaction) may be requested from a second cold HSM at 14309. In one implementation, a master key share request message may be sent to the second cold HSM to request the second master private key share encrypted with an RSA public key that corresponds to the RSA private key stored in tamper-proof storage of a first cold HSM. It is to be understood that, depending on the number of key shares used to reconstruct a full master private key, any number (e.g., none, one, multiple) of second cold HSMs may be utilized in this manner to obtain second master private key shares (e.g., if five key shares are used, three key shares from three second cold HSMs may be utilized in addition to a key share from the hot HSM and a key share from a first cold HSM).

A determination may be made at 14313 whether the request for the encrypted second master private key share is authorized. In one implementation, one or more operators (e.g., based on M-of-N authentication) may have to approve (e.g., via an authentication entry device associated with the second cold HSM) the request to export the encrypted second master private key share from the second cold HSM for the request to be authorized.

If the request for the encrypted second master private key share is not authorized, an error message may be generated at 14317. For example, the error message may specify the error that occurred (e.g., request to export the encrypted second master private key share from the second cold HSM is not authorized). A warning message may be provided to the user and/or an action may be triggered at 14321. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with the wallet. In another example, the triggered action may be to invalidate the master key and to generate a new master key.

If the request for the encrypted second master private key share is authorized, transaction signing may be requested from the first cold HSM at 14325. In one implementation, a transaction signing request message may be sent to the first cold HSM to request transaction signing.

The signed transaction (e.g., the transaction signature) may be copied to an external storage device at 14329. In one implementation, the signed transaction may be utilized by the NTSTS component to provide a transaction signing response.

FIG. 144 shows a logic flow diagram illustrating embodiments of a cold secure firmware transaction signing (CSFTS) component for the SOCOACT. In FIG. 144, a cold SFTS API call may be obtained at 14401. For example, the cold SFTS API call may be obtained as a result of a call from a first cold HSM associated with the CSFTS component. It is to be understood that although the CSFTS component is described with regard to an API method to sign a transaction (e.g., signMessageHash), in some embodiment, a variety of API methods may be available. In one embodiment, the following API methods may be available to the first cold HSM and/or to an offline TSS:

```
signMessageHash - this method receives a message hash, a keychain path and a
handle to the transient object containing a second master private key share (e.g.,
encrypted), and returns an ECDSA signature value. Seed reconstruction from shares
and key derivation steps are implemented by the CSFTS component. Temporary keys
generated for signing are wiped out of the device once the signing process is
complete.
  Input:
    256-bit hash value to be signed
    keychain path to be used for Bip32 key derivation
    handle to the transient object containing a second master private key
share (e.g., encrypted)
  Output:
    ECDSA signature in DER format
```

Encrypted master private key shares utilized to recover a master private key may be determined at 14405. For example, the encrypted master private key shares may include an encrypted second master private key share (e.g., from a second cold HSM) and an encrypted third master private key share (e.g., from a paired hot HSM). In one implementation, the encrypted master private key shares may be provided as input parameters in the cold SFTS API call.

A determination may be made at 14409 whether the encrypted master private key shares are decryptable. In one implementation, this determination may be made by checking whether decrypting the encrypted master private key shares using a private key decryption key stored in tamper-proof storage of the first cold HSM results in valid objects.

If the encrypted master private key shares are not decryptable, an error message may be generated at 14413. For example, the error message may specify the error that occurred (e.g., master private key shares are not decryptable). A warning message may be provided to a user and/or an action may be triggered at 14417. In one implementation, a warning message based on the generated error message may be provided to the user (e.g., via the offline TSS) to inform the user regarding the error. In another implementation, an action may be triggered based on a specified condition (e.g., non-decryptable master private key shares obtained three times). For example, the triggered action may be to erase data associated with an associated wallet. In another example, the triggered action may be to invalidate the master key associated with the master private key shares and to generate a new master key.

If the encrypted master private key shares are decryptable, the encrypted master private key shares may be decrypted using the private key decryption key at 14421. For example, the private key decryption key may be an RSA private key that corresponds to the RSA public key provided to other HSMs. In one implementation, the RSA private key may be determined using a PKCS #11 function (e.g., C_FindObjectsInit( . . . )). In another implementation, the RSA private key may be determined via an internal call on a HSM environment setting configured externally at HSM deployment time. In an alternative implementation, the RSA private key may be determined via a MySQL database command (e.g., retrieved from a MySQL database in tamper-proof storage). In another alternative implementation, the RSA private key may be generated dynamically (e.g., each time transaction signing is executed) and provided to other HSMs using public key request and public key response messages. In one implementation, the encrypted master private key shares may be decrypted using a PKCS #11 function (e.g., C_Decrypt( . . . )).

A first master private key share may be retrieved at 14425. In one implementation, the first master private key share may be determined using a PKCS #11 function (e.g., C_FindObjectsInit( . . . )). In another implementation, the first master private key share may be determined via an internal call on a HSM environment setting configured externally at HSM deployment time. In an alternative implementation, the first master private key share may be determined via a MySQL database command (e.g., retrieved from a MySQL database in tamper-proof storage).

A master private key may be determined from master private key shares (e.g., from the first master private key share, the second master private key share and the third master private key share) at 14429. In one embodiment, a method such as Shamir's Secret Sharing may be utilized to recover the master private key from the master private key shares. See FIG. 127 for additional details regarding utilizing Shamir's Secret Sharing.

Transaction data may be determined at 14433. In one implementation, the transaction data may be provided in the cold SFTS API call and may include a wallet identifier, a transaction identifier, a transaction hash, a keychain path, and/or the like.

A determination may be made at 14437 whether the transaction data is valid. In one embodiment, this determination may be made by checking whether the transaction data has a valid signature from the paired hot HSM. For example, checking the signature facilitates verifying that the transaction data was provided by the paired hot HSM. In one implementation, the signature may be verified using a PKCS #11 function (e.g., C_Verify( . . . )).

If the signature is invalid, an error message may be generated at 14413. For example, the error message may specify the error that occurred (e.g., transaction data signature is invalid). A warning message may be provided to a user and/or an action may be triggered at 14417. In one implementation, a warning message based on the generated error message may be provided to the user (e.g., via the offline TSS) to inform the user regarding the error. In another implementation, an action may be triggered based on a specified condition (e.g., transaction data with invalid signature obtained three times). For example, the triggered action may be to erase data associated with an associated wallet. In another example, the triggered action may be to invalidate the master key associated with the master private key shares and to generate a new master key.

If the signature is valid, a signing private key for the specified keychain path may be generated using the determined master private key at 14441. In one implementation, the signing private key may be generated in accordance with a deterministic key derivation procedure as described in Bip32. The transaction may be signed at 14445. In one implementation, the generated signing private key may be used to sign the transaction hash in accordance with the hashing algorithm utilized by the Ethereum protocol (e.g., KECCAK256(RLP(message))). For example, the transaction may be signed using a Keccak hash function of a recursive length prefix (RLP) of the message.

Temporary private key data may be wiped from memory at 14449. In one implementation, the second master private key share obtained from the second cold HSM, the third master private key share obtained from the paired hot HSM, the determined master private key, and/or the generated signing private key may be wiped from memory of the first cold HSM associated with the CSFTS component. The signed transaction may be returned at 14453. In one implementation, the ECDSA signature in DER format may be returned.

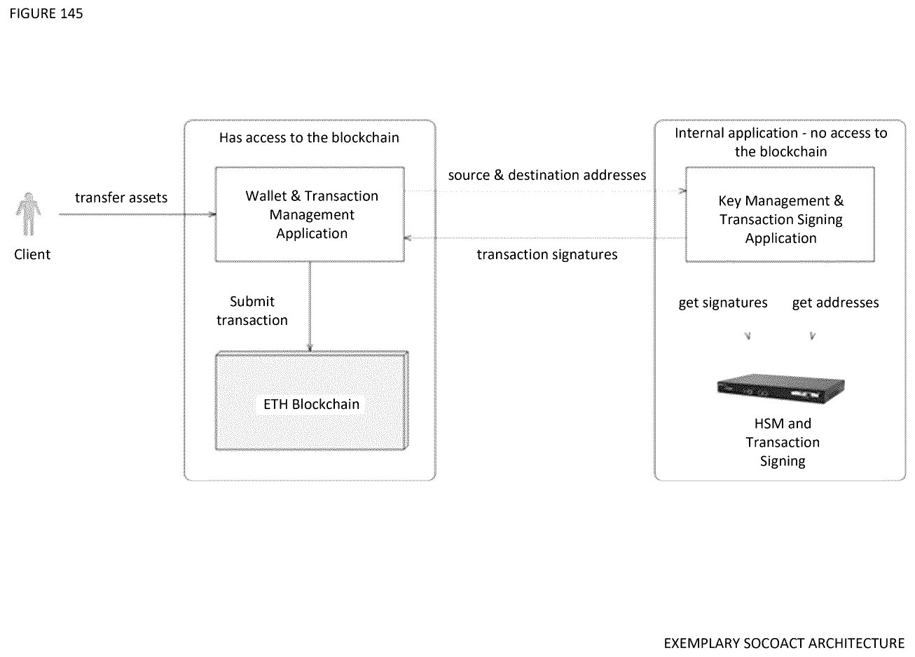

FIG. 145 shows non-limiting, example embodiments of an architecture for the SOCOACT. In FIG. 145, an embodiment of how a wallet & transaction management application and a key management & transaction signing application may be utilized to facilitate validation of wallet addresses participating in blockchain transactions is illustrated.

Multi-signature (multisig or m-sig) wallets are used to protect digital assets by enforcing a certain minimum number of signatures from authorized parties for enabling sensitive operations (e.g., transfer of assets, withdrawal of funds, etc.). For example, in a 3-of-5 m-sig wallet at least three holders of wallet-controlling key pairs (owners) must submit their signatures in order to authorize spending transactions.

There is no native multi-signature support built in Ethereum specification and this functionality requires custom implementation using smart contracts (or simply contracts). Further, there is no built-in dependency among wallets' addresses and their owners' key pairs. This dependency, however, can play a significant security control role in systems where wallet management and key management systems are segregated and a key management system uses a FIPS compliant HSM to store wallet keys for transaction signing and address generation. In one embodiment, wallet addresses and transaction compositions are being managed by the Wallet & Transaction Management application and submitted to the Key Management & Transaction Signing application for signing asset movement transactions (e.g., movement of funds from a source to a destination wallet). If any such address, maintained by the Wallet & Transaction Management application, is tampered with, corrupted, or substituted with a malicious one without additional controls, Key Management & Transaction Signing application cannot detect this and may sign a malicious or erroneous transaction resulting in a theft or loss of assets. If, however, participating wallet addresses are dependent on the key materials that are controlled by the Key Management & Transaction Signing application, the latter may be able to validate submitted addresses before generating transaction signatures.

In one embodiment, the SOCOACT may include a deployment procedure of Ethereum multi-signature smart contracts that creates a dependency among addresses of deployed contracts and their owners' public keys, and a verification procedure of proving the legitimacy of wallet addresses owned by the parties controlling owners' key pairs.

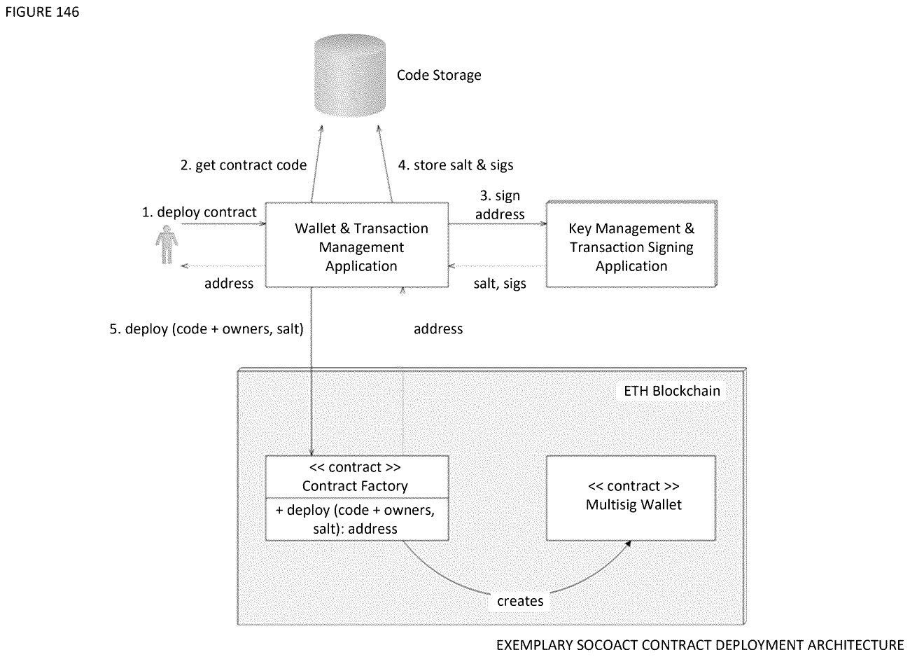

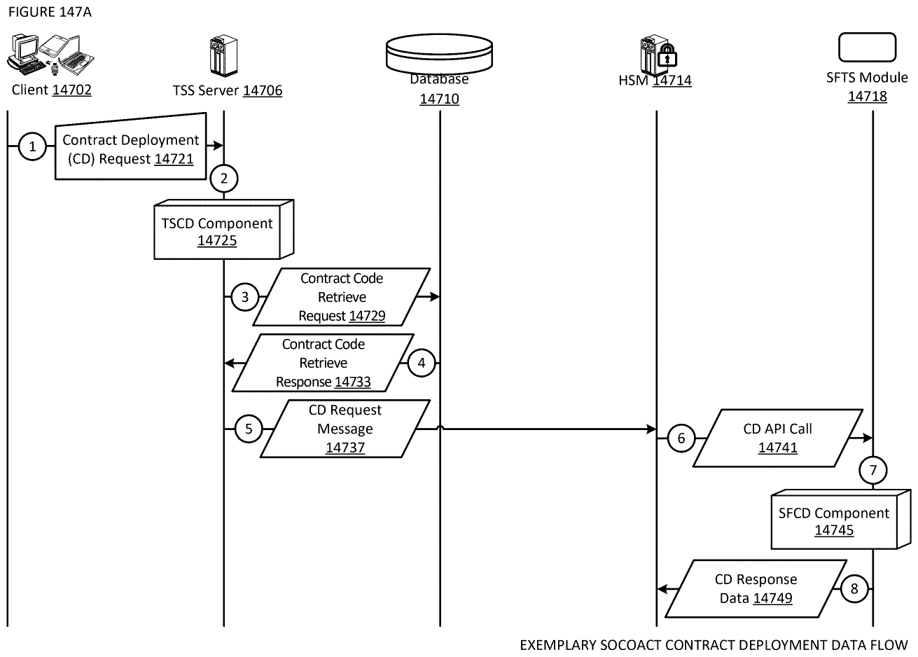

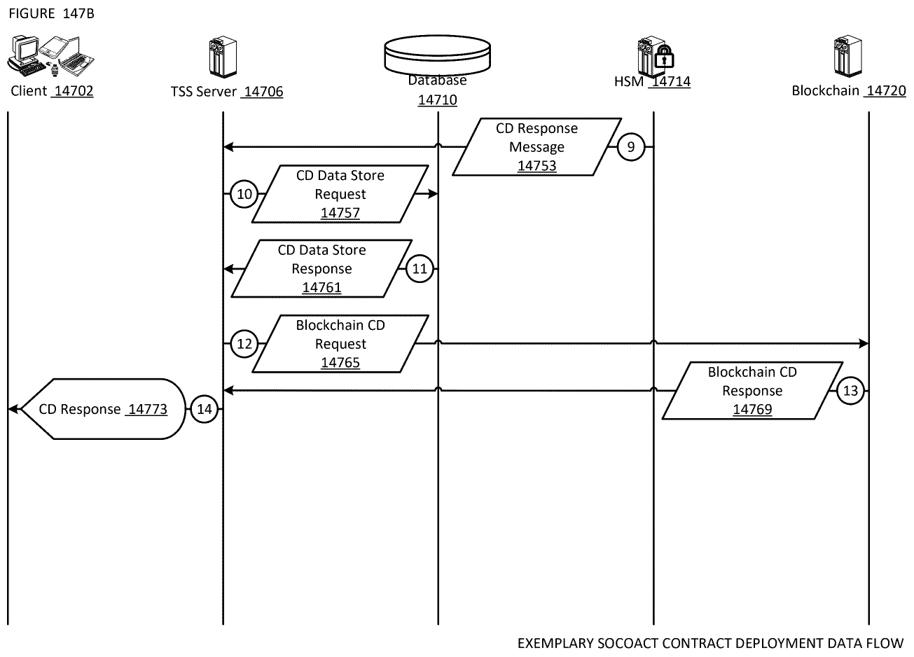

FIG. 146 shows non-limiting, example embodiments of a contract deployment architecture for the SOCOACT. In FIG. 146, an embodiment of a deployment procedure of Ethereum multi-signature smart contracts that creates a dependency among addresses of deployed contracts and their owners' public keys is illustrated.

Ethereum specification provides a method, proposed in Ethereum Improvement Protocol (EIP) EIP-1014, to deploy smart contracts and obtain their addresses, where deployment request is being sent as a functional call to an instance of the specialized contract, called Contract Factory, and the address of deployed contract is calculated as a function of the Contract Factory's address, bytecode of the contract being deployed and a one-time 32-byte salt value. Addresses calculated this way do not have any dependency on the keys that actually control the deployed contracts.

In one embodiment, the SOCOACT may implement the following deployment procedure to create a dependency among addresses of deployed contracts and their owners' public keys for multi-signature wallet deployment based on EIP-1014 method:
1166.1. For each owner's controlling key pair, generate an EOA address (owner address) from the pair's public key.
1166.2. Make a list of owner addresses an input parameter to the constructor method of the contract and append it to the contract's bytecode.
1166.3. Address of the deployed contract becomes a function of the contract's bytecode and the full list of owners' addresses and can be calculated in advance as follows:

An EIP-1014 address = last 20 bytes of the Keccak-256 (SHA-3) hash of the
concatenated list of deployment factory's address, salt and Keccak-256 hash of
contract's bytecode including constructor parameters - all prefixed with 0xFF
byte:

| | |
|---|---|
| • | Factory address: 0x4949d05Cb64224BA4DC94D6A1776455C37c63F53 |
| • | Salt: 0x000000000000000000000000000000000000000000000000000000000000208A |
| • | Contract's bytecode (including constructor parameters): |
| | 608060405260405161081...30005100032 |
| • | Minimum number of signatures, necessary to unlock funds: 2 |
| • | Owner's address 1: 0x788fd5e1f7b444ea36963e1c08261a7188049f6f |
| • | Owner's address 2: 0xe82e2d50f58521aea63c87b25173cdb5b9455551 |
| • | Owner's address 3: 0xee995c9ded9311a58373d52cfed87d965925f400 |
| ⇒ | Concatenated list: |
| | FF 4949d05Cb64224BA4DC94D6A1776455C37c63F53 208A |
| | Keccak-256(608060405260405161081...2...788fd5e1f7b444ea36963e1c08261a7188049f6f |
| | e82e2d50f58521aea63c87b25173cdb5b9455551 |
| | ee995c9ded9311a58373d52cfed87d965925f400) |
| ⇒ | Keccak-256 of concatenated list: |
| | CC51A85DE52745986D4F95924DBBA4673520EC3D921818A72D18D8E3C100C824 |
| ⇒ | EIP-1014 address = last 20 bytes: |
| | 0x4Dbba4673520eC3D921818a72d18D8e3C100C824 |

1166.4. Sign this address using the private keys, corresponding to owner's addresses. For the signing procedure, submit the bytecode and Contract Factory's address, as well as identification parameters of the owners' keys. Signing component may:
   1166.4.1. Generate a one-time 32-byte salt value.
   1166.4.2. Generate owner addresses from the key identification parameters.
   1166.4.3. Append generated owner addresses to the contract's bytecode and calculate the addresses of the contract after the deployment.
   1166.4.4. Append calculated address and the same 32-byte salt, hash the result and sign it with one of owners' private keys.
   1166.4.5. Repeat the signing procedure for each signing node each time verifying previously generated signatures and reusing the same salt value, generated for the first signature.

Addresses of contracts deployed this way may be calculated in advance and “parked” for security and/or other purposes (e.g., turning on monitoring for contract's events ahead of its deployment, etc.).

FIGS. 147A-B show non-limiting, example embodiments of a datagraph illustrating data flow(s) for the SOCOACT. In FIGS. 147A-B, a client 14702 (e.g., of a user) may send a contract deployment (CD) request 14721 to a TSS server 14706 to request deployment of a smart contract (e.g., an Ethereum multi-signature smart contract with a dependency between the address of the deployed contract and the owners' public keys). For example, the client may be a desktop, a laptop, a tablet, a smartphone, a smartwatch, and/or the like that is executing a client application. In one implementation, the contract deployment request may include data such as a request identifier, user authentication data, a request type (e.g., deploy contract), contract parameters (e.g., contract identifier, M-of-N, owners), and/or the like. In one embodiment, the client may provide the following example contract deployment request, substantially in the form of a HTTP(S) POST message including XML-formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</account_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <contract_deployment_request>
    <request_identifier>ID_request_51</request_identifier>
    <request_type>DEPLOY_CONTRACT</request_type>
    <contract_parameters>
      <contract_identifier>ID_contract_51</contract_identifier>
      <M_of_N>2-of-3</M_of_N>
      <owner>
        <owner_identifier>ID_user_1</owner_identifier>
  <keyset_identifier>ID_master_key_pair_1</keyset_identifier>
        <keychain_path>m/0/0/1/0</keychain_path>
      </owner>
      <owner>
        <owner_identifier>ID_user_2</owner_identifier>
  <keyset_identifier>ID_master_key_pair_2</keyset_identifier>
        <keychain_path>m/0/0/1/0</keychain_path>
      </owner>
      <owner>
        <owner_identifier>ID_user_3</owner_identifier>
  <keyset_identifier>ID_master_key_pair_3</keyset_identifier>
        <keychain_path>m/0/0/1/0</keychain_path>
      </owner>
    </contract_parameters>
  </contract_deployment_request>
</auth_request>
```

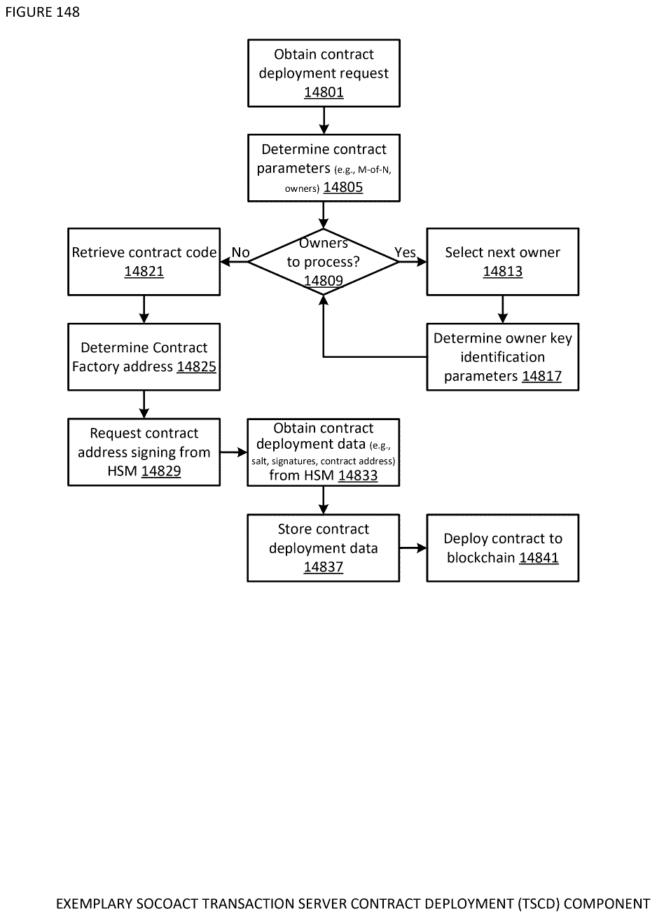

A TSCD component 14725 may utilize data provided in the contract deployment request to facilitate contract deployment. See FIG. 148 for additional details regarding the TSCD component.

The TSS server 14706 may send a contract code retrieve request 14729 to a database 14710 to retrieve the contract's code (e.g., bytecode (e.g., including constructor parameters)). In one implementation, the contract code retrieve request may include data such as a request identifier, a contract identifier, and/or the like. In one embodiment, the TSS server may provide the following example contract code retrieve request, substantially in the form of a HTTP(S) POST message including XML-formatted data, as provided below:

```
POST /contract_code_retrieve_request.php HTTP/1.1
Host: www.server.com
Content-Type: Application/XML
Content-Length: 667
<?XML version = “1.0” encoding = “UTF-8”?>
<contract_code_retrieve_request>
  <request_identifier>ID_request_52</request_identifier>
  <contract_identifier>ID_contract_51</contract_identifier>
</contract_code_retrieve_request>
```

The database 14710 may send a contract code retrieve response 14733 to the TSS server 14706 with the requested contract code. In one implementation, the contract code retrieve response may include data such as a response identifier, the requested contract code, and/or the like. In one embodiment, the database may provide the following example contract code retrieve response, substantially in the form of a HTTP(S) POST message including XML-formatted data, as provided below:

```
POST /contract_code_retrieve_response.php HTTP/1.1
Host: www.server.com
Content-Type: Application/XML
Content-Length: 667
<?XML version = “1.0” encoding = “UTF-8”?>
<contract_code_retrieve_response>
  <response_identifier>ID_response_52</response_identifier>
  <bytecode>608060405260405161081...30005100032</bytecode>
</contract_code_retrieve_response>
```

The TSS server 14706 may send a CD request message 14737 to a HSM 14714 to request that the HSM sign the contract and/or provide contract deployment data. In one implementation, the CD request message may include data such as a request identifier, a request type (e.g., deploy contract), contract parameters (e.g., contract identifier, M-of-N, owners), contract code, contract factory address, and/or the like. In one embodiment, the TSS server may provide the following example CD request message, substantially in the form of a HTTP(S) POST message including XML-formatted data, as provided below:

```
POST /CD_request_message.php HTTP/1.1
Host: www.server.com
Content-Type: Application/XML
Content-Length: 667
<?XML version = “1.0” encoding = “UTF-8”?>
<CD_request_message>
  <request_identifier>ID_request_53</request_identifier>
  <request_type>DEPLOY_CONTRACT</request_type>
  <contract_parameters>
    <contract_identifier>ID_contract_51</contract_identifier>
    <M_of_N>2-of-3</M_of_N>
    <owner>
      <owner_identifier>ID_user_1</owner_identifier>
      <keyset_identifier>ID_master_key_pair_1</keyset_identifier>
      <keychain_path>m/0/0/1/0</keychain_path>
    </owner>
    <owner>
      <owner_identifier>ID_user_2</owner_identifier>
      <keyset_identifier>ID_master_key_pair_2</keyset_identifier>
      <keychain_path>m/0/0/1/0</keychain_path>
    </owner>
    <owner>
      <owner_identifier>ID_user_3</owner_identifier>
      <keyset_identifier>ID_master_key_pair_3</keyset_identifier>
      <keychain_path>m/0/0/1/0</keychain_path>
    </owner>
  </contract_parameters>
  <bytecode>608060405260405161081...30005100032</bytecode>
  <contract_factory_address>
    0x4949d05Cb64224BA4DC94D6A1776455C37c63F53
  </contract_factory_address>
</CD_request_message>
```

The HSM 14714 may send a CD API call 14741 to a SFTS module 14718 to request that the SFTS module sign the contract and/or provide contract deployment data. In one implementation, the CD API call may include data such as a request identifier, a request type (e.g., deploy contract), contract parameters (e.g., contract identifier, M-of-N, owners), contract code, contract factory address, and/or the like.

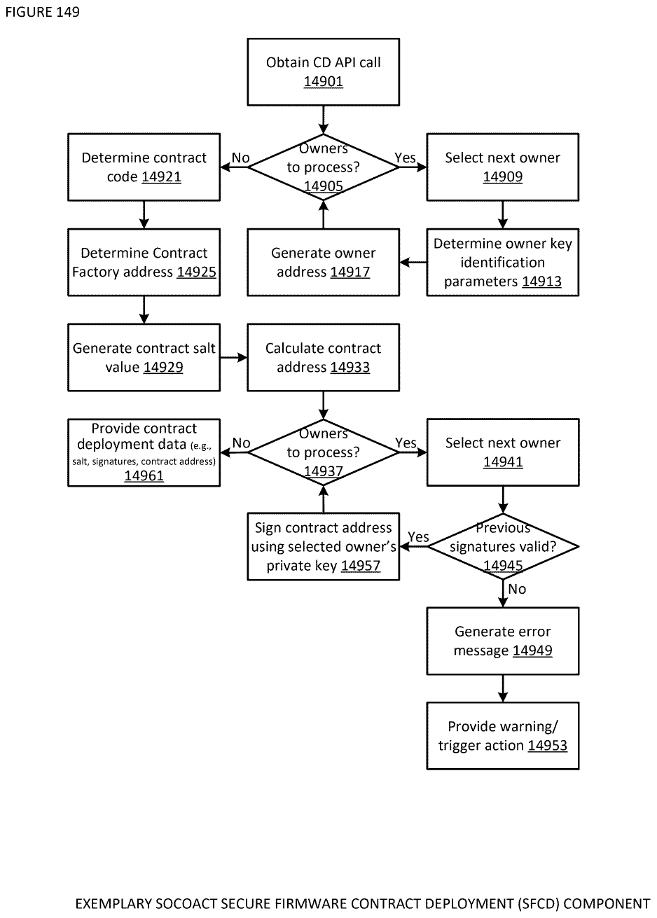

Data provided in the CD API call may be used by a SFCD component 14745 to calculate a contract address (e.g., based on owners' addresses) and to sign the contract (e.g., to generate ECDSA signatures in DER format). See FIG. 149 for additional details regarding the SFCD component.

The SFTS module 14718 may send CD response data 14749 to the HSM 14714 in response to the CD API call. In one implementation, the CD response data may include owners' ECDSA signatures in DER format, a salt value, the contract address, and/or the like.

The HSM 14714 may send a CD response message 14753 to the TSS server 14706 (e.g., via a HSM Access Provider). In one implementation, the CD response message may include data such as a response identifier, contract deployment data, and/or the like. In one embodiment, the HSM may provide the following example CD response message, substantially in the form of a HTTP(S) POST message including XML-formatted data, as provided below:

```
POST /CD_response_message.php HTTP/1.1
Host: www.server.com
Content-Type: Application/XML
Content-Length: 667
<?XML version = “1.0” encoding = “UTF-8”?>
<CD_response_message>
  <response_identifier>ID_response_53</response_identifier>
  <contract_deployment_data>
    <contract_identifier>ID_contract_51</contract_identifier>
    <contract_deployment_signature>
      ECDSA signature in DER format of ID_user_1
    </contract_deployment_signature>
    <contract_deployment_signature>
      ECDSA signature in DER format of ID_user_2
    </contract_deployment_signature>
    <contract_deployment_signature>
      ECDSA signature in DER format of ID_user_3
    </contract_deployment_signature>
    <salt_value>
  0x000000000000000000000000000000000000000000000000000000000000208A
    </salt_value>
    <contract_address>
      0x4Dbba4673520eC3D921818a72d18D8e3C100C824
    </contract_address>
  </contract_deployment_data>
</CD_response_message>
```

The TSS server 14706 may send a CD data store request 14757 to the database 14710 to store the contract's contract deployment data. In one implementation, the CD data store request may include data such as a request identifier, contract deployment data, and/or the like. In one embodiment, the TSS server may provide the following example CD data store request, substantially in the form of a HTTP(S) POST message including XML-formatted data, as provided below:

```
POST /CD_data_store_request.php HTTP/1.1
Host: www.server.com
Content-Type: Application/XML
Content-Length: 667
<?XML version = “1.0” encoding = “UTF-8”?>
<CD_data_store_request>
  <request_identifier>ID_request_55</request_identifier>
  <contract_deployment_data>
    <contract_identifier>ID_contract_51</contract_identifier>
    <contract_deployment_signature>
      ECDSA signature in DER format of ID_user_1
    </contract_deployment_signature>
    <contract_deployment_signature>
      ECDSA signature in DER format of ID_user_2
    </contract_deployment_signature>
    <contract_deployment_signature>
      ECDSA signature in DER format of ID_user_3
    </contract_deployment_signature>
    <salt_value>
  0x000000000000000000000000000000000000000000000000000000000000208A
    </salt_value>
    <contract_address>
      0x4Dbba4673520eC3D921818a72d18D8e3C100C824
    </contract_address>
  </contract_deployment_data>
</CD_data_store_request>
```

The database 14710 may send a CD data store response 14761 to the TSS server 14706 to confirm that the contract's contract deployment data was stored successfully. In one implementation, the CD data store response may include data such as a response identifier, a status, and/or the like. In one embodiment, the database may provide the following example CD data store response, substantially in the form of a HTTP(S) POST message including XML-formatted data, as provided below:

```
POST /CD_data_store_response.php HTTP/1.1
Host: www.server.com
Content-Type: Application/XML
Content-Length: 667
<?XML version = “1.0” encoding = “UTF-8”?>
<CD_data_store_response>
  <response_identifier>ID_response_55</response_identifier>
  <status>OK</status>
</CD_data_store_response>
```

The TSS server 14706 may send a blockchain CD request 14765 to a blockchain 14720 to deploy the contract on the blockchain (e.g., Ethereum). In one implementation, the blockchain CD request may include data such as a request identifier, contract code (e.g., bytecode including owners' addresses), a salt value, and/or the like. In one embodiment, the TSS server may provide the following example blockchain CD request, substantially in the form of a HTTP(S) POST message including XML-formatted data, as provided below:

```
POST /blockchain_CD_request.php HTTP/1.1
Host: www.server.com
Content-Type: Application/XML
Content-Length: 667
<?XML version = “1.0” encoding = “UTF-8”?>
<blockchain_CD_request>
  <request_identifier>ID_request_56</request_identifier>
  <bytecode>
    608060405260405161081...2...788fd5e1f7b444ea36963e1c08261a7188049f6f
    e82e2d50f58521aea63c87b25173cdb5b9455551
    ee995c9ded9311a58373d52cfed87d965925f400
  </bytecode>
  <salt_value>
    0x000000000000000000000000000000000000000000000000000000000000208A
  </salt_value>
</blockchain_CD_request>
```

The blockchain 14720 may send a blockchain CD response 14769 to the TSS server 14706 to confirm that the contract was deployed. In one implementation, the blockchain CD response may include data such as a response identifier, a status, a contract address, additional blockchain data (e.g., block hash, gas used), and/or the like. In one embodiment, the blockchain may provide the following example blockchain CD response, substantially in the form of a HTTP(S) POST message including XML-formatted data, as provided below:

```
POST /blockchain_CD_response.php HTTP/1.1
Host: www.server.com
Content-Type: Application/XML
Content-Length: 667
<?XML version = “1.0” encoding = “UTF-8”?>
<blockchain_CD_response>
  <response_identifier>ID_response_56</response_identifier>
  <status>OK</status>
  <contract_address>
    0x4Dbba4673520eC3D921818a72d18D8e3C100C824
  </contract_address>
  ...
</blockchain_CD_response>
```

The TSS server 14706 may send a CD response 14773 to the client 14702 (e.g., to provide the user with the address of the deployed smart contract). In one implementation, the CD response may include data such as a response identifier, a status, a contract address, and/or the like. In one embodiment, the TSS server may provide the following example CD response, substantially in the form of a HTTP(S) POST message including XML-formatted data, as provided below:

```
POST /CD_response.php HTTP/1.1
Host: www.server.com
Content-Type: Application/XML
Content-Length: 667
<?XML version = “1.0” encoding = “UTF-8”?>
<CD_response>
  <response_identifier>ID_response_51</response_identifier>
  <status>OK</status>
  <contract_address>
    0x4Dbba4673520eC3D921818a72d18D8e3C100C824
  </contract_address>
</CD_response>
```

FIG. 148 shows non-limiting, example embodiments of a logic flow illustrating a transaction server contract deployment (TSCD) component for the SOCOACT. In FIG. 148, a contract deployment request may be obtained at 14801. For example, the contract deployment request may be obtained as a result of a user utilizing SOCOACT UI to request deployment of a smart contract (e.g., an Ethereum multi-signature smart contract with a dependency between the address of the deployed contract and the owners' public keys).

Contract parameters of the smart contract associated with the contract deployment request may be determined at 14805. For example, contract parameters may include a contract identifier, an M-of-N configuration, a set of owner datastructures, and/or the like. In one implementation, the contract deployment request may be parsed (e.g., using PHP commands) to determine the contract parameters (e.g., based on the value of the contract_parameters field).

A determination may be made at 14809 whether there remain owner datastructures to process. In one implementation, each of the owner datastructures specified in the contract parameters may be processed. If there remain owner datastructures to process, the next owner datastructure may be selected for processing at 14813.

Owner key identification parameters associated with the selected owner datastructure may be determined at 14817. For example, owner key identification parameters may include an owner identifier, a keyset identifier, a wallet type, a keychain path, and/or the like. In one implementation, the selected owner datastructure may be parsed (e.g., using PHP commands) to determine the owner key identification parameters (e.g., based on the values of the owner_identifier, keyset_identifier, keychain_path fields).

Contract code of the smart contract associated with the contract deployment request may be retrieved at 14821. In one embodiment, the contract code may be the bytecode of the smart contract. In one implementation, the contract code may be retrieved from the contracts database table 17319s. For example, the contract code may be retrieved via a MySQL database command similar to the following:

SELECT contractCode
FROM Contracts
WHERE contractID = ID_contract_51;

A deployment factory (e.g., Contract Factory) address may be determined at 14825. In one embodiment, the deployment factory (e.g., Contract Factory) may be a specialized smart contract utilized to facilitate deployment of smart contracts (e.g., to the Ethereum blockchain). In one implementation, a blockchain address of the deployment factory associated with a TSS server executing the TSCD component may be determined.

Contract address signing for the smart contract associated with the contract deployment request may be requested from an HSM at 14829. In one implementation, a contract deployment (CD) request message may be sent to the HSM to request contract address signing. For example, the CD request message may include the determined owner key identification parameters, contract code, deployment factory address, and/or the like.

Contract deployment data for the smart contract associated with the contract deployment request may be obtained from the HSM at 14833. For example, contract deployment data may include a salt (e.g., a 32-byte salt value), a set of contract deployment signatures (e.g., by the owners specified in the owner datastructures), a set of owner addresses (e.g., generated by the HSM based on the owner key identification parameters), a contract address, and/or the like. In one implementation, the contract deployment data may be obtained via a CD response message. It is to be understood that the combination of two different sets of parameters, bytecode and list of addresses, creates a wallet, controlled by specific owners. Adding a salt value during the deployment creates a unique address for such a wallet. Thus, different salt values for the same combination of bytecode and owners' addresses create different wallets for the same owners, which may be utilized for splitting funds, upgrading wallets, and/or the like.

The contract deployment data may be stored at 14837. In one implementation, the contract deployment data may be stored in the contracts database table 17319s. For example, the contract deployment data may be stored via a MySQL database command similar to the following:

```
UPDATE Contracts
SET contractSalt =
  “0x000000000000000000000000000000000000000000000000000000000000208A”,
  contractDeploymentSignatures =
    “ECDSA signature in DER format of ID_user_1
    ECDSA signature in DER format of ID_user_2
    ECDSA signature in DER format of ID_user_3”,
  contractOwnerAddresses = “
    Owner's address 1: 0x788fd5e1f7b444ea36963e1c08261a7188049f6f
    Owner's address 2: 0xe82e2d50f58521aea63c87b25173cdb5b9455551
    Owner's address 3: 0xee995c9ded9311a58373d52cfed87d965925f400”,
  contractAddress = “0x4Dbba4673520eC3D921818a72d18D8e3C100C824”
WHERE contractID = ID_contract_51;
```

The smart contract associated with the contract deployment request may be deployed to the blockchain at 14841. In one implementation, a deploy method of the deployment factory may be utilized to deploy the smart contract. For example, the bytecode of the smart contract (e.g., including the set of owner addresses as part of the constructor parameters) and the salt may be provided to the deploy method.

FIG. 149 shows non-limiting, example embodiments of a logic flow illustrating a secure firmware contract deployment (SFCD) component for the SOCOACT. In FIG. 149, a contract deployment (CD) API call associated with a smart contract may be obtained at 14901. For example, the CD API call may be obtained as a result of a call from a HSM associated with the SFCD component. It is to be understood that although the SFCD component is described with regard to an API method to sign a smart contract address (e.g.,/address/sign), in some embodiment, a variety of API methods may be available. In one embodiment, the following API methods (e.g., REST API endpoints) may be available to the HSM and/or to a TSS:

```
/address/sign - this API method receives a contract's bytecode, Contract Factory's
address, owners' identification parameters, and returns the future address of the
deployed contract along with an ECDSA signature value, created with one of the
owners' private keys.
  Input:
    contract's bytecode
    Contract Factory's address
    owners' identification parameters (e.g., keyset ID, wallet type,
keychain path for Bip-32 derivation)
  Output:
    address of the contract after the deployment
    32-byte salt value to be used both during the deployment and for the
validation of the address signature
    ECDSA signature in DER format
```

A determination may be made at 14905 whether there remain owner datastructures to process. In one implementation, each of the owner datastructures provided in the CD API call may be processed. If there remain owner datastructures to process, the next owner datastructure may be selected for processing at 14909.

Owner key identification parameters associated with the selected owner datastructure may be determined at 14913. For example, owner key identification parameters may include an owner identifier, a keyset identifier, a wallet type, a keychain path, and/or the like. In one implementation, the selected owner datastructure may be parsed (e.g., using PHP commands) to determine the owner key identification parameters (e.g., based on the values of the owner_identifier, keyset_identifier, keychain_path fields).

An owner address associated with the selected owner datastructure may be generated at 14917. In one implementation, the owner address may be generated using the owner key identification parameters associated with the selected owner datastructure as an EOA address per Bip32 data model. See FIG. 120B for additional details regarding generating owner addresses using the Bip32 data model. For example, the keyset identifier may correspond to a master key pair associated with the owner identifier, and the keychain path may be used to determine a public key that is used to generate the owner address (e.g., last 20 bytes of the Keccak-256 (SHA-3) hash of the public key). In one embodiment, a keyset identifier is a unique number, identifying a keyset: logical aggregation of master seeds (e.g., 64-byte numbers). In one embodiment, a wallet type is a subgroup of seeds within a keyset (e.g., no seed should belong to more than one wallet type). In one embodiment, the number of seeds for a specific wallet type may be determined by the multi-signature configuration (e.g., a 2-of-3 wallet type should have three seeds). In one embodiment, from each seed, using a keychain path and BIP-32 spec, one can generate one public key and, consequently, one address. For example, if the wallet type contains three seeds, there are three independent addresses to be generated for the same keychain path, but from different seeds (e.g., a 2-of-3 wallet may have 3 owners' addresses for each combination of: keyset ID, wallet type, keychain path).

Contract code of the smart contract may be determined at 14921. In one embodiment, the contract code may be the bytecode of the smart contract. In one implementation, the contract code may be provided in the CD API call.

A deployment factory (e.g., Contract Factory) address associated with the smart contract may be determined at 14925. In one embodiment, the deployment factory address may be a blockchain address of a deployment factory smart contract on the Ethereum blockchain. In one implementation, the deployment factory address may be provided in the CD API call.

A salt value for the smart contract may be generated at 14929. For example, a one-time 32-byte salt value may be generated. In one implementation, a random or (e.g., cryptographically secure) pseudorandom number generator may be utilized to generate the salt value.

A contract address for the smart contract may be calculated at 14933. In one embodiment, the contract address may be calculated in a way that creates a dependency between the contract address and the owners' public keys. In one implementation, the contract address may be calculated as an EIP-1014 address that is equal to the last 20 bytes of the Keccak-256 (SHA-3) hash of the concatenated list of the deployment factory address, the salt value, and Keccak-256 hash of the smart contract's bytecode including the generated owner addresses as constructor parameters-all prefixed with 0xFF byte. See FIG. 146 for additional details regarding calculating an EIP-1014 address.

A determination may be made at 14937 whether there remain owner datastructures to process. In one implementation, each of the owner datastructures provided in the CD API call may be processed. If there remain owner datastructures to process, the next owner datastructure may be selected for processing at 14941.

A determination may be made at 14945 whether previously generated contract deployment signatures (e.g., if any) used to sign the contract address for the smart contract are valid. If any of the previously generated signatures is invalid, an error message may be generated at 14949. For example, the error message may specify the error that occurred (e.g., a previously generated signature is invalid). A warning message may be provided to a user and/or an action may be triggered at 14953. In one implementation, a warning message based on the generated error message may be provided to the user (e.g., via the TSS) to inform the user regarding the error. In another implementation, an action may be triggered based on a specified condition (e.g., invalid signature obtained three times). For example, the triggered action may be to erase data associated with an associated wallet.

If the previously generated contract deployment signatures are valid, the contract address for the smart contract may be signed using a private key associated with the selected owner datastructure that corresponds to the generated owner address associated with the selected owner datastructure at 14957. In one embodiment, the contract address and the salt value may be appended, the result hashed, and the hash signed using the private key to generate a contract deployment signature. In one implementation, the hash may be calculated in accordance with the hashing algorithm utilized by the Ethereum protocol (e.g., KECCAK256 (contract address+salt value)), and the hash may be signed using a PKCS #11 function (e.g., C_Sign( . . . )). It is to be understood that, in various implementations, different owners may utilize different HSMs (e.g., each HSM executing a separate SFCD component), the same HSM, combinations of HSMs, and/or the like to sign the contract address (e.g., reusing the same salt value by passing it among HSMs as a parameter).

Contract deployment data may be provided at 14961. For example, contract deployment data may include the salt value, the generated contract deployment signatures, the generated owner addresses, the contract address, and/or the like. In one implementation, the contract deployment data may be returned to the HSM as the output of the CD API call.

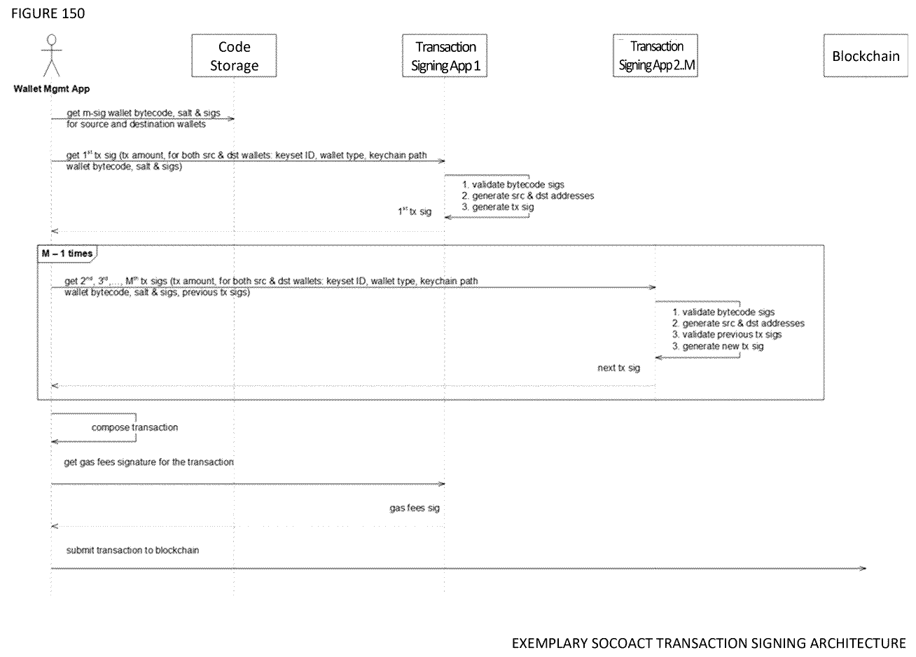

FIG. 150 shows non-limiting, example embodiments of a transaction signing architecture for the SOCOACT. In FIG. 150, an embodiment of a verification procedure of proving the legitimacy of wallet addresses owned by the parties controlling owners' key pairs is illustrated.

In one embodiment, in a fund transfer transaction moving funds from one contract (e.g., source wallet) to another (e.g., destination wallet), where either one or both are controlled by a company's own m-sig wallets, the source and/or destination contract addresses, generated as described above (e.g., with regard to FIGS. 145-149), may be securely and reliably generated during the transaction signing process. Instead of providing source and/or destination addresses of intra-wallet transactions to the Key Management & Transaction Signing application, which runs the risk of address tampering at the Wallet & Transaction Management application side, the wallet client provides wallet identification parameters in the signing request, for example:

Wallet identification parameters:
keyset ID
wallet type
keychain path
wallet address
wallet address signatures including salt value

Using these parameters, the Key Management & Transaction Signing application may verify that provided signatures match the owner's public keys, generated for keyset ID/wallet type/keychain path combinations, to validate the legitimacy of wallet addresses participating in the blockchain transaction before generating transaction signatures.

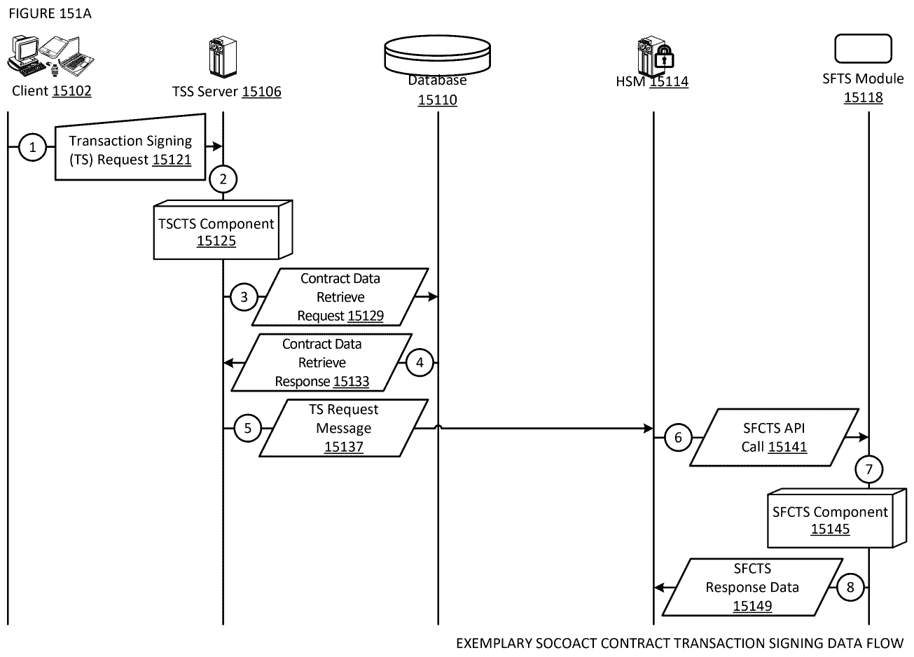

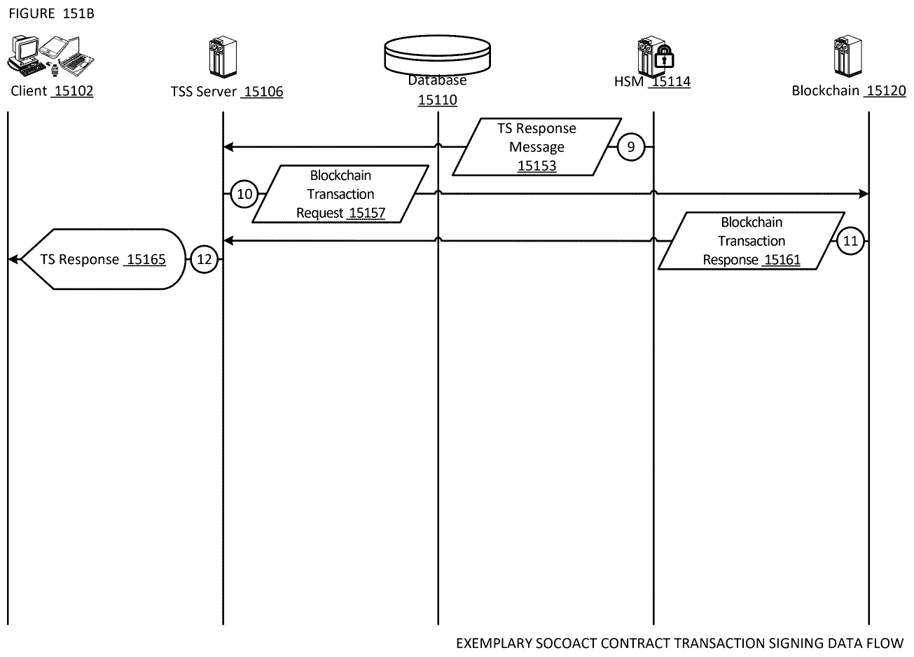

FIGS. 151A-B show non-limiting, example embodiments of a datagraph illustrating data flow(s) for the SOCOACT. In FIGS. 151A-B, a client 15102 (e.g., of a user) may send a transaction signing (TS) request 15121 to a TSS server 15106 to request that a transaction be signed. For example, the client may be a desktop, a laptop, a tablet, a smartphone, a smartwatch, and/or the like that is executing a client application. In one implementation, the TS request may include data such as a request identifier, a request type (e.g., sign transaction), a transaction identifier, transaction details, source wallet parameters, destination wallet parameters, and/or the like. In one embodiment, the client may provide the following example transaction signing (TS) request, substantially in the form of a HTTP(S) POST message including XML-formatted data, as provided below:

```
POST /TS_request.php HTTP/1.1
Host: www.server.com
Content-Type: Application/XML
Content-Length: 667
<?XML version = “1.0” encoding = “UTF-8”?>
<TS_request>
  <request_identifier>ID_request_61</request_identifier>
  <request_type>SIGN_TRANSACTION</request_type>
  <transaction_identifier>ID_transaction_61</transaction_identifier>
  <transaction_details>transaction amount, etc.</transaction_details>
  <source_wallet_parameters>
    <contract_identifier>ID_contract_51</contract_identifier>
    <M_of_N>2-of-3</M_of_N>
    <owner>
      <owner_identifier>ID_user_1</owner_identifier>
      <keyset_identifier>ID_master_key_pair_1</keyset_identifier>
      <keychain_path>m/0/0/1/0</keychain_path>
    </owner>
    <owner>
      <owner_identifier>ID_user_2</owner_identifier>
      <keyset_identifier>ID_master_key_pair_2</keyset_identifier>
      <keychain_path>m/0/0/1/0</keychain_path>
    </owner>
    <owner>
      <owner_identifier>ID_user_3</owner_identifier>
      <keyset_identifier>ID_master_key_pair_3</keyset_identifier>
      <keychain_path>m/0/0/1/0</keychain_path>
    </owner>
  </source_wallet_parameters>
  <destination_wallet_parameters>
    <contract_identifier>ID_contract_52</contract_identifier>
    <M_of_N>2-of-3</M_of_N>
    <owner>
      <owner_identifier>ID_user_11</owner_identifier>
      <keyset_identifier>ID_master_key_pair_11</keyset_identifier>
      <keychain_path>m/0/0/1/0</keychain_path>
    </owner>
    <owner>
      <owner_identifier>ID_user_12</owner_identifier>
      <keyset_identifier>ID_master_key_pair_12</keyset_identifier>
      <keychain_path>m/0/0/1/0</keychain_path>
    </owner>
    <owner>
      <owner_identifier>ID_user_13</owner_identifier>
      <keyset_identifier>ID_master_key_pair_13</keyset_identifier>
      <keychain_path>m/0/0/1/0</keychain_path>
    </owner>
  </destination_wallet_parameters>
</TS_request>
```

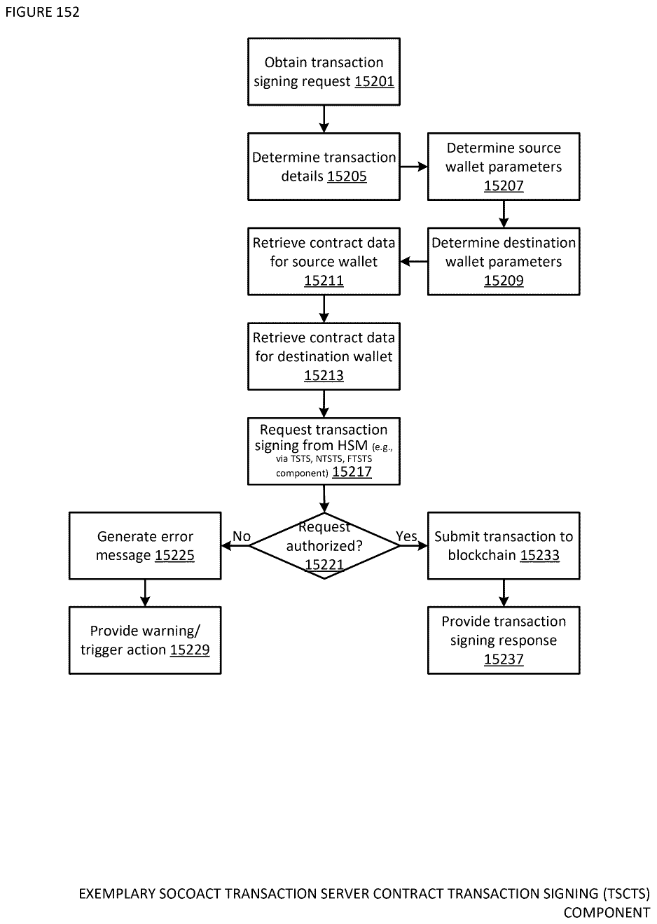

A TSCTS component 15125 may utilize parameters provided in the TS request to facilitate transaction signing. See FIG. 152 for additional details regarding the TSCTS component.

The TSS server 15106 may send a contract data retrieve request 15129 to a database 15110 to retrieve contract data for a source wallet and/or for a destination wallet. For example, separate contract data retrieve requests may be sent for the source wallet and for the destination wallet. In another example, a combined contract data retrieve request may be sent for both the source wallet and for the destination wallet. In one implementation, the contract data retrieve request may include data such as a request identifier, a contract identifier (e.g., a source wallet identifier, a destination wallet identifier), and/or the like. In one embodiment, the TSS server may provide the following example contract data retrieve request, substantially in the form of a HTTP(S) POST message including XML-formatted data, as provided below:

```
POST /contract_data_retrieve_request.php HTTP/1.1
Host: www.server.com
Content-Type: Application/XML
Content-Length: 667
<?XML version = “1.0” encoding = “UTF-8”?>
<contract_data_retrieve_request>
  <request_identifier>ID_request_62</request_identifier>
  <contract_identifier>ID_contract_51</contract_identifier>
</contract_data_retrieve_request>
```

The database 15110 may send a contract data retrieve response 15133 to the TSS server 15106 with the requested contract data. In one implementation, the contract data retrieve response may include data such as a response identifier, the requested contract data, and/or the like. In one embodiment, the database may provide the following example contract data retrieve response, substantially in the form of a HTTP(S) POST message including XML-formatted data, as provided below:

```
POST /contract_data_retrieve_response.php HTTP/1.1
Host: www.server.com
Content-Type: Application/XML
Content-Length: 667
<?XML version = “1.0” encoding = “UTF-8”?>
<contract_data_retrieve_response>
  <response_identifier>ID_response_62</response_identifier>
  <bytecode>608060405260405161081...30005100032</bytecode>
  <salt_value>
    0x000000000000000000000000000000000000000000000000000000000000208A
  </salt_value>
  <contract_address>
    0x4Dbba4673520eC3D921818a72d18D8e3C100C824
  </contract_address>
  <contract_deployment_signature>
    ECDSA signature in DER format of ID_user_1
  </contract_deployment_signature>
  <contract_deployment_signature>
    ECDSA signature in DER format of ID_user_2
  </contract_deployment_signature>
  <contract_deployment_signature>
    ECDSA signature in DER format of ID_user_3
  </contract_deployment_signature>
</contract_data_retrieve_response>
```

The TSS server 15106 may send a TS request message 15137 to a HSM 15114 to request that the HSM sign the transaction. In one implementation, the TS request message may be sent via a HSM Access Provider and may include data such as a request identifier, a request type (e.g., sign transaction), a transaction identifier, transaction details, contract factory address, source wallet parameters, source wallet contract data, destination wallet parameters, destination wallet contract data, previous transaction signature(s), and/or the like. In one embodiment, the TSS server may provide the following example TS request message, substantially in the form of a HTTP(S) POST message including XML-formatted data, as provided below:

```
POST /TS_request_message.php HTTP/1.1
Host: www.server.com
Content-Type: Application/XML
Content-Length: 667
<?XML version = “1.0” encoding = “UTF-8”?>
<TS_request_message>
  <request_identifier>ID_request_63</request_identifier>
  <request_type>SIGN_TRANSACTION</request_type>
  <transaction_identifier>ID_transaction_61</transaction_identifier>
  <transaction_details>transaction amount, etc.</transaction_details>
  <contract_factory_address>
    0x4949d05Cb64224BA4DC94D6A1776455C37c63F53
  </contract_factory_address>
  <source_wallet_parameters>
    <contract_identifier>ID_contract_51</contract_identifier>
    <M_of_N>2-of-3</M_of_N>
    <owner>
      <owner_identifier>ID_user_1</owner_identifier>
      <keyset_identifier>ID_master_key_pair_1</keyset_identifier>
      <keychain_path>m/0/0/1/0</keychain_path>
    </owner>
    <owner>
      <owner_identifier>ID_user_2</owner_identifier>
      <keyset_identifier>ID_master_key_pair_2</keyset_identifier>
      <keychain_path>m/0/0/1/0</keychain_path>
    </owner>
    <owner>
      <owner_identifier>ID_user_3</owner_identifier>
      <keyset_identifier>ID_master_key_pair_3</keyset_identifier>
      <keychain_path>m/0/0/1/0</keychain_path>
    </owner>
  </source_wallet_parameters>
  <source_wallet_contract_data>
    <contract_identifier>ID_contract_51</contract_identifier>
    <bytecode>608060405260405161081...30005100032</bytecode>
    <salt_value>
  0x000000000000000000000000000000000000000000000000000000000000208A
    </salt_value>
    <contract_address>
      0x4Dbba4673520eC3D921818a72d18D8e3C100C824
    </contract_address>
    <contract_deployment_signature>
      ECDSA signature in DER format of ID_user_1
    </contract_deployment_signature>
    <contract_deployment_signature>
      ECDSA signature in DER format of ID_user_2
    </contract_deployment_signature>
    <contract_deployment_signature>
      ECDSA signature in DER format of ID_user_3
    </contract_deployment_signature>
  </source_wallet_contract_data>
  <destination_wallet_parameters>
    <contract_identifier>ID_contract_52</contract_identifier>
    <M_of_N>2-of-3</M_of_N>
    <owner>
      <owner_identifier>ID_user_11</owner_identifier>
      <keyset_identifier>ID_master_key_pair_11</keyset_identifier>
      <keychain_path>m/0/0/1/0</keychain_path>
    </owner>
    <owner>
      <owner_identifier>ID_user_12</owner_identifier>
      <keyset_identifier>ID_master_key_pair_12</keyset_identifier>
      <keychain_path>m/0/0/1/0</keychain_path>
    </owner>
    <owner>
      <owner_identifier>ID_user_13</owner_identifier>
      <keyset_identifier>ID_master_key_pair_13</keyset_identifier>
      <keychain_path>m/0/0/1/0</keychain_path>
    </owner>
  </destination_wallet_parameters>
  <destination_wallet_contract_data>
    <contract_identifier>ID_contract_52</contract_identifier>
    <bytecode>467860405262754161033...45605100999</bytecode>
    <salt_value>
  0x000000000000000000000000000000000000000000000000000000000000319B
    </salt_value>
    <contract_address>
      0x5Dbba4673520eC3D921818a72d18D8e3C100C935
    </contract_address>
    <contract_deployment_signature>
      ECDSA signature in DER format of ID_user_11
    </contract_deployment_signature>
    <contract_deployment_signature>
      ECDSA signature in DER format of ID_user_12
    </contract_deployment_signature>
    <contract_deployment_signature>
      ECDSA signature in DER format of ID_user_13
    </contract_deployment_signature>
  </destination_wallet_contract_data>
</TS_request_message>
```

The HSM 15114 may send a SFCTS API call 15141 to a SFTS module 15118 to request that the SFTS module sign the transaction. In one implementation, the SFCTS API call may include data such as a request identifier, a request type (e.g., sign transaction), a transaction identifier, transaction details, contract factory address, source wallet parameters, source wallet contract data, destination wallet parameters, destination wallet contract data, and/or the like.

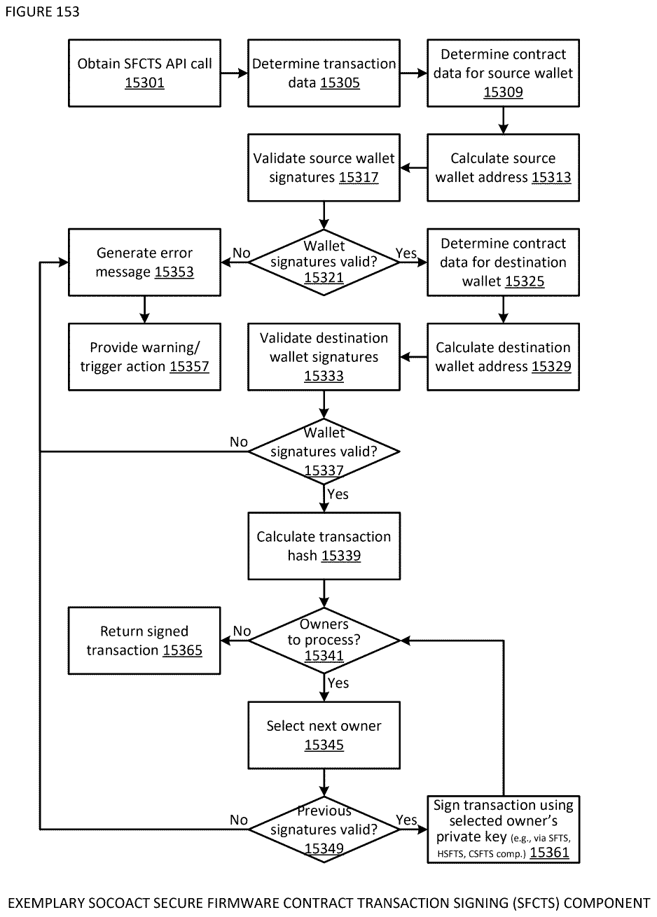

Data provided in the SFCTS API call may be used by a SFCTS component 15145 to validate the legitimacy of wallet addresses participating in the blockchain transaction and to sign the transaction (e.g., to generate an ECDSA signature in DER format). See FIG. 153 for additional details regarding the SFCTS component.

The SFTS module 15118 may send SFCTS response data 15149 to the HSM 15114 in response to the SFCTS API call. In one implementation, the SFCTS response data may include an ECDSA signature in DER format.

The HSM 15114 may send a TS response message 15153 to the TSS server 15106 (e.g., via a HSM Access Provider). In one implementation, the TS response message may include data such as a response identifier, a transaction identifier, a transaction signature, and/or the like. In one embodiment, the HSM may provide the following example TS response message, substantially in the form of a HTTP(S) POST message including XML-formatted data, as provided below:

```
POST /TS_response_message.php HTTP/1.1
Host: www.server.com
Content-Type: Application/XML
Content-Length: 667
<?XML version = “1.0” encoding = “UTF-8”?>
<TS_response_message>
  <response_identifier>ID_response_63</response_identifier>
  <transaction_identifier>ID_transaction_61</transaction_identifier>
  <transaction_signature>ECDSA signature in DER format</transaction_signature>
</TS_response_message>
```

The TSS server 15106 may send a blockchain transaction request 15157 to a blockchain 15120 to submit the transaction to the blockchain (e.g., Ethereum). In one implementation, the blockchain transaction request may include data such as a request identifier, transaction data (e.g., including the transaction details and the transaction signature), and/or the like. In one embodiment, the TSS server may provide the following example blockchain transaction request, substantially in the form of a HTTP(S) POST message including XML-formatted data, as provided below:

```
POST /blockchain_transaction_request.php HTTP/1.1
Host: www.server.com
Content-Type: Application/XML
Content-Length: 667
<?XML version = “1.0” encoding = “UTF-8”?>
<blockchain_transaction_request>
  <request_identifier>ID_request_65</request_identifier>
  <transaction_data>Ethereum transaction data</transaction_data>
</blockchain_transaction_request>
```

The blockchain 15120 may send a blockchain transaction response 15161 to the TSS server 15106 to confirm that the transaction was processed. In one implementation, the blockchain transaction response may include data such as a response identifier, a status, and/or the like. In one embodiment, the blockchain may provide the following example blockchain transaction response, substantially in the form of a HTTP(S) POST message including XML-formatted data, as provided below:

```
POST /blockchain_transaction_response.php HTTP/1.1
Host: www.server.com
Content-Type: Application/XML
Content-Length: 667
<?XML version = “1.0” encoding = “UTF-8”?>
<blockchain_transaction_response>
  <response_identifier>ID_response_65</response_identifier>
  <status>OK</status>
</blockchain_transaction_response>
```

The TSS server 15106 may send a TS response 15165 to the client 15102 (e.g., to inform the user that the transaction was processed). In one implementation, the TS response may include data such as a response identifier, a transaction identifier, a transaction signature, a status, and/or the like. In one embodiment, the TSS server may provide the following example TS response, substantially in the form of a HTTP(S) POST message including XML-formatted data, as provided below:

```
POST /TS_response.php HTTP/1.1
Host: www.server.com
Content-Type: Application/XML
Content-Length: 667
<?XML version = “1.0” encoding = “UTF-8”?>
<TS_response>
  <response_identifier>ID_response_61</response_identifier>
  <transaction_identifier>ID_transaction_61</transaction_identifier>
  <transaction_signature>ECDSA signature in DER format</transaction_signature>
  <status>OK</status>
</TS_response>
```

FIG. 152 shows non-limiting, example embodiments of a logic flow illustrating a transaction server contract transaction signing (TSCTS) component for the SOCOACT. In FIG. 152, a transaction signing request may be obtained at 15201. For example, the transaction signing request may be obtained as a result of a user utilizing a UI of a fund transfer program to initiate transaction signing (e.g., a fund transfer transaction between a source wallet and a destination wallet).

Transaction details associated with the transaction signing request may be determined at 15205. For example, transaction details may include a transaction amount, gas price, gas limit, a nonce, and/or the like. In one implementation, the transaction signing request may be parsed (e.g., using PHP commands) to determine the transaction details (e.g., based on the value of the transaction_details field).

Source wallet parameters of a source wallet (e.g., smart contract) associated with the transaction signing request may be determined at 15207. For example, source wallet parameters may include a wallet identifier (e.g., a contract identifier), an M-of-N configuration, a set of owner datastructures, and/or the like. In one implementation, the transaction signing request may be parsed (e.g., using PHP commands) to determine the source wallet parameters (e.g., based on the value of the source_wallet_parameters field).

Destination wallet parameters of a destination wallet (e.g., smart contract) associated with the transaction signing request may be determined at 15209. For example, destination wallet parameters may include a wallet identifier (e.g., a contract identifier), an M-of-N configuration, a set of owner datastructures, and/or the like. In one implementation, the transaction signing request may be parsed (e.g., using PHP commands) to determine the destination wallet parameters (e.g., based on the value of the destination_wallet_parameters field).

Contract data for the source wallet may be retrieved at 15211. In one implementation, the contract data for the source wallet may be retrieved from the contracts database table 17319s. For example, the contract data for the source wallet may be retrieved via a MySQL database command similar to the following:

SELECT contractCode, contractSalt, contractAddress,
contractDeploymentSignatures, contractContractFactoryAddress
FROM Contracts
WHERE contractID = ID_contract_51;

Contract data for the destination wallet may be retrieved at 15213. In one implementation, the contract data for the destination wallet may be retrieved from the contracts database table 17319s. For example, the contract data for the destination wallet may be retrieved via a MySQL database command similar to the following:

SELECT contractCode, contractSalt, contractAddress,
contractDeploymentSignatures, contractContractFactoryAddress
FROM Contracts
WHERE contractID = ID_contract_52;

Transaction signing may be requested from an HSM (e.g., via TSTS, NTSTS, FTSTS component) at 15217. In one implementation, a transaction signing request message may be sent to the HSM to request transaction signing. It is to be understood that, in various embodiments, transaction signing may be performed in a variety of ways (e.g., as discussed with regard to TSTS, NTSTS, FTSTS components).

A determination may be made at 15221 whether the transaction signing request was authorized by the HSM. In one implementation, the HSM may validate the legitimacy of wallet addresses participating in the blockchain transaction before signing the transaction. If the transaction signing request was not authorized, an error message may be generated at 15225. For example, the error message may specify the error that occurred (e.g., source wallet address and/or destination wallet address cannot be validated). A warning message may be provided to the user and/or an action may be triggered at 15229. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with a wallet.

If the transaction signing request was authorized, the transaction may be submitted to a blockchain (e.g., the Ethereum blockchain) at 15233. In one implementation, the transaction may be broadcast to the blockchain via a blockchain transaction request.

A transaction signing response may be provided to the user's client at 15237. In one implementation, a transaction signing response may be sent to inform the user whether the transaction signing was completed successfully (e.g., via a UI of the fund transfer program).

FIG. 153 shows non-limiting, example embodiments of a logic flow illustrating a secure firmware contract transaction signing (SFCTS) component for the SOCOACT. In FIG. 153, a SFCTS API call may be obtained at 15301. For example, the SFCTS API call may be obtained as a result of a call from a HSM associated with the SFCTS component. It is to be understood that although the SFCTS component is described with regard to an API method to sign a transaction (e.g.,/transaction/sign), in some embodiment, a variety of API methods may be available. In one embodiment, the following API methods (e.g., REST API endpoints) may be available to the HSM and/or to a TSS:

```
/transaction/sign - this API method signs transactions transferring digital assets
(e.g., within or among a company's wallets).
  Source:
    contract identifier:
      address
      list of signatures
    ...
  Destination:
    contract identifier:
      address
      list of signatures
    ...
```

Transaction data may be determined at 15305. In one implementation, the transaction data may be provided in the SFCTS API call and may include a transaction identifier, transaction details (e.g., including transaction amount, gas price, gas limit, a nonce, and/or the like), a deployment factory (e.g., Contract Factory) address, source wallet parameters (e.g., including a wallet identifier (e.g., a contract identifier), an M-of-N configuration, a set of owner datastructures, and/or the like) of a source wallet (e.g., smart contract), destination wallet parameters (e.g., including a wallet identifier (e.g., a contract identifier), an M-of-N configuration, a set of owner datastructures, and/or the like) of a destination wallet (e.g., smart contract), and/or the like.

Contract data for the source wallet may be determined at 15309. In one implementation, the contract data for the source wallet may be provided in the SFCTS API call and may include contract code (e.g., the bytecode), a salt value, a contract address, a set of contract deployment signatures, a deployment factory (e.g., Contract Factory) address (e.g., in case different Contract Factories were used for the source wallet and for the destination wallet), and/or the like.

A source wallet address may be calculated at 15313. In one implementation, the source wallet address may be calculated as an EIP-1014 address that is equal to the last 20 bytes of the Keccak-256 (SHA-3) hash of the concatenated list of the deployment factory address for the source wallet, the salt value for the source wallet, and Keccak-256 hash of the source wallet's bytecode including owner addresses generated using owner key identification parameters for each associated owner datastructure (e.g., as discussed with regard to 14905-14917) as constructor parameters-all prefixed with 0xFF byte. See FIG. 146 for additional details regarding calculating an EIP-1014 address. In another implementation, the source wallet address may be provided as part of the contract data for the source wallet.

Source wallet signatures may be validated at 15317. In one embodiment, each of the contract deployment signatures associated with the source wallet may be validated. In one implementation, the contract deployment signatures associated with the source wallet may be verified using a PKCS #11 function (e.g., C_Verify ( . . . )). For example, a contract deployment signature associated with an owner datastructure may be validated as follows:
Public Key=determine a public key that corresponds to the generated owner address associated with the owner datastructure using the owner key identification parameters associated with the owner datastructure
Hashed Value=Append the source wallet address and the salt value for the source wallet, and calculate a hash value of the result (e.g., KECCAK256 (source wallet address+salt value))
Validate the contract deployment signature=the contract deployment signature is valid if the validation procedure for the hashed value and the public key returns true

A determination may be made at 15321 whether the contract deployment signatures associated with the source wallet are valid. If the contract deployment signatures associated with the source wallet are not valid, an error message may be generated at 15353. For example, the error message may specify the error that occurred (e.g., contract deployment signature is invalid). A warning message may be provided to a user and/or an action may be triggered at 15357. In one implementation, a warning message based on the generated error message may be provided to the user (e.g., via the TSS) to inform the user regarding the error. In another implementation, an action may be triggered based on a specified condition (e.g., invalid signature obtained three times). For example, the triggered action may be to erase data associated with the source wallet.

If the contract deployment signatures associated with the source wallet are valid, contract data for the destination wallet may be determined at 15325. In one implementation, the contract data for the destination wallet may be provided in the SFCTS API call and may include contract code (e.g., the bytecode), a salt value, a contract address, a set of contract deployment signatures, a deployment factory (e.g., Contract Factory) address (e.g., in case different Contract Factories were used for the source wallet and for the destination wallet), and/or the like.

A destination wallet address may be calculated at 15329. In one implementation, the destination wallet address may be calculated as an EIP-1014 address that is equal to the last 20 bytes of the Keccak-256 (SHA-3) hash of the concatenated list of the deployment factory address for the destination wallet, the salt value for the destination wallet, and Keccak-256 hash of the destination wallet's bytecode including owner addresses generated using owner key identification parameters for each associated owner datastructure (e.g., as discussed with regard to 14905-14917) as constructor parameters-all prefixed with 0xFF byte. See FIG. 146 for additional details regarding calculating an EIP-1014 address. In another implementation, the destination wallet address may be provided as part of the contract data for the destination wallet.

Destination wallet signatures may be validated at 15333. In one embodiment, each of the contract deployment signatures associated with the destination wallet may be validated. In one implementation, the contract deployment signatures associated with the destination wallet may be verified using a PKCS #11 function (e.g., C_Verify ( . . . )). For example, a contract deployment signature associated with an owner datastructure may be validated as follows:
Public Key=determine a public key that corresponds to the generated owner address associated with the owner datastructure using the owner key identification parameters associated with the owner datastructure
Hashed Value=Append the destination wallet address and the salt value for the destination wallet, and calculate a hash value of the result (e.g., KECCAK256 (destination wallet address+salt value))
Validate the contract deployment signature=the contract deployment signature is valid if the validation procedure for the hashed value and the public key returns true

A determination may be made at 15337 whether the contract deployment signatures associated with the destination wallet are valid. If the contract deployment signatures associated with the destination wallet are not valid, an error message may be generated at 15353. For example, the error message may specify the error that occurred (e.g., contract deployment signature is invalid). A warning message may be provided to a user and/or an action may be triggered at 15357. In one implementation, a warning message based on the generated error message may be provided to the user (e.g., via the TSS) to inform the user regarding the error. In another implementation, an action may be triggered based on a specified condition (e.g., invalid signature obtained three times). For example, the triggered action may be to erase data associated with the destination wallet.

If the contract deployment signatures associated with the destination wallet are valid, a transaction hash for the transaction (e.g., with the calculated destination wallet address used as the “to address” of the transaction message) may be generated at 15339. In one implementation, the transaction hash may be calculated in accordance with the hashing algorithm utilized by the Ethereum protocol (e.g., KECCAK256(RLP(message)))

A determination may be made at 15341 whether there remain owner datastructures to process. In one implementation, each of the owner datastructures provided in the SFCTS API call may be processed. If there remain owner datastructures to process, the next owner datastructure may be selected for processing at 15345.

A determination may be made at 15349 whether previously generated transaction signatures (e.g., if any) used to sign the transaction are valid. If any of the previously generated signatures is invalid, an error message may be generated at 15353. For example, the error message may specify the error that occurred (e.g., transaction signature is invalid). A warning message may be provided to a user and/or an action may be triggered at 15357. In one implementation, a warning message based on the generated error message may be provided to the user (e.g., via the TSS) to inform the user regarding the error. In another implementation, an action may be triggered based on a specified condition (e.g., invalid signature obtained three times). For example, the triggered action may be to erase data associated with the source wallet.

If the previously generated transaction signatures are valid, the transaction may be signed using a private key associated with the selected owner datastructure at 15361. It is to be understood that, in various embodiments, transaction signing may be performed in a variety of ways (e.g., as discussed with regard to SFTS, HSFTS, CSFTS components), and different owners may utilize different HSMs (e.g., each HSM executing a separate SFCTS component), the same HSM, combinations of HSMs, and/or the like to sign the transaction.

The signed transaction may be returned at 15365. In one implementation, the ECDSA signature in DER format may be returned.

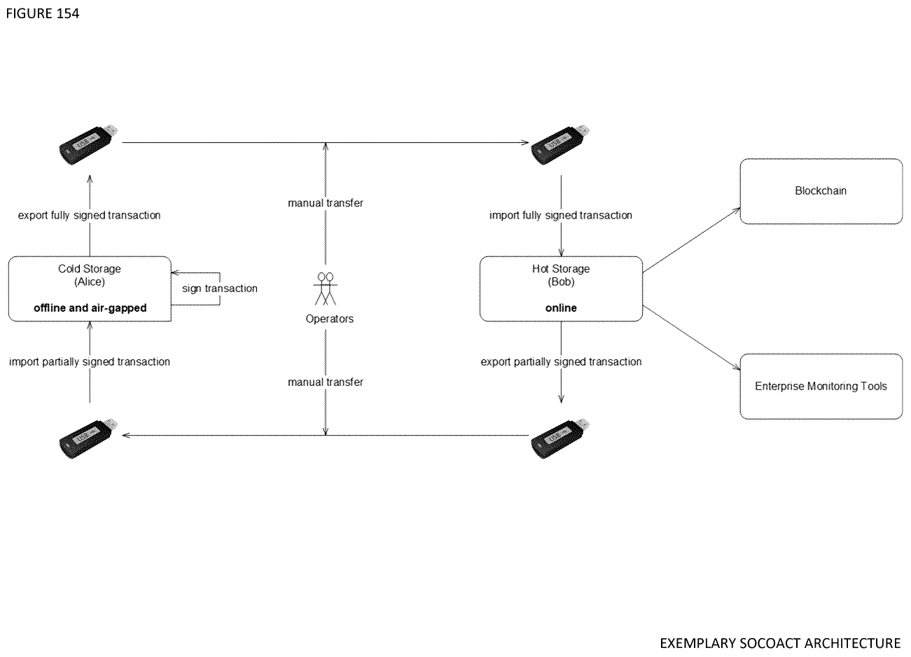

FIG. 154 shows non-limiting, example embodiments of an architecture for the SOCOACT. In FIG. 154, an embodiment of how USB keys may be utilized to implement a signing process in case of offline cold storage and online hot storage is illustrated. In one implementation, the signing process may utilize a multi-signature protocol, in which at least some signatures are generated by offline components, and may be implemented as follows. At least some cold storage signing components are implemented as offline air-gapped servers, located in highly protected rooms. A transaction signature (e.g., first transaction signature) may be generated by an online hot storage component (e.g., implemented as an online server). The partially signed transaction may be exported onto a piece of transfer equipment (e.g., a USB key). One or more operators may carry the USB key to cold storage (e.g., a locked cold storage room). The operators may activate a signing server and import the partially signed transaction into the signing server. The signing server (e.g., via an HSM) may generate new (e.g., offline) transaction signatures and may export the fully signed transaction and/or auxiliary files (e.g., log files, audit trail files, system reports) back to the USB key. The operators may transfer the USB key back to the online hot storage and may imports them into the online server. The signed transaction may be processed and submitted to the blockchain. Auxiliary files may be submitted to enterprise monitoring tools.

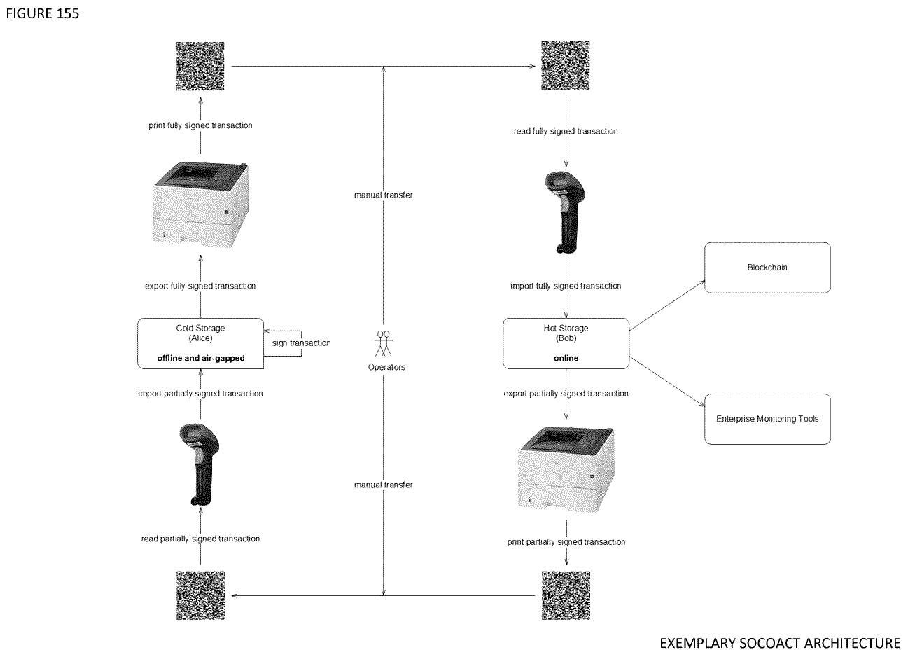

FIG. 155 shows non-limiting, example embodiments of an architecture for the SOCOACT. In FIG. 155, an embodiment of how QR codes may be utilized to implement a signing process in case of offline cold storage and online hot storage is illustrated. In one implementation, the signing process as discussed with regard to FIG. 154 may be modified to mitigate the risk of injecting malware into the cold storage system with the USB key as follows. The USB key may be replaced with a barcode medium (e.g., a QR code) by printing or displaying on a screen (e.g., of a mobile device) the partially signed transaction (e.g., using QR code format). The partially signed transaction may be imported into the signing server using an optical reader (e.g., a barcode reader, a camera). The fully signed transaction and/or the auxiliary files may be printed or displayed on a screen (e.g., using QR code format). The fully signed transaction and/or the auxiliary files may be imported into the online server using an optical reader.

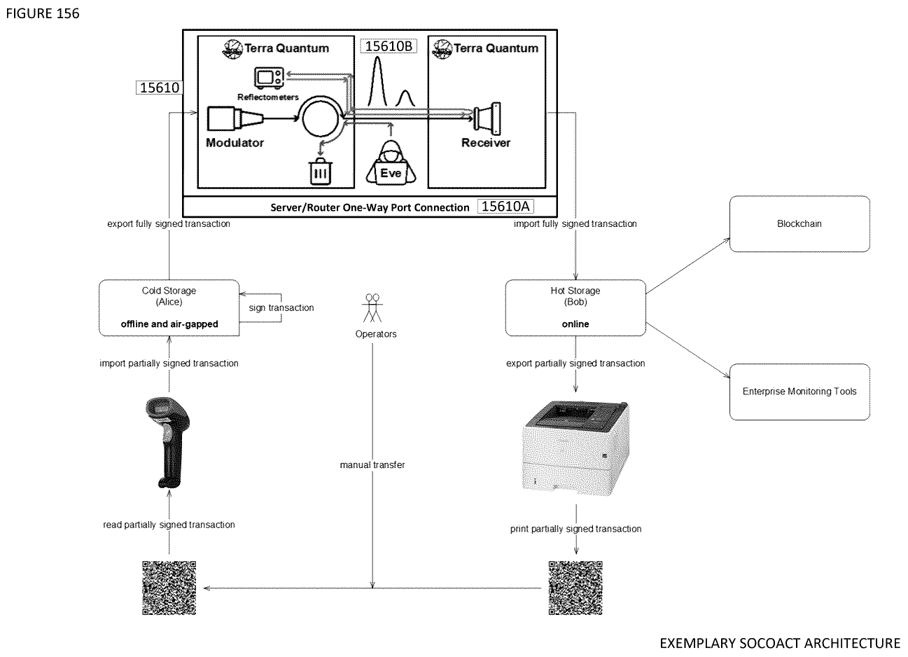

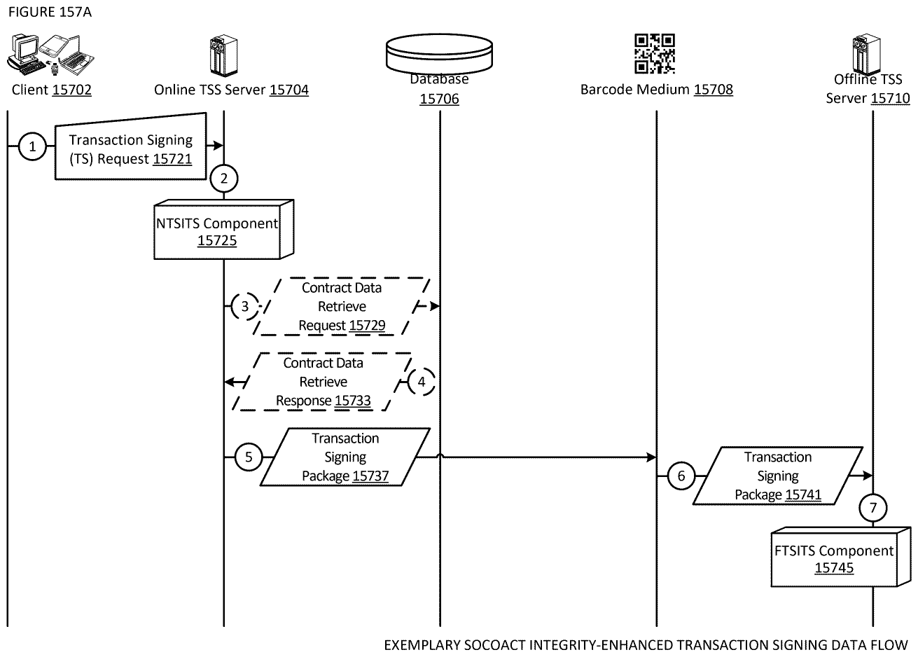

FIG. 156 shows non-limiting, example embodiments of an architecture for the SOCOACT. In FIG. 156, an embodiment of how an integrity authentication communication channel (e.g., a server/router one-way port connection, a unidirectional quantum-secured communication channel, etc.) may be utilized to implement a signing process in case of offline cold storage and online hot storage is illustrated. The maximum size of information that may be encoded into a single QR code is about 3 KB. Consequently, large transactions or transactions with a large number of signatures may have to be split into pieces, converted into separate QR codes, and read separately for the original transaction to be restored. This may create a significant processing overhead, which may be further exacerbated when adding auxiliary files (e.g., often large and containing hundreds of kilobytes or megabytes of information). In one implementation, the signing process as discussed with regard to FIG. 155 may be modified to mitigate processing overhead associated with the size of information being exchanged as follows. The fully signed transaction and/or the auxiliary files may be transferred from the cold storage to the hot storage via an integrity authentication communication channel 15610 (e.g., a server/router one-way port connection, a unidirectional quantum-secured communication channel, etc.). In one implementation, a server/router one-way port connection 15610A may utilize a transmitting network device structured to block receiving ports (e.g., at a hardware level) so that the cold storage is incapable of receiving data. In another implementation, a unidirectional quantum-secured communication channel 15610B (e.g., a one-way optical channel) may be utilized. In this alternative implementation, the cold storage is connected to an optical transmitter (e.g., Terra Quantum optical transmitter via an ethernet port) equipped with an optical circulator blocking backward signals, thus preventing all kinds of injection attacks. The cold storage thus remains quasi-offline and the overall security of the system does not decrease. The hot storage is connected to an optical receiver (e.g., Terra Quantum optical receiver via an ethernet port). The transmitter and the receiver may be connected with an optical fiber line. Another device, an Optical Time-Domain Reflectometer (OTDR) is also connected to the line for controlling its integrity. The OTDR creates a unique fingerprint of both the line and the receiver detectors by identifying defects and features which cannot be replicated. It is not possible for an attacker to meddle with the line or substitute the receiver detectors without changing this fingerprint, hence any modification to the transmission line may be detected.

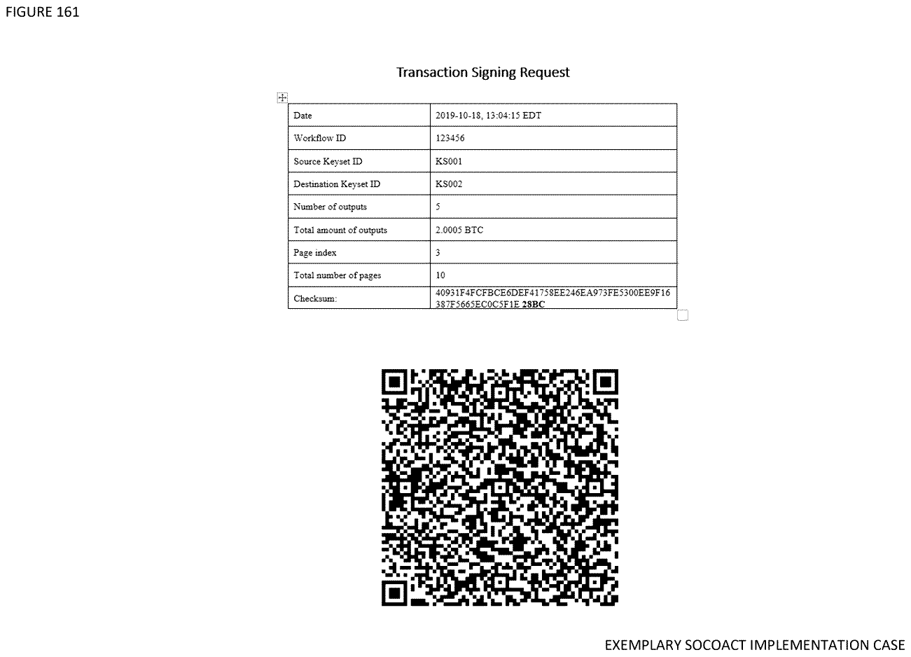

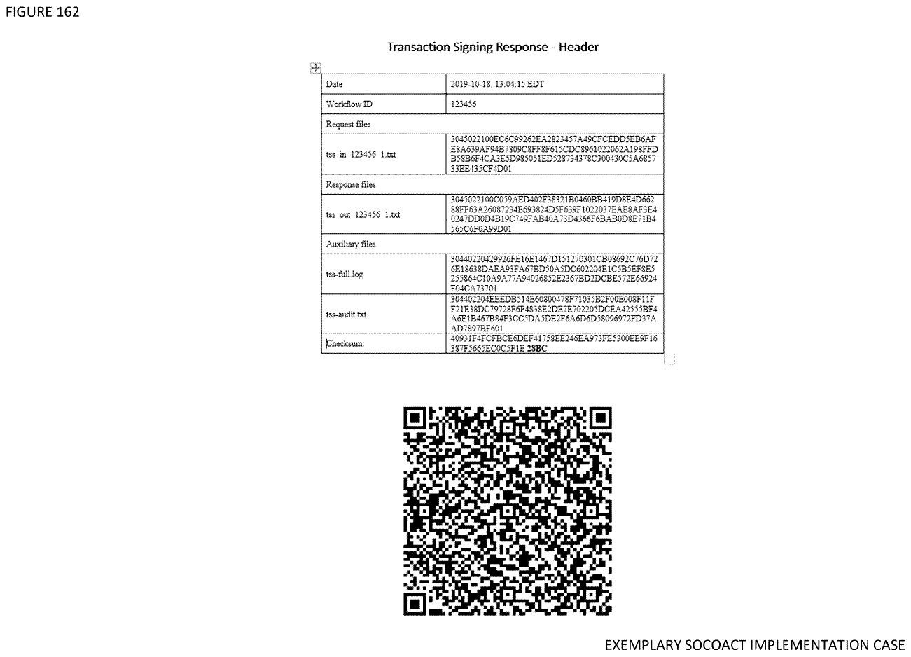

An additional authentication procedure allows the receiver (e.g., the online server) to validate the data source as well as the integrity of transmitted information. The online server may use the additional authentication procedure to verify that the data being transmitted are indeed coming from the cold storage and that data (e.g., log, audit and system report files) are intact. The additional authentication procedure may be implemented as follows:
1247.1. The cold storage system hosts some private keys and uses them for signing transactions. As a part of the initial setup, the hot storage system may be configured with appropriate public keys that can be used for signature verification. For example, if the overall system is using BIP-32 protocol for key derivation, then its online component may be configured with the appropriate extendible public key (xPub).
1247.2. Each signing procedure may be assigned a unique number, workflow ID, associated with the transaction signing request package to be signed: one or more transactions, identification of keys to be used for signing. The transaction signing request package may be formed and/or temporarily stored on the online receiving workstation.
1247.3. The transaction signing request package may be encoded into one or multiple QR codes (e.g., to be printed and transferred to the cold storage (e.g., see FIG. 161)).
1247.4. During the signing procedure the operators may scan the set of QR codes into the cold storage machine which processes the request and creates in a designated location a transaction signing response package to be transmitted back to the online machine via the integrity authentication communication channel (e.g., see FIG. 162) comprising:
   1247.4.1. Header file, comprised of:
      1247.4.1.1.workflow ID
      1247.4.1.2.list of request file names along with generated signatures of their hash codes
      1247.4.1.3.list of response file names along with generated signatures of their hash codes
      1247.4.1.4.list of auxiliary file names along with generated signatures of their hash codes
   1247.4.2. Transaction signing response files
   1247.4.3. Auxiliary files
1247.5. The transaction signing response package may be sent to the online receiver using an integrity authentication communication channel transmission.
1247.6. The online server:
   1247.6.1. Receives files within the transmission.
   1247.6.2. Identifies the header file, compares the list of input files with the locally stored one and validates provided signatures using pre-configured public keys—the process halts if any validation fails, which means either invalid data transmission or a potentially malicious sender.
   1247.6.3. Validates response files and their signatures and rejects files that did not pass the validation.
   1247.6.4. If the validations are successful, received files are submitted for further processing:
      1247.6.4.1.Transactions are forwarded to the blockchain integration process (e.g., submitted to the blockchain)
      1247.6.4.2.Log, audit and system report files are forwarded to the enterprise monitoring tools.
   1247.7. If any validations fail, an action may be triggered (e.g., resubmit the files for new transfer or repeat the whole procedure).
   1247.8. If a potential intrusion is detected by the OTDR an investigation procedure may be initiated.

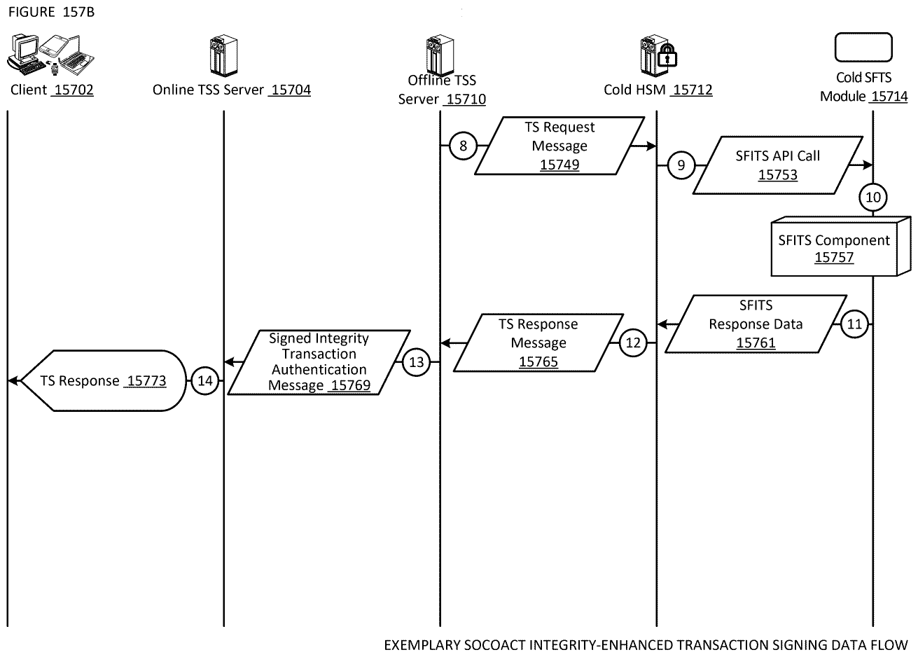

FIGS. 157A-B show non-limiting, example embodiments of a datagraph illustrating data flow(s) for the SOCOACT. In FIGS. 157A-B, dashed lines indicate data flow elements that may be more likely to be optional. In FIGS. 157A-B, a client 15702 (e.g., of a user) may send a transaction signing (TS) request 15721 to an online TSS server 15704 to request that a transaction be signed. For example, the client may be a desktop, a laptop, a tablet, a smartphone, a smartwatch, and/or the like that is executing a client application. In one implementation, the TS request may include data such as a request identifier, user authentication data, a request type (e.g., sign message hash), a wallet identifier, a transaction identifier, a transaction hash, a keychain path, and/or the like. In one embodiment, the client may provide the following example TS request, substantially in the form of a HTTP(S) POST message including XML-formatted data, as provided below:

```
POST /authrequest.php HTTP/1.1
Host: localhost
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</account_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <TS_request>
    <request_identifier>ID_request_71</request_identifier>
    <request_type>SIGN_TRANSACTION</request_type>
    <wallet_identifier>ID_Wallet_71</wallet_identifier>
    <transaction_identifier>ID_transaction_71</transaction_identifier>
    <transaction_hash>256-bit hash value to be signed</transaction_hash>
    <keychain_path>m/0/0/1/0</keychain_path>
  </TS_request>
</auth_request>
```

In another implementation (e.g., where wallet address verification is utilized), the TS request may include data such as a request identifier, user authentication data, a request type (e.g., sign transaction), a transaction identifier, transaction details, source wallet parameters, destination wallet parameters, and/or the like. In one embodiment, the client may provide the following example transaction signing (TS) request, substantially in the form of a HTTP(S) POST message including XML-formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>JohnDaDoeDoeDoooe@gmail.com</user_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <TS_request>
    <request_identifier>ID_request_71</request_identifier>
    <request_type>SIGN_TRANSACTION</request_type>
    <transaction_identifier>ID_transaction_71</transaction_identifier>
    <transaction_details>transaction amount, etc.</transaction_details>
    <source_wallet_parameters>
      <contract_identifier>ID_contract_71</contract_identifier>
      <M_of_N>2-of-3</M_of_N>
      <owner>
        <owner_identifier>ID_user_1</owner_identifier>
  <keyset_identifier>ID_master_key_pair_1</keyset_identifier>
        <keychain_path>m/0/0/1/0</keychain_path>
      </owner>
      <owner>
        <owner_identifier>ID_user_2</owner_identifier>
  <keyset_identifier>ID_master_key_pair_2</keyset_identifier>
        <keychain_path>m/0/0/1/0</keychain_path>
      </owner>
      <owner>
        <owner_identifier>ID_user_3</owner_identifier>
  <keyset_identifier>ID_master_key_pair_3</keyset_identifier>
        <keychain_path>m/0/0/1/0</keychain_path>
      </owner>
    </source_wallet_parameters>
    <destination_wallet_parameters>
      <contract_identifier>ID_contract_72</contract_identifier>
      <M_of_N>2-of-3</M_of_N>
      <owner>
        <owner_identifier>ID_user_11</owner_identifier>
  <keyset_identifier>ID_master_key_pair_11</keyset_identifier>
        <keychain_path>m/0/0/1/0</keychain_path>
      </owner>
      <owner>
        <owner_identifier>ID_user_12</owner_identifier>
  <keyset_identifier>ID_master_key_pair_12</keyset_identifier>
        <keychain_path>m/0/0/1/0</keychain_path>
      </owner>
      <owner>
        <owner_identifier>ID_user_13</owner_identifier>
  <keyset_identifier>ID_master_key_pair_13</keyset_identifier>
        <keychain_path>m/0/0/1/0</keychain_path>
      </owner>
    </destination_wallet_parameters>
  </TS_request>
</auth_request>
```

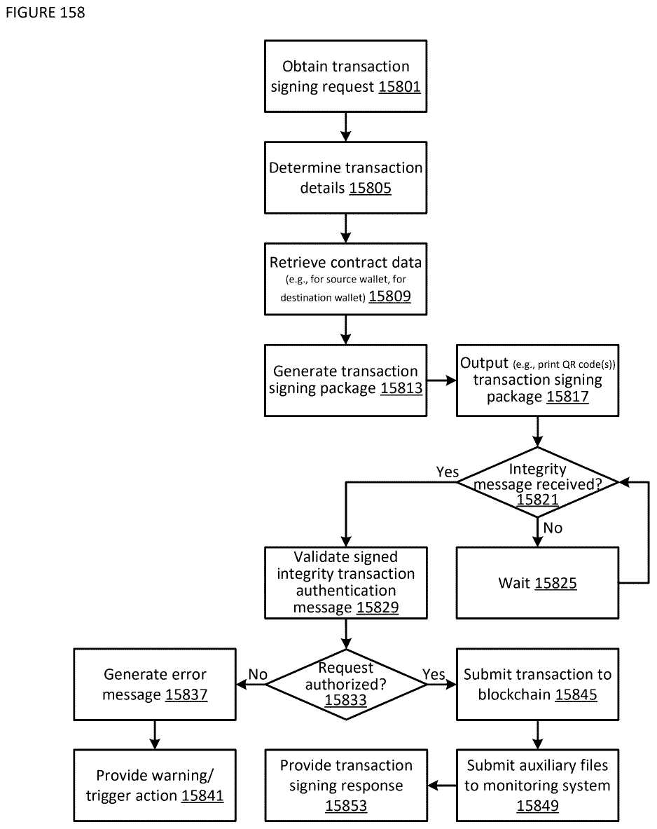

An online transaction server integrity-enhanced transaction signing (NTSITS) component 15725 may utilize parameters provided in the TS request to facilitate transaction signing. See FIG. 158 for additional details regarding the NTSITS component.

In some implementations (e.g., where wallet address verification is utilized), the online TSS server 15704 may send a contract data retrieve request 15729 to a database 15706 to retrieve contract data for a source wallet and/or for a destination wallet. For example, separate contract data retrieve requests may be sent for the source wallet and for the destination wallet. In another example, a combined contract data retrieve request may be sent for both the source wallet and for the destination wallet. In one implementation, the contract data retrieve request may include data such as a request identifier, a contract identifier (e.g., a source wallet identifier, a destination wallet identifier), and/or the like. In one embodiment, the online TSS server may provide the following example contract data retrieve request, substantially in the form of a HTTP(S) POST message including XML-formatted data, as provided below:

```
POST /contract_data_retrieve_request.php HTTP/1.1
Host: www.server.com
Content-Type: Application/XML
Content-Length: 667
<?XML version = “1.0” encoding = “UTF-8”?>
<contract_data_retrieve_request>
  <request_identifier>ID_request_72</request_identifier>
  <contract_identifier>ID_contract_71</contract_identifier>
</contract_data_retrieve_request>
```

The database 15706 may send a contract data retrieve response 15733 to the online TSS server 15704 with the requested contract data. In one implementation, the contract data retrieve response may include data such as a response identifier, the requested contract data, and/or the like. In one embodiment, the database may provide the following example contract data retrieve response, substantially in the form of a HTTP(S) POST message including XML-formatted data, as provided below:

```
POST /contract_data_retrieve_response.php HTTP/1.1
Host: www.server.com
Content-Type: Application/XML
Content-Length: 667
<?XML version = “1.0” encoding = “UTF-8”?>
<contract_data_retrieve_response>
  <response_identifier>ID_response_72</response_identifier>
  <bytecode>608060405260405161081...30005100032</bytecode>
  <salt_value>
    0x000000000000000000000000000000000000000000000000000000000000208A
  </salt_value>
  <contract_address>
    0x4Dbba4673520eC3D921818a72d18D8e3C100C824
  </contract_address>
  <contract_deployment_signature>
    ECDSA signature in DER format of ID_user_1
  </contract_deployment_signature>
  <contract_deployment_signature>
    ECDSA signature in DER format of ID_user_2
  </contract_deployment_signature>
  <contract_deployment_signature>
    ECDSA signature in DER format of ID_user_3
  </contract_deployment_signature>
</contract_data_retrieve_response>
```

The online TSS server 15704 may generate and/or export (e.g., via a printer) a transaction signing package 15737 to a barcode medium 15708. In one implementation, the transaction signing package may include data such as a request identifier, a workflow ID, details regarding one or more transactions to be signed, identification of keys to be used for signing, a checksum, and/or the like. In one embodiment, the online TSS server may generate the following example transaction signing package, substantially in the form of a HTTP(S) POST message including XML-formatted data, as provided below:

```
POST /transaction_signing_package.php HTTP/1.1
Host: www.server.com
Content-Type: Application/XML
Content-Length: 667
<?XML version = “1.0” encoding = “UTF-8”?>
<transaction_signing_package>
  <request_identifier>ID_request_73</request_identifier>
  <workflow_ID>123456</workflow_ID>
  <request_file>
    <file>
      <file_name>tss_in_123456.txt</file_name>
      <request_type>SIGN_TRANSACTION</request_type>
      <wallet_identifier>ID_Wallet_71</wallet_identifier>
  <transaction_identifier>ID_transaction_71</transaction_identifier>
      <transaction_hash>256-bit hash value to be
signed</transaction_hash>
      <keychain_path>m/0/0/1/0</keychain_path>
      <transferable_data>...</transferable_data>
      <master_key_share>...</master_key_share>
      <checksum>40931F4FC...</checksum>
    </file>
  </request_file>
</transaction_signing_package>
```

In another embodiment, the online TSS server may generate the following example transaction signing package, substantially in the form of a HTTP(S) POST message including XML-formatted data, as provided below:

```
POST /transaction_signing_package.php HTTP/1.1
Host: www.server.com
Content-Type: Application/XML
Content-Length: 667
<?XML version = “1.0” encoding = “UTF-8”?>
<transaction_signing_package>
  <request_identifier>ID_request_73</request_identifier>
  <workflow_ID>123456</workflow_ID>
  <request_file>
    <file>
      <file_name>tss_in_123456.txt</file_name>
      <request_type>SIGN_TRANSACTION</request_type>
  <transaction_identifier>ID_transaction_71</transaction_identifier>
```

| | |
|---|---|
| <transaction_details>transaction | amount, |

```
etc.</transaction_details>
      <contract_factory_address>
        0x4949d05Cb64224BA4DC94D6A1776455C37c63F53
      </contract_factory_address>
      <source_wallet_parameters>
  <contract_identifier>ID_contract_71</contract_identifier>
        <M_of_N>2-of-3</M_of_N>
        <owner>
          <owner_identifier>ID_user_1</owner_identifier>
  <keyset_identifier>ID_master_key_pair_1</keyset_identifier>
          <keychain_path>m/0/0/1/0</keychain_path>
        </owner>
        <owner>
          <owner_identifier>ID_user_2</owner_identifier>
  <keyset_identifier>ID_master_key_pair_2</keyset_identifier>
          <keychain_path>m/0/0/1/0</keychain_path>
        </owner>
        <owner>
          <owner_identifier>ID_user_3</owner_identifier>
  <keyset_identifier>ID_master_key_pair_3</keyset_identifier>
          <keychain_path>m/0/0/1/0</keychain_path>
      </owner>
      </source_wallet_parameters>
      <source_wallet_contract_data>
  <contract_identifier>ID_contract_71</contract_identifier>
        <bytecode>608060405260405161081...30005100032</bytecode>
        <salt_value>
  0x000000000000000000000000000000000000000000000000000000000000208A
        </salt_value>
        <contract_address>
          0x4Dbba4673520eC3D921818a72d18D8e3C100C824
        </contract_address>
        <contract_deployment_signature>
          ECDSA signature in DER format of ID_user_1
        </contract_deployment_signature>
        <contract_deployment_signature>
          ECDSA signature in DER format of ID_user_2
        </contract_deployment_signature>
        <contract_deployment_signature>
          ECDSA signature in DER format of ID_user_3
        </contract_deployment_signature>
      </source_wallet_contract_data>
      <destination_wallet_parameters>
  <contract_identifier>ID_contract_72</contract_identifier>
        <M_of_N>2-of-3</M_of_N>
        <owner>
          <owner_identifier>ID_user_11</owner_identifier>
  <keyset_identifier>ID_master_key_pair_11</keyset_identifier>
          <keychain_path>m/0/0/1/0</keychain_path>
        </owner>
        <owner>
          <owner_identifier>ID_user_12</owner_identifier>
  <keyset_identifier>ID_master_key_pair_12</keyset_identifier>
          <keychain_path>m/0/0/1/0</keychain_path>
        </owner>
        <owner>
          <owner_identifier>ID_user_13</owner_identifier>
  <keyset_identifier>ID_master_key_pair_13</keyset_identifier>
          <keychain_path>m/0/0/1/0</keychain_path>
        </owner>
      </destination_wallet_parameters>
      <destination_wallet_contract_data>
  <contract_identifier>ID_contract_72</contract_identifier>
        <bytecode>467860405262754161033...45605100999</bytecode>
        <salt_value>
  0x000000000000000000000000000000000000000000000000000000000000319B
        </salt_value>
        <contract_address>
          0x5Dbba4673520eC3D921818a72d18D8e3C100C935
        </contract_address>
        <contract_deployment_signature>
          ECDSA signature in DER format of ID_user_11
        </contract_deployment_signature>
        <contract_deployment_signature>
          ECDSA signature in DER format of ID_user_12
        </contract_deployment_signature>
        <contract_deployment_signature>
          ECDSA signature in DER format of ID_user_13
        </contract_deployment_signature>
      </destination_wallet_contract_data>
      <checksum>40931F4FC...</checksum>
    </file>
  </request_file>
</transaction_signing_package>
```

In various implementations, the barcode medium may be a printed medium (e.g., a paper with a QR code), a digital medium (e.g., a display screen with a QR code), and/or the like. See FIG. 161 for an example of a barcode medium that may be generated. It is to be understood that one or multiple barcode mediums may be generated (e.g., depending on the size of data in the transaction signing request package), and that each barcode medium may comprise one or multiple QR codes. The barcode medium may include additional data such as a barcode medium page number, total number of barcode medium pages, error detection/correction data, and/or the like. For example, such additional data may be used to facilitate reconstruction of the transaction signing request package from multiple barcode mediums.

An offline TSS server 15710 may import (e.g., via an optical reader) and/or reconstruct the transaction signing package 15741 from the barcode medium 15708. In one implementation, the user may move the barcode medium from the online TSS server to the offline TSS server, and may utilize the offline TSS server (e.g., an offline transaction signing runtime) to request that the transaction be signed using the transaction signing package (e.g., resulting in the importing).

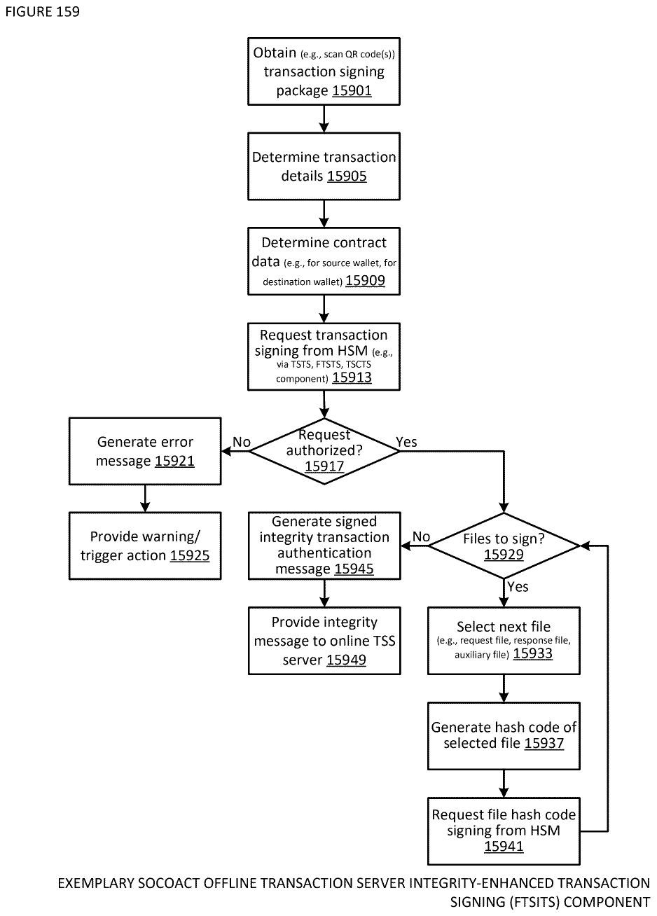

An offline transaction server integrity-enhanced transaction signing (FTSITS) component 15745 may utilize the transaction signing package to facilitate transaction signing. See FIG. 159 for additional details regarding the FTSITS component.

The offline TSS server 15710 may send a TS request message 15749 to a cold HSM 15712 to request that the cold HSM sign the transaction. In one implementation, the TS request message may be sent via a HSM Access Provider and may include data such as a request identifier, a request type (e.g., sign message hash), a wallet identifier, a transaction identifier, a transaction hash, a keychain path, transferable data (e.g., partially signed transaction data), encrypted master key share(s), and/or the like. In one embodiment, the offline TSS server may provide the following example TS request message, substantially in the form of a HTTP(S) POST message including XML-formatted data, as provided below:

```
POST /TS_request_message.php HTTP/1.1
Host: www.server.com
Content-Type: Application/XML
Content-Length: 667
<?XML version = “1.0” encoding = “UTF-8”?>
<TS_request_message>
  <request_identifier>ID_request_74</request_identifier>
  <request_type>SIGN_TRANSACTION</request_type>
  <wallet_identifier>ID_Wallet_71</wallet_identifier>
  <transaction_identifier>ID_transaction_71</transaction_identifier>
  <transaction_hash>256-bit hash value to be signed</transaction_hash>
  <keychain_path>m/0/0/1/0</keychain_path>
  <transferable_data>...</transferable_data>
  <master_key_share>...</master_key_share>
</TS_request_message>
```

In another implementation, the TS request message may be sent via a HSM Access Provider and may include data such as a request identifier, a request type (e.g., sign message hash), a request type (e.g., sign transaction), a transaction identifier, transaction details, contract factory address, source wallet parameters, source wallet contract data, destination wallet parameters, destination wallet contract data, previous transaction signature(s), and/or the like. In one embodiment, the offline TSS server may provide the following example TS request message, substantially in the form of a HTTP(S) POST message including XML-formatted data, as provided below:

```
POST /TS_request_message.php HTTP/1.1
Host: www.server.com
Content-Type: Application/XML
Content-Length: 667
<?XML version = “1.0” encoding = “UTF-8”?>
<TS_request_message>
  <request_identifier>ID_request_74</request_identifier>
  <request_type>SIGN_TRANSACTION</request_type>
  <transaction_identifier>ID_transaction_71</transaction_identifier>
  <transaction_details>transaction amount, etc.</transaction_details>
  <contract_factory_address>
    0x4949d05Cb64224BA4DC94D6A1776455C37c63F53
  </contract_factory_address>
  <source_wallet_parameters>
    <contract_identifier>ID_contract_71</contract_identifier>
    <M_of_N>2-of-3</M_of_N>
    <owner>
      <owner_identifier>ID_user_1</owner_identifier>
      <keyset_identifier>ID_master_key_pair_1</keyset_identifier>
      <keychain_path>m/0/0/1/0</keychain_path>
    </owner>
    <owner>
      <owner_identifier>ID_user_2</owner_identifier>
      <keyset_identifier>ID_master_key_pair_2</keyset_identifier>
      <keychain_path>m/0/0/1/0</keychain_path>
    </owner>
    <owner>
      <owner_identifier>ID_user_3</owner_identifier>
      <keyset_identifier>ID_master_key_pair_3</keyset_identifier>
      <keychain_path>m/0/0/1/0</keychain_path>
    </owner>
  </source_wallet_parameters>
  <source_wallet_contract_data>
    <contract_identifier>ID_contract_71</contract_identifier>
    <bytecode>608060405260405161081...30005100032</bytecode>
    <salt_value>
  0x000000000000000000000000000000000000000000000000000000000000208A
    </salt_value>
    <contract_address>
      0x4Dbba4673520eC3D921818a72d18D8e3C100C824
    </contract_address>
    <contract_deployment_signature>
      ECDSA signature in DER format of ID_user_1
    </contract_deployment_signature>
    <contract_deployment_signature>
      ECDSA signature in DER format of ID_user_2
    </contract_deployment_signature>
    <contract_deployment_signature>
      ECDSA signature in DER format of ID_user_3
    </contract_deployment_signature>
  </source_wallet_contract_data>
  <destination_wallet_parameters>
    <contract_identifier>ID_contract_72</contract_identifier>
    <M_of_N>2-of-3</M_of_N>
    <owner>
      <owner_identifier>ID_user_11</owner_identifier>
      <keyset_identifier>ID_master_key_pair_11</keyset_identifier>
      <keychain_path>m/0/0/1/0</keychain_path>
    </owner>
    <owner>
      <owner_identifier>ID_user_12</owner_identifier>
      <keyset_identifier>ID_master_key_pair_12</keyset_identifier>
      <keychain_path>m/0/0/1/0</keychain_path>
    </owner>
    <owner>
      <owner_identifier>ID_user_13</owner_identifier>
      <keyset_identifier>ID_master_key_pair_13</keyset_identifier>
      <keychain_path>m/0/0/1/0</keychain_path>
    </owner>
  </destination_wallet_parameters>
  <destination_wallet_contract_data>
    <contract_identifier>ID_contract_72</contract_identifier>
    <bytecode>467860405262754161033...45605100999</bytecode>
    <salt_value>
  0x000000000000000000000000000000000000000000000000000000000000319B
    </salt_value>
    <contract_address>
      0x5Dbba4673520eC3D921818a72d18D8e3C100C935
    </contract_address>
    <contract_deployment_signature>
      ECDSA signature in DER format of ID_user_11
    </contract_deployment_signature>
    <contract_deployment_signature>
      ECDSA signature in DER format of ID_user_12
    </contract_deployment_signature>
    <contract_deployment_signature>
      ECDSA signature in DER format of ID_user_13
    </contract_deployment_signature>
  </destination_wallet_contract_data>
</TS_request_message>
```

The cold HSM 15712 may send an SFITS API call 15753 to a cold SFTS module 15714 to request that the cold SFTS module sign the transaction. In one implementation, the SFITS API call may include data such as a request identifier, a request type (e.g., sign message hash), a wallet identifier, a transaction identifier, a transaction hash, a keychain path, transferable data (e.g., partially signed transaction data), encrypted master key share(s), and/or the like. In another implementation, the SFITS API call may include data such as a request identifier, a request type (e.g., sign message hash), a request type (e.g., sign transaction), a transaction identifier, transaction details, contract factory address, source wallet parameters, source wallet contract data, destination wallet parameters, destination wallet contract data, previous transaction signature(s), and/or the like.

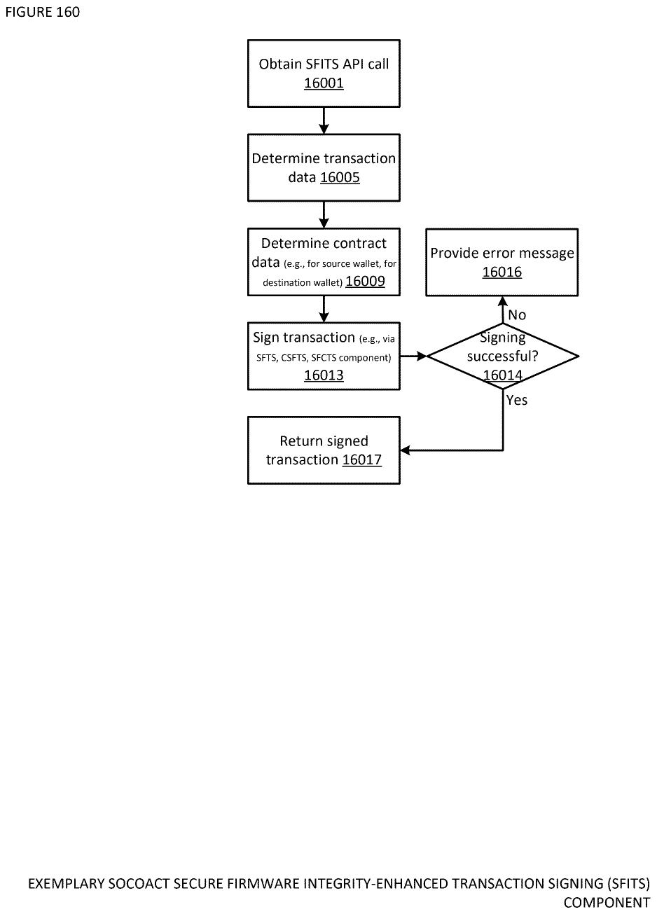

Data provided in the SFITS API call may be used by a secure firmware integrity-enhanced transaction signing (SFITS) component 15757 to sign the transaction (e.g., to generate an ECDSA signature in DER format). In various implementations, the SFITS component may determine a master private key from master key shares, may validate the legitimacy of wallet addresses participating in the blockchain transaction, and/or the like when signing the transaction. See FIG. 160 for additional details regarding the SFITS component.

The cold SFTS module 15714 may send SFITS response data 15761 to the cold HSM 15712 in response to the SFITS API call. In one implementation, the SFITS response data may include an ECDSA signature in DER format.

The cold HSM 15712 may send a TS response message 15765 to the offline TSS server 15710 (e.g., via a HSM Access Provider). In one implementation, the TS response message may include data such as a response identifier, a transaction identifier, a transaction signature, and/or the like. In one embodiment, the cold HSM may provide the following example TS response message, substantially in the form of a HTTP(S) POST message including XML-formatted data, as provided below:

```
POST /TS_response_message.php HTTP/1.1
Host: www.server.com
Content-Type: Application/XML
Content-Length: 667
<?XML version = “1.0” encoding = “UTF-8”?>
<TS_response_message>
  <response_identifier>ID_response_74</response_identifier>
  <transaction_identifier>ID_transaction_71</transaction_identifier>
  <transaction_signature>ECDSA signature in DER
  format</transaction_signature>
</TS_response_message>
```

In one embodiment, the offline TSS server 15710 may send a signed integrity transaction authentication message 15769 to the online TSS server 15704 with the fully signed transaction and/or auxiliary files (e.g., log files, audit trail files, system reports) via an integrity authentication communication channel (e.g., in which the transmitting network device of the offline TSS server is structured to block receiving ports (e.g., at a hardware level)). In another embodiment, the router (e.g., ethernet router, ethernet switch, ethernet hub, fiber router, fiber switch, software based router (e.g., Docker, VyOS, OpenWRT, etc.), etc.) at the site in which the TSS server is disposed in communication with, that router has receiving ports blocked to the TSS server so it is incapable of receiving data. In one implementation, the signed integrity transaction authentication message may include data such as a response identifier, a header file, a response file, an auxiliary file, and/or the like. See FIG. 162 for an example of a header file. In one embodiment, the offline TSS server may provide the following example signed integrity transaction authentication message, substantially in the form of a HTTP(S) POST message including XML-formatted data, as provided below:

```
POST /signed_integrity_transaction_authentication_message.php
HTTP/1.1
Host: www.server.com
Content-Type: Application/XML
Content-Length: 667
<?XML version = “1.0” encoding = “UTF-8”?>
<signed_integrity_transaction_authentication_message>
  <response_identifier>ID_response_73</response_identifier>
  <header_file>
    <workflow_ID>123456</workflow_ID>
    <request_files>
      <file>
        <file_name>tss_in_123456.txt</file_name>
        <file_signature>3045022100EC6...</file_signature>
      </file>
    </request_files>
    <response_files>
      <file>
        <file_name>tss_out_123456.txt</file_name>
        <file_signature>3045022100C05...</file_signature>
      </file>
    </response_files>
    <auxiliary_files>
      <file>
        <file_name>tss_full.log</file_name>
        <file_signature>3044022042992...</file_signature>
      </file>
      <file>
        <file_name>tss_audit.txt</file_name>
        <file_signature>304402204EEED...</file_signature>
      </file>
    </auxiliary_files>
    <checksum>40931F4FC...</checksum>
  </header_file>
  <response_file>
    <file>
      <file_name>tss_out_123456.txt</file_name>
  <transaction_identifier>ID_transaction_71</transaction_identifier>
      <transaction_signature>
        ECDSA signature in DER format
      </transaction_signature>
      <checksum>40931F4FC...</checksum>
    </file>
  </response_file>
  <auxiliary_file>
    <file>
      <file_name>tss_full.log</file_name>
      <file_contents>log file contents</file_contents>
      <checksum>40931F4FC...</checksum>
    </file>
    <file>
      <file_name>tss_audit.txt</file_name>
      <file_contents>audit file contents</file_contents>
      <checksum>40931F4FC...</checksum>
    </file>
  </auxiliary_file>
</signed_integrity_transaction_authentication_message>
```

The online TSS server 15704 may send a TS response 15773 to the client 15702 (e.g., to inform the user that the transaction was processed). In one implementation, the TS response may include data such as a response identifier, a transaction identifier, a transaction signature, a status, and/or the like. In one embodiment, the online TSS server may provide the following example TS response, substantially in the form of a HTTP(S) POST message including XML-formatted data, as provided below:

```
POST /TS_response.php HTTP/1.1
Host: www.server.com
Content-Type: Application/XML
Content-Length: 667
<?XML version = “1.0” encoding = “UTF-8”?>
<TS_response>
  <response_identifier>ID_response_71</response_identifier>
  <transaction_identifier>ID_transaction_71</transaction_identifier>
  <transaction_signature>ECDSA signature in DER
  format</transaction_signature>
  <status>OK</status>
</TS_response>
```

FIG. 158 shows non-limiting, example embodiments of a logic flow illustrating an online transaction server integrity-enhanced transaction signing (NTSITS) component for the SOCOACT. In FIG. 158, a transaction signing request may be obtained at 15801. For example, the transaction signing request may be obtained as a result of a user utilizing a UI of a fund transfer program to initiate transaction signing (e.g., a fund transfer EOA transaction on Ethereum blockchain, a fund transfer transaction between a source wallet and a destination wallet) via an online TSS server.

Transaction details associated with the transaction signing request may be determined at 15805. For example, transaction details may include a wallet identifier, a transaction identifier, a transaction hash, a keychain path, a transaction amount, gas price, gas limit, a nonce, source wallet parameters, destination wallet parameters, and/or the like. In one implementation, the transaction signing request may be parsed (e.g., using PHP commands) to determine the transaction details (e.g., based on the value of the TS_request field).

In some implementations (e.g., where wallet address verification is utilized), contract data (e.g., for the source wallet and/or for the destination wallet) may be retrieved at 15809. In one implementation, the contract data may be retrieved from the contracts database table 17319s. For example, the contract data for the source wallet may be retrieved via a MySQL database command similar to the following:

SELECT contractCode, contractSalt, contractAddress,
contractDeploymentSignatures, contractContractFactoryAddress
FROM Contracts
WHERE contractID = ID_contract_71;

In another example, the contract data for the destination wallet may be retrieved via a MySQL database command similar to the following:

SELECT contractCode, contractSalt, contractAddress,
contractDeploymentSignatures, contractContractFactoryAddress
FROM Contracts
WHERE contractID = ID_contract_72;

A transaction signing request package may be generated at 15813. For example, the transaction signing request package may include a workflow ID, the transaction details, the contract data, a checksum (e.g., of the contents of the transaction signing request package file), and/or the like. See FIG. 161 for an example of a transaction signing request package that may be generated. In one implementation, the transaction signing request package may be formed and/or temporarily stored on the online TSS server.

The transaction signing request package may be output (e.g., as a set of QR codes) to a barcode medium at 15817. In various implementations, the barcode medium may be printed (e.g., on paper), displayed (e.g., on a screen), and/or the like. See FIG. 161 for an example of a QR code that may be generated. It is to be understood that one or multiple QR codes may be generated (e.g., depending on the size of data in the transaction signing request package), and that each barcode medium may comprise one or multiple QR codes. The barcode medium may include additional data such as a QR code index number, total number of QR codes, error detection/correction data, and/or the like. For example, such additional data may be used to facilitate reconstruction of the transaction signing request package from multiple QR codes.

A determination may be made at 15821 whether a signed integrity transaction authentication message corresponding (e.g., based on the workflow ID) to the transaction signing request package was received (e.g., from an offline TSS server via an integrity authentication communication channel). In one embodiment, the following (e.g., Java) method may be available to the online TSS server to check for signed integrity transaction authentication messages:

```
FileProcessor.receive( ): List<File> - this periodically invoked method
returns a list of fully qualified names of files, received via the integrity
authentication communication channel.
  Input:
    void
  Output:
    fully qualified names of received files
```

If not received, the SOCOACT may wait at 15825 until the corresponding signed integrity transaction authentication message is received.

If received, the signed integrity transaction authentication message corresponding to the transaction signing request package may be validated at 15829. In one implementation, a transaction signing response package sent via the signed integrity transaction authentication message may be processed to determine a header file. The header file may be parsed (e.g., using PHP commands) to determine data such as: a list of request file names along with generated signatures of their hash codes, a list of response file names along with generated signatures of their hash codes, a list of auxiliary file names along with generated signatures of their hash codes, and/or the like. A signature validation public key (e.g., associated with a cold HSM) may be determined and used to validate files specified in the transaction signing response package. For example, a request file (e.g., provided in the transaction signing request package) specified in the header file may be validated by decrypting the signature of the request file with the signature validation public key and verifying that the decrypted hash code matches the hash code (e.g., a checksum) for the request file temporarily stored on the online TSS server. In another example, a response file (e.g., a fully signed transaction file) or an auxiliary file (e.g., a log file, an audit trail file, a system report file) specified in the header file may be validated by calculating a hash code (e.g., a checksum) of the response file or of the auxiliary file, decrypting the signature of the response file or of the auxiliary file with the signature validation public key, and verifying that the decrypted hash code matches the calculated hash code.

A determination may be made at 15833 whether the transaction signing request was authorized. In one implementation, if any of the files in the transaction signing response package fail validation, the transaction signing request may be unauthorized. If the transaction signing request was not authorized, an error message may be generated at 15837. For example, the error message may specify the error that occurred (e.g., file in the transaction signing response package failed validation). A warning message may be provided to the user and/or an action may be triggered at 15841. In one implementation, a warning message based on the generated error message may be provided to the user to inform the user regarding the error. In another implementation, an action may be triggered based on a specified condition (e.g., a file failed validation). For example, the triggered action may be to resubmit the file for new transfer or to repeat the whole procedure.

If the transaction signing request was authorized, the transaction may be submitted to a blockchain (e.g., the Ethereum blockchain) at 15845. In one implementation, the transaction may be broadcast to the blockchain via a blockchain transaction request.

Auxiliary files may be submitted to a monitoring system at 15849. In one implementation, the log, audit and system report files may be forwarded to the enterprise monitoring tools.

A transaction signing response may be provided to the user's client at 15853. In one implementation, a transaction signing response may be sent to inform the user whether the transaction signing was completed successfully (e.g., via a UI of the fund transfer program).

FIG. 159 shows non-limiting, example embodiments of a logic flow illustrating an offline transaction server integrity-enhanced transaction signing (FTSITS) component for the SOCOACT. In FIG. 159, a transaction signing request package may be obtained at 15901. For example, the transaction signing request package may be obtained as a result of a user utilizing an optical reader (e.g., a barcode reader, a camera) to import the transaction signing request package from a barcode medium (e.g., a paper with a QR code, a display screen with a QR code) to facilitate transaction signing. It is to be understood that one or multiple barcode mediums may be scanned to import the transaction signing request package, and that each barcode medium may comprise one or multiple QR codes. In one implementation, a set of QR codes (e.g., with each QR code encoding a subset of data) may be scanned (e.g., serially using a barcode reader, in parallel using a camera and QR detection and/or decoding techniques to detect and/or decode multiple QR codes on a barcode medium simultaneously) and the determined data subsets may be combined in accordance with page and/or index numbers to reconstruct the transaction signing request package.

Transaction details associated with the transaction signing request package may be determined at 15905. For example, transaction details may include a wallet identifier, a transaction identifier, a transaction hash, a keychain path, a transaction amount, gas price, gas limit, a nonce, source wallet parameters, destination wallet parameters, and/or the like. In one implementation, the transaction signing request package may be parsed (e.g., using PHP commands) to determine the transaction details (e.g., based on the value of the request_file field).

In some implementations (e.g., where wallet address verification is utilized), contract data (e.g., for the source wallet and/or for the destination wallet) associated with the transaction signing request package may be determined at 15909. For example, contract data may include contract code, a salt value, a contract address, a set of contract deployment signatures, a deployment factory address, and/or the like. In one implementation, the transaction signing request package may be parsed (e.g., using PHP commands) to determine the contract data (e.g., based on the value of the request_file field).

Transaction signing may be requested from a cold HSM (e.g., via TSTS, FTSTS, TSCTS component) at 15913. In one implementation, a transaction signing request message may be sent to the cold HSM to request transaction signing. It is to be understood that, in various embodiments, transaction signing may be performed in a variety of ways (e.g., as discussed with regard to TSTS, FTSTS, TSCTS components).

A determination may be made at 15917 whether the transaction signing request was authorized by the cold HSM. In one implementation, one or more operators (e.g., based on M-of-N authentication) may have to approve (e.g., via an authentication entry device associated with the cold HSM) the transaction signing request for the request to be authorized. In some implementations (e.g., where wallet address verification is utilized), the cold HSM may validate the legitimacy of wallet addresses participating in the blockchain transaction before signing the transaction.

If the transaction signing request was not authorized, an error message may be generated at 15921. For example, the error message may specify the error that occurred (e.g., request to export encrypted master private key share is not authorized, source wallet address and/or destination wallet address cannot be validated). A warning message may be provided to the user and/or an action may be triggered at 15925. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with a wallet.

A determination may be made at 15929 whether there remain files to process for a transaction signing response package. In one implementation, each of the files associated with the transaction signing response package (e.g., header files, request files, response files, auxiliary files) may be processed. If there remain files to process, the next file associated with the transaction signing response package may be selected for processing at 15933.

A hash code of the selected file may be generated at 15937. In one implementation, a checksum of the file's contents may be calculated and used as the hash code. File hash code signing may be requested from the cold HSM at 15941. In one implementation, the hash code of the selected file may be signed in a similar manner as discussed with regard to signing a transaction hash. For example, the hash code may be encrypted with a signature validation private key (e.g., associated with the cold HSM).

A signed integrity transaction authentication message may be generated at 15945. In one embodiment, the signed integrity transaction authentication message may comprise the transaction signing response package. For example, the transaction signing response package may comprise a header file, a set of response files, a set of auxiliary files, and/or the like. See FIG. 162 for an example of a header file that may be generated for the transaction signing response package. In one implementation, the transaction signing response package may be formed and/or temporarily stored on the offline TSS server.

The signed integrity transaction authentication message may be provided to the online TSS server at 15949. In one implementation, the signed integrity transaction authentication message may be sent to the online TSS server using an integrity authentication communication channel. In one embodiment, the following (e.g., Java) method may be available to the offline TSS server to send signed integrity transaction authentication messages:

```
FileProcessor.send(List<File>) - this method receives a list of full
pathnames of the files to be transferred using an integrity authentication
communication channel, opens the network connection on a
pre-configured port, and sends the files to the receiver.
  Input:
    List of files to be transferred
  Output:
    Void method, no output. Throws an exception in case of a failure.
```

FIG. 160 shows non-limiting, example embodiments of a logic flow illustrating a secure firmware integrity-enhanced transaction signing (SFITS) component for the SOCOACT. In FIG. 160, a SFITS API call may be obtained at 16001. For example, the SFITS API call may be obtained as a result of a call from a cold HSM associated with the SFITS component. In various embodiments, a variety of API methods may be available to sign a transaction (e.g., signMessageHash,/transaction/sign).

Transaction data may be determined at 16005. In one implementation, the transaction data may be provided in the SFITS API call and may include a wallet identifier, a transaction identifier, a transaction hash, a keychain path, a transaction amount, gas price, gas limit, a nonce, source wallet parameters, destination wallet parameters, and/or the like.

In some implementations (e.g., where wallet address verification is utilized), contract data (e.g., for the source wallet and/or for the destination wallet) may be determined at 16009. In one implementation, the contract data may be provided in the SFITS API call and may include contract code, a salt value, a contract address, a set of contract deployment signatures, a deployment factory address, and/or the like.

The transaction may be signed (e.g., via SFTS, CSFTS, SFCTS component) at 16013. It is to be understood that, in various embodiments, transaction signing may be performed in a variety of ways (e.g., as discussed with regard to SFTS, CSFTS, SFCTS components).

A determination may be made at 16014 whether the transaction signing was successful. If an error was detected during the transaction signing, a corresponding error message may be provided to a user at 16016 to inform the user regarding the error.

The signed transaction may be returned at 16017. In one implementation, the ECDSA signature in DER format may be returned.

FIG. 161 shows non-limiting, example embodiments of implementation case(s) for the SOCOACT. In FIG. 161, an exemplary transaction signing request package file and a corresponding QR code encoding the transaction signing request package file that may be generated on a barcode medium are illustrated. The transaction signing request package file may include data fields such as date, workflow ID, keychain path (e.g., source keyset ID, destination keyset ID), transaction data (e.g., number of outputs, total amount of outputs), page index, total number of pages, checksum, and/or the like.

FIG. 162 shows non-limiting, example embodiments of implementation case(s) for the SOCOACT. In FIG. 162, an exemplary transaction signing response package header file corresponding to the transaction signing request package file discussed with regard to FIG. 161 is illustrated. The transaction signing response package header file may include data fields such as date, workflow ID, list of file names along with signatures of their hash codes (e.g., for request files, response files, auxiliary files), checksum, and/or the like.

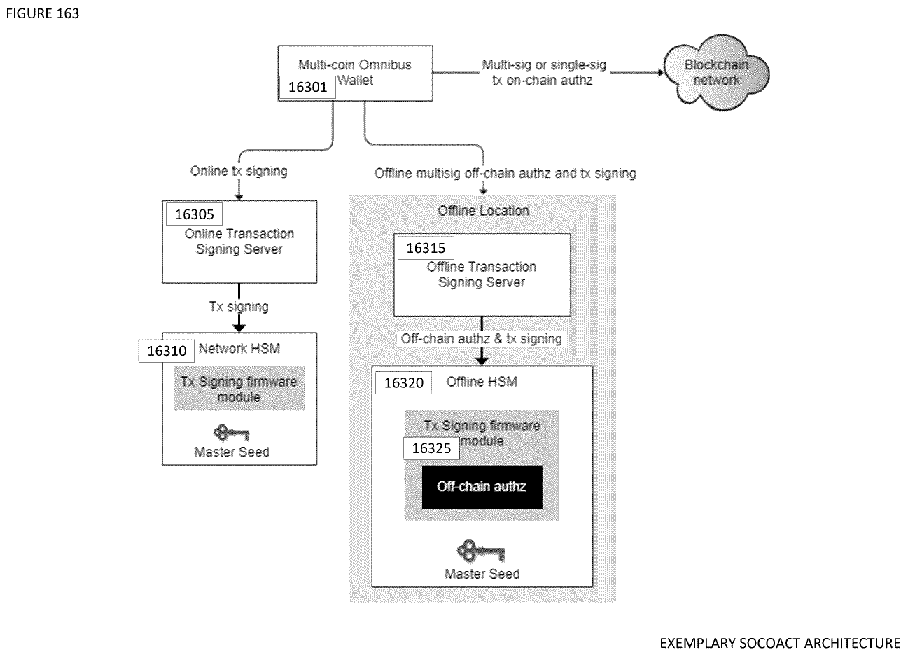

FIG. 163 shows non-limiting, example embodiments of an architecture for the SOCOACT. In FIG. 163, an embodiment of a multisig transaction signing architecture is illustrated. In one implementation, the multisig architecture comprises components including: a wallet application (multi-coin omnibus wallet) 16301, an online transaction signing server (TSS) 16305 and a hot HSM 16310, an offline TSS 16315 and a cold HSM 16320. An m-of-n scheme may have multiple online and/or offline TSS & HSM instances. For a 3-of-4 example, there may be one online and three offline locations of identical offline TSS and cold HSM deployment. Each HSM stores a unique master private seed which participates in a multisig transaction authorization and signing process. Each master public seed may be stored on each HSM device. A custom firmware module is utilized on HSMs to perform on-board signing and off-chain authorization in cold storage.

In one implementation, the wallet application may be a hosted omnibus HD wallet application that supports multiple crypto currencies. Its functions may include: initiate transaction, request and coordinate multisig signing to online and offline transaction signing servers across multiple online and offline locations, manage transactions and wallet, submit fully signed transaction to blockchain for on-chain authorization and confirmation.

In one implementation, the online TSS comprises an online transaction signing application and the hot HSM (e.g., a network HSM appliance). In one implementation, the offline TSS resides in an offline location where a transaction signing application and the offline (cold) HSM device are hosted on a (e.g., desktop) machine without any network connectivity and manual access is allowed with strict cyber and physical security controls, usually considered as air-gapped “Cold” storage. HSMs may provide cryptographic key storage such that master seeds on those FIPS 140-2 level 3 compliant hardware devices are securely protected. Each HSM acts as a transaction signing device which runs a custom firmware module 16325 to perform on-board BIP32 key derivation and ECDSA signing operations. For the offline HSM, the custom firmware module is also the enforcement point of off-chain authorization for on-chain single-sig transaction signing.

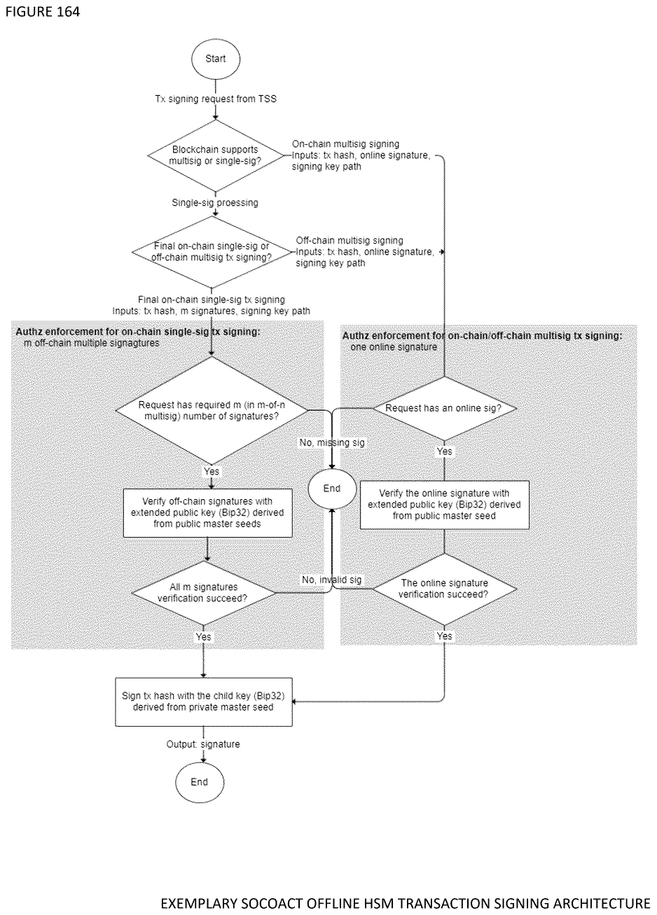

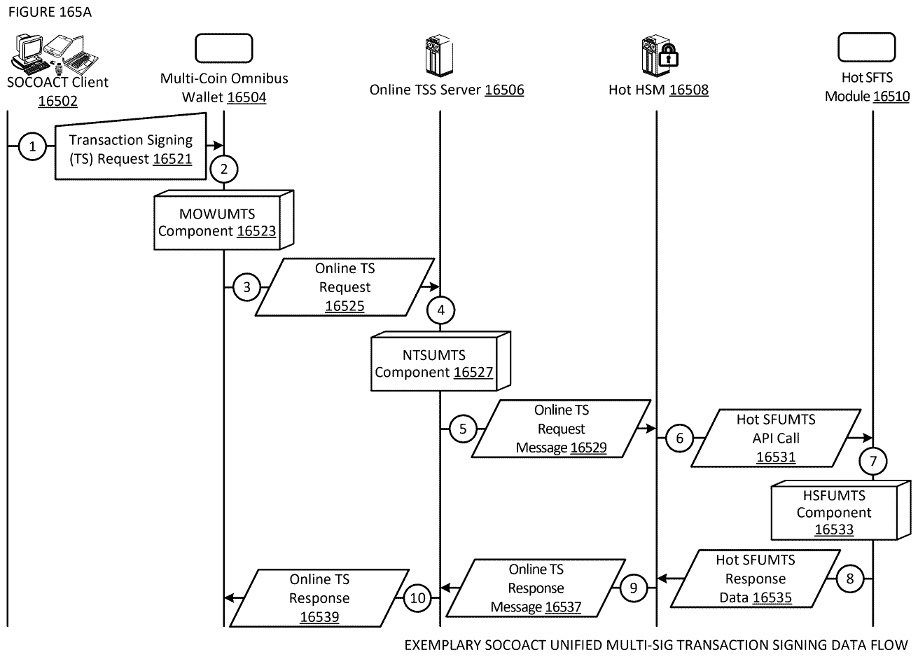

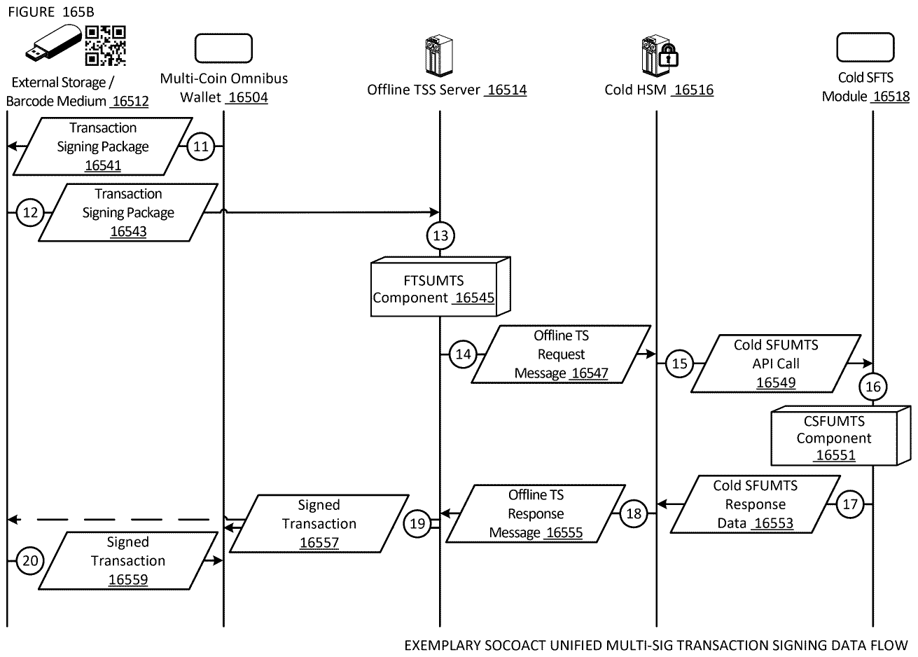

FIG. 164 shows non-limiting, example embodiments of an architecture for the SOCOACT. In FIG. 164, an embodiment of an offline HSM transaction signing architecture is illustrated. In one implementation, a custom firmware module may be implemented and installed on each offline HSM device (e.g., on each of the three offline HSMs for the 3-of-4 example) to enforce multisig off-chain authorization for single-sig on-chain transactions by verifying a transaction hash with a specified number of off-chain signatures using extended public keys. The off-chain authorization implementation may utilize ECDSA signature verification calls to built-in crypto functions natively supported in a FIPS 140-2 HSM.

In some embodiments, the custom firmware module may be implemented to perform the following operations to secure transaction signing:
1301.1. For any signing (on-chain or off-chain) it verifies that the first online signature is present and valid to verify the presence of one online signature in the multisig transaction and the transportation data's integrity in initiating a fund transfer operational process initiated from online transaction creation.
1301.2. Performs the BIP32 public and private key derivation to generate a transient child key from the non-extractable master seed on the HSM and uses the derived private key for transaction signing and the public one for signature verification. The offline HSM is hardened to enforce that transaction signing using the master private seed goes through this firmware module.

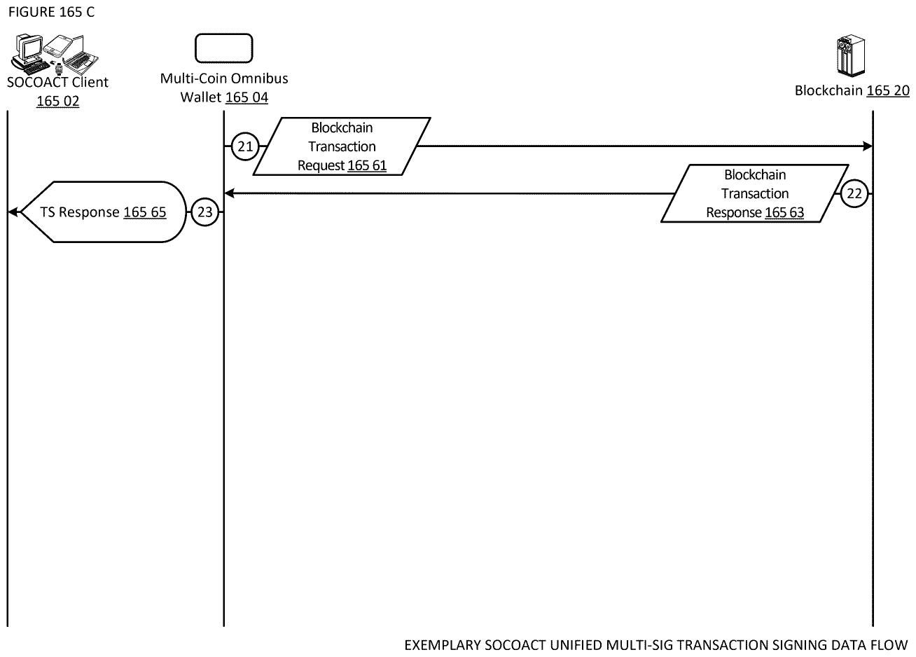

FIGS. 165A-C show non-limiting, example embodiments of a datagraph illustrating data flow(s) for the SOCOACT. In FIGS. 165A-C, dashed lines indicate data flow elements that may be more likely to be optional. In FIGS. 165A-C, a SOCOACT client 16502 (e.g., of a user) may send a transaction signing (TS) request 16521 to a multi-coin omnibus wallet 16504 to request that a transaction be signed. For example, the SOCOACT client may be a desktop, a laptop, a tablet, a smartphone, a smartwatch, and/or the like that is executing a client application. In one implementation, the TS request may include data such as a request identifier, user authentication data, a request type (e.g., sign message hash), a wallet identifier, source wallet parameters, destination wallet parameters, a transaction identifier, transaction details, a transaction hash, a keychain path, and/or the like. In one embodiment, the SOCOACT client may provide the following example TS request, substantially in the form of a HTTP(S) POST message including XML-formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name> JohnDaDoeDoeDoooe@gmail.com</account_name>
      <password>abc123</password>
      //OPTIONAL <cookie>cookieID</cookie>
      //OPTIONAL <digital_cert_link>www.mydigitalcertificate.com/
JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <TS_request>
    <request_identifier>ID_request_81</request_identifier>
    <request_type>SIGN_TRANSACTION</request_type>
    <wallet_identifier>ID_wallet_81</wallet_identifier>
    <transaction_identifier>ID_transaction_81</transaction_identifier>
    <transaction_details>
      blockchain type (e.g., Bitcoin, Ethereum), transaction amount,
etc.
    </transaction_details>
    <transaction_hash>256-bit hash value to be signed</transaction_hash>
    <keychain_path>m/0/0/1/0</keychain_path>
  </TS_request>
</auth_request>
```

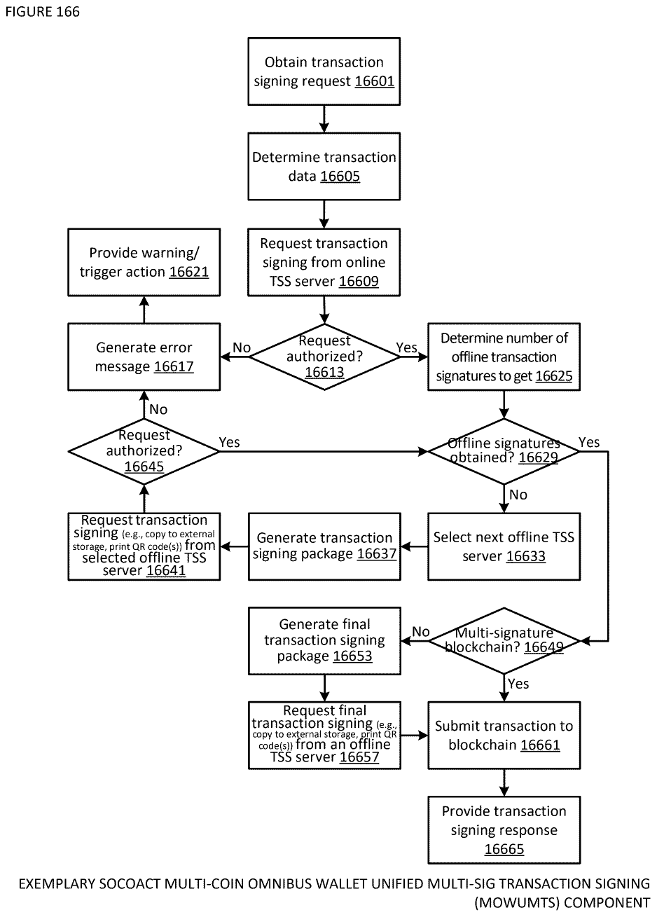

A multi-coin omnibus wallet unified multi-sig transaction signing (MOWUMTS) component 16523 may utilize parameters provided in the TS request to facilitate transaction signing. See FIG. 166 for additional details regarding the MOWUMTS component.

The multi-coin omnibus wallet 16504 may send an online TS request 16525 to an online TSS server 16506 to request online transaction signing for the transaction. For example, the multi-coin omnibus wallet may be a component hosted on and/or integrated into a separate server, the online TSS server, the SOCOACT client, and/or the like. It is to be understood that one or multiple online TS requests may be sent to one or more online TSS servers depending on the number of online transaction signatures desired (e.g., a separate online TS request may be sent to a separate online TSS server for each desired online transaction signature). In one implementation, the online TS request may include data such as a request identifier, a request type (e.g., sign message hash), a wallet identifier, source/destination wallet parameters, a transaction identifier, transaction details, a transaction hash, a keychain path, and/or the like. In one embodiment, the multi-coin omnibus wallet may provide the following example online TS request, substantially in the form of a HTTP(S) POST message including XML-formatted data, as provided below:

```
POST /online_TS_request.php HTTP/1.1
Host: www.server.com
Content-Type: Application/XML
Content-Length: 667
<?XML version = “1.0” encoding = “UTF-8”?>
<online_TS_request>
  <request_identifier>ID_request_82</request_identifier>
  <request_type>SIGN_TRANSACTION</request_type>
  <wallet_identifier>ID_wallet_81</wallet_identifier>
  <transaction_identifier>ID_transaction_81</transaction_identifier>
  <transaction_details>
    blockchain type (e.g., Bitcoin, Ethereum), transaction amount, etc.
  </transaction_details>
  <transaction_hash>256-bit hash value to be signed</transaction_hash>
  <keychain_path>m/0/0/1/0</keychain_path>
</online_TS_request>
```

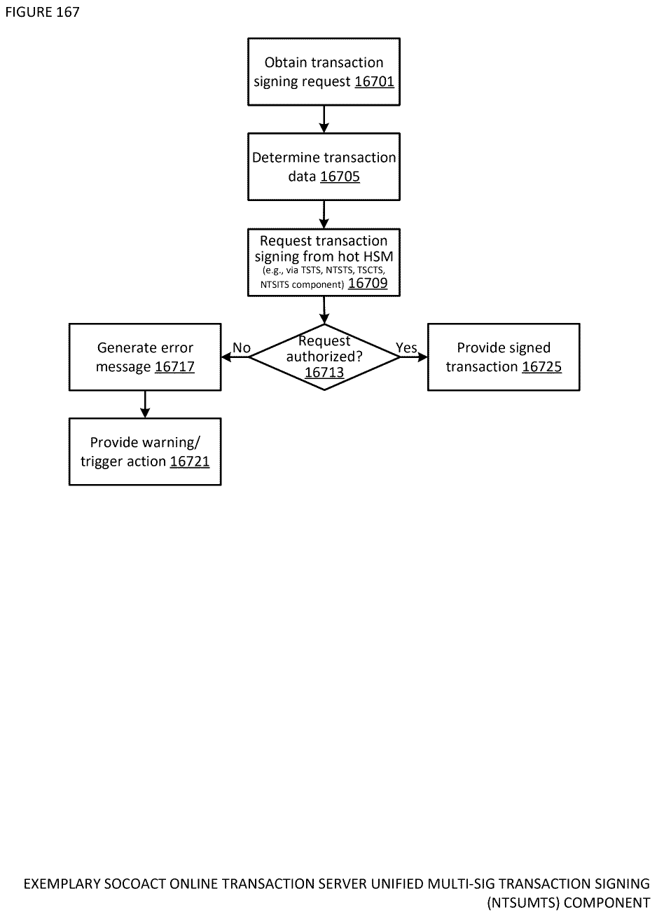

An online transaction server unified multi-sig transaction signing (NTSUMTS) component 16527 may utilize parameters provided in the online TS request to facilitate online transaction signing. See FIG. 167 for additional details regarding the NTSUMTS component.

The online TSS server 16506 may send an online TS request message 16529 to a hot HSM 16508 to request that the hot HSM sign the transaction. In one implementation, the online TS request message may be sent via a HSM Access Provider and may include data such as a request identifier, a request type (e.g., sign message hash), a wallet identifier, contract factory address, source/destination wallet parameters/contract data, previous transaction signature(s), a transaction identifier, transaction details, a transaction hash, a keychain path, transferable data, encrypted master key share(s), and/or the like. In one embodiment, the online TSS server may provide the following example online TS request message, substantially in the form of a HTTP(S) POST message including XML-formatted data, as provided below:

```
POST /online_TS_request_message.php HTTP/1.1
Host: www.server.com
Content-Type: Application/XML
Content-Length: 667
<?XML version = “1.0” encoding = “UTF-8”?>
<online_TS_request_message>
  <request_identifier>ID_request_83</request_identifier>
  <request_type>SIGN_TRANSACTION</request_type>
  <wallet_identifier>ID_wallet_81</wallet_identifier>
  <transaction_identifier>ID_transaction_81</transaction_identifier>
  <transaction_details>
    blockchain type (e.g., Bitcoin, Ethereum), transaction amount, etc.
  </transaction_details>
  <transaction_hash>256-bit hash value to be signed</transaction_hash>
  <keychain_path>m/0/0/1/0</keychain_path>
</online_TS_request_message>
```

The hot HSM 16508 may send a hot SFUMTS API call 16531 to a hot SFTS module 16510 to request that the hot SFTS module sign the transaction. In one implementation, the hot SFUMTS API call may include data such as a request identifier, a request type (e.g., sign message hash), a wallet identifier, contract factory address, source/destination wallet parameters/contract data, previous transaction signature(s), a transaction identifier, transaction details, a transaction hash, a keychain path, transferable data, encrypted master key share(s), and/or the like.

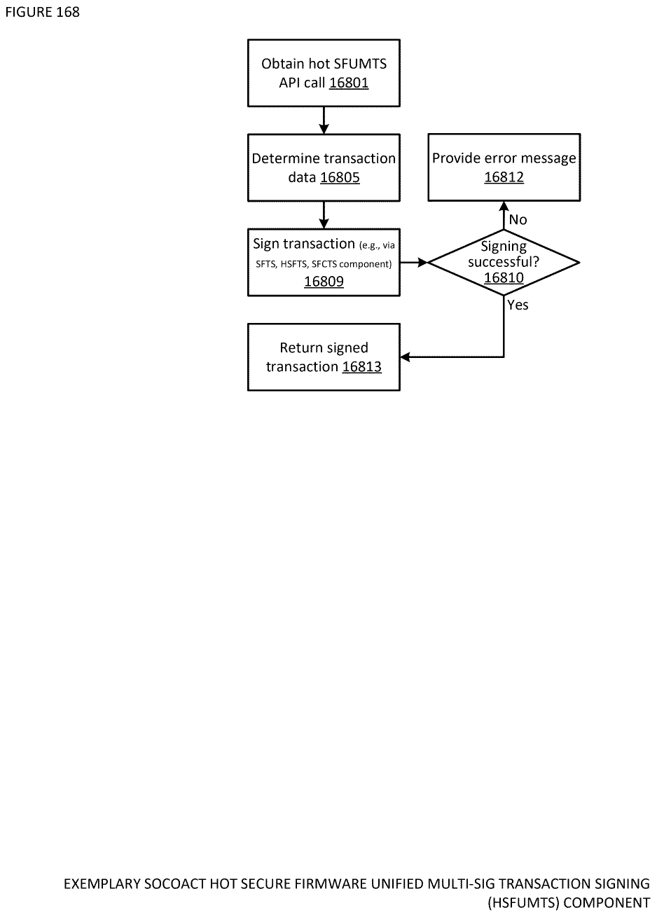

Data provided in the hot SFUMTS API call may be used by a hot secure firmware unified multi-sig transaction signing (HSFUMTS) component 16533 to sign the transaction (e.g., to generate an ECDSA signature in DER format). In various implementations, the HSFUMTS component may determine a master private key from master key shares, may validate the legitimacy of wallet addresses participating in the blockchain transaction, and/or the like when signing the transaction. See FIG. 168 for additional details regarding the HSFUMTS component.

The hot SFTS module 16510 may send a hot SFUMTS response data 16535 to the hot HSM 16508 in response to the hot SFUMTS API call. In one implementation, the hot SFUMTS response data may include an ECDSA signature in DER format.

The hot HSM 16508 may send an online TS response message 16537 to the online TSS server 16506 (e.g., via a HSM Access Provider). In one implementation, the online TS response message may include data such as a response identifier, a transaction identifier, a transaction signature, and/or the like. In one embodiment, the hot HSM may provide the following example online TS response message, substantially in the form of a HTTP(S) POST message including XML-formatted data, as provided below:

```
POST /online_TS_response_message.php HTTP/1.1
Host: www.server.com
Content-Type: Application/XML
Content-Length: 667
<?XML version = “1.0” encoding = “UTF-8”?>
<online_TS_response_message>
  <response_identifier>ID_response_83</response_identifier>
  <transaction_identifier>ID_transaction_81</transaction_identifier>
  <transaction_signature>ECDSA signature in DER format</transaction_signature>
</online_TS_response_message>
```

The online TSS server 16506 may send an online TS response 16539 to the multi-coin omnibus wallet 16504 with the requested online transaction signature. In one implementation, the online TS response may include data such as a response identifier, a transaction identifier, a transaction signature, and/or the like. In one embodiment, the online TSS server may provide the following example online TS response, substantially in the form of a HTTP(S) POST message including XML-formatted data, as provided below:

```
POST /online_TS_response.php HTTP/1.1
Host: www.server.com
Content-Type: Application/XML
Content-Length: 667
<?XML version = “1.0” encoding = “UTF-8”?>
<online_TS_response>
  <response_identifier>ID_response_82</response_identifier>
  <transaction_identifier>ID_transaction_81</transaction_identifier>
  <transaction_signature>ECDSA signature in DER format</transaction_signature>
</online_TS_response>
```

The multi-coin omnibus wallet 16504 may generate and/or export (e.g., copy to an external storage device, print to a barcode medium) a transaction signing package 16541 to an external storage device/barcode medium 16512. It is to be understood that one or multiple transaction signing packages may be sent to one or more offline TSS servers depending on the number of offline transaction signatures desired (e.g., a transaction signing package (e.g., the same transaction package, different transaction signing packages) may be sent to a separate offline TSS server for each desired offline transaction signature). In one implementation, the transaction signing package may include data such as a request identifier, a workflow ID, a request type (e.g., sign message hash), a request subtype (e.g., non-final transaction signing, final transaction signing), a wallet identifier, contract factory address, source/destination wallet parameters/contract data, previous transaction signature(s), a transaction identifier, transaction details, a transaction hash, a keychain path, transferable data, encrypted master key share(s), a checksum, and/or the like. In one embodiment, the multi-coin omnibus wallet may generate the following example transaction signing package, substantially in the form of a HTTP(S) POST message including XML-formatted data, as provided below:

```
POST /transaction_signing_package.php HTTP/1.1
Host: www.server.com
Content-Type: Application/XML
Content-Length: 667
<?XML version = “1.0” encoding = “UTF-8”?>
<transaction_signing_package>
  <request_identifier>ID_request_85</request_identifier>
  <workflow_ID>234567</workflow_ID>
  <request_file>
    <file>
      <file_name>in_234567.txt</file_name>
      <request_type>SIGN_TRANSACTION</request_type>
  <request_subtype>NON_FINAL_TRANSACTION_SIGNING</request_subtype>
      <wallet_identifier>ID_Wallet_81</wallet_identifier>
  <transaction_identifier>ID_transaction_81</transaction_identifier>
      <transaction_details>
        blockchain type (e.g., Bitcoin, Ethereum), transaction amount,
etc.
      </transaction_details>
      <transaction_hash>256-bit hash value to be
signed</transaction_hash>
      <keychain_path>m/0/0/1/0</keychain_path>
      <transaction_signatures>
        previous hot HSM and/or cold HSM signed transaction
signatures
      </transaction_signatures>
      <checksum>51141E2AB...</checksum>
    </file>
  </request_file>
</transaction_signing_package>
```

An offline TSS server 16514 may import (e.g., copy from the external storage device, read from the barcode medium via an optical reader) and/or reconstruct the transaction signing package 16543 from the external storage device/barcode medium 16512. In one implementation, the user may utilize the offline TSS server (e.g., an offline transaction signing runtime) to request that the transaction be signed using the transaction signing package (e.g., resulting in the importing).

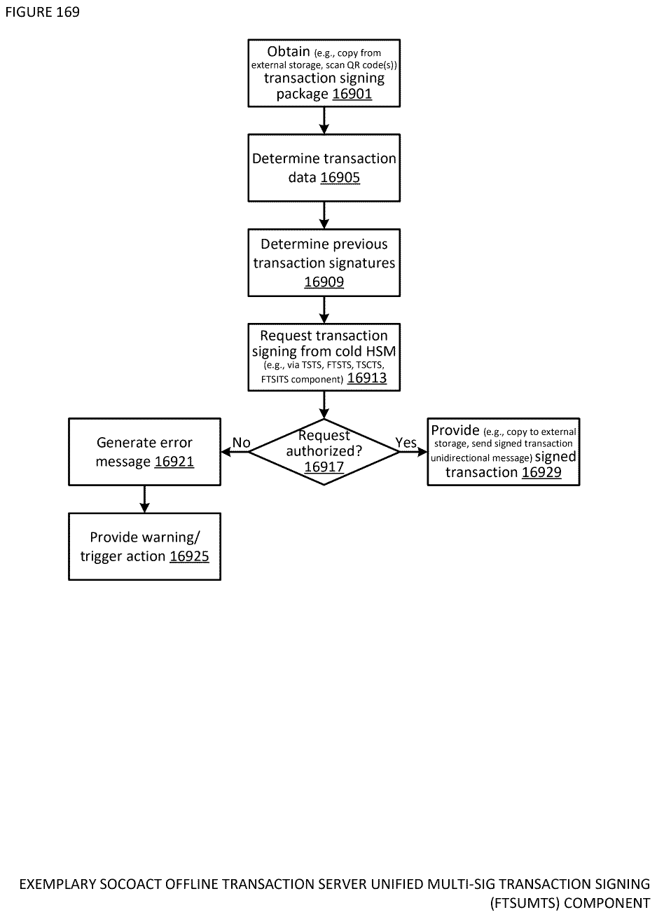

An offline transaction server unified multi-sig transaction signing (FTSUMTS) component 16545 may utilize the transaction signing package to facilitate transaction signing. See FIG. 169 for additional details regarding the FTSUMTS component.

The offline TSS server 16514 may send an offline TS request message 16547 to a cold HSM 16516 to request that the cold HSM sign the transaction. In one implementation, the offline TS request message may be sent via a HSM Access Provider and may include data such as a request identifier, a request type (e.g., sign message hash), a request subtype (e.g., non-final transaction signing, final transaction signing), a wallet identifier, contract factory address, source/destination wallet parameters/contract data, previous transaction signature(s), a transaction identifier, transaction details, a transaction hash, a keychain path, transferable data, encrypted master key share(s), and/or the like. In one embodiment, the offline TSS server may provide the following example offline TS request message, substantially in the form of a HTTP(S) POST message including XML-formatted data, as provided below:

```
POST /offline_TS_request_message.php HTTP/1.1
Host: www.server.com
Content-Type: Application/XML
Content-Length: 667
<?XML version = “1.0” encoding = “UTF-8”?>
<offline_TS_request_message>
  <request_identifier>ID_request_86</request_identifier>
  <request_type>SIGN_TRANSACTION</request_type>
  <request_subtype>NON_FINAL_TRANSACTION_SIGNING</request_subtype>
  <wallet_identifier>ID_Wallet_81</wallet_identifier>
  <transaction_identifier>ID_transaction_81</transaction_identifier>
  <transaction_details>
    blockchain type (e.g., Bitcoin, Ethereum), transaction amount, etc.
  </transaction_details>
  <transaction_hash>256-bit hash value to be signed</transaction_hash>
  <keychain_path>m/0/0/1/0</keychain_path>
  <transaction_signatures>
    previous hot HSM and/or cold HSM signed transaction signatures
  </transaction_signatures>
</offline_TS_request_message>
```

The cold HSM 16516 may send a cold SFUMTS API call 16549 to a cold SFTS module 16518 to request that the cold SFTS module sign the transaction. In one implementation, the cold SFUMTS API call may include data such as a request identifier, a request type (e.g., sign message hash), a request subtype (e.g., non-final transaction signing, final transaction signing), a wallet identifier, contract factory address, source/destination wallet parameters/contract data, previous transaction signature(s), a transaction identifier, transaction details, a transaction hash, a keychain path, transferable data, encrypted master key share(s), and/or the like.

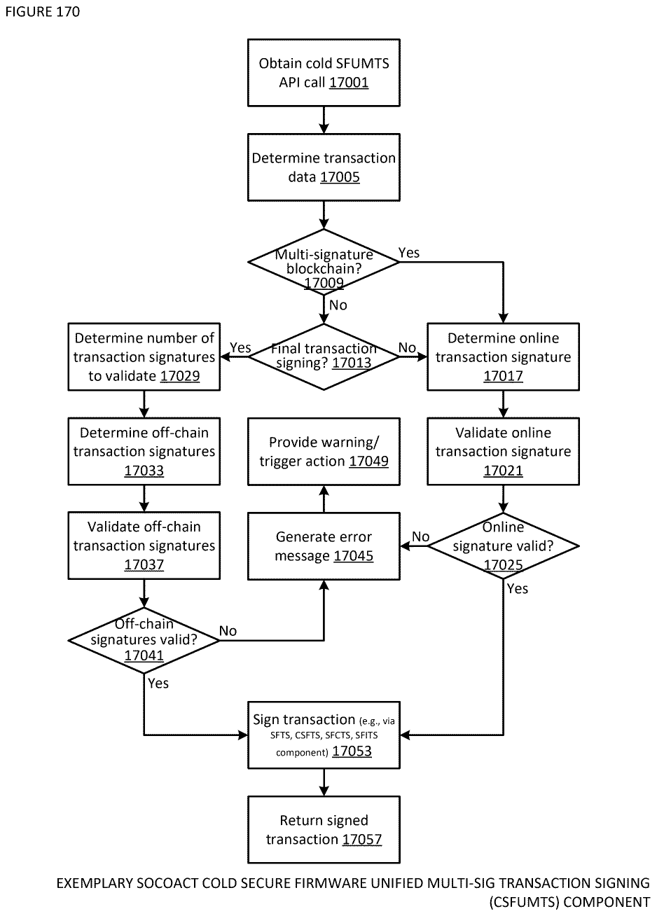

Data provided in the cold SFUMTS API call may be used by a cold secure firmware unified multi-sig transaction signing (CSFUMTS) component 16551 to sign the transaction (e.g., to generate an ECDSA signature in DER format). In various implementations, the CSFUMTS component may determine a master private key from master key shares, may validate the legitimacy of wallet addresses participating in the blockchain transaction, and/or the like when signing the transaction. See FIG. 170 for additional details regarding the CSFUMTS component.

The cold SFTS module 16518 may send a cold SFUMTS response data 16553 to the cold HSM 16516 in response to the cold SFUMTS API call. In one implementation, the cold SFUMTS response data may include an ECDSA signature in DER format.

The cold HSM 16516 may send an offline TS response message 16555 to the offline TSS server 16514 (e.g., via a HSM Access Provider). In one implementation, the offline TS response message may include data such as a response identifier, a transaction identifier, a transaction signature, and/or the like. In one embodiment, the cold HSM may provide the following example offline TS response message, substantially in the form of a HTTP(S) POST message including XML-formatted data, as provided below:

```
POST /offline_TS_response_message.php HTTP/1.1
Host: www.server.com
Content-Type: Application/XML
Content-Length: 667
<?XML version = “1.0” encoding = “UTF-8”?>
<offline_TS_response_message>
  <response_identifier>ID_response_86</response_identifier>
  <transaction_identifier>ID_transaction_81</transaction_identifier>
  <transaction_signature>ECDSA signature in DER format</transaction_signature>
</offline_TS_response_message>
```

In one embodiment, the offline TSS server 16514 may send a signed integrity transaction authentication message 16557 to the multi-coin omnibus wallet 16504 (e.g., to a machine hosting the multi-coin omnibus wallet) with the signed transaction and/or other data via an integrity authentication communication channel (e.g., in which the transmitting network device of the offline TSS server is structured to block receiving ports (e.g., at a hardware level)). In one implementation, the signed integrity transaction authentication message may include data such as a response identifier, a header file, a response file, an auxiliary file, and/or the like. For example, the offline TSS server may provide the following example signed integrity transaction authentication message, substantially in the form of a HTTP(S) POST message including XML-formatted data, as provided below:

```
POST /signed_integrity_transaction_authentication_message.php HTTP/1.1
Host: www.server.com
Content-Type: Application/XML
Content-Length: 667
<?XML version = “1.0” encoding = “UTF-8”?>
<signed_integrity_transaction_authentication_message>
  <request_identifier>ID_response_85</request_identifier>
  <header_file>
    <workflow_ID>234567</workflow_ID>
    <request_files>
      <file>
        <file_name>in_234567.txt</file_name>
        <file_signature>4155022100FD6...</file_signature>
      </file>
    </request_files>
    <response_files>
      <file>
        <file_name>out_234567.txt</file_name>
        <file_signature>5265022500AB7...</file_signature>
      </file>
    </response_files>
    <checksum>62241E3BC...</checksum>
  </header_file>
  <response_file>
    <file>
      <file_name>out_234567.txt</file_name>
  <transaction_identifier>ID_transaction_81</transaction_identifier>
      <transaction_signature>
        ECDSA signature in DER format
      </transaction_signature>
      <checksum>72241E3CD...</checksum>
    </file>
  </response_file>
</signed_integrity_transaction_authentication_message>
```

In another embodiment, the offline TSS server 16514 may copy the signed transaction (e.g., the transaction signature) 16557 and/or other data to the external storage device/barcode medium 16512. The multi-coin omnibus wallet 16504 may import (e.g., copy from the external storage device, read from a barcode medium via an optical reader) the signed transaction (e.g., the transaction signature) 16559 and/or other data from the external storage device/barcode medium 16512 to a storage location accessible to the multi-coin omnibus wallet (e.g., to a machine hosting the multi-coin omnibus wallet).

The multi-coin omnibus wallet 16504 may send a blockchain transaction request 16561 to a blockchain 16520 to submit the transaction to the blockchain (e.g., Bitcoin, Ethereum). In one implementation, the blockchain transaction request may include data such as a request identifier, transaction data (e.g., including the transaction details and the transaction signature(s)), and/or the like. In one embodiment, the multi-coin omnibus wallet may provide the following example blockchain transaction request (e.g., for a blockchain that supports on-chain multi-sig), substantially in the form of a HTTP(S) POST message including XML-formatted data, as provided below:

```
POST /blockchain_transaction_request.php HTTP/1.1
Host: www.server.com
Content-Type: Application/XML
Content-Length: 667
<?XML version = “1.0” encoding = “UTF-8”?>
<blockchain_transaction_request>
  <request_identifier>ID_request_88</request_identifier>
  <transaction_data>
    <transaction_details>
      Bitcoin transaction details
    </transaction_details>
    <transaction_signatures>
      online signature, 1^{st} offline signature, 2^{nd} offline signature
    </transaction_signatures>
  </transaction_data>
</blockchain_transaction_request>
```

In another embodiment, the multi-coin omnibus wallet may provide the following example blockchain transaction request (e.g., for a blockchain that supports on-chain single-sig), substantially in the form of a HTTP(S) POST message including XML-formatted data, as provided below:

```
POST /blockchain_transaction_request.php HTTP/1.1
Host: www.server.com
Content-Type: Application/XML
Content-Length: 667
<?XML version = “1.0” encoding = “UTF-8”?>
<blockchain_transaction_request>
  <request_identifier>ID_request_88</request_identifier>
  <transaction_data>
    <transaction_details>
      Ethereum transaction details
    </transaction_details>
    <transaction_signature>
      EOA on-chain signature
    </transaction_signature>
  </transaction_data>
</blockchain_transaction_request>
```

The blockchain 16520 may send a blockchain transaction response 16563 to the multi-coin omnibus wallet 16504 to confirm that the transaction was processed. In one implementation, the blockchain transaction response may include data such as a response identifier, a status, and/or the like. In one embodiment, the blockchain may provide the following example blockchain transaction response, substantially in the form of a HTTP(S) POST message including XML-formatted data, as provided below:

```
POST /blockchain_transaction_response.php HTTP/1.1
Host: www.server.com
Content-Type: Application/XML
Content-Length: 667
<?XML version = “1.0” encoding = “UTF-8”?>
<blockchain_transaction_response>
  <response_identifier>ID_response_88</response_identifier>
  <status>OK</status>
</blockchain_transaction_response>
```

The multi-coin omnibus wallet 16504 may send a TS response 16565 to the SOCOACT client 16502 (e.g., to inform the user that the transaction was processed). In one implementation, the TS response may include data such as a response identifier, a transaction identifier, transaction signature(s), a status, and/or the like. In one embodiment, the multi-coin omnibus wallet may provide the following example TS response, substantially in the form of a HTTP(S) POST message including XML-formatted data, as provided below:

```
POST /TS_response.php HTTP/1.1
Host: www.server.com
Content-Type: Application/XML
Content-Length: 667
<?XML version = “1.0” encoding = “UTF-8”?>
<TS_response>
  <response_identifier>ID_response_81</response_identifier>
  <transaction_identifier>ID_transaction_81</transaction_identifier>
  <transaction_signatures>
    ECDSA signature(s) in DER format
  </transaction_signatures>
  <status>OK</status>
</TS_response>
```

FIG. 166 shows non-limiting, example embodiments of a logic flow illustrating a multi-coin omnibus wallet unified multi-sig transaction signing (MOWUMTS) component for the SOCOACT. In FIG. 166, a transaction signing request may be obtained at 16601. For example, the transaction signing request may be obtained as a result of a user utilizing a UI of a multi-coin omnibus wallet to initiate transaction signing for a transaction (e.g., a fund transfer transaction for one of the multiple crypto currencies supported by the multi-coin omnibus wallet).

Transaction data associated with the transaction signing request may be determined at 16605. For example, transaction data may include a wallet identifier, source wallet parameters, destination wallet parameters, a transaction identifier, transaction details (e.g., blockchain type, a transaction amount, gas price, gas limit, a nonce), a transaction hash, a keychain path, and/or the like. In one implementation, the transaction signing request may be parsed (e.g., using PHP commands) to determine the transaction data (e.g., based on the value of the TS_request field).

Transaction signing may be requested from an online TSS server at 16609 to obtain an online transaction signature. In one implementation, an online transaction signing request may be sent to the online TSS server to request transaction signing. It is to be understood that, in various embodiments, transaction signing may be requested from multiple online TSS servers depending on the number of online transaction signatures desired.

A determination may be made at 16613 whether the online transaction signing request was authorized. If the online transaction signing request was not authorized, an error message may be generated at 16617. For example, the error message may specify the error that occurred (e.g., request to sign the transaction is not authorized). A warning message may be provided to the user and/or an action may be triggered at 16621. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with a wallet.

If the online transaction signing request was authorized, the number of offline transaction signatures to get may be determined at 16625. In one embodiment, the number of offline transaction signatures to get may be determined based on the M-of-N multisig configuration associated with the transaction. In one implementation (e.g., where a single online transaction signature and multiple offline transaction signatures are utilized for authorization), the number of offline transaction signatures to get may be M−1. For example, for a 3-of-4 configuration, the number of offline transaction signatures to get may be 2.

A determination may be made at 16629 whether there remain offline signatures to obtain. In one implementation, the determined number of offline transaction signatures to get may be obtained. If there remain offline signatures to obtain, the next offline TSS server from which to obtain an offline transaction signature may be selected at 16633. For simplicity, a 3-of-4 (1 online, 2-of-3 offline) configuration example for Bitcoin (BTC) and Ethereum (ETH) transactions is described, but any M-of-N (1<M<=N) multisig scheme for a variety of crypto currencies may be implemented in a similar manner. The table below describes a key storage structure to support on-chain multisig BTC transactions, multisig off-chain authorization for ETH, and single-sig on-chain EOA transactions for ETH.

| | | Online | | | |
|---|---|---|---|---|---|
| | Authorization | location | Offline location (2-of-3) | | |
| Coin | type | Site 1 | Site 2 | Site 3 | Site 4 |
| BTC | On-chain | Seed1_on | Seed2_off | Seed3_off | Seed4_off |
| | (3-of-4) | | | | |
| ETH | Off-chain | | | | |
| | (3-of-4) | | | | |

| | | |
|---|---|---|
| On-chain | N/A | Seed_eoa_off |
| (single-sig) | | |

During a key ceremony, the same 4 master private seeds may be distributed across one online and three offline locations for BTC and ETH multisig. An additional single EOA master seed may be replicated across the three offline locations for redundancy. The 4 master public seeds are distributed across the locations. In a fund transfer operation, one online and 2 (out of 3) offline seeds are used to co-sign a transaction. Any offline location can verify any of the signatures from other locations.

A transaction signing package may be generated at 16637. For example, the transaction signing request package may include a workflow ID, the transaction data, previous transaction signature(s) (e.g., the online transaction signature), a checksum (e.g., of the contents of the transaction signing request package file), and/or the like. In one implementation, the transaction signing request package may be formed and/or temporarily stored by the multi-coin omnibus wallet. It is to be understood that the same transaction signing package may be used for each of the offline TSS servers (e.g., generated once and reused for each offline TSS server) or different transaction signing packages may be used for each of the offline TSS servers (e.g., generated separately for each offline TSS server).

Transaction signing may be requested from the selected offline TSS server at 16641 to obtain an offline transaction signature. In one implementation, the transaction signing package may be copied to an external storage device (e.g., a USB storage device). In another implementation, the transaction signing request package may be output (e.g., as a set of QR codes) to a barcode medium. In various implementations, the barcode medium may be printed (e.g., on paper), displayed (e.g., on a screen), and/or the like. It is to be understood that one or multiple QR codes may be generated (e.g., depending on the size of data in the transaction signing request package), and that each barcode medium may comprise one or multiple QR codes. The barcode medium may include additional data such as a QR code index number, total number of QR codes, error detection/correction data, and/or the like. For example, such additional data may be used to facilitate reconstruction of the transaction signing request package from multiple QR codes. In one embodiment, the external storage device/barcode medium may be provided (e.g., by the user) to the selected offline TSS server to request transaction signing.

A determination may be made at 16645 whether the offline transaction signing request was authorized. In one implementation, the signed transaction may be imported (e.g., copied from the external storage device (e.g., or another USB storage device), read from a barcode medium via an optical reader) after transaction signing by the selected offline TSS server. In another implementation, the signed transaction may be received (e.g., from the selected offline TSS server via an integrity authentication communication channel) via a signed integrity transaction authentication message corresponding (e.g., based on the workflow ID) to the transaction signing request package after transaction signing by the selected offline TSS server. For example, the signed transaction may include an ECDSA signature in DER format, which may be validated.

If the offline transaction signing request was not authorized, an error message may be generated at 16617. For example, the error message may specify the error that occurred (e.g., request to sign the transaction is not authorized). A warning message may be provided to the user and/or an action may be triggered at 16621. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with a wallet.

If there do not remain additional offline signatures to obtain, a determination may be made at 16649 whether the transaction signing request is associated with a multi-signature blockchain (e.g., a blockchain, such as Bitcoin, that offers built-in support for multisig authorization as part of signature verification in transaction confirmation execution). In one implementation, this determination may be made based on the blockchain type associated with the transaction signing request.

If the transaction signing request is associated with a single-signature blockchain (e.g., a blockchain, such as Ethereum, that does not offer built-in support for multisig authorization as part of signature verification in transaction confirmation execution), a final transaction signing package may be generated at 16653. For example, the final transaction signing request package may include a workflow ID, the transaction data, previous transaction signature(s) (e.g., the online transaction signature and the offline transaction signatures), a checksum (e.g., of the contents of the transaction signing request package file), and/or the like. In one implementation, the transaction signing request package may be formed and/or temporarily stored by the multi-coin omnibus wallet.

Final transaction signing may be requested from an offline TSS server at 16657 to obtain an on-chain transaction signature (e.g., the single EOA signature). In one implementation, the final transaction signing package may be copied to an external storage device (e.g., a USB storage device). In another implementation, the final transaction signing request package may be output (e.g., as a set of QR codes) to a barcode medium. In various implementations, the barcode medium may be printed (e.g., on paper), displayed (e.g., on a screen), and/or the like. It is to be understood that one or multiple QR codes may be generated (e.g., depending on the size of data in the final transaction signing request package), and that each barcode medium may comprise one or multiple QR codes. The barcode medium may include additional data such as a QR code index number, total number of QR codes, error detection/correction data, and/or the like. For example, such additional data may be used to facilitate reconstruction of the final transaction signing request package from multiple QR codes. In one embodiment, the external storage device/barcode medium may be provided (e.g., by the user) to the offline TSS server to request final transaction signing. In one implementation, any of the offline TSS servers may be utilized for final transaction signing. The signed transaction may be obtained and/or validated in a similar way as discussed with regard to 16645.

The transaction may be submitted to a blockchain (e.g., the Bitcoin blockchain, the Ethereum blockchain) at 16661. In one implementation, the transaction may be broadcast to the blockchain via a blockchain transaction request. For example, if the transaction signing request is associated with a multi-signature blockchain, the obtained multiple on-chain transaction signatures (e.g., the online transaction signature and the offline transaction signatures) may be provided in the blockchain transaction request. In another example, if the transaction signing request is associated with a single-signature blockchain, the obtained single on-chain transaction signature (e.g., the single EOA signature) may be provided in the blockchain transaction request.

A transaction signing response may be provided to the user's client at 16665. In one implementation, a transaction signing response may be sent to inform the user whether the transaction signing was completed successfully (e.g., via a UI of the multi-coin omnibus wallet).

FIG. 167 shows non-limiting, example embodiments of a logic flow illustrating an online transaction server unified multi-sig transaction signing (NTSUMTS) component for the SOCOACT. In FIG. 167, a transaction signing request may be obtained at 16701. For example, an online transaction signing request may be obtained from a multi-coin omnibus wallet requesting transaction signing for a transaction as specified by a user.

Transaction data associated with the transaction signing request may be determined at 16705. For example, transaction data may include a wallet identifier, source wallet parameters, destination wallet parameters, a transaction identifier, transaction details (e.g., blockchain type, a transaction amount, gas price, gas limit, a nonce), a transaction hash, a keychain path, and/or the like. In one implementation, the transaction signing request may be parsed (e.g., using PHP commands) to determine the transaction data (e.g., based on the value of the online_TS_request field).

Transaction signing may be requested from a hot HSM (e.g., via TSTS, NTSTS, TSCTS, NTSITS component) at 16709. In one implementation, an online transaction signing request message may be sent to the hot HSM to request transaction signing. It is to be understood that, in various embodiments, transaction signing may be performed in a variety of ways (e.g., as discussed with regard to TSTS, NTSTS, TSCTS, NTSITS components).

A determination may be made at 16713 whether the transaction signing request was authorized by the hot HSM. In one implementation, one or more operators may have to approve (e.g., via an authentication entry device associated with the hot HSM) the transaction signing request for the request to be authorized.

If the transaction signing request was not authorized, an error message may be generated at 16717. For example, the error message may specify the error that occurred (e.g., request not approved). A warning message may be provided to the user and/or an action may be triggered at 16721. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with a wallet.

If the transaction signing request was authorized, the signed transaction may be provided to the multi-coin omnibus wallet at 16725. In one implementation, a transaction signature (e.g., an ECDSA signature in DER format) may be provided via an online transaction signing response.

FIG. 168 shows non-limiting, example embodiments of a logic flow illustrating a hot secure firmware unified multi-sig transaction signing (HSFUMTS) component for the SOCOACT. In FIG. 168, a hot SFUMTS API call may be obtained at 16801. For example, the hot SFUMTS API call may be obtained as a result of a call from a hot HSM associated with the HSFUMTS component. In various embodiments, a variety of API methods may be available to sign a transaction (e.g., signMessageHash,/transaction/sign).

Transaction data may be determined at 16805. In one implementation, the transaction data may be provided in the hot SFUMTS API call and may include a wallet identifier, source wallet parameters, destination wallet parameters, a transaction identifier, transaction details (e.g., blockchain type, a transaction amount, gas price, gas limit, a nonce), a transaction hash, a keychain path, and/or the like.

The transaction may be signed (e.g., via SFTS, HSFTS, SFCTS component) at 16809. It is to be understood that, in various embodiments, transaction signing may be performed in a variety of ways (e.g., as discussed with regard to SFTS, HSFTS, SFCTS components). In one embodiment, the transaction may be signed with an online transaction signature. In one implementation, the transaction may be signed using a master private key.

A determination may be made at 16810 whether the transaction signing was successful. If an error was detected during the transaction signing, a corresponding error message may be provided to a user at 16812 to inform the user regarding the error.

The signed transaction may be returned at 16813. In one implementation, the ECDSA signature in DER format may be returned.

FIG. 169 shows non-limiting, example embodiments of a logic flow illustrating an offline transaction server unified multi-sig transaction signing (FTSUMTS) component for the SOCOACT. In FIG. 169, a transaction signing request package may be obtained at 16901. For example, the transaction signing request package may be obtained as a result of a user utilizing a UI of an offline transaction signing runtime to copy the transaction signing request package from an external storage device (e.g., a USB drive inserted by the user) to facilitate transaction signing. In another example, the transaction signing request package may be obtained as a result of a user utilizing an optical reader (e.g., a barcode reader, a camera) to read the transaction signing request package from a barcode medium (e.g., a paper with a QR code, a display screen with a QR code) to facilitate transaction signing.

Transaction data associated with the transaction signing request package may be determined at 16905. For example, transaction data may include a wallet identifier, contract factory address, source/destination wallet parameters/contract data, a transaction identifier, transaction details (e.g., blockchain type, a transaction amount, gas price, gas limit, a nonce), a transaction hash, a keychain path, and/or the like. In one implementation, the transaction signing request package may be parsed (e.g., using PHP commands) to determine the transaction data (e.g., based on the value of the request_file field).

Previous transaction signatures may be determined at 16909. For example, an online transaction signature for the transaction provided by a hot HSM may be determined. In one implementation, the transaction signing request package may be parsed (e.g., using PHP commands) to determine the previous transaction signatures (e.g., based on the value of the transaction_signatures field).

Transaction signing may be requested from a cold HSM (e.g., via TSTS, FTSTS, TSCTS, FTSITS component) at 16913. In one implementation, an offline transaction signing request message may be sent to the cold HSM to request transaction signing. It is to be understood that, in various embodiments, transaction signing may be performed in a variety of ways (e.g., as discussed with regard to TSTS, FTSTS, TSCTS, FTSITS components).

A determination may be made at 16917 whether the transaction signing request was authorized by the cold HSM. In one implementation, one or more operators may have to approve (e.g., via an authentication entry device associated with the cold HSM) the transaction signing request for the request to be authorized.

If the transaction signing request was not authorized, an error message may be generated at 16921. For example, the error message may specify the error that occurred (e.g., request not approved). A warning message may be provided to the user and/or an action may be triggered at 16925. In one implementation, a warning message based on the generated error message may be provided to the user to inform the user regarding the error. In another implementation, an action may be triggered based on a specified condition (e.g., unauthorized request occurred three times). For example, the triggered action may be to erase data associated with a wallet.

If the transaction signing request was authorized, the signed transaction (e.g., the transaction signature) may be provided for a multi-coin omnibus wallet at 16929. In one implementation, the signed transaction may be copied to an external storage device. In another implementation, a signed integrity transaction authentication message comprising a transaction signing response package including the signed transaction may be generated and/or sent to the multi-coin omnibus wallet using an integrity authentication communication channel.

FIG. 170 shows non-limiting, example embodiments of a logic flow illustrating a cold secure firmware unified multi-sig transaction signing (CSFUMTS) component for the SOCOACT. In FIG. 170, a cold SFUMTS API call may be obtained at 17001. For example, the cold SFUMTS API call may be obtained as a result of a call from a cold HSM associated with the CSFUMTS component. In various embodiments, a variety of API methods may be available to sign a transaction (e.g., signMessageHash,/transaction/sign).

Transaction data may be determined at 17005. In one implementation, the transaction data may be provided in the cold SFUMTS API call and may include a wallet identifier, contract factory address, source/destination wallet parameters/contract data, a transaction identifier, transaction details (e.g., blockchain type, a transaction amount, gas price, gas limit, a nonce), a transaction hash, a keychain path, and/or the like.

A determination may be made at 17009 whether the transaction is associated with a multi-signature blockchain (e.g., a blockchain, such as Bitcoin, that offers built-in support for multisig authorization as part of signature verification in transaction confirmation execution). In one implementation, this determination may be made based on the blockchain type associated with the transaction.

If the transaction is associated with a single-signature blockchain (e.g., a blockchain, such as Ethereum, that does not offer built-in support for multisig authorization as part of signature verification in transaction confirmation execution), a determination may be made at 17013 whether final transaction signing was requested. In one implementation, a request subtype may be provided as an input parameter in the cold SFUMTS API call and may specify whether final transaction signing is requested. In another implementation, this determination may be made based on evaluation of other input parameters (e.g., the number of provided previous transaction signature(s), a keychain path, and/or the like).

If the transaction is associated with a multi-signature blockchain, or the transaction is associated with a single-signature blockchain and final transaction signing was requested, an online transaction signature associated with the transaction may be determined at 17017. In one implementation, previous transaction signature(s) may be provided as an input parameter in the cold SFUMTS API call and may specify the online transaction signature associated with the transaction. It is to be understood that, in various embodiments, multiple online transaction signatures may be determined and/or validated depending on the M-of-N multisig configuration (e.g., specifying the (e.g., minimum, maximum) number of online transaction signatures and/or the (e.g., minimum, maximum) number of offline transaction signatures that may be used for M) associated with the transaction.

The online transaction signature associated with the transaction may be validated at 17021. In one implementation, the online transaction signature associated with the transaction may be verified using a PKCS #11 function (e.g., C_Verify ( . . . )).

A determination may be made at 17025 whether the online transaction signature associated with the transaction is valid. If the online transaction signature associated with the transaction is not valid, an error message may be generated at 17045. For example, the error message may specify the error that occurred (e.g., online transaction signature is invalid). A warning message may be provided to a user and/or an action may be triggered at 17049. In one implementation, a warning message based on the generated error message may be provided to the user (e.g., via an offline TSS) to inform the user regarding the error. In another implementation, an action may be triggered based on a specified condition (e.g., invalid online transaction signature obtained three times). For example, the triggered action may be to erase data associated with a wallet.

If the online transaction signature associated with the transaction is valid, the transaction may be signed (e.g., via SFTS, CSFTS, SFCTS, SFITS component) at 17053. It is to be understood that, in various embodiments, transaction signing may be performed in a variety of ways (e.g., as discussed with regard to SFTS, CSFTS, SFCTS, SFITS components). In one embodiment, the transaction may be signed with an offline transaction signature. In one implementation, the transaction may be signed using a master private key (e.g., to generate a signing private key).

If the transaction is associated with a single-signature blockchain and final transaction signing was not requested, the number of off-chain transaction signatures to validate may be determined at 17029. In one embodiment, the number of off-chain transaction signatures to validate may be determined as M specified by the M-of-N multisig configuration. In one implementation, the M-of-N multisig configuration (e.g., retrieved by the cold HSM) associated with a private key (e.g., specified by the keychain path) may be analyzed (e.g., parsed) to determine M.

Off-chain transaction signatures associated with the transaction may be determined at 17033. In one implementation, previous transaction signature(s) may be provided as an input parameter in the cold SFUMTS API call and may specify the off-chain transaction signatures associated with the transaction. In various embodiments, the off-chain transaction signatures associated with the transaction may include some number of online transaction signature(s) and/or offline transaction signature(s) depending on the M-of-N multisig configuration.

The off-chain transaction signatures may be validated at 17037. In one implementation, the off-chain transaction signatures associated with the transaction may be verified using a PKCS #11 function (e.g., C_Verify ( . . . )).

A determination may be made at 17041 whether the off-chain transaction signatures associated with the transaction are valid. In one implementation, the number of off-chain transaction signatures and/or their validity may be checked to make this determination. If the off-chain transaction signatures are not valid, an error message may be generated at 17045. For example, the error message may specify the error that occurred (e.g., insufficient number of off-chain transaction signatures provided). A warning message may be provided to a user and/or an action may be triggered at 17049. In one implementation, a warning message based on the generated error message may be provided to the user (e.g., via an offline TSS) to inform the user regarding the error. In another implementation, an action may be triggered based on a specified condition (e.g., insufficient number of off-chain transaction signatures provided three times). For example, the triggered action may be to erase data associated with a wallet.

If the off-chain transaction signatures are valid, the transaction may be signed (e.g., via SFTS, CSFTS, SFCTS, SFITS component) at 17053. It is to be understood that, in various embodiments, transaction signing may be performed in a variety of ways (e.g., as discussed with regard to SFTS, CSFTS, SFCTS, SFITS components). In one embodiment, the transaction may be signed with an on-chain transaction signature. In one implementation, the transaction may be signed using an EOA master private key (e.g., to generate a signing private key).

The signed transaction may be returned at 17057. In one implementation, the ECDSA signature in DER format may be returned.

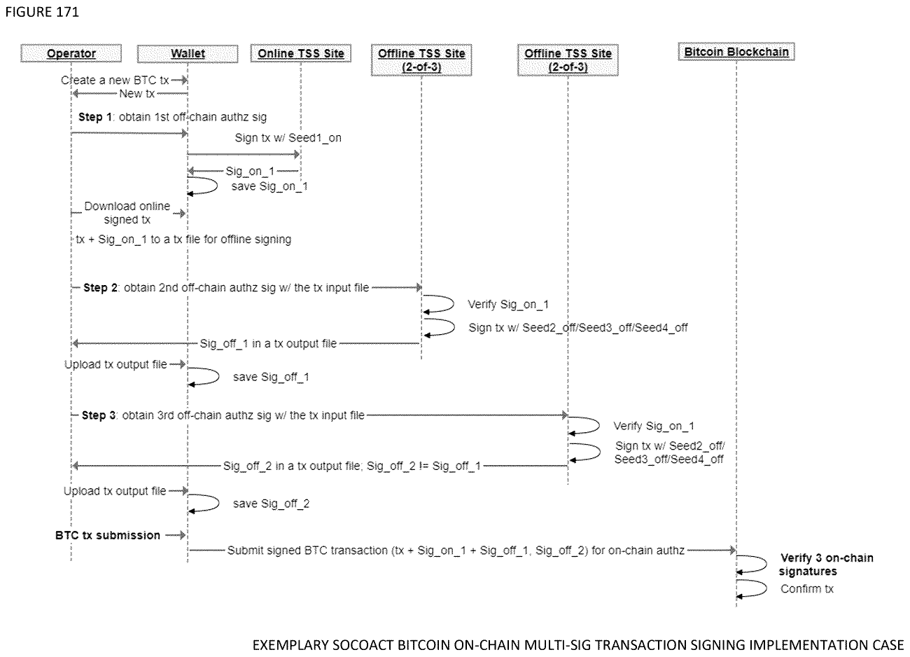

FIG. 171 shows non-limiting, example embodiments of implementation case(s) for the SOCOACT. In FIG. 171, an exemplary multisig transaction flow for a 3-of-4 (1 online, 2-of-3 offline) configuration example with on-chain authorization in a BTC fund transfer process is illustrated. For Bitcoin, the 4 seeds jointly hold BTC assets and 3 are used in a fund transfer process in which the final authorization is carried on-chain. Bitcoin blockchain transaction confirmation process verifies that 3 signatures are valid by using their extended public keys in the submitted transaction. Offline TSS's do not perform off-chain authorization in this example.

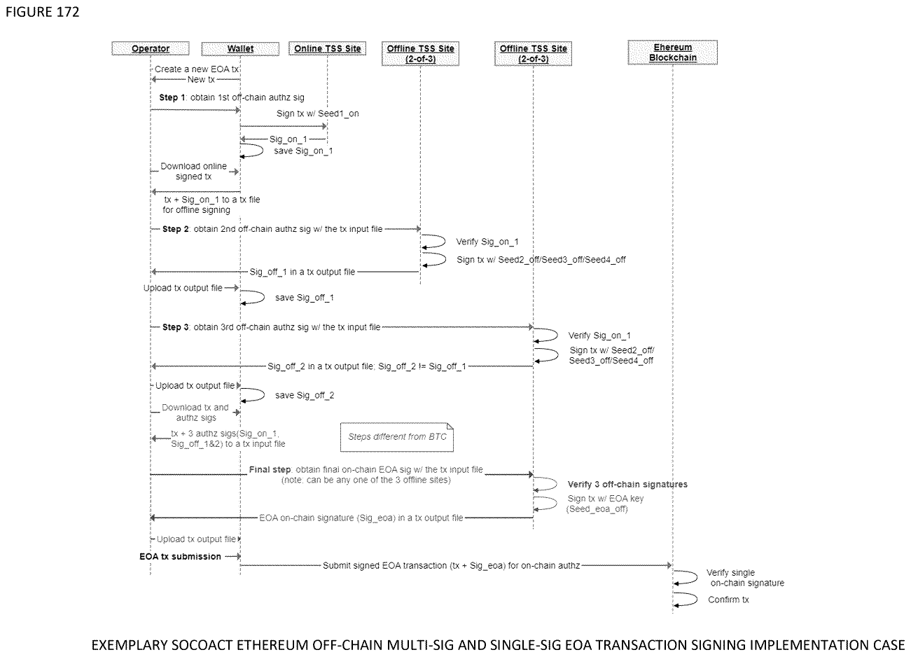

FIG. 172 shows non-limiting, example embodiments of implementation case(s) for the SOCOACT. In FIG. 172, an exemplary multisig transaction flow for a 3-of-4 (1 online, 2-of-3 offline) configuration example with off-chain authorization in an ETH fund transfer process is illustrated. For Ethereum, the EOA seed holds ETH asset. 3 (out of 4) signatures are used in a fund transfer process to authorize the final EOA transaction signing on an offline TSS. The final EOA authorization is carried on-chain, where an Ethereum blockchain transaction confirmation process verifies the single EOA signature using its extended public key derived from the EOA address holding the ether.

### Additional Alternative Embodiment Examples

The following alternative example embodiments provide a number of variations of some of the already discussed principles for expanded color on the abilities of the SOCOACT.

### Dynamic Blockchain Asset Interchange

As a public or private ledger, a blockchain is an immutable record of transactions between entities organized into larger blocks of data, recorded in a linear order using cryptographic techniques and maintained in a distributed fashion by multiple computer nodes accessible through the public internet. It is of great interest to develop a single, universally useable and scalable digital currency using blockchain technology to maintain an immutable history of all transactions.

Different organizations/entities support one or another implementation of incompatible blockchain ledger solutions to record value transfer quickly between participating parties and to maintain an immutable record of transactions specific to their business. Any data or representation of value may be recorded in a transaction on these systems and once recorded in the blockchain it becomes an ironclad record of everything that happens to that asset and data.

The various implementations exhibit technical limitations in computing capability, network bandwidth, and transaction storage resulting in issues of scalability based on a premise of a single blockchain. Each has some concept or desirability of maintaining privacy of the data. Scalability is a major technical challenge and instead of a single all-encompassing blockchain to store digital assets, hundreds or thousands of such systems that interact automatically through exchange mechanisms would be more robust.

The SOCOACT creates multiple points of exchange on different blockchains, containing one or more nodes that establish contact with at least one node from another blockchain network. Transactions designated for the external blockchain(s) contain agreed upon source and destination blockchain network identifiers as part of transaction source and recipient addressing information in addition to appropriate data values for assets being transferred. The source network transaction provides attestation of ownership, identifies the exchange point between the two networks and includes additional information to allow the creation of a new transaction on the destination network attesting to the new owner relationship.

The SOCOACT may create a transaction entry on the source digital ledger to ensure that the asset cannot be reused on that blockchain while creating a new transaction on the destination ledger that can continue to be used within that system. In addition to straight forward transfer of asset information between systems, the SOCOACT may also utilize third party market makers to implement exchange rates between the different digital ledger systems.

In one embodiment, the multitude of blockchains (e.g., public and private) may be thought of as a system of bubbles with some immediately adjacent to each other and others spanning some distance across the system. In addition to adjacency it is possible that some bubbles are enclosed within larger bubbles. Like bubbles, minor adjustments to one bubble directly affect neighboring bubbles and those subsequently interact with other bubbles further away or contained within other bubbles. Each bubble behaves according to its individual attributes of size, composition and other characteristics. Without a central bubble controlling the interactions, an equilibrium is reached based on the characteristics of each bubble. This automatic adjustment would be a result of improved interaction between blockchains.

As a simple illustration, two blockchains are shown in FIG. 93 that operate with completely different nodes and entities, maintaining separate digital ledgers. The first blockchain contains eight nodes with each node having a reasonable level of interconnections with other peers. For simplicity, the second blockchain also contains eight nodes with each node acting in much the same way as the first blockchain described above, but representing different assets, valuations and possibly different rules of governance.

Each node is validating transactions, the cryptographically secure blocks, and maintaining a copy of the digital ledger for their respective blockchain network. The nodes in the network are exchanging this information with typical pathways depicted by solid lines on the diagram. The four shaded exchange nodes are exchanging additional information and data (dashed lines) between nodes in the two separate networks as directed by the SOCOACT as described above.

Transactions contain cryptographic signature information referencing one or more input values and assets as the source for the transaction with directions on how to unlock the source value. In addition, one or more output cryptographic references and directions on how to validate the output is included for use in a later transaction. The directions to validate input and output operations could utilize single or multiparty cryptographic signatures, smart contracts, and/or the like for secure use and security such as for escrow requirements.

For exchange between the two networks, the inputs for these transaction have to be valid entries on the source blockchain and one or more outputs could be directed for transfer to the other blockchain. The exchange node(s) may advertise the ability to interact with one or more additional blockchains and coordinate the completion of a transaction input on one blockchain and initiate the transaction output on a separate blockchain. The structure of transactions to accomplish the exchange may effectively remain the same with the addition of agreed to identifiers that relate cryptographic addresses of different blockchain networks.

Each network may have a registered identifier or address that may allow the exchange nodes that interconnect different blockchains to recognize a transaction that is destined to another blockchain. In addition, these nodes may maintain a network addressing table that indicates multiple routing pathways across the broader structure of blockchains for improved efficiency.

### Exemplary Borrow Process—Alternative Embodiment 1

The trader will use “Security Search” function in the Borrow Securities widget to see how many clients hold the concerned security, in this case PETS.

The trader will be able to see:
1389.1. Clients holding security
1389.2. Prior Borrow of that security-On Loan quantity
1389.3. Current quantity of the security-Available to Lend Quantity

The trader will be able to input number of shares (he wants to borrow) and rate at which the trader wants to borrow shares.

Once the trader inputs the details, “Book” button will be available so that by pressing the button, borrow can be initiated.

As soon as the process is started, the trader will be informed via an alert which states “Booking on Blockchain”. The screen will also inform that Fidelity has borrowed from Client C.

Client will also be informed via an alert which informs the user about Loan transaction occurring by him/meaning Borrow transaction by Fidelity.

Once Borrow is initiated, below fields will be updated in Fidelity View:
1394.1. Transaction list
1394.2. Borrowed Securities
1394.3. On Loan and Avail to Lend fields in all screens

Once Borrow is initiated, below fields will be updated in Client View:
1395.1. Transaction list
1395.2. Security Availability
1395.3. On Loan and Avail to Lend fields in all screens

When Fidelity releases the collateral schedule, Blockchain update happens as the anticipated amount of transfer from Fidelity's account to Client's account gets updated.

Anticipated Delta column in Wire Requirement widget in Fidelity View, Agent View and Client View screens will only be updated once Fidelity releases the schedule (collateral schedule) which means collateral will be updated.

Wire Requirement widget in all three screens namely Fidelity View, Client View and Agent View will be updated once the collateral is released by Fidelity. Anticipated Delta field will show the amount Agent will get by the end of the day in Client's account from Fidelity. If the amount is negative, that means the amount will be withdrawn.

### Exemplary Borrow Process—Alternative Embodiment 2

When a broker dealer borrows a security from its client, the transaction will be reported on Oracle database first. From Oracle database, the transaction details will flow into the WORM (Write Once Read Many) database. Once the transaction is stored on Oracle database, transaction data will flow on to the Blockchain, and then based on Transaction Process Optimizer rules. TPO (Transaction Process Optimizer) would be operated based on various risk parameters which include number of transactions, data storage or schedule.

However, non-transactional data will be replicated on the distributed servers and would not flow on to the blockchain. This unique approach will increase the speed of overall data transfer and save the data storage on the Blockchain (by excluding static data from the Blockchain).

Additional embodiments may include:
A1. A crypto asset digitizer apparatus, comprising:
a memory;
a component collection in the memory, including:
   a smart contract generating component; and
   a smart contract fulfillment component;
a processor disposed in communication with the memory, and configured to issue a plurality of processing instructions from the component collection stored in the memory,
   wherein the processor issues instructions from the smart contract generating component, stored in the memory, to:
      instantiate, via at least one processor, an aggregated crypto 2-party transaction trigger entry in a socially aggregated blockchain datastructure, wherein the aggregated crypto 2-party transaction trigger entry specifies at least one associated aggregated blockchain oracle that provides oracle data for evaluation via the aggregated crypto 2-party transaction trigger entry;
   wherein the processor issues instructions from the smart contract fulfillment component, stored in the memory, to:
      obtain, via at least one processor, a first encrypted token for the crypto 2-party transaction trigger entry from a first associated aggregated blockchain oracle, wherein the first encrypted token is for a first account data structure datastore having a crypto token asset value, wherein the first associated aggregated blockchain oracle is responsive to crypto tokens deposit activity of a first party;
      obtain, via at least one processor, a second encrypted token for the crypto 2-party transaction trigger entry from a second associated aggregated blockchain oracle, wherein the second encrypted token is for a second account data structure datastore having a crypto token asset value, wherein the second associated aggregated blockchain oracle is responsive to crypto tokens deposit activity of a second party;
      determine, via at least one processor, that an instantiated aggregated crypto 2-party transaction trigger entry unlock event occurred;
      facilitate, via at least one processor, unlocking the instantiated aggregated crypto 2-party transaction trigger entry based on the determination, and providing the first encrypted token to the second party and providing the second encrypted token to the first party.
A2. The apparatus of embodiment A1, wherein the aggregated crypto 2-party transaction trigger entry is instantiated via a smart contract generator GUI.
A3. The apparatus of embodiment A2, wherein the smart contract generator GUI includes a payout structure drawing user interface component that facilitates obtaining a payout structure specification for a derivative from a user.
A4. The apparatus of embodiment A3, wherein the payout structure drawing user interface component facilitates obtaining a payout structure specification for the derivative based on a plurality of axis dimensions, and wherein each of the plurality of axis dimensions is associated with an aggregated blockchain oracle specified by the user.
A5. The apparatus of embodiment A1, wherein the first associated aggregated blockchain oracle and the second associated aggregated blockchain oracle are the same entity.
A6. The apparatus of embodiment A1, wherein at least one associated aggregated blockchain oracle provides crowdsourced decentralized data.
A7. The apparatus of embodiment A1, wherein at least one associated aggregated blockchain oracle provides combined crowdsourced decentralized weather data.
A8. The apparatus of embodiment A1, wherein the instantiated aggregated crypto 2-party transaction trigger entry unlock event is receipt of the first encrypted token and of the second encrypted token.
A9. The apparatus of embodiment A1, wherein the determination that the instantiated aggregated crypto 2-party transaction trigger entry unlock event occurred is made based on oracle data providable by a third associated aggregated blockchain oracle.
A10. The apparatus of embodiment A9, wherein the instantiated aggregated crypto 2-party transaction trigger entry unlock event is any of: anti-ping detection, detection of excess threshold account balance in an account data structure datastore, detection of excess threshold of aggregated blockchain oracle data value, detection of excess threshold number of transactions, detection of specified micro transaction amount, excess bounds of a smart contract generator GUI generated crypto smart rule, failure to login to 4th party website, geofence transgression, user request.
A11. The apparatus of embodiment A9, wherein the first account data structure datastore or the second account data structure datastore has a crypto token asset for a trackable real world item.
A12. The apparatus of embodiment A11, wherein the trackable real world item is trackable via a constant video stream.
A13. The apparatus of embodiment A11, wherein the determination that the instantiated aggregated crypto 2-party transaction trigger entry unlock event occurred is conditioned on not receiving oracle data, indicating that the real world item was moved after it had been delivered to a designated location, from the third associated aggregated blockchain oracle.
A14. The apparatus of embodiment A1, wherein the first encrypted token is decryptable by a private key of the second party and the second encrypted token is decryptable by a private key of the first party.
A15. The apparatus of embodiment A1, further comprising:
the processor issues instructions from the smart contract fulfillment component, stored in the memory, to:
   facilitate providing a crypto unlock key for decrypting the first encrypted token to the second party and a crypto unlock key for decrypting the second encrypted token to the first party.
A16. A processor-readable crypto asset digitizer non-transient physical medium storing processor-executable components, the components, comprising:
a component collection stored in the medium, including:
   a smart contract generating component; and
   a smart contract fulfillment component;
   wherein the smart contract generating component, stored in the medium, includes processor-issuable instructions to:
      instantiate, via at least one processor, an aggregated crypto 2-party transaction trigger entry in a socially aggregated blockchain datastructure, wherein the aggregated crypto 2-party transaction trigger entry specifies at least one associated aggregated blockchain oracle that provides oracle data for evaluation via the aggregated crypto 2-party transaction trigger entry;
   wherein the smart contract fulfillment component, stored in the medium, includes processor-issuable instructions to:
      obtain, via at least one processor, a first encrypted token for the crypto 2-party transaction trigger entry from a first associated aggregated blockchain oracle, wherein the first encrypted token is for a first account data structure datastore having a crypto token asset value, wherein the first associated aggregated blockchain oracle is responsive to crypto tokens deposit activity of a first party;
      obtain, via at least one processor, a second encrypted token for the crypto 2-party transaction trigger entry from a second associated aggregated blockchain oracle, wherein the second encrypted token is for a second account data structure datastore having a crypto token asset value, wherein the second associated aggregated blockchain oracle is responsive to crypto tokens deposit activity of a second party;
      determine, via at least one processor, that an instantiated aggregated crypto 2-party transaction trigger entry unlock event occurred;
      facilitate, via at least one processor, unlocking the instantiated aggregated crypto 2-party transaction trigger entry based on the determination, and providing the first encrypted token to the second party and providing the second encrypted token to the first party.
A17. The medium of embodiment A16, wherein the aggregated crypto 2-party transaction trigger entry is instantiated via a smart contract generator GUI.
A18. The medium of embodiment A17, wherein the smart contract generator GUI includes a payout structure drawing user interface component that facilitates obtaining a payout structure specification for a derivative from a user.
A19. The medium of embodiment A18, wherein the payout structure drawing user interface component facilitates obtaining a payout structure specification for the derivative based on a plurality of axis dimensions, and wherein each of the plurality of axis dimensions is associated with an aggregated blockchain oracle specified by the user.
A20. The medium of embodiment A16, wherein the first associated aggregated blockchain oracle and the second associated aggregated blockchain oracle are the same entity.
A21. The medium of embodiment A16, wherein at least one associated aggregated blockchain oracle provides crowdsourced decentralized data.
A22. The medium of embodiment A16, wherein at least one associated aggregated blockchain oracle provides combined crowdsourced decentralized weather data.
A23. The medium of embodiment A16, wherein the instantiated aggregated crypto 2-party transaction trigger entry unlock event is receipt of the first encrypted token and of the second encrypted token.
A24. The medium of embodiment A16, wherein the determination that the instantiated aggregated crypto 2-party transaction trigger entry unlock event occurred is made based on oracle data providable by a third associated aggregated blockchain oracle.
A25. The medium of embodiment A24, wherein the instantiated aggregated crypto 2-party transaction trigger entry unlock event is any of: anti-ping detection, detection of excess threshold account balance in an account data structure datastore, detection of excess threshold of aggregated blockchain oracle data value, detection of excess threshold number of transactions, detection of specified micro transaction amount, excess bounds of a smart contract generator GUI generated crypto smart rule, failure to login to 4th party website, geofence transgression, user request.
A26. The medium of embodiment A24, wherein the first account data structure datastore or the second account data structure datastore has a crypto token asset for a trackable real world item.
A27. The medium of embodiment A26, wherein the trackable real world item is trackable via a constant video stream.
A28. The medium of embodiment A26, wherein the determination that the instantiated aggregated crypto 2-party transaction trigger entry unlock event occurred is conditioned on not receiving oracle data, indicating that the real world item was moved after it had been delivered to a designated location, from the third associated aggregated blockchain oracle.
A29. The medium of embodiment A16, wherein the first encrypted token is decryptable by a private key of the second party and the second encrypted token is decryptable by a private key of the first party.
A30. The medium of embodiment A16, further comprising:
the smart contract fulfillment component, stored in the medium, includes processor-issuable instructions to:
   facilitate providing a crypto unlock key for decrypting the first encrypted token to the second party and a crypto unlock key for decrypting the second encrypted token to the first party.
A31. A processor-implemented crypto asset digitizer system, comprising:
   smart contract generating component means, to:
      instantiate, via at least one processor, an aggregated crypto 2-party transaction trigger entry in a socially aggregated blockchain datastructure, wherein the aggregated crypto 2-party transaction trigger entry specifies at least one associated aggregated blockchain oracle that provides oracle data for evaluation via the aggregated crypto 2-party transaction trigger entry;
   smart contract fulfillment component means, to:
      obtain, via at least one processor, a first encrypted token for the crypto 2-party transaction trigger entry from a first associated aggregated blockchain oracle, wherein the first encrypted token is for a first account data structure datastore having a crypto token asset value, wherein the first associated aggregated blockchain oracle is responsive to crypto tokens deposit activity of a first party;
      obtain, via at least one processor, a second encrypted token for the crypto 2-party transaction trigger entry from a second associated aggregated blockchain oracle, wherein the second encrypted token is for a second account data structure datastore having a crypto token asset value, wherein the second associated aggregated blockchain oracle is responsive to crypto tokens deposit activity of a second party;
      determine, via at least one processor, that an instantiated aggregated crypto 2-party transaction trigger entry unlock event occurred;
      facilitate, via at least one processor, unlocking the instantiated aggregated crypto 2-party transaction trigger entry based on the determination, and providing the first encrypted token to the second party and providing the second encrypted token to the first party.
A32. The system of embodiment A31, wherein the aggregated crypto 2-party transaction trigger entry is instantiated via a smart contract generator GUI.
A33. The system of embodiment A32, wherein the smart contract generator GUI includes a payout structure drawing user interface component that facilitates obtaining a payout structure specification for a derivative from a user.
A34. The system of embodiment A33, wherein the payout structure drawing user interface component facilitates obtaining a payout structure specification for the derivative based on a plurality of axis dimensions, and wherein each of the plurality of axis dimensions is associated with an aggregated blockchain oracle specified by the user.
A35. The system of embodiment A31, wherein the first associated aggregated blockchain oracle and the second associated aggregated blockchain oracle are the same entity.
A36. The system of embodiment A31, wherein at least one associated aggregated blockchain oracle provides crowdsourced decentralized data.
A37. The system of embodiment A31, wherein at least one associated aggregated blockchain oracle provides combined crowdsourced decentralized weather data.
A38. The system of embodiment A31, wherein the instantiated aggregated crypto 2-party transaction trigger entry unlock event is receipt of the first encrypted token and of the second encrypted token.
A39. The system of embodiment A31, wherein the determination that the instantiated aggregated crypto 2-party transaction trigger entry unlock event occurred is made based on oracle data providable by a third associated aggregated blockchain oracle.
A40. The system of embodiment A39, wherein the instantiated aggregated crypto 2-party transaction trigger entry unlock event is any of: anti-ping detection, detection of excess threshold account balance in an account data structure datastore, detection of excess threshold of aggregated blockchain oracle data value, detection of excess threshold number of transactions, detection of specified micro transaction amount, excess bounds of a smart contract generator GUI generated crypto smart rule, failure to login to 4th party website, geofence transgression, user request.
A41. The system of embodiment A39, wherein the first account data structure datastore or the second account data structure datastore has a crypto token asset for a trackable real world item.
A42. The system of embodiment A41, wherein the trackable real world item is trackable via a constant video stream.
A43. The system of embodiment A41, wherein the determination that the instantiated aggregated crypto 2-party transaction trigger entry unlock event occurred is conditioned on not receiving oracle data, indicating that the real world item was moved after it had been delivered to a designated location, from the third associated aggregated blockchain oracle.
A44. The system of embodiment A31, wherein the first encrypted token is decryptable by a private key of the second party and the second encrypted token is decryptable by a private key of the first party.
A45. The system of embodiment A31, further comprising:
smart contract fulfillment component means, to:
   facilitate providing a crypto unlock key for decrypting the first encrypted token to the second party and a crypto unlock key for decrypting the second encrypted token to the first party.
A46. A processor-implemented crypto asset digitizer method, comprising:
executing processor-implemented smart contract generating component instructions to:
   instantiate, via at least one processor, an aggregated crypto 2-party transaction trigger entry in a socially aggregated blockchain datastructure, wherein the aggregated crypto 2-party transaction trigger entry specifies at least one associated aggregated blockchain oracle that provides oracle data for evaluation via the aggregated crypto 2-party transaction trigger entry;
executing processor-implemented smart contract fulfillment component instructions to:
   obtain, via at least one processor, a first encrypted token for the crypto 2-party transaction trigger entry from a first associated aggregated blockchain oracle, wherein the first encrypted token is for a first account data structure datastore having a crypto token asset value, wherein the first associated aggregated blockchain oracle is responsive to crypto tokens deposit activity of a first party;
   obtain, via at least one processor, a second encrypted token for the crypto 2-party transaction trigger entry from a second associated aggregated blockchain oracle, wherein the second encrypted token is for a second account data structure datastore having a crypto token asset value, wherein the second associated aggregated blockchain oracle is responsive to crypto tokens deposit activity of a second party;
   determine, via at least one processor, that an instantiated aggregated crypto 2-party transaction trigger entry unlock event occurred;
   facilitate, via at least one processor, unlocking the instantiated aggregated crypto 2-party transaction trigger entry based on the determination, and providing the first encrypted token to the second party and providing the second encrypted token to the first party.
A47. The method of embodiment A46, wherein the aggregated crypto 2-party transaction trigger entry is instantiated via a smart contract generator GUI.
A48. The method of embodiment A47, wherein the smart contract generator GUI includes a payout structure drawing user interface component that facilitates obtaining a payout structure specification for a derivative from a user.
A49. The method of embodiment A48, wherein the payout structure drawing user interface component facilitates obtaining a payout structure specification for the derivative based on a plurality of axis dimensions, and wherein each of the plurality of axis dimensions is associated with an aggregated blockchain oracle specified by the user.
A50. The method of embodiment A46, wherein the first associated aggregated blockchain oracle and the second associated aggregated blockchain oracle are the same entity.
A51. The method of embodiment A46, wherein at least one associated aggregated blockchain oracle provides crowdsourced decentralized data.
A52. The method of embodiment A46, wherein at least one associated aggregated blockchain oracle provides combined crowdsourced decentralized weather data.
A53. The method of embodiment A46, wherein the instantiated aggregated crypto 2-party transaction trigger entry unlock event is receipt of the first encrypted token and of the second encrypted token.
A54. The method of embodiment A46, wherein the determination that the instantiated aggregated crypto 2-party transaction trigger entry unlock event occurred is made based on oracle data providable by a third associated aggregated blockchain oracle.
A55. The method of embodiment A54, wherein the instantiated aggregated crypto 2-party transaction trigger entry unlock event is any of: anti-ping detection, detection of excess threshold account balance in an account data structure datastore, detection of excess threshold of aggregated blockchain oracle data value, detection of excess threshold number of transactions, detection of specified micro transaction amount, excess bounds of a smart contract generator GUI generated crypto smart rule, failure to login to 4th party website, geofence transgression, user request.
A56. The method of embodiment A54, wherein the first account data structure datastore or the second account data structure datastore has a crypto token asset for a trackable real world item.
A57. The method of embodiment A56, wherein the trackable real world item is trackable via a constant video stream.
A58. The method of embodiment A56, wherein the determination that the instantiated aggregated crypto 2-party transaction trigger entry unlock event occurred is conditioned on not receiving oracle data, indicating that the real world item was moved after it had been delivered to a designated location, from the third associated aggregated blockchain oracle.
A59. The method of embodiment A46, wherein the first encrypted token is decryptable by a private key of the second party and the second encrypted token is decryptable by a private key of the first party.
A60. The method of embodiment A46, further comprising:
executing processor-implemented smart contract fulfillment component instructions to:
   facilitate providing a crypto unlock key for decrypting the first encrypted token to the second party and a crypto unlock key for decrypting the second encrypted token to the first party.
A101. A crypto voting apparatus, comprising:
a memory;
a component collection in the memory, including:
a processor disposed in communication with the memory, and configured to issue a plurality of processing instructions from the component collection stored in the memory,
   wherein the processor issues instructions from the component collection, stored in the memory, to:
      obtain crypto vote request from a voter;
      determine voter eligibility for crypto voting;
      search crypto vote database for eligible voting events for voter;
      generate crypto vote user interface (UI) and provide the crypto vote UI to the voter;
      obtain crypto vote selections from the voter, wherein the crypto vote selections are stored on a socially aggregated blockchain datastructure and include fractional crypto votes and crypto smart rules and associated aggregated blockchain oracles aggregating values;
      evaluate the crypto votes including fractional crypto votes and crypto smart rules;
      determine voting outcomes based on evaluation of the crypto votes.
102 The apparatus of embodiment A101, wherein the aggregated crypto trigger is any of: anti-ping detection, detection of excess threshold account balance, detection of excess threshold of aggregated blockchain oracle value, detection of excess threshold number of transactions, detection of specified micro transaction amount, excess bounds of a UI generated crypto smart rule, failure to login to 4th party website, geofence transgression, user request.
A103. The apparatus of embodiment A101, further, comprising:
   instantiate an aggregated crypto trigger in a socially aggregated blockchain datastructure and an associated aggregated blockchain oracle via socially blockchain entry component from crypto smart rule generator user interface (UI), wherein the associated aggregated blockchain oracle obtains socially aggregated values via socially aggregated blockchain datastructure entries for evaluation by the aggregated crypto trigger;
   provide voting outcomes to voting outcome requestors;
   execute the instantiated aggregated triggers based on the determined voting outcomes;
   execute crypto smart rules based on the determined voting outcomes.
A104. A crypto recovery key apparatus, comprising:
a memory;
a component collection in the memory, including:
a processor disposed in communication with the memory, and configured to issue a plurality of processing instructions from the component collection stored in the memory,
   wherein the processor issues instructions from the component collection, stored in the memory, to:
      obtain a crypto multi key wallet instantiation request from a user;
      generate a multi key crypto wallet with multiple keys;
      provide a 3^{rd} party public crypto key message for the multi key crypto wallet to the user, wherein the 3^{rd} party public crypto key message includes a 3^{rd} party public crypto key and is configured to allow the user to generate a private crypto key for the crypto multi key wallet and to instantiate the crypto multi key crypto wallet;
      instantiate an aggregated crypto wallet failsafe trigger in a socially aggregated blockchain datastructure and an associated aggregated blockchain oracle via socially blockchain entry component from crypto smart rule generator user interface (UI), wherein the associated aggregated blockchain oracle obtains socially aggregated values via socially aggregated blockchain datastructure entries for evaluation by the aggregated crypto wallet failsafe trigger;
      determine if aggregated crypto wallet failsafe trigger event occurred;
      provide 3^{rd} party key to multi key crypto wallet upon determination of aggregated crypto wallet failsafe trigger event.
A105. The apparatus of embodiment A104, wherein the aggregated crypto wallet failsafe trigger is any of: anti-ping detection, detection of excess threshold account balance, detection of excess threshold of aggregated blockchain oracle value, detection of excess threshold number of transactions, detection of specified micro transaction amount, excess bounds of a UI generated crypto smart rule, failure to login to 4th party website, geofence transgression, user request.
A106. A crypto asset digitizer apparatus, comprising:
a memory;
a component collection in the memory, including:
a processor disposed in communication with the memory, and configured to issue a plurality of processing instructions from the component collection stored in the memory,
   wherein the processor issues instructions from the component collection, stored in the memory, to:
      instantiate an aggregated crypto 2-party transaction trigger in a socially aggregated blockchain datastructure and an associated aggregated blockchain oracle via socially blockchain entry component from crypto smart rule generator user interface (UI), wherein the associated aggregated blockchain oracle obtains socially aggregated values via socially aggregated blockchain datastructure entries for evaluation by the aggregated crypto 2-party transaction trigger;
      provide a crypto unlock key to the 2-party transaction trigger entry to a first party account;
      provide a crypto unlock key to the 2-party transaction trigger entry to a second party account;
      obtain an first encrypted token for the crypto 2-party transaction trigger form the first party account, wherein the encrypted token is for an account having an asset value;
      obtain an second encrypted token for the crypto 2-party transaction trigger form the second party account;
      determine an instantiated aggregated crypto 2-party transaction trigger event occurred;
      unlock instantiated aggregated crypto 2-party transaction trigger entry based on determination and provide the first encrypted token to the second party and provide the second encrypted token to the first party;
      provide aggregated 2-party transaction trigger values for unlocking tokens to first and second parties for unlocking encrypted tokens for access to token accounts.
A107. The apparatus of embodiment A106, wherein the aggregated crypto 2-party transaction trigger is any of: anti-ping detection, detection of excess threshold account balance, detection of excess threshold of aggregated blockchain oracle value, detection of excess threshold number of transactions, detection of specified micro transaction amount, excess bounds of a UI generated crypto smart rule, failure to login to 4th party website, geofence transgression, user request.
A108. A crypto smart rules generator apparatus, comprising:
a memory;
a component collection in the memory, including:
a processor disposed in communication with the memory, and configured to issue a plurality of processing instructions from the component collection stored in the memory,
   wherein the processor issues instructions from the component collection, stored in the memory, to:
      obtain selection for a crypto smart rule type form a user;
      provide a crypto smart rule generator user interface (UI) for the selection type;
      obtain threshold constraint selections from the user;
      generate crypto smart rule from the constraint selections;
      instantiate an aggregated crypto smart rules trigger in a socially aggregated blockchain datastructure and an associated aggregated blockchain oracle via socially blockchain entry component from the threshold constraint selections and crypto smart rule type obtained from crypto smart rule generator UI, wherein the associated aggregated blockchain oracle obtains socially aggregated values via socially aggregated blockchain datastructure entries for evaluation by the aggregated crypto trigger.
A109. The apparatus of embodiment A108, wherein the aggregated crypto smart rules trigger is any of: anti-ping detection, detection of excess threshold account balance, detection of excess threshold of aggregated blockchain oracle value, detection of excess threshold number of transactions, detection of specified micro transaction amount, excess bounds of a UI generated crypto smart rule, failure to login to 4th party website, geofence transgression, user request.
A110. A crypto user authentication apparatus, comprising:
a memory;
a component collection in the memory, including:
a processor disposed in communication with the memory, and configured to issue a plurality of processing instructions from the component collection stored in the memory,
   wherein the processor issues instructions from the component collection, stored in the memory, to:
      obtain a user authentication request with a crypto wallet identifier from a requestor;
      cause an instantiation of a micro transaction to a crypto wallet associated to the crypto wallet identifier, wherein the micro transaction is of a crypto currency and wherein the transaction is any of a deposit or withdrawal type of a specified crypto trigger rule;
      determine the specified amount of the micro transaction matches the specified crypto trigger rule;
      provide indication of user authentication to the requestor.
A111. The apparatus of embodiment A110, wherein the specified crypto trigger rule is an aggregated crypto smart rules trigger and is any of: anti-ping detection, detection of excess threshold account balance, detection of excess threshold of aggregated blockchain oracle value, detection of excess threshold number of transactions, detection of specified micro transaction amount, excess bounds of a UI generated crypto smart rule, failure to login to 4th party website, geofence transgression, user request.
A112. The apparatus of embodiment A111, wherein instantiation of the micro transaction is initiated by the requestor.
A113. The apparatus of embodiment A112, wherein the specified amount is specified by the requestor.
A114. The apparatus of embodiment A111, wherein the specified amount is specified by the requestor.
A115. The apparatus of embodiment A114, wherein instantiation of the micro transaction is initiated by the requestor.
A201. A crypto recovery key apparatus, comprising:
a memory;
a component collection in the memory, including:
   a multiple key account data structure datastore generating component; and
   a crypto key recovery component;
a processor disposed in communication with the memory, and configured to issue a plurality of processing instructions from the component collection stored in the memory,
   wherein the processor issues instructions from the multiple key account data structure datastore generating component, stored in the memory, to:
      obtain, via at least one processor, a multiple key account data structure datastore generation request from a user;
      determine, via at least one processor, a set of crypto public keys for a multiple key account data structure datastore;
      instantiate, via at least one processor, the multiple key account data structure datastore in a socially aggregated blockchain datastructure using the determined set of crypto public keys;
      associate, via at least one processor, a crypto recovery private key with the multiple key account data structure datastore;
      set, via at least one processor, trigger event recovery settings for the multiple key account data structure datastore;
   wherein the processor issues instructions from the crypto key recovery component, stored in the memory, to:
      obtain, via at least one processor, a trigger event message associated with the multiple key account data structure datastore;
      determine, via at least one processor, recovery settings associated with a trigger event specified in the trigger event message;
      retrieve, via at least one processor, the crypto recovery private key; and
      facilitate, via at least one processor, a recovery action, specified in the recovery settings, associated with the trigger event using the crypto recovery private key.
A202. The apparatus of embodiment A201, wherein the multiple key account data structure datastore generation request specifies the set of crypto public keys and the crypto recovery private key.
A203. The apparatus of embodiment A201, wherein the crypto recovery private key is encrypted.
A204. The apparatus of embodiment A201, wherein instructions to instantiate the multiple key account data structure datastore in the socially aggregated blockchain datastructure further include instructions to add a multisignature address associated with the determined set of crypto public keys to the multiple key account data structure datastore.
A205. The apparatus of embodiment A204, wherein the crypto recovery private key corresponds to a crypto public key in the set of crypto public keys.
A206. The apparatus of embodiment A201, wherein the set of crypto public keys is a set of two crypto public keys, wherein the set of crypto public keys includes a normal use crypto public key and a recovery crypto public key.
A207. The apparatus of embodiment A201, wherein the trigger event message is obtained from an aggregated blockchain oracle.
A208. The apparatus of embodiment A207, wherein the aggregated blockchain oracle provides crowdsourced decentralized data.
A209. The apparatus of embodiment A201, wherein the trigger event is any of: user request, occurrence of geofence constraint violation, anti-ping detection, occurrence of time range fencing violation, occurrence of transaction/consumption constraint violation, occurrence of account balance constraint violation, occurrence of specified oracle data value, occurrence of a smart contract generator GUI generated crypto smart rule violation, detection of fraud, detection of a specified vote, detection of a specified vote result, detection of a request to add an external feature to an account, detection of a specified crypto verification response, failure to login to 4th party website.
A210. The apparatus of embodiment A201, wherein instructions to retrieve the crypto recovery private key further include instructions to decrypt the crypto recovery private key using a decryption key provided by a validation server associated with the multiple key account data structure datastore.
A211. The apparatus of embodiment A201, wherein instructions to facilitate the recovery action further include instructions to transfer crypto tokens associated with the multiple key account data structure datastore to a specified location.
A212. The apparatus of embodiment A211, wherein the specified location is another multiple key account data structure datastore associated with the user.
A213. The apparatus of embodiment A211, wherein the specified location is a specified multisignature address associated with the user, wherein the specified multisignature address is not associated with the multiple key account data structure datastore
A214. The apparatus of embodiment A201, wherein instructions to facilitate the recovery action further include instructions to provide the crypto recovery private key to the user.
A215. The apparatus of embodiment A201, wherein the trigger event recovery settings are obtained from the user via a smart contract generator GUI.
A216. A processor-readable crypto recovery key non-transient physical medium storing processor-executable components, the components, comprising:
a component collection stored in the medium, including:
   a multiple key account data structure datastore generating component; and
   a crypto key recovery component;
   wherein the multiple key account data structure datastore generating component, stored in the medium, includes processor-issuable instructions to:
      obtain, via at least one processor, a multiple key account data structure datastore generation request from a user;
      determine, via at least one processor, a set of crypto public keys for a multiple key account data structure datastore;
      instantiate, via at least one processor, the multiple key account data structure datastore in a socially aggregated blockchain datastructure using the determined set of crypto public keys;
      associate, via at least one processor, a crypto recovery private key with the multiple key account data structure datastore;
      set, via at least one processor, trigger event recovery settings for the multiple key account data structure datastore;
   wherein the crypto key recovery component, stored in the medium, includes processor-issuable instructions to:
      obtain, via at least one processor, a trigger event message associated with the multiple key account data structure datastore;
      determine, via at least one processor, recovery settings associated with a trigger event specified in the trigger event message;
      retrieve, via at least one processor, the crypto recovery private key; and
      facilitate, via at least one processor, a recovery action, specified in the recovery settings, associated with the trigger event using the crypto recovery private key.
A217. The medium of embodiment A216, wherein the multiple key account data structure datastore generation request specifies the set of crypto public keys and the crypto recovery private key.
A218. The medium of embodiment A216, wherein the crypto recovery private key is encrypted.
A219. The medium of embodiment A216, wherein instructions to instantiate the multiple key account data structure datastore in the socially aggregated blockchain datastructure further include instructions to add a multisignature address associated with the determined set of crypto public keys to the multiple key account data structure datastore.
A220. The medium of embodiment A219, wherein the crypto recovery private key corresponds to a crypto public key in the set of crypto public keys.
A221. The medium of embodiment A216, wherein the set of crypto public keys is a set of two crypto public keys, wherein the set of crypto public keys includes a normal use crypto public key and a recovery crypto public key.
A222. The medium of embodiment A216, wherein the trigger event message is obtained from an aggregated blockchain oracle.
A223. The medium of embodiment A222, wherein the aggregated blockchain oracle provides crowdsourced decentralized data.
A224. The medium of embodiment A216, wherein the trigger event is any of: user request, occurrence of geofence constraint violation, anti-ping detection, occurrence of time range fencing violation, occurrence of transaction/consumption constraint violation, occurrence of account balance constraint violation, occurrence of specified oracle data value, occurrence of a smart contract generator GUI generated crypto smart rule violation, detection of fraud, detection of a specified vote, detection of a specified vote result, detection of a request to add an external feature to an account, detection of a specified crypto verification response, failure to login to 4^{th} party website.
A225. The medium of embodiment A216, wherein instructions to retrieve the crypto recovery private key further include instructions to decrypt the crypto recovery private key using a decryption key provided by a validation server associated with the multiple key account data structure datastore.
A226. The medium of embodiment A216, wherein instructions to facilitate the recovery action further include instructions to transfer crypto tokens associated with the multiple key account data structure datastore to a specified location.
A227. The medium of embodiment A226, wherein the specified location is another multiple key account data structure datastore associated with the user.
A228. The medium of embodiment A226, wherein the specified location is a specified multisignature address associated with the user, wherein the specified multisignature address is not associated with the multiple key account data structure datastore
A229. The medium of embodiment A216, wherein instructions to facilitate the recovery action further include instructions to provide the crypto recovery private key to the user.
A230. The medium of embodiment A216, wherein the trigger event recovery settings are obtained from the user via a smart contract generator GUI.
A231. A processor-implemented crypto recovery key system, comprising:
   multiple key account data structure datastore generating component means, to:
      obtain, via at least one processor, a multiple key account data structure datastore generation request from a user;
      determine, via at least one processor, a set of crypto public keys for a multiple key account data structure datastore;
      instantiate, via at least one processor, the multiple key account data structure datastore in a socially aggregated blockchain datastructure using the determined set of crypto public keys;
      associate, via at least one processor, a crypto recovery private key with the multiple key account data structure datastore;
      set, via at least one processor, trigger event recovery settings for the multiple key account data structure datastore;
   crypto key recovery component means, to:
      obtain, via at least one processor, a trigger event message associated with the multiple key account data structure datastore;
      determine, via at least one processor, recovery settings associated with a trigger event specified in the trigger event message;
      retrieve, via at least one processor, the crypto recovery private key; and
      facilitate, via at least one processor, a recovery action, specified in the recovery settings, associated with the trigger event using the crypto recovery private key.
A232. The system of embodiment A231, wherein the multiple key account data structure datastore generation request specifies the set of crypto public keys and the crypto recovery private key.
A233. The system of embodiment A231, wherein the crypto recovery private key is encrypted.
A234. The system of embodiment A231, wherein means to instantiate the multiple key account data structure datastore in the socially aggregated blockchain datastructure further include means to add a multisignature address associated with the determined set of crypto public keys to the multiple key account data structure datastore.
A235. The system of embodiment A234, wherein the crypto recovery private key corresponds to a crypto public key in the set of crypto public keys.
A236. The system of embodiment A231, wherein the set of crypto public keys is a set of two crypto public keys, wherein the set of crypto public keys includes a normal use crypto public key and a recovery crypto public key.
A237. The system of embodiment A231, wherein the trigger event message is obtained from an aggregated blockchain oracle.
A238. The system of embodiment A237, wherein the aggregated blockchain oracle provides crowdsourced decentralized data.
A239. The system of embodiment A231, wherein the trigger event is any of: user request, occurrence of geofence constraint violation, anti-ping detection, occurrence of time range fencing violation, occurrence of transaction/consumption constraint violation, occurrence of account balance constraint violation, occurrence of specified oracle data value, occurrence of a smart contract generator GUI generated crypto smart rule violation, detection of fraud, detection of a specified vote, detection of a specified vote result, detection of a request to add an external feature to an account, detection of a specified crypto verification response, failure to login to 4^{th} party website.
A240. The system of embodiment A231, wherein means to retrieve the crypto recovery private key further include means to decrypt the crypto recovery private key using a decryption key provided by a validation server associated with the multiple key account data structure datastore.
A241. The system of embodiment A231, wherein means to facilitate the recovery action further include means to transfer crypto tokens associated with the multiple key account data structure datastore to a specified location.
A242. The system of embodiment A241, wherein the specified location is another multiple key account data structure datastore associated with the user.
A243. The system of embodiment A241, wherein the specified location is a specified multisignature address associated with the user, wherein the specified multisignature address is not associated with the multiple key account data structure datastore
A244. The system of embodiment A231, wherein means to facilitate the recovery action further include means to provide the crypto recovery private key to the user.
A245. The system of embodiment A231, wherein the trigger event recovery settings are obtained from the user via a smart contract generator GUI.
A246. A processor-implemented crypto recovery key method, comprising:
   executing processor-implemented multiple key account data structure datastore generating component instructions to:
      obtain, via at least one processor, a multiple key account data structure datastore generation request from a user;
      determine, via at least one processor, a set of crypto public keys for a multiple key account data structure datastore;
      instantiate, via at least one processor, the multiple key account data structure datastore in a socially aggregated blockchain datastructure using the determined set of crypto public keys;
      associate, via at least one processor, a crypto recovery private key with the multiple key account data structure datastore;
      set, via at least one processor, trigger event recovery settings for the multiple key account data structure datastore;
   executing processor-implemented crypto key recovery component instructions to:
      obtain, via at least one processor, a trigger event message associated with the multiple key account data structure datastore;
      determine, via at least one processor, recovery settings associated with a trigger event specified in the trigger event message;
      retrieve, via at least one processor, the crypto recovery private key; and
      facilitate, via at least one processor, a recovery action, specified in the recovery settings, associated with the trigger event using the crypto recovery private key.
A247. The method of embodiment A246, wherein the multiple key account data structure datastore generation request specifies the set of crypto public keys and the crypto recovery private key.
A248. The method of embodiment A246, wherein the crypto recovery private key is encrypted.
A249. The method of embodiment A246, wherein instructions to instantiate the multiple key account data structure datastore in the socially aggregated blockchain datastructure further include instructions to add a multisignature address associated with the determined set of crypto public keys to the multiple key account data structure datastore.
A250. The method of embodiment A249, wherein the crypto recovery private key corresponds to a crypto public key in the set of crypto public keys.
A251. The method of embodiment A246, wherein the set of crypto public keys is a set of two crypto public keys, wherein the set of crypto public keys includes a normal use crypto public key and a recovery crypto public key.
A252. The method of embodiment A246, wherein the trigger event message is obtained from an aggregated blockchain oracle.
A253. The method of embodiment A252, wherein the aggregated blockchain oracle provides crowdsourced decentralized data.
A254. The method of embodiment A246, wherein the trigger event is any of: user request, occurrence of geofence constraint violation, anti-ping detection, occurrence of time range fencing violation, occurrence of transaction/consumption constraint violation, occurrence of account balance constraint violation, occurrence of specified oracle data value, occurrence of a smart contract generator GUI generated crypto smart rule violation, detection of fraud, detection of a specified vote, detection of a specified vote result, detection of a request to add an external feature to an account, detection of a specified crypto verification response, failure to login to 4^{th} party website.
A255. The method of embodiment A246, wherein instructions to retrieve the crypto recovery private key further include instructions to decrypt the crypto recovery private key using a decryption key provided by a validation server associated with the multiple key account data structure datastore.
A256. The method of embodiment A246, wherein instructions to facilitate the recovery action further include instructions to transfer crypto tokens associated with the multiple key account data structure datastore to a specified location.
A257. The method of embodiment A256, wherein the specified location is another multiple key account data structure datastore associated with the user.
A258. The method of embodiment A256, wherein the specified location is a specified multisignature address associated with the user, wherein the specified multisignature address is not associated with the multiple key account data structure datastore
A259. The method of embodiment A246, wherein instructions to facilitate the recovery action further include instructions to provide the crypto recovery private key to the user.
A260. The method of embodiment A246, wherein the trigger event recovery settings are obtained from the user via a smart contract generator GUI.
A301. A crypto voting apparatus, comprising:
a memory;
a component collection in the memory, including:
   a voter authentication component; and
   a vote processing component;
a processor disposed in communication with the memory, and configured to issue a plurality of processing instructions from the component collection stored in the memory,
   wherein the processor issues instructions from the voter authentication component, stored in the memory, to:
      obtain, via at least one processor, a crypto vote request associated with a poll from a user;
      obtain, via at least one processor, voter authentication from the user;
      determine, via at least one processor, that the user is authorized to vote in the poll based on the obtained voter authentication data;
      generate, via at least one processor, an authentication token for the authorized user;
      generate, via at least one processor, a crypto vote user interface (UI) and provide the crypto vote UI to the user;
   wherein the processor issues instructions from the vote processing component, stored in the memory, to:
      obtain, via at least one processor, a crypto vote input from the user, wherein the crypto vote input specifies a conditional vote, wherein the conditional vote includes a set of vote conditions, and wherein each vote condition in the set of vote conditions is associated with a vote outcome and with an aggregated blockchain oracle;
      instantiate, via at least one processor, the conditional vote in a socially aggregated blockchain datastructure;
      determine, via at least one processor, that a vote condition in the set of vote conditions has been satisfied by evaluating aggregated blockchain oracle data provided by the aggregated blockchain oracle associated with the determined vote condition; and
      determine, via at least one processor, vote outcome of the conditional vote as the vote outcome associated with the determined vote condition.
A302. The apparatus of embodiment A301, wherein instructions to obtain voter authentication further include instructions to obtain login credentials for an account created based on the user providing proof of identity.
A303. The apparatus of embodiment A301, wherein instructions to obtain voter authentication further include instructions to detect that the user satisfied a smart contract instantiated in the socially aggregated blockchain datastructure.
A304. The apparatus of embodiment A303, wherein the user satisfies the smart contract by transferring a crypto token from a crypto address known to belong to the user.
A305. The apparatus of embodiment A301, wherein instructions to determine that the user is authorized to vote in the poll further include instructions to detect that the user is on a voters list associated with the poll.
A306. The apparatus of embodiment A301, wherein the authentication token is generated such that the user's identity cannot be determined from the authentication token.
A307. The apparatus of embodiment A301, wherein the crypto vote UI is a smart contract generator GUI.
A308. The apparatus of embodiment A301, wherein an aggregated blockchain oracle is any of: a market data provider, a GPS data provider, a date/time provider, a crowdsourced decentralized data provider, a news provider, an activity monitor, an RSS feed.
A309. The apparatus of embodiment A301, wherein a vote outcome associated with a vote condition is a fractional vote that specifies a plurality of vote outcomes and a voting power portion allocated to each of the plurality of vote outcomes.
A310. The apparatus of embodiment A301, wherein the instantiated conditional vote is encrypted. A311. The apparatus of embodiment A301, wherein the evaluated aggregated blockchain oracle data is combined crowdsourced decentralized product usage data.
A312. The apparatus of embodiment A301, further comprising:
   the processor issues instructions from the vote processing component, stored in the memory, to:
      facilitate a vote action associated with the determined vote outcome of the conditional vote.
A313. The apparatus of embodiment A312, wherein the vote action is any of: restrict access to an account, release an extra key, purchase stock, vote in a specified way in another poll.
A314. The apparatus of embodiment A312, wherein the evaluated aggregated blockchain oracle data includes securities transactions associated with an entity.
A315. The apparatus of embodiment A314, wherein the vote action is to replicate the securities transactions of the entity.
A316. A processor-readable crypto voting non-transient physical medium storing processor-executable components, the components, comprising:
a component collection stored in the medium, including:
   a voter authentication component; and
   a vote processing component;
   wherein the voter authentication component, stored in the medium, includes processor-issuable instructions to:
      obtain, via at least one processor, a crypto vote request associated with a poll from a user;
      obtain, via at least one processor, voter authentication from the user;
      determine, via at least one processor, that the user is authorized to vote in the poll based on the obtained voter authentication data;
      generate, via at least one processor, an authentication token for the authorized user;
      generate, via at least one processor, a crypto vote user interface (UI) and provide the crypto vote UI to the user;
   wherein the vote processing component, stored in the medium, includes processor-issuable instructions to:
      obtain, via at least one processor, a crypto vote input from the user, wherein the crypto vote input specifies a conditional vote, wherein the conditional vote includes a set of vote conditions, and wherein each vote condition in the set of vote conditions is associated with a vote outcome and with an aggregated blockchain oracle;
      instantiate, via at least one processor, the conditional vote in a socially aggregated blockchain datastructure;
      determine, via at least one processor, that a vote condition in the set of vote conditions has been satisfied by evaluating aggregated blockchain oracle data provided by the aggregated blockchain oracle associated with the determined vote condition; and
      determine, via at least one processor, vote outcome of the conditional vote as the vote outcome associated with the determined vote condition.
A317. The medium of embodiment A316, wherein instructions to obtain voter authentication further include instructions to obtain login credentials for an account created based on the user providing proof of identity.
A318. The medium of embodiment A316, wherein instructions to obtain voter authentication further include instructions to detect that the user satisfied a smart contract instantiated in the socially aggregated blockchain datastructure.
A319. The medium of embodiment A318, wherein the user satisfies the smart contract by transferring a crypto token from a crypto address known to belong to the user.
A320. The medium of embodiment A316, wherein instructions to determine that the user is authorized to vote in the poll further include instructions to detect that the user is on a voters list associated with the poll.
A321. The medium of embodiment A316, wherein the authentication token is generated such that the user's identity cannot be determined from the authentication token.
A322. The medium of embodiment A316, wherein the crypto vote UI is a smart contract generator GUI.
A323. The medium of embodiment A316, wherein an aggregated blockchain oracle is any of: a market data provider, a GPS data provider, a date/time provider, a crowdsourced decentralized data provider, a news provider, an activity monitor, an RSS feed.
A324. The medium of embodiment A316, wherein a vote outcome associated with a vote condition is a fractional vote that specifies a plurality of vote outcomes and a voting power portion allocated to each of the plurality of vote outcomes.
A325. The medium of embodiment A316, wherein the instantiated conditional vote is encrypted.
A326. The medium of embodiment A316, wherein the evaluated aggregated blockchain oracle data is combined crowdsourced decentralized product usage data.
A327. The medium of embodiment A316, further comprising:
   the vote processing component, stored in the medium, includes processor-issuable instructions to:
      facilitate a vote action associated with the determined vote outcome of the conditional vote.
A328. The medium of embodiment A327, wherein the vote action is any of: restrict access to an account, release an extra key, purchase stock, vote in a specified way in another poll.
A329. The medium of embodiment A327, wherein the evaluated aggregated blockchain oracle data includes securities transactions associated with an entity.
A330. The medium of embodiment A329, wherein the vote action is to replicate the securities transactions of the entity.
A331. A processor-implemented crypto voting system, comprising:
voter authentication component means, to:
   obtain, via at least one processor, a crypto vote request associated with a poll from a user;
   obtain, via at least one processor, voter authentication from the user;
   determine, via at least one processor, that the user is authorized to vote in the poll based on the obtained voter authentication data;
   generate, via at least one processor, an authentication token for the authorized user;
   generate, via at least one processor, a crypto vote user interface (UI) and provide the crypto vote UI to the user;
vote processing component means, to:
   obtain, via at least one processor, a crypto vote input from the user, wherein the crypto vote input specifies a conditional vote, wherein the conditional vote includes a set of vote conditions, and wherein each vote condition in the set of vote conditions is associated with a vote outcome and with an aggregated blockchain oracle;
   instantiate, via at least one processor, the conditional vote in a socially aggregated blockchain datastructure;
   determine, via at least one processor, that a vote condition in the set of vote conditions has been satisfied by evaluating aggregated blockchain oracle data provided by the aggregated blockchain oracle associated with the determined vote condition; and
   determine, via at least one processor, vote outcome of the conditional vote as the vote outcome associated with the determined vote condition.
A332. The system of embodiment A331, wherein means to obtain voter authentication further include means to obtain login credentials for an account created based on the user providing proof of identity.
A333. The system of embodiment A331, wherein means to obtain voter authentication further include means to detect that the user satisfied a smart contract instantiated in the socially aggregated blockchain datastructure.
A334. The system of embodiment A333, wherein the user satisfies the smart contract by transferring a crypto token from a crypto address known to belong to the user.
A335. The system of embodiment A331, wherein means to determine that the user is authorized to vote in the poll further include means to detect that the user is on a voters list associated with the poll.
A336. The system of embodiment A331, wherein the authentication token is generated such that the user's identity cannot be determined from the authentication token.
A337. The system of embodiment A331, wherein the crypto vote UI is a smart contract generator GUI.
A338. The system of embodiment A331, wherein an aggregated blockchain oracle is any of: a market data provider, a GPS data provider, a date/time provider, a crowdsourced decentralized data provider, a news provider, an activity monitor, an RSS feed.
A339. The system of embodiment A331, wherein a vote outcome associated with a vote condition is a fractional vote that specifies a plurality of vote outcomes and a voting power portion allocated to each of the plurality of vote outcomes.
A340. The system of embodiment A331, wherein the instantiated conditional vote is encrypted.
A341. The system of embodiment A331, wherein the evaluated aggregated blockchain oracle data is combined crowdsourced decentralized product usage data.
A342. The system of embodiment A331, further comprising:
   the vote processing component means, to:
      facilitate a vote action associated with the determined vote outcome of the conditional vote.
A343. The system of embodiment A342, wherein the vote action is any of: restrict access to an account, release an extra key, purchase stock, vote in a specified way in another poll.
A344. The system of embodiment A342, wherein the evaluated aggregated blockchain oracle data includes securities transactions associated with an entity.
A345. The system of embodiment A344, wherein the vote action is to replicate the securities transactions of the entity.
A346. A processor-implemented crypto voting method, comprising:
   executing processor-implemented voter authentication component instructions to:
      obtain, via at least one processor, a crypto vote request associated with a poll from a user;
      obtain, via at least one processor, voter authentication from the user;
      determine, via at least one processor, that the user is authorized to vote in the poll based on the obtained voter authentication data;
      generate, via at least one processor, an authentication token for the authorized user;
      generate, via at least one processor, a crypto vote user interface (UI) and provide the crypto vote UI to the user;
   executing processor-implemented vote processing component instructions to:
      obtain, via at least one processor, a crypto vote input from the user, wherein the crypto vote input specifies a conditional vote, wherein the conditional vote includes a set of vote conditions, and wherein each vote condition in the set of vote conditions is associated with a vote outcome and with an aggregated blockchain oracle;
      instantiate, via at least one processor, the conditional vote in a socially aggregated blockchain datastructure;
      determine, via at least one processor, that a vote condition in the set of vote conditions has been satisfied by evaluating aggregated blockchain oracle data provided by the aggregated blockchain oracle associated with the determined vote condition; and
      determine, via at least one processor, vote outcome of the conditional vote as the vote outcome associated with the determined vote condition.
A347. The method of embodiment A346, wherein instructions to obtain voter authentication further include instructions to obtain login credentials for an account created based on the user providing proof of identity.
A348. The method of embodiment A346, wherein instructions to obtain voter authentication further include instructions to detect that the user satisfied a smart contract instantiated in the socially aggregated blockchain datastructure.
A349. The method of embodiment A348, wherein the user satisfies the smart contract by transferring a crypto token from a crypto address known to belong to the user.
A350. The method of embodiment A346, wherein instructions to determine that the user is authorized to vote in the poll further include instructions to detect that the user is on a voters list associated with the poll.
A351. The method of embodiment A346, wherein the authentication token is generated such that the user's identity cannot be determined from the authentication token.
A352. The method of embodiment A346, wherein the crypto vote U1 is a smart contract generator GUI.
A353. The method of embodiment A346, wherein an aggregated blockchain oracle is any of: a market data provider, a GPS data provider, a date/time provider, a crowdsourced decentralized data provider, a news provider, an activity monitor, an RSS feed.
A354. The method of embodiment A346, wherein a vote outcome associated with a vote condition is a fractional vote that specifies a plurality of vote outcomes and a voting power portion allocated to each of the plurality of vote outcomes.
A355. The method of embodiment A346, wherein the instantiated conditional vote is encrypted. A356. The method of embodiment A346, wherein the evaluated aggregated blockchain oracle data is combined crowdsourced decentralized product usage data.
A357. The method of embodiment A346, further comprising:
   executing processor-implemented vote processing component instructions to:
      facilitate a vote action associated with the determined vote outcome of the conditional vote.
A358. The method of embodiment A357, wherein the vote action is any of: restrict access to an account, release an extra key, purchase stock, vote in a specified way in another poll.
A359. The method of embodiment A357, wherein the evaluated aggregated blockchain oracle data includes securities transactions associated with an entity.
A360. The method of embodiment A359, wherein the vote action is to replicate the securities transactions of the entity.
A401. A crypto verification apparatus, comprising:
a memory;
a component collection in the memory, including:
   a verification processing component;
a processor disposed in communication with the memory, and configured to issue a plurality of processing instructions from the component collection stored in the memory,
   wherein the processor issues instructions from the verification processing component, stored in the memory, to:
      obtain, via at least one processor, an external feature add request associated with a participant account data structure from an authenticated user, wherein the external feature add request identifies an external feature to associate with the participant account data structure;
      determine, via at least one processor, a verification standard for the external feature add request;
      determine, via at least one processor, verification data parameters to obtain from the authenticated user based on the determined verification standard, wherein the verification data parameters include a specification of one or more crypto tokens to be transferred by the authenticated user;
      determine, via at least one processor, a verification address for the external feature;
      generate, via at least one processor, a crypto verification request that specifies the verification data parameters to obtain from the authenticated user and the verification address from which the one or more crypto tokens are to be transferred;
      provide, via at least one processor, the crypto verification request to the authenticated user;
      obtain, via at least one processor, a crypto verification response from the authenticated user, wherein the crypto verification response comprises a verification transaction in a socially aggregated blockchain datastructure; and
      modify, via at least one processor, the participant account data structure to indicate association with the external feature based on determining that the verification transaction satisfies the specified verification data parameters.
A402. The apparatus of embodiment A401, wherein the participant account data structure is associated with a multiple key account data structure datastore.
A403. The apparatus of embodiment A401, wherein the external feature is a third party electronic wallet.
A404. The apparatus of embodiment A401, wherein the external feature add request specifies a linked service where the external feature is to be utilized.
A405. The apparatus of embodiment A404, wherein the verification standard is specific to the linked service.
A406. The apparatus of embodiment A401, wherein the verification standard is based on a smart contract generator GUI generated crypto smart rule.
A407. The apparatus of embodiment A401, wherein the verification data parameters include one or more of: a verification string, a verification amount, location data, a time stamp, metadata, UI triggerables.
A408. The apparatus of embodiment A403, further comprising:
   the processor issues instructions from the verification processing component, stored in the memory, to:
      transfer the one or more crypto tokens to the third party electronic wallet.
A409. The apparatus of embodiment A408, wherein the one or more crypto tokens include encrypted crypto token data encrypted with a public key associated with the third party electronic wallet.
A410. The apparatus of embodiment A401, wherein instructions to generate a crypto verification request further include instructions to instantiate a crypto smart contract in a socially aggregated blockchain datastructure.
A411. The apparatus of embodiment A410, wherein instructions to determine that the verification transaction satisfies the specified verification data parameters further include instructions to detect that the verification transaction satisfies the crypto smart contract instantiated in the socially aggregated blockchain datastructure.
A412. The apparatus of embodiment A410, wherein the crypto smart contract specifies an aggregated blockchain oracle associated with a verification data parameter.
A413. The apparatus of embodiment A412, wherein an aggregated blockchain oracle is any of: a market data provider, a GPS data provider, a date/time provider, a crowdsourced decentralized data provider, a news provider, an activity monitor, an RSS feed.
A414. The apparatus of embodiment A413, wherein an RSS feed is any of: an aggregated mobile phone data feed, a social network feed, a news feed, a market data feed.
A415. The apparatus of embodiment A412, wherein instructions to determine that the verification transaction satisfies the specified verification data parameters further include instructions to detect that the verification transaction satisfies the crypto smart contract instantiated in the socially aggregated blockchain datastructure based on oracle data provided by the aggregated blockchain oracle.
A416. A processor-readable crypto verification non-transient physical medium storing processor-executable components, the components, comprising:
a component collection stored in the medium, including:
   a verification processing component;
   wherein the verification processing component, stored in the medium, includes processor-issuable instructions to:
      obtain, via at least one processor, an external feature add request associated with a participant account data structure from an authenticated user, wherein the external feature add request identifies an external feature to associate with the participant account data structure;
      determine, via at least one processor, a verification standard for the external feature add request;
      determine, via at least one processor, verification data parameters to obtain from the authenticated user based on the determined verification standard, wherein the verification data parameters include a specification of one or more crypto tokens to be transferred by the authenticated user;
      determine, via at least one processor, a verification address for the external feature;
      generate, via at least one processor, a crypto verification request that specifies the verification data parameters to obtain from the authenticated user and the verification address from which the one or more crypto tokens are to be transferred;
      provide, via at least one processor, the crypto verification request to the authenticated user;
      obtain, via at least one processor, a crypto verification response from the authenticated user, wherein the crypto verification response comprises a verification transaction in a socially aggregated blockchain datastructure; and
      modify, via at least one processor, the participant account data structure to indicate association with the external feature based on determining that the verification transaction satisfies the specified verification data parameters.
A417. The medium of embodiment A416, wherein the participant account data structure is associated with a multiple key account data structure datastore.
A418. The medium of embodiment A416, wherein the external feature is a third party electronic wallet.
A419. The medium of embodiment A416, wherein the external feature add request specifies a linked service where the external feature is to be utilized.
A420. The medium of embodiment A419, wherein the verification standard is specific to the linked service.
A421. The medium of embodiment A416, wherein the verification standard is based on a smart contract generator GUI generated crypto smart rule.
A422. The medium of embodiment A416, wherein the verification data parameters include one or more of: a verification string, a verification amount, location data, a time stamp, metadata, UI triggerables.
A423. The medium of embodiment A418, further comprising:
   the verification processing component, stored in the medium, includes processor-issuable instructions to:
      transfer the one or more crypto tokens to the third party electronic wallet.
A424. The medium of embodiment A423, wherein the one or more crypto tokens include encrypted crypto token data encrypted with a public key associated with the third party electronic wallet.
A425. The medium of embodiment A416, wherein instructions to generate a crypto verification request further include instructions to instantiate a crypto smart contract in a socially aggregated blockchain datastructure.
A426. The medium of embodiment A425, wherein instructions to determine that the verification transaction satisfies the specified verification data parameters further include instructions to detect that the verification transaction satisfies the crypto smart contract instantiated in the socially aggregated blockchain datastructure.
A427. The medium of embodiment A425, wherein the crypto smart contract specifies an aggregated blockchain oracle associated with a verification data parameter.
A428. The medium of embodiment A427, wherein an aggregated blockchain oracle is any of: a market data provider, a GPS data provider, a date/time provider, a crowdsourced decentralized data provider, a news provider, an activity monitor, an RSS feed. A429. The medium of embodiment A428, wherein an RSS feed is any of: an aggregated mobile phone data feed, a social network feed, a news feed, a market data feed.
A430. The medium of embodiment A427, wherein instructions to determine that the verification transaction satisfies the specified verification data parameters further include instructions to detect that the verification transaction satisfies the crypto smart contract instantiated in the socially aggregated blockchain datastructure based on oracle data provided by the aggregated blockchain oracle.
A431. A processor-implemented crypto verification system, comprising:
   verification processing component means, to:
      obtain, via at least one processor, an external feature add request associated with a participant account data structure from an authenticated user, wherein the external feature add request identifies an external feature to associate with the participant account data structure;
      determine, via at least one processor, a verification standard for the external feature add request;
      determine, via at least one processor, verification data parameters to obtain from the authenticated user based on the determined verification standard, wherein the verification data parameters include a specification of one or more crypto tokens to be transferred by the authenticated user;
      determine, via at least one processor, a verification address for the external feature;
      generate, via at least one processor, a crypto verification request that specifies the verification data parameters to obtain from the authenticated user and the verification address from which the one or more crypto tokens are to be transferred;
      provide, via at least one processor, the crypto verification request to the authenticated user;
      obtain, via at least one processor, a crypto verification response from the authenticated user, wherein the crypto verification response comprises a verification transaction in a socially aggregated blockchain datastructure; and
      modify, via at least one processor, the participant account data structure to indicate association with the external feature based on determining that the verification transaction satisfies the specified verification data parameters.
A432. The system of embodiment A431, wherein the participant account data structure is associated with a multiple key account data structure datastore.
A433. The system of embodiment A431, wherein the external feature is a third party electronic wallet.
A434. The system of embodiment A431, wherein the external feature add request specifies a linked service where the external feature is to be utilized.
A435. The system of embodiment A434, wherein the verification standard is specific to the linked service.
A436. The system of embodiment A431, wherein the verification standard is based on a smart contract generator GUI generated crypto smart rule.
A437. The system of embodiment A431, wherein the verification data parameters include one or more of: a verification string, a verification amount, location data, a time stamp, metadata, UI triggerables.
A438. The system of embodiment A433, further comprising:
   verification processing component means, to:
      transfer the one or more crypto tokens to the third party electronic wallet.
A439. The system of embodiment A438, wherein the one or more crypto tokens include encrypted crypto token data encrypted with a public key associated with the third party electronic wallet.
A440. The system of embodiment A431, wherein means to generate a crypto verification request further include means to instantiate a crypto smart contract in a socially aggregated blockchain datastructure.
A441. The system of embodiment A440, wherein means to determine that the verification transaction satisfies the specified verification data parameters further include means to detect that the verification transaction satisfies the crypto smart contract instantiated in the socially aggregated blockchain datastructure.
A442. The system of embodiment A440, wherein the crypto smart contract specifies an aggregated blockchain oracle associated with a verification data parameter.
A443. The system of embodiment A442, wherein an aggregated blockchain oracle is any of: a market data provider, a GPS data provider, a date/time provider, a crowdsourced decentralized data provider, a news provider, an activity monitor, an RSS feed.
A444. The system of embodiment A443, wherein an RSS feed is any of: an aggregated mobile phone data feed, a social network feed, a news feed, a market data feed.
A445. The system of embodiment A442, wherein means to determine that the verification transaction satisfies the specified verification data parameters further include means to detect that the verification transaction satisfies the crypto smart contract instantiated in the socially aggregated blockchain datastructure based on oracle data provided by the aggregated blockchain oracle.
A446. A processor-implemented crypto verification method, comprising:
   executing processor-implemented verification processing component instructions to:
      obtain, via at least one processor, an external feature add request associated with a participant account data structure from an authenticated user, wherein the external feature add request identifies an external feature to associate with the participant account data structure;
      determine, via at least one processor, a verification standard for the external feature add request;
      determine, via at least one processor, verification data parameters to obtain from the authenticated user based on the determined verification standard, wherein the verification data parameters include a specification of one or more crypto tokens to be transferred by the authenticated user;
      determine, via at least one processor, a verification address for the external feature;
      generate, via at least one processor, a crypto verification request that specifies the verification data parameters to obtain from the authenticated user and the verification address from which the one or more crypto tokens are to be transferred;
      provide, via at least one processor, the crypto verification request to the authenticated user;
      obtain, via at least one processor, a crypto verification response from the authenticated user, wherein the crypto verification response comprises a verification transaction in a socially aggregated blockchain datastructure; and
      modify, via at least one processor, the participant account data structure to indicate association with the external feature based on determining that the verification transaction satisfies the specified verification data parameters.
A447. The method of embodiment A446, wherein the participant account data structure is associated with a multiple key account data structure datastore.
A448. The method of embodiment A446, wherein the external feature is a third party electronic wallet.
A449. The method of embodiment A446, wherein the external feature add request specifies a linked service where the external feature is to be utilized.
A450. The method of embodiment A449, wherein the verification standard is specific to the linked service.
A451. The method of embodiment A446, wherein the verification standard is based on a smart contract generator GUI generated crypto smart rule.
A452. The method of embodiment A446, wherein the verification data parameters include one or more of: a verification string, a verification amount, location data, a time stamp, metadata, UI triggerables.
A453. The method of embodiment A448, further comprising:
   executing processor-implemented verification processing component instructions to:
      transfer the one or more crypto tokens to the third party electronic wallet.
A454. The method of embodiment A453, wherein the one or more crypto tokens include encrypted crypto token data encrypted with a public key associated with the third party electronic wallet.
A455. The method of embodiment A446, wherein instructions to generate a crypto verification request further include instructions to instantiate a crypto smart contract in a socially aggregated blockchain datastructure.
A456. The method of embodiment A455, wherein instructions to determine that the verification transaction satisfies the specified verification data parameters further include instructions to detect that the verification transaction satisfies the crypto smart contract instantiated in the socially aggregated blockchain datastructure.
A457. The method of embodiment A455, wherein the crypto smart contract specifies an aggregated blockchain oracle associated with a verification data parameter.
A458. The method of embodiment A457, wherein an aggregated blockchain oracle is any of: a market data provider, a GPS data provider, a date/time provider, a crowdsourced decentralized data provider, a news provider, an activity monitor, an RSS feed.
A459. The method of embodiment A458, wherein an RSS feed is any of: an aggregated mobile phone data feed, a social network feed, a news feed, a market data feed.
A460. The method of embodiment A457, wherein instructions to determine that the verification transaction satisfies the specified verification data parameters further include instructions to detect that the verification transaction satisfies the crypto smart contract instantiated in the socially aggregated blockchain datastructure based on oracle data provided by the aggregated blockchain oracle.
A501. A crypto smart rules generator apparatus, comprising:
a memory;
a component collection in the memory, including:
   a smart contract generating component;
a processor disposed in communication with the memory, and configured to issue a plurality of processing instructions from the component collection stored in the memory,
   wherein the processor issues instructions from the smart contract generating component, stored in the memory, to:
      obtain, via at least one processor, a selection, from a user, of a crypto smart rule type for a crypto smart rule associated with an aggregated crypto transaction trigger entry;
      provide, via at least one processor, a crypto smart rule generator user interface (UI) for the selected crypto smart rule type;
      obtain, via at least one processor, a selection, from the user via the UI, of a threshold constraint for the crypto smart rule;
      obtain, via at least one processor, a selection, from the user via the UI, of an aggregated blockchain oracle that provides oracle data for evaluation via the aggregated crypto transaction trigger entry for the crypto smart rule;
      generate, via at least one processor, the aggregated crypto transaction trigger entry based on the selected threshold constraint and the selected aggregated blockchain oracle for the crypto smart rule; and
      instantiate, via at least one processor, the aggregated crypto transaction trigger entry in a socially aggregated blockchain datastructure.
A502. The apparatus of embodiment A501, wherein the aggregated blockchain oracle is another aggregated crypto transaction trigger entry in a socially aggregated blockchain datastructure.
A503. The apparatus of embodiment A501, wherein the aggregated blockchain oracle is any of: a market data provider, a GPS data provider, a date/time provider, a crowdsourced decentralized data provider, a news provider, an activity monitor, an RSS feed.
A504. The apparatus of embodiment A503, wherein an RSS feed is any of: an aggregated mobile phone data feed, a social network feed, a news feed, a market data feed.
A505. The apparatus of embodiment A501, wherein the aggregated blockchain oracle provides crowdsourced decentralized data.
A506. The apparatus of embodiment A501, wherein the threshold constraint associated with the instantiated aggregated crypto transaction trigger entry is based on any of: anti-ping detection, detection of excess threshold account balance in an account data structure datastore, detection of excess threshold of aggregated blockchain oracle data value, detection of excess threshold number of transactions, detection of specified micro transaction amount, excess bounds of a smart contract generator GUI generated crypto smart rule, failure to login to 4^{th} party website, geofence transgression, user request.
A507. The apparatus of embodiment A501, wherein the threshold constraint is cascading and includes at least two levels.
A508. The apparatus of embodiment A501, wherein the instantiated aggregated crypto transaction trigger entry is configured to facilitate an action upon satisfaction of the crypto smart rule, wherein the action is any of: exchange assets between counterparties, restrict access to an account data structure datastore, release an extra key associated with an account data structure datastore, purchase stock, vote in a specified way.
A509. The apparatus of embodiment A501, wherein the UI includes a chart component.
A510. The apparatus of embodiment A501, wherein the UI includes a geographic map component.
A511. A processor-readable crypto smart rules generator non-transient physical medium storing processor-executable components, the components, comprising:
a component collection stored in the medium, including:
   a smart contract generating component;
   wherein the smart contract generating component, stored in the medium, includes processor-issuable instructions to:
      obtain, via at least one processor, a selection, from a user, of a crypto smart rule type for a crypto smart rule associated with an aggregated crypto transaction trigger entry;
      provide, via at least one processor, a crypto smart rule generator user interface (UI) for the selected crypto smart rule type;
      obtain, via at least one processor, a selection, from the user via the UI, of a threshold constraint for the crypto smart rule;
      obtain, via at least one processor, a selection, from the user via the UI, of an aggregated blockchain oracle that provides oracle data for evaluation via the aggregated crypto transaction trigger entry for the crypto smart rule;
      generate, via at least one processor, the aggregated crypto transaction trigger entry based on the selected threshold constraint and the selected aggregated blockchain oracle for the crypto smart rule; and
      instantiate, via at least one processor, the aggregated crypto transaction trigger entry in a socially aggregated blockchain datastructure.
A512. The medium of embodiment A511, wherein the aggregated blockchain oracle is another aggregated crypto transaction trigger entry in a socially aggregated blockchain datastructure.
A513. The medium of embodiment A511, wherein the aggregated blockchain oracle is any of: a market data provider, a GPS data provider, a date/time provider, a crowdsourced decentralized data provider, a news provider, an activity monitor, an RSS feed.
A514. The medium of embodiment A513, wherein an RSS feed is any of: an aggregated mobile phone data feed, a social network feed, a news feed, a market data feed.
A515. The medium of embodiment A511, wherein the aggregated blockchain oracle provides crowdsourced decentralized data.
A516. The medium of embodiment A511, wherein the threshold constraint associated with the instantiated aggregated crypto transaction trigger entry is based on any of: anti-ping detection, detection of excess threshold account balance in an account data structure datastore, detection of excess threshold of aggregated blockchain oracle data value, detection of excess threshold number of transactions, detection of specified micro transaction amount, excess bounds of a smart contract generator GUI generated crypto smart rule, failure to login to 4^{th} party website, geofence transgression, user request.
A517. The medium of embodiment A511, wherein the threshold constraint is cascading and includes at least two levels.
A518. The medium of embodiment A511, wherein the instantiated aggregated crypto transaction trigger entry is configured to facilitate an action upon satisfaction of the crypto smart rule, wherein the action is any of: exchange assets between counterparties, restrict access to an account data structure datastore, release an extra key associated with an account data structure datastore, purchase stock, vote in a specified way.
A519. The medium of embodiment A511, wherein the UI includes a chart component.
A520. The medium of embodiment A511, wherein the UI includes a geographic map component.
A521. A processor-implemented crypto smart rules generator system, comprising:
   smart contract generating component means, to:
      obtain, via at least one processor, a selection, from a user, of a crypto smart rule type for a crypto smart rule associated with an aggregated crypto transaction trigger entry;
      provide, via at least one processor, a crypto smart rule generator user interface (UI) for the selected crypto smart rule type;
      obtain, via at least one processor, a selection, from the user via the UI, of a threshold constraint for the crypto smart rule;
      obtain, via at least one processor, a selection, from the user via the UI, of an aggregated blockchain oracle that provides oracle data for evaluation via the aggregated crypto transaction trigger entry for the crypto smart rule;
      generate, via at least one processor, the aggregated crypto transaction trigger entry based on the selected threshold constraint and the selected aggregated blockchain oracle for the crypto smart rule; and
      instantiate, via at least one processor, the aggregated crypto transaction trigger entry in a socially aggregated blockchain datastructure.
A522. The system of embodiment A521, wherein the aggregated blockchain oracle is another aggregated crypto transaction trigger entry in a socially aggregated blockchain datastructure.
A523. The system of embodiment A521, wherein the aggregated blockchain oracle is any of: a market data provider, a GPS data provider, a date/time provider, a crowdsourced decentralized data provider, a news provider, an activity monitor, an RSS feed.
A524. The system of embodiment A523, wherein an RSS feed is any of: an aggregated mobile phone data feed, a social network feed, a news feed, a market data feed.
A525. The system of embodiment A521, wherein the aggregated blockchain oracle provides crowdsourced decentralized data.
A526. The system of embodiment A521, wherein the threshold constraint associated with the instantiated aggregated crypto transaction trigger entry is based on any of: anti-ping detection, detection of excess threshold account balance in an account data structure datastore, detection of excess threshold of aggregated blockchain oracle data value, detection of excess threshold number of transactions, detection of specified micro transaction amount, excess bounds of a smart contract generator GUI generated crypto smart rule, failure to login to 4^{th} party website, geofence transgression, user request.
A527. The system of embodiment A521, wherein the threshold constraint is cascading and includes at least two levels.
A528. The system of embodiment A521, wherein the instantiated aggregated crypto transaction trigger entry is configured to facilitate an action upon satisfaction of the crypto smart rule, wherein the action is any of: exchange assets between counterparties, restrict access to an account data structure datastore, release an extra key associated with an account data structure datastore, purchase stock, vote in a specified way.
A529. The system of embodiment A521, wherein the UI includes a chart component.
A530. The system of embodiment A521, wherein the UI includes a geographic map component.
A531. A processor-implemented crypto smart rules generator method, comprising:
   executing processor-implemented smart contract generating component instructions to:
      obtain, via at least one processor, a selection, from a user, of a crypto smart rule type for a crypto smart rule associated with an aggregated crypto transaction trigger entry;
      provide, via at least one processor, a crypto smart rule generator user interface (UI) for the selected crypto smart rule type;
      obtain, via at least one processor, a selection, from the user via the UI, of a threshold constraint for the crypto smart rule;
      obtain, via at least one processor, a selection, from the user via the UI, of an aggregated blockchain oracle that provides oracle data for evaluation via the aggregated crypto transaction trigger entry for the crypto smart rule;
      generate, via at least one processor, the aggregated crypto transaction trigger entry based on the selected threshold constraint and the selected aggregated blockchain oracle for the crypto smart rule; and
      instantiate, via at least one processor, the aggregated crypto transaction trigger entry in a socially aggregated blockchain datastructure.
A532. The method of embodiment A531, wherein the aggregated blockchain oracle is another aggregated crypto transaction trigger entry in a socially aggregated blockchain datastructure.
A533. The method of embodiment A531, wherein the aggregated blockchain oracle is any of: a market data provider, a GPS data provider, a date/time provider, a crowdsourced decentralized data provider, a news provider, an activity monitor, an RSS feed.
A534. The method of embodiment A533, wherein an RSS feed is any of: an aggregated mobile phone data feed, a social network feed, a news feed, a market data feed.
A535. The method of embodiment A531, wherein the aggregated blockchain oracle provides crowdsourced decentralized data.
A536. The method of embodiment A531, wherein the threshold constraint associated with the instantiated aggregated crypto transaction trigger entry is based on any of: anti-ping detection, detection of excess threshold account balance in an account data structure datastore, detection of excess threshold of aggregated blockchain oracle data value, detection of excess threshold number of transactions, detection of specified micro transaction amount, excess bounds of a smart contract generator GUI generated crypto smart rule, failure to login to 4^{th} party website, geofence transgression, user request.
A537. The method of embodiment A531, wherein the threshold constraint is cascading and includes at least two levels.
A538. The method of embodiment A531, wherein the instantiated aggregated crypto transaction trigger entry is configured to facilitate an action upon satisfaction of the crypto smart rule, wherein the action is any of: exchange assets between counterparties, restrict access to an account data structure datastore, release an extra key associated with an account data structure datastore, purchase stock, vote in a specified way.
A539. The method of embodiment A531, wherein the UI includes a chart component.
A540. The method of embodiment A531, wherein the UI includes a geographic map component.
A601. A crypto asset transfer processing apparatus, comprising:
a memory;
a component collection in the memory, including:
   a transfer of assets transaction processing component;
a processor disposed in communication with the memory, and configured to issue a plurality of processing instructions from the component collection stored in the memory,
   wherein the processor issues instructions from the transfer of assets transaction processing component, stored in the memory, to:
      obtain, via at least one processor, a crypto asset transfer notification associated with an account, wherein the crypto asset transfer notification is sent to a first entity from a second entity;
      determine, via at least one processor, account verification data specified in the crypto asset transfer notification, wherein the account verification data is generated by the second entity;
      retrieve, via at least one processor, a set of account data associated with the account, wherein the set of account data is stored by the first entity;
      generate, via at least one processor, a hash of the retrieved set of account data;
      verify, via at least one processor, that the determined account verification data matches the generated hash;
      determine, via at least one processor, a requested asset specified in the crypto asset transfer notification;
      make, via at least one processor, an API call to generate a crypto token asset for the requested asset in a socially aggregated blockchain datastructure, wherein the API call facilitates transfer of the generated crypto token asset to an account data structure datastore associated with the first entity;
      determine, via at least one processor, an address of an aggregated crypto transaction trigger entry specified in the crypto asset transfer notification, wherein the aggregated crypto transaction trigger entry is configured to facilitate transfer of the generated crypto token asset from the account data structure datastore associated with the first entity to an account data structure datastore associated with the second entity upon satisfaction of a crypto smart rule; and
      provide, via at least one processor, oracle data that satisfies the crypto smart rule via the determined address of the aggregated crypto transaction trigger entry.
A602. The apparatus of embodiment A601, wherein the first entity is a delivering broker and the second entity is a receiving broker.
A603. The apparatus of embodiment A601, wherein the account verification data is generated by the second entity using a hash of a set of account data, associated with the account, stored by the second entity.
A604. The apparatus of embodiment A601, wherein the set of account data associated with the account is a set of demographic data associated with the account's owner.
A605. The apparatus of embodiment A601, wherein the hash of the retrieved set of account data is generated by utilizing a hash function on a string formed by concatenating each data item in the set of account data in a specified order.
A606. The apparatus of embodiment A601, wherein the requested asset is specified using a security identifier.
A607. The apparatus of embodiment A606, wherein the security identifier is one of: a CUSIP, a ticker symbol, an ISIN.
A608. The apparatus of embodiment A601, wherein the API call to generate a crypto token asset for the requested asset includes an asset creation request for the requested asset to an administrative node that controls asset definition for the socially aggregated blockchain datastructure.
A609. The apparatus of embodiment A601, wherein the API call to generate a crypto token asset for the requested asset includes an asset issuance request for the requested asset to an administrative node that controls asset issuance for the socially aggregated blockchain datastructure.
A610. The apparatus of embodiment A609, wherein positions data for the account data structure datastore associated with the first entity is encrypted such that access is restricted to the first entity and to an administrative entity associated with the administrative node.
A611. The apparatus of embodiment A601, wherein the aggregated crypto transaction trigger entry includes an omnibus address associated with the second entity.
A612. The apparatus of embodiment A611, wherein the second entity transfers the crypto token asset, transferred via the aggregated crypto transaction trigger entry, to an address generated for the account.
A613. The apparatus of embodiment A601, wherein the aggregated crypto transaction trigger entry includes an address associated with the second entity generated for the account.
A614. The apparatus of embodiment A601, wherein the oracle data is provided via an API call.
A615. The apparatus of embodiment A601, wherein the oracle data that satisfies the crypto smart rule is a signature of the first entity.
A616. A processor-readable crypto asset transfer processing non-transient physical medium storing processor-executable components, the components, comprising:
a component collection stored in the medium, including:
   a transfer of assets transaction processing component;
   wherein the transfer of assets transaction processing component, stored in the medium, includes processor-issuable instructions to:
      obtain, via at least one processor, a crypto asset transfer notification associated with an account, wherein the crypto asset transfer notification is sent to a first entity from a second entity;
      determine, via at least one processor, account verification data specified in the crypto asset transfer notification, wherein the account verification data is generated by the second entity;
      retrieve, via at least one processor, a set of account data associated with the account, wherein the set of account data is stored by the first entity;
      generate, via at least one processor, a hash of the retrieved set of account data;
      verify, via at least one processor, that the determined account verification data matches the generated hash;
      determine, via at least one processor, a requested asset specified in the crypto asset transfer notification;
      make, via at least one processor, an API call to generate a crypto token asset for the requested asset in a socially aggregated blockchain datastructure, wherein the API call facilitates transfer of the generated crypto token asset to an account data structure datastore associated with the first entity;
      determine, via at least one processor, an address of an aggregated crypto transaction trigger entry specified in the crypto asset transfer notification, wherein the aggregated crypto transaction trigger entry is configured to facilitate transfer of the generated crypto token asset from the account data structure datastore associated with the first entity to an account data structure datastore associated with the second entity upon satisfaction of a crypto smart rule; and
      provide, via at least one processor, oracle data that satisfies the crypto smart rule via the determined address of the aggregated crypto transaction trigger entry.
A617. The medium of embodiment A616, wherein the first entity is a delivering broker and the second entity is a receiving broker.
A618. The medium of embodiment A616, wherein the account verification data is generated by the second entity using a hash of a set of account data, associated with the account, stored by the second entity.
A619. The medium of embodiment A616, wherein the set of account data associated with the account is a set of demographic data associated with the account's owner.
A620. The medium of embodiment A616, wherein the hash of the retrieved set of account data is generated by utilizing a hash function on a string formed by concatenating each data item in the set of account data in a specified order.
A621. The medium of embodiment A616, wherein the requested asset is specified using a security identifier.
A622. The medium of embodiment A621, wherein the security identifier is one of: a CUSIP, a ticker symbol, an ISIN.
A623. The medium of embodiment A616, wherein the API call to generate a crypto token asset for the requested asset includes an asset creation request for the requested asset to an administrative node that controls asset definition for the socially aggregated blockchain datastructure.
A624. The medium of embodiment A616, wherein the API call to generate a crypto token asset for the requested asset includes an asset issuance request for the requested asset to an administrative node that controls asset issuance for the socially aggregated blockchain datastructure.
A625. The medium of embodiment A624, wherein positions data for the account data structure datastore associated with the first entity is encrypted such that access is restricted to the first entity and to an administrative entity associated with the administrative node.
A626. The medium of embodiment A616, wherein the aggregated crypto transaction trigger entry includes an omnibus address associated with the second entity.
A627. The medium of embodiment A626, wherein the second entity transfers the crypto token asset, transferred via the aggregated crypto transaction trigger entry, to an address generated for the account.
A628. The medium of embodiment A616, wherein the aggregated crypto transaction trigger entry includes an address associated with the second entity generated for the account.
A629. The medium of embodiment A616, wherein the oracle data is provided via an API call.
A630. The medium of embodiment A616, wherein the oracle data that satisfies the crypto smart rule is a signature of the first entity.
A631. A processor-implemented crypto asset transfer processing system, comprising:
a transfer of assets transaction processing component means, to:
   obtain, via at least one processor, a crypto asset transfer notification associated with an account, wherein the crypto asset transfer notification is sent to a first entity from a second entity;
   determine, via at least one processor, account verification data specified in the crypto asset transfer notification, wherein the account verification data is generated by the second entity;
   retrieve, via at least one processor, a set of account data associated with the account, wherein the set of account data is stored by the first entity;
   generate, via at least one processor, a hash of the retrieved set of account data;
   verify, via at least one processor, that the determined account verification data matches the generated hash;
   determine, via at least one processor, a requested asset specified in the crypto asset transfer notification;
   make, via at least one processor, an API call to generate a crypto token asset for the requested asset in a socially aggregated blockchain datastructure, wherein the API call facilitates transfer of the generated crypto token asset to an account data structure datastore associated with the first entity;
   determine, via at least one processor, an address of an aggregated crypto transaction trigger entry specified in the crypto asset transfer notification, wherein the aggregated crypto transaction trigger entry is configured to facilitate transfer of the generated crypto token asset from the account data structure datastore associated with the first entity to an account data structure datastore associated with the second entity upon satisfaction of a crypto smart rule; and
   provide, via at least one processor, oracle data that satisfies the crypto smart rule via the determined address of the aggregated crypto transaction trigger entry.
A632. The system of embodiment A631, wherein the first entity is a delivering broker and the second entity is a receiving broker.
A633. The system of embodiment A631, wherein the account verification data is generated by the second entity using a hash of a set of account data, associated with the account, stored by the second entity.
A634. The system of embodiment A631, wherein the set of account data associated with the account is a set of demographic data associated with the account's owner.
A635. The system of embodiment A631, wherein the hash of the retrieved set of account data is generated by utilizing a hash function on a string formed by concatenating each data item in the set of account data in a specified order.
A636. The system of embodiment A631, wherein the requested asset is specified using a security identifier.
A637. The system of embodiment A636, wherein the security identifier is one of: a CUSIP, a ticker symbol, an ISIN.
A638. The system of embodiment A631, wherein the API call to generate a crypto token asset for the requested asset includes an asset creation request for the requested asset to an administrative node that controls asset definition for the socially aggregated blockchain datastructure.
A639. The system of embodiment A631, wherein the API call to generate a crypto token asset for the requested asset includes an asset issuance request for the requested asset to an administrative node that controls asset issuance for the socially aggregated blockchain datastructure.
A640. The system of embodiment A639, wherein positions data for the account data structure datastore associated with the first entity is encrypted such that access is restricted to the first entity and to an administrative entity associated with the administrative node.
A641. The system of embodiment A631, wherein the aggregated crypto transaction trigger entry includes an omnibus address associated with the second entity.
A642. The system of embodiment A641, wherein the second entity transfers the crypto token asset, transferred via the aggregated crypto transaction trigger entry, to an address generated for the account.
A643. The system of embodiment A631, wherein the aggregated crypto transaction trigger entry includes an address associated with the second entity generated for the account.
A644. The system of embodiment A631, wherein the oracle data is provided via an API call.
A645. The system of embodiment A631, wherein the oracle data that satisfies the crypto smart rule is a signature of the first entity.
A646. A processor-implemented crypto asset transfer processing method, comprising: executing processor-implemented transfer of assets transaction processing component instructions to:
   obtain, via at least one processor, a crypto asset transfer notification associated with an account, wherein the crypto asset transfer notification is sent to a first entity from a second entity;
   determine, via at least one processor, account verification data specified in the crypto asset transfer notification, wherein the account verification data is generated by the second entity;
   retrieve, via at least one processor, a set of account data associated with the account, wherein the set of account data is stored by the first entity;
   generate, via at least one processor, a hash of the retrieved set of account data;
   verify, via at least one processor, that the determined account verification data matches the generated hash;
   determine, via at least one processor, a requested asset specified in the crypto asset transfer notification;
   make, via at least one processor, an API call to generate a crypto token asset for the requested asset in a socially aggregated blockchain datastructure, wherein the API call facilitates transfer of the generated crypto token asset to an account data structure datastore associated with the first entity;
   determine, via at least one processor, an address of an aggregated crypto transaction trigger entry specified in the crypto asset transfer notification, wherein the aggregated crypto transaction trigger entry is configured to facilitate transfer of the generated crypto token asset from the account data structure datastore associated with the first entity to an account data structure datastore associated with the second entity upon satisfaction of a crypto smart rule; and
   provide, via at least one processor, oracle data that satisfies the crypto smart rule via the determined address of the aggregated crypto transaction trigger entry.
A647. The method of embodiment A646, wherein the first entity is a delivering broker and the second entity is a receiving broker.
A648. The method of embodiment A646, wherein the account verification data is generated by the second entity using a hash of a set of account data, associated with the account, stored by the second entity.
A649. The method of embodiment A646, wherein the set of account data associated with the account is a set of demographic data associated with the account's owner.
A650. The method of embodiment A646, wherein the hash of the retrieved set of account data is generated by utilizing a hash function on a string formed by concatenating each data item in the set of account data in a specified order.
A651. The method of embodiment A646, wherein the requested asset is specified using a security identifier.
A652. The method of embodiment A651, wherein the security identifier is one of: a CUSIP, a ticker symbol, an ISIN.
A653. The method of embodiment A646, wherein the API call to generate a crypto token asset for the requested asset includes an asset creation request for the requested asset to an administrative node that controls asset definition for the socially aggregated blockchain datastructure.
A654. The method of embodiment A646, wherein the API call to generate a crypto token asset for the requested asset includes an asset issuance request for the requested asset to an administrative node that controls asset issuance for the socially aggregated blockchain datastructure.
A655. The method of embodiment A654, wherein positions data for the account data structure datastore associated with the first entity is encrypted such that access is restricted to the first entity and to an administrative entity associated with the administrative node.
A656. The method of embodiment A646, wherein the aggregated crypto transaction trigger entry includes an omnibus address associated with the second entity.
A657. The method of embodiment A656, wherein the second entity transfers the crypto token asset, transferred via the aggregated crypto transaction trigger entry, to an address generated for the account.
A658. The method of embodiment A646, wherein the aggregated crypto transaction trigger entry includes an address associated with the second entity generated for the account.
A659. The method of embodiment A646, wherein the oracle data is provided via an API call.
A660. The method of embodiment A646, wherein the oracle data that satisfies the crypto smart rule is a signature of the first entity.
A1001. A migration displacement tracking apparatus, comprising:
a memory;
a component collection in any of memory and communication, including:
   a migration component;
a processor disposed in communication with the memory, and configured to issue a plurality of processing instructions from the component collection stored in the memory,
   wherein a processor issues instructions from the migration component, stored in the memory, to:
      obtain a unique wallet identifier from a migrant wallet source associated with a user;
      obtain a geographic transaction request from the migrant wallet source;
      commit the geographic transaction request to a distributed block chain database configured to propagate the geographic transaction request across a distributed block chain database network;
      provide a starting displacement region at an initial time;
      provide a target displacement region at a subsequent time;
      query the distributed block chain database for users matching a starting displacement region at the initial time;
      select a subset of lost or displaced users at the target displacement region at the subsequent time from the results of the query;
      identify lost users from the query that were not in the selected subset.
A1002. The apparatus of embodiment A1001, wherein the transaction request includes a number of additional fields specified in an 80 byte transaction payload.
A1003. The apparatus of embodiment A1002, wherein the fields include longitude and latitude.
A1004. The apparatus of embodiment A1002, wherein the additional fields include attributes.
A1005. The apparatus of embodiment A1004, wherein the additional fields include size.
A1006. The apparatus of embodiment A1004, wherein attributes include nationality.
A1007. The apparatus of embodiment A1004, wherein attributes include the user's identification information.
A1008. A processor-readable migration displacement tracking non-transient medium storing processor-executable components, the components comprising:
a component collection stored in the medium, including:
   a migration component;
   wherein the component collection, stored in the medium, includes processor-issuable instructions to:
      obtain a unique wallet identifier from a migrant wallet source associated with a user;
      obtain a geographic transaction request from the migrant wallet source;
      commit the geographic transaction request to a distributed block chain database configured to propagate the geographic transaction request across a distributed block chain database network;
      provide a starting displacement region at an initial time;
      provide a target displacement region at a subsequent time;
      query the distributed block chain database for users matching a starting displacement region at the initial time;
      select a subset of lost or displaced users at the target displacement region at the subsequent time from the results of the query;
      identify lost users from the query that were not in the selected subset.
A1009. The processor-readable migration displacement tracking non-transient medium of embodiment 1008, wherein the transaction request includes a number of additional fields specified in an 80 byte transaction payload.
A1010. The processor-readable migration displacement tracking non-transient medium of embodiment 1009, wherein the fields include longitude and latitude.
A1011. The processor-readable migration displacement tracking non-transient medium of embodiment 1009, wherein the additional fields include attributes.
A1012. The processor-readable migration displacement tracking non-transient medium of embodiment 1011, wherein the additional fields include size.
A1013. The processor-readable migration displacement tracking non-transient medium of embodiment 1011, wherein attributes include nationality.
A1014. The processor-readable migration displacement tracking non-transient medium of embodiment 1011, wherein attributes include the user's identification information.
A1015. A processor-implemented migration displacement tracking method, comprising: executing processor-implemented migration component instructions to:
   obtain a unique wallet identifier from a migrant wallet source associated with a user;
   obtain a geographic transaction request from the migrant wallet source;
   commit the geographic transaction request to a distributed block chain database configured to propagate the geographic transaction request across a distributed block chain database network;
   provide a starting displacement region at an initial time;
   provide a target displacement region at a subsequent time;
   query the distributed block chain database for users matching a starting displacement region at the initial time;
   select a subset of lost or displaced users at the target displacement region at the subsequent time from the results of the query;
   identify lost users from the query that were not in the selected subset.
A1016. The processor-implemented migration displacement tracking method of embodiment A1015, wherein the transaction request includes a number of additional fields specified in an 80 byte transaction payload.
A1017. The processor-implemented migration displacement tracking method of embodiment A1016, wherein the fields include longitude and latitude.
A1018. The processor-implemented migration displacement tracking method of embodiment A1016, wherein the additional fields include attributes.
A1019. The processor-implemented migration displacement tracking method of embodiment A1016, wherein the additional fields include size.
A1020. The processor-implemented migration displacement tracking method of embodiment 1016, wherein attributes include nationality.
A1021. The processor-implemented migration displacement tracking method of embodiment A1016, wherein attributes include the user's identification information.
A1022. A processor-implemented migration displacement tracking system, comprising:
a migration component means, to:
   obtain a unique wallet identifier from a migrant wallet source associated with a user;
   obtain a geographic transaction request from the migrant wallet source;
   commit the geographic transaction request to a distributed block chain database configured to propagate the geographic transaction request across a distributed block chain database network;
   provide a starting displacement region at an initial time;
   provide a target displacement region at a subsequent time;
   query the distributed block chain database for users matching a starting displacement region at the initial time;
   select a subset of lost or displaced users at the target displacement region at the subsequent time from the results of the query;
   identify lost users from the query that were not in the selected subset.
A1023. The processor-implemented migration displacement tracking system of embodiment A1022, wherein the transaction request includes a number of additional fields specified in an 80 byte transaction payload.
A1024. The processor-implemented migration displacement tracking system of embodiment A1022, wherein the fields include longitude and latitude.
A1025. The processor-implemented migration displacement tracking system of embodiment 1022, wherein the additional fields include attributes.
A1026. The processor-implemented migration displacement tracking system of embodiment A1022, wherein the additional fields include size.
A1027. The processor-implemented migration displacement tracking system of embodiment A1022, wherein attributes include nationality.
A1028. The processor-implemented migration displacement tracking system of embodiment A1022, wherein attributes include the user's identification information.
A1029. A point-to-point payment guidance apparatus, comprising:
a memory;
a component collection in any of memory and communication, including:
   a point-to-point guidance component;
a processor disposed in communication with the memory, and configured to issue a plurality of processing instructions from the component collection stored in the memory,
   wherein a processor issues instructions from the point-to-point guidance component, stored in the memory, to:
      obtain a target wallet identifier registration at a beacon;
      register the target wallet identifier with the beacon;
      obtain a unique wallet identifier from a migrant wallet source associated with a user at the beacon;
      obtain a target transaction request at the beacon from the migrant wallet source;
      commit the target transaction request for the amount specified in the target transaction request to a distributed block chain database configured to propagate the target transaction request across a distributed block chain database network for payment targeted to the target wallet identifier registered at the beacon.
A1030. The apparatus of embodiment A1029, wherein the beacon is registered to an organization.
A1031. The apparatus of embodiment A1030, wherein the target wallet identifier is of an employee of the organization.
A1032. The apparatus of embodiment A1031, further, comprising: verify the target wallet identifier is associated with the organization.
A1033. The apparatus of embodiment A1032, wherein the verification includes identifying the target wallet identifier exists in the organization's database.
A1034. The apparatus of embodiment A1032, wherein the verification includes authentication credentials.
A1035. The apparatus of embodiment A1034, wherein the authentication credentials are digitally signed.
A1036. The apparatus of embodiment A1034, wherein the authentication credentials are encrypted.
A1037. The apparatus of embodiment A1034, wherein the registration of the target wallet occurs upon the verification.
A1038. The apparatus of embodiment A1029, wherein the target transaction request includes a number of additional fields specified in an 80 byte transaction payload.
A1039. The apparatus of embodiment A1038, wherein the fields include a tip amount.
A1040. The apparatus of embodiment A1038, wherein the fields include the beacon's unique identifier.
A1041. The apparatus of embodiment A1038, wherein the fields include the target wallet identifier.
A1042. The apparatus of embodiment A1038, wherein the fields include the user's identification information.
A1043. The apparatus of embodiment A1029, wherein the beacon is a target mobile user device with access to a target user's target wallet associated with the target wallet identifier.
A1044. The apparatus of embodiment A1029, wherein the unique wallet identifier's source is a source mobile user device with access to a user's source wallet associated with the unique wallet identifier.
A1045. The apparatus of embodiment A1038, wherein the fields include a transaction amount.
A1046. The apparatus of embodiment A1038, wherein the fields include a transaction item.
A1047. The apparatus of embodiment A1029, wherein the beacon may be integral to a device.
A1048. The apparatus of embodiment A1047, wherein the integration may be through a smart device having a processor and wireless communication.
A1049. The apparatus of embodiment A1047, wherein the integration may be by affixing a beacon to the device.
A1050. The apparatus of embodiment A1047, wherein the beacon may be affixed to a utility meter.
A1051. The apparatus of embodiment A1047, wherein the beacon affixed to a utility meter may be read by a user.
A1052. The apparatus of embodiment A1047, wherein the beacon affixed to a utility meter may be read by a user and outstanding usage may be paid by the user.
A1053. The apparatus of embodiment A1047, wherein the beacon affixed to a utility meter is a refrigerator at a hotel, and usage metrics include items consumed by the user.
A1054. The apparatus of embodiment A1047, wherein the beacon affixed to a utility meter is a thermostat at a hotel, and usage metrics include items consumed by the user.
A1055. The apparatus of embodiment A1047, wherein the beacon affixed to a utility meter is a television at a hotel, and usage metrics include items viewed by the user.
A1056. The apparatus of embodiment A1047, wherein the beacon affixed to a utility meter is a button affixed to consumables at a hotel, and usage metrics include items consumed by the user.
A1057. A processor-readable point-to-point payment guidance non-transient medium storing processor-executable components, the components, comprising:
a component collection stored in the medium, including:
   a point-to-point guidance component;
   wherein the component collection, stored in the medium, includes processor-issuable instructions to:
      obtain a target wallet identifier registration at a beacon;
      register the target wallet identifier with the beacon;
      obtain a unique wallet identifier from a wallet source associated with a user at the beacon;
      obtain a target transaction request at the beacon from the wallet source;
      commit the target transaction request for the amount specified in the target transaction request to a distributed block chain database configured to propagate the target transaction request across a distributed block chain database network for payment targeted to the target wallet identifier registered at the beacon.
A1058. The processor-readable point-to-point payment guidance non-transient medium of embodiment A1057, wherein the beacon is registered to an organization.
A1059. The processor-readable point-to-point payment guidance non-transient medium of embodiment A1058, wherein the target wallet identifier is of an employee of the organization.
A1060. The processor-readable point-to-point payment guidance non-transient medium of embodiment A1059, further, comprising:

instructions to verify the target wallet identifier is associated with the organization.

A1061. The processor-readable point-to-point payment guidance non-transient medium of embodiment A1060, wherein the verification includes identifying the target wallet identifier exists in the organization's database.
A1062. The processor-readable point-to-point payment guidance non-transient medium of embodiment A1060, wherein the verification includes authentication credentials.
A1063. The processor-readable point-to-point payment guidance non-transient medium of embodiment A1062, wherein the authentication credentials are digitally signed.
A1064. The processor-readable point-to-point payment guidance non-transient medium of embodiment A1062, wherein the authentication credentials are encrypted.
A1065. The processor-readable point-to-point payment guidance non-transient medium of embodiment A1060, wherein the registration of the target wallet occurs upon the verification.
A1066. The processor-readable point-to-point payment guidance non-transient medium of embodiment A1057, wherein the target transaction request includes a number of additional fields specified in an 80 byte transaction payload.
A1067. The processor-readable point-to-point payment guidance non-transient medium of embodiment A1066, wherein the fields include a tip amount.
A1068. The processor-readable point-to-point payment guidance non-transient medium of embodiment A1066, wherein the fields include the beacon's unique identifier.
A1069. The processor-readable point-to-point payment guidance non-transient medium of embodiment A1066, wherein the fields include the target wallet identifier.
A1070. The processor-readable point-to-point payment guidance non-transient medium of embodiment A1066, wherein the fields include the user's identification information.
A1071. The processor-readable point-to-point payment guidance non-transient medium of embodiment A1057, wherein the beacon is a target mobile user device with access to a target user's target wallet associated with the target wallet identifier.
A1072. The processor-readable point-to-point payment guidance non-transient medium of embodiment A1057, wherein the unique wallet identifier's source is a source mobile user device with access to a user's source wallet associated with the unique wallet identifier.
A1073. The processor-readable point-to-point payment guidance non-transient medium of embodiment A1066, wherein the fields include a transaction amount.
A1074. The processor-readable point-to-point payment guidance non-transient medium of embodiment A1066, wherein the fields include a transaction item.
A1075. The processor-readable point-to-point payment guidance non-transient medium of embodiment A1057, wherein the beacon may be integral to a device.
A1076. The processor-readable point-to-point payment guidance non-transient medium of embodiment A1057, wherein the integration may be through a smart device having a processor and wireless communication.
A1077. The processor-readable point-to-point payment guidance non-transient medium of embodiment A1057, wherein the integration may be by affixing a beacon to the device.
A1078. The processor-readable point-to-point payment guidance non-transient medium of embodiment A1057, wherein the beacon may be affixed to a utility meter.
A1079. The processor-readable point-to-point payment guidance non-transient medium of embodiment A1057, wherein the beacon affixed to a utility meter may be read by a user.
A1080. The processor-readable point-to-point payment guidance non-transient medium of embodiment A1057, wherein the beacon affixed to a utility meter may be read by a user and outstanding usage may be paid by the user.
A1081. The processor-readable point-to-point payment guidance non-transient medium of embodiment A1057, wherein the beacon affixed to a utility meter is a refrigerator at a hotel, and usage metrics include items consumed by the user.
A1082. The processor-readable point-to-point payment guidance non-transient medium of embodiment A1057, wherein the beacon affixed to a utility meter is a thermostat at a hotel, and usage metrics include items consumed by the user.
A1083. The processor-readable point-to-point payment guidance non-transient medium of embodiment A1057, wherein the beacon affixed to a utility meter is a television at a hotel, and usage metrics include items viewed by the user.
A1084. The processor-readable point-to-point payment guidance non-transient medium of embodiment A1057, wherein the beacon affixed to a utility meter is a button affixed to consumables at a hotel, and usage metrics include items consumed by the user.
A1085. A processor-implemented point-to-point payment guidance method, comprising:
executing processor-implemented point-to-point guidance component instructions to:
   obtain a target wallet identifier registration at a beacon;
   register the target wallet identifier with the beacon;
   obtain a unique wallet identifier from a wallet source associated with a user at the beacon;
   obtain a target transaction request at the beacon from the migrant wallet source;
   commit the target transaction request for the amount specified in the target transaction request to a distributed block chain database configured to propagate the target transaction request across a distributed block chain database network for payment targeted to the target wallet identifier registered at the beacon.
A1086. The processor-implemented point-to-point payment guidance method of embodiment A1085, wherein the beacon is registered to an organization.
A1087. The processor-implemented point-to-point payment guidance method of embodiment A1085, wherein the target wallet identifier is of an employee of the organization.
A1088. The processor-implemented point-to-point payment guidance method of embodiment A1085, further comprising:
instructions to verify the target wallet identifier is associated with the organization.
A1089. The processor-implemented point-to-point payment guidance method of embodiment A1088, wherein the verification includes identifying the target wallet identifier exists in the organization's database.
A1090. The processor-implemented point-to-point payment guidance method of embodiment A1088, wherein the verification includes authentication credentials.
A1091. The processor-implemented point-to-point payment guidance method of embodiment A1090, wherein the authentication credentials are digitally signed.
A1092. The processor-implemented point-to-point payment guidance method of embodiment A1090, wherein the authentication credentials are encrypted.
A1093. The processor-implemented point-to-point payment guidance method of embodiment A1090, wherein the registration of the target wallet occurs upon the verification.
A1094. The processor-implemented point-to-point payment guidance method of embodiment A1088, wherein the target transaction request includes a number of additional fields specified in an 80 byte transaction payload.
A1095. The processor-implemented point-to-point payment guidance method of embodiment A1094, wherein the fields include a tip amount.
A1096. The processor-implemented point-to-point payment guidance method of embodiment A1094, wherein the fields include the beacon's unique identifier.
A1097. The processor-implemented point-to-point payment guidance method of embodiment A1094, wherein the fields include the target wallet identifier.
A1098. The processor-implemented point-to-point payment guidance method of embodiment A1094, wherein the fields include the user's identification information.
A1099. The processor-implemented point-to-point payment guidance method of embodiment A1094, wherein the beacon is a target mobile user device with access to a target user's target wallet associated with the target wallet identifier.
A1100. The processor-implemented point-to-point payment guidance method of embodiment A1094, wherein the unique wallet identifier's source is a source mobile user device with access to a user's source wallet associated with the unique wallet identifier.
A1101. The processor-implemented point-to-point payment guidance method of embodiment A1094, wherein the fields include a transaction amount.
A1102. The processor-implemented point-to-point payment guidance method of embodiment A1094, wherein the fields include a transaction item.
A1103. The processor-implemented point-to-point payment guidance method of embodiment A1094, wherein the beacon may be integral to a device.
A1104. The processor-implemented point-to-point payment guidance method of embodiment A1094, wherein the integration may be through a smart device having a processor and wireless communication.
A1105. The processor-implemented point-to-point payment guidance method of embodiment A1094, wherein the integration may be by affixing a beacon to the device.
A1106. The processor-implemented point-to-point payment guidance method of embodiment A1094, wherein the beacon may be affixed to a utility meter.
A1107. The processor-implemented point-to-point payment guidance method of embodiment A1094, wherein the beacon affixed to a utility meter may be read by a user.
A1108. The processor-implemented point-to-point payment guidance method of embodiment A1094, wherein the beacon affixed to a utility meter may be read by a user and outstanding usage may be paid by the user.
A1109. The processor-implemented point-to-point payment guidance method of embodiment A1094, wherein the beacon affixed to a utility meter is a refrigerator at a hotel, and usage metrics include items consumed by the user.
A1110. The processor-implemented point-to-point payment guidance method of embodiment A1094, wherein the beacon affixed to a utility meter is a thermostat at a hotel, and usage metrics include items consumed by the user.
A1111. The processor-implemented point-to-point payment guidance method of embodiment A1094, wherein the beacon affixed to a utility meter is a television at a hotel, and usage metrics include items viewed by the user.
A1112. The processor-implemented point-to-point payment guidance method of embodiment A1094, wherein the beacon affixed to a utility meter is a button affixed to consumables at a hotel, and usage metrics include items consumed by the user.
A1113. A processor-implemented point-to-point payment guidance system, comprising:
a point-to-point guidance component means, to:
   obtain a target wallet identifier registration at a beacon;
   register the target wallet identifier with the beacon;
   obtain a unique wallet identifier from a wallet source associated with a user at the beacon;
   obtain a target transaction request at the beacon from the wallet source;
   commit the target transaction request for the amount specified in the target transaction request to a distributed block chain database configured to propagate the target transaction request across a distributed block chain database network for payment targeted to the target wallet identifier registered at the beacon.
A1114. The processor-implemented point-to-point payment guidance system of embodiment A1113, wherein the beacon is registered to an organization.
A1115. The processor-implemented point-to-point payment guidance system of embodiment A1113, wherein the target wallet identifier is of an employee of the organization.
A1116. The processor-implemented point-to-point payment guidance system 92, further comprising:
   instructions to verify the target wallet identifier is associated with the organization.
A1117. The processor-implemented point-to-point payment guidance system of embodiment A1116, wherein the verification includes identifying the target wallet identifier exists in the organization's database.
A1118. The processor-implemented point-to-point payment guidance system of embodiment A1116, wherein the verification includes authentication credentials.
A1119. The processor-implemented point-to-point payment guidance system of embodiment A1116, wherein the authentication credentials are digitally signed.
A1120. The processor-implemented point-to-point payment guidance system of embodiment A1116, wherein the authentication credentials are encrypted.
A1121. The processor-implemented point-to-point payment guidance system of embodiment A1116, wherein the registration of the target wallet occurs upon the verification.
A1122. The processor-implemented point-to-point payment guidance system of embodiment A1116, wherein the target transaction request includes a number of additional fields specified in an 80 byte transaction payload.
A1123. The processor-implemented point-to-point payment guidance system of embodiment A1122, wherein the fields include a tip amount.
A1124. The processor-implemented point-to-point payment guidance system of embodiment A1122, wherein the fields include the beacon's unique identifier.
A1125. The processor-implemented point-to-point payment guidance system of embodiment A1122, wherein the fields include the target wallet identifier.
A1126. The processor-implemented point-to-point payment guidance system of embodiment A1122, wherein the fields include the user's identification information.
A1127. The processor-implemented point-to-point payment guidance system of embodiment A1116, wherein the beacon is a target mobile user device with access to a target user's target wallet associated with the target wallet identifier.
A1128. The processor-implemented point-to-point payment guidance system of embodiment A1116, wherein the unique wallet identifier's source is a source mobile user device with access to a user's source wallet associated with the unique wallet identifier.
A1129. The processor-implemented point-to-point payment guidance system of embodiment A1116, wherein the fields include a transaction amount.
A1130. The processor-implemented point-to-point payment guidance system of embodiment A1116, wherein the fields include a transaction item.
A1131. The processor-implemented point-to-point payment guidance system of embodiment A1116, wherein the beacon is integral to a device.
A1132. The processor-implemented point-to-point payment guidance system of embodiment A1116, wherein the integration may be through a smart device having a processor and wireless communication.
A1133. The processor-implemented point-to-point payment guidance system of embodiment A1116, wherein the integration may be by affixing a beacon to the device.
A1134. The processor-implemented point-to-point payment guidance system of embodiment A1116, wherein the beacon may be affixed to a utility meter.
A1135. The processor-implemented point-to-point payment guidance system of embodiment A1116, wherein the beacon affixed to a utility meter may be read by a user.
A1136. The processor-implemented point-to-point payment guidance system of embodiment A1116, wherein the beacon affixed to a utility meter may be read by a user and outstanding usage may be paid by the user.
A1137. The processor-implemented point-to-point payment guidance system of embodiment A1116, wherein the beacon affixed to a utility meter is a refrigerator at a hotel, and usage metrics include items consumed by the user.
A1138. The processor-implemented point-to-point payment guidance system of embodiment A1116, wherein the beacon affixed to a utility meter is a thermostat at a hotel, and usage metrics include items consumed by the user.
A1139. The processor-implemented point-to-point payment guidance system of embodiment A1116, wherein the beacon affixed to a utility meter is a television at a hotel, and usage metrics include items viewed by the user.
A1140. The processor-implemented point-to-point payment guidance system of embodiment A1116, wherein the beacon affixed to a utility meter is a button affixed to consumables, and usage metrics include items consumed by the user.
A1141. A point-to-point payment guidance apparatus, comprising:
a component collection stored in the medium, including:
a memory;
a component collection in any of memory and communication, including:
   a point-to-point guidance component;
a processor disposed in communication with the memory, and configured to issue a plurality of processing instructions from the component collection stored in the memory,
wherein a processor issues instructions from the component collection, stored in the memory, to
   obtain a payment source wallet identifier associated with a user at a beacon integrated with a product used by the user, which product periodically requires replenishment;
   register the payment source wallet identifier with the beacon;
   monitor a use or consumption of the product;
   when a use or consumption reaches a threshold level, transmit an order for a replenishment of the product to a supplier of the product; and
   transmit a destination address for the supplier to receive a payment from the payment source wallet identifier for the replenishment of the product to a distributed blockchain database configured to propagate the transaction request to a distributed blockchain database network for payment targeted to the destination address provided by the beacon.
A1142. The apparatus of embodiment A1141, wherein the payment source wallet identifier includes a plurality of source addresses of the user, and wherein the user may select one or more sources addresses from which to provide a payment.
A1143. The apparatus of embodiment A1141, wherein the transaction request includes a number of additional fields specified in an 80 byte transaction payload.
A1144. The apparatus of embodiment A1143, wherein the additional fields store at least one of public key or a hash of the public key of the user.
A1145. The apparatus of embodiment A1144, wherein the fields include data that may be queried by the user using the public key to confirm the transaction request and payment amount.
A1146. The apparatus of embodiment A1143, wherein the fields include a unique identifier of the beacon.
A1147. The apparatus of embodiment A1143, wherein the fields include the target wallet identifier.
A1148. The apparatus of embodiment A1143, wherein the fields include the user's identification information.
A1149. The apparatus of embodiment A1143, wherein the fields include a transaction amount.
A1150. The apparatus of embodiment A1066, wherein the fields include a micropayment amount.
A1151. The apparatus of embodiment A1141, wherein the beacon is integrated with the product
A1152. The apparatus of embodiment A1141, wherein the beacon is separate from the product
A1153. The apparatus of embodiment A1141, wherein the integration may be by affixing a beacon to the product.
A1154. A processor-readable point-to-point payment guidance non-transient medium storing processor-executable components, the components, comprising:
a component collection stored in the medium, including:
   a point-to-point guidance component;
   wherein the component collection, stored in the medium, includes processor-issuable instructions to:
      obtain a payment source wallet identifier associated with a user at a beacon integrated with a product used by the user, which product periodically requires replenishment;
      register the payment source wallet identifier with the beacon;
      monitor a use or consumption of the product;
      when a use or consumption reaches a threshold level, transmit an order for a replenishment of the product to a supplier of the product; and
      transmit a destination address for the supplier to receive a payment from the payment source wallet identifier for the replenishment of the product to a distributed blockchain database configured to propagate the transaction request to a distributed blockchain database network for payment targeted to the destination address provided by the beacon.
A1155. The processor-readable point-to-point payment guidance non-transient medium of embodiment A1154, wherein the payment source wallet identifier includes a plurality of source addresses of the user, and wherein the user may select one or more sources addresses from which to provide a payment.
A1156. The processor-readable point-to-point payment guidance non-transient medium of embodiment A1154, wherein the transaction request includes a number of additional fields specified in an 80 byte transaction payload.
A1157. The processor-readable point-to-point payment guidance non-transient medium of embodiment A1156, wherein the additional fields store at least one of public key or a hash of the public key of the user.
A1158. The processor-readable point-to-point payment guidance non-transient medium of embodiment A1157, wherein the fields include data that may be queried by the user using the public key to confirm the transaction request and payment amount.
A1159. The processor-readable point-to-point payment guidance non-transient medium of embodiment A1156, wherein the fields include a unique identifier of the beacon.
A1160. The processor-readable point-to-point payment guidance non-transient medium of embodiment A1156, wherein the fields include the target wallet identifier.
A1161. The processor-readable point-to-point payment guidance non-transient medium of embodiment A1156, wherein the fields include the user's identification information.
A1162. The processor-readable point-to-point payment guidance non-transient medium of embodiment A1156, wherein the fields include a transaction amount.
A1163. The processor-readable point-to-point payment guidance non-transient medium of embodiment A1066, wherein the fields include a micropayment amount.
A1164. The processor-readable point-to-point payment guidance non-transient medium of embodiment A1154, wherein the beacon is integrated with the product
A1165. The processor-readable point-to-point payment guidance non-transient medium of embodiment A1154, wherein the beacon is separate from the product
A1166. The processor-readable point-to-point payment guidance non-transient medium of embodiment A1154, wherein the integration may be by affixing a beacon to the product.
A1167. A point-to-point payment guidance method, comprising:
   obtaining a payment source wallet identifier associated with a user at a beacon integrated with a product used by the user, which product periodically requires replenishment;
   registering the payment source wallet identifier with the beacon;
   monitoring a use or consumption of the product;
   when a use or consumption reaches a threshold level, transmitting an order for a replenishment of the product to a supplier of the product; and
   transmitting a destination address for the supplier to receive a payment from the payment source wallet identifier for the replenishment of the product to a distributed blockchain database configured to propagate the transaction request to a distributed blockchain database network for payment targeted to the destination address provided by the beacon.
A1168. The method of embodiment A1167, wherein the payment source wallet identifier includes a plurality of source addresses of the user, and wherein the user may select one or more sources addresses from which to provide a payment.
A1169. The method of embodiment A1167, wherein the transaction request includes a number of additional fields specified in an 80 byte transaction payload.
A1170. The method of embodiment A1169, wherein the additional fields store at least one of public key or a hash of the public key of the user.
A1171. The method of embodiment A1170, wherein the fields include data that may be queried by the user using the public key to confirm the transaction request and payment amount.
A1172. The method of embodiment A1169, wherein the fields include a unique identifier of the beacon.
A1173. The method of embodiment A1169, wherein the fields include the target wallet identifier.
A1174. The method of embodiment A1169, wherein the fields include the user's identification information.
A1175. The method of embodiment A1169, wherein the fields include a transaction amount.
A1176. The method of embodiment A1169, wherein the fields include a micropayment amount.
A1177. The method of embodiment A1167, wherein the beacon is integrated with the product
A1178. The method of embodiment A1167, wherein the beacon is separate from the product
A1179. The method of embodiment A1167, wherein the integration may be by affixing a beacon to the product.
A1180. A point-to-point payment guidance system, comprising:
   means for obtaining a payment source wallet identifier associated with a user at a beacon integrated with a product used by the user, which product periodically requires replenishment;
      means for registering the payment source wallet identifier with the beacon;
   means for monitoring a use or consumption of the product;
   means for transmitting an order for a replenishment of the product to a supplier of the product when a use or consumption reaches a threshold level; and
   means for transmitting a destination address for the supplier to receive a payment from the payment source wallet identifier for the replenishment of the product to a distributed blockchain database configured to propagate the transaction request to a distributed blockchain database network for payment targeted to the destination address provided by the beacon.
A1181. The system of embodiment A1180, wherein the payment source wallet identifier includes a plurality of source addresses of the user, and wherein the user may select one or more sources addresses from which to provide a payment.
A1182. The system of embodiment A1180, wherein the transaction request includes a number of additional fields specified in an 80 byte transaction payload.
A1183. The system of embodiment A1182, wherein the additional fields store at least one of public key or a hash of the public key of the user.
A1184. The system of embodiment A1183, wherein the fields include data that may be queried by the user using the public key to confirm the transaction request and payment amount.
A1185. The system of embodiment A1182, wherein the fields include a unique identifier of the beacon.
A1186. The system of embodiment A1182, wherein the fields include the target wallet identifier.
A1187. The system of embodiment A1182, wherein the fields include the user's identification information.
A1188. The system of embodiment A1182, wherein the fields include a transaction amount.
A1189. The system of embodiment A1182, wherein the fields include a micropayment amount.
A1190. The system of embodiment A1180, wherein the beacon is integrated with the product.
A1191. The system of embodiment A1180, wherein the beacon is separate from the product.
A1192. The system of embodiment A1180, wherein the integration may be by affixing a beacon to the product.
B1. An order processing apparatus, comprising:
a memory;
a component collection in the memory, including:
   an order processing component,
a processor disposed in communication with the memory, and configured to issue a plurality of processing instructions from the component collection stored in the memory,
   wherein the processor issues instructions from the order processing component, stored in the memory, to:
      obtain, via at least one processor, an order of a user for an order processing entity;
      determine, via at least one processor, a blockchain data node associated with the order, wherein the blockchain data node facilitates access to user-owned read data of the user;
      determine, via at least one processor, an access control node associated with the blockchain data node;
      provide, via at least one processor, a blockchain identifier of the blockchain data node and a blockchain identifier of the order processing entity to the access control node;
      obtain, via at least one processor, the user-owned read data from the access control node;
      execute, via at least one processor, the order using the user-owned read data;
      determine, via at least one processor, a write access blockchain node associated with the order, wherein the write access blockchain node grants the order processing entity permission from the user to create one or more blockchain data nodes with the write access blockchain node as parent;
      determine, via at least one processor, user-owned write data to store with regard to the executed order;
      create, via at least one processor, a new blockchain data node with the write access blockchain node as parent, wherein the new blockchain data node facilitates access to the user-owned write data, wherein the new blockchain data node is cryptographically signed by the order processing entity.
B2. The apparatus of embodiment B1, wherein the user-owned read data is a subset of user-owned data stored via the blockchain data node.
B3. The apparatus of embodiment B1, further comprising:
the processor issues instructions from the order processing component, stored in the memory, to:
   determine, via at least one processor, a read access grant node associated with the blockchain data node; and
   provide, via at least one processor, a blockchain identifier of the read access grant node to the access control node.
B4. The apparatus of embodiment B1, wherein the access control node is specific to the order.
B5. The apparatus of embodiment B1, wherein the access control node is specific to the user.
B6. The apparatus of embodiment B1, wherein the user-owned read data includes information regarding funds used to pay for the order.
B7. The apparatus of embodiment B1, wherein the blockchain data node is cryptographically signed by another order processing entity that is a member in a network of trusted order processing entities.
B8. The apparatus of embodiment B1, wherein the user-owned write data is associated with a category of user-owned data, and the write access blockchain node is associated with the category of user-owned data.
B9. The apparatus of embodiment B1, wherein the user can revoke the order processing entity's read access to the blockchain data node.
B10. The apparatus of embodiment B9, wherein the user can reinstate the order processing entity's read access to the blockchain data node.
B11. The apparatus of embodiment B1, further comprising:
the processor issues instructions from the order processing component, stored in the memory, to:
   provide, via at least one processor, a blockchain identifier of the new blockchain data node to a validator node.
B12. The apparatus of embodiment B1, further comprising:
the processor issues instructions from the order processing component, stored in the memory, to:
   provide, via at least one processor, a blockchain identifier of the new blockchain data node to a second access control node.
B13. The apparatus of embodiment B12, wherein the access control node and the second access control node are the same node.
B14. The apparatus of embodiment B12, further comprising:
the processor issues instructions from the order processing component, stored in the memory, to:
   provide, via at least one processor, a decryption key to the second access control node, wherein the user-owned write data is encrypted and can be decrypted using the decryption key.
B15. The apparatus of embodiment B1, further comprising:
the processor issues instructions from the order processing component, stored in the memory, to:
   provide, via at least one processor, backing repository data to be stored in a backing repository to the second access control node, wherein the new blockchain data node facilitates access to the stored backing repository data.
B16. An order processing non-transient physical medium storing processor-executable components, the components, comprising:
a component collection stored in the medium, including:
   an order processing component;
   wherein the order processing component, stored in the medium, includes processor-issuable instructions to:
      obtain, via at least one processor, an order of a user for an order processing entity;
      determine, via at least one processor, a blockchain data node associated with the order, wherein the blockchain data node facilitates access to user-owned read data of the user;
      determine, via at least one processor, an access control node associated with the blockchain data node;
      provide, via at least one processor, a blockchain identifier of the blockchain data node and a blockchain identifier of the order processing entity to the access control node;
      obtain, via at least one processor, the user-owned read data from the access control node;
      execute, via at least one processor, the order using the user-owned read data;
      determine, via at least one processor, a write access blockchain node associated with the order, wherein the write access blockchain node grants the order processing entity permission from the user to create one or more blockchain data nodes with the write access blockchain node as parent;
      determine, via at least one processor, user-owned write data to store with regard to the executed order;
      create, via at least one processor, a new blockchain data node with the write access blockchain node as parent, wherein the new blockchain data node facilitates access to the user-owned write data, wherein the new blockchain data node is cryptographically signed by the order processing entity.
B17. The medium of embodiment B16, wherein the user-owned read data is a subset of user-owned data stored via the blockchain data node.
B18. The medium of embodiment B16, further comprising:
the order processing component, stored in the medium, includes processor-issuable instructions to:
   determine, via at least one processor, a read access grant node associated with the blockchain data node; and
   provide, via at least one processor, a blockchain identifier of the read access grant node to the access control node.
B19. The medium of embodiment B16, wherein the access control node is specific to the order.
B20. The medium of embodiment B16, wherein the access control node is specific to the user.
B21. The medium of embodiment B16, wherein the user-owned read data includes information regarding funds used to pay for the order.
B22. The medium of embodiment B16, wherein the blockchain data node is cryptographically signed by another order processing entity that is a member in a network of trusted order processing entities.
B23. The medium of embodiment B16, wherein the user-owned write data is associated with a category of user-owned data, and the write access blockchain node is associated with the category of user-owned data.
B24. The medium of embodiment B16, wherein the user can revoke the order processing entity's read access to the blockchain data node.
B25. The medium of embodiment B24, wherein the user can reinstate the order processing entity's read access to the blockchain data node.
B26. The medium of embodiment B16, further comprising:
the order processing component, stored in the medium, includes processor-issuable instructions to:
   provide, via at least one processor, a blockchain identifier of the new blockchain data node to a validator node.
B27. The medium of embodiment B16, further comprising:
the order processing component, stored in the medium, includes processor-issuable instructions to:
   provide, via at least one processor, a blockchain identifier of the new blockchain data node to a second access control node.
B28. The medium of embodiment B27, wherein the access control node and the second access control node are the same node.
B29. The medium of embodiment B27, further comprising:
the order processing component, stored in the medium, includes processor-issuable instructions to:
   provide, via at least one processor, a decryption key to the second access control node, wherein the user-owned write data is encrypted and can be decrypted using the decryption key.
B30. The medium of embodiment B16, further comprising:
the order processing component, stored in the medium, includes processor-issuable instructions to:
   provide, via at least one processor, backing repository data to be stored in a backing repository to the second access control node, wherein the new blockchain data node facilitates access to the stored backing repository data.
B31. A processor-implemented order processing system, comprising:
   an order processing component means, to:
      obtain, via at least one processor, an order of a user for an order processing entity;
      determine, via at least one processor, a blockchain data node associated with the order, wherein the blockchain data node facilitates access to user-owned read data of the user;
      determine, via at least one processor, an access control node associated with the blockchain data node;
      provide, via at least one processor, a blockchain identifier of the blockchain data node and a blockchain identifier of the order processing entity to the access control node;
      obtain, via at least one processor, the user-owned read data from the access control node;
      execute, via at least one processor, the order using the user-owned read data;
      determine, via at least one processor, a write access blockchain node associated with the order, wherein the write access blockchain node grants the order processing entity permission from the user to create one or more blockchain data nodes with the write access blockchain node as parent;
      determine, via at least one processor, user-owned write data to store with regard to the executed order;
      create, via at least one processor, a new blockchain data node with the write access blockchain node as parent, wherein the new blockchain data node facilitates access to the user-owned write data, wherein the new blockchain data node is cryptographically signed by the order processing entity.
B32. The system of embodiment B31, wherein the user-owned read data is a subset of user-owned data stored via the blockchain data node.
B33. The system of embodiment B31, further comprising:
the order processing component means, to:
   determine, via at least one processor, a read access grant node associated with the blockchain data node; and
   provide, via at least one processor, a blockchain identifier of the read access grant node to the access control node.
B34. The system of embodiment B31, wherein the access control node is specific to the order.
B35. The system of embodiment B31, wherein the access control node is specific to the user.
B36. The system of embodiment B31, wherein the user-owned read data includes information regarding funds used to pay for the order.
B37. The system of embodiment B31, wherein the blockchain data node is cryptographically signed by another order processing entity that is a member in a network of trusted order processing entities.
B38. The system of embodiment B31, wherein the user-owned write data is associated with a category of user-owned data, and the write access blockchain node is associated with the category of user-owned data.
B39. The system of embodiment B31, wherein the user can revoke the order processing entity's read access to the blockchain data node.
B40. The system of embodiment B39, wherein the user can reinstate the order processing entity's read access to the blockchain data node.
B41. The system of embodiment B31, further comprising:
the order processing component means, to:
   provide, via at least one processor, a blockchain identifier of the new blockchain data node to a validator node.
B42. The system of embodiment B31, further comprising:
the order processing component means, to:
   provide, via at least one processor, a blockchain identifier of the new blockchain data node to a second access control node.
B43. The system of embodiment B42, wherein the access control node and the second access control node are the same node.
B44. The system of embodiment B42, further comprising:
the order processing component means, to:
   provide, via at least one processor, a decryption key to the second access control node, wherein the user-owned write data is encrypted and can be decrypted using the decryption key.
B45. The system of embodiment B31, further comprising:
the order processing component means, to:
   provide, via at least one processor, backing repository data to be stored in a backing repository to the second access control node, wherein the new blockchain data node facilitates access to the stored backing repository data.
B46. A processor-implemented order processing method, comprising:
   executing processor-implemented order processing component instructions to:
      obtain, via at least one processor, an order of a user for an order processing entity;
      determine, via at least one processor, a blockchain data node associated with the order, wherein the blockchain data node facilitates access to user-owned read data of the user;
      determine, via at least one processor, an access control node associated with the blockchain data node;
      provide, via at least one processor, a blockchain identifier of the blockchain data node and a blockchain identifier of the order processing entity to the access control node;
      obtain, via at least one processor, the user-owned read data from the access control node;
      execute, via at least one processor, the order using the user-owned read data;
      determine, via at least one processor, a write access blockchain node associated with the order, wherein the write access blockchain node grants the order processing entity permission from the user to create one or more blockchain data nodes with the write access blockchain node as parent;
      determine, via at least one processor, user-owned write data to store with regard to the executed order;
      create, via at least one processor, a new blockchain data node with the write access blockchain node as parent, wherein the new blockchain data node facilitates access to the user-owned write data, wherein the new blockchain data node is cryptographically signed by the order processing entity.
B47. The method of embodiment B46, wherein the user-owned read data is a subset of user-owned data stored via the blockchain data node.
B48. The method of embodiment B46, further comprising:
executing processor-implemented order processing component instructions to:
   determine, via at least one processor, a read access grant node associated with the blockchain data node; and
   provide, via at least one processor, a blockchain identifier of the read access grant node to the access control node.
B49. The method of embodiment B46, wherein the access control node is specific to the order.
B50. The method of embodiment B46, wherein the access control node is specific to the user.
B51. The method of embodiment B46, wherein the user-owned read data includes information regarding funds used to pay for the order.
B52. The method of embodiment B46, wherein the blockchain data node is cryptographically signed by another order processing entity that is a member in a network of trusted order processing entities.
B53. The method of embodiment B46, wherein the user-owned write data is associated with a category of user-owned data, and the write access blockchain node is associated with the category of user-owned data.
B54. The method of embodiment B46, wherein the user can revoke the order processing entity's read access to the blockchain data node.
B55. The method of embodiment B54, wherein the user can reinstate the order processing entity's read access to the blockchain data node.
B56. The method of embodiment B46, further comprising:
executing processor-implemented order processing component instructions to:
   provide, via at least one processor, a blockchain identifier of the new blockchain data node to a validator node.
B57. The method of embodiment B46, further comprising:
executing processor-implemented order processing component instructions to:
   provide, via at least one processor, a blockchain identifier of the new blockchain data node to a second access control node.
B58. The method of embodiment B57, wherein the access control node and the second access control node are the same node.
B59. The method of embodiment B57, further comprising:
executing processor-implemented order processing component instructions to:
   provide, via at least one processor, a decryption key to the second access control node, wherein the user-owned write data is encrypted and can be decrypted using the decryption key
B60. The method of embodiment B46, further comprising:
executing processor-implemented order processing component instructions to:
   provide, via at least one processor, backing repository data to be stored in a backing repository to the second access control node, wherein the new blockchain data node facilitates access to the stored backing repository data.
B101. A transaction unwinding apparatus, comprising:
a memory;
a component collection in the memory, including:
   an agency action component,
a processor disposed in communication with the memory, and configured to issue a plurality of processing instructions from the component collection stored in the memory,
   wherein the processor issues instructions from the agency action component, stored in the memory, to:
      obtain, via at least one processor, an agency action request from a user of an agency oversight configured blockchain;
      determine, via at least one processor, a transaction identifier of an unwind transaction associated with the agency action request;
      determine, via at least one processor, an unwind address associated with the agency action request;
      analyze, via at least one processor, the agency oversight configured blockchain to determine an affected transaction for the unwind transaction, wherein the affected transaction involves unspent crypto tokens that originated from the unwind transaction; and
      generate, via at least one processor, an agency blockchain transaction request that facilitates transferring crypto tokens from an address associated with the affected transaction to the unwind address.
B102. The apparatus of embodiment B101, wherein each transaction stored on the agency oversight configured blockchain is in a compliant format that allows an agency providing oversight over the agency oversight configured blockchain to unwind the transaction.
B103. The apparatus of embodiment B102, wherein a transaction is in a compliant format when a redeem script associated with the transaction is a 1-of-n multisig script.
B104. The apparatus of embodiment B103, wherein the transaction is in a compliant format when the redeem script includes a public key associated with the agency.
B105. The apparatus of embodiment B101, further comprising:
the processor issues instructions from the agency action component, stored in the memory, to:
   determine, via at least one processor, an unwind amount associated with the agency action request;
   wherein, the agency blockchain transaction request facilitates transferring the unwind amount of crypto tokens.
B106. The apparatus of embodiment B101, wherein the unwind address is associated with the user.
B107. The apparatus of embodiment B101, wherein crypto tokens associated with the unwind transaction are unspent, and the unwind transaction is the affected transaction.
B108. The apparatus of embodiment B101, wherein a plurality of affected transactions are determined, and wherein each affected transaction in the plurality of affected transactions involves a portion of unspent crypto tokens that originated from the unwind transaction.
B109. The apparatus of embodiment B108, wherein the agency blockchain transaction request includes a plurality of input fields, and wherein each input field corresponds to an affected transaction in the plurality of affected transactions.
B110. The apparatus of embodiment B108, wherein a plurality of unwind addresses are determined, wherein a plurality of agency blockchain transaction requests are generated, and wherein each of the plurality of agency blockchain transaction requests corresponds to an affected transaction in the plurality of affected transactions and to an unwind addresses in the plurality of unwind addresses.
B111. A processor-readable transaction unwinding non-transient physical medium storing processor-executable components, the components, comprising:
a component collection stored in the medium, including:
   an agency action component;
   wherein the agency action component, stored in the medium, includes processor-issuable instructions to:
      obtain, via at least one processor, an agency action request from a user of an agency oversight configured blockchain;
      determine, via at least one processor, a transaction identifier of an unwind transaction associated with the agency action request;
      determine, via at least one processor, an unwind address associated with the agency action request;
      analyze, via at least one processor, the agency oversight configured blockchain to determine an affected transaction for the unwind transaction, wherein the affected transaction involves unspent crypto tokens that originated from the unwind transaction; and
      generate, via at least one processor, an agency blockchain transaction request that facilitates transferring crypto tokens from an address associated with the affected transaction to the unwind address.
B112. The medium of embodiment B111, wherein each transaction stored on the agency oversight configured blockchain is in a compliant format that allows an agency providing oversight over the agency oversight configured blockchain to unwind the transaction.
B113. The medium of embodiment B112, wherein a transaction is in a compliant format when a redeem script associated with the transaction is a 1-of-n multisig script.
B114. The medium of embodiment B113, wherein the transaction is in a compliant format when the redeem script includes a public key associated with the agency.
B115. The medium of embodiment B111, further comprising:
the agency action component, stored in the medium, includes processor-issuable instructions to:
   determine, via at least one processor, an unwind amount associated with the agency action request;
   wherein, the agency blockchain transaction request facilitates transferring the unwind amount of crypto tokens.
B116. The medium of embodiment B111, wherein the unwind address is associated with the user.
B117. The medium of embodiment B111, wherein crypto tokens associated with the unwind transaction are unspent, and the unwind transaction is the affected transaction.
B118. The medium of embodiment B111, wherein a plurality of affected transactions are determined, and wherein each affected transaction in the plurality of affected transactions involves a portion of unspent crypto tokens that originated from the unwind transaction.
B119. The medium of embodiment B118, wherein the agency blockchain transaction request includes a plurality of input fields, and wherein each input field corresponds to an affected transaction in the plurality of affected transactions.
B120. The medium of embodiment B118, wherein a plurality of unwind addresses are determined, wherein a plurality of agency blockchain transaction requests are generated, and wherein each of the plurality of agency blockchain transaction requests corresponds to an affected transaction in the plurality of affected transactions and to an unwind addresses in the plurality of unwind addresses.
B121. A processor-implemented transaction unwinding system, comprising:
   an agency action component means, to:
      obtain, via at least one processor, an agency action request from a user of an agency oversight configured blockchain;
      determine, via at least one processor, a transaction identifier of an unwind transaction associated with the agency action request;
      determine, via at least one processor, an unwind address associated with the agency action request;
      analyze, via at least one processor, the agency oversight configured blockchain to determine an affected transaction for the unwind transaction, wherein the affected transaction involves unspent crypto tokens that originated from the unwind transaction; and
      generate, via at least one processor, an agency blockchain transaction request that facilitates transferring crypto tokens from an address associated with the affected transaction to the unwind address.
B122. The system of embodiment B121, wherein each transaction stored on the agency oversight configured blockchain is in a compliant format that allows an agency providing oversight over the agency oversight configured blockchain to unwind the transaction.
B123. The system of embodiment B122, wherein a transaction is in a compliant format when a redeem script associated with the transaction is a 1-of-n multisig script.
B124. The system of embodiment B123, wherein the transaction is in a compliant format when the redeem script includes a public key associated with the agency.
B125. The system of embodiment B121, further comprising:
the agency action component means, to:
   determine, via at least one processor, an unwind amount associated with the agency action request;
   wherein, the agency blockchain transaction request facilitates transferring the unwind amount of crypto tokens.
B126. The system of embodiment B121, wherein the unwind address is associated with the user.
B127. The system of embodiment B121, wherein crypto tokens associated with the unwind transaction are unspent, and the unwind transaction is the affected transaction.
B128. The system of embodiment B121, wherein a plurality of affected transactions are determined, and wherein each affected transaction in the plurality of affected transactions involves a portion of unspent crypto tokens that originated from the unwind transaction.
B129. The system of embodiment B128, wherein the agency blockchain transaction request includes a plurality of input fields, and wherein each input field corresponds to an affected transaction in the plurality of affected transactions.
B130. The system of embodiment B128, wherein a plurality of unwind addresses are determined, wherein a plurality of agency blockchain transaction requests are generated, and wherein each of the plurality of agency blockchain transaction requests corresponds to an affected transaction in the plurality of affected transactions and to an unwind addresses in the plurality of unwind addresses.
B131. A processor-implemented transaction unwinding method, comprising:
   executing processor-implemented agency action component instructions to:
      obtain, via at least one processor, an agency action request from a user of an agency oversight configured blockchain;
      determine, via at least one processor, a transaction identifier of an unwind transaction associated with the agency action request;
      determine, via at least one processor, an unwind address associated with the agency action request;
      analyze, via at least one processor, the agency oversight configured blockchain to determine an affected transaction for the unwind transaction, wherein the affected transaction involves unspent crypto tokens that originated from the unwind transaction; and
      generate, via at least one processor, an agency blockchain transaction request that facilitates transferring crypto tokens from an address associated with the affected transaction to the unwind address.
B132. The method of embodiment B131, wherein each transaction stored on the agency oversight configured blockchain is in a compliant format that allows an agency providing oversight over the agency oversight configured blockchain to unwind the transaction.
B133. The method of embodiment B132, wherein a transaction is in a compliant format when a redeem script associated with the transaction is a 1-of-n multisig script.
B134. The method of embodiment B133, wherein the transaction is in a compliant format when the redeem script includes a public key associated with the agency.
B135. The method of embodiment B131, further comprising:
executing processor-implemented agency action component instructions to:
   determine, via at least one processor, an unwind amount associated with the agency action request;
   wherein, the agency blockchain transaction request facilitates transferring the unwind amount of crypto tokens.
B136. The method of embodiment B131, wherein the unwind address is associated with the user.
B137. The method of embodiment B131, wherein crypto tokens associated with the unwind transaction are unspent, and the unwind transaction is the affected transaction.
B138. The method of embodiment B131, wherein a plurality of affected transactions are determined, and wherein each affected transaction in the plurality of affected transactions involves a portion of unspent crypto tokens that originated from the unwind transaction.
B139. The method of embodiment B138, wherein the agency blockchain transaction request includes a plurality of input fields, and wherein each input field corresponds to an affected transaction in the plurality of affected transactions.
B140. The method of embodiment B138, wherein a plurality of unwind addresses are determined, wherein a plurality of agency blockchain transaction requests are generated, and wherein each of the plurality of agency blockchain transaction requests corresponds to an affected transaction in the plurality of affected transactions and to an unwind addresses in the plurality of unwind addresses.
B201. A inter-blockchain network transaction facilitating apparatus, comprising:
a memory;
a component collection in the memory, including:
   a transaction processing component;
a processor disposed in communication with the memory, and configured to issue a plurality of processing instructions from the component collection stored in the memory,
   wherein the processor issues instructions from the transaction processing component, stored in the memory, to:
      obtain, via an exchange node of a source blockchain network, an inter-blockchain network transaction to transfer crypto tokens from a first user of the source blockchain network to a second user of a target blockchain network;
      validate, via at least one processor, input data associated with the inter-blockchain network transaction to confirm that the first user is authorized to transfer the crypto tokens;
      add, via at least one processor, a securing transaction to the source blockchain network's blockchain, wherein the securing transaction ensures that the crypto tokens may not be reused on the source blockchain network;
      determine, via at least one processor, an exchange node of the target blockchain network configured to facilitate inter-blockchain network transactions with the exchange node of the source blockchain network; and
      generate, via the exchange node of the source blockchain network, an inter-blockchain exchange request for the determined exchange node of the target blockchain network, wherein the inter-blockchain exchange request facilitates processing of the inter-blockchain network transaction on the target blockchain network.
B202. The apparatus of embodiment B201, wherein the source blockchain network is configured to serve a first region, and the target blockchain network is configured to serve a second region.
B203. The apparatus of embodiment B202, wherein a region is one of: a geographic region, a unit of an organization, a sidechain.
B204. The apparatus of embodiment B201, wherein the exchange node of the source blockchain network is specified as the exchange point between the source blockchain network and the target blockchain network in the inter-blockchain network transaction by the first user.
B205. The apparatus of embodiment B201, wherein the securing transaction transfers the crypto tokens to an address on the source blockchain network from which the crypto tokens cannot be transferred.
B206. The apparatus of embodiment B201, wherein the exchange node of the target blockchain network is specified by a configuration setting of the exchange node of the source blockchain network.
B207. The apparatus of embodiment B201, wherein the exchange node of the target blockchain network is determined dynamically based on the best crypto token exchange rate between crypto tokens of the source blockchain network and crypto tokens of the target blockchain network from crypto token exchange rates offered by exchange nodes of the target blockchain network.
B208. The apparatus of embodiment B201, wherein there is an inter-blockchain network exchange rate, other than one to one, between crypto tokens of the source blockchain network and crypto tokens of the target blockchain network, and wherein the exchange node of the source blockchain network is configured to determine the inter-blockchain network exchange rate.
B209. The apparatus of embodiment B208, wherein the inter-blockchain network exchange rate is determined by querying a third party market maker.
B210. The apparatus of embodiment B208, wherein the inter-blockchain exchange request includes a converted crypto tokens amount to be provided to the second user of the target blockchain network, and wherein the converted crypto tokens amount is calculated based on the determined inter-blockchain network exchange rate.
B211. The apparatus of embodiment B201, wherein the inter-blockchain exchange request includes proof that the source crypto tokens cannot be reused on the source blockchain network.
B212. The apparatus of embodiment B211, wherein the proof includes a transaction identifier of the securing transaction.
B213. The apparatus of embodiment B201, further, comprising:
   an inter-blockchain exchange processing component;
   wherein the processor issues instructions from the inter-blockchain exchange processing component, stored in the memory, to:
      obtain, via the exchange node of the target blockchain network, the inter-blockchain exchange request;
      validate, via at least one processor, that the crypto tokens may not be reused on the source blockchain network; and
      add, via at least one processor, the inter-blockchain network transaction to the target blockchain network's blockchain.
B214. The apparatus of embodiment B213, wherein the inter-blockchain network transaction is added to the target blockchain network's blockchain in an unmodified form.
B215. The apparatus of embodiment B213, wherein the inter-blockchain network transaction is added to the target blockchain network's blockchain in a modified form that includes a cryptographic signature of the exchange node of the target blockchain network.
B216. A processor-readable inter-blockchain network transaction facilitating non-transient physical medium storing processor-executable components, the components, comprising:
a component collection stored in the medium, including:
   a transaction processing component;
   wherein the transaction processing component, stored in the medium, includes processor-issuable instructions to:
      obtain, via an exchange node of a source blockchain network, an inter-blockchain network transaction to transfer crypto tokens from a first user of the source blockchain network to a second user of a target blockchain network;
      validate, via at least one processor, input data associated with the inter-blockchain network transaction to confirm that the first user is authorized to transfer the crypto tokens;
      add, via at least one processor, a securing transaction to the source blockchain network's blockchain, wherein the securing transaction ensures that the crypto tokens may not be reused on the source blockchain network;
      determine, via at least one processor, an exchange node of the target blockchain network configured to facilitate inter-blockchain network transactions with the exchange node of the source blockchain network; and
      generate, via the exchange node of the source blockchain network, an inter-blockchain exchange request for the determined exchange node of the target blockchain network, wherein the inter-blockchain exchange request facilitates processing of the inter-blockchain network transaction on the target blockchain network.
B217. The medium of embodiment B216, wherein the source blockchain network is configured to serve a first region, and the target blockchain network is configured to serve a second region.
B218. The medium of embodiment B217, wherein a region is one of: a geographic region, a unit of an organization, a sidechain.
B219. The medium of embodiment B216, wherein the exchange node of the source blockchain network is specified as the exchange point between the source blockchain network and the target blockchain network in the inter-blockchain network transaction by the first user.
B220. The medium of embodiment B216, wherein the securing transaction transfers the crypto tokens to an address on the source blockchain network from which the crypto tokens cannot be transferred.
B221. The medium of embodiment B216, wherein the exchange node of the target blockchain network is specified by a configuration setting of the exchange node of the source blockchain network.
B222. The medium of embodiment B216, wherein the exchange node of the target blockchain network is determined dynamically based on the best crypto token exchange rate between crypto tokens of the source blockchain network and crypto tokens of the target blockchain network from crypto token exchange rates offered by exchange nodes of the target blockchain network.
B223. The medium of embodiment B216, wherein there is an inter-blockchain network exchange rate, other than one to one, between crypto tokens of the source blockchain network and crypto tokens of the target blockchain network, and wherein the exchange node of the source blockchain network is configured to determine the inter-blockchain network exchange rate.
B224. The medium of embodiment B223, wherein the inter-blockchain network exchange rate is determined by querying a third party market maker.
B225. The medium of embodiment B223, wherein the inter-blockchain exchange request includes a converted crypto tokens amount to be provided to the second user of the target blockchain network, and wherein the converted crypto tokens amount is calculated based on the determined inter-blockchain network exchange rate.
B226. The medium of embodiment B216, wherein the inter-blockchain exchange request includes proof that the source crypto tokens cannot be reused on the source blockchain network.
B227. The medium of embodiment B226, wherein the proof includes a transaction identifier of the securing transaction.
B228. The medium of embodiment B216, further, comprising:
   an inter-blockchain exchange processing component in the component collection;
   wherein the inter-blockchain exchange processing component, stored in the medium, includes processor-issuable instructions to:
      obtain, via the exchange node of the target blockchain network, the inter-blockchain exchange request;
      validate, via at least one processor, that the crypto tokens may not be reused on the source blockchain network; and
      add, via at least one processor, the inter-blockchain network transaction to the target blockchain network's blockchain.
B229. The medium of embodiment B228, wherein the inter-blockchain network transaction is added to the target blockchain network's blockchain in an unmodified form.
B230. The medium of embodiment B228, wherein the inter-blockchain network transaction is added to the target blockchain network's blockchain in a modified form that includes a cryptographic signature of the exchange node of the target blockchain network.
B231. A processor-implemented inter-blockchain network transaction facilitating system, comprising:
   a transaction processing component means, to:
      obtain, via an exchange node of a source blockchain network, an inter-blockchain network transaction to transfer crypto tokens from a first user of the source blockchain network to a second user of a target blockchain network;
      validate, via at least one processor, input data associated with the inter-blockchain network transaction to confirm that the first user is authorized to transfer the crypto tokens;
      add, via at least one processor, a securing transaction to the source blockchain network's blockchain, wherein the securing transaction ensures that the crypto tokens may not be reused on the source blockchain network;
      determine, via at least one processor, an exchange node of the target blockchain network configured to facilitate inter-blockchain network transactions with the exchange node of the source blockchain network; and
      generate, via the exchange node of the source blockchain network, an inter-blockchain exchange request for the determined exchange node of the target blockchain network, wherein the inter-blockchain exchange request facilitates processing of the inter-blockchain network transaction on the target blockchain network.
B232. The system of embodiment B231, wherein the source blockchain network is configured to serve a first region, and the target blockchain network is configured to serve a second region.
B233. The system of embodiment B232, wherein a region is one of: a geographic region, a unit of an organization, a sidechain.
B234. The system of embodiment B231, wherein the exchange node of the source blockchain network is specified as the exchange point between the source blockchain network and the target blockchain network in the inter-blockchain network transaction by the first user.
B235. The system of embodiment B231, wherein the securing transaction transfers the crypto tokens to an address on the source blockchain network from which the crypto tokens cannot be transferred.
B236. The system of embodiment B231, wherein the exchange node of the target blockchain network is specified by a configuration setting of the exchange node of the source blockchain network.
B237. The system of embodiment B231, wherein the exchange node of the target blockchain network is determined dynamically based on the best crypto token exchange rate between crypto tokens of the source blockchain network and crypto tokens of the target blockchain network from crypto token exchange rates offered by exchange nodes of the target blockchain network.
B238. The system of embodiment B231, wherein there is an inter-blockchain network exchange rate, other than one to one, between crypto tokens of the source blockchain network and crypto tokens of the target blockchain network, and wherein the exchange node of the source blockchain network is configured to determine the inter-blockchain network exchange rate.
B239. The system of embodiment B238, wherein the inter-blockchain network exchange rate is determined by querying a third party market maker.
B240. The system of embodiment B238, wherein the inter-blockchain exchange request includes a converted crypto tokens amount to be provided to the second user of the target blockchain network, and wherein the converted crypto tokens amount is calculated based on the determined inter-blockchain network exchange rate.
B241. The system of embodiment B231, wherein the inter-blockchain exchange request includes proof that the source crypto tokens cannot be reused on the source blockchain network.
B242. The system of embodiment B241, wherein the proof includes a transaction identifier of the securing transaction.
B243. The system of embodiment B231, further, comprising:
   an inter-blockchain exchange processing component means, to:
      obtain, via the exchange node of the target blockchain network, the inter-blockchain exchange request;
      validate, via at least one processor, that the crypto tokens may not be reused on the source blockchain network; and
      add, via at least one processor, the inter-blockchain network transaction to the target blockchain network's blockchain.
B244. The system of embodiment B243, wherein the inter-blockchain network transaction is added to the target blockchain network's blockchain in an unmodified form.
B245. The system of embodiment B243, wherein the inter-blockchain network transaction is added to the target blockchain network's blockchain in a modified form that includes a cryptographic signature of the exchange node of the target blockchain network.
B246. A processor-implemented inter-blockchain network transaction facilitating method, comprising:
   executing processor-implemented transaction processing component instructions to:
      obtain, via an exchange node of a source blockchain network, an inter-blockchain network transaction to transfer crypto tokens from a first user of the source blockchain network to a second user of a target blockchain network;
      validate, via at least one processor, input data associated with the inter-blockchain network transaction to confirm that the first user is authorized to transfer the crypto tokens;
      add, via at least one processor, a securing transaction to the source blockchain network's blockchain, wherein the securing transaction ensures that the crypto tokens may not be reused on the source blockchain network;
      determine, via at least one processor, an exchange node of the target blockchain network configured to facilitate inter-blockchain network transactions with the exchange node of the source blockchain network; and
      generate, via the exchange node of the source blockchain network, an inter-blockchain exchange request for the determined exchange node of the target blockchain network, wherein the inter-blockchain exchange request facilitates processing of the inter-blockchain network transaction on the target blockchain network.
B247. The method of embodiment B246, wherein the source blockchain network is configured to serve a first region, and the target blockchain network is configured to serve a second region.
B248. The method of embodiment B247, wherein a region is one of: a geographic region, a unit of an organization, a sidechain.
B249. The method of embodiment B246, wherein the exchange node of the source blockchain network is specified as the exchange point between the source blockchain network and the target blockchain network in the inter-blockchain network transaction by the first user.
B250. The method of embodiment B246, wherein the securing transaction transfers the crypto tokens to an address on the source blockchain network from which the crypto tokens cannot be transferred.
B251. The method of embodiment B246, wherein the exchange node of the target blockchain network is specified by a configuration setting of the exchange node of the source blockchain network.
B252. The method of embodiment B246, wherein the exchange node of the target blockchain network is determined dynamically based on the best crypto token exchange rate between crypto tokens of the source blockchain network and crypto tokens of the target blockchain network from crypto token exchange rates offered by exchange nodes of the target blockchain network.
B253. The method of embodiment B246, wherein there is an inter-blockchain network exchange rate, other than one to one, between crypto tokens of the source blockchain network and crypto tokens of the target blockchain network, and wherein the exchange node of the source blockchain network is configured to determine the inter-blockchain network exchange rate.
B254. The method of embodiment B253, wherein the inter-blockchain network exchange rate is determined by querying a third party market maker.
B255. The method of embodiment B253, wherein the inter-blockchain exchange request includes a converted crypto tokens amount to be provided to the second user of the target blockchain network, and wherein the converted crypto tokens amount is calculated based on the determined inter-blockchain network exchange rate.
B256. The method of embodiment B246, wherein the inter-blockchain exchange request includes proof that the source crypto tokens cannot be reused on the source blockchain network.
B257. The method of embodiment B256, wherein the proof includes a transaction identifier of the securing transaction.
B258. The method of embodiment B246, further, comprising:
   executing processor-implemented inter-blockchain exchange processing component instructions to:
      obtain, via the exchange node of the target blockchain network, the inter-blockchain exchange request;
      validate, via at least one processor, that the crypto tokens may not be reused on the source blockchain network; and
      add, via at least one processor, the inter-blockchain network transaction to the target blockchain network's blockchain.
B259. The method of embodiment B258, wherein the inter-blockchain network transaction is added to the target blockchain network's blockchain in an unmodified form.
B260. The method of embodiment B258, wherein the inter-blockchain network transaction is added to the target blockchain network's blockchain in a modified form that includes a cryptographic signature of the exchange node of the target blockchain network.
C1. A blockchain synchronizing apparatus, comprising:
a memory;
a component collection in the memory, including:
   a blockchain sync adaptor component, and
   a transaction process optimizer component;
a processor disposed in communication with the memory, and configured to issue a plurality of processing instructions from the component collection stored in the memory,
   wherein the processor issues instructions from the blockchain sync adaptor component, stored in the memory, to:
      obtain, via at least one processor, a borrow transaction request associated with a borrow transaction;
      store, via at least one processor, transaction attributes associated with the borrow transaction in a database;
      notify, via at least one processor, the transaction process optimizer component regarding the borrow transaction;
      obtain, via at least one processor, a blockchain sync notification associated with the borrow transaction from the transaction process optimizer component;
      filter, via at least one processor, the stored transaction attributes associated with the borrow transaction;
      generate, via at least one processor, a smart contract associated with the borrow transaction, wherein the smart contract includes the filtered transaction attributes;
      send, via at least one processor, the generated smart contract to a blockchain node of a blockchain network;
      receive, via at least one processor, a smart contract notification associated with the smart contract; and
      provide, via at least one processor, a push notification to a user interface component of a user's client regarding the smart contract notification.
C2. The apparatus of embodiment C1, wherein the transaction attributes include a customer's customer identifier with a broker-dealer, an identifier of a fully paid security in the customer's account with the broker-dealer to be borrowed, and an identifier of a collateral agent that will hold collateral for the fully paid security to be borrowed.
C3. The apparatus of embodiment C1, wherein the database is a write once read many (WORM) database.
C4. The apparatus of embodiment C1, wherein the transaction process optimizer component is notified via a borrow transaction notification based on receipt of the borrow transaction request.
C5. The apparatus of embodiment C1, wherein the transaction process optimizer component is notified via a borrow transaction notification from the database based on activation of a database trigger associated with storing the transaction attributes in the database.
C6. The apparatus of embodiment C1, further, comprising:
   the processor issues instructions from the transaction process optimizer component, stored in the memory, to:
      obtain, via at least one processor, a borrow transaction notification associated with the borrow transaction;
      update, via at least one processor, a set of utilized cumulative tracking attributes to reflect details of the borrow transaction;
      determine, via at least one processor, that a sync threshold has been triggered based on analysis of the set of utilized cumulative tracking attributes; and
      send, via at least one processor, the blockchain sync notification to the blockchain sync adaptor component.
C7. The apparatus of embodiment C6, wherein the analysis of the set of utilized cumulative tracking attributes further comprises instructions to:
   determine a set of utilized rules; and
   apply the set of utilized rules to the set of utilized cumulative tracking attributes to determine whether the sync threshold has been triggered.
C8. The apparatus of embodiment C6, wherein the analysis of the set of utilized cumulative tracking attributes further comprises instructions to:
   determine a utilized machine learning structure; and
   provide the set of utilized cumulative tracking attributes as inputs to the utilized machine learning structure to determine whether the sync threshold has been triggered.
C9. The apparatus of embodiment C8, wherein the utilized machine learning structure is a neural network.
C10. The apparatus of embodiment C6, wherein the blockchain sync notification specifies a set of borrow transactions, including the borrow transaction, that should be synchronized to the blockchain network.
C11. The apparatus of embodiment C1, wherein the filtered transaction attributes are transactional attributes associated with the borrow transaction.
C12. The apparatus of embodiment C1, further, comprising:
   the processor issues instructions from the blockchain sync adaptor component, stored in the memory, to:
      generate a summary attribute using a hash of the filtered-out attributes; and
      wherein the smart contract includes the summary attribute.
C13. The apparatus of embodiment C1, wherein the smart contract is an Ethereum smart contract that utilizes an oracle.
C14. The apparatus of embodiment C6,
   wherein the smart contract includes a set of precalculated variables with values calculated before the smart contract is sent to the blockchain node;
   wherein the smart contract includes a set of postcalculated variables with values to be calculated off-chain after the smart contract is sent to the blockchain node; and
   wherein the smart contract is configured to obtain the set of postcalculated variables from an oracle; and
   wherein the analysis of the set of utilized cumulative tracking attributes indicates an acceptable risk value associated with calculating values of the set of postcalculated variables off-chain.
C15. The apparatus of embodiment C2,
   wherein the smart contract is implemented to perform periodic settlement of collateral associated with the borrow transaction by transferring funds between the broker-dealer's account and the customer's account with the collateral agent;
   wherein frequency of the periodic settlement is configured via an oracle;
   wherein the smart contract notification is generated when a periodic settlement occurs; and
   wherein the user interface component notifies the user regarding the periodic settlement.
C16. A processor-readable blockchain synchronizing non-transient physical medium storing processor-executable components, the components, comprising:
a component collection stored in the medium, including:
   a blockchain sync adaptor component, and
   a transaction process optimizer component;
   wherein the blockchain sync adaptor component, stored in the medium, includes processor-issuable instructions to:
      obtain, via at least one processor, a borrow transaction request associated with a borrow transaction;
      store, via at least one processor, transaction attributes associated with the borrow transaction in a database;
      notify, via at least one processor, the transaction process optimizer component regarding the borrow transaction;
      obtain, via at least one processor, a blockchain sync notification associated with the borrow transaction from the transaction process optimizer component;
      filter, via at least one processor, the stored transaction attributes associated with the borrow transaction;
      generate, via at least one processor, a smart contract associated with the borrow transaction, wherein the smart contract includes the filtered transaction attributes;
      send, via at least one processor, the generated smart contract to a blockchain node of a blockchain network;
      receive, via at least one processor, a smart contract notification associated with the smart contract; and
      provide, via at least one processor, a push notification to a user interface component of a user's client regarding the smart contract notification.
C17. The medium of embodiment C16, wherein the transaction attributes include a customer's customer identifier with a broker-dealer, an identifier of a fully paid security in the customer's account with the broker-dealer to be borrowed, and an identifier of a collateral agent that will hold collateral for the fully paid security to be borrowed.
C18. The medium of embodiment C16, wherein the database is a write once read many (WORM) database.
C19. The medium of embodiment C16, wherein the transaction process optimizer component is notified via a borrow transaction notification based on receipt of the borrow transaction request.
C20. The medium of embodiment C16, wherein the transaction process optimizer component is notified via a borrow transaction notification from the database based on activation of a database trigger associated with storing the transaction attributes in the database.
C21. The medium of embodiment C16, further, comprising:
   the transaction process optimizer component, stored in the medium, includes processor-issuable instructions to:
      obtain, via at least one processor, a borrow transaction notification associated with the borrow transaction;
      update, via at least one processor, a set of utilized cumulative tracking attributes to reflect details of the borrow transaction;
      determine, via at least one processor, that a sync threshold has been triggered based on analysis of the set of utilized cumulative tracking attributes; and
      send, via at least one processor, the blockchain sync notification to the blockchain sync adaptor component.
C22. The medium of embodiment C21, wherein the analysis of the set of utilized cumulative tracking attributes further comprises instructions to:
   determine a set of utilized rules; and
   apply the set of utilized rules to the set of utilized cumulative tracking attributes to determine whether the sync threshold has been triggered.
C23. The medium of embodiment C21, wherein the analysis of the set of utilized cumulative tracking attributes further comprises instructions to:
   determine a utilized machine learning structure; and
   provide the set of utilized cumulative tracking attributes as inputs to the utilized machine learning structure to determine whether the sync threshold has been triggered.
C24. The medium of embodiment C23, wherein the utilized machine learning structure is a neural network.
C25. The medium of embodiment C21, wherein the blockchain sync notification specifies a set of borrow transactions, including the borrow transaction, that should be synchronized to the blockchain network.
C26. The medium of embodiment C16, wherein the filtered transaction attributes are transactional attributes associated with the borrow transaction.
C27. The medium of embodiment C16, further, comprising:
   the blockchain sync adaptor component, stored in the medium, includes processor-issuable instructions to:
      generate a summary attribute using a hash of the filtered-out attributes; and
      wherein the smart contract includes the summary attribute.
C28. The medium of embodiment C16, wherein the smart contract is an Ethereum smart contract that utilizes an oracle.
C29. The medium of embodiment C21,
   wherein the smart contract includes a set of precalculated variables with values calculated before the smart contract is sent to the blockchain node;
   wherein the smart contract includes a set of postcalculated variables with values to be calculated off-chain after the smart contract is sent to the blockchain node;
   wherein the smart contract is configured to obtain the set of postcalculated variables from an oracle; and
   wherein the analysis of the set of utilized cumulative tracking attributes indicates an acceptable risk value associated with calculating values of the set of postcalculated variables off-chain.
C30. The medium of embodiment C17,
   wherein the smart contract is implemented to perform periodic settlement of collateral associated with the borrow transaction by transferring funds between the broker-dealer's account and the customer's account with the collateral agent;
   wherein frequency of the periodic settlement is configured via an oracle;
   wherein the smart contract notification is generated when a periodic settlement occurs; and
   wherein the user interface component notifies the user regarding the periodic settlement.
C31. A processor-implemented blockchain synchronizing system, comprising:
a blockchain sync adaptor component means, to:
   obtain, via at least one processor, a borrow transaction request associated with a borrow transaction;
   store, via at least one processor, transaction attributes associated with the borrow transaction in a database;
   notify, via at least one processor, the transaction process optimizer component regarding the borrow transaction;
   obtain, via at least one processor, a blockchain sync notification associated with the borrow transaction from the transaction process optimizer component;
   filter, via at least one processor, the stored transaction attributes associated with the borrow transaction;
   generate, via at least one processor, a smart contract associated with the borrow transaction, wherein the smart contract includes the filtered transaction attributes;
   send, via at least one processor, the generated smart contract to a blockchain node of a blockchain network;
   receive, via at least one processor, a smart contract notification associated with the smart contract; and
   provide, via at least one processor, a push notification to a user interface component of a user's client regarding the smart contract notification.
C32. The system of embodiment C31, wherein the transaction attributes include a customer's customer identifier with a broker-dealer, an identifier of a fully paid security in the customer's account with the broker-dealer to be borrowed, and an identifier of a collateral agent that will hold collateral for the fully paid security to be borrowed.
C33. The system of embodiment C31, wherein the database is a write once read many (WORM) database.
C34. The system of embodiment C31, wherein the transaction process optimizer component is notified via a borrow transaction notification based on receipt of the borrow transaction request.
C35. The system of embodiment C31, wherein the transaction process optimizer component is notified via a borrow transaction notification from the database based on activation of a database trigger associated with storing the transaction attributes in the database.
C36. The system of embodiment C31, further, comprising:
   a transaction process optimizer component means, to:
      obtain, via at least one processor, a borrow transaction notification associated with the borrow transaction;
      update, via at least one processor, a set of utilized cumulative tracking attributes to reflect details of the borrow transaction;
      determine, via at least one processor, that a sync threshold has been triggered based on analysis of the set of utilized cumulative tracking attributes; and
      send, via at least one processor, the blockchain sync notification to the blockchain sync adaptor component.
C37. The system of embodiment C36, wherein the analysis of the set of utilized cumulative tracking attributes further comprises instructions to:
   determine a set of utilized rules; and
   apply the set of utilized rules to the set of utilized cumulative tracking attributes to determine whether the sync threshold has been triggered.
C38. The system of embodiment C36, wherein the analysis of the set of utilized cumulative tracking attributes further comprises instructions to:
   determine a utilized machine learning structure; and
   provide the set of utilized cumulative tracking attributes as inputs to the utilized machine learning structure to determine whether the sync threshold has been triggered.
C39. The system of embodiment C38, wherein the utilized machine learning structure is a neural network.
C40. The system of embodiment C36, wherein the blockchain sync notification specifies a set of borrow transactions, including the borrow transaction, that should be synchronized to the blockchain network.
C41. The system of embodiment C31, wherein the filtered transaction attributes are transactional attributes associated with the borrow transaction.
C42. The system of embodiment C31, further, comprising:
   the blockchain sync adaptor component means, to:
      generate a summary attribute using a hash of the filtered-out attributes; and
      wherein the smart contract includes the summary attribute.
C43. The system of embodiment C31, wherein the smart contract is an Ethereum smart contract that utilizes an oracle.
C44. The system of embodiment C36,
   wherein the smart contract includes a set of precalculated variables with values calculated before the smart contract is sent to the blockchain node;
   wherein the smart contract includes a set of postcalculated variables with values to be calculated off-chain after the smart contract is sent to the blockchain node;
   wherein the smart contract is configured to obtain the set of postcalculated variables from an oracle; and
   wherein the analysis of the set of utilized cumulative tracking attributes indicates an acceptable risk value associated with calculating values of the set of postcalculated variables off-chain.
C45. The system of embodiment C32,
   wherein the smart contract is implemented to perform periodic settlement of collateral associated with the borrow transaction by transferring funds between the broker-dealer's account and the customer's account with the collateral agent;
   wherein frequency of the periodic settlement is configured via an oracle;
   wherein the smart contract notification is generated when a periodic settlement occurs; and
   wherein the user interface component notifies the user regarding the periodic settlement.
C46. A processor-implemented blockchain synchronizing method, comprising:
executing processor-implemented blockchain sync adaptor component instructions to:
   obtain, via at least one processor, a borrow transaction request associated with a borrow transaction;
   store, via at least one processor, transaction attributes associated with the borrow transaction in a database;
   notify, via at least one processor, the transaction process optimizer component regarding the borrow transaction;
   obtain, via at least one processor, a blockchain sync notification associated with the borrow transaction from the transaction process optimizer component;
   filter, via at least one processor, the stored transaction attributes associated with the borrow transaction;
   generate, via at least one processor, a smart contract associated with the borrow transaction, wherein the smart contract includes the filtered transaction attributes;
   send, via at least one processor, the generated smart contract to a blockchain node of a blockchain network;
   receive, via at least one processor, a smart contract notification associated with the smart contract; and
   provide, via at least one processor, a push notification to a user interface component of a user's client regarding the smart contract notification.
C47. The method of embodiment C46, wherein the transaction attributes include a customer's customer identifier with a broker-dealer, an identifier of a fully paid security in the customer's account with the broker-dealer to be borrowed, and an identifier of a collateral agent that will hold collateral for the fully paid security to be borrowed.
C48. The method of embodiment C46, wherein the database is a write once read many (WORM) database.
C49. The method of embodiment C46, wherein the transaction process optimizer component is notified via a borrow transaction notification based on receipt of the borrow transaction request.
C50. The method of embodiment C46, wherein the transaction process optimizer component is notified via a borrow transaction notification from the database based on activation of a database trigger associated with storing the transaction attributes in the database.
C51. The method of embodiment C46, further, comprising:
   a transaction process optimizer component means, to:
      obtain, via at least one processor, a borrow transaction notification associated with the borrow transaction;
      update, via at least one processor, a set of utilized cumulative tracking attributes to reflect details of the borrow transaction;
      determine, via at least one processor, that a sync threshold has been triggered based on analysis of the set of utilized cumulative tracking attributes; and
      send, via at least one processor, the blockchain sync notification to the blockchain sync adaptor component.
C52. The method of embodiment C51, wherein the analysis of the set of utilized cumulative tracking attributes further comprises instructions to:
   determine a set of utilized rules; and
   apply the set of utilized rules to the set of utilized cumulative tracking attributes to determine whether the sync threshold has been triggered.
C53. The method of embodiment C51, wherein the analysis of the set of utilized cumulative tracking attributes further comprises instructions to:
   determine a utilized machine learning structure; and
   provide the set of utilized cumulative tracking attributes as inputs to the utilized machine learning structure to determine whether the sync threshold has been triggered.
C54. The method of embodiment C53, wherein the utilized machine learning structure is a neural network.
C55. The method of embodiment C51, wherein the blockchain sync notification specifies a set of borrow transactions, including the borrow transaction, that should be synchronized to the blockchain network.
C56. The method of embodiment C46, wherein the filtered transaction attributes are transactional attributes associated with the borrow transaction.
C57. The method of embodiment C46, further, comprising:
   the blockchain sync adaptor component means, to:
      generate a summary attribute using a hash of the filtered-out attributes; and
      wherein the smart contract includes the summary attribute.
C58. The method of embodiment C46, wherein the smart contract is an Ethereum smart contract that utilizes an oracle.
C59. The method of embodiment C51,
   wherein the smart contract includes a set of precalculated variables with values calculated before the smart contract is sent to the blockchain node;
   wherein the smart contract includes a set of postcalculated variables with values to be calculated off-chain after the smart contract is sent to the blockchain node;
   wherein the smart contract is configured to obtain the set of postcalculated variables from an oracle; and
   wherein the analysis of the set of utilized cumulative tracking attributes indicates an acceptable risk value associated with calculating values of the set of postcalculated variables off-chain.
C60. The method of embodiment C47,
   wherein the smart contract is implemented to perform periodic settlement of collateral associated with the borrow transaction by transferring funds between the broker-dealer's account and the customer's account with the collateral agent;
   wherein frequency of the periodic settlement is configured via an oracle;
   wherein the smart contract notification is generated when a periodic settlement occurs; and
   wherein the user interface component notifies the user regarding the periodic settlement.
D1. A transaction signing apparatus, comprising:
a memory;
a component collection in the memory, including:
   a secure firmware transaction signing component implemented by a first hardware security module (HSM);
a processor disposed in communication with the memory, and configured to issue a plurality of processing instructions from the component collection stored in the memory,
   wherein the processor issues instructions from the secure firmware transaction signing component, stored in the memory, to:
      receive, via at least one processor, a transaction signing request message for a transaction;
      obtain, via at least one processor, an encrypted master private key associated with the transaction from a second HSM;
      retrieve, via at least one processor, from the first HSM's tamper-proof storage, a private key decryption key associated with the first HSM;
      decrypt, via at least one processor, by the first HSM, the encrypted master private key using the retrieved private key decryption key;
      determine, via at least one processor, a transaction hash and a keychain path associated with the transaction signing request message;
      generate, via at least one processor, by the first HSM, a signing private key for the determined keychain path using the decrypted master private key;
      sign, via at least one processor, by the first HSM, the determined transaction hash using the generated signing private key to generate a signature; and
      return, via at least one processor, the generated signature.
D2. The apparatus of embodiment D1, wherein the first HSM is a PCIe appliance installed in a transaction signing server.
D3. The apparatus of embodiment D1, wherein the second HSM is a USB appliance communicatively coupled to the first HSM via USB.
D4. The apparatus of embodiment D1, wherein the second HSM includes a pin entry device. D5. The apparatus of embodiment D4, wherein the second HSM provides the encrypted master private key to the first HSM upon obtaining separate credentials from a predetermined number of people.
D6. The apparatus of embodiment D1, wherein the second HSM also implements a secure firmware transaction signing component.
D7. The apparatus of embodiment D1, wherein the transaction signing request is an API call to a method exposed by the secure firmware transaction signing component.
D8. The apparatus of embodiment D1, wherein the encrypted master private key is encrypted, by the second HSM, using a public key encryption key of the first HSM stored in the second HSM's tamper-proof storage.
D9. The apparatus of embodiment D1, wherein the signing private key is generated using a Bip32-based deterministic key derivation procedure.
D10. The apparatus of embodiment D1, further, comprising:
   the processor issues instructions from the secure firmware transaction signing component, stored in the memory, to:
      wipe, via at least one processor, temporary private key data from the memory after generating the signature.
D11. The apparatus of embodiment D10, wherein the temporary private key data includes the encrypted master private key, the decrypted master private key, and the generated signing private key.
D12. The apparatus of embodiment D1, wherein the transaction hash is signed in accordance with the hashing algorithm utilized by the Bitcoin protocol.
D13. The apparatus of embodiment D1, wherein the signature is returned in Distinguished Encoding Rules format.
D14. A processor-readable transaction signing non-transient physical medium storing processor-executable components, the components, comprising:
a component collection stored in the medium, including:
   a secure firmware transaction signing component implemented by a first hardware security module (HSM);
   wherein the secure firmware transaction signing component, stored in the medium, includes processor-issuable instructions to:
      receive, via at least one processor, a transaction signing request message for a transaction;
      obtain, via at least one processor, an encrypted master private key associated with the transaction from a second HSM;
      retrieve, via at least one processor, from the first HSM's tamper-proof storage, a private key decryption key associated with the first HSM;
      decrypt, via at least one processor, by the first HSM, the encrypted master private key using the retrieved private key decryption key;
      determine, via at least one processor, a transaction hash and a keychain path associated with the transaction signing request message;
      generate, via at least one processor, by the first HSM, a signing private key for the determined keychain path using the decrypted master private key;
      sign, via at least one processor, by the first HSM, the determined transaction hash using the generated signing private key to generate a signature; and
      return, via at least one processor, the generated signature.
D15. The medium of embodiment D14, wherein the first HSM is a PCIe appliance installed in a transaction signing server.
D16. The medium of embodiment D14, wherein the second HSM is a USB appliance communicatively coupled to the first HSM via USB.
D17. The medium of embodiment D14, wherein the second HSM includes a pin entry device.
D18. The medium of embodiment D17, wherein the second HSM provides the encrypted master private key to the first HSM upon obtaining separate credentials from a predetermined number of people.
D19. The medium of embodiment D14, wherein the second HSM also implements a secure firmware transaction signing component.
D20. The medium of embodiment D14, wherein the transaction signing request is an API call to a method exposed by the secure firmware transaction signing component.
D21. The medium of embodiment D14, wherein the encrypted master private key is encrypted, by the second HSM, using a public key encryption key of the first HSM stored in the second HSM's tamper-proof storage.
D22. The medium of embodiment D14, wherein the signing private key is generated using a Bip32-based deterministic key derivation procedure.
D23. The medium of embodiment D14, further, comprising:
   the secure firmware transaction signing component, stored in the medium, includes processor-issuable instructions to:
      wipe, via at least one processor, temporary private key data from the memory after generating the signature.
D24. The medium of embodiment D23, wherein the temporary private key data includes the encrypted master private key, the decrypted master private key, and the generated signing private key.
D25. The medium of embodiment D14, wherein the transaction hash is signed in accordance with the hashing algorithm utilized by the Bitcoin protocol.
D26. The medium of embodiment D14, wherein the signature is returned in Distinguished Encoding Rules format.
D27. A processor-implemented transaction signing system, comprising:
   secure firmware transaction signing component means implemented by a first hardware security module (HSM), to:
      receive, via at least one processor, a transaction signing request message for a transaction;
      obtain, via at least one processor, an encrypted master private key associated with the transaction from a second HSM;
      retrieve, via at least one processor, from the first HSM's tamper-proof storage, a private key decryption key associated with the first HSM;
      decrypt, via at least one processor, by the first HSM, the encrypted master private key using the retrieved private key decryption key;
      determine, via at least one processor, a transaction hash and a keychain path associated with the transaction signing request message;
      generate, via at least one processor, by the first HSM, a signing private key for the determined keychain path using the decrypted master private key;
      sign, via at least one processor, by the first HSM, the determined transaction hash using the generated signing private key to generate a signature; and
      return, via at least one processor, the generated signature.
D28. The system of embodiment D27, wherein the first HSM is a PCIe appliance installed in a transaction signing server.
D29. The system of embodiment D27, wherein the second HSM is a USB appliance communicatively coupled to the first HSM via USB.
D30. The system of embodiment D27, wherein the second HSM includes a pin entry device.
D31. The system of embodiment D30, wherein the second HSM provides the encrypted master private key to the first HSM upon obtaining separate credentials from a predetermined number of people.
D32. The system of embodiment D27, wherein the second HSM also implements a secure firmware transaction signing component.
D33. The system of embodiment D27, wherein the transaction signing request is an API call to a method exposed by the secure firmware transaction signing component.
D34. The system of embodiment D27, wherein the encrypted master private key is encrypted, by the second HSM, using a public key encryption key of the first HSM stored in the second HSM's tamper-proof storage.
D35. The system of embodiment D27, wherein the signing private key is generated using a Bip32-based deterministic key derivation procedure.
D36. The system of embodiment D27, further, comprising:
   secure firmware transaction signing component means, to:
      wipe, via at least one processor, temporary private key data from the memory after generating the signature.
D37. The system of embodiment D36, wherein the temporary private key data includes the encrypted master private key, the decrypted master private key, and the generated signing private key.
D38. The system of embodiment D27, wherein the transaction hash is signed in accordance with the hashing algorithm utilized by the Bitcoin protocol.
D39. The system of embodiment D27, wherein the signature is returned in Distinguished Encoding Rules format.
D40. A processor-implemented transaction signing method, comprising:
   executing processor-implemented secure firmware transaction signing component instructions implemented by a first hardware security module (HSM), to:
      receive, via at least one processor, a transaction signing request message for a transaction;
      obtain, via at least one processor, an encrypted master private key associated with the transaction from a second HSM;
      retrieve, via at least one processor, from the first HSM's tamper-proof storage, a private key decryption key associated with the first HSM;
      decrypt, via at least one processor, by the first HSM, the encrypted master private key using the retrieved private key decryption key;
      determine, via at least one processor, a transaction hash and a keychain path associated with the transaction signing request message;
      generate, via at least one processor, by the first HSM, a signing private key for the determined keychain path using the decrypted master private key;
      sign, via at least one processor, by the first HSM, the determined transaction hash using the generated signing private key to generate a signature; and
      return, via at least one processor, the generated signature.
D41. The method of embodiment D40, wherein the first HSM is a PCIe appliance installed in a transaction signing server.
D42. The method of embodiment D40, wherein the second HSM is a USB appliance communicatively coupled to the first HSM via USB.
D43. The method of embodiment D40, wherein the second HSM includes a pin entry device.
D44. The method of embodiment D43, wherein the second HSM provides the encrypted master private key to the first HSM upon obtaining separate credentials from a predetermined number of people.
D45. The method of embodiment D40, wherein the second HSM also implements a secure firmware transaction signing component.
D46. The method of embodiment D40, wherein the transaction signing request is an API call to a method exposed by the secure firmware transaction signing component.
D47. The method of embodiment D40, wherein the encrypted master private key is encrypted, by the second HSM, using a public key encryption key of the first HSM stored in the second HSM's tamper-proof storage.
D48. The method of embodiment D40, wherein the signing private key is generated using a Bip32-based deterministic key derivation procedure.
D49. The method of embodiment D40, further, comprising:
   executing processor-implemented secure firmware transaction signing component instructions to:
      wipe, via at least one processor, temporary private key data from the memory after generating the signature.
D50. The method of embodiment D49, wherein the temporary private key data includes the encrypted master private key, the decrypted master private key, and the generated signing private key.
D51. The method of embodiment D40, wherein the transaction hash is signed in accordance with the hashing algorithm utilized by the Bitcoin protocol.
D52. The method of embodiment D40, wherein the signature is returned in Distinguished Encoding Rules format.
D101. A secure firmware key backup apparatus, comprising:
a memory;
a component collection in the memory, including:
   a secure firmware key backup component implemented by a backup hardware security module (HSM);
a processor disposed in communication with the memory, and configured to issue a plurality of processing instructions from the component collection stored in the memory,
   wherein the processor issues instructions from the secure firmware key backup component, stored in the memory, to:
      receive, via at least one processor, by the backup HSM, a key backup request from a backup utility, wherein the key backup request includes an encrypted master key associated with a hosting HSM;
      retrieve, via at least one processor, from the backup HSM's tamper-proof storage, a private key decryption key corresponding to a public key encryption key previously provided by the backup HSM to the backup utility for the hosting HSM, wherein the encrypted master key is encrypted using the public key encryption key by the hosting HSM;
      decrypt, via at least one processor, by the backup HSM, the encrypted master key using the retrieved private key decryption key;
      determine, via at least one processor, by the backup HSM, a specified number of master key shares to generate for the decrypted master key;
      generate, via at least one processor, by the backup HSM, the specified number of master key shares using a secret sharing method; and
      provide, via at least one processor, by the backup HSM, the generated master key shares to the backup utility.
D102. The apparatus of embodiment D101, wherein the backup HSM is a PCIe appliance.
D103. The apparatus of embodiment D101, wherein the hosting HSM is a USB appliance communicatively coupled to the backup HSM via USB.
D104. The apparatus of embodiment D101, wherein the key backup request is an API call to a method exposed by the secure firmware key backup component.
D105. The apparatus of embodiment D101, wherein the public key encryption key and the corresponding private key decryption key are predefined for the backup HSM.
D106. The apparatus of embodiment D101, wherein the public key encryption key and the corresponding private key decryption key are generated dynamically each time a key backup is executed.
D107. The apparatus of embodiment D101, wherein the secret sharing method is Shamir's Secret Sharing.
D108. The apparatus of embodiment D101, further, comprising:
   the processor issues instructions from the secure firmware key backup component, stored in the memory, to:
      determine, via at least one processor, by the backup HSM, a specified number of master key shares sufficient to recover the master key; and
      wherein the master key shares are generated using the secret sharing method based on the determined number of master key shares sufficient to recover the master key.
D109. The apparatus of embodiment D101, further, comprising:
   a backup utility key backup component in the component collection, and
   the processor issues instructions from the backup utility key backup component, stored in the memory, to:
      generate, via at least one processor, backup materials from the generated master key shares.
D110. The apparatus of embodiment D109, wherein the backup materials are any of: paper printouts, metal plates, plastic plates, USB keys, hard drives, solid state drives, portable HSMs.
D111. The apparatus of embodiment D109, wherein the backup materials are distributed for storage in geographically distributed backup locations.
D112. The apparatus of embodiment D111, wherein each geographic backup location stores a mixture of different types of backup materials.
D113. The apparatus of embodiment D101, further, comprising:
   a secure firmware key recovery component in the component collection, and
   the processor issues instructions from the secure firmware key recovery component, stored in the memory, to:
      receive, via at least one processor, by a second backup HSM, a key recovery request from a recovery utility, wherein the key recovery request includes a set of master key shares sufficient to recover the master key, wherein the key recovery request includes a second public key encryption key provided by a second hosting HSM, wherein the second public key encryption key corresponds to a second private key decryption key stored in tamper-proof storage of the second hosting HSM;
      recover, via at least one processor, by the second backup HSM, the master key from the set of master key shares using the secret sharing method;
      encrypt, via at least one processor, by the second backup HSM, the recovered master key using the second public key encryption key; and
      provide, via at least one processor, by the second backup HSM, the encrypted recovered master key to the recovery utility.
D114. The apparatus of embodiment D113, wherein the backup HSM and the second backup HSM are the same HSM.
D115. The apparatus of embodiment D113, wherein the hosting HSM and the second hosting HSM are the same HSM.
D116. A processor-readable secure firmware key backup non-transient physical medium storing processor-executable components, the components, comprising:
a component collection stored in the medium, including:
   a secure firmware key backup component implemented by a backup hardware security module (HSM);
   wherein the secure firmware key backup component, stored in the medium, includes processor-issuable instructions to:
      receive, via at least one processor, by the backup HSM, a key backup request from a backup utility, wherein the key backup request includes an encrypted master key associated with a hosting HSM;
      retrieve, via at least one processor, from the backup HSM's tamper-proof storage, a private key decryption key corresponding to a public key encryption key previously provided by the backup HSM to the backup utility for the hosting HSM, wherein the encrypted master key is encrypted using the public key encryption key by the hosting HSM;
      decrypt, via at least one processor, by the backup HSM, the encrypted master key using the retrieved private key decryption key;
      determine, via at least one processor, by the backup HSM, a specified number of master key shares to generate for the decrypted master key;
      generate, via at least one processor, by the backup HSM, the specified number of master key shares using a secret sharing method; and
      provide, via at least one processor, by the backup HSM, the generated master key shares to the backup utility.
D117. The medium of embodiment D116, wherein the backup HSM is a PCIe appliance.
D118. The medium of embodiment D116, wherein the hosting HSM is a USB appliance communicatively coupled to the backup HSM via USB.
D119. The medium of embodiment D116, wherein the key backup request is an API call to a method exposed by the secure firmware key backup component.
D120. The medium of embodiment D116, wherein the public key encryption key and the corresponding private key decryption key are predefined for the backup HSM.
D121. The medium of embodiment D116, wherein the public key encryption key and the corresponding private key decryption key are generated dynamically each time a key backup is executed.
D122. The medium of embodiment D116, wherein the secret sharing method is Shamir's Secret Sharing.
D123. The medium of embodiment D116, further, comprising:
   the secure firmware key backup component, stored in the medium, includes processor-issuable instructions to:
      determine, via at least one processor, by the backup HSM, a specified number of master key shares sufficient to recover the master key; and
      wherein the master key shares are generated using the secret sharing method based on the determined number of master key shares sufficient to recover the master key.
D124. The medium of embodiment D116, further, comprising:
   a backup utility key backup component in the component collection, and
   the backup utility key backup component, stored in the medium, includes processor-issuable instructions to:
      generate, via at least one processor, backup materials from the generated master key shares.
D125. The medium of embodiment D124, wherein the backup materials are any of: paper printouts, metal plates, plastic plates, USB keys, hard drives, solid state drives, portable HSMs.
D126. The medium of embodiment D124, wherein the backup materials are distributed for storage in geographically distributed backup locations.
D127. The medium of embodiment D126, wherein each geographic backup location stores a mixture of different types of backup materials.
D128. The medium of embodiment D116, further, comprising:
   a secure firmware key recovery component in the component collection, and
   the secure firmware key recovery component, stored in the medium, includes processor-issuable instructions to:
      receive, via at least one processor, by a second backup HSM, a key recovery request from a recovery utility, wherein the key recovery request includes a set of master key shares sufficient to recover the master key, wherein the key recovery request includes a second public key encryption key provided by a second hosting HSM, wherein the second public key encryption key corresponds to a second private key decryption key stored in tamper-proof storage of the second hosting HSM;
      recover, via at least one processor, by the second backup HSM, the master key from the set of master key shares using the secret sharing method;
      encrypt, via at least one processor, by the second backup HSM, the recovered master key using the second public key encryption key; and
      provide, via at least one processor, by the second backup HSM, the encrypted recovered master key to the recovery utility.
D129. The medium of embodiment D128, wherein the backup HSM and the second backup HSM are the same HSM.
D130. The medium of embodiment D128, wherein the hosting HSM and the second hosting HSM are the same HSM.
D131. A processor-implemented secure firmware key backup system, comprising:
   a secure firmware key backup component means implemented by a backup hardware security module (HSM), to:
      receive, via at least one processor, by the backup HSM, a key backup request from a backup utility, wherein the key backup request includes an encrypted master key associated with a hosting HSM;
      retrieve, via at least one processor, from the backup HSM's tamper-proof storage, a private key decryption key corresponding to a public key encryption key previously provided by the backup HSM to the backup utility for the hosting HSM, wherein the encrypted master key is encrypted using the public key encryption key by the hosting HSM;
      decrypt, via at least one processor, by the backup HSM, the encrypted master key using the retrieved private key decryption key;
      determine, via at least one processor, by the backup HSM, a specified number of master key shares to generate for the decrypted master key;
      generate, via at least one processor, by the backup HSM, the specified number of master key shares using a secret sharing method; and
      provide, via at least one processor, by the backup HSM, the generated master key shares to the backup utility.
D132. The system of embodiment D131, wherein the backup HSM is a PCIe appliance.
D133. The system of embodiment D131, wherein the hosting HSM is a USB appliance communicatively coupled to the backup HSM via USB.
D134. The system of embodiment D131, wherein the key backup request is an API call to a method exposed by the secure firmware key backup component.
D135. The system of embodiment D131, wherein the public key encryption key and the corresponding private key decryption key are predefined for the backup HSM.
D136. The system of embodiment D131, wherein the public key encryption key and the corresponding private key decryption key are generated dynamically each time a key backup is executed.
D137. The system of embodiment D131, wherein the secret sharing method is Shamir's Secret Sharing.
D138. The system of embodiment D131, further, comprising:
   the secure firmware key backup component means, to:
      determine, via at least one processor, by the backup HSM, a specified number of master key shares sufficient to recover the master key; and
      wherein the master key shares are generated using the secret sharing method based on the determined number of master key shares sufficient to recover the master key.
D139. The system of embodiment D131, further, comprising:
   a backup utility key backup component means, to:
      generate, via at least one processor, backup materials from the generated master key shares.
D140. The system of embodiment D139, wherein the backup materials are any of: paper printouts, metal plates, plastic plates, USB keys, hard drives, solid state drives, portable HSMs.
D141. The system of embodiment D139, wherein the backup materials are distributed for storage in geographically distributed backup locations.
D142. The system of embodiment D141, wherein each geographic backup location stores a mixture of different types of backup materials.
D143. The system of embodiment D131, further, comprising:
   a secure firmware key recovery component means, to:
      receive, via at least one processor, by a second backup HSM, a key recovery request from a recovery utility, wherein the key recovery request includes a set of master key shares sufficient to recover the master key, wherein the key recovery request includes a second public key encryption key provided by a second hosting HSM, wherein the second public key encryption key corresponds to a second private key decryption key stored in tamper-proof storage of the second hosting HSM;
      recover, via at least one processor, by the second backup HSM, the master key from the set of master key shares using the secret sharing method;
      encrypt, via at least one processor, by the second backup HSM, the recovered master key using the second public key encryption key; and
      provide, via at least one processor, by the second backup HSM, the encrypted recovered master key to the recovery utility.
D144. The system of embodiment D143, wherein the backup HSM and the second backup HSM are the same HSM.
D145. The system of embodiment D143, wherein the hosting HSM and the second hosting HSM are the same HSM.
D146. A processor-implemented secure firmware key backup method, comprising:
   executing processor-implemented secure firmware key backup component instructions to:
      receive, via at least one processor, by the backup HSM, a key backup request from a backup utility, wherein the key backup request includes an encrypted master key associated with a hosting HSM;
      retrieve, via at least one processor, from the backup HSM's tamper-proof storage, a private key decryption key corresponding to a public key encryption key previously provided by the backup HSM to the backup utility for the hosting HSM, wherein the encrypted master key is encrypted using the public key encryption key by the hosting HSM;
      decrypt, via at least one processor, by the backup HSM, the encrypted master key using the retrieved private key decryption key;
      determine, via at least one processor, by the backup HSM, a specified number of master key shares to generate for the decrypted master key;
      generate, via at least one processor, by the backup HSM, the specified number of master key shares using a secret sharing method; and
      provide, via at least one processor, by the backup HSM, the generated master key shares to the backup utility.
D147. The method of embodiment D146, wherein the backup HSM is a PCIe appliance.
D148. The method of embodiment D146, wherein the hosting HSM is a USB appliance communicatively coupled to the backup HSM via USB.
D149. The method of embodiment D146, wherein the key backup request is an API call to a method exposed by the secure firmware key backup component.
D150. The method of embodiment D146, wherein the public key encryption key and the corresponding private key decryption key are predefined for the backup HSM.
D151. The method of embodiment D146, wherein the public key encryption key and the corresponding private key decryption key are generated dynamically each time a key backup is executed.
D152. The method of embodiment D146, wherein the secret sharing method is Shamir's Secret Sharing.
D153. The method of embodiment D146, further, comprising:
   executing processor-implemented secure firmware key backup component instructions to:
      determine, via at least one processor, by the backup HSM, a specified number of master key shares sufficient to recover the master key; and
      wherein the master key shares are generated using the secret sharing method based on the determined number of master key shares sufficient to recover the master key.
D154. The method of embodiment D146, further, comprising:
   executing processor-implemented backup utility key backup component instructions to:
      generate, via at least one processor, backup materials from the generated master key shares.
D155. The method of embodiment D154, wherein the backup materials are any of: paper printouts, metal plates, plastic plates, USB keys, hard drives, solid state drives, portable HSMs.
D156. The method of embodiment D154, wherein the backup materials are distributed for storage in geographically distributed backup locations.
D157. The method of embodiment D156, wherein each geographic backup location stores a mixture of different types of backup materials.
D158. The method of embodiment D146, further, comprising:
   executing processor-implemented secure firmware key recovery component instructions to:
      receive, via at least one processor, by a second backup HSM, a key recovery request from a recovery utility, wherein the key recovery request includes a set of master key shares sufficient to recover the master key, wherein the key recovery request includes a second public key encryption key provided by a second hosting HSM, wherein the second public key encryption key corresponds to a second private key decryption key stored in tamper-proof storage of the second hosting HSM;
      recover, via at least one processor, by the second backup HSM, the master key from the set of master key shares using the secret sharing method;
      encrypt, via at least one processor, by the second backup HSM, the recovered master key using the second public key encryption key; and
      provide, via at least one processor, by the second backup HSM, the encrypted recovered master key to the recovery utility.
D159. The method of embodiment D158, wherein the backup HSM and the second backup HSM are the same HSM.
D160. The method of embodiment D158, wherein the hosting HSM and the second hosting HSM are the same HSM.
D171. The apparatus of embodiment D113, wherein the second backup HSM requires the set of master key shares to include a first specified number of master key shares stored on any physical backup materials and a second specified number of master key shares stored on any digital backup materials.
D172. The apparatus of embodiment D113, wherein the second backup HSM requires the set of master key shares to include a first specified number of master key shares stored on specified physical backup materials and a second specified number of master key shares stored on specified digital backup materials.
D173. The medium of embodiment D128, wherein the second backup HSM requires the set of master key shares to include a first specified number of master key shares stored on any physical backup materials and a second specified number of master key shares stored on any digital backup materials.
D174. The medium of embodiment D128, wherein the second backup HSM requires the set of master key shares to include a first specified number of master key shares stored on specified physical backup materials and a second specified number of master key shares stored on specified digital backup materials.
D175. The system of embodiment D143, wherein the second backup HSM requires the set of master key shares to include a first specified number of master key shares stored on any physical backup materials and a second specified number of master key shares stored on any digital backup materials.
D176. The system of embodiment D143, wherein the second backup HSM requires the set of master key shares to include a first specified number of master key shares stored on specified physical backup materials and a second specified number of master key shares stored on specified digital backup materials.
D177. The method of embodiment D158, wherein the second backup HSM requires the set of master key shares to include a first specified number of master key shares stored on any physical backup materials and a second specified number of master key shares stored on any digital backup materials.
D178. The method of embodiment D158, wherein the second backup HSM requires the set of master key shares to include a first specified number of master key shares stored on specified physical backup materials and a second specified number of master key shares stored on specified digital backup materials.
D201. A transaction signing apparatus, comprising:
a memory;
a component collection in the memory, including:
   a secure firmware transaction signing component implemented by a first hardware security module (HSM);
a processor disposed in communication with the memory, and configured to issue a plurality of processing instructions from the component collection stored in the memory,
   wherein the processor issues instructions from the secure firmware transaction signing component, stored in the memory, to:
      receive, via at least one processor, by the first HSM, a transaction signing request message for a transaction from a transaction signing server (TSS), wherein the transaction signing request message includes an encrypted second master key share associated with a second HSM;
      retrieve, via at least one processor, from the first HSM's tamper-proof storage, a private key decryption key corresponding to a public key encryption key previously provided by the first HSM to the TSS for the second HSM, wherein the encrypted second master key share is encrypted using the public key encryption key by the second HSM;
      decrypt, via at least one processor, by the first HSM, the encrypted second master key share using the retrieved private key decryption key;
      retrieve, via at least one processor, from the first HSM's tamper-proof storage, a first master key share;
      recover, via at least one processor, by the first HSM, a master private key from the first master key share and the decrypted second master key share using a secret sharing method;
      determine, via at least one processor, by the first HSM, a transaction hash and a keychain path associated with the transaction signing request message;
      generate, via at least one processor, by the first HSM, a signing private key for the determined keychain path using the recovered master private key;
      sign, via at least one processor, by the first HSM, the determined transaction hash using the generated signing private key to generate a signature; and
      return, via at least one processor, the generated signature.
D202. The apparatus of embodiment D201, wherein the first HSM is a PCIe appliance.
D203. The apparatus of embodiment D201, wherein the second HSM is a USB appliance communicatively coupled to the TSS via USB.
D204. The apparatus of embodiment D201, wherein the second HSM includes an authentication entry device.
D205. The apparatus of embodiment D204, wherein the second HSM provides the encrypted second master key share to the TSS upon obtaining separate credentials via the authentication entry device from a predetermined number of people.
D206. The apparatus of embodiment D205, wherein the second HSM enforces M-of-N security policy for exporting the encrypted second master key share, wherein access to the second HSM is controlled by M-of-N authentication policy.
D207. The apparatus of embodiment D201, wherein the private key decryption key and the public key encryption key are predefined for the first HSM.
D208. The apparatus of embodiment D201, wherein the private key decryption key and the public key encryption key are generated dynamically each time a transaction signing request message is received.
D209. The apparatus of embodiment D201, wherein the transaction signing request message is an API call to a method exposed by the secure firmware transaction signing component.
D210. The apparatus of embodiment D201, wherein the secret sharing method is Shamir's Secret Sharing.
D211. The apparatus of embodiment D201, wherein the signing private key is generated using a Bip32-based deterministic key derivation procedure.
D212. The apparatus of embodiment D201, further, comprising:
   the processor issues instructions from the secure firmware transaction signing component, stored in the memory, to:
      wipe, via at least one processor, temporary private key data from the memory after generating the signature.
D213. The apparatus of embodiment D212, wherein the temporary private key data includes the private key decryption key, the public key encryption key, the encrypted second master key share, the decrypted second master key share, the recovered master private key, and the generated signing private key.
D214. The apparatus of embodiment D201, wherein the transaction hash is signed in accordance with the hashing algorithm utilized by the Bitcoin protocol.
D215. The apparatus of embodiment D201, wherein the signature is returned in Distinguished Encoding Rules format.
D216. A processor-readable transaction signing non-transient physical medium storing processor-executable components, the components, comprising:
a component collection stored in the medium, including:
   a secure firmware transaction signing component implemented by a first hardware security module (HSM);
   wherein the secure firmware transaction signing component, stored in the medium, includes processor-issuable instructions to:
      receive, via at least one processor, by the first HSM, a transaction signing request message for a transaction from a transaction signing server (TSS), wherein the transaction signing request message includes an encrypted second master key share associated with a second HSM;
      retrieve, via at least one processor, from the first HSM's tamper-proof storage, a private key decryption key corresponding to a public key encryption key previously provided by the first HSM to the TSS for the second HSM, wherein the encrypted second master key share is encrypted using the public key encryption key by the second HSM;
      decrypt, via at least one processor, by the first HSM, the encrypted second master key share using the retrieved private key decryption key;
      retrieve, via at least one processor, from the first HSM's tamper-proof storage, a first master key share;
      recover, via at least one processor, by the first HSM, a master private key from the first master key share and the decrypted second master key share using a secret sharing method;
      determine, via at least one processor, by the first HSM, a transaction hash and a keychain path associated with the transaction signing request message;
      generate, via at least one processor, by the first HSM, a signing private key for the determined keychain path using the recovered master private key;
      sign, via at least one processor, by the first HSM, the determined transaction hash using the generated signing private key to generate a signature; and
      return, via at least one processor, the generated signature.
D217. The medium of embodiment D216, wherein the first HSM is a PCIe appliance.
D218. The medium of embodiment D216, wherein the second HSM is a USB appliance communicatively coupled to the TSS via USB.
D219. The medium of embodiment D216, wherein the second HSM includes an authentication entry device.
D220. The medium of embodiment D219, wherein the second HSM provides the encrypted second master key share to the TSS upon obtaining separate credentials via the authentication entry device from a predetermined number of people.
D221. The medium of embodiment D220, wherein the second HSM enforces M-of-N security policy for exporting the encrypted second master key share, wherein access to the second HSM is controlled by M-of-N authentication policy.
D222. The medium of embodiment D216, wherein the private key decryption key and the public key encryption key are predefined for the first HSM.
D223. The medium of embodiment D216, wherein the private key decryption key and the public key encryption key are generated dynamically each time a transaction signing request message is received.
D224. The medium of embodiment D216, wherein the transaction signing request message is an API call to a method exposed by the secure firmware transaction signing component.
D225. The medium of embodiment D216, wherein the secret sharing method is Shamir's Secret Sharing.
D226. The medium of embodiment D216, wherein the signing private key is generated using a Bip32-based deterministic key derivation procedure.
D227. The medium of embodiment D216, further, comprising:
   the secure firmware transaction signing component, stored in the medium, includes processor-issuable instructions to:
      wipe, via at least one processor, temporary private key data from the memory after generating the signature.
D228. The medium of embodiment D227, wherein the temporary private key data includes the private key decryption key, the public key encryption key, the encrypted second master key share, the decrypted second master key share, the recovered master private key, and the generated signing private key.
D229. The medium of embodiment D216, wherein the transaction hash is signed in accordance with the hashing algorithm utilized by the Bitcoin protocol.
D230. The medium of embodiment D216, wherein the signature is returned in Distinguished Encoding Rules format.
D231. A processor-implemented transaction signing system, comprising:
   secure firmware transaction signing component means implemented by a first hardware security module (HSM), to:
      receive, via at least one processor, by the first HSM, a transaction signing request message for a transaction from a transaction signing server (TSS), wherein the transaction signing request message includes an encrypted second master key share associated with a second HSM;
      retrieve, via at least one processor, from the first HSM's tamper-proof storage, a private key decryption key corresponding to a public key encryption key previously provided by the first HSM to the TSS for the second HSM, wherein the encrypted second master key share is encrypted using the public key encryption key by the second HSM;
      decrypt, via at least one processor, by the first HSM, the encrypted second master key share using the retrieved private key decryption key;
      retrieve, via at least one processor, from the first HSM's tamper-proof storage, a first master key share;
      recover, via at least one processor, by the first HSM, a master private key from the first master key share and the decrypted second master key share using a secret sharing method;
      determine, via at least one processor, by the first HSM, a transaction hash and a keychain path associated with the transaction signing request message;
      generate, via at least one processor, by the first HSM, a signing private key for the determined keychain path using the recovered master private key;
      sign, via at least one processor, by the first HSM, the determined transaction hash using the generated signing private key to generate a signature; and
      return, via at least one processor, the generated signature.
D232. The system of embodiment D231, wherein the first HSM is a PCIe appliance.
D233. The system of embodiment D231, wherein the second HSM is a USB appliance communicatively coupled to the TSS via USB.
D234. The system of embodiment D231, wherein the second HSM includes an authentication entry device.
D235. The system of embodiment D234, wherein the second HSM provides the encrypted second master key share to the TSS upon obtaining separate credentials via the authentication entry device from a predetermined number of people.
D236. The system of embodiment D235, wherein the second HSM enforces M-of-N security policy for exporting the encrypted second master key share, wherein access to the second HSM is controlled by M-of-N authentication policy.
D237. The system of embodiment D231, wherein the private key decryption key and the public key encryption key are predefined for the first HSM.
D238. The system of embodiment D231, wherein the private key decryption key and the public key encryption key are generated dynamically each time a transaction signing request message is received.
D239. The system of embodiment D231, wherein the transaction signing request message is an API call to a method exposed by the secure firmware transaction signing component.
D240. The system of embodiment D231, wherein the secret sharing method is Shamir's Secret Sharing.
D241. The system of embodiment D231, wherein the signing private key is generated using a Bip32-based deterministic key derivation procedure.
D242. The system of embodiment D231, further, comprising:
   secure firmware transaction signing component means, to:
      wipe, via at least one processor, temporary private key data from the memory after generating the signature.
D243. The system of embodiment D242, wherein the temporary private key data includes the private key decryption key, the public key encryption key, the encrypted second master key share, the decrypted second master key share, the recovered master private key, and the generated signing private key.
D244. The system of embodiment D231, wherein the transaction hash is signed in accordance with the hashing algorithm utilized by the Bitcoin protocol.
D245. The system of embodiment D231, wherein the signature is returned in Distinguished Encoding Rules format.
D246. A processor-implemented transaction signing method, comprising:
   executing processor-implemented secure firmware transaction signing component instructions implemented by a first hardware security module (HSM), to:
      receive, via at least one processor, by the first HSM, a transaction signing request message for a transaction from a transaction signing server (TSS), wherein the transaction signing request message includes an encrypted second master key share associated with a second HSM;
      retrieve, via at least one processor, from the first HSM's tamper-proof storage, a private key decryption key corresponding to a public key encryption key previously provided by the first HSM to the TSS for the second HSM, wherein the encrypted second master key share is encrypted using the public key encryption key by the second HSM;
      decrypt, via at least one processor, by the first HSM, the encrypted second master key share using the retrieved private key decryption key;
      retrieve, via at least one processor, from the first HSM's tamper-proof storage, a first master key share;
      recover, via at least one processor, by the first HSM, a master private key from the first master key share and the decrypted second master key share using a secret sharing method;
      determine, via at least one processor, by the first HSM, a transaction hash and a keychain path associated with the transaction signing request message;
      generate, via at least one processor, by the first HSM, a signing private key for the determined keychain path using the recovered master private key;
      sign, via at least one processor, by the first HSM, the determined transaction hash using the generated signing private key to generate a signature; and
      return, via at least one processor, the generated signature.
D247. The method of embodiment D246, wherein the first HSM is a PCIe appliance.
D248. The method of embodiment D246, wherein the second HSM is a USB appliance communicatively coupled to the TSS via USB.
D249. The method of embodiment D246, wherein the second HSM includes an authentication entry device.
D250. The method of embodiment D249, wherein the second HSM provides the encrypted second master key share to the TSS upon obtaining separate credentials via the authentication entry device from a predetermined number of people.
D251. The method of embodiment D250, wherein the second HSM enforces M-of-N security policy for exporting the encrypted second master key share, wherein access to the second HSM is controlled by M-of-N authentication policy.
D252. The method of embodiment D246, wherein the private key decryption key and the public key encryption key are predefined for the first HSM.
D253. The method of embodiment D246, wherein the private key decryption key and the public key encryption key are generated dynamically each time a transaction signing request message is received.
D254. The method of embodiment D246, wherein the transaction signing request message is an API call to a method exposed by the secure firmware transaction signing component.
D255. The method of embodiment D246, wherein the secret sharing method is Shamir's Secret Sharing.
D256. The method of embodiment D246, wherein the signing private key is generated using a Bip32-based deterministic key derivation procedure.
D257. The method of embodiment D246, further, comprising:
   executing processor-implemented secure firmware transaction signing component instructions to:
      wipe, via at least one processor, temporary private key data from the memory after generating the signature.
D258. The method of embodiment D257, wherein the temporary private key data includes the private key decryption key, the public key encryption key, the encrypted second master key share, the decrypted second master key share, the recovered master private key, and the generated signing private key.
D259. The method of embodiment D246, wherein the transaction hash is signed in accordance with the hashing algorithm utilized by the Bitcoin protocol.
D260. The method of embodiment D246, wherein the signature is returned in Distinguished Encoding Rules format.
D301. A transaction signing apparatus, comprising:
a memory;
a component collection in the memory, including:
   a hot secure firmware transaction signing component implemented by a hot hardware security module (HSM), and
   a cold secure firmware transaction signing component implemented by a first cold HSM;
a processor disposed in communication with the memory, and configured to issue a plurality of processing instructions from the component collection stored in the memory,
   wherein the processor issues instructions from the hot secure firmware transaction signing component, stored in the memory, to:
      receive, via at least one processor, by the hot HSM, an online transaction signing request message for a transaction from an online transaction signing server (TSS);
      retrieve, via at least one processor, from the hot HSM's tamper-proof storage, a third master key share;
      determine, via at least one processor, by the hot HSM, a public key encryption key of the first cold HSM;
      encrypt, via at least one processor, by the hot HSM, the third master key share using the public key encryption key of the first cold HSM; and
      return, via at least one processor, the encrypted third master key share to the online TSS for transfer to an offline TSS;
   wherein the processor issues instructions from the cold secure firmware transaction signing component, stored in the memory, to:
      receive, via at least one processor, by the first cold HSM, an offline transaction signing request message for the transaction from the offline TSS, wherein the offline transaction signing request message includes: an encrypted second master key share associated with a second cold HSM and the encrypted third master key share associated with the hot HSM;
      retrieve, via at least one processor, from the first cold HSM's tamper-proof storage, a private key decryption key of the first cold HSM corresponding to the public key encryption key of the first cold HSM previously provided to the second cold HSM and to the hot HSM, wherein the encrypted second master key share is encrypted using the public key encryption key of the first cold HSM by the second cold HSM;
      decrypt, via at least one processor, by the first cold HSM, the encrypted second master key share and the encrypted third master key share using the retrieved private key decryption key of the first cold HSM;
      retrieve, via at least one processor, from the first cold HSM's tamper-proof storage, a first master key share;
      recover, via at least one processor, by the first cold HSM, a master private key from the first master key share, the decrypted second master key share and the decrypted third master key share using a secret sharing method;
      determine, via at least one processor, by the first cold HSM, a keychain path associated with the offline transaction signing request message;
      generate, via at least one processor, by the first cold HSM, a signing private key for the determined keychain path using the recovered master private key;
      sign, via at least one processor, by the first cold HSM, the transaction using the generated signing private key to generate a signature; and
      return, via at least one processor, the generated signature.
D302. The apparatus of embodiment D301, further, comprising:
   the processor issues instructions from the hot secure firmware transaction signing component, stored in the memory, to:
      determine, via at least one processor, by the hot HSM, transaction data associated with the transaction;
      retrieve, via at least one processor, from the hot HSM's tamper-proof storage, a private signing key corresponding to a public signing key of the hot HSM previously provided to the first cold HSM;
      sign, via at least one processor, by the hot HSM, the transaction data; and
      return, via at least one processor, the signed transaction data to the online TSS for transfer to the offline TSS.
D303. The apparatus of embodiment D302, further, comprising:
   the processor issues instructions from the cold secure firmware transaction signing component, stored in the memory, to:
      verify, via at least one processor, by the first cold HSM, the signed transaction data using the public signing key of the hot HSM.
D304. The apparatus of embodiment D301, wherein an external storage device is utilized to transfer the encrypted third master key share from the online TSS to the offline TSS.
D305. The apparatus of embodiment D301, wherein the hot HSM and the first cold HSM are PCIe appliances.
D306. The apparatus of embodiment D301, wherein the second cold HSM is a USB appliance communicatively coupled to the first cold HSM via USB.
D307. The apparatus of embodiment D301, wherein the second cold HSM includes an authentication entry device.
D308. The apparatus of embodiment D307, wherein the second cold HSM provides the encrypted second master key share to the offline TSS upon obtaining separate credentials via the authentication entry device from a predetermined number of people.
D309. The apparatus of embodiment D308, wherein the second cold HSM enforces M-of-N security policy for exporting the encrypted second master key share, wherein access to the second cold HSM is controlled by M-of-N authentication policy.
D310. The apparatus of embodiment D301, wherein the private key decryption key of the first cold HSM and the public key encryption key of the first cold HSM are predefined.
D311. The apparatus of embodiment D301, wherein the private key decryption key of the first cold HSM and the public key encryption key of the first cold HSM are generated dynamically for each transaction.
D312. The apparatus of embodiment D301, wherein the secret sharing method is Shamir's Secret Sharing.
D313. The apparatus of embodiment D301, further, comprising:
   the processor issues instructions from the cold secure firmware transaction signing component, stored in the memory, to:
      wipe, via at least one processor, temporary key data from the memory of the first cold HSM after generating the signature.
D314. The apparatus of embodiment D313, wherein the temporary key data includes the encrypted second master key share, the decrypted second master key share, the encrypted third master key share, the decrypted third master key share, the recovered master private key, and the generated signing private key.
D315. The apparatus of embodiment D301, wherein the signature is returned in Distinguished Encoding Rules format.
D316. A processor-readable transaction signing non-transient physical medium storing processor-executable components, the components, comprising:
a component collection stored in the medium, including:
   a hot secure firmware transaction signing component implemented by a hot hardware security module (HSM), and
   a cold secure firmware transaction signing component implemented by a first cold HSM;
   wherein the hot secure firmware transaction signing component, stored in the medium, includes processor-issuable instructions to:
      receive, via at least one processor, by the hot HSM, an online transaction signing request message for a transaction from an online transaction signing server (TSS);
      retrieve, via at least one processor, from the hot HSM's tamper-proof storage, a third master key share;
      determine, via at least one processor, by the hot HSM, a public key encryption key of the first cold HSM;
      encrypt, via at least one processor, by the hot HSM, the third master key share using the public key encryption key of the first cold HSM; and
      return, via at least one processor, the encrypted third master key share to the online TSS for transfer to an offline TSS;
   wherein the cold secure firmware transaction signing component, stored in the medium, includes processor-issuable instructions to:
      receive, via at least one processor, by the first cold HSM, an offline transaction signing request message for the transaction from the offline TSS, wherein the offline transaction signing request message includes: an encrypted second master key share associated with a second cold HSM and the encrypted third master key share associated with the hot HSM;
      retrieve, via at least one processor, from the first cold HSM's tamper-proof storage, a private key decryption key of the first cold HSM corresponding to the public key encryption key of the first cold HSM previously provided to the second cold HSM and to the hot HSM, wherein the encrypted second master key share is encrypted using the public key encryption key of the first cold HSM by the second cold HSM;
      decrypt, via at least one processor, by the first cold HSM, the encrypted second master key share and the encrypted third master key share using the retrieved private key decryption key of the first cold HSM;
      retrieve, via at least one processor, from the first cold HSM's tamper-proof storage, a first master key share;
      recover, via at least one processor, by the first cold HSM, a master private key from the first master key share, the decrypted second master key share and the decrypted third master key share using a secret sharing method;
      determine, via at least one processor, by the first cold HSM, a keychain path associated with the offline transaction signing request message;
      generate, via at least one processor, by the first cold HSM, a signing private key for the determined keychain path using the recovered master private key;
      sign, via at least one processor, by the first cold HSM, the transaction using the generated signing private key to generate a signature; and
      return, via at least one processor, the generated signature.
D317. The medium of embodiment D316, further, comprising:
   the hot secure firmware transaction signing component, stored in the medium, includes processor-issuable instructions to:
      determine, via at least one processor, by the hot HSM, transaction data associated with the transaction;
      retrieve, via at least one processor, from the hot HSM's tamper-proof storage, a private signing key corresponding to a public signing key of the hot HSM previously provided to the first cold HSM;
      sign, via at least one processor, by the hot HSM, the transaction data; and
      return, via at least one processor, the signed transaction data to the online TSS for transfer to the offline TSS.
D318. The medium of embodiment D317, further, comprising:
   the cold secure firmware transaction signing component, stored in the medium, includes processor-issuable instructions to:
      verify, via at least one processor, by the first cold HSM, the signed transaction data using the public signing key of the hot HSM.
D319. The medium of embodiment D316, wherein an external storage device is utilized to transfer the encrypted third master key share from the online TSS to the offline TSS.
D320. The medium of embodiment D316, wherein the hot HSM and the first cold HSM are PCIe appliances.
D321. The medium of embodiment D316, wherein the second cold HSM is a USB appliance communicatively coupled to the first cold HSM via USB.
D322. The medium of embodiment D316, wherein the second cold HSM includes an authentication entry device.
D323. The medium of embodiment D322, wherein the second cold HSM provides the encrypted second master key share to the offline TSS upon obtaining separate credentials via the authentication entry device from a predetermined number of people.
D324. The medium of embodiment D323, wherein the second cold HSM enforces M-of-N security policy for exporting the encrypted second master key share, wherein access to the second cold HSM is controlled by M-of-N authentication policy.
D325. The medium of embodiment D316, wherein the private key decryption key of the first cold HSM and the public key encryption key of the first cold HSM are predefined.
D326. The medium of embodiment D316, wherein the private key decryption key of the first cold HSM and the public key encryption key of the first cold HSM are generated dynamically for each transaction.
D327. The medium of embodiment D316, wherein the secret sharing method is Shamir's Secret Sharing.
D328. The medium of embodiment D316, further, comprising:
the cold secure firmware transaction signing component, stored in the medium, includes processor-issuable instructions to:
   wipe, via at least one processor, temporary key data from the memory of the first cold HSM after generating the signature.
D329. The medium of embodiment D328, wherein the temporary key data includes the encrypted second master key share, the decrypted second master key share, the encrypted third master key share, the decrypted third master key share, the recovered master private key, and the generated signing private key.
D330. The medium of embodiment D316, wherein the signature is returned in Distinguished Encoding Rules format.
D331. A processor-implemented transaction signing system, comprising:
   a hot secure firmware transaction signing component means, to:
      receive, via at least one processor, by the hot HSM, an online transaction signing request message for a transaction from an online transaction signing server (TSS);
      retrieve, via at least one processor, from the hot HSM's tamper-proof storage, a third master key share;
      determine, via at least one processor, by the hot HSM, a public key encryption key of the first cold HSM;
      encrypt, via at least one processor, by the hot HSM, the third master key share using the public key encryption key of the first cold HSM; and
      return, via at least one processor, the encrypted third master key share to the online TSS for transfer to an offline TSS;
   a cold secure firmware transaction signing component means, to:
      receive, via at least one processor, by the first cold HSM, an offline transaction signing request message for the transaction from the offline TSS, wherein the offline transaction signing request message includes: an encrypted second master key share associated with a second cold HSM and the encrypted third master key share associated with the hot HSM;
      retrieve, via at least one processor, from the first cold HSM's tamper-proof storage, a private key decryption key of the first cold HSM corresponding to the public key encryption key of the first cold HSM previously provided to the second cold HSM and to the hot HSM, wherein the encrypted second master key share is encrypted using the public key encryption key of the first cold HSM by the second cold HSM;
      decrypt, via at least one processor, by the first cold HSM, the encrypted second master key share and the encrypted third master key share using the retrieved private key decryption key of the first cold HSM;
      retrieve, via at least one processor, from the first cold HSM's tamper-proof storage, a first master key share;
      recover, via at least one processor, by the first cold HSM, a master private key from the first master key share, the decrypted second master key share and the decrypted third master key share using a secret sharing method;
      determine, via at least one processor, by the first cold HSM, a keychain path associated with the offline transaction signing request message;
      generate, via at least one processor, by the first cold HSM, a signing private key for the determined keychain path using the recovered master private key;
      sign, via at least one processor, by the first cold HSM, the transaction using the generated signing private key to generate a signature; and
      return, via at least one processor, the generated signature.
D332. The system of embodiment D331, further, comprising:
the hot secure firmware transaction signing component means, to:
   determine, via at least one processor, by the hot HSM, transaction data associated with the transaction;
   retrieve, via at least one processor, from the hot HSM's tamper-proof storage, a private signing key corresponding to a public signing key of the hot HSM previously provided to the first cold HSM;
   sign, via at least one processor, by the hot HSM, the transaction data; and
   return, via at least one processor, the signed transaction data to the online TSS for transfer to the offline TSS.
D333. The system of embodiment D332, further, comprising:
   the cold secure firmware transaction signing component means, to:
      verify, via at least one processor, by the first cold HSM, the signed transaction data using the public signing key of the hot HSM.
D334. The system of embodiment D331, wherein an external storage device is utilized to transfer the encrypted third master key share from the online TSS to the offline TSS.
D335. The system of embodiment D331, wherein the hot HSM and the first cold HSM are PCIe appliances.
D336. The system of embodiment D331, wherein the second cold HSM is a USB appliance communicatively coupled to the first cold HSM via USB.
D337. The system of embodiment D331, wherein the second cold HSM includes an authentication entry device.
D338. The system of embodiment D337, wherein the second cold HSM provides the encrypted second master key share to the offline TSS upon obtaining separate credentials via the authentication entry device from a predetermined number of people.
D339. The system of embodiment D338, wherein the second cold HSM enforces M-of-N security policy for exporting the encrypted second master key share, wherein access to the second cold HSM is controlled by M-of-N authentication policy.
D340. The system of embodiment D331, wherein the private key decryption key of the first cold HSM and the public key encryption key of the first cold HSM are predefined.
D341. The system of embodiment D331, wherein the private key decryption key of the first cold HSM and the public key encryption key of the first cold HSM are generated dynamically for each transaction.
D342. The system of embodiment D331, wherein the secret sharing method is Shamir's Secret Sharing.
D343. The system of embodiment D331, further, comprising:
   the cold secure firmware transaction signing component means, to:
      wipe, via at least one processor, temporary key data from the memory of the first cold HSM after generating the signature.
D344. The system of embodiment D343, wherein the temporary key data includes the encrypted second master key share, the decrypted second master key share, the encrypted third master key share, the decrypted third master key share, the recovered master private key, and the generated signing private key.
D345. The system of embodiment D331, wherein the signature is returned in Distinguished Encoding Rules format.
D346. A processor-implemented transaction signing method, comprising:
   executing processor-implemented hot secure firmware transaction signing component instructions to:
      receive, via at least one processor, by the hot HSM, an online transaction signing request message for a transaction from an online transaction signing server (TSS);
      retrieve, via at least one processor, from the hot HSM's tamper-proof storage, a third master key share;
      determine, via at least one processor, by the hot HSM, a public key encryption key of the first cold HSM;
      encrypt, via at least one processor, by the hot HSM, the third master key share using the public key encryption key of the first cold HSM; and
      return, via at least one processor, the encrypted third master key share to the online TSS for transfer to an offline TSS;
   executing processor-implemented cold secure firmware transaction signing component instructions to:
      receive, via at least one processor, by the first cold HSM, an offline transaction signing request message for the transaction from the offline TSS, wherein the offline transaction signing request message includes: an encrypted second master key share associated with a second cold HSM and the encrypted third master key share associated with the hot HSM;
      retrieve, via at least one processor, from the first cold HSM's tamper-proof storage, a private key decryption key of the first cold HSM corresponding to the public key encryption key of the first cold HSM previously provided to the second cold HSM and to the hot HSM, wherein the encrypted second master key share is encrypted using the public key encryption key of the first cold HSM by the second cold HSM;
      decrypt, via at least one processor, by the first cold HSM, the encrypted second master key share and the encrypted third master key share using the retrieved private key decryption key of the first cold HSM;
      retrieve, via at least one processor, from the first cold HSM's tamper-proof storage, a first master key share;
      recover, via at least one processor, by the first cold HSM, a master private key from the first master key share, the decrypted second master key share and the decrypted third master key share using a secret sharing method;
      determine, via at least one processor, by the first cold HSM, a keychain path associated with the offline transaction signing request message;
      generate, via at least one processor, by the first cold HSM, a signing private key for the determined keychain path using the recovered master private key;
      sign, via at least one processor, by the first cold HSM, the transaction using the generated signing private key to generate a signature; and
      return, via at least one processor, the generated signature.
D347. The method of embodiment D346, further, comprising:
   executing processor-implemented hot secure firmware transaction signing component instructions to:
      determine, via at least one processor, by the hot HSM, transaction data associated with the transaction;
      retrieve, via at least one processor, from the hot HSM's tamper-proof storage, a private signing key corresponding to a public signing key of the hot HSM previously provided to the first cold HSM;
      sign, via at least one processor, by the hot HSM, the transaction data; and
      return, via at least one processor, the signed transaction data to the online TSS for transfer to the offline TSS.
D348. The method of embodiment D347, further, comprising:
   executing processor-implemented cold secure firmware transaction signing component instructions to:
      verify, via at least one processor, by the first cold HSM, the signed transaction data using the public signing key of the hot HSM.
D349. The method of embodiment D346, wherein an external storage device is utilized to transfer the encrypted third master key share from the online TSS to the offline TSS.
D350. The method of embodiment D346, wherein the hot HSM and the first cold HSM are PCIe appliances.
D351. The method of embodiment D346, wherein the second cold HSM is a USB appliance communicatively coupled to the first cold HSM via USB.
D352. The method of embodiment D346, wherein the second cold HSM includes an authentication entry device.
D353. The method of embodiment D352, wherein the second cold HSM provides the encrypted second master key share to the offline TSS upon obtaining separate credentials via the authentication entry device from a predetermined number of people.
D354. The method of embodiment D353, wherein the second cold HSM enforces M-of-N security policy for exporting the encrypted second master key share, wherein access to the second cold HSM is controlled by M-of-N authentication policy.
D355. The method of embodiment D346, wherein the private key decryption key of the first cold HSM and the public key encryption key of the first cold HSM are predefined.
D356. The method of embodiment D346, wherein the private key decryption key of the first cold HSM and the public key encryption key of the first cold HSM are generated dynamically for each transaction.
D357. The method of embodiment D346, wherein the secret sharing method is Shamir's Secret Sharing.
D358. The method of embodiment D346, further, comprising:
   executing processor-implemented cold secure firmware transaction signing component instructions to:
      wipe, via at least one processor, temporary key data from the memory of the first cold HSM after generating the signature.
D359. The method of embodiment D358, wherein the temporary key data includes the encrypted second master key share, the decrypted second master key share, the encrypted third master key share, the decrypted third master key share, the recovered master private key, and the generated signing private key.
D360. The method of embodiment D346, wherein the signature is returned in Distinguished Encoding Rules format.
D401. A verified address smart contract deploying apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via the at least one processor, a contract deployment request message datastructure by a hardware security module (HSM) from a transaction signing server (TSS), in which the contract deployment request message datastructure is structured to specify a set of owner datastructures, a deployment factory address, and contract code for a smart contract;
   determine, via the at least one processor, by the HSM, owner key identification parameters associated with an owner datastructure in the set of owner datastructures, in which the owner key identification parameters are structured to specify a keyset identifier and a keychain path;
   determine, via the at least one processor, by the HSM, an owner public key associated with the owner datastructure using the owner key identification parameters;
   generate, via the at least one processor, by the HSM, an owner address associated with the owner datastructure using the owner public key;
   generate, via the at least one processor, by the HSM, a salt value for the smart contract;
   calculate, via the at least one processor, by the HSM, a contract address for the smart contract as a function of the deployment factory address, the salt value, the contract code, and the owner address;
   determine, via the at least one processor, by the HSM, an owner private key associated with the owner datastructure using the owner key identification parameters, in which the owner private key corresponds to the owner public key;
   sign, via at least one processor, by the HSM, the contract address for the smart contract using the owner private key to generate a contract deployment signature; and
   provide, via at least one processor, by the HSM, a contract deployment data datastructure to the TSS, in which the contract deployment data datastructure is structured to specify the salt value, and the contract deployment signature.
D402. The apparatus of embodiment D401, in which the deployment factory address is a blockchain address of a Contract Factory smart contract on the Ethereum blockchain.
D403. The apparatus of embodiment D401, in which the contract code is structured as a bytecode.
D404. The apparatus of embodiment D401, in which the owner key identification parameters are structured to specify a wallet type.
D405. The apparatus of embodiment D401, in which the owner address is generated using a Bip32-based deterministic key derivation procedure.
D406. The apparatus of embodiment D405, in which the owner address is calculated as the last 20 bytes of Keccak-256 hash of the owner public key.
D407. The apparatus of embodiment D401, in which the salt value is structured as a one-time 32-byte salt value.
D408. The apparatus of embodiment D401, in which the contract address is calculated as an EIP-1014 blockchain address.
D409. The apparatus of embodiment D408, in which the contract address is calculated as the last 20 bytes of Keccak-256 hash of a concatenated list of: 0xFF byte, the deployment factory address, the salt value, and Keccak-256 hash of a concatenated list of: the contract code, and the owner address.
D410. The apparatus of embodiment D401, in which the contract deployment data datastructure is structured to specify the owner address.
D411. The apparatus of embodiment D401, in which the component collection storage is further structured with processor-executable instructions, comprising:
   obtain, via the at least one processor, by the HSM, a transaction signing request message datastructure associated with a transaction, in which the transaction signing request message datastructure is structured to specify a transaction amount, a source wallet datastructure, and a destination wallet datastructure, in which either the source wallet datastructure or the destination wallet datastructure is a verified address wallet datastructure that corresponds to the smart contract;
   determine, via the at least one processor, by the HSM, the owner key identification parameters associated with the verified address wallet datastructure;
   calculate, via the at least one processor, by the HSM, the contract address for the verified address wallet datastructure as a function of the deployment factory address, the salt value, the contract code, and the owner address;
   validate, via the at least one processor, by the HSM, the contract deployment signature associated with the verified address wallet datastructure;
   calculate, via the at least one processor, by the HSM, a transaction hash for the transaction;
   sign, via at least one processor, by the HSM, the transaction hash using a transaction signing private key associated with the owner datastructure to generate a transaction signature; and
   return, via at least one processor, the generated transaction signature.
D412. The apparatus of embodiment D411, in which the instructions to validate the contract deployment signature associated with the verified address wallet datastructure are structured as instructions to also validate other contract deployment signatures associated with the verified address wallet datastructure, in which the other contract deployment signatures are associated with other owner datastructures in the set of owner datastructures.
D413. The apparatus of embodiment D411, in which the owner private key and the transaction signing private key are the same key.
D414. The apparatus of embodiment D411, in which the transaction hash is signed in accordance with a hashing algorithm utilized by the Ethereum protocol.
D415. The apparatus of embodiment D411, in which the transaction signature is returned in Distinguished Encoding Rules format.
D416. A verified address smart contract deploying processor-readable, non-transient medium, the medium storing a component collection, the component collection storage structured with processor-executable instructions comprising:
   obtain, via the at least one processor, a contract deployment request message datastructure by a hardware security module (HSM) from a transaction signing server (TSS), in which the contract deployment request message datastructure is structured to specify a set of owner datastructures, a deployment factory address, and contract code for a smart contract;
   determine, via the at least one processor, by the HSM, owner key identification parameters associated with an owner datastructure in the set of owner datastructures, in which the owner key identification parameters are structured to specify a keyset identifier and a keychain path;
   determine, via the at least one processor, by the HSM, an owner public key associated with the owner datastructure using the owner key identification parameters;
   generate, via the at least one processor, by the HSM, an owner address associated with the owner datastructure using the owner public key;
   generate, via the at least one processor, by the HSM, a salt value for the smart contract;
   calculate, via the at least one processor, by the HSM, a contract address for the smart contract as a function of the deployment factory address, the salt value, the contract code, and the owner address;
   determine, via the at least one processor, by the HSM, an owner private key associated with the owner datastructure using the owner key identification parameters, in which the owner private key corresponds to the owner public key;
   sign, via at least one processor, by the HSM, the contract address for the smart contract using the owner private key to generate a contract deployment signature; and
   provide, via at least one processor, by the HSM, a contract deployment data datastructure to the TSS, in which the contract deployment data datastructure is structured to specify the salt value, and the contract deployment signature.
D417. The medium of embodiment D416, in which the deployment factory address is a blockchain address of a Contract Factory smart contract on the Ethereum blockchain.
D418. The medium of embodiment D416, in which the contract code is structured as a bytecode.
D419. The medium of embodiment D416, in which the owner key identification parameters are structured to specify a wallet type.
D420. The medium of embodiment D416, in which the owner address is generated using a Bip32-based deterministic key derivation procedure.
D421. The medium of embodiment D420, in which the owner address is calculated as the last 20 bytes of Keccak-256 hash of the owner public key.
D422. The medium of embodiment D416, in which the salt value is structured as a one-time 32-byte salt value.
D423. The medium of embodiment D416, in which the contract address is calculated as an EIP-1014 blockchain address.
D424. The medium of embodiment D423, in which the contract address is calculated as the last 20 bytes of Keccak-256 hash of a concatenated list of: 0xFF byte, the deployment factory address, the salt value, and Keccak-256 hash of a concatenated list of: the contract code, and the owner address.
D425. The medium of embodiment D416, in which the contract deployment data datastructure is structured to specify the owner address.
D426. The medium of embodiment D416, in which the component collection storage is further structured with processor-executable instructions, comprising:
   obtain, via the at least one processor, by the HSM, a transaction signing request message datastructure associated with a transaction, in which the transaction signing request message datastructure is structured to specify a transaction amount, a source wallet datastructure, and a destination wallet datastructure, in which either the source wallet datastructure or the destination wallet datastructure is a verified address wallet datastructure that corresponds to the smart contract;
   determine, via the at least one processor, by the HSM, the owner key identification parameters associated with the verified address wallet datastructure;
   calculate, via the at least one processor, by the HSM, the contract address for the verified address wallet datastructure as a function of the deployment factory address, the salt value, the contract code, and the owner address;
   validate, via the at least one processor, by the HSM, the contract deployment signature associated with the verified address wallet datastructure;
   calculate, via the at least one processor, by the HSM, a transaction hash for the transaction;
   sign, via at least one processor, by the HSM, the transaction hash using a transaction signing private key associated with the owner datastructure to generate a transaction signature; and
   return, via at least one processor, the generated transaction signature.
D427. The medium of embodiment D426, in which the instructions to validate the contract deployment signature associated with the verified address wallet datastructure are structured as instructions to also validate other contract deployment signatures associated with the verified address wallet datastructure, in which the other contract deployment signatures are associated with other owner datastructures in the set of owner datastructures.
D428. The medium of embodiment D426, in which the owner private key and the transaction signing private key are the same key.
D429. The medium of embodiment D426, in which the transaction hash is signed in accordance with a hashing algorithm utilized by the Ethereum protocol.
D430. The medium of embodiment D426, in which the transaction signature is returned in Distinguished Encoding Rules format.
D431. A verified address smart contract deploying processor-implemented system, comprising: means to store a component collection;
means to process processor-executable instructions from the component collection, the component collection storage structured with processor-executable instructions including:
   obtain, via the at least one processor, a contract deployment request message datastructure by a hardware security module (HSM) from a transaction signing server (TSS), in which the contract deployment request message datastructure is structured to specify a set of owner datastructures, a deployment factory address, and contract code for a smart contract;
   determine, via the at least one processor, by the HSM, owner key identification parameters associated with an owner datastructure in the set of owner datastructures, in which the owner key identification parameters are structured to specify a keyset identifier and a keychain path;
   determine, via the at least one processor, by the HSM, an owner public key associated with the owner datastructure using the owner key identification parameters;
   generate, via the at least one processor, by the HSM, an owner address associated with the owner datastructure using the owner public key;
   generate, via the at least one processor, by the HSM, a salt value for the smart contract;
   calculate, via the at least one processor, by the HSM, a contract address for the smart contract as a function of the deployment factory address, the salt value, the contract code, and the owner address;
   determine, via the at least one processor, by the HSM, an owner private key associated with the owner datastructure using the owner key identification parameters, in which the owner private key corresponds to the owner public key;
   sign, via at least one processor, by the HSM, the contract address for the smart contract using the owner private key to generate a contract deployment signature; and
   provide, via at least one processor, by the HSM, a contract deployment data datastructure to the TSS, in which the contract deployment data datastructure is structured to specify the salt value, and the contract deployment signature.
D432. The system of embodiment D431, in which the deployment factory address is a blockchain address of a Contract Factory smart contract on the Ethereum blockchain.
D433. The system of embodiment D431, in which the contract code is structured as a bytecode. D434. The system of embodiment D431, in which the owner key identification parameters are structured to specify a wallet type.
D435. The system of embodiment D431, in which the owner address is generated using a Bip32-based deterministic key derivation procedure.
D436. The system of embodiment D435, in which the owner address is calculated as the last 20 bytes of Keccak-256 hash of the owner public key.
D437. The system of embodiment D431, in which the salt value is structured as a one-time 32-byte salt value.
D438. The system of embodiment D431, in which the contract address is calculated as an EIP-1014 blockchain address.
D439. The system of embodiment D438, in which the contract address is calculated as the last 20 bytes of Keccak-256 hash of a concatenated list of: 0xFF byte, the deployment factory address, the salt value, and Keccak-256 hash of a concatenated list of: the contract code, and the owner address.
D440. The system of embodiment D431, in which the contract deployment data datastructure is structured to specify the owner address.
D441. The system of embodiment D431, in which the component collection storage is further structured with processor-executable instructions, comprising:
   obtain, via the at least one processor, by the HSM, a transaction signing request message datastructure associated with a transaction, in which the transaction signing request message datastructure is structured to specify a transaction amount, a source wallet datastructure, and a destination wallet datastructure, in which either the source wallet datastructure or the destination wallet datastructure is a verified address wallet datastructure that corresponds to the smart contract;
   determine, via the at least one processor, by the HSM, the owner key identification parameters associated with the verified address wallet datastructure;
   calculate, via the at least one processor, by the HSM, the contract address for the verified address wallet datastructure as a function of the deployment factory address, the salt value, the contract code, and the owner address;
   validate, via the at least one processor, by the HSM, the contract deployment signature associated with the verified address wallet datastructure;
   calculate, via the at least one processor, by the HSM, a transaction hash for the transaction;
   sign, via at least one processor, by the HSM, the transaction hash using a transaction signing private key associated with the owner datastructure to generate a transaction signature; and
   return, via at least one processor, the generated transaction signature.
D442. The system of embodiment D441, in which the instructions to validate the contract deployment signature associated with the verified address wallet datastructure are structured as instructions to also validate other contract deployment signatures associated with the verified address wallet datastructure, in which the other contract deployment signatures are associated with other owner datastructures in the set of owner datastructures.
D443. The system of embodiment D441, in which the owner private key and the transaction signing private key are the same key.
D444. The system of embodiment D441, in which the transaction hash is signed in accordance with a hashing algorithm utilized by the Ethereum protocol.
D445. The system of embodiment D441, in which the transaction signature is returned in Distinguished Encoding Rules format.
D446. A verified address smart contract deploying processor-implemented process, including processing processor-executable instructions via at least one processor from a component collection stored in at least one memory, the component collection storage structured with processor-executable instructions comprising:
   obtain, via the at least one processor, a contract deployment request message datastructure by a hardware security module (HSM) from a transaction signing server (TSS), in which the contract deployment request message datastructure is structured to specify a set of owner datastructures, a deployment factory address, and contract code for a smart contract;
   determine, via the at least one processor, by the HSM, owner key identification parameters associated with an owner datastructure in the set of owner datastructures, in which the owner key identification parameters are structured to specify a keyset identifier and a keychain path;
   determine, via the at least one processor, by the HSM, an owner public key associated with the owner datastructure using the owner key identification parameters;
   generate, via the at least one processor, by the HSM, an owner address associated with the owner datastructure using the owner public key;
   generate, via the at least one processor, by the HSM, a salt value for the smart contract;
   calculate, via the at least one processor, by the HSM, a contract address for the smart contract as a function of the deployment factory address, the salt value, the contract code, and the owner address;
   determine, via the at least one processor, by the HSM, an owner private key associated with the owner datastructure using the owner key identification parameters, in which the owner private key corresponds to the owner public key;
   sign, via at least one processor, by the HSM, the contract address for the smart contract using the owner private key to generate a contract deployment signature; and
   provide, via at least one processor, by the HSM, a contract deployment data datastructure to the TSS, in which the contract deployment data datastructure is structured to specify the salt value, and the contract deployment signature.
D447. The process of embodiment D446, in which the deployment factory address is a blockchain address of a Contract Factory smart contract on the Ethereum blockchain.
D448. The process of embodiment D446, in which the contract code is structured as a bytecode.
D449. The process of embodiment D446, in which the owner key identification parameters are structured to specify a wallet type.
D450. The process of embodiment D446, in which the owner address is generated using a Bip32-based deterministic key derivation procedure.
D451. The process of embodiment D450, in which the owner address is calculated as the last 20 bytes of Keccak-256 hash of the owner public key.
D452. The process of embodiment D446, in which the salt value is structured as a one-time 32-byte salt value.
D453. The process of embodiment D446, in which the contract address is calculated as an EIP-1014 blockchain address.
D454. The process of embodiment D453, in which the contract address is calculated as the last 20 bytes of Keccak-256 hash of a concatenated list of: 0xFF byte, the deployment factory address, the salt value, and Keccak-256 hash of a concatenated list of: the contract code, and the owner address.
D455. The process of embodiment D446, in which the contract deployment data datastructure is structured to specify the owner address.
D456. The process of embodiment D446, in which the component collection storage is further structured with processor-executable instructions, comprising:
   obtain, via the at least one processor, by the HSM, a transaction signing request message datastructure associated with a transaction, in which the transaction signing request message datastructure is structured to specify a transaction amount, a source wallet datastructure, and a destination wallet datastructure, in which either the source wallet datastructure or the destination wallet datastructure is a verified address wallet datastructure that corresponds to the smart contract;
   determine, via the at least one processor, by the HSM, the owner key identification parameters associated with the verified address wallet datastructure;
   calculate, via the at least one processor, by the HSM, the contract address for the verified address wallet datastructure as a function of the deployment factory address, the salt value, the contract code, and the owner address;
   validate, via the at least one processor, by the HSM, the contract deployment signature associated with the verified address wallet datastructure;
   calculate, via the at least one processor, by the HSM, a transaction hash for the transaction;
   sign, via at least one processor, by the HSM, the transaction hash using a transaction signing private key associated with the owner datastructure to generate a transaction signature; and
   return, via at least one processor, the generated transaction signature.
D457. The process of embodiment D456, in which the instructions to validate the contract deployment signature associated with the verified address wallet datastructure are structured as instructions to also validate other contract deployment signatures associated with the verified address wallet datastructure, in which the other contract deployment signatures are associated with other owner datastructures in the set of owner datastructures.
D458. The process of embodiment D456, in which the owner private key and the transaction signing private key are the same key.
D459. The process of embodiment D456, in which the transaction hash is signed in accordance with a hashing algorithm utilized by the Ethereum protocol.
D460. The process of embodiment D456, in which the transaction signature is returned in Distinguished Encoding Rules format.
D501. A verified address smart contract transaction signing apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via the at least one processor, by a hardware security module (HSM), a transaction signing request message datastructure associated with a transaction, in which the transaction signing request message datastructure is structured to specify a transaction amount, a source wallet datastructure, and a destination wallet datastructure, in which either the source wallet datastructure or the destination wallet datastructure is a verified address wallet datastructure that corresponds to a smart contract;
   determine, via the at least one processor, by the HSM, owner key identification parameters associated with an owner datastructure associated with the verified address wallet datastructure;
   calculate, via the at least one processor, by the HSM, a contract address for the verified address wallet datastructure as a function of a deployment factory address, a salt value for the smart contract, contract code for the smart contract, and an owner address generated using the owner key identification parameters;
   validate, via the at least one processor, by the HSM, a contract deployment signature associated with the verified address wallet datastructure;
   calculate, via the at least one processor, by the HSM, a transaction hash for the transaction;
   sign, via at least one processor, by the HSM, the transaction hash using a transaction signing private key associated with the owner datastructure to generate a transaction signature; and
   return, via at least one processor, the generated transaction signature.
D502. The apparatus of embodiment D501, in which the instructions to validate the contract deployment signature associated with the verified address wallet datastructure are structured as instructions to also validate other contract deployment signatures associated with the verified address wallet datastructure, in which the other contract deployment signatures are associated with other owner datastructures in a set of owner datastructures associated with the smart contract.
D503. The apparatus of embodiment D501, in which an owner private key used to generate the contract deployment signature and the transaction signing private key are the same key.
D504. The apparatus of embodiment D501, in which the transaction hash is signed in accordance with a hashing algorithm utilized by the Ethereum protocol.
D505. The apparatus of embodiment D501, in which the transaction signature is returned in Distinguished Encoding Rules format.
D506. A verified address smart contract transaction signing processor-readable, non-transient medium, the medium storing a component collection, the component collection storage structured with processor-executable instructions comprising:
   obtain, via the at least one processor, by a hardware security module (HSM), a transaction signing request message datastructure associated with a transaction, in which the transaction signing request message datastructure is structured to specify a transaction amount, a source wallet datastructure, and a destination wallet datastructure, in which either the source wallet datastructure or the destination wallet datastructure is a verified address wallet datastructure that corresponds to a smart contract;
   determine, via the at least one processor, by the HSM, owner key identification parameters associated with an owner datastructure associated with the verified address wallet datastructure;
   calculate, via the at least one processor, by the HSM, a contract address for the verified address wallet datastructure as a function of a deployment factory address, a salt value for the smart contract, contract code for the smart contract, and an owner address generated using the owner key identification parameters;
   validate, via the at least one processor, by the HSM, a contract deployment signature associated with the verified address wallet datastructure;
   calculate, via the at least one processor, by the HSM, a transaction hash for the transaction;
   sign, via at least one processor, by the HSM, the transaction hash using a transaction signing private key associated with the owner datastructure to generate a transaction signature; and
   return, via at least one processor, the generated transaction signature.
D507. The medium of embodiment D506, in which the instructions to validate the contract deployment signature associated with the verified address wallet datastructure are structured as instructions to also validate other contract deployment signatures associated with the verified address wallet datastructure, in which the other contract deployment signatures are associated with other owner datastructures in a set of owner datastructures associated with the smart contract.
D508. The medium of embodiment D506, in which an owner private key used to generate the contract deployment signature and the transaction signing private key are the same key.
D509. The medium of embodiment D506, in which the transaction hash is signed in accordance with a hashing algorithm utilized by the Ethereum protocol.
D510. The medium of embodiment D506, in which the transaction signature is returned in Distinguished Encoding Rules format.
D511. A verified address smart contract transaction signing processor-implemented system, comprising:
means to store a component collection;
means to process processor-executable instructions from the component collection, the component collection storage structured with processor-executable instructions including:
   obtain, via the at least one processor, by a hardware security module (HSM), a transaction signing request message datastructure associated with a transaction, in which the transaction signing request message datastructure is structured to specify a transaction amount, a source wallet datastructure, and a destination wallet datastructure, in which either the source wallet datastructure or the destination wallet datastructure is a verified address wallet datastructure that corresponds to a smart contract;
   determine, via the at least one processor, by the HSM, owner key identification parameters associated with an owner datastructure associated with the verified address wallet datastructure;
   calculate, via the at least one processor, by the HSM, a contract address for the verified address wallet datastructure as a function of a deployment factory address, a salt value for the smart contract, contract code for the smart contract, and an owner address generated using the owner key identification parameters;
   validate, via the at least one processor, by the HSM, a contract deployment signature associated with the verified address wallet datastructure;
   calculate, via the at least one processor, by the HSM, a transaction hash for the transaction;
   sign, via at least one processor, by the HSM, the transaction hash using a transaction signing private key associated with the owner datastructure to generate a transaction signature; and
   return, via at least one processor, the generated transaction signature.
D512. The system of embodiment D511, in which the instructions to validate the contract deployment signature associated with the verified address wallet datastructure are structured as instructions to also validate other contract deployment signatures associated with the verified address wallet datastructure, in which the other contract deployment signatures are associated with other owner datastructures in a set of owner datastructures associated with the smart contract.
D513. The system of embodiment D511, in which an owner private key used to generate the contract deployment signature and the transaction signing private key are the same key.
D514. The system of embodiment D511, in which the transaction hash is signed in accordance with a hashing algorithm utilized by the Ethereum protocol.
D515. The system of embodiment D511, in which the transaction signature is returned in Distinguished Encoding Rules format.
D516. A verified address smart contract transaction signing processor-implemented process, including processing processor-executable instructions via at least one processor from a component collection stored in at least one memory, the component collection storage structured with processor-executable instructions comprising:
   obtain, via the at least one processor, by a hardware security module (HSM), a transaction signing request message datastructure associated with a transaction, in which the transaction signing request message datastructure is structured to specify a transaction amount, a source wallet datastructure, and a destination wallet datastructure, in which either the source wallet datastructure or the destination wallet datastructure is a verified address wallet datastructure that corresponds to a smart contract;
   determine, via the at least one processor, by the HSM, owner key identification parameters associated with an owner datastructure associated with the verified address wallet datastructure;
   calculate, via the at least one processor, by the HSM, a contract address for the verified address wallet datastructure as a function of a deployment factory address, a salt value for the smart contract, contract code for the smart contract, and an owner address generated using the owner key identification parameters;
   validate, via the at least one processor, by the HSM, a contract deployment signature associated with the verified address wallet datastructure;
   calculate, via the at least one processor, by the HSM, a transaction hash for the transaction;
   sign, via at least one processor, by the HSM, the transaction hash using a transaction signing private key associated with the owner datastructure to generate a transaction signature; and
   return, via at least one processor, the generated transaction signature.
D517. The process of embodiment D516, in which the instructions to validate the contract deployment signature associated with the verified address wallet datastructure are structured as instructions to also validate other contract deployment signatures associated with the verified address wallet datastructure, in which the other contract deployment signatures are associated with other owner datastructures in a set of owner datastructures associated with the smart contract.
D518. The process of embodiment D516, in which an owner private key used to generate the contract deployment signature and the transaction signing private key are the same key.
D519. The process of embodiment D516, in which the transaction hash is signed in accordance with a hashing algorithm utilized by the Ethereum protocol.
D520. The process of embodiment D516, in which the transaction signature is returned in Distinguished Encoding Rules format.
D601. An integrity enhanced data transfer transaction signing apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   obtain, via the at least one processor, by an online transaction signing server (TSS), a transaction signing request datastructure for a transaction;
   generate, via the at least one processor, by the online TSS, a transaction signing request package datastructure, in which the transaction signing request package datastructure is structured to specify transaction details associated with the transaction;
   calculate, via the at least one processor, by the online TSS, a hash code of the transaction signing request package datastructure;
   export, via the at least one processor, the transaction signing request package datastructure to a barcode medium;
   receive, via the at least one processor, from an offline TSS, a signed integrity transaction authentication message corresponding to the transaction signing request package datastructure, in which the signed integrity transaction authentication message is structured to specify a header datastructure and a signed transaction response datastructure, in which the signed transaction response datastructure is structured to specify a transaction signature for the transaction;
   determine, via the at least one processor, a signature validation public key corresponding to a cold hardware security module (HSM) associated with the offline TSS;
   parse, via the at least one processor, by the online TSS, the header datastructure to determine a hash code signature, generated by the cold HSM, of the transaction signing request package datastructure;
   validate, via the at least one processor, by the online TSS, the hash code signature of the transaction signing request package datastructure with the signature validation public key;
   parse, via the at least one processor, by the online TSS, the header datastructure to determine a hash code signature, generated by the cold HSM, of the signed transaction response datastructure;
   validate, via the at least one processor, by the online TSS, the hash code signature of the signed transaction response datastructure with the signature validation public key; and
   submit, via the at least one processor, by the online TSS, the transaction signature for the transaction to a blockchain.
D602. The apparatus of embodiment D601, in which the barcode medium is one of: a printed medium, a digital medium.
D603. The apparatus of embodiment D601, in which the barcode medium comprises a set of QR codes.
D604. The apparatus of embodiment D601, in which the instructions to export the transaction signing request package datastructure to a barcode medium are structured as:
   determine, via the at least one processor, data size of the transaction signing request package datastructure;
   calculate, via the at least one processor, the number of data subsets to utilize based on the data size and a maximum data carrying capacity of a barcode medium;
   split, via the at least one processor, the transaction signing request package datastructure into data subsets, in which a data subset is structured not to exceed the maximum data carrying capacity of a barcode medium; and
   output, via the at least one processor, each of the data subsets to a separate barcode medium comprising a QR code encoding the respective data subset.
D605. The apparatus of embodiment D601, in which the signed integrity transaction authentication message is received via an integrity authentication communication channel.
D606. The apparatus of embodiment D605, in which the integrity authentication communication channel comprises a transmitting network device structured to block receiving ports.
D607. The apparatus of embodiment D601, in which a hash code is structured as a checksum.
D608. The apparatus of embodiment D601, in which the instructions to validate the hash code signature of the transaction signing request package datastructure are structured as:
   decrypt, via the at least one processor, the hash code signature of the transaction signing request package datastructure with the signature validation public key; and
   verify, via the at least one processor, that the decrypted hash code of the transaction signing request package datastructure matches the calculated hash code of the transaction signing request package datastructure.
D609. The apparatus of embodiment D601, in which the instructions to validate the hash code signature of the signed transaction response datastructure are structured as:
   calculate, via the at least one processor, a hash code of the signed transaction response datastructure;
   decrypt, via the at least one processor, the hash code signature of the signed transaction response datastructure with the signature validation public key; and
   verify, via the at least one processor, that the decrypted hash code of the signed transaction response datastructure matches the calculated hash code of the signed transaction response datastructure.
D610. The apparatus of embodiment D601, in which the signed integrity transaction authentication message is structured to specify an auxiliary datastructure.
D611. The apparatus of embodiment D610, in which the auxiliary datastructure is structured to specify any of: a log file, an audit trail file, a system report file.
D612. The apparatus of embodiment D610, in which the component collection storage is further structured with processor-executable instructions, comprising:
parse, via the at least one processor, the header datastructure to determine a hash code signature, generated by the cold HSM, of the auxiliary datastructure; and
validate, via the at least one processor, the hash code signature of the auxiliary datastructure with the signature validation public key.
D613. The apparatus of embodiment D612, in which the instructions to validate the hash code signature of the auxiliary datastructure are structured as:
   calculate, via the at least one processor, a hash code of the auxiliary datastructure;
   decrypt, via the at least one processor, the hash code signature of the auxiliary datastructure with the signature validation public key; and
   verify, via the at least one processor, that the decrypted hash code of the auxiliary datastructure matches the calculated hash code of the auxiliary datastructure.
D614. The apparatus of embodiment D601, in which the transaction signing request package datastructure is structured to specify a source wallet datastructure and a destination wallet datastructure, in which either the source wallet datastructure or the destination wallet datastructure is a verified address wallet datastructure that corresponds to a smart contract, and in which the cold HSM is structured to validate a contract deployment signature of a verified address wallet datastructure.
D615. The apparatus of embodiment D601, in which the transaction signature is in Distinguished Encoding Rules format.
D616. An integrity enhanced data transfer transaction signing processor-readable, non-transient medium, the medium storing a component collection, the component collection storage structured with processor-executable instructions comprising:
   obtain, via the at least one processor, by an online transaction signing server (TSS), a transaction signing request datastructure for a transaction;
   generate, via the at least one processor, by the online TSS, a transaction signing request package datastructure, in which the transaction signing request package datastructure is structured to specify transaction details associated with the transaction;
   calculate, via the at least one processor, by the online TSS, a hash code of the transaction signing request package datastructure;
   export, via the at least one processor, the transaction signing request package datastructure to a barcode medium;
   receive, via the at least one processor, from an offline TSS, a signed integrity transaction authentication message corresponding to the transaction signing request package datastructure, in which the signed integrity transaction authentication message is structured to specify a header datastructure and a signed transaction response datastructure, in which the signed transaction response datastructure is structured to specify a transaction signature for the transaction;
   determine, via the at least one processor, a signature validation public key corresponding to a cold hardware security module (HSM) associated with the offline TSS;
   parse, via the at least one processor, by the online TSS, the header datastructure to determine a hash code signature, generated by the cold HSM, of the transaction signing request package datastructure;
   validate, via the at least one processor, by the online TSS, the hash code signature of the transaction signing request package datastructure with the signature validation public key;
   parse, via the at least one processor, by the online TSS, the header datastructure to determine a hash code signature, generated by the cold HSM, of the signed transaction response datastructure;
   validate, via the at least one processor, by the online TSS, the hash code signature of the signed transaction response datastructure with the signature validation public key; and
   submit, via the at least one processor, by the online TSS, the transaction signature for the transaction to a blockchain.
D617. The medium of embodiment D616, in which the barcode medium is one of: a printed medium, a digital medium.
D618. The medium of embodiment D616, in which the barcode medium comprises a set of QR codes.
D619. The medium of embodiment D616, in which the instructions to export the transaction signing request package datastructure to a barcode medium are structured as:
   determine, via the at least one processor, data size of the transaction signing request package datastructure;
   calculate, via the at least one processor, the number of data subsets to utilize based on the data size and a maximum data carrying capacity of a barcode medium;
   split, via the at least one processor, the transaction signing request package datastructure into data subsets, in which a data subset is structured not to exceed the maximum data carrying capacity of a barcode medium; and
   output, via the at least one processor, each of the data subsets to a separate barcode medium comprising a QR code encoding the respective data subset.
D620. The medium of embodiment D616, in which the signed integrity transaction authentication message is received via an integrity authentication communication channel.
D621. The medium of embodiment D620, in which the integrity authentication communication channel comprises a transmitting network device structured to block receiving ports.
D622. The medium of embodiment D616, in which a hash code is structured as a checksum.
D623. The medium of embodiment D616, in which the instructions to validate the hash code signature of the transaction signing request package datastructure are structured as:
   decrypt, via the at least one processor, the hash code signature of the transaction signing request package datastructure with the signature validation public key; and
   verify, via the at least one processor, that the decrypted hash code of the transaction signing request package datastructure matches the calculated hash code of the transaction signing request package datastructure.
D624. The medium of embodiment D616, in which the instructions to validate the hash code signature of the signed transaction response datastructure are structured as:
   calculate, via the at least one processor, a hash code of the signed transaction response datastructure;
   decrypt, via the at least one processor, the hash code signature of the signed transaction response datastructure with the signature validation public key; and
   verify, via the at least one processor, that the decrypted hash code of the signed transaction response datastructure matches the calculated hash code of the signed transaction response datastructure.
D625. The medium of embodiment D616, in which the signed integrity transaction authentication message is structured to specify an auxiliary datastructure.
D626. The medium of embodiment D625, in which the auxiliary datastructure is structured to specify any of: a log file, an audit trail file, a system report file.
D627. The medium of embodiment D625, in which the component collection storage is further structured with processor-executable instructions, comprising:
   parse, via the at least one processor, the header datastructure to determine a hash code signature, generated by the cold HSM, of the auxiliary datastructure; and
   validate, via the at least one processor, the hash code signature of the auxiliary datastructure with the signature validation public key.
D628. The medium of embodiment D627, in which the instructions to validate the hash code signature of the auxiliary datastructure are structured as:
   calculate, via the at least one processor, a hash code of the auxiliary datastructure;
   decrypt, via the at least one processor, the hash code signature of the auxiliary datastructure with the signature validation public key; and
   verify, via the at least one processor, that the decrypted hash code of the auxiliary datastructure matches the calculated hash code of the auxiliary datastructure.
D629. The medium of embodiment D616, in which the transaction signing request package datastructure is structured to specify a source wallet datastructure and a destination wallet datastructure, in which either the source wallet datastructure or the destination wallet datastructure is a verified address wallet datastructure that corresponds to a smart contract, and in which the cold HSM is structured to validate a contract deployment signature of a verified address wallet datastructure.
D630. The medium of embodiment D616, in which the transaction signature is in Distinguished Encoding Rules format.
D631. An integrity enhanced data transfer transaction signing processor-implemented system, comprising:
means to store a component collection;
means to process processor-executable instructions from the component collection, the component collection storage structured with processor-executable instructions including:
   obtain, via the at least one processor, by an online transaction signing server (TSS), a transaction signing request datastructure for a transaction;
   generate, via the at least one processor, by the online TSS, a transaction signing request package datastructure, in which the transaction signing request package datastructure is structured to specify transaction details associated with the transaction;
   calculate, via the at least one processor, by the online TSS, a hash code of the transaction signing request package datastructure;
   export, via the at least one processor, the transaction signing request package datastructure to a barcode medium;
   receive, via the at least one processor, from an offline TSS, a signed integrity transaction authentication message corresponding to the transaction signing request package datastructure, in which the signed integrity transaction authentication message is structured to specify a header datastructure and a signed transaction response datastructure, in which the signed transaction response datastructure is structured to specify a transaction signature for the transaction;
   determine, via the at least one processor, a signature validation public key corresponding to a cold hardware security module (HSM) associated with the offline TSS;
   parse, via the at least one processor, by the online TSS, the header datastructure to determine a hash code signature, generated by the cold HSM, of the transaction signing request package datastructure;
   validate, via the at least one processor, by the online TSS, the hash code signature of the transaction signing request package datastructure with the signature validation public key;
   parse, via the at least one processor, by the online TSS, the header datastructure to determine a hash code signature, generated by the cold HSM, of the signed transaction response datastructure;
   validate, via the at least one processor, by the online TSS, the hash code signature of the signed transaction response datastructure with the signature validation public key; and
   submit, via the at least one processor, by the online TSS, the transaction signature for the transaction to a blockchain.
D632. The system of embodiment D631, in which the barcode medium is one of: a printed medium, a digital medium.
D633. The system of embodiment D631, in which the barcode medium comprises a set of QR codes.
D634. The system of embodiment D631, in which the instructions to export the transaction signing request package datastructure to a barcode medium are structured as:
   determine, via the at least one processor, data size of the transaction signing request package datastructure;
   calculate, via the at least one processor, the number of data subsets to utilize based on the data size and a maximum data carrying capacity of a barcode medium;
   split, via the at least one processor, the transaction signing request package datastructure into data subsets, in which a data subset is structured not to exceed the maximum data carrying capacity of a barcode medium; and
   output, via the at least one processor, each of the data subsets to a separate barcode medium comprising a QR code encoding the respective data subset.
D635. The system of embodiment D631, in which the signed integrity transaction authentication message is received via an integrity authentication communication channel.
D636. The system of embodiment D635, in which the integrity authentication communication channel comprises a transmitting network device structured to block receiving ports.
D637. The system of embodiment D631, in which a hash code is structured as a checksum.
D638. The system of embodiment D631, in which the instructions to validate the hash code signature of the transaction signing request package datastructure are structured as:
   decrypt, via the at least one processor, the hash code signature of the transaction signing request package datastructure with the signature validation public key; and
   verify, via the at least one processor, that the decrypted hash code of the transaction signing request package datastructure matches the calculated hash code of the transaction signing request package datastructure.
D639. The system of embodiment D631, in which the instructions to validate the hash code signature of the signed transaction response datastructure are structured as:
   calculate, via the at least one processor, a hash code of the signed transaction response datastructure;
   decrypt, via the at least one processor, the hash code signature of the signed transaction response datastructure with the signature validation public key; and
   verify, via the at least one processor, that the decrypted hash code of the signed transaction response datastructure matches the calculated hash code of the signed transaction response datastructure.
D640. The system of embodiment D631, in which the signed integrity transaction authentication message is structured to specify an auxiliary datastructure.
D641. The system of embodiment D640, in which the auxiliary datastructure is structured to specify any of: a log file, an audit trail file, a system report file.
D642. The system of embodiment D640, in which the component collection storage is further structured with processor-executable instructions, comprising:
   parse, via the at least one processor, the header datastructure to determine a hash code signature, generated by the cold HSM, of the auxiliary datastructure; and
   validate, via the at least one processor, the hash code signature of the auxiliary datastructure with the signature validation public key.
D643. The system of embodiment D642, in which the instructions to validate the hash code signature of the auxiliary datastructure are structured as:
   calculate, via the at least one processor, a hash code of the auxiliary datastructure;
   decrypt, via the at least one processor, the hash code signature of the auxiliary datastructure with the signature validation public key; and
   verify, via the at least one processor, that the decrypted hash code of the auxiliary datastructure matches the calculated hash code of the auxiliary datastructure.
D644. The system of embodiment D631, in which the transaction signing request package datastructure is structured to specify a source wallet datastructure and a destination wallet datastructure, in which either the source wallet datastructure or the destination wallet datastructure is a verified address wallet datastructure that corresponds to a smart contract, and in which the cold HSM is structured to validate a contract deployment signature of a verified address wallet datastructure.
D645. The system of embodiment D631, in which the transaction signature is in Distinguished Encoding Rules format.
D646. An integrity enhanced data transfer transaction signing processor-implemented process, including processing processor-executable instructions via at least one processor from a component collection stored in at least one memory, the component collection storage structured with processor-executable instructions comprising:
   obtain, via the at least one processor, by an online transaction signing server (TSS), a transaction signing request datastructure for a transaction;
   generate, via the at least one processor, by the online TSS, a transaction signing request package datastructure, in which the transaction signing request package datastructure is structured to specify transaction details associated with the transaction;
   calculate, via the at least one processor, by the online TSS, a hash code of the transaction signing request package datastructure;
   export, via the at least one processor, the transaction signing request package datastructure to a barcode medium;
   receive, via the at least one processor, from an offline TSS, a signed integrity transaction authentication message corresponding to the transaction signing request package datastructure, in which the signed integrity transaction authentication message is structured to specify a header datastructure and a signed transaction response datastructure, in which the signed transaction response datastructure is structured to specify a transaction signature for the transaction;
   determine, via the at least one processor, a signature validation public key corresponding to a cold hardware security module (HSM) associated with the offline TSS;
   parse, via the at least one processor, by the online TSS, the header datastructure to determine a hash code signature, generated by the cold HSM, of the transaction signing request package datastructure;
   validate, via the at least one processor, by the online TSS, the hash code signature of the transaction signing request package datastructure with the signature validation public key;
   parse, via the at least one processor, by the online TSS, the header datastructure to determine a hash code signature, generated by the cold HSM, of the signed transaction response datastructure;
   validate, via the at least one processor, by the online TSS, the hash code signature of the signed transaction response datastructure with the signature validation public key; and
   submit, via the at least one processor, by the online TSS, the transaction signature for the transaction to a blockchain.
D647. The process of embodiment D646, in which the barcode medium is one of: a printed medium, a digital medium.
D648. The process of embodiment D646, in which the barcode medium comprises a set of QR codes.
D649. The process of embodiment D646, in which the instructions to export the transaction signing request package datastructure to a barcode medium are structured as:
   determine, via the at least one processor, data size of the transaction signing request package datastructure;
   calculate, via the at least one processor, the number of data subsets to utilize based on the data size and a maximum data carrying capacity of a barcode medium;
   split, via the at least one processor, the transaction signing request package datastructure into data subsets, in which a data subset is structured not to exceed the maximum data carrying capacity of a barcode medium; and
   output, via the at least one processor, each of the data subsets to a separate barcode medium comprising a QR code encoding the respective data subset.
D650. The process of embodiment D646, in which the signed integrity transaction authentication message is received via an integrity authentication communication channel.
D651. The process of embodiment D650, in which the integrity authentication communication channel comprises a transmitting network device structured to block receiving ports.
D652. The process of embodiment D646, in which a hash code is structured as a checksum.
D653. The process of embodiment D646, in which the instructions to validate the hash code signature of the transaction signing request package datastructure are structured as:
   decrypt, via the at least one processor, the hash code signature of the transaction signing request package datastructure with the signature validation public key; and
   verify, via the at least one processor, that the decrypted hash code of the transaction signing request package datastructure matches the calculated hash code of the transaction signing request package datastructure.
D654. The process of embodiment D646, in which the instructions to validate the hash code signature of the signed transaction response datastructure are structured as:
   calculate, via the at least one processor, a hash code of the signed transaction response datastructure;
   decrypt, via the at least one processor, the hash code signature of the signed transaction response datastructure with the signature validation public key; and
   verify, via the at least one processor, that the decrypted hash code of the signed transaction response datastructure matches the calculated hash code of the signed transaction response datastructure.
D655. The process of embodiment D646, in which the signed integrity transaction authentication message is structured to specify an auxiliary datastructure.
D656. The process of embodiment D655, in which the auxiliary datastructure is structured to specify any of: a log file, an audit trail file, a system report file.
D657. The process of embodiment D655, in which the component collection storage is further structured with processor-executable instructions, comprising:
   parse, via the at least one processor, the header datastructure to determine a hash code signature, generated by the cold HSM, of the auxiliary datastructure; and
   validate, via the at least one processor, the hash code signature of the auxiliary datastructure with the signature validation public key.
D658. The process of embodiment D657, in which the instructions to validate the hash code signature of the auxiliary datastructure are structured as:
   calculate, via the at least one processor, a hash code of the auxiliary datastructure;
   decrypt, via the at least one processor, the hash code signature of the auxiliary datastructure with the signature validation public key; and
   verify, via the at least one processor, that the decrypted hash code of the auxiliary datastructure matches the calculated hash code of the auxiliary datastructure.
D659. The process of embodiment D646, in which the transaction signing request package datastructure is structured to specify a source wallet datastructure and a destination wallet datastructure, in which either the source wallet datastructure or the destination wallet datastructure is a verified address wallet datastructure that corresponds to a smart contract, and in which the cold HSM is structured to validate a contract deployment signature of a verified address wallet datastructure.
D660. The process of embodiment D646, in which the transaction signature is in Distinguished Encoding Rules format.
D701. A transaction signing apparatus, comprising:
at least one memory;
a component collection stored in the at least one memory;
at least one processor disposed in communication with the at least one memory, the at least one processor executing processor-executable instructions from the component collection, the component collection storage structured with processor-executable instructions, comprising:
   receive, via the at least one processor, by a cold hardware security module (HSM), an offline transaction signing request message datastructure for a transaction from an offline transaction signing server (TSS);
   determine, via the at least one processor, by the cold HSM, a blockchain type specified via the offline transaction signing request message datastructure, in which the blockchain type identifies one of: a multi-signature blockchain, a single-signature blockchain;
   upon determining, via the at least one processor, by the cold HSM, that the blockchain type identifies a single-signature blockchain:
      determine, via the at least one processor, by the cold HSM, whether final transaction signing is specified via the transaction signing request message datastructure;
   upon determining, via the at least one processor, by the cold HSM, that final transaction signing is specified:
      determine, via the at least one processor, by the cold HSM, a set of previous off-chain transaction signatures associated with the transaction specified via the offline transaction signing request message datastructure; and
      validate, via the at least one processor, by the cold HSM, each respective previous off-chain signature in the set of previous off-chain transaction signatures with a corresponding public key of the respective previous off-chain signature;
   upon determining, via the at least one processor, by the cold HSM, that the blockchain type identifies a multi-signature blockchain, or that the blockchain type identifies a single-signature blockchain and final transaction signing is not specified:
      determine, via the at least one processor, by the cold HSM, a previous online transaction signature associated with the transaction specified via the offline transaction signing request message datastructure; and
      validate, via the at least one processor, by the cold HSM, the previous online transaction signature with a corresponding public key;
   determine, via the at least one processor, by the cold HSM, a transaction hash associated with the transaction by evaluating transaction data specified via the offline transaction signing request message datastructure;
   determine, via the at least one processor, by the cold HSM, a keychain path specified via the transaction signing request message datastructure;
   generate, via the at least one processor, by the cold HSM, a signing private key for the determined keychain path from a master private key;
   sign, via the at least one processor, by the cold HSM, the determined transaction hash using the generated signing private key to generate a signature; and
   return, via the at least one processor, the generated signature to the offline TSS.
D702. The apparatus of embodiment D701, in which the set of previous off-chain transaction signatures includes at least one online transaction signature generated by a hot HSM and at least one offline transaction signature generated by a second cold HSM.
D703. The apparatus of embodiment D702, in which the second cold HSM is another cold HSM.
D704. The apparatus of embodiment D702, in which the second cold HSM is the cold HSM.
D705. The apparatus of embodiment D701, in which the transaction hash is specified in a data field of the offline transaction signing request message datastructure.
D706. The apparatus of embodiment D701, in which the transaction hash is calculated by the cold HSM using the transaction data.
D707. The apparatus of embodiment D706, in which the transaction data is structured to specify a source wallet datastructure and a destination wallet datastructure, in which either the source wallet datastructure or the destination wallet datastructure is a verified address wallet datastructure that corresponds to a smart contract, and in which the cold HSM is structured to validate a contract deployment signature of a verified address wallet datastructure.
D708. The apparatus of embodiment D701, in which the component collection storage is further structured with processor-executable instructions, comprising:
verify, via the at least one processor, by the cold HSM, that a cardinality of the set of previous off-chain transaction signatures matches M specified by an M-of-N multisig configuration associated with the signing private key.
D709. The apparatus of embodiment D701, in which the signing private key is generated using a Bip32-based deterministic key derivation procedure.
D710. The apparatus of embodiment D701, in which the signature is returned in Distinguished Encoding Rules format.
D711. A transaction signing processor-readable, non-transient medium, the medium storing a component collection, the component collection storage structured with processor-executable instructions comprising:
   receive, via the at least one processor, by a cold hardware security module (HSM), an offline transaction signing request message datastructure for a transaction from an offline transaction signing server (TSS);
   determine, via the at least one processor, by the cold HSM, a blockchain type specified via the offline transaction signing request message datastructure, in which the blockchain type identifies one of: a multi-signature blockchain, a single-signature blockchain;
   upon determining, via the at least one processor, by the cold HSM, that the blockchain type identifies a single-signature blockchain:
      determine, via the at least one processor, by the cold HSM, whether final transaction signing is specified via the transaction signing request message datastructure;
      upon determining, via the at least one processor, by the cold HSM, that final transaction signing is specified:
         determine, via the at least one processor, by the cold HSM, a set of previous off-chain transaction signatures associated with the transaction specified via the offline transaction signing request message datastructure; and
         validate, via the at least one processor, by the cold HSM, each respective previous off-chain signature in the set of previous off-chain transaction signatures with a corresponding public key of the respective previous off-chain signature;
   upon determining, via the at least one processor, by the cold HSM, that the blockchain type identifies a multi-signature blockchain, or that the blockchain type identifies a single-signature blockchain and final transaction signing is not specified:
      determine, via the at least one processor, by the cold HSM, a previous online transaction signature associated with the transaction specified via the offline transaction signing request message datastructure; and
      validate, via the at least one processor, by the cold HSM, the previous online transaction signature with a corresponding public key;
   determine, via the at least one processor, by the cold HSM, a transaction hash associated with the transaction by evaluating transaction data specified via the offline transaction signing request message datastructure;
   determine, via the at least one processor, by the cold HSM, a keychain path specified via the transaction signing request message datastructure;
   generate, via the at least one processor, by the cold HSM, a signing private key for the determined keychain path from a master private key;
   sign, via the at least one processor, by the cold HSM, the determined transaction hash using the generated signing private key to generate a signature; and
   return, via the at least one processor, the generated signature to the offline TSS.
D712. The medium of embodiment D711, in which the set of previous off-chain transaction signatures includes at least one online transaction signature generated by a hot HSM and at least one offline transaction signature generated by a second cold HSM.
D713. The medium of embodiment D712, in which the second cold HSM is another cold HSM.
D714. The medium of embodiment D712, in which the second cold HSM is the cold HSM.
D715. The medium of embodiment D711, in which the transaction hash is specified in a data field of the offline transaction signing request message datastructure.
D716. The medium of embodiment D711, in which the transaction hash is calculated by the cold HSM using the transaction data.
D717. The medium of embodiment D716, in which the transaction data is structured to specify a source wallet datastructure and a destination wallet datastructure, in which either the source wallet datastructure or the destination wallet datastructure is a verified address wallet datastructure that corresponds to a smart contract, and in which the cold HSM is structured to validate a contract deployment signature of a verified address wallet datastructure.
D718. The medium of embodiment D711, in which the component collection storage is further structured with processor-executable instructions, comprising:
verify, via the at least one processor, by the cold HSM, that a cardinality of the set of previous off-chain transaction signatures matches M specified by an M-of-N multisig configuration associated with the signing private key.
D719. The medium of embodiment D711, in which the signing private key is generated using a Bip32-based deterministic key derivation procedure.
D720. The medium of embodiment D711, in which the signature is returned in Distinguished Encoding Rules format.
D721. A transaction signing processor-implemented system, comprising:
means to store a component collection;
means to process processor-executable instructions from the component collection, the component collection storage structured with processor-executable instructions including:
   receive, via the at least one processor, by a cold hardware security module (HSM), an offline transaction signing request message datastructure for a transaction from an offline transaction signing server (TSS);
   determine, via the at least one processor, by the cold HSM, a blockchain type specified via the offline transaction signing request message datastructure, in which the blockchain type identifies one of: a multi-signature blockchain, a single-signature blockchain;
   upon determining, via the at least one processor, by the cold HSM, that the blockchain type identifies a single-signature blockchain:
      determine, via the at least one processor, by the cold HSM, whether final transaction signing is specified via the transaction signing request message datastructure;
      upon determining, via the at least one processor, by the cold HSM, that final transaction signing is specified:
         determine, via the at least one processor, by the cold HSM, a set of previous off-chain transaction signatures associated with the transaction specified via the offline transaction signing request message datastructure; and
         validate, via the at least one processor, by the cold HSM, each respective previous off-chain signature in the set of previous off-chain transaction signatures with a corresponding public key of the respective previous off-chain signature;
   upon determining, via the at least one processor, by the cold HSM, that the blockchain type identifies a multi-signature blockchain, or that the blockchain type identifies a single-signature blockchain and final transaction signing is not specified:
      determine, via the at least one processor, by the cold HSM, a previous online transaction signature associated with the transaction specified via the offline transaction signing request message datastructure; and
      validate, via the at least one processor, by the cold HSM, the previous online transaction signature with a corresponding public key;
   determine, via the at least one processor, by the cold HSM, a transaction hash associated with the transaction by evaluating transaction data specified via the offline transaction signing request message datastructure;
   determine, via the at least one processor, by the cold HSM, a keychain path specified via the transaction signing request message datastructure;
   generate, via the at least one processor, by the cold HSM, a signing private key for the determined keychain path from a master private key;
   sign, via the at least one processor, by the cold HSM, the determined transaction hash using the generated signing private key to generate a signature; and
   return, via the at least one processor, the generated signature to the offline TSS.
D722. The system of embodiment D721, in which the set of previous off-chain transaction signatures includes at least one online transaction signature generated by a hot HSM and at least one offline transaction signature generated by a second cold HSM.
D723. The system of embodiment D722, in which the second cold HSM is another cold HSM.
D724. The system of embodiment D722, in which the second cold HSM is the cold HSM.
D725. The system of embodiment D721, in which the transaction hash is specified in a data field of the offline transaction signing request message datastructure.
D726. The system of embodiment D721, in which the transaction hash is calculated by the cold HSM using the transaction data.
D727. The system of embodiment D726, in which the transaction data is structured to specify a source wallet datastructure and a destination wallet datastructure, in which either the source wallet datastructure or the destination wallet datastructure is a verified address wallet datastructure that corresponds to a smart contract, and in which the cold HSM is structured to validate a contract deployment signature of a verified address wallet datastructure.
D728. The system of embodiment D721, in which the component collection storage is further structured with processor-executable instructions, comprising:
verify, via the at least one processor, by the cold HSM, that a cardinality of the set of previous off-chain transaction signatures matches M specified by an M-of-N multisig configuration associated with the signing private key.
D729. The system of embodiment D721, in which the signing private key is generated using a Bip32-based deterministic key derivation procedure.
D730. The system of embodiment D721, in which the signature is returned in Distinguished Encoding Rules format.
D731. A transaction signing processor-implemented process, including processing processor-executable instructions via at least one processor from a component collection stored in at least one memory, the component collection storage structured with processor-executable instructions comprising:
   receive, via the at least one processor, by a cold hardware security module (HSM), an offline transaction signing request message datastructure for a transaction from an offline transaction signing server (TSS);
   determine, via the at least one processor, by the cold HSM, a blockchain type specified via the offline transaction signing request message datastructure, in which the blockchain type identifies one of: a multi-signature blockchain, a single-signature blockchain;
   upon determining, via the at least one processor, by the cold HSM, that the blockchain type identifies a single-signature blockchain:
      determine, via the at least one processor, by the cold HSM, whether final transaction signing is specified via the transaction signing request message datastructure;
      upon determining, via the at least one processor, by the cold HSM, that final transaction signing is specified:
         determine, via the at least one processor, by the cold HSM, a set of previous off-chain transaction signatures associated with the transaction specified via the offline transaction signing request message datastructure; and
         validate, via the at least one processor, by the cold HSM, each respective previous off-chain signature in the set of previous off-chain transaction signatures with a corresponding public key of the respective previous off-chain signature;
   upon determining, via the at least one processor, by the cold HSM, that the blockchain type identifies a multi-signature blockchain, or that the blockchain type identifies a single-signature blockchain and final transaction signing is not specified:
      determine, via the at least one processor, by the cold HSM, a previous online transaction signature associated with the transaction specified via the offline transaction signing request message datastructure; and
      validate, via the at least one processor, by the cold HSM, the previous online transaction signature with a corresponding public key;
   determine, via the at least one processor, by the cold HSM, a transaction hash associated with the transaction by evaluating transaction data specified via the offline transaction signing request message datastructure;
   determine, via the at least one processor, by the cold HSM, a keychain path specified via the transaction signing request message datastructure;
   generate, via the at least one processor, by the cold HSM, a signing private key for the determined keychain path from a master private key;
   sign, via the at least one processor, by the cold HSM, the determined transaction hash using the generated signing private key to generate a signature; and
   return, via the at least one processor, the generated signature to the offline TSS.
D732. The process of embodiment D731, in which the set of previous off-chain transaction signatures includes at least one online transaction signature generated by a hot HSM and at least one offline transaction signature generated by a second cold HSM.
D733. The process of embodiment D732, in which the second cold HSM is another cold HSM.
D734. The process of embodiment D732, in which the second cold HSM is the cold HSM.
D735. The process of embodiment D731, in which the transaction hash is specified in a data field of the offline transaction signing request message datastructure.
D736. The process of embodiment D731, in which the transaction hash is calculated by the cold HSM using the transaction data.
D737. The process of embodiment D736, in which the transaction data is structured to specify a source wallet datastructure and a destination wallet datastructure, in which either the source wallet datastructure or the destination wallet datastructure is a verified address wallet datastructure that corresponds to a smart contract, and in which the cold HSM is structured to validate a contract deployment signature of a verified address wallet datastructure.
D738. The process of embodiment D731, in which the component collection storage is further structured with processor-executable instructions, comprising:
verify, via the at least one processor, by the cold HSM, that a cardinality of the set of previous off-chain transaction signatures matches M specified by an M-of-N multisig configuration associated with the signing private key.
D739. The process of embodiment D731, in which the signing private key is generated using a Bip32-based deterministic key derivation procedure.
D740. The process of embodiment D731, in which the signature is returned in Distinguished Encoding Rules format.
E1. A blockchain transaction data auditing apparatus, comprising:
at least one memory;
a component collection stored in the at least one memory;
any of at least one processor disposed in communication with the at least one memory, the any of at least one processor executing processor-executable instructions from the component collection, storage of the component collection structured with processor-executable instructions comprising:
   receive a plurality of transaction record datastructures for each of a plurality of transactions, each transaction record datastructure comprising a source address, a destination address, a transaction amount and a timestamp of a transaction;
   verify, via the source address corresponding to the source digital wallet, that the transaction amount is available in the source digital wallet;
   cryptographically record the transaction record datastructure in a blockchain;
   receive the source address and the destination address;
   hash the source address using a bloom filter to generate a source wallet address;
   hash the destination address using the bloom filter to generate a destination wallet address;
   add the source wallet address as a first row and a column entry to a matrix datastructure representing a weighted graph of the plurality of transactions;
   add the destination wallet address as a second row and column entry to the matrix datastructure representing a weighted graph of the plurality of transactions;
   add the transaction amount and the timestamp as an entry to the row corresponding to the source wallet address and the column corresponding to the destination wallet address; and
   generate a list representation of the matrix datastructure, where each entry in the list comprises a tuple having the source wallet address, the destination wallet address, the transaction amount and the timestamp.
E2. The apparatus of embodiment E1, the component collection further comprising an Auditing component, in which the processor issues instructions from the Auditing component, stored in the memory, to:
   receive a request to search for a prior transaction including the source address;
   obtain the source wallet address corresponding to the source address from the bloom filter component;
   search the list for the tuple including the source wallet address; and
   when the tuple comprises the source wallet address, retrieve the timestamp corresponding to the transaction, decrypt a segment of the blockchain corresponding to the timestamp, and retrieve the transaction record datastructure corresponding to the transaction from the segment of the blockchain.
E3. The apparatus of embodiment E1, in which a list-of-lists datastructure includes at least one tuple per list with each entry containing the row index, the column index and the value; and, further comprising:
   updating incremental matrix construction as an updated list-of-lists datastructure with new transaction details structured as searchable.
E4. The apparatus of embodiment E1, in which the source address comprises a hash of a source public key, the source public key comprises a string of alphanumeric characters greater than 27 characters in length.
E5. The apparatus of embodiment E1, in which the source address comprises a RIPEMD-160 hash of an SHA256 hash of a source public key.
E6. The apparatus of embodiment E1, in which the destination address comprises a hash of a destination public key, the destination public key comprises a string of alphanumeric characters greater than 27 characters in length.
E7. The apparatus of embodiment E1, in which the destination address comprises a RIPEMD-160 hash of an SHA256 hash of the source address.
E8. The apparatus of embodiment E1, in which the transaction comprises a virtual currency transaction.
E9. The apparatus of embodiment E1, further comprising the bloom filter, the bloom filter comprising a linear congruential generator (LCG) algorithm that hashes the source address having a first storage bandwidth requirement into a sequence of pseudo-randomized outputs having a second storage bandwidth requirement that is lower than the first storage bandwidth requirement.
E10. The apparatus of embodiment E9, in which the source address cannot be recovered from the sequence using a reverse hashing algorithm.
E11. The apparatus of embodiment E9, the LCG is used to hash the source address several times to generate the sequence.
E12. The apparatus of embodiment E9, in which the LCG is applied to separate segments of the source address to generate the sequence.
E13. The apparatus of embodiment E1, in which the bloom filter hashes the destination address having a first storage bandwidth requirement into a sequence of pseudo-randomized outputs having a second storage bandwidth requirement that is lower than the first storage bandwidth requirement.
E14. The apparatus of embodiment E13, in which the destination address cannot be recovered from the sequence using a reverse hashing algorithm.
E15. The apparatus of embodiment E13, the bloom filter is used to hash the destination address several times to generate the sequence.
E16. The apparatus of embodiment E13, in which the bloom filter is applied to separate segments of the destination address to generate the sequence.
E17. The apparatus of embodiment E1, in which the matrix datastructure contains a transaction amount that corresponds to an outflow of the transaction amount from the source address to the destination address.
E18. The apparatus of embodiment E1, in which the matrix datastructure contains a transaction amount that corresponds to an inflow of the transaction amount from the source address to the destination address.
E19. The apparatus of embodiment E1, in which the processor issues instructions from the bloom filter component, stored in the memory, to:
determine a list of corresponding false positives for hash of the source address; and
store the source wallet address with a list of the corresponding false positives.
E20. The apparatus of embodiment E1, in which the processor issues instructions from the bloom filter component, stored in the memory, to:
   determine a list of corresponding false positives for hash of the destination address; and
   store the destination wallet address with a list of the corresponding false positives.
E21. A blockchain transaction data auditing processor-readable, non-transient medium, the medium storing a component collection, storage of the component collection structured with processor-executable instructions comprising:
   receive a plurality of transaction record datastructures for each of a plurality of transactions, each transaction record datastructure comprising a source address, a destination address, a transaction amount and a timestamp of a transaction;
   verify, via the source address corresponding to the source digital wallet, that the transaction amount is available in the source digital wallet;
   cryptographically record the transaction record datastructure in a blockchain;
   receive the source address and the destination address;
   hash the source address using a bloom filter to generate a source wallet address;
   hash the destination address using the bloom filter to generate a destination wallet address;
   add the source wallet address as a first row and a column entry to a matrix datastructure representing a weighted graph of the plurality of transactions;
   add the destination wallet address as a second row and column entry to the matrix datastructure representing a weighted graph of the plurality of transactions;
   add the transaction amount and the timestamp as an entry to the row corresponding to the source wallet address and the column corresponding to the destination wallet address; and
   generate a list representation of the matrix datastructure, where each entry in the list comprises a tuple having the source wallet address, the destination wallet address, the transaction amount and the timestamp.
E22. The medium of embodiment E21, the component collection further comprising an Auditing component, in which the processor issues instructions from the Auditing component, stored in the memory, to:
   receive a request to search for a prior transaction including the source address;
   obtain the source wallet address corresponding to the source address from the bloom filter component;
   search the list for the tuple including the source wallet address; and
   when the tuple comprises the source wallet address, retrieve the timestamp corresponding to the transaction, decrypt a segment of the blockchain corresponding to the timestamp, and retrieve the transaction record datastructure corresponding to the transaction from the segment of the blockchain.
E23. The medium of embodiment E21, in which a list-of-lists datastructure includes at least one tuple per list with each entry containing the row index, the column index and the value; and, further comprising:
   updating incremental matrix construction as an updated list-of-lists datastructure with new transaction details structured as searchable.
E24. The medium of embodiment E21, in which the source address comprises a hash of a source public key, the source public key comprises a string of alphanumeric characters greater than 27 characters in length.
E25. The medium of embodiment E21, in which the source address comprises a RIPEMD-160 hash of an SHA256 hash of a source public key.
E26. The medium of embodiment E21, in which the destination address comprises a hash of a destination public key, the destination public key comprises a string of alphanumeric characters greater than 27 characters in length.
E27. The medium of embodiment E21, in which the destination address comprises a RIPEMD-160 hash of an SHA256 hash of the source address.
E28. The medium of embodiment E21, in which the transaction comprises a virtual currency transaction.
E29. The medium of embodiment E21, further comprising the bloom filter, the bloom filter comprising a linear congruential generator (LCG) algorithm that hashes the source address having a first storage bandwidth requirement into a sequence of pseudo-randomized outputs having a second storage bandwidth requirement that is lower than the first storage bandwidth requirement.
E30. The medium of embodiment E29, in which the source address cannot be recovered from the sequence using a reverse hashing algorithm.
E31. The medium of embodiment E29, the LCG is used to hash the source address several times to generate the sequence.
E32. The medium of embodiment E29, in which the LCG is applied to separate segments of the source address to generate the sequence.
E33. The medium of embodiment E21, in which the bloom filter hashes the destination address having a first storage bandwidth requirement into a sequence of pseudo-randomized outputs having a second storage bandwidth requirement that is lower than the first storage bandwidth requirement.
E34. The medium of embodiment E33, in which the destination address cannot be recovered from the sequence using a reverse hashing algorithm.
E35. The medium of embodiment E33, the bloom filter is used to hash the destination address several times to generate the sequence.
E36. The medium of embodiment E33, in which the bloom filter is applied to separate segments of the destination address to generate the sequence.
E37. The medium of embodiment E21, in which the matrix datastructure contains a transaction amount that corresponds to an outflow of the transaction amount from the source address to the destination address.
E38. The medium of embodiment E21, in which the matrix datastructure contains a transaction amount that corresponds to an inflow of the transaction amount from the source address to the destination address.
E39. The medium of embodiment E21, in which the processor issues instructions from the bloom filter component, stored in the memory, to:
   determine a list of corresponding false positives for hash of the source address; and
   store the source wallet address with a list of the corresponding false positives.
E40. The medium of embodiment E21, in which the processor issues instructions from the bloom filter component, stored in the memory, to:
   determine a list of corresponding false positives for hash of the destination address; and
   store the destination wallet address with a list of the corresponding false positives.
E41. A blockchain transaction data auditing processor-implemented system, comprising: means to store a component collection;
means to process processor-executable instructions from the component collection, storage of the component collection structured with processor-executable instructions comprising:
   receive a plurality of transaction record datastructures for each of a plurality of transactions, each transaction record datastructure comprising a source address, a destination address, a transaction amount and a timestamp of a transaction;
   verify, via the source address corresponding to the source digital wallet, that the transaction amount is available in the source digital wallet;
   cryptographically record the transaction record datastructure in a blockchain;
   receive the source address and the destination address;
   hash the source address using a bloom filter to generate a source wallet address;
   hash the destination address using the bloom filter to generate a destination wallet address;
   add the source wallet address as a first row and a column entry to a matrix datastructure representing a weighted graph of the plurality of transactions;
   add the destination wallet address as a second row and column entry to the matrix datastructure representing a weighted graph of the plurality of transactions;
   add the transaction amount and the timestamp as an entry to the row corresponding to the source wallet address and the column corresponding to the destination wallet address; and
   generate a list representation of the matrix datastructure, where each entry in the list comprises a tuple having the source wallet address, the destination wallet address, the transaction amount and the timestamp.
E42. The system of embodiment E41, the component collection further comprising an Auditing component, in which the processor issues instructions from the Auditing component, stored in the memory, to:
   receive a request to search for a prior transaction including the source address;
   obtain the source wallet address corresponding to the source address from the bloom filter component;
   search the list for the tuple including the source wallet address; and
   when the tuple comprises the source wallet address, retrieve the timestamp corresponding to the transaction, decrypt a segment of the blockchain corresponding to the timestamp, and retrieve the transaction record datastructure corresponding to the transaction from the segment of the blockchain.
E43. The system of embodiment E41, in which a list-of-lists datastructure includes at least one tuple per list with each entry containing the row index, the column index and the value; and, further comprising:
   updating incremental matrix construction as an updated list-of-lists datastructure with new transaction details structured as searchable.
E44. The system of embodiment E41, in which the source address comprises a hash of a source public key, the source public key comprises a string of alphanumeric characters greater than 27 characters in length.
E45. The system of embodiment E41, in which the source address comprises a RIPEMD-160 hash of an SHA256 hash of a source public key.
E46. The system of embodiment E41, in which the destination address comprises a hash of a destination public key, the destination public key comprises a string of alphanumeric characters greater than 27 characters in length.
E47. The system of embodiment E41, in which the destination address comprises a RIPEMD-160 hash of an SHA256 hash of the source address.
E48. The system of embodiment E41, in which the transaction comprises a virtual currency transaction.
E49. The system of embodiment E41, further comprising the bloom filter, the bloom filter comprising a linear congruential generator (LCG) algorithm that hashes the source address having a first storage bandwidth requirement into a sequence of pseudo-randomized outputs having a second storage bandwidth requirement that is lower than the first storage bandwidth requirement.
E50. The system of embodiment E49, in which the source address cannot be recovered from the sequence using a reverse hashing algorithm.
E51. The system of embodiment E49, the LCG is used to hash the source address several times to generate the sequence.
E52. The system of embodiment E49, in which the LCG is applied to separate segments of the source address to generate the sequence.
E53. The system of embodiment E41, in which the bloom filter hashes the destination address having a first storage bandwidth requirement into a sequence of pseudo-randomized outputs having a second storage bandwidth requirement that is lower than the first storage bandwidth requirement.
E54. The system of embodiment E53, in which the destination address cannot be recovered from the sequence using a reverse hashing algorithm.
E55. The system of embodiment E53, the bloom filter is used to hash the destination address several times to generate the sequence.
E56. The system of embodiment E53, in which the bloom filter is applied to separate segments of the destination address to generate the sequence.
E57. The system of embodiment E41, in which the matrix datastructure contains a transaction amount that corresponds to an outflow of the transaction amount from the source address to the destination address.
E58. The system of embodiment E41, in which the matrix datastructure contains a transaction amount that corresponds to an inflow of the transaction amount from the source address to the destination address.
E59. The system of embodiment E41, in which the processor issues instructions from the bloom filter component, stored in the memory, to:
   determine a list of corresponding false positives for hash of the source address; and
   store the source wallet address with a list of the corresponding false positives.
E60. The system of embodiment E41, in which the processor issues instructions from the bloom filter component, stored in the memory, to:
   determine a list of corresponding false positives for hash of the destination address; and
   store the destination wallet address with a list of the corresponding false positives.
E61. A blockchain transaction data auditing processor-implemented process, including processing processor-executable instructions via any of at least one processor from a component collection stored in at least one memory, storage of the component collection structured with processor-executable instructions comprising:
   receive a plurality of transaction record datastructures for each of a plurality of transactions, each transaction record datastructure comprising a source address, a destination address, a transaction amount and a timestamp of a transaction;
   verify, via the source address corresponding to the source digital wallet, that the transaction amount is available in the source digital wallet;
   cryptographically record the transaction record datastructure in a blockchain;
   receive the source address and the destination address;
   hash the source address using a bloom filter to generate a source wallet address;
   hash the destination address using the bloom filter to generate a destination wallet address;
   add the source wallet address as a first row and a column entry to a matrix datastructure representing a weighted graph of the plurality of transactions;
   add the destination wallet address as a second row and column entry to the matrix datastructure representing a weighted graph of the plurality of transactions;
   add the transaction amount and the timestamp as an entry to the row corresponding to the source wallet address and the column corresponding to the destination wallet address; and
   generate a list representation of the matrix datastructure, where each entry in the list comprises a tuple having the source wallet address, the destination wallet address, the transaction amount and the timestamp.
E62. The process of embodiment E61, the component collection further comprising an Auditing component, in which the processor issues instructions from the Auditing component, stored in the memory, to:
   receive a request to search for a prior transaction including the source address;
   obtain the source wallet address corresponding to the source address from the bloom filter component;
   search the list for the tuple including the source wallet address; and
   when the tuple comprises the source wallet address, retrieve the timestamp corresponding to the transaction, decrypt a segment of the blockchain corresponding to the timestamp, and retrieve the transaction record datastructure corresponding to the transaction from the segment of the blockchain.
E63. The process of embodiment E61, in which a list-of-lists datastructure includes at least one tuple per list with each entry containing the row index, the column index and the value; and, further comprising:
   updating incremental matrix construction as an updated list-of-lists datastructure with new transaction details structured as searchable.
E64. The process of embodiment E61, in which the source address comprises a hash of a source public key, the source public key comprises a string of alphanumeric characters greater than 27 characters in length.
E65. The process of embodiment E61, in which the source address comprises a RIPEMD-160 hash of an SHA256 hash of a source public key.
E66. The process of embodiment E61, in which the destination address comprises a hash of a destination public key, the destination public key comprises a string of alphanumeric characters greater than 27 characters in length.
E67. The process of embodiment E61, in which the destination address comprises a RIPEMD-160 hash of an SHA256 hash of the source address.
E68. The process of embodiment E61, in which the transaction comprises a virtual currency transaction.
E69. The process of embodiment E61, further comprising the bloom filter, the bloom filter comprising a linear congruential generator (LCG) algorithm that hashes the source address having a first storage bandwidth requirement into a sequence of pseudo-randomized outputs having a second storage bandwidth requirement that is lower than the first storage bandwidth requirement.
E70. The process of embodiment E69, in which the source address cannot be recovered from the sequence using a reverse hashing algorithm.
E71. The process of embodiment E69, the LCG is used to hash the source address several times to generate the sequence.
E72. The process of embodiment E69, in which the LCG is applied to separate segments of the source address to generate the sequence.
E73. The process of embodiment E61, in which the bloom filter hashes the destination address having a first storage bandwidth requirement into a sequence of pseudo-randomized outputs having a second storage bandwidth requirement that is lower than the first storage bandwidth requirement.
E74. The process of embodiment E73, in which the destination address cannot be recovered from the sequence using a reverse hashing algorithm.
E75. The process of embodiment E73, the bloom filter is used to hash the destination address several times to generate the sequence.
E76. The process of embodiment E73, in which the bloom filter is applied to separate segments of the destination address to generate the sequence.
E77. The process of embodiment E61, in which the matrix datastructure contains a transaction amount that corresponds to an outflow of the transaction amount from the source address to the destination address.
E78. The process of embodiment E61, in which the matrix datastructure contains a transaction amount that corresponds to an inflow of the transaction amount from the source address to the destination address.
E79. The process of embodiment E61, in which the processor issues instructions from the bloom filter component, stored in the memory, to:
   determine a list of corresponding false positives for hash of the source address; and
   store the source wallet address with a list of the corresponding false positives.
E80. The process of embodiment E61, in which the processor issues instructions from the bloom filter component, stored in the memory, to:
   determine a list of corresponding false positives for hash of the destination address; and
   store the destination wallet address with a list of the corresponding false positives.

### SOCOACT Controller

FIG. 173 shows a block diagram illustrating non-limiting, example embodiments of a SOCOACT controller. In this embodiment, the SOCOACT controller 17301 may serve to aggregate, process, store, search, serve, identify, instruct, generate, match, and/or facilitate interactions with a computer through information technology technologies, and/or other related data.

Users, which may be people and/or other systems, may engage information technology systems (e.g., computers) to facilitate information processing. In turn, computers employ processors to process information; such processors 17303 may be referred to as central processing units (CPU). One form of processor is referred to as a microprocessor. CPUs use communicative circuits to pass binary encoded signals acting as instructions to allow various operations. These instructions may be operational and/or data instructions containing and/or referencing other instructions and data in various processor accessible and operable areas of memory 17329 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SOCOACT controller 17301 may be connected to and/or communicate with entities such as, but not limited to any of: one or more users from peripheral devices 17312 (e.g., user input devices 17311); an optional cryptographic processor device 17328; and/or a communications network 17313.

Networks comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is referred to as a “node.” Networks are generally thought to facilitate the transfer of information from source points to destinations. A node specifically tasked with furthering the passage of information from a source to a destination is called a “router.” There are many forms of networks such as Local Area Networks (LANs), Pico networks, Wide Area Networks (WANs), Wireless Networks (WLANs), etc. For example, the Internet is, generally, an interconnection of a multitude of networks whereby remote clients and servers may access and interoperate with one another.

The SOCOACT controller 17301 may be based on computer systems that may comprise, but are not limited to, components such as any of: a computer systemization 17302 connected to memory 17329.

### Computer Systemization

A computer systemization 17302 may comprise a clock 17330, central processing unit (“CPU(s)” and/or “processor(s)” (these terms are used interchangeably throughout the disclosure unless noted to the contrary)) 17303, a memory 17329 (e.g., a read only memory (ROM) 17306, a random access memory (RAM) 17305, etc.), and/or an interface bus 17307, and most frequently, although not necessarily, are all interconnected and/or communicating through a system bus 17304 on one or more (mother) board(s) 17302 having conductive and/or otherwise transportive circuit pathways through which instructions (e.g., binary encoded signals) may travel to effectuate communications, operations, storage, etc. The computer systemization may be connected to a power source 17386; e.g., optionally the power source may be internal. Optionally, a cryptographic processor 17326 may be connected to the system bus. In another embodiment, the cryptographic processor, transceivers (e.g., ICs) 17374, and/or sensor array (e.g., any of: accelerometer, altimeter, ambient light, barometer, global positioning system (GPS) (thereby allowing SOCOACT controller to determine its location), gyroscope, magnetometer, pedometer, proximity, ultra-violet sensor, etc.) 17373 may be connected as either internal and/or external peripheral devices 17312 via the interface bus I/O 17308 (not pictured) and/or directly via the interface bus 17307. In turn, the transceivers may be connected to antenna(s) 17375, thereby effectuating wireless transmission and reception of various communication and/or sensor protocols; for example the antenna(s) may connect to various transceiver chipsets (depending on deployment needs), including any of: Broadcom® BCM4329FKUBG transceiver chip (e.g., providing 802.11n, Bluetooth® 2.1+EDR, FM, etc.); a Broadcom® BCM4752 GPS receiver with accelerometer, altimeter, GPS, gyroscope, magnetometer; a Broadcom® BCM4335 transceiver chip (e.g., providing 2G, 3G, and 4G long-term evolution (LTE) cellular communications; 802.11ac, Bluetooth® 4.0 low energy (LE) (e.g., beacon features)); a Broadcom® BCM43341 transceiver chip (e.g., providing 2G, 3G and 4G LTE cellular communications; 802.11g, Bluetooth® 4.0, near field communication (NFC), FM radio); an Infineon Technologies® X-Gold 618-PMB9800 transceiver chip (e.g., providing 2G/3G HSDPA/HSUPA communications); a MediaTek® MT6620 transceiver chip (e.g., providing 802.11n (also known as WiFi® in numerous iterations), Bluetooth® 4.0 LE, FM, GPS; a Lapis Semiconductor® ML8511 UV sensor; a Maxim Integrated® MAX44000 ambient light and infrared proximity sensor; a Texas Instruments® WiLink® WL1283 transceiver chip (e.g., providing 802.11n, Bluetooth® 3.0, FM, GPS); and/or the like. The system clock may have a crystal oscillator and generates a base signal through the computer systemization's circuit pathways. The clock may be coupled to the system bus and various clock multipliers that may increase or decrease the base operating frequency for other components interconnected in the computer systemization. The clock and various components in a computer systemization drive signals embodying information throughout the system. Such transmission and reception of instructions embodying information throughout a computer systemization may be referred to as communications. These communicative instructions may further be transmitted, received, and the cause of return and/or reply communications beyond the instant computer systemization to any of: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU is often packaged in a number of formats varying from large supercomputer(s) and mainframe(s) computers, down to mini computers, servers, desktop computers, laptops, thin clients (e.g., Chromebooks®), netbooks, tablets (e.g., Android®, iPads®, and Windows® tablets, etc.), mobile smartphones (e.g., Android®, iPhones®, Nokia®, Palm® and Windows® phones, etc.), wearable device(s) (e.g., headsets (e.g., Apple AirPods (Pro)®, glasses, goggles (e.g., Apple Vision Pro®, Google Glass®), watches, etc.), and/or the like. Often, the processors themselves may incorporate various specialized processing units, such as, but not limited to any of: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 17329 beyond the processor itself; internal memory may include, but is not limited to any of: fast registers, various levels of cache memory (e.g., level 1, 2, 3, etc.), (dynamic/static) RAM, solid state memory, etc. The processor may access this memory through the use of a memory address space that is accessible via instruction address, which the processor can construct and decode allowing it to access a circuit path to a specific memory address space having a memory state. The CPU may be a microprocessor such as: AMD's® Athlon®, Duron® and/or Opteron®; Apple's® A, M, S, U series of processors (e.g., A5, A6, A7, A8 . . . . M1, M2 . . . . S1, S2 . . . . U1 . . . , etc.); ARM's® application, embedded and secure processors; IBM® and/or Motorola's DragonBall® and PowerPC®; IBM's® and Sony's® Cell processor; Intel's® 80X86 series (e.g., 80386, 80486), Pentium®, Celeron®, Core (2) Duo®, i series (e.g., i3, i5, i7, i9, etc.), Itanium®, Xeon®, and/or XScale®; Motorola's® 680X0 series (e.g., 68020, 68030, 68040, etc.); and/or the like processor(s). The CPU interacts with memory through instruction passing through conductive and/or transportive conduits (e.g., (printed) electronic and/or optic circuits) to execute stored instructions (i.e., program code), e.g., via load/read address commands; e.g., the CPU may read processor issuable instructions from memory (e.g., reading it from a component collection (e.g., an interpreted and/or compiled program application/library including allowing the processor to execute instructions from the application/library) stored in the memory). Such instruction passing facilitates communication within the SOCOACT controller and beyond through various interfaces. Should processing requirements dictate a greater amount speed and/or capacity, distributed processors (e.g., see Distributed SOCOACT below), mainframe, multi-core, parallel, and/or super-computer architectures may similarly be employed. Alternatively, should deployment requirements dictate greater portability, smaller mobile devices (e.g., Personal Digital Assistants (PDAs)) may be employed.

Depending on the particular implementation, features of the SOCOACT may be achieved by implementing a microcontroller such as any of: CAST's® R8051XC2 microcontroller; Diligent's® Basys 3 Artix-7, Nexys A7-100T, U192015125IT, etc.; Intel's® MCS 51 (i.e., 8051 microcontroller); and/or the like. Also, to implement certain features of the SOCOACT, some feature implementations may rely on embedded components, such as any of: Application-Specific Integrated Circuit (“ASIC”), Digital Signal Processing (“DSP”), Field Programmable Gate Array (“FPGA”), and/or the like embedded technology. For example, any of the SOCOACT component collection (distributed or otherwise) and/or features may be implemented via the microprocessor and/or via embedded components; e.g., via any of: ASIC, coprocessor, DSP, FPGA, and/or the like. Alternately, some implementations of the SOCOACT may be implemented with embedded components that are configured and used to achieve a variety of features or signal processing.

Depending on the particular implementation, the embedded components may include software solutions, hardware solutions, and/or some combination of both hardware/software solutions. For example, SOCOACT features discussed herein may be achieved through implementing FPGAs, which are a semiconductor devices containing programmable logic components called “logic blocks”, and programmable interconnects, such as any of: the high performance FPGA Virtex® series, the low cost Spartan® series manufactured by Xilinx®, and/or the like. Logic blocks and interconnects can be programmed by the customer or designer, after the FPGA is manufactured, to implement any of the SOCOACT features. A hierarchy of programmable interconnects allow logic blocks to be interconnected as needed by the SOCOACT system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the SOCOACT may be developed on FPGAs and then migrated into a fixed version that more resembles ASIC implementations. Alternate or coordinating implementations may migrate SOCOACT controller features to a final ASIC instead of or in addition to FPGAs. Depending on the implementation all of the aforementioned embedded components and microprocessors may be considered the “CPU” and/or “processor” for the SOCOACT.

### Power Source

The power source 17386 may be of any various form for powering small electronic circuit board devices such as any of the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 17386 is connected to at least one of the interconnected subsequent components of the SOCOACT thereby providing an electric current to all subsequent components. In one example, the power source 17386 is connected to the system bus component 17304. In an alternative embodiment, an outside power source 17386 is provided through a connection across the I/O 17308 interface. For example, Ethernet (with power on Ethernet), IEEE 1394, USB and/or the like connections carry both data and power across the connection and is therefore a suitable source of power.

### Interface Adapters

Interface bus(ses) 17307 may accept, connect, and/or communicate to a number of interface adapters, variously although not necessarily in the form of adapter cards, such as but not limited to any of: input output interfaces (I/O) 17308, storage interfaces 17309, network interfaces 17310, and/or the like. Optionally, cryptographic processor interfaces 17327 similarly may be connected to the interface bus. The interface bus provides for the communications of interface adapters with one another as well as with other components of the computer systemization. Interface adapters are adapted for a compatible interface bus. Interface adapters variously connect to the interface bus via a slot architecture. Various slot architectures may be employed, such as, but not limited to any of: Accelerated Graphics Port (AGP), Card Bus, (Extended) Industry Standard Architecture ((E)ISA), Micro Channel Architecture (MCA), NuBus, Peripheral Component Interconnect (Extended) (PCI (X)), PCI Express, Personal Computer Memory Card International Association (PCMCIA), and/or the like.

Storage interfaces 17309 may accept, communicate, and/or connect to a number of storage devices such as, but not limited to any of: (removable) storage devices 17314, removable disc devices, and/or the like. Storage interfaces may employ connection protocols such as, but not limited to any of: (Ultra) (Serial) Advanced Technology Attachment (Packet Interface) ((Ultra) (Serial) ATA(PI)), (Enhanced) Integrated Drive Electronics ((E) IDE), Institute of Electrical and Electronics Engineers (IEEE®) 1394, fiber channel, Non-Volatile Memory (NVM) Express (NVMe), Small Computer Systems Interface (SCSI), Thunderbolt, Universal Serial Bus (USB), and/or the like.

Network interfaces 17310 may accept, communicate, and/or connect to a communications network 17313. Through a communications network 17313, the SOCOACT controller is accessible through remote clients 17333b (e.g., computers with web browsers) by users 17333a. Network interfaces may employ connection protocols such as, but not limited to any of: direct connect, Ethernet (e.g., any of: fiber, thick, thin, twisted pair 10/100/1000/10000 Base T, and/or the like), Token Ring, wireless connection such as IEEE 802.11a-y, and/or the like. Should processing requirements dictate a greater amount speed and/or capacity, distributed network controllers (e.g., see Distributed SOCOACT below), architectures may similarly be employed to pool, load balance, and/or otherwise decrease/increase the communicative bandwidth required by the SOCOACT controller. A communications network may be any one and/or the combination of the following: a direct interconnection; the Internet; Interplanetary Internet (e.g., Coherent File Distribution Protocol (CFDP), Space Communications Protocol Specifications (SCPS), etc.); a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a cellular, WiFi®, Wireless Application Protocol (WAP), I-mode, and/or the like); and/or the like. A network interface may be regarded as a specialized form of an input output interface. Further, multiple network interfaces 17310 may be used to engage with various communications network types 17313. For example, multiple network interfaces may be employed to allow for the communication over broadcast, multicast, and/or unicast networks.

Input Output interfaces (I/O) 17308 may accept, communicate, and/or connect to any of: user, peripheral devices 17312 (e.g., input devices 17311), cryptographic processor devices 17328, and/or the like. I/O may employ connection protocols such as, but not limited to any of: audio: analog, digital, monaural, RCA, stereo, and/or the like; data: Apple Desktop Bus (ADB)®, IEEE 1394a-b, serial, universal serial bus (USB); infrared; joystick; keyboard; midi; optical; PC AT; PS/2; parallel; radio; touch interfaces: capacitive, optical, resistive, etc. displays; video interface: Apple Desktop Connector (ADC), BNC, coaxial, component, composite, digital, Digital Visual Interface (DVI), (mini) displayport, high-definition multimedia interface (HDMI), RCA, RF antennae, S-Video, Thunderbolt®/USB-C, VGA, and/or the like; wireless transceivers: 802.11a-y; Bluetooth®; cellular (e.g., code division multiple access (CDMA), high speed packet access (HSPA (+)), high-speed downlink packet access (HSDPA), global system for mobile communications (GSM), long term evolution (LTE), WiMax®, etc.); and/or the like. One output device may include a video display, which may comprise a Cathode Ray Tube (CRT), Liquid Crystal Display (LCD), Light-Emitting Diode (LED), Organic Light-Emitting Diode (OLED), and/or the like based monitor with an interface (e.g., HDMI circuitry and cable) that accepts signals from a video interface, may be used. The video interface composites information generated by a computer systemization and generates video signals based on the composited information in a video memory frame. Another output device is a television set, which accepts signals from a video interface. The video interface provides the composited video information through a video connection interface that accepts a video display interface (e.g., an RCA composite video connector accepting an RCA composite video cable; a DVI connector accepting a DVI display cable, etc.).

Peripheral devices 17312 may be connected and/or communicate to I/O and/or other facilities of the like such as any of: network interfaces, storage interfaces, directly to the interface bus, system bus, the CPU, and/or the like. Peripheral devices may be external, internal and/or part of the SOCOACT controller. Peripheral devices may include any of: antenna, audio devices (e.g., line-in, line-out, microphone input, speakers, etc.), cameras (e.g., gesture (e.g., Microsoft Kinect®) detection, motion detection, still, video, webcam, etc.), dongles (e.g., for copy protection ensuring secure transactions with a digital signature, as connection/format adaptors, and/or the like), external processors (for added capabilities; e.g., crypto devices 528), force-feedback devices (e.g., vibrating motors), infrared (IR) transceiver, network interfaces, printers, scanners, sensors/sensor arrays and peripheral extensions (e.g., ambient light, GPS, gyroscopes, proximity, temperature, etc.), storage devices, transceivers (e.g., cellular, GPS, etc.), video devices (e.g., goggles, monitors, etc.), video sources, visors, and/or the like. Peripheral devices often include types of input devices (e.g., cameras).

User input devices 17311 often are a type of peripheral device 512 (see above) and may include any of: accelerometers, camaras, card readers, dongles, finger print readers, gloves, graphics tablets, joysticks, keyboards, microphones, mouse (mice), remote controls, security/biometric devices (e.g., facial identifiers, fingerprint reader, iris reader, retina reader, etc.), styluses, touch screens (e.g., capacitive, resistive, etc.), trackballs, trackpads, watches, and/or the like.

It should be noted that although user input devices and peripheral devices may be employed, the SOCOACT controller may be embodied as an embedded, dedicated, and/or monitor-less (i.e., headless) device, and access may be provided over a network interface connection.

Cryptographic units such as, but not limited to any of: microcontrollers, processors 17326, interfaces 17327, and/or devices 17328 may be attached, and/or communicate with the SOCOACT controller. A MC68HC16 microcontroller, manufactured by Motorola, Inc.®, may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other specialized cryptographic processors include any of: Broadcom's® CryptoNetX and other Security Processors; nCipher's® nShield; SafeNet's® Luna PCI (e.g., 7100) series; Semaphore Communications'® 40 MHz Roadrunner 184; Sun's® Cryptographic Accelerators (e.g., Accelerator 6000 PCIe Board, Accelerator 500 Daughtercard); Via Nano® Processor (e.g., L2100, L2200, U2400) line, which is capable of performing 500+MB/s of cryptographic instructions; VLSI Technology's® 33 MHz 6868; and/or the like.

### Memory

Generally, any mechanization and/or embodiment allowing a processor to affect the storage and/or retrieval of information is regarded as memory 17329. The storing of information in memory may result in a physical alteration of the memory to have a different physical state that makes the memory a (e.g., physical) structure with a unique encoding of the memory stored therein. While memory is often physical and/or non-transitory, short term transitory memories may also be employed in various contexts, e.g., network communication may also be employed to send data as signals acting as transitory as well, for applications not requiring more long-term storage. Often, memory is a fungible technology and resource, thus, any number of memory embodiments may be employed in lieu of or in concert with one another. It is to be understood that the SOCOACT controller and/or a computer systemization may employ various forms of memory 17329. For example, a computer systemization may be configured to have the operation of on-chip CPU memory (e.g., registers), RAM, ROM, and any other storage devices performed by a paper punch tape or paper punch card mechanism; however, such an embodiment would result in an extremely slow rate of operation. In one configuration, memory 17329 may include ROM 17306, RAM 17305, and a storage device 17314. A storage device 17314 may be any various computer system storage. Storage devices may include: an array of devices (e.g., Redundant Array of Independent Disks (RAID)); a cache memory, a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); RAM drives; register memory (e.g., in a CPU), solid state memory devices (e.g., USB memory, solid state drives (SSD), etc.); other processor-readable storage mediums; and/or other devices of the like. Thus, a computer systemization generally employs and makes use of memory.

### Component Collection

The memory 17329 may contain a collection of processor-executable application/library/program and/or database components (e.g., including processor-executable instructions) and/or data such as, but not limited to any of: operating system component(s) 17315 (operating system); information server component(s) 17316 (information server); user interface component(s) 17317 (user interface); Web browser component(s) 17318 (Web browser); database(s) 17319; mail server component(s) 17321; mail client component(s) 17322; cryptographic server component(s) 17320 (cryptographic server); machine learning component 17323; distributed immutable ledger component 17324; the SOCOACT component(s) 17335 (e.g., which may include Virtual Currency, Blockchain, Transact. Confirm., TTI, TTP, OP, AF, SF, TV, TP, AA, IEP, BSA, TPO, SFTS, BUKB, SFKB, RUKR, SFKR, TSTS, NTSTS, HSFTS, FTSTS, CSFTS, TSCD, SFCD, TSCTS, SFCTS, NTSITS, FTSITS, SFITS, MOWUMTS, NTSUMTS, HSFUMTS, FTSUMTS, CSFUMTS 17341A-17358A, 17341B-17347B, 17341C-17342C, 17341D-17360D, and/or the like components); and/or the like (i.e., collectively referred to throughout as a “component collection”). These components may be stored and accessed from the storage devices and/or from storage devices accessible through an interface bus. Although unconventional program components such as those in the component collection may be stored in a local storage device 17314, they may also be loaded and/or stored in memory such as: cache, peripheral devices, processor registers, RAM, remote storage facilities through a communications network, ROM, various forms of memory, and/or the like.

### Operating System

The operating system component 17315 is an executable program component facilitating the operation of the SOCOACT controller. The operating system may facilitate access to any of: I/O, network interfaces, peripheral devices, storage devices, and/or the like. The operating system may be a highly fault tolerant, scalable, and secure system such as any of: Apple's Macintosh OS X® (Server) and macOS®; AT&T® Plan 9R; Be OS®; Blackberry's QNX®; Google's Chrome®; Microsoft's Windows® Jul. 8, 2010; Unix and Unix-like system distributions (such as AT&T's® UNIX®; Berkley Software Distribution (BSD)® variations such as FreeBSD®, NetBSD®, OpenBSD®, and/or the like; Linux® distributions such as Red Hat®, Ubuntu®, and/or the like); and/or the like operating systems. However, more limited and/or less secure operating systems also may be employed such as any of: Apple Macintosh OS® (i.e., versions 1-9), IBM OS/2®, Microsoft DOS® Microsoft Windows® 2000/2003/3.1/95/98/CE/Millennium/Mobile/NT/Vista/XP/7/X (Server)®, Palm OS®, and/or the like. Additionally, for robust mobile deployment applications, mobile operating systems may be used, such as any of: Apple's iOS®; China Operating System COS®; Google's Android®; Microsoft® Windows® RT/Phone®; Palm's WebOS®; Samsung®/Intel's Tizen®; and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may facilitate the interaction with any of: communications networks, data, I/O, peripheral devices, program components, memory, user input devices, and/or the like. The operating system may provide communications protocols that allow the SOCOACT controller to communicate with other entities through a communications network 17313. Various communication protocols may be used by the SOCOACT controller as a subcarrier transport mechanism for interaction, such as, but not limited to any of: multicast, TCP/IP, UDP, unicast, and/or the like.

### Information Server

An information server component 17316 is a stored program component that is executed by a CPU. The information server may be an Internet information server such as, but not limited to any of: Apache Software Foundation's Apache®, Microsoft's Internet Information Server®, and/or the like. The information server may allow for the execution of program components through facilities such as any of: Active Server Page (ASP), ActiveX, (ANSI) (Objective-) C (++), C# and/or .NET®, Common Gateway Interface (CGI) scripts, dynamic (D) hypertext markup language (HTML), FLASH®, Java®, JavaScript®, Practical Extraction Report Language (PERL)®, Hypertext Pre-Processor (PHP), pipes, Python®, Ruby, wireless application protocol (WAP), WebObjects®, and/or the like. The information server may support secure communications protocols such as, but not limited to any of: File Transfer Protocol (FTP(S)); HyperText Transfer Protocol (HTTP); Secure Hypertext Transfer Protocol (HTTPS), Secure Socket Layer (SSL) Transport Layer Security (TLS), messaging protocols (e.g., America Online (AOL®) Instant Messenger (AIM)®, Application Exchange (APEX), ICQ, Internet Relay Chat (IRC), Microsoft Network (MSN) Messenger® Service, Presence and Instant Messaging Protocol (PRIM), Internet Engineering Task Force's® (IETF's) Session Initiation Protocol (SIP), SIP for Instant Messaging and Presence Leveraging Extensions (SIMPLE), Slack®, open XML-based Extensible Messaging and Presence Protocol (XMPP) (i.e., Jabber® or Open Mobile Alliance's (OMA's) Instant Messaging and Presence Service (IMPS)), Yahoo! Instant Messenger® Service, and/or the like). The information server may provide results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SOCOACT controller based on the remainder of the HTTP request. For example, a request such as http://followed by the address, e.g., 123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with any of: the SOCOACT database 17319, operating systems, other program components, user interfaces, Web browsers, and/or the like.

Access to the SOCOACT database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SOCOACT. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in SQL by instantiating a search string with the proper join/select commands based on the tagged text entries, and the resulting command is provided over the bridge mechanism to the SOCOACT as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as buttons, check boxes, cursors, graphical views, menus, scrollers, text fields, and windows (collectively referred to as widgets) similarly facilitate the access, capabilities, operation, and display of data and computer hardware and operating system resources, and status. Operation interfaces are called user interfaces. Graphical user interfaces (GUIs) such as the Apple's iOS®, Macintosh Operating System's Aqua®; IBM's OS/2®; Google's Chrome® (e.g., and other webbrowser/cloud based client OSs); Microsoft's Windows® 2000/2003/3.1/95/98/CE/Millennium/Mobile/NT/Vista/XP/7/X (Server)® (i.e., Aero, Surface, etc.); Unix's X-Windows (e.g., which may include additional Unix graphic interface libraries and layers such as K Desktop Environment (KDE)®, mythTV and GNU Network Object Model Environment (GNOME))®, web interface libraries (e.g., ActiveX®, AJAX, (D) HTML, FLASH®, Java®, JavaScript®, etc. interface libraries such as, but not limited to any of: Dojo, jQuery (UI), MooTools, Prototype, script.aculo.us, SWFObject, Yahoo! User Interface®, and/or the like, any of which may be used and) provide a baseline and mechanism of accessing and displaying information graphically to users.

A user interface component 17317 is a stored program component that is executed by a CPU. The user interface may be a graphic user interface as provided by, with, and/or atop operating systems and/or operating environments, and may provide executable library APIs (as may operating systems and the numerous other components noted in the component collection) that allow instruction calls to generate user interface elements such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 17318 is a stored program component that is executed by a CPU. The Web browser may be a hypertext viewing application such as any of: Apple's (mobile) Safari®, Brave Software, Inc.'s Brave Browser (including Virtual Private Network (VPN) features), Google's Chrome®, Microsoft Edge®, Microsoft Internet Explorer®, Mozilla's Firefox®, Netscape Navigator®, The Tor Project, Inc,'s Tor Browser® (including VPN features), and/or the like. Secure Web browsing may be supplied with 128 bit (or greater) encryption by way of HTTPS, SSL, and/or the like. Web browsers allowing for the execution of program components through facilities such as any of: ActiveX®, AJAX, (D) HTML, FLASH®, Java®, JavaScript®, web browser plug-in APIs (e.g., FireFox®, Safari® Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with any of: information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the SOCOACT enabled nodes. The combined application may be nugatory on systems employing Web browsers.

### Mail Server

A mail server component 17321 is a stored program component that is executed by a CPU 17303. The mail server may be an Internet mail server such as, but not limited to any of: dovecot, Courier IMAP, Cyrus IMAP, Maildir, Microsoft Exchange®, sendmail, and/or the like. The mail server may allow for the execution of program components through facilities such as any of: ASP, ActiveX®, (ANSI) (Objective-) C (++), C# and/or .NET, CGI scripts, Java®, JavaScript®, PERL®, PHP, pipes, Python®, WebObjects®, and/or the like. The mail server may support communications protocols such as, but not limited to any of: Internet message access protocol (IMAP), Messaging Application Programming Interface (MAPI)/Microsoft Exchange®, post office protocol (POP3), simple mail transfer protocol (SMTP), and/or the like. The mail server can route, forward, and process incoming and outgoing mail messages that have been sent, relayed and/or otherwise traversing through and/or to the SOCOACT. Alternatively, the mail server component may be distributed out to mail service providing entities such as Google's® cloud services (e.g., Gmail® and notifications may alternatively be provided via messenger services such as AOL's Instant Messenger®, Apple's iMessage®, Google Messenger®, SnapChat®, etc.).

Access to the SOCOACT mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 17322 is a stored program component that is executed by a CPU 17303. The mail client may be a mail viewing application such as any of: Apple Mail®, Microsoft Entourage®, Microsoft Outlook®, Microsoft Outlook Express®, Mozilla®, Thunderbird®, and/or the like. Mail clients may support a number of transfer protocols, such as any of: IMAP, Microsoft Exchange®, POP3, SMTP, and/or the like. A mail client may communicate to and/or with other components in a component collection, including itself, and/or facilities of the like. Most frequently, the mail client communicates with ay of: mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 17320 is a stored program component that is executed by any of: a CPU 17303, cryptographic processor 17326, cryptographic processor interface 17327, cryptographic processor device 17328, and/or the like. Cryptographic processor interfaces may allow for expedition of encryption and/or decryption requests by the cryptographic component; however, the cryptographic component, alternatively, may run on a CPU and/or GPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to any of: digital certificates (e.g., X.509 authentication framework), digital signatures, dual signatures, enveloping, password access protection, public key management, and/or the like. The cryptographic component facilitates numerous (encryption and/or decryption) security protocols such as, but not limited to any of: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), Transport Layer Security (TLS), and/or the like. Employing such encryption security protocols, the SOCOACT may encrypt all incoming and/or outgoing communications and may serve as node within a virtual private network (VPN) with a wider communications network. The cryptographic component facilitates the process of “security authorization” whereby access to a resource is inhibited by a security protocol and the cryptographic component effects authorized access to the secured resource. In addition, the cryptographic component may provide unique identifiers of content, e.g., employing an MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to allow the SOCOACT component to engage in secure transactions if so desired. The cryptographic component facilitates the secure accessing of resources on the SOCOACT and facilitates the access of secured resources on remote systems; i.e., it may act as a client and/or server of secured resources. Most frequently, the cryptographic component communicates with any of: information servers, operating systems, other program components, and/or the like. The cryptographic component may contain, communicate, generate, obtain, and/or provide program component, system, user, and/or data communications, requests, and/or responses.

### Machine Learning (ML)

In one non limiting embodiment, the SOCOACT includes a machine learning component 17323, which may be a stored program component that is executed by a CPU 17303. The machine learning component, alternatively, may run on any of: a set of specialized processors, ASICs, FPGAs, GPUs, and/or the like. The machine learning component may be deployed to execute serially, in parallel, distributed, and/or the like, such as by utilizing cloud computing. The machine learning component may employ an ML platform such as any of: Amazon SageMaker, Azure® Machine Learning, DataRobot AI Cloud, Google AI Platform, IBM Watson® Studio, and/or the like. The machine learning component may be implemented using any of: an ML framework such as any of: PyTorch, Apache MXNet, MathWorks Deep Learning Toolbox, scikit-learn, TensorFlow, XGBoost, and/or the like. The machine learning component facilitates training and/or testing of ML prediction logic data structures (e.g., models) and/or utilizing ML prediction logic data structures (e.g., models) to output ML predictions by the SOCOACT. The machine learning component may employ various artificial intelligence and/or learning mechanisms such as any of: Reinforcement Learning, Supervised Learning, Unsupervised Learning, and/or the like. The machine learning component may employ ML prediction logic data structure (e.g., model) types such as any of: Bayesian Networks, Classification prediction logic data structures (e.g., models), Decision Trees, Neural Networks (NNs), Regression prediction logic data structures (e.g., models), and/or the like.

### Distributed Immutable Ledger (DIL)

In one non limiting embodiment, the SOCOACT includes a distributed immutable ledger component 17324, which may be a stored program component that is executed by a CPU 17303. The distributed immutable ledger component, alternatively, may run on any of: a set of specialized processors, ASICs, FPGAs, GPUs, and/or the like. The distributed immutable ledger component may be deployed to execute as any of: serially, in parallel, distributed, and/or the like, such as by utilizing a peer-to-peer network. The distributed immutable ledger component may be implemented as a blockchain (e.g., public blockchain, private blockchain, hybrid blockchain) that comprises cryptographically linked records (e.g., blocks). The distributed immutable ledger component may employ a platform such as any of: Bitcoin, Bitcoin Cash, Dogecoin, Ethereum, Litecoin, Monero, Zcash, and/or the like. The distributed immutable ledger component may employ a consensus mechanism such as any of: proof of authority, proof of space, proof of stake, proof of work, and/or the like. The distributed immutable ledger component may be used to provide mechanisms such as any of: data storage, cryptocurrency, inventory tracking, non-fungible tokens (NFTs), smart contracts, and/or the like.

### The SOCOACT Database

The SOCOACT database component 17319 may be embodied in a database and its stored data. The database is a stored program component, which is executed by the CPU; the stored program component portion configuring the CPU to process the stored data. The database may be a fault tolerant, relational, scalable, secure database such as any of: Claris FileMaker®, MySQL®, Oracle®, Sybase®, etc. may be used. Additionally, optimized fast memory and distributed databases such as any of: IBM's Netezza®, MongoDB's MongoDB®, opensource Hadoop®, opensource VoltDB, SAP's Hana®, etc. Relational databases are an extension of a flat file. Relational databases include a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. Alternative key fields may be used from any of the fields having unique value sets, and in some alternatives, even non-unique values in combinations with other fields. More precisely, they uniquely identify rows of a table on the “one” side of a one-to-many relationship.

Alternatively, the SOCOACT database may be implemented using various other data-structures, such as any of: an array, hash, (linked) list, struct, structured text file (e.g., JSON, XML, and/or the like), table, flat file database, and/or the like. Such data-structures may be stored in memory and/or in (structured) files. In another alternative, an object-oriented database may be used, such as any of: Frontier™, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the SOCOACT database is implemented as a data-structure, the use of the SOCOACT database 17319 may be integrated into another component such as the SOCOACT component 17335. Also, the database may be implemented as a mix of data structures, objects, programs, relational structures, scripts, and/or the like. Databases may be consolidated and/or distributed in countless variations (e.g., see Distributed SOCOACT below). Portions of databases, e.g., tables, may be exported and/or imported and thus decentralized and/or integrated.

In another embodiment, the database component (and/or other storage mechanism of the SOCOACT) may store data immutably so that tampering with the data becomes physically impossible and the fidelity and security of the data may be assured. In some embodiments, the database may be stored to write only or write once, read many (WORM) mediums. In another embodiment, the data may be stored on distributed ledger systems (e.g., via blockchain) so that any tampering to entries would be readily identifiable. In one embodiment, the database component may employ the distributed immutable ledger component DIL 17324 mechanism.

In one embodiment, the database component 17319 includes several tables representative of the schema, tables, structures, keys, entities and relationships of the described database 17319a-z:
An accounts table 17319a includes fields such as, but not limited to any of: an accountID, accountOwnerID, accountContactID, assetIDs, deviceIDs, paymentIDs, transactionIDs, userIDs, accountType (e.g., agent, entity (e.g., corporate, non-profit, partnership, etc.), individual, etc.), accountCreationDate, accountUpdateDate, accountName, accountNumber, routingNumber, link WalletsID, accountPrioritAccaountRatio, accountAddress, accountState, accountZIPcode, accountCountry, accountEmail, accountPhone, accountAuthKey, accountIPaddress, accountURLAccessCode, accountPortNo, accountAuthorizationCode, accountAccessPrivileges, accountPreferences, accountRestrictions, accountVerificationStandard, accountExternalFeatures, and/or the like;
A users table 17319b includes fields such as, but not limited to any of: a userID, userSSN, taxID, userContactID, accountID, assetIDs, deviceIDs, paymentIDs, transactionIDs, userType (e.g., agent, entity (e.g., corporate, non-profit, partnership, etc.), individual, etc.), namePrefix, firstName, middleName, lastName, nameSuffix, DateOfBirth, userAge, userName, userEmail, userSocial AccountID, reputationScore, contact Type, contactRelationship, userPhone, userAddress, userCity, userState, userZIPCode, userCountry, userAuthorizationCode, userAccessPrivilges, userPreferences, userRestrictions, primaryFirstName, primaryLastName, primarySSN, secondaryFirstName, secondary LastName, secondarySSN, and/or the like (the user table may support and/or track multiple entity accounts on a SOCOACT);
An devices table 17319c includes fields such as, but not limited to any of: deviceID, sensorIDs, accountID, assetIDs, paymentIDs, deviceType, deviceName, deviceManufacturer, deviceModel, device Version, deviceSerialNo, deviceIPaddress, deviceMACaddress, device ECID, deviceUUID, deviceLocation, deviceCertificate, deviceOS, appIDs, deviceResources, deviceSession, authKey, deviceSecureKey, walletAppInstalledFlag, deviceAccessPrivileges, devicePreferences, deviceRestrictions, hardware_config, software_config, storage_location, sensor_value, pin_reading, data_length, channel_requirement, sensor_name, sensor_model_no, sensor_manufacturer, sensor_type, sensor_serial_number, sensor_power_requirement, device_power_requirement, location, sensor_associated_tool, sensor_dimensions, device_dimensions, sensor_communications_type, device_communications_type, power percentage, power_condition, temperature_setting, speed_adjust, hold_duration, part_actuation, and/or the like. Device table may, in some embodiments, include fields corresponding to one or more Bluetooth® profiles, such as those published at www.bluetooth.org/en-us/specification/adopted-specifications, and/or other device specifications, and/or the like;
An apps table 17319d includes fields such as, but not limited to any of: appID, appName, appType, appDependencies, accountID, deviceIDs, transactionID, userID, appStoreAuthKey, appStoreAccountID, appStoreIPaddress, appStoreURLaccessCode, appStorePortNo, appAccessPrivileges, appPreferences, appRestrictions, portNum, access API_call, linked_wallets_list, and/or the like;
An assets table 17319e includes fields such as, but not limited to any of: assetID, accountID, userID, distributor AccountID, distributorPaymentID, distributorOnwerID, assetOwnerID, assetType, assetSourceDeviceID, assetSourceDeviceType, assetSourceDistributionChannelID, assetSourceDistributionChannelName, assetSourceDistributionChannelType, assetTargetChannelID, assetTargetChannelType, assetTargetChannel Name, asset Name, assetSeriesName, assetSeriesSeason, assetSeriesEpisode, assetCode, assetQuantity, assetCost, assetPrice, assetValue, assetManufactuer, assetModelNo, assetSerialNo, assetLocation, assetAddress, assetState, assetZIPcode, assetState, assetCountry, assetEmail, assetGarbageCollected, assetIPaddress, assetURLaccessCode, assetOwner AccountID, subscriptionIDs, assetAuthroizationCode, assetAccessPrivileges, assetPreferences, assetRestrictions, assetAPI, assetAPIconnectionAddress, and/or the like;
A payments table 17319f includes fields such as, but not limited to any of: paymentID, accountID, userID, couponID, coupon Value, couponConditions, couponExpiration, paymentType, paymentAccountNo, paymentAccountName, paymentAccountAuthorizationCodes, paymentExpirationDate, paymentCCV, paymentRoutingNo, paymentRoutingType, paymentAddress, paymentState, paymentZIPcode, paymentCountry, paymentEmail, paymentAuthKey, paymentIPaddress, paymentURLaccessCode, paymentPortNo, paymentAccessPrivileges, paymentPreferences, payementRestrictions, and/or the like;
An transactions table 17319g includes fields such as, but not limited to any of: transactionID, accountID, assetIDs, deviceIDs, paymentIDs, transactionIDs, userID, merchantID, transactionType, transactionDate, transactionTime, transactionAmount, transactionQuantity, transactionDetails, productsList, productType, productTitle, productsSummary, productParamsList, transactionNo, transactionAccessPrivileges, transactionPreferences, transactionRestrictions, merchantAuthKey, merchantAuthCode, and/or the like;
An merchants table 17319h includes fields such as, but not limited to any of: merchantID, merchantTaxID, merchanteName, merchantContactUserID, accountID, issuerID, acquirerID, merchantEmail, merchantAddress, merchantState, merchantZIPcode, merchantCountry, merchantAuthKey, merchantIPaddress, portNum, merchantURLaccessCode, merchantPortNo, merchantAccessPrivileges, merchantPreferences, merchantRestrictions, and/or the like;
An ads table 17319i includes fields such as, but not limited to any of: adID, advertiserID, adMerchantID, adNetworkID, adName, adTags, advertiserName, adSponsor, adTime, adGeo, adAttributes, adFormat, adProduct, adText, adMedia, adMediaID, adChannelID, adTagTime, adAudioSignature, adHash, adTemplateID, adTemplateData, adSourceID, adSourceName, adSourceServerIP, adSourceURL, adSourceSecurityProtocol, adSourceFTP, adAuthKey, adAccessPrivileges, adPreferences, adRestrictions, adNetworkXchangeID, adNetworkXchangeName, adNetworkXchangeCost, adNetworkXchangeMetricType (e.g., CPA, CPC, CPM, CTR, etc.), adNetworkXchangeMetricValue, adNetworkXchangeServer, adNetworkXchangePortNumber, publisherID, publisherAddress, publisherURL, publisherTag, publisherIndustry, publisherName, publisherDescription, siteDomain, siteURL, siteContent, siteTag, siteContext, siteImpression, siteVisits, siteHeadline, sitePage, siteAdPrice, sitePlacement, sitePosition, bidID, bidExchange, bidOS, bidTarget, bidTimestamp, bidPrice, bidImpressionID, bidType, bidScore, adType (e.g., mobile, desktop, wearable, largescreen, interstitial, etc.), assetID, merchantID, deviceID, userID, accountID, impressionID, impressionOS, impressionTimeStamp, impressionGeo, impressionAction, impression Type, impressionPublisherID, impressionPublisherURL, and/or the like;
An ML table 17319j includes fields such as, but not limited to any of: MLID, predictionLogicStructureID, predictionLogicStructureType, predictionLogicStructureConfiguration, predictionLogicStructure TrainedStructure, predictionLogicStructure TrainingData, predictionLogicStructure TrainingDataConfiguration, predictionLogicStructure TestingData, predictionLogicStructureTestingDataConfiguration, predictionLogicStructureOutputData, predictionLogicStructureOutputDataConfiguration, and/or the like;
A blockchain table 17319k includes fields such as, but not limited to: block(1) . . . block(n). The blockchain table 17319k may be used to store blocks that form blockchains of transactions as described herein.

A public key table 173191 includes fields such as, but not limited to: accountID, accountOwnerID, accountContactID, public_key. The public key table 173191 may be used to store and retrieve the public keys generated for clients of the SOCOACT system as described herein.

A private key table table 17319m includes fields such as, but not limited to: ownerID, OwnertContact, private_key. The private keys held here will not be the private keys of registere users of the SOCOACT system, but instead will be used to authentic transactions originating from the SOCOACT system.

An OpReturn table 17319n includes fields such as, but not limited to: transactionID, OpReturn_Value1 . . . . OpReturn_Value80; where each OpReturn Value entry stores one byte in the OpReturn field for the purposes described above.

A wallet table 173190 includes fields such as, but not limited to: an accountID, accountOwnerID, accountContactID, transactionIDs, SourceAddress(1) . . . . SourceAddress(n), BalanceAddress(1) . . . . Balance address (n), validationServerSettings, recoveryPrivateKey, triggerEventType, recoverySettings. The wallet table 173190 may be used to store wallet information as described in the foregoing.

Hash functions table 17319p stores the hash functions that may be used by the Bloom Filter component 17348A, TTI component 17357A, TTP component 17358A, etc., and may include fields such as: hashFunction1, hashFunction2 . . . hashFunction(n).

Physical Address table 17319q stores the physical address generated by Bloom filter application to source and destination addresses in a transaction, and accordingly may include the following fields: publickey, physicalAddress.

The transaction distance matrix representing all transactions undertaken via the SOCOACT are stored in a LIL or similar format, and accordingly the LIL table 17319r may include the following fields: sourceAddress, destinationAddress, transaction ValueTimestampTuple.

A contracts table 17319s includes fields such as, but not limited to: contractID, contractAddress, contractType, contractParties, contractTerms, contractOracles, contractTokens, contractCode, contractOwnerIDs, contractOwnerAddresses, contractNumberOfSignatures, contractDeploymentSignatures, contractSalt, contractContractFactory Address, and/or the like.

A polls table 17319t includes fields such as, but not limited to: pollID, pollName, pollAvailable VotingOptions, pollAvailableConditions, pollAvailableActions, authenticationStandard, authorizedVoters, pollTalliedResults, and/or the like.

A votes table 17319u includes fields such as, but not limited to: voteID, voteAddress, voterID, voteOutcome, voteConditions, voteOracles, voteActions, associatedPollID, and/or the like.

A NodeData table 17319v includes fields such as, but not limited to: nodeID, nodeBackingRepositoryData, nodeDecryptionKey, and/or the like;

An exchange table 17319w includes fields such as, but not limited to: blockchainNetworkID, exchangeNodesIDs, remoteBlockchainNetworksIDs, remoteBlockchainExchangeNodeIDs, blockchainExchangeRates, and/or the like;

A TPO table 17319x includes fields such as, but not limited to: optimizerConfigurationID, configurationParameters, trackingAttributes, rules, machineLearningStructures, and/or the like;

A HSM table 17319y includes fields such as, but not limited to: HSM_ID, walletID, masterPrivateKey, masterPublicKey, privateKeyDecryptionKey, publicKeyEncryptionKey, isPortableHSM_Utilized, associatedHSM_ID, masterPrivateKeyShare, and/or the like;

A market data table 17319z includes fields such as, but not limited to any of: market_data_feed_ID, asset_ID, asset_symbol, asset_name, spot_price, bid_price, ask price, and/or the like; in one embodiment, the market data table is populated through a market data feed (e.g., Bloomberg's PhatPipe®, Consolidated Quote System® (CQS), Consolidated Tape Association® (CTA), Consolidated Tape System® (CTS), Dun & Bradstreet®, OTC Montage Data Feed® (OMDF), Reuter's Tib®, Triarch®, US equity trade and quote market data®, Unlisted Trading Privileges® (UTP) Trade Data Feed® (UTDF), UTP Quotation Data Feed® (UQDF), and/or the like feeds, e.g., via ITC 2.1 and/or respective feed protocols), for example, through Microsoft's® Active Template Library and Dealing Object Technology's real-time toolkit Rtt.Multi.

In one embodiment, the SOCOACT database may interact with other database systems. For example, employing a distributed database system, queries and data access by search SOCOACT component may treat the combination of the SOCOACT database, an integrated data security layer database as a single database entity (e.g., see Distributed SOCOACT below).

In one embodiment, user programs may contain various user interface primitives, which may serve to update the SOCOACT. Also, various accounts may require custom database tables depending upon the environments and the types of clients the SOCOACT may need to serve. It should be noted that any unique fields may be designated as a key field throughout. In an alternative embodiment, these tables have been decentralized into their own databases and their respective database controllers (i.e., individual database controllers for each of the above tables). The SOCOACT may also be configured to distribute the databases over several computer systemizations and/or storage devices. Similarly, configurations of the decentralized database controllers may be varied by consolidating and/or distributing the various database components 17319a-z. The SOCOACT may be configured to keep track of various settings, inputs, and parameters via database controllers.

The SOCOACT database may communicate to and/or with other components in a component collection, including itself, and/or facilities of the like. Most frequently, the SOCOACT database communicates with any of: the SOCOACT component, other program components, and/or the like. The database may contain, retain, and provide information regarding other nodes and data.

### The SOCOACTs

The SOCOACT component 17335 is a stored program component that is executed by a CPU via stored instruction code configured to engage signals across conductive pathways of the CPU and SOCOACT controller components. In one embodiment, the SOCOACT component incorporates any and/or all combinations of the aspects of the SOCOACT that were discussed in the previous figures. As such, the SOCOACT affects accessing, obtaining and the provision of information, services, transactions, and/or the like across various communications networks. The features and embodiments of the SOCOACT discussed herein increase network efficiency by reducing data transfer requirements with the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., may reduce the capacity and structural infrastructure requirements to support the SOCOACT's features and facilities, and in many cases reduce the costs, energy consumption/requirements, and extend the life of SOCOACT's underlying infrastructure; this has the added benefit of making the SOCOACT more reliable. Similarly, many of the features and mechanisms are designed to be easier for users to use and access, thereby broadening the audience that may enjoy/employ and exploit the feature sets of the SOCOACT; such ease of use also helps to increase the reliability of the SOCOACT. In addition, the feature sets include heightened security as noted via the Cryptographic components 17320, 17326, 17328 and throughout, making access to the features and data more reliable and secure

The SOCOACT transforms transfer of assets (TOA) initiation request, brokerage order request, blockchain transaction request, agency action request, borrow transaction request, contract deployment request, transaction signing request, key backup request, key recovery request datastructure/inputs, via SOCOACT components (e.g., Virtual Currency, Blockchain, Transact. Confirm., TTI, TTP, OP, AF, SF, TV, TP, AA, IEP, BSA, TPO, SFTS, BUKB, SFKB, RUKR, SFKR, TSTS, NTSTS, HSFTS, FTSTS, CSFTS, TSCD, SFCD, TSCTS, SFCTS, NTSITS, FTSITS, SFITS, MOWUMTS, NTSUMTS, HSFUMTS, FTSUMTS, CSFUMTS), into TOA confirm., brokerage order confirm., transaction confirm., agency action notif., borrow transaction init notification, borrow transaction sync notification, contract deployment response, transaction signing resp., key backup resp., key recovery resp. outputs.

The SOCOACT component facilitates access of information between nodes may be developed by employing various development tools and languages such as, but not limited to any of: Apache® components, Assembly, ActiveX, binary executables, (ANSI) (Objective-) C (++), C# and/or .NET®, database adapters, CGI scripts, Java®, JavaScript®, mapping tools, procedural and object oriented development tools, PERL®, PHP, Python®, Ruby, shell scripts, SQL commands, web application server extensions, web development environments and libraries (e.g., Microsoft's® ActiveX®; Adobe AIR®, FLEX & FLASH®; AJAX; (D) HTML; Dojo, Java®; JavaScript®; jQuery(UI); MooTools; Prototype; script.aculo.us; Simple Object Access Protocol (SOAP); SWFObject; Yahoo!® User Interface; and/or the like), WebObjects®, and/or the like. In one embodiment, the SOCOACT server employs a cryptographic server to encrypt and decrypt communications. The SOCOACT component may communicate to and/or with other components in a component collection, including itself, and/or facilities of the like. Most frequently, the SOCOACT component communicates with any of: the SOCOACT database, operating systems, other program components, and/or the like. The SOCOACT may contain, communicate, generate, obtain, and/or provide program component, system, user, and/or data communications, requests, and/or responses.

A Login Component 17341A is a stored program component that is executed by a CPU. In various embodiments, the Login Component 17341A incorporates any and/or all combinations of the aspects of logging into the SOCOACT that was discussed above with respect to FIG. 4.

A Virtual Currency Transaction Component 17342A is a stored program component that is executed by a CPU. In various embodiments, the Virtual Currency Transaction Component 17342A incorporates any and/or all combinations of the aspects of the SOCOACT that was discussed above with respect to FIG. 5.

A Blockchain Component 17343A is a stored program component that is executed by a CPU. In one embodiment, the Blockchain Component 17343A incorporates any and/or all combinations of the aspects of the SOCOACT that was discussed in the previous figures.

A Transaction Confirmation Component 17344A is a stored program component that is executed by a CPU. In one embodiment, the Transaction Confirmation Component 17344A incorporates any and/or all combinations of the aspects of the SOCOACT that was discussed above with respect to FIGS. 5 and 7.

An Order Generation Component 17345A and an Order Placement Component 17346A provide the functionalities as listed above for the SOCOACT.

### Distributed SOCOACTs

The structure and/or operation of any of the SOCOACT node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion. As such, a combination of hardware may be distributed within a location, within a region and/or globally where logical access to a controller may be abstracted as a singular node, yet where a multitude of private, semiprivate and publicly accessible node controllers (e.g., via dispersed data centers) are coordinated to serve requests (e.g., providing private cloud, semi-private cloud, and public cloud computing resources) and allowing for the serving of such requests in discrete regions (e.g., isolated, local, regional, national, global cloud access, etc.).

Thus, SOCOACT may be implemented with varying functional, logical, operational, organizational, structural and/or topological modifications may be made without departing from the scope and/or spirit of the disclosure. For example, unless expressly described otherwise, it is to be understood that the logical and/or topological structure of any combination of any program components (e.g., of the component collection), other components, data flow order, logic flow order, and/or any present feature sets as described in the figures and/or throughout are not limited to a fixed operating order and/or arrangement, but rather, any disclosed order is exemplary (e.g., such description may be presented as such for ease of description and understanding of disclosed principles) and all equivalents, and the components may execute at the same or different processors and in varying orders. Furthermore, it is to be understood that such features are not limited to serial execution (e.g., such description may be presented as such for ease of description and understanding of disclosed principles), but rather, any number of threads, processes, services, servers, and/or the like that may execute asymmetrically, asynchronously, batch, concurrently, delayed, dynamically, in parallel, on-demand, periodically, real-time, symmetrically, simultaneously, synchronously, triggered, and/or the like may take place depending on how the components and even individual methods and/or functions are called. For example, in any of the dataflow and/or logic flow descriptions, any individual item and/or method and/or function called may only execute serially and/or asynchronously in a small deployment on a single core machine, but may be executed concurrently, in parallel, simultaneously, synchronously (as well as asynchronously yet still concurrent, in parallel, and/or simultaneously) when deployed on multicore processors or even across multiple machines and in and from multiple machines and geographic regions.

As such, the component collection may be consolidated and/or distributed in countless variations through various data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so as discussed through the disclosure and/or through various other data processing communication techniques. Furthermore, any part or sub parts of the SOCOACT node controller's component collection (and/or any constituent processing instructions) may be executed on at least one processing unit, where that processing unit may be a sub-unit of a CPU, a core, an entirely different CPU and/or sub-unit at the same location or remotely at a different location, and/or across many multiple such processing units. For example, for load-balancing reasons, parts of the component collection may start to execute on a given CPU core, then the next instruction/execution element of the component collection may (e.g., be moved to) execute on another CPU core, on the same, or completely different CPU at the same or different location, e.g., because the CPU may become over taxed with instruction executions, and as such, a scheduler may move instructions at the taxed CPU and/or CPU sub-unit to another CPU and/or CPU sub-unit with a lesser instruction execution load. In another embodiment, processing may take place on hosted virtual machines such as on Amazon® Data/Web Services (AWS)® where virtual machines literally do not even exist while SOCOACT is executing, and as processing demands increase, such additional virtual machines may be spun up and instantiated as necessary and created on-the-fly to increase processing throughput (e.g., by distributing processing of SOCOACT component collection processor instructions), and conversely, virtual machines may be spun down and cease to exist as processing demands decrease; these virtual machines may be spun up/down on the same, or in completely remote and physically separate facilities and hardware. As such, it may be difficult and/or impossible to predict on which CPU, processing sub-unit, and/or virtual machine a process instruction begins execution and where it will continue and/or conclude execution, as it may be on the same and/or completely different CPU, processing sub-unit, virtual machine, and/or the like.

The configuration of the SOCOACT controller may depend on the context of system deployment. Factors such as, but not limited to any of: the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to any of: data referencing (e.g., pointers), internal messaging, object instance variable communication, shared memory space, variable passing, and/or the like. For example, cloud services such as any of: Amazon Data/Web Services®, Microsoft Azure®, Hewlett Packard Helion®, IBM® Cloud services allow for SOCOACT controller and/or SOCOACT component collections to be hosted in full or partially for varying degrees of scale.

If component collection components are discrete, separate, and/or external to one another, then communicating, obtaining, and/or providing data with and/or to other component components may be accomplished through inter-application data processing communication techniques such as, but not limited to any of: Application Program Interfaces (API) information passage; (distributed) Component Object Model ((D) COM), (Distributed) Object Linking and Embedding ((D) OLE), and/or the like), Common Object Request Broker Architecture (CORBA), Jini local and remote application program interfaces, JavaScript Object Notation (JSON)®, NeXT Computer, Inc.'s® (Dynamic) Object Linking, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as any of: JSON, lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to any of: character (e.g., tab) delineated text, HTML, JSON, structured text streams, XML, and/or the like structured data. In another embodiment, inter-application data processing protocols themselves may have integrated parsers (e.g., JSON, SOAP, and/or like parsers) that may be employed to parse (e.g., communications) data. Further, the parsing grammar may be used beyond message parsing, but may also be used to parse any of: databases, data collections, data stores, structured data, and/or the like. Again, the desired configuration may depend upon the context, environment, and requirements of system deployment.

For example, in some implementations, the SOCOACT controller may be executing a PHP script implementing a Secure Sockets Layer (“SSL”) socket server via the information server, which it listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via an SSL connection, parse the data to extract variables, and store the data to a database, is provided below:

```
<?PHP
header(′Content-Type: text/plain′);
// set ip address and port to listen to for incoming data
$address = ‘192.168.0.100’;
$port = 255;
// create a server-side SSL socket, listen for/accept incoming communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of message
do {
  $input = “”;
  $input = socket_read($client, 1024);
  $data .= $input;
} while($input != “”);
// parse data to extract variables
$obj = json_decode($data, true);
// store input data in a database
mysql_connect(″201.408.185.132″,$DBserver,$password); // access database server
mysql_select(“CLIENT_DB.SQL”); // select database to append
mysql_query(“INSERT INTO UserTable (transmission)
VALUES ($data)”); // add data to UserTable table in a CLIENT database
mysql_close (“CLIENT_DB.SQL”); // close connection to database
?>
```

Also, the following resources may be used to provide example embodiments regarding SOAP parser implementation:

www.xav.com/perl/site/lib/SOAP/Parser.html
publib.boulder.ibm.com/infocenter/tivihelp/v2r1/index.jsp?topic=/com.ibm.IBMDI.d
oc/referenceguide295.htm

publib.boulder.ibm.com/infocenter/tivihelp/v2r1/index.jsp?topic=/com.ibm.IBMDI.d
oc/referenceguide259.htm

all of which are hereby expressly incorporated by reference.

In order to address various issues and advance the art, the entirety of this application for Computationally Efficient Transfer Processing, Auditing, and Search Apparatuses, Mechanisms, Mediums, Processes and Systems (including the Cover Page, Title, Headings, Field, Background, Summary, Brief Description of the Drawings, Detailed Description, Claims, Abstract, Figures, Appendices, and otherwise) shows, by way of illustration, various non-limiting example embodiments in which the claimed innovations may be practiced. The advantages and features described in the application are of a representative sample of embodiments only, and are not exhaustive and/or exclusive. They are presented to assist in understanding and teach the claimed principles. It should be noted that to the extent any financial and/or investment examples are included, such examples are for illustrative purpose(s) only, and are not, nor should they be interpreted, as investment advice. As such, all examples and/or embodiments are deemed to be non-limiting throughout this disclosure; it should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It may be appreciated that many of those undescribed embodiments incorporate and/or be based of same principles of the innovations and others are equivalent. As such, no inference should be drawn regarding those embodiments discussed herein relative to those not discussed herein other than it is as such for purposes of reducing space and repetition. Consequently, terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should not be construed to limit embodiments, and instead, again, are offered for convenience of description of orientation and/or convenience of reference, and as such, do not require that any embodiments be constructed or operated in a particular orientation unless explicitly indicated as such. Terms such as “attached”, “affixed”, “connected”, “coupled”, “interconnected”, etc. may refer to a relationship where structures are secured or attached to one another either directly or indirectly through intervening structures, as well as both movable or rigid attachments or relationships, unless expressly described otherwise. Similarly, descriptions of embodiments disclosed throughout this disclosure, any reference to direction or orientation is merely intended for convenience of description and/or of reference and is not intended in any way to limit the scope of described embodiments. Furthermore, it is to be understood, unless expressly described otherwise, that other embodiments may be utilized and functional, logical, operational, organizational, structural and/or topological modifications may be made without departing from the scope and/or spirit of the disclosure. For instance, unless expressly described otherwise, it is to be understood that the logical and/or topological structure of any combination of any program components (a component collection), other components, data flow order, logic flow order, and/or any present feature sets as described in the figures and/or throughout are not limited to a fixed operating order and/or arrangement, but rather, any disclosed order is exemplary and all equivalents, regardless of order, are contemplated by the disclosure. Also, it is to be understood, unless expressly described otherwise, that such features are not limited to serial execution, but rather, any number of threads, processes, services, servers, and/or the like that may execute asymmetrically, asynchronously, batch, concurrently, delayed, dynamically, in parallel, on-demand, periodically, real-time, symmetrically, simultaneously, synchronously, triggered, and/or the like are contemplated by the disclosure (e.g., see Distributed SOCOACT, above, for examples). Consequently, some of these features may be mutually contradictory, in that they cannot be simultaneously present in a single embodiment. Similarly, some features may be applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations-in-part, divisions, provisionals, re-issues, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a SOCOACT individual and/or enterprise user, component, database configuration and/or relational model, data type, data transmission and/or network framework, feature, library, syntax structure, and/or the like, various embodiments of the SOCOACT, may be implemented that allow a great deal of flexibility and customization. While various embodiments and discussions of the SOCOACT have included information technology, however, it is to be understood that the embodiments described herein may be readily configured and/or customized for a wide variety of other applications and/or implementations. For example, aspects of the SOCOACT also may be adapted for monetary and non-monetary transactions, for non-financial transactions (e.g., medical data), for processing transaction other than borrow transactions, for non-Bitcoin and/or non-Ethereum transactions, and/or the like.

What is claimed is:

1. A blockchain transaction data auditing apparatus, comprising:
at least one memory;
a component collection stored in the at least one memory;
any of at least one processor disposed in communication with the at least one memory, the any of at least one processor executing processor-executable instructions from the component collection, storage of the component collection structured with processor-executable instructions comprising:
receive a plurality of transaction record datastructures for each of a plurality of transactions, each transaction record datastructure comprising a source address, a destination address, a transaction amount and a timestamp of a transaction;
verify, via the source address corresponding to the source digital wallet, that the transaction amount is available in the source digital wallet;
cryptographically record the transaction record datastructure in a blockchain;
receive the source address and the destination address;
hash the source address using a bloom filter to generate a source wallet address;
hash the destination address using the bloom filter to generate a destination wallet address;
add the source wallet address as a first row and a column entry to a matrix datastructure representing a weighted graph of the plurality of transactions;
add the destination wallet address as a second row and column entry to the matrix datastructure representing a weighted graph of the plurality of transactions;
add the transaction amount and the timestamp as an entry to the row corresponding to the source wallet address and the column corresponding to the destination wallet address; and
generate a list representation of the matrix datastructure, where each entry in the list comprises a tuple having the source wallet address, the destination wallet address, the transaction amount and the timestamp.

2. The apparatus of claim 1, the component collection further comprising an Auditing component, in which the processor issues instructions from the Auditing component, stored in the memory, to:
receive a request to search for a prior transaction including the source address;
obtain the source wallet address corresponding to the source address from the bloom filter component;
search the list for the tuple including the source wallet address; and
when the tuple comprises the source wallet address, retrieve the timestamp corresponding to the transaction, decrypt a segment of the blockchain corresponding to the timestamp, and retrieve the transaction record datastructure corresponding to the transaction from the segment of the blockchain.

3. The apparatus of claim 1, in which a list-of-lists datastructure includes at least one tuple per list with each entry containing the row index, the column index and the value; and, further comprising:
updating incremental matrix construction as an updated list-of-lists datastructure with new transaction details structured as searchable.

4. The apparatus of claim 1, in which the source address comprises a hash of a source public key, the source public key comprises a string of alphanumeric characters greater than 27 characters in length.

5. The apparatus of claim 1, in which the source address comprises a RIPEMD-160 hash of an SHA256 hash of a source public key.

6. The apparatus of claim 1, in which the destination address comprises a hash of a destination public key, the destination public key comprises a string of alphanumeric characters greater than 27 characters in length.

7. The apparatus of claim 1, in which the destination address comprises a RIPEMD-160 hash of an SHA256 hash of the source address.

8. The apparatus of claim 1, in which the transaction comprises a virtual currency transaction.

9. The apparatus of claim 1, further comprising the bloom filter, the bloom filter comprising a linear congruential generator (LCG) algorithm that hashes the source address having a first storage bandwidth requirement into a sequence of pseudo-randomized outputs having a second storage bandwidth requirement that is lower than the first storage bandwidth requirement.

10. The apparatus of claim 9, in which the source address cannot be recovered from the sequence using a reverse hashing algorithm.

11. The apparatus of claim 9, the LCG is used to hash the source address several times to generate the sequence.

12. The apparatus of claim 9, in which the LCG is applied to separate segments of the source address to generate the sequence.

13. The apparatus of claim 1, in which the bloom filter hashes the destination address having a first storage bandwidth requirement into a sequence of pseudo-randomized outputs having a second storage bandwidth requirement that is lower than the first storage bandwidth requirement.

14. The apparatus of claim 13, in which the destination address cannot be recovered from the sequence using a reverse hashing algorithm.

15. The apparatus of claim 13, the bloom filter is used to hash the destination address several times to generate the sequence.

16. The apparatus of claim 13, in which the bloom filter is applied to separate segments of the destination address to generate the sequence.

17. The apparatus of claim 1, in which the matrix datastructure contains a transaction amount that corresponds to an outflow of the transaction amount from the source address to the destination address.

18. The apparatus of claim 1, in which the matrix datastructure contains a transaction amount that corresponds to an inflow of the transaction amount from the source address to the destination address.

19. The apparatus of claim 1, in which the processor issues instructions from the bloom filter component, stored in the memory, to:
determine a list of corresponding false positives for hash of the source address; and
store the source wallet address with a list of the corresponding false positives.

20. The apparatus of claim 1, in which the processor issues instructions from the bloom filter component, stored in the memory, to:
determine a list of corresponding false positives for hash of the destination address; and
store the destination wallet address with a list of the corresponding false positives.

21. A blockchain transaction data auditing processor-readable, non-transient medium, the medium storing a component collection, the component collection storage structured with processor-executable instructions comprising:
receive a plurality of transaction record datastructures for each of a plurality of transactions, each transaction record datastructure comprising a source address, a destination address, a transaction amount and a timestamp of a transaction;
verify, via the source address corresponding to the source digital wallet, that the transaction amount is available in the source digital wallet;
cryptographically record the transaction record datastructure in a blockchain;
receive the source address and the destination address;
hash the source address using a bloom filter to generate a source wallet address;
hash the destination address using the bloom filter to generate a destination wallet address;
add the source wallet address as a first row and a column entry to a matrix datastructure representing a weighted graph of the plurality of transactions;
add the destination wallet address as a second row and column entry to the matrix datastructure representing a weighted graph of the plurality of transactions;
add the transaction amount and the timestamp as an entry to the row corresponding to the source wallet address and the column corresponding to the destination wallet address; and
generate a list representation of the matrix datastructure, where each entry in the list comprises a tuple having the source wallet address, the destination wallet address, the transaction amount and the timestamp.

22. A blockchain transaction data auditing processor-implemented system, comprising:
means to store a component collection;
means to process processor-executable instructions from the component collection, the component collection storage structured with processor-executable instructions including:
receive a plurality of transaction record datastructures for each of a plurality of transactions, each transaction record datastructure comprising a source address, a destination address, a transaction amount and a timestamp of a transaction;
verify, via the source address corresponding to the source digital wallet, that the transaction amount is available in the source digital wallet;
cryptographically record the transaction record datastructure in a blockchain;
receive the source address and the destination address;
hash the source address using a bloom filter to generate a source wallet address;
hash the destination address using the bloom filter to generate a destination wallet address;
add the source wallet address as a first row and a column entry to a matrix datastructure representing a weighted graph of the plurality of transactions;
add the destination wallet address as a second row and column entry to the matrix datastructure representing a weighted graph of the plurality of transactions;
add the transaction amount and the timestamp as an entry to the row corresponding to the source wallet address and the column corresponding to the destination wallet address; and
generate a list representation of the matrix datastructure, where each entry in the list comprises a tuple having the source wallet address, the destination wallet address, the transaction amount and the timestamp.

23. A blockchain transaction data auditing process, including processing processor-executable instructions via at least one processor from a component collection stored in at least one memory, the component collection storage structured with processor-executable instructions comprising:
receive a plurality of transaction record datastructures for each of a plurality of transactions, each transaction record datastructure comprising a source address, a destination address, a transaction amount and a timestamp of a transaction;
verify, via the source address corresponding to the source digital wallet, that the transaction amount is available in the source digital wallet;
cryptographically record the transaction record datastructure in a blockchain;
receive the source address and the destination address;
hash the source address using a bloom filter to generate a source wallet address;
hash the destination address using the bloom filter to generate a destination wallet address;
add the source wallet address as a first row and a column entry to a matrix datastructure representing a weighted graph of the plurality of transactions;
add the destination wallet address as a second row and column entry to the matrix datastructure representing a weighted graph of the plurality of transactions;
add the transaction amount and the timestamp as an entry to the row corresponding to the source wallet address and the column corresponding to the destination wallet address; and
generate a list representation of the matrix datastructure, where each entry in the list comprises a tuple having the source wallet address, the destination wallet address, the transaction amount and the timestamp.
